(19) United States
(12) Patent Application Publication
(10) Pub. No.: US 2022/0259479 A1
(43) Pub. Date: Aug. 18, 2022

(54) SALT HYDRATE COMPOSITIONS FOR THERMAL ENERGY STORAGE SYSTEMS

(71) Applicant: THE REGENTS OF THE UNIVERSITY OF MICHIGAN, Ann Arbor, MI (US)

(72) Inventors: Donald Jason SIEGEL, Austin, TX (US); Steven KIYABU, Ann Arbor, MI (US)

(73) Assignee: THE REGENTS OF THE UNIVERSITY OF MICHIGAN, Ann Arbor, MI (US)

(21) Appl. No.: 17/581,356

(22) Filed: Jan. 21, 2022

Related U.S. Application Data
(60) Provisional application No. 63/139,987, filed on Jan. 21, 2021.

(51) Int. Cl. C09K 5/16; C01G 3/04; C01G 23/02; C01G 49/10; C01G 51/08; C01G 53/08; C01B 33/107; C01F 5/28; C01G 45/06; C01F 11/22; C01D 15/04

(52) U.S. Cl. CPC C09K 5/16; C01G 3/04; C01G 23/028; C01G 49/10; C01G 51/08; C01P 2006/36; C01B 33/10705; C01F 5/28; C01G 45/06; C01F 11/22; C01D 15/04; C01G 53/08

(57) ABSTRACT

Compositions suitable for reversibly storing heat in thermal energy systems (TES) include a salt hydrate represented by the formula: MX_{q}.nH₂O. M is a cation selected from Groups 1 to 14 of the IUPAC Periodic Table, X is a halide of Group 17, q ranges from 1 to 4, and n ranges from 1 to 12. The cation (M) may have an electronegativity of ≤ about 1.8 and a molar mass ≤ about 28 g/mol. The anion (X) may have an electronegativity of ≥ about 2.9 to ≤ about 3.2. A distance between a cation (M) and coordinating water molecules (H₂O) is ≤ about 2.1 Å. Thermal energy systems (TES) incorporating such compositions are also provided that are configured to reversibly store heat in the thermal energy system (TES) via an endothermic dehydration reaction and to release heat in in the thermal energy system (TES) via an exothermic hydration reaction.

### CROSS-REFERENCE TO RELATED APPLICATIONS

This application claims the benefit of U.S. Provisional Application No. 63/139,987 filed on Jan. 21, 2021. The entire disclosure of the above application is incorporated herein by reference.

### GOVERNMENT SUPPORT

This invention was made with government support under W56HZV-19-2-0001 awarded by the U.S. Army. The government has certain rights in the invention.

### FIELD

The present disclosure relates to new, high-capacity materials for applications in thermal energy storage systems that incorporate salt hydrates configured to reversibly store heat in the thermal energy storage system (TES) via an endothermic dehydration reaction and to release heat in in the thermal energy storage system (TES) via an exothermic hydration reaction.

### BACKGROUND

This section provides background information related to the present disclosure which is not necessarily prior art.

Heat is an important, but inefficient, aspect of the energy ecosystem. It is estimated that waste heat loss ultimately accounts for over two-thirds of the energy produced in the United States. As a result, there has been increasing demand for technological strategies that can more effectively manage heat. Thermal energy storage (TES) is one such strategy. TES has been used to thermally manage various systems (e.g., buildings, electronics, textiles), capture waste heat for later reuse (e.g., industrial processes), and store energy generated in solar power plants.

TES can be used within automotive vehicles for thermal management. Vehicles have many systems that operate at a wide range of temperatures. Applications such as passenger compartment/cabin heating, compartment/cabin electronics, and a cool end of a cooling loop tend to operate at temperatures below 100° C. Other systems operate at higher temperatures, such as various power electronics (125° C.-200° C.), engine exhaust heat recovery (200° C.-800° C.), and cold start buffering for the catalytic converter (320° C.-560° C.). Additionally, given the space and weight constraints on these vehicle systems, TES systems with high volumetric and gravimetric energy densities are desirable. In many cases, the TES material is the limiting factor within TES systems. As such, it would be desirable to identify new TES materials that can reversibly store heat with high energy densities at temperatures corresponding to target applications and temperature ranges, by way of non-limiting example, in vehicular applications.

### SUMMARY

This section provides a general summary of the disclosure, and is not a comprehensive disclosure of its full scope or all of its features.

In certain aspects the present disclosure relates to compositions suitable for use in thermal energy systems (TES). In certain variations, the composition comprises a salt hydrate represented by the formula: MX_{q}.nH₂O, where M is a cation selected from Groups 1-14 of the IUPAC Periodic Table, X is a halide of Group 17 of the IUPAC Periodic Table, q ranges from 1 to 4, and n ranges from 1 to 12. The salt hydrate may be selected from the group consisting of: AlBr₃.H₂O, BaBr₂.12H₂O, BaF₂.2H₂O, BaF₂.12H₂O, BaI₂.12H₂O, BeBr₂.9H₂O, BeCl₂.12H₂O, BeF₂.9H₂O, BeI₂.2H₂O, BeI₂.8H₂O, BeI₂.12H₂O, CaBr₂.12H₂O, CaI₂.2H₂O, CaI₂.12H₂O, CoBr₂.12H₂O, CoBr₃.9H₂O, CoCl₂.12H₂O, CoCl₃.9H₂O, CoF₂.12H₂O, CoF₃.9H₂O, CoI₂.12H₂O, CrBr₂.4H₂O, CrBr₂.12H₂O, CrBr₄.8H₂O, CrCl₂.12H₂O, CrCl₄.8H₂O, CrF₂.4H₂O, CrF₂.12H₂O, CrF₄.5H₂O, CrF₄.8H₂O, CrI₂.4H₂O, CrI₂.12H₂O, CrI₃.9H₂O, CrI₄.3H₂O, CrI₄.8H₂O, CuBr₂.12H₂O, CuF.H₂O, CuF.2H₂O, CuF₂.4H₂O, CuF₂.12H₂O, CuI₂.4H₂O, FeBr₃.H₂O, FeBr₃.9H₂O, FeF₂.12H₂O, FeF₃.9H₂O, FeI₃.2H₂O, FeI₃.3H₂O, GaBr₃.2H₂O, GaBr₃.9H₂O, GaF₃.9H₂O, GaI₃.H₂O, GaI₃.9H₂O, GeBr₂.4H₂O, GeBr₂.12H₂O, GeCl₂.2H₂O, GeCl₂.4H₂O, GeCl₂.12H₂O, GeCl₄.8H₂O, GeF₂.2H₂O, GeF₂.4H₂O, GeF₂.12H₂O, GeF₄.5H₂O, GeF₄.8H₂O, GeI₂.4H₂O, GeI₂.12H₂O, GeI₄.H₂O, HfBr₃.9H₂O, HfBr₄.2H₂O, HfBr₄.3H₂O, HfBr₄.4H₂O, HfBr₄.8H₂O, HfCl₃.9H₂O, HfCl₄.2H₂O, HfCl₄.3H₂O, HfCl₄.4H₂O, HfF₄.8H₂O, HfI₃.9H₂O, HfI₄.2H₂O, HfI₄.H₂O, LaF₃.9H₂O, LaI₂.12H₂O, LiF.4H₂O, MgBr₂.12H₂O, MgF₂.12H₂O, MgI₂.4H₂O, MgI₂.12H₂O, MnBr₂.12H₂O, MnBr₃.6H₂O, MnBr₄.8H₂O, MnCl₃.9H₂O, MnCl₄.8H₂O, MnF₂.12H₂O, MnF₃.9H₂O, MnF₄.2H₂O, MnF₄.4H₂O, MnF₄.5H₂O, MnF₄.8H₂O, MnI₂.12H₂O, MnI₃.6H₂O, MnI₄.8H₂O, MoBr₃.9H₂O, MoBr₄.8H₂O, MoCl₃.2H₂O, MoCl₃.9H₂O, MoCl₄.4H₂O, MoCl₄.8H₂O, MoF₂.H₂O, MoF₃.3H₂O, MoF₃.9H₂O, MoF₄.2H₂O, MoF₄.5H₂O, MoF₄.8H₂O, MoI₃.9H₂O, MoI₄.8H₂O, NaBr.H₂O, NaBr₄H₂O, NaF.4H₂O, NbBr₃.6H₂O, NbBr₃.9H₂O, NbBr₄.8H₂O, NbCl₃.9H₂O, NbCl₄.8H₂O, NbF₃.H₂O, NbF₃.9H₂O, NbF₄.5H₂O, NbF₄.8H₂O, NbI₃.6H₂O, NbI₃.9H₂O, NbI₄.8H₂O, NiBr₂.12H₂O, NiBr₃.6H₂O, NiCl₃.9H₂O, NiF₂.12H₂O, NiF₃.2H₂O, NiF₃.9H₂O, NiI₂.12H₂O, PbBr₂.2H₂O, PbBr₂.4H₂O, PbBr₂.12H₂O, PbBr₄.8H₂O, PbCl₂.12H₂O, PbCl₄.3H₂O, PbCl₄.8H₂O, PbF₂.2H₂O, PbF₂.12H₂O, PbF₄.2H₂O, PbF₄.3H₂O, PbF₄.5H₂O, PbI₂.4H₂O, PbI₂.12H₂O, PbI₄.5H₂O, RbBr₄H₂O, RbCl_{.4}H₂O, RbI.4H₂O, ScBr₃.9H₂O, ScF₃.3H₂O, ScF₃.9H₂O, ScI₃.6H₂O, ScI₃.9H₂O, SiBr₂.8H₂O, SiBr₄.8H₂O, SiBr₄.9H₂O, SiCl₂.8H₂O, SiCl₄.8H₂O, SiCl₄.9H₂O, SiF₄.5H₂O, SiF₄.8H₂O, SiI₂.8H₂O, SiI₄.9H₂O, SnBr₂.4H₂O, SnBr₂.12H₂O, SnCl₂.12H₂O, SnF₂.4H₂O, SnF₂.12H₂O, SnF₄.2H₂O, SnF₄.5H₂O, SnF₄.8H₂O, SnI₂.4H₂O, SnI₂.12H₂O, SnI₄.H₂O, SnI₄.2H₂O, SnI₄.3H₂O, SrBr₂.12H₂O, SrCl₂.12H₂O, SrF₂.2H₂O, SrF₂.12H₂O, SrI₂.12H₂O, TaBr₃.6H₂O, TaBr₃.9H₂O, TaBr₄.8H₂O, TaCl₃.9H₂O, TaCl₄.8H₂O, TaF₃.H₂O, TaF₄.5H₂O, TaF₄.8H₂O, TaI₃.6H₂O, TaI₄.8H₂O, TiBr₂.H₂O, TiBr₂.12H₂O, TiBr₃.9H₂O, TiBr₄.8H₂O, TiCl₂.12H₂O, TiCl₃.H₂O, TiF₂.H₂O, TiF₂.12H₂O, TiF₃.3H₂O, TiF₃.9H₂O, TiF₄.5H₂O, TiF₄.8H₂O, TiI₂.12H₂O, TiI₃.9H₂O, TiI₄.8H₂O, VBr₂.12H₂O, VBr₃.9H₂O, VBr₄.8H₂O, VCl₂.H₂O, VCl₂.12H₂O, VCl₃.9H₂O, VCl₄.8H₂O, VF₂.12H₂O, VF₃.9H₂O, VF₄.2H₂O, VF₄.5H₂O, VF₄.8H₂O, VI₂.12H₂O, VI₃.9H₂O, VI₄.8H₂O, WBr₄.8H₂O, WCl₄.8H₂O, WF₄.5H₂O, WF₄.8H₂O, WI₄.8H₂O, YF₃.9H₂O, YI₃.7H₂O, YI₃.9H₂O, ZnBr₂.12H₂O, ZnCl₂.12H₂O, ZnF₂.12H₂O, ZnI₁₂.12H₂O, ZrBr₂.H₂O, ZrBr₂.12H₂O, ZrBr₃.9H₂O, ZrBr₄.2H₂O, ZrBr₄.3H₂O, ZrBr₄.4H₂O, ZrBr₄.8H₂O, ZrCl₂.H₂O, ZrCl₂.12H₂O, ZrCl₃.9H₂O, ZrF₃.9H₂O, ZrF₄.8H₂O, ZrI₃.9H₂O, ZrI₄.2H₂O, ZrI₄.8H₂O, AIBr₃.4H₂O, AIBr₃.7H₂O, AIBr₃.8H₂O, AlBr₃.10H₂O, AlCl₃.H₂O, AlCl₃.H₂O, AlCl₃.H₂O, AlF₃.8H₂O, AlF₃.10H₂O, AlI₃.H₂O, AlI₃.2H₂O, AlI₃.3H₂O, AlI₃.4H₂O, AlI₃.7H₂O, AlI₃.8H₂O, AlI₃.10H₂O, BaBr₂.6H₂O, BaBr₂.7H₂O, BaBr₂.8H₂O, BaBr₂.9H₂O, BaF₂.H₂O, BaF₂.4H₂O, BaF₂.6H₂O, BaF₂.7H₂O, BaF₂.8H₂O, BaF₂.9H₂O, BaI₂.8H₂O, BaI₂.9H₂O, BeBr₂.H₂O, BeBr₂.2H₂O, BeBr₂.8H₂O, BeBr₂.12H₂O, BeCl₂.7H₂O, BeCl₂.8H₂O, BeCl₂.9H₂O, BeF₂.7H₂O, BeF₂.8H₂O, BeF₂.12H₂O, BeI₂.7H₂O, BeI₂.9H₂O, CaBr₂.7H₂O, CaBr₂.8H₂O, CaI₂.9H₂O, CoBr₂.8H₂O, CoBr₂.9H₂O, CoBr₃.H₂O, CoBr₃.3H₂O, CoBr₃.4H₂O, CoBr₃.7H₂O, CoBr₃.10H₂O, CoCl₃.H₂O, CoCl₃.H₂O, CoF₂.8H₂O, CoF₂.9H₂O, CoF₃.6H₂O, CoF₃.7H₂O, CoF₃.8H₂O, CoF₃.10H₂O, CoI₂.8H₂O, CoI₂.9H₂O, CoI₃.H₂O, CoI₃.6H₂O, CoI₃.7H₂O, CoI₃.9H₂O, CoI₃.H₂O, CrBr₂.H₂O, CrBr₂.2H₂O, CrBr₂.7H₂O, CrBr₂.8H₂O, CrBr₂.9H₂O, CrBr₃.H₂O, CrBr₃.2H₂O, CrBr₃.3H₂O, CrBr₃.7H₂O, CrBr₃.10H₂O, CrBr₄.2H₂O, CrBr₄.3H₂O, CrBr₄.4H₂O, CrBr₄.5H₂O, CrBr₄.9H₂O, CrCl₂.H₂O, CrCl₂.7H₂O, CrCl₂.8H₂O, CrCl₂.9H₂O, CrCl₃.H₂O, CrCl₄.2H₂O, CrCl₄.3H₂O, CrCl₄.4H₂O, CrCl₄.5H₂O, CrF2.H₂O, CrF₂.6H₂O, CrF₂.7H₂O, CrF₂.8H₂O, CrF₂.9H₂O, CrF₄.3H₂O, CrF₄.4H₂O, CrI₂.H₂O, CrI₂.2H₂O, CrI₂.6H₂O, CrI₂.7H₂O, CrI₂.8H₂O, CrI₂.9H₂O, CrI₃.H₂O, CrI₃.2H₂O, CrI₃.H₂O, CrI₃.7H₂O, CrI₃.8H₂O, CrI₃.10H₂O, CrI₄.2H₂O, CrI₄.4H₂O, CrI₄.5H₂O, CrI₄.9H₂O, CuBr₃H₂O, CuBr₂.7H₂O, CuBr₂.8H₂O, CuBr₂.9H₂O, CuCl₂.8H₂O, CuCl₂.9H₂O, CuF.3H₂O, CuF.4H₂O, CuF₂.6H₂O, CuF₂.8H₂O, CuF₂.9H₂O, CuI₂.6H₂O, CuI₂.8H₂O, CuI₂.9H₂O, CuI₂.12H₂O, FeBr₂.8H₂O, FeBr₂.12H₂O, FeBr₃.3H₂O, FeBr₃.4H₂O, FeBr₃.7H₂O, FeBr₃.8H₂O, FeBr₃.10H₂O, FeCl₂.8H₂O, FeF2.H₂O, FeF₂.2H₂O, FeF₂.6H₂O, FeF₂.9H₂O, FeF₃.2H₂O, FeF₃.4H₂O, FeF₃.6H₂O, FeF₃.7H₂O, FeF₃.8H₂O, FeF₃.10H₂O, FeI₂.7H₂O, FeI₂.8H₂O, FeI₂.12H₂O, FeI₃.H₂O, FeI₃.H₂O, FeI₃.7H₂O, FeI₃.H₂O, FeI₃.9H₂O, GaBr₃.H₂O, GaBr₃.4H₂O, GaBr₃.6H₂O, GaBr₃.7H₂O, GaBr₃.8H₂O, GaBr₃.10H₂O, GaCl₃.2H₂O, GaCl₃.H₂O, GaCl₃.H₂O, GaCl₃.7H₂O, GaCl₃.H₂O, GaCl₃.H₂O, GaF₃.4H₂O, GaF₃.6H₂O, GaF₃.7H₂O, GaF₃.10H₂O, GaI₃.H₂O, GaI₃.H₂O, GaI₃.6H₂O, GaI₃.7H₂O, GaI₃.H₂O, GeBr₂.H₂O, GeBr₂.2H₂O, GeBr₂.6H₂O, GeBr₂.7H₂O, GeBr₂.8H₂O, GeBr₂.9H₂O, GeBr₄.3H₂O, GeBr₄.4H₂O, GeBr₄.5H₂O, GeBr₄.9H₂O, GeCl₂.H₂O, GeCl₂.6H₂O, GeCl₂.7H₂O, GeCl₂.8H₂O, GeCl₂.9H₂O, GeCl₄.3H₂O, GeCl₄.4H₂O, GeCl₄.9H₂O, GeF₂.6H₂O, GeF₂.7H₂O, GeF₂.8H₂O, GeF₂.9H₂O, GeF₄.H₂O, GeF₄.4H₂O, GeF₄.9H₂O, GeI₂.H₂O, GeI₂.2H₂O, GeI₂.6H₂O, GeI₂.7H₂O, GeI₂.8H₂O, GeI₂.9H₂O, GeI₄.3H₂O, GeI₄.4H₂O, GeI₄.5H₂O, GeI₄.9H₂O, HfBr₃.H₂O, HfBr₃.7H₂O, HfBr₃.8H₂O, HfBr₃.10H₂O, HfBr₄.5H₂O, HfBr₄.9H₂O, HfBr₄.10H₂O, HfCl₃.H₂O, HfCl₃.6H₂O, HfCl₃.7H₂O, HfCl₃.H₂O, HfCl₃.H₂O, HfCl₄.9H₂O, HfCl₄.10H₂O, HfF₃.9H₂O, HfF₃.10H₂O, HfF₄.4H₂O, HfF₄.5H₂O, HfF₄.9H₂O, HfI₃.6H₂O, HfI₃.7H₂O, HfI₃.H₂O, HfI₃.H₂O, HfI₄.3H₂O, HfI₄.4H₂O, HfI₄.5H₂O, HfI₄.9H₂O, HfI₄.10H₂O, LaBr₂.9H₂O, LaBr₂.12H₂O, LaBr₃.2H₂O, LaBr₃.10H₂O, LaCl_{.3}H₂O, LaCl_{.4}H₂O, LaCl₂.12H₂O, LaF₂.12H₂O, LaF₃.H₂O, LaF₃.4H₂O, LaF₃.7H₂O, LaF₃.8H₂O, LaF₃.10H₂O, LaI.4H₂O, LaI₂.7H₂O, LaI₂.8H₂O, LaI₂.9H₂O, LaI₃.H₂O, LaI₃.2H₂O, LaI₃.3H₂O, LaI₃.H₂O, LaI₃.7H₂O, LaI₃.H₂O, LaI₃.H₂O, LiF.3H₂O, MgBr₂.7H₂O, MgF₂.6H₂O, MgF₂.8H₂O, MgI₂.H₂O, MnBr₂.7H₂O, MnBr₂.8H₂O, MnBr₂.9H₂O, MnBr₃.H₂O, MnBr₃.2H₂O, MnBr₃.3H₂O, MnBr₃.4H₂O, MnBr₃.7H₂O, MnBr₃.8H₂O, MnBr₃.9H₂O, MnBr₃. 10H₂O, MnBr₄.2H₂O, MnBr₄.3H₂O, MnBr₄.5H₂O, MnBr₄.9H₂O, MnCl₃.H₂O, MnCl₃.H₂O, MnCl₃.7H₂O, MnCl₃.H₂O, MnCl₄.2H₂O, MnCl₄.3H₂O, MnCl₄.5H₂O, MnCl₄.9H₂O, MnF₂.6H₂O, MnF₂.8H₂O, MnF₂.9H₂O, MnF₃.4H₂O, MnF₃.6H₂O, MnF₃.7H₂O, MnF₄.H₂O, MnF₄.3H₂O, MnF₄.9H₂O, MnI₂.7H₂O, MnI₂.8H₂O, MnI₂.9H₂O, MnI₃.H₂O, MnI₃.2H₂O, MnI₃.3H₂O, MnI₃.4H₂O, MnI₃.7H₂O, MnI₃.8H₂O, MnI₃.9H₂O, MnI₃.10H₂O, MnI₄.2H₂O, MnI₄.3H₂O, MnI₄.4H₂O, MnI₄.5H₂O, MoBr₂.12H₂O, MoBr₃.3H₂O, MoBr₃.4H₂O, MoBr₃.6H₂O, MoBr₃.7H₂O, MoBr₃.8H₂O, MoBr₃.10H₂O, MoBr₄.2H₂O, MoBr₄.3H₂O, MoBr₄.4H₂O, MoBr₄.5H₂O, MoBr₄.9H₂O, MoCl₂.12H₂O, MoCl₃.H₂O, MoCl₃.7H₂O, MoCl₃.H₂O, MoCl₃.H₂O, MoCl₄.H₂O, MoCl₄.3H₂O, MoCl₄.5H₂O, MoF₂.8H₂O, MoF₂.9H₂O, MoF₂.12H₂O, MoF₃.H₂O, MoF₃.2H₂O, MoF₃.4H₂O, MoF₃.6H₂O, MoF₃.7H₂O, MoF₃.8H₂O, MoF₃.10H₂O, MoF₄.3H₂O, MoF₄.4H₂O, MoF₄.9H₂O, MoI₂.12H₂O, MoI₃.H₂O, MoI₃.H₂O, MoI₃.6H₂O, MoI₃.7H₂O, MoI₃.H₂O, MoI₃.10H₂O, MoI₄.2H₂O, MoI₄.3H₂O, MoI₄.4H₂O, MoI₄.5H₂O, MoI₄.9H₂O, NaBr₃H₂O, NaF.H₂O, NaF.2H₂O, NaF.3H₂O, NbBr₃.2H₂O, NbBr₃.3H₂O, NbBr₃.4H₂O, NbBr₃.7H₂O, NbBr₃.8H₂O, NbBr₃.10H₂O, NbBr₄.2H₂O, NbBr₄.3H₂O, NbBr₄.4H₂O, NbBr₄.5H₂O, NbBr₄.9H₂O, NbCl₃.H₂O, NbCl₃.H₂O, NbCl₃.H₂O, NbCl₃.6H₂O, NbCl₃.7H₂O, NbCl₃.H₂O, NbCl₃.H₂O, NbCl₄.2H₂O, NbCl₄.3H₂O, NbCl₄.4H₂O, NbCl₄.5H₂O, NbCl₄.9H₂O, NbF₃.2H₂O, NbF₃.3H₂O, NbF₃.4H₂O, NbF₃.6H₂O, NbF₃.7H₂O, NbF₃.8H₂O, NbF₃.10H₂O, NbF₄.H₂O, NbF₄.2H₂O, NbF₄.3H₂O, NbF₄.4H₂O, NbF₄.9H₂O, NbI₃.2H₂O, NbI₃.H₂O, NbI₃.H₂O, NbI₃.7H₂O, NbI₃.H₂O, NbI₃.H₂O, NbI₄.2H₂O, NbI₄.3H₂O, NbI₄.4H₂O, NbI₄.5H₂O, NbI₄.9H₂O, NbI₄.10H₂O, NiBr₂.7H₂O, NiBr₂.8H₂O, NiBr₃.H₂O, NiBr₃.2H₂O, NiBr₃.3H₂O, NiBr₃.4H₂O, NiBr₃.7H₂O, NiBr₃.8H₂O, NiBr₃.9H₂O, NiBr₃.10H₂O, NiCl₃.4H₂O, NiCl₃.H₂O, NiCl₃.H₂O, NiCl₃.H₂O, NiF₂.H₂O, NiF₂.7H₂O, NiF₂.8H₂O, NiF₂.9H₂O, NiF₃.6H₂O, NiF₃.10H₂O, NiI₂.H₂O, NiI₂.2H₂O, NiI₂.7H₂O, NiI₂.8H₂O, NiI₂.9H₂O, NiI₃.2H₂O, NiI₃.3H₂O, NiI₃.6H₂O, NiI₃.7H₂O, NiI₃.8H₂O, NiI₃.9H₂O, NiI₃.H₂O, PbBr₂.6H₂O, PbBr₂.7H₂O, PbBr₂.8H₂O, PbBr₂.9H₂O, PbBr₄.3H₂O, PbBr₄.4H₂O, PbBr₄.5H₂O, PbBr₄.9H₂O, PbCl₂.H₂O, PbCl₂.7H₂O, PbCl₂.8H₂O, PbCl₂.9H₂O, PbCl₄.2H₂O, PbCl₄.4H₂O, PbCl₄.5H₂O, PbF₂.4H₂O, PbF₂.6H₂O, PbF₂.7H₂O, PbF₂.8H₂O, PbF₂.9H₂O, PbF₄.H₂O, PbF₄.4H₂O, PbI₂.H₂O, PbI₂.6H₂O, PbI₂.7H₂O, PbI₂.8H₂O, PbI₂.9H₂O, PbI₄.H₂O, PbI₄.3H₂O, PbI₄.4H₂O, PbI₄.H₂O, PbI₄.9H₂O, RbBr.H₂O, RbBr₂H₂O, RbBr₃H₂O, RbCl.H₂O, RbCl.2H₂O, RbCl_{.3}H₂O, RbIH₂O, RbI2H₂O, RbI3H₂O, ScBr₃.2H₂O, ScBr₃.8H₂O, ScBr₃.10H₂O, ScCl₃.H₂O, ScCl₃.H₂O, ScF₃.2H₂O, ScF₃.4H₂O, ScF₃.7H₂O, ScF₃.8H₂O, ScF₃.10H₂O, ScI₃.H₂O, ScI₃.H₂O, ScI₃.H₂O, ScI₃.7H₂O, ScI₃.10H₂O, SiBr₂.4H₂O, SiBr₂.9H₂O, SiBr₂.12H₂O, SiBr₄.3H₂O, SiBr₄.4H₂O, SiBr₄.5H₂O, SiCl₂.4H₂O, SiCl₂.7H₂O, SiCl₂.9H₂O, SiCl₂.12H₂O, SiCl₄.3H₂O, SiCl₄.4H₂O, SiCl₄.5H₂O, SiF₂.2H₂O, SiF₂.8H₂O, SiF₄.3H₂O, SiF₄.4H₂O, SiF₄.9H₂O, SiI₂.4H₂O, SiI₂.6H₂O, SiI₂.9H₂O, SiI₂.12H₂O, SiI₄.H₂O, SnBr₂.6H₂O, SnBr₂.8H₂O, SnBr₂.9H₂O, SnBr₄.2H₂O, SnBr₄.3H₂O, SnBr₄.9H₂O, SnCl₂.8H₂O, SnF₂.6H₂O, SnF₂.7H₂O, SnF₂.8H₂O, SnF₂.9H₂O, SnF₄.H₂O, SnF₄.3H₂O, SnF₄.4H₂O, SnF₄.9H₂O, SnI₂.H₂O, SnI₂.6H₂O, SnI₂.7H₂O, SnI₂.8H₂O, SnI₂.9H₂O, SnI₄.4H₂O, SnI₄.9H₂O, SrBr₂.4H₂O, SrBr₂.7H₂O, SrBr₂.8H₂O, SrBr₂.9H₂O, SrCl₂.8H₂O, SrF₂.4H₂O, SrF₂.6H₂O, SrF₂.8H₂O, SrF₂.9H₂O, SrI₂.4H₂O, SrI₂.8H₂O, SrI₂.9H₂O, TaBr₃.H₂O, TaBr₃.2H₂O, TaBr₃.3H₂O, TaBr₃.4H₂O, TaBr₃.7H₂O, TaBr₃.8H₂O, TaBr₃.10H₂O, TaBr₄.2H₂O, TaBr₄.3H₂O, TaBr₄.4H₂O, TaBr₄.5H₂O, TaBr₄.9H₂O, TaCl₃.2H₂O, TaCl₃.H₂O, TaCl₃.H₂O, TaCl₃.6H₂O, TaCl₃.7H₂O, TaCl₃.H₂O, TaCl₃.H₂O, TaCl₄.2H₂O, TaCl₄.3H₂O, TaCl₄.4H₂O, TaCl₄.5H₂O, TaCl₄.9H₂O, TaF₃.9H₂O, TaF₃.10H₂O, TaF₄.2H₂O, TaF₄.3H₂O, TaF₄.4H₂O, TaF₄.9H₂O, TaI₃.H₂O, TaI₃.H₂O, TaI₃.7H₂O, TaI₃.H₂O, TaI₃.9H₂O, TaI₃.H₂O, TaI₄.2H₂O, TaI₄.3H₂O, TaI₄.4H₂O, TaI₄.5H₂O, TaI₄.9H₂O, TaI₄.10H₂O, TiBr₂.2H₂O, TiBr₂.4H₂O, TiBr₂.7H₂O, TiBr₂.8H₂O, TiBr₂.9H₂O, TiBr₃.H₂O, TiBr₃.2H₂O, TiBr₃.3H₂O, TiBr₃.4H₂O, TiBr₃.7H₂O, TiBr₃.8H₂O, TiBr₃.10H₂O, TiBr₄.2H₂O, TiBr₄.3H₂O, TiBr₄.4H₂O, TiBr₄.5H₂O, TiBr₄.9H₂O, TiCl₂.4H₂O, TiCl₂.7H₂O, TiCl₂.8H₂O, TiCl₂.9H₂O, TiCl₃.H₂O,TiCl₃.2H₂O, TiCl₃.7H₂O, TiCl₃.H₂O, TiCl₃.H₂O, TiCl₄.3H₂O, TiCl₄.4H₂O, TiCl₄.9H₂O, TiF₂.4H₂O, TiF₂.6H₂O, TiF₂.8H₂O, TiF₂.9H₂O, TiF₃.2H₂O, TiF₃.6H₂O, TiF₃.7H₂O, TiF₃.8H₂O, TiF₄.3H₂O, TiF₄.9H₂O, TiI₂.H₂O, TiI₂.2H₂O, TiI₂.4H₂O, TiI₂.6H₂O, TiI₂.7H₂O, TiI₂.8H₂O, TiI₂.9H₂O, TiI₃.2H₂O, TiI₃.3H₂O, TiI₃.4H₂O, TiI₃.7H₂O, TiI₃.8H₂O, TiI₃.H₂O, TiI₄.2H₂O, TiI₄.3H₂O, TiI₄.4H₂O, TiI₄.5H₂O, TiI₄.9H₂O, VBr₂.H₂O, VBr₂.7H₂O, VBr₂.8H₂O, VBr₂.9H₂O, VBr₃.H₂O, VBr₃.2H₂O, VBr₃.3H₂O, VBr₃.7H₂O, VBr₃.8H₂O, VBr₄.2H₂O, VBr₄.3H₂O, VBr₄.4H₂O, VBr₄.5H₂O, VCl₂.6H₂O, VCl₂.7H₂O, VCl₂.8H₂O, VCl₂.9H₂O, VCl₃.H₂O, VCl₃.7H₂O, VCl₃.H₂O, VCl₃. 10H₂O, VCl₄.2H₂O, VCl₄.3H₂O, VCl₄.5H₂O, VF₂.2H₂O, VF₂.6H₂O, VF₂.7H₂O, VF₂.8H₂O, VF₂.9H₂O, VF₃.4H₂O, VF₃.6H₂O, VF₄.H₂O, VF₄.3H₂O, VF₄.4H₂O, VI₂.H₂O,VI₂.2H₂O, VI₂.7H₂O, VI₂.8H₂O, VI₂.9H₂O, VI₃.2H₂O, VI₃.H₂O, VI₃.H₂O, VI₃.7H₂O, VI₃.H₂O, VI₃.H₂O, VI₄.2H₂O, VI₄.3H₂O, VI₄.4H₂O, VI₄.5H₂O, VI₄.9H₂O, WBr₄.2H₂O, WBr₄.3H₂O, WBr₄.5H₂O, WBr₄.9H₂O, WCl₄.2H₂O, WCl₄.3H₂O, WCl₄.4H₂O, WCl₄.5H₂O, WCl₄.9H₂O, WF₄.2H₂O, WF₄.3H₂O, WF₄.4H₂O, WI₄.2H₂O, WI₄.3H₂O, WI₄.4H₂O, WI₄.5H₂O, WI₄.9H₂O, YBr₃.H₂O, YBr₃.2H₂O, YBr₃.4H₂O, YBr₃.7H₂O, YCl₃.H₂O, YCl₃.H₂O, YF₃.H₂O, YF₃.2H₂O, YF₃.4H₂O, YF₃.6H₂O, YF₃.7H₂O, YF₃.8H₂O, YF₃.10H₂O, YI₃.2H₂O, YI₃.4H₂O, YI₃.10H₂O, ZnBr₂.7H₂O, ZnBr₂.8H₂O, ZnBr₂.9H₂O, ZnF2.H₂O, ZnF₂.6H₂O, ZnF₂.8H₂O, ZnF₂.9H₂O, ZnI2.H₂O, ZnI₂.9H₂O, ZrBr₂.6H₂O, ZrBr₂.7H₂O, ZrBr₂.8H₂O, ZrBr₂.9H₂O, ZrBr₃.2H₂O, ZrBr₃.3H₂O, ZrBr₃.4H₂O, ZrBr₃.6H₂O, ZrBr₃.7H₂O, ZrBr₃.8H₂O, ZrBr₃.10H₂O, ZrBr₄.5H₂O, ZrBr₄.9H₂O, ZrB r4. 10H₂O, ZrCl₂.9H₂O, ZrCl₃.H₂O, ZrCl₃.2H₂O, ZrCl₃. 3 H₂O, ZrCl₃.H₂O, ZrCl₃.6H₂O, ZrCl₃.7H₂O, ZrCl₃.H₂O, ZrCl₃.H₂O, ZrCl₄.9H₂O, ZrCl₄.10H₂O, ZrF₃.6H₂O, ZrF₃.7H₂O, ZrF₃.8H₂O, ZrF₃.10H₂O, ZrF₄.2H₂O, ZrF₄.5H₂O, ZrF₄.9H₂O, ZrI₂.12H₂O, ZrI₃.H₂O, ZrI₃.H₂O, ZrI₃.6H₂O, ZrI₃.7H₂O, ZrI₃.H₂O, ZrI₃.H₂O, ZrI₄.3H₂O, ZrI₄.4H₂O, ZrI₄.5H₂O, ZrI₄.9H₂O, Zr4.10H₂O, and combinations thereof. In one aspect, M is selected from the group consisting of: lithium (Li), sodium (Na), potassium (K), rubidium (Rb), cesium (Cs), beryllium (Be), magnesium (Mg), calcium (Ca), strontium (Sr), barium (Ba), scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), iron (Fe), cobalt (Co), nickel (Ni), copper (Cu), zinc (Zn), aluminum (Al), gallium (Ga), silicon (Si), germanium (Ge), tin (Sn), lead (Pb)), lanthanum (La), and combinations thereof and X is selected from the group consisting of: fluorine (F), chlorine (Cl), bromine (Br), iodine (I), and combinations thereof.

In one aspect, M is selected from the group consisting of lithium (Li), sodium (Na), beryllium (Be), magnesium (Mg), and aluminum (Al). Further, X is a halide selected from the group consisting of: fluorine (F), chlorine (Cl) and bromine (Br).

In one aspect, X comprises fluorine (F), so that the metal hydrate is represented by the formula: MF_{q}.nH₂O.

In one aspect, the salt hydrate is selected from the group consisting of: AlBr₃.H₂O, BaBr₂.12H₂O, BaF₂.2H₂O, BaF₂.12H₂O, BaI₂.12H₂O, BeBr₂.9H₂O, BeCl₂.12H₂O, BeF₂.9H₂O, BeI₂.2H₂O, BeI₂.8H₂O, BeI₂.12H₂O, CaBr₂.12H₂O, CaI₂.2H₂O, CaI₂.12H₂O, CoBr₂.12H₂O, CoBr₃.9H₂O, CoCl₂.12H₂O, CoCl₃.9H₂O, CoF₂.12H₂O, CoF₃.9H₂O, CoI₂.12H₂O, CrBr₂.4H₂O, CrBr₂.12H₂O, CrBr₄.8H₂O, CrCl₂.12H₂O, CrCl₄.8H₂O, CrF₂.4H₂O, CrF₂.12H₂O, CrF₄.5H₂O, CrF₄.8H₂O, CrI₂.4H₂O, CrI₂.12H₂O, CrI₃.9H₂O, CrI₄.3H₂O, CrI₄.H₂O, CuBr₂.12H₂O, CuF.H₂O, CuF.2H₂O, CuF₂.4H₂O, CuF₂.12H₂O, CuI₂.4H₂O, FeBr₃.H₂O, FeBr₃.9H₂O, FeF₂.12H₂O, FeF₃.9H₂O, FeI₃.2H₂O, FeI₃.H₂O, GaBr₃.2H₂O, GaBr₃.9H₂O, GaF₃.9H₂O, GaI₃.H₂O, GaI₃.9H₂O, GeBr₂.4H₂O, GeBr₂.12H₂O, GeCl₂.2H₂O, GeCl₂.4H₂O, GeCl₂.12H₂O, GeCl₄.8H₂O, GeF₂.2H₂O, GeF₂.4H₂O, GeF₂.12H₂O, GeF₄.5H₂O, GeF₄.8H₂O, GeI₂.4H₂O, GeI₂.12H₂O, GeI₄.H₂O, HfBr₃.9H₂O, HfBr₄.2H₂O, HfBr₄.3H₂O, HfBr₄.4H₂O, HfBr₄.8H₂O, HfCl₃.9H₂O, HfCl₄.2H₂O, HfCl₄.3H₂O, HfCl₄.4H₂O, HfF₄.8H₂O, HfI₃.9H₂O, HfI₄.2H₂O, HfI₄.H₂O, LaF₃.9H₂O, LaI₂.12H₂O, LiF.4H₂O, MgBr₂.12H₂O, MgF₂.12H₂O, MgI₂.4H₂O, MgI₂.12H₂O, MnBr₂.12H₂O, MnBr₃.6H₂O, MnBr₄.8H₂O, MnCl₃.9H₂O, MnCl₄.8H₂O, MnF₂.12H₂O, MnF₃.9H₂O, MnF₄.2H₂O, MnF₄.4H₂O, MnF₄.5H₂O, MnF₄.8H₂O, MnI₂.12H₂O, MnI₃.6H₂O, MnI₄.H₂O, MoBr₃.9H₂O, MoBr₄.8H₂O, MoCl₃.2H₂O, MoCl₃.9H₂O, MoCl₄.4H₂O, MoCl₄.8H₂O, MoF₂.H₂O, MoF₃.3H₂O, MoF₃.9H₂O, MoF₄.2H₂O, MoF₄.5H₂O, MoF₄.8H₂O, MoI₃.9H₂O, MoI₄.H₂O, NaBr.H₂O, NaBr₄H₂O, NaF.4H₂O, NbBr₃.6H₂O, NbBr₃.9H₂O, NbBr₄.8H₂O, NbCl₃.9H₂O, NbCl₄.8H₂O, NbF₃.H₂O, NbF₃.9H₂O, NbF₄.5H₂O, NbF₄.8H₂O, NbI₃.6H₂O, NbI₃.9H₂O, NbI₄.8H₂O, NiBr₂.12H₂O, NiBr₃.6H₂O, NiCl₃.9H₂O, NiF₂.12H₂O, NiF₃.2H₂O, NiF₃.9H₂O, NiI₂.12H₂O, PbBr₂.2H₂O, PbBr₂.4H₂O, PbBr₂.12H₂O, PbBr₄.8H₂O, PbCl₂.12H₂O, PbCl₄.3H₂O, PbCl₄.8H₂O, PbF₂.2H₂O, PbF₂.12H₂O, PbF₄.2H₂O, PbF₄.3H₂O, PbF₄.5H₂O, PbI₂.4H₂O, PbI₂.12H₂O, PbI₄.5H₂O, RbBr₄H₂O, RbCl_{.4}H₂O, RbI_{.4}H₂O, ScBr₃.9H₂O, ScF₃.3H₂O, ScF₃.9H₂O, ScI₃.6H₂O, ScI₃.9H₂O, SiBr₂.8H₂O, SiBr₄.8H₂O, SiBr₄.9H₂O, SiCl₂.8H₂O, SiCl₄.8H₂O, SiCl₄.9H₂O, SiF₄.5H₂O, SiF₄.8H₂O, SiI₂.8H₂O, SiI₄.9H₂O, SnBr₂.4H₂O, SnBr₂.12H₂O, SnCl₂.12H₂O, SnF₂.4H₂O, SnF₂.12H₂O, SnF₄.2H₂O, SnF₄.5H₂O, SnF₄.8H₂O, SnI₂.4H₂O, SnI₂.12H₂O, SnI₄.H₂O, SnI₄.2H₂O, SnI₄.3H₂O, SrBr₂.12H₂O, SrCl₂.12H₂O, SrF₂.2H₂O, SrF₂.12H₂O, SrI₂.12H₂O, TaBr₃.6H₂O, TaBr₃.9H₂O, TaBr₄.8H₂O, TaCl₃.9H₂O, TaCl₄.8H₂O, TaF₃.H₂O, TaF₄.5H₂O, TaF₄.8H₂O, TaI₃.6H₂O, TaI₄.8H₂O, TiBr₂.H₂O, TiBr₂.12H₂O, TiBr₃.9H₂O, TiBr₄.8H₂O, TiCl₂.12H₂O, TiCl₃.H₂O, TiF₂.H₂O, TiF₂.12H₂O, TiF₃.3H₂O, TiF₃.9H₂O, TiF₄.5H₂O, TiF₄.8H₂O, TiI₂.12H₂O, TiI₃.9H₂O, TiI₄.8H₂O, VBr₂.12H₂O, VBr₃.9H₂O, VBr₄.8H₂O, VCl₂.H₂O, VCl₂.12H₂O, VCl₃.9H₂O, VCl₄.8H₂O, VF₂.12H₂O, VF₃.9H₂O, VF₄.2H₂O, VF₄.5H₂O, VF₄.8H₂O, VI₂.12H₂O, VI₃.9H₂O, VI₄.8H₂O, WBr₄.8H₂O, WCl₄.8H₂O, WF₄.5H₂O, WF₄.8H₂O, WI₄.8H₂O, YF₃.9H₂O, YI₃.7H₂O, YI₃.9H₂O, ZnBr₂.12H₂O, ZnCl₂.12H₂O, ZnF₂.12H₂O, ZnI₁₂.12H₂O, ZrBr₂.H₂O, ZrBr₂.12H₂O, ZrBr₃.9H₂O, ZrBr₄.2H₂O, ZrBr₄.3H₂O, ZrBr₄.4H₂O, ZrBr₄.8H₂O, ZrCl₂.H₂O, ZrCl₂.12H₂O, ZrCl₃.9H₂O, ZrF₃.9H₂O, ZrF₄.8H₂O, ZrI₃.9H₂O, ZrI₄.2H₂O, ZrI₄.8H₂O, and combinations thereof. In one aspect, the salt hydrate is selected from the group consisting of: A1Br₃.4H₂O, A1Br₃.7H₂O, A1Br₃.8H₂O, AlBr₃.10H₂O, AlCl₃.H₂O, AlCl₃.H₂O, AlCl₃.H₂O, A1F₃.8H₂O, A1F₃.10H₂O, AlI₃.H₂O, AlI₃.2H₂O, AlI₃.3H₂O, AlI₃.4H₂O, AlI₃.7H₂O, AlI₃.8H₂O, AlI₃.10H₂O, BaBr₂.6H₂O, BaBr₂.7H₂O, BaBr₂.8H₂O, BaBr₂.9H₂O, BaF₂.H₂O, BaF₂.4H₂O, BaF₂.6H₂O, BaF₂.7H₂O, BaF₂.8H₂O, BaF₂.9H₂O, BaI₂.8H₂O, BaI₂.9H₂O, BeBr₂.H₂O, BeBr₂.2H₂O, BeBr₂.8H₂O, BeBr₂.12H₂O, BeCl₂.7H₂O, BeCl₂.8H₂O, BeCl₂.9H₂O, BeF₂.7H₂O, BeF₂.8H₂O, BeF₂.12H₂O, BeI₂.7H₂O, BeI₂.9H₂O, CaBr₂.7H₂O, CaBr₂.8H₂O, CaI₂.9H₂O, CoBr₂.8H₂O, CoBr₂.9H₂O, CoBr₃.H₂O, CoBr₃.3H₂O, CoBr₃.4H₂O, CoBr₃.7H₂O, CoBr₃.10H₂O, CoCl₃.H₂O, CoCl₃.H₂O, CoF₂.8H₂O, CoF₂.9H₂O, CoF₃.6H₂O, CoF₃.7H₂O, CoF₃.8H₂O, CoF₃.10H₂O, CoI₂.8H₂O, CoI₂.9H₂O, CoI₃.H₂O, CoI₃.6H₂O, CoI₃.7H₂O, CoI₃.9H₂O, CoI₃.H₂O, CrBr₂.H₂O, CrBr₂.2H₂O, CrBr₂.7H₂O, CrBr₂.8H₂O, CrBr₂.9H₂O, CrBr₃.H₂O, CrBr₃.2H₂O, CrBr₃.3H₂O, CrBr₃.7H₂O, CrBr₃.10H₂O, CrBr₄.2H₂O, CrBr₄.3H₂O, CrBr₄.4H₂O, CrBr₄.5H₂O, CrBr₄.9H₂O, CrCl₂.H₂O, CrCl₂.7H₂O, CrCl₂.8H₂O, CrCl₂.9H₂O, CrCl₃.H₂O, CrCl₄.2H₂O, CrCl₄.3H₂O, CrCl₄.4H₂O, CrCl₄.5H₂O, CrF2.H₂O, CrF₂.6H₂O, CrF₂.7H₂O, CrF₂.8H₂O, CrF₂.9H₂O, CrF₄.3H₂O, CrF₄.4H₂O, CrI₂.H₂O, CrI₂.2H₂O, CrI₂.6H₂O, CrI₂.7H₂O, CrI₂.8H₂O, CrI₂.9H₂O, CrI₃.H₂O, CrI₃.2H₂O, CrI₃.H₂O, CrI₃.7H₂O, CrI₃.8H₂O, CrI₃.10H₂O, CrI₄.2H₂O, CrI₄.4H₂O, CrI₄.5H₂O, CrI₄.9H₂O, CuBr₃H₂O, CuBr₂.7H₂O, CuBr₂.8H₂O, CuBr₂.9H₂O, CuCl₂.8H₂O, CuCl₂.9H₂O, CuF.3H₂O, CuF.4H₂O, CuF₂.6H₂O, CuF₂.8H₂O, CuF₂.9H₂O, CuI₂.6H₂O, CuI₂.8H₂O, CuI₂.9H₂O, CuI₂.12H₂O, FeBr₂.8H₂O, FeBr₂.12H₂O, FeBr₃.3H₂O, FeBr₃.4H₂O, FeBr₃.7H₂O, FeBr₃.8H₂O, FeBr₃.10H₂O, FeCl₂.8H₂O, FeF2.H₂O, FeF₂.2H₂O, FeF₂.6H₂O, FeF₂.9H₂O, FeF₃.2H₂O, FeF₃.4H₂O, FeF₃.6H₂O, FeF₃.7H₂O, FeF₃.8H₂O, FeF₃.10H₂O, FeI₂.7H₂O, FeI₂.8H₂O, FeI₂.12H₂O, FeI₃.H₂O, FeI₃.H₂O, FeI₃.7H₂O, FeI₃.H₂O, FeI₃.9H₂O, GaBr₃.H₂O, GaBr₃.4H₂O, GaBr₃.6H₂O, GaBr₃.7H₂O, GaBr₃.8H₂O, GaBr₃.10H₂O, GaCl₃.2H₂O, GaCl₃.H₂O, GaCl₃.H₂O, GaCl₃.7H₂O, GaCl₃.H₂O, GaCl₃.H₂O, GaF₃.4H₂O, GaF₃.6H₂O, GaF₃.7H₂O, GaF₃.10H₂O, GaI₃.H₂O, GaI₃.H₂O, GaI₃.6H₂O, GaI₃.7H₂O, GaI₃.H₂O, GeBr₂.H₂O, GeBr₂.2H₂O, GeBr₂.6H₂O, GeBr₂.7H₂O, GeBr₂.8H₂O, GeBr₂.9H₂O, GeBr₄.3H₂O, GeBr₄.4H₂O, GeBr₄.5H₂O, GeBr₄.9H₂O, GeCl₂.H₂O, GeCl₂.6H₂O, GeCl₂.7H₂O, GeCl₂.8H₂O, GeCl₂.9H₂O, GeCl₄.3H₂O, GeCl₄.4H₂O, GeCl₄.9H₂O, GeF₂.6H₂O, GeF₂.7H₂O, GeF₂.8H₂O, GeF₂.9H₂O, GeF₄.H₂O, GeF₄.4H₂O, GeF₄.9H₂O, GeI₂.H₂O, GeI₂.2H₂O, GeI₂.6H₂O, GeI₂.7H₂O, GeI₂.8H₂O, GeI₂.9H₂O, GeI₄.3H₂O, GeI₄.4H₂O, GeI₄.5H₂O, GeI₄.9H₂O, HfBr₃.6H₂O, HfBr₃.7H₂O, HfBr₃.8H₂O, HfBr₃.10H₂O, HfBr₄.5H₂O, HfBr₄.9H₂O, HfBr₄.10H₂O, HfCl₃.H₂O, HfCl₃.6H₂O, HfCl₃.7H₂O, HfCl₃.H₂O, HfCl₃.H₂O, HfCl₄.9H₂O, HfCl₄.10H₂O, HfF₃.9H₂O, HfF₃.10H₂O, HfF₄.4H₂O, HfF₄.5H₂O, HfF₄.9H₂O, HfI₃.6H₂O, HfI₃.7H₂O, HfI₃.H₂O, HfI₃.H₂O, HfI₄.3H₂O, HfI₄.4H₂O, HfI₄.5H₂O, HfI₄.9H₂O, HfI₄.10H₂O, LaBr₂.9H₂O, LaBr₂.12H₂O, LaBr₃.2H₂O, LaBr₃.10H₂O, LaCl_{.3}H₂O, LaCl_{.4}H₂O, LaCl₂.12H₂O, LaF₂.12H₂O, LaF₃.H₂O, LaF₃.4H₂O, LaF₃.7H₂O, LaF₃.8H₂O, LaF₃.10H₂O, LaI.4H₂O, LaI₂.7H₂O, LaI₂.8H₂O, LaI₂.9H₂O, LaI₃.H₂O, LaI₃.2H₂O, LaI₃.3H₂O, LaI₃.H₂O, LaI₃.7H₂O, LaI₃.H₂O, LaI₃.H₂O, LiF.3H₂O, MgBr₂.7H₂O, MgF₂.6H₂O, MgF₂.8H₂O, MgI2.H₂O, MnBr₂.7H₂O, MnBr₂.8H₂O, MnBr₂.9H₂O, MnBr₃.H₂O, MnBr₃.2H₂O, MnBr₃.3H₂O, MnBr₃.4H₂O, MnBr₃.7H₂O, MnBr₃.8H₂O, MnBr₃.9H₂O, MnBr₃.10H₂O, MnBr₄.2H₂O, MnBr₄.3H₂O, MnBr₄.5H₂O, MnBr₄.9H₂O, MnCl₃.H₂O, MnCl₃.H₂O, MnCl₃.7H₂O, MnCl₃.H₂O, MnCl₄.2H₂O, MnCl₄.3H₂O, MnCl₄.5H₂O, MnCl₄.9H₂O, MnF₂.6H₂O, MnF₂.8H₂O, MnF₂.9H₂O, MnF₃.4H₂O, MnF₃.6H₂O, MnF₃.7H₂O, MnF₄.H₂O, MnF₄.3H₂O, MnF₄.9H₂O, MnI₂.7H₂O, MnI₂.8H₂O, MnI₂.9H₂O, MnI₃.H₂O, MnI₃.2H₂O, MnI₃.3H₂O, MnI₃.H₂O, MnI₃.7H₂O, MnI₃.8H₂O, MnI₃.9H₂O, MnI₃.10H₂O, MnI₄.2H₂O, MnI₄.3H₂O, MnI₄.4H₂O, MnI₄.5H₂O, MoBr₂.12H₂O, MoBr₃.3H₂O, MoBr₃.4H₂O, MoBr₃.6H₂O, MoBr₃.7H₂O, MoBr₃.8H₂O, MoBr₃.10H₂O, MoBr₄.2H₂O, MoBr₄.3H₂O, MoBr₄.4H₂O, MoBr₄.5H₂O, MoBr₄.9H₂O, MoCl₂.12H₂O, MoCl₃.H₂O, MoCl₃.7H₂O, MoCl₃.H₂O, MoCl₃.H₂O, MoCl₄.H₂O, MoCl₄.3H₂O, MoCl₄.5H₂O, MoF₂.8H₂O, MoF₂.9H₂O, MoF₂.12H₂O, MoF₃.H₂O, MoF₃.2H₂O, MoF₃.4H₂O, MoF₃.6H₂O, MoF₃.7H₂O, MoF₃.8H₂O, MoF₃.10H₂O, MoF₄.3H₂O, MoF₄.4H₂O, MoF₄.9H₂O, MoI₂.12H₂O,₂O, MoI₃.3H₂O, MoI₃.4H₂O, MoI₃.6H₂O, MoI₃.7H₂O, MoI₃.H₂O, MoI₃.10H₂O, MoI₄.2H₂O, MoI₄.3H₂O, MoI₄.4H₂O, MoI₄.5H₂O, MoI₄.9H₂O, NaBr₃H₂O, NaF.H₂O, NaF.2H₂O, NaF.3H₂O, NbBr₃.2H₂O, NbBr₃.3H₂O, NbBr₃.4H₂O, NbBr₃.7H₂O, NbBr₃.8H₂O, NbBr₃.10H₂O, NbBr₄.2H₂O, NbBr₄.3H₂O, NbBr₄.4H₂O, NbBr₄.5H₂O, NbBr₄.9H₂O, NbCl₃.1420, NbCl₃.H₂O, NbCl₃.H₂O, NbCl₃.6H₂O, NbCl₃.7H₂O, NbCl₃.H₂O, NbCl₃.H₂O, NbCl₄.2H₂O, NbCl₄.3H₂O, NbCl₄.4H₂O, NbCl₄.5H₂O, NbCl₄.9H₂O, NbF₃.2H₂O, NbF₃.3H₂O, NbF₃.4H₂O, NbF₃.6H₂O, NbF₃.7H₂O, NbF₃.8H₂O, NbF₃.10H₂O, NbF₄.H₂O, NbF₄.2H₂O, NbF₄.3H₂O, NbF₄.4H₂O, NbF₄.9H₂O, NbI₃.2H₂O, NbI₃.H₂O, NbI₃.H₂O, NbI₃.7H₂O, NbI₃.H₂O, NbI₃.H₂O, NbI₄.2H₂O, NbI₄.3H₂O, NbI₄.4H₂O, NbI₄.5H₂O, NbI₄.9H₂O, NbI4.10H₂O, NiBr₂.7H₂O, NiBr₂.8H₂O, NiBr₃.H₂O, NiBr₃.2H₂O, NiBr₃.3H₂O, NiBr₃.4H₂O, NiBr₃.7H₂O, NiBr₃.8H₂O, NiBr₃.9H₂O, NiBr₃.10H₂O, NiCl₃.1420, NiCl₃.H₂O, NiCl₃.H₂O, NiCl₃.H₂O, NiF2.H₂O, NiF₂.7H₂O, NiF₂.8H₂O, NiF₂.9H₂O, NiF₃.6H₂O, NiF₃.10H₂O, NiI₂.H₂O, NiI₂.2H₂O, NiI₂.7H₂O, NiI₂.8H₂O, NiI₂.9H₂O, NiI₃.2H₂O, NiI₃.3H₂O, NiI₃.6H₂O, NiI₃.7H₂O, NiI₃.8H₂O, NiI₃.9H₂O, NiI₃.H₂O, PbBr₂.6H₂O, PbBr₂.7H₂O, PbBr₂.8H₂O, PbBr₂.9H₂O, PbBr₄.3H₂O, PbBr₄.4H₂O, PbBr₄.5H₂O, PbBr₄.9H₂O, PbCl₂.1420, PbCl₂.7H₂O, PbCl₂.8H₂O, PbCl₂.9H₂O, PbCl₄.2H₂O, PbCl₄.4H₂O, PbCl₄.5H₂O, PbF₂.4H₂O, PbF₂.6H₂O, PbF₂.7H₂O, PbF₂.8H₂O, PbF₂.9H₂O, PbF₄.H₂O, PbF₄.4H₂O, PbI₂.H₂O, PbI₂.6H₂O, PbI₂.7H₂O, PbI₂.8H₂O, PbI₂.9H₂O, PbI₄.H₂O, PbI₄.3H₂O, PbI₄.4H₂O, PbI₄.H₂O, PbI₄.9H₂O, RbBr.H₂O, RbBr₂H₂O, RbBr₃H₂O, RbCl.H₂O, RbCl_{.2}H₂O, RbCl_{.3}H₂O, RbIH₂O, RbI2H₂O, RbI3H₂O, ScBr₃.2H₂O, ScBr₃.8H₂O, ScBr₃.10H₂O, ScCl₃.H₂O, ScCl₃.H₂O, ScF₃.2H₂O, ScF₃.4H₂O, ScF₃.7H₂O, ScF₃.8H₂O, ScF₃.10H₂O, ScI₃.H₂O, ScI₃.H₂O, ScI₃.H₂O, ScI₃.7H₂O, ScI₃.10H₂O, SiBr₂.4H₂O, SiBr₂.9H₂O, SiBr₂.12H₂O, SiBr₄.3H₂O, SiBr₄.4H₂O, SiBr₄.5H₂O, SiCl₂.4H₂O, SiCl₂.7H₂O, SiCl₂.9H₂O, SiCl₂.12H₂O, SiCl₄.3H₂O, SiCl₄.4H₂O, SiCl₄.5H₂O, SiF₂.2H₂O, SiF₂.8H₂O, SiF₄.3H₂O, SiF₄.4H₂O, SiF₄.9H₂O, SiI₂.4H₂O, SiI₂.6H₂O, SiI₂.9H₂O, SiI₂.12H₂O, SiI₄.H₂O, SnBr₂.6H₂O, SnBr₂.8H₂O, SnBr₂.9H₂O, SnBr₄.2H₂O, SnBr₄.3H₂O, SnBr₄.9H₂O, SnCl₂.8H₂O, SnF₂.6H₂O, SnF₂.7H₂O, SnF₂.8H₂O, SnF₂.9H₂O, SnF₄.H₂O, SnF₄.3H₂O, SnF₄.4H₂O, SnF₄.9H₂O, SnI₂.H₂O, SnI₂.6H₂O, SnI₂.7H₂O, SnI₂.8H₂O, SnI₂.9H₂O, SnI₄.4H₂O, SnI₄.9H₂O, SrBr₂.4H₂O, SrBr₂.7H₂O, SrBr₂.8H₂O, SrBr₂.9H₂O, SrCl₂.8H₂O, SrF₂.4H₂O, SrF₂.6H₂O, SrF₂.8H₂O, SrF₂.9H₂O, SrI₂.4H₂O, SrI₂.8H₂O, SrI₂.9H₂O, TaBr₃.H₂O, TaBr₃.2H₂O, TaBr₃.3H₂O, TaBr₃.4H₂O, TaBr₃.7H₂O, TaBr₃.8H₂O, TaBr₃.10H₂O, TaBr₄.2H₂O, TaBr₄.3H₂O, TaBr₄.4H₂O, TaBr₄.5H₂O, TaBr₄.9H₂O, TaCl₃.2H₂O, TaCl₃.H₂O, TaCl₃.H₂O, TaCl₃.6H₂O, TaCl₃.7H₂O, TaCl₃.H₂O, TaCl₃.H₂O, TaCl₄.2H₂O, TaCl₄.3H₂O, TaCl₄.4H₂O, TaCl₄.5H₂O, TaCl₄.9H₂O, TaF₃.9H₂O, TaF₃.10H₂O, TaF₄.2H₂O, TaF₄.3H₂O, TaF₄.4H₂O, TaF₄.9H₂O, TaI₃.H₂O, TaI₃.H₂O, TaI₃.7H₂O, TaI₃.H₂O, TaI₃.9H₂O, TaI₃.10H₂O, TaI₄.2H₂O, TaI₄.3H₂O, TaI₄.4H₂O, TaI₄.5H₂O, TaI₄.9H₂O, TaI₄.10H₂O, TiBr₂.2H₂O, TiBr₂.4H₂O, TiBr₂.7H₂O, TiBr₂.8H₂O, TiBr₂.9H₂O, TiBr₃.H₂O, TiBr₃.2H₂O, TiBr₃.3H₂O, TiBr₃.4H₂O, TiBr₃.7H₂O, TiBr₃.8H₂O, TiBr₃.10H₂O, TiBr₄.2H₂O, TiBr₄.3H₂O, TiBr₄.4H₂O, TiBr₄.5H₂O, TiBr₄.9H₂O, TiCl₂.4H₂O, TiCl₂.7H₂O, TiCl₂.8H₂O, TiCl₂.9H₂O, TiCl₃.H₂O,TiCl₃.2H₂O, TiCl₃.7H₂O, TiCl₃.H₂O, TiCl₃.H₂O, TiCl₄.3H₂O, TiCl₄.4H₂O, TiCl₄.9H₂O, TiF₂.4H₂O, TiF₂.6H₂O, TiF₂.8H₂O, TiF₂.9H₂O, TiF₃.2H₂O, TiF₃.6H₂O, TiF₃.7H₂O, TiF₃.8H₂O, TiF₄.3H₂O, TiF₄.9H₂O, TiI₂.H₂O, TiI₂.2H₂O, TiI₂.4H₂O, TiI₂.6H₂O, TiI₂.7H₂O, TiI₂.8H₂O, TiI₂.9H₂O, TiI₃.2H₂O, TiI₃.3H₂O, TiI₃.4H₂O, TiI₃.7H₂O, TiI₃.8H₂O, TiI₃.H₂O, TiI₄.2H₂O, TiI₄.3H₂O, TiI₄.4H₂O, TiI₄.5H₂O, TiI₄.9H₂O, VBr₂.H₂O, VBr₂.7H₂O, VBr₂.8H₂O, VBr₂.9H₂O, VBr₃.H₂O, VBr₃.2H₂O, VBr₃.3H₂O, VBr₃.7H₂O, VBr₃.8H₂O, VBr₄.2H₂O, VBr₄.3H₂O, VBr₄.4H₂O, VBr₄.5H₂O, VCl₂.6H₂O, VCl₂.7H₂O, VCl₂.8H₂O, VCl₂.9H₂O, VCl₃.H₂O, VCl₃.7H₂O, VCl₃.H₂O, VCl₃.H₂O, VCl₄.2H₂O, VCl₄.3H₂O, VCl₄.5H₂O, VF₂.2H₂O, VF₂.6H₂O, VF₂.7H₂O, VF₂.8H₂O, VF₂.9H₂O, VF₃.4H₂O, VF₃.6H₂O, VF₄.H₂O, VF₄.3H₂O, VF₄.4H₂O, VI₂.H₂O, VI₂.2H₂O, VI₂.7H₂O, VI₂.8H₂O, VI₂.9H₂O, VI₃.2H₂O, VI₃.H₂O, VI₃.H₂O, VI₃.7H₂O, VI₃.H₂O, VI₃.H₂O, VI₄.2H₂O, VI₄.3H₂O, VI₄.4H₂O, VI₄.5H₂O, VI₄.9H₂O, WBr₄.2H₂O, WBr₄.3H₂O, WBr₄.5H₂O, WBr₄.9H₂O, WCl₄.2H₂O, WCl₄.3H₂O, WCl₄.4H₂O, WCl₄.5H₂O, WCl₄.9H₂O, WF₄.2H₂O, WF₄.3H₂O, WF₄.4H₂O, WI₄.2H₂O, WI₄.3H₂O, WI₄.4H₂O, WI₄.5H₂O, WI₄.9H₂O, YBr₃.H₂O, YBr₃.2H₂O, YBr₃.4H₂O, YBr₃.7H₂O, YCl₃.H₂O, YCl₃.H₂O, YF₃.H₂O, YF₃.2H₂O, YF₃.4H₂O, YF₃.6H₂O, YF₃.7H₂O, YF₃.8H₂O, YF₃.10H₂O, YI₃.2H₂O, YI₃.4H₂O, YI₃.10H₂O, ZnBr₂.7H₂O, ZnBr₂.8H₂O, ZnBr₂.9H₂O, ZnF2.H₂O, ZnF₂.6H₂O, ZnF₂.8H₂O, ZnF₂.9H₂O, ZnI2.H₂O, ZnI₂.9H₂O, ZrBr₂.6H₂O, ZrBr₂.7H₂O, ZrBr₂.8H₂O, ZrBr₂.9H₂O, ZrBr₃.2H₂O, ZrBr₃.3H₂O, ZrBr₃.4H₂O, ZrBr₃.6H₂O, ZrBr₃.7H₂O, ZrBr₃.8H₂O, ZrBr₃.10H₂O, ZrBr₄.5H₂O, ZrBr₄.9H₂O, ZrBr₄.10H₂O, ZrCl₂.9H₂O, ZrCl₃.H₂O, ZrCl₃.2H₂O, ZrCl₃.H₂O, ZrCl₃.H₂O, ZrCl₃.6H₂O, ZrCl₃.7H₂O, ZrCl₃.H₂O, ZrCl₃.H₂O, ZrCl₄.9H₂O, ZrCl₄.10H₂O, ZrF₃.6H₂O, ZrF₃.7H₂O, ZrF₃.8H₂O, ZrF₃.10H₂O, ZrF₄.2H₂O, ZrF₄.5H₂O, ZrF₄.9H₂O, ZrI₂.12H₂O, ZrI₃.H₂O, ZrI₃.H₂O, ZrI₃.6H₂O, ZrI₃.7H₂O, ZrI₃.H₂O, ZrI₃.H₂O, ZrI₄.3H₂O, Zr4.4H₂O, ZrI₄.5H₂O, ZrI₄.9H₂O, ZrI₄.10H₂O, and combinations thereof.

In one aspect, the salt hydrate comprises a plurality of cations (M) including a first cation and a second cation. A minimum distance between the first cation and the second cation is greater than or equal to about 4.1 A.

In one aspect, a temperature hysteresis of a dehydration reaction and a hydration reaction of the salt hydrate is less than or equal to about 50° C.

In one aspect, the salt hydrate has a volumetric energy density of greater than or equal to about 1.3 GJ/m³.

In one aspect, the salt hydrate is selected from the group consisting of: LiF.4H₂O, TiF₂.12H₂O, MgF₂.12H₂O, MnF₂.12H₂O, SiF₄.5H₂O, CuF.H₂O, TiF₂.H₂O, and combinations thereof.

In certain other aspects, the present disclosure relates to a thermal energy system (TES) comprising: a thermal energy storage material comprising a salt hydrate that is represented by the formula: MX_{q}.nH₂O, where M is a cation selected from Groups 1.14 of the IUPAC Periodic Table, X is a halide of Group 17 of the IUPAC Periodic Table, q ranges from 1 to 4, and n ranges from 1 to 12. The salt hydrate is optionally selected from the group consisting of: AlBr₃.H₂O, AlBr₃.9H₂O, AlCl₃.H₂O, AlCl₃.9H₂O, A1F₃.9H₂O, AlI₃.6H₂O, AlI₃.9H₂O, BaBr₂.12H₂O, BaCl₂.12H₂O, BaF₂.2H₂O, BaF₂.12H₂O, BaI₂.12H₂O, BeBr₂.4H₂O, BeBr₂.9H₂O, BeCl₂.2H₂O, BeCl₂.4H₂O, BeCl₂.12H₂O, BeF₂.2H₂O, BeF₂.4H₂O, BeF₂.9H₂O, BeI₂.2H₂O, BeI₂.4H₂O, BeI₂.8H₂O, BeI₂.12H₂O, CaBr₂.H₂O, CaBr₂.2H₂O, CaBr₂.12H₂O, CaCl₂.12H₂O, CaF₂.12H₂O, CaI₂.2H₂O, CaI₂.12H₂O, CoBr₂.12H₂O, CoBr₃.6H₂O, CoBr₃.9H₂O, CoCl₂.12H₂O, CoCl₃.6H₂O, CoCl₃.9H₂O, CoF₂.4H₂O, CoF₂.12H₂O, CoF₃.3H₂O, CoF₃.9H₂O, CoI₂.12H₂O, CrBr₂.4H₂O, CrBr₂.12H₂O, CrBr₃.9H₂O, CrBr₄.8H₂O, CrCl₂.12H₂O, CrCl₃.9H₂O, CrCl₄.8H₂O, CrF₂.4H₂O, CrF₂.12H₂O, CrF₃.3H₂O, CrF₃.9H₂O, CrF₄.2H₂O, CrF₄.5H₂O, CrF₄.8H₂O, CrI₂.4H₂O, CrI₂.12H₂O, CrI₃.9H₂O, CrI₄.3H₂O, CrI₄.H₂O, CsF.2H₂O, CsI.4H₂O, CuBr₂.12H₂O, CuCl₂.4H₂O, CuCl₂.12H₂O, CuF.H₂O, CuF.2H₂O, CuF₂.4H₂O, CuF₂.12H₂O, CuI₂.4H₂O, FeBr₃.H₂O, FeBr₃.9H₂O, FeCl₂.9H₂O, FeCl₃.H₂O, FeCl₃.H₂O, FeCl₃.9H₂O, FeF₂.12H₂O, FeF₃.H₂O, FeF₃.9H₂O, FeI₃.2H₂O, FeI₃.H₂O, GaBr₃.2H₂O, GaBr₃.9H₂O, GaCl₃.H₂O, GaCl₃.9H₂O, GaF₃.9H₂O, GaI₃.H₂O, GaI₃.9H₂O, GeBr₂.4H₂O, GeBr₂.12H₂O, GeCl₂.2H₂O, GeCl₂.4H₂O, GeCl₂.12H₂O, GeCl₄.8H₂O, GeF₂.2H₂O, GeF₂.4H₂O, GeF₂.12H₂O, GeF₄.2H₂O, GeF₄.5H₂O, GeF₄.8H₂O, GeI₂.4H₂O, GeI₂.12H₂O, GeI₄.H₂O, HfBr₃.9H₂O, HfBr₄.2H₂O, HfBr₄.3H₂O, HfBr₄.4H₂O, HfBr₄.8H₂O, HfCl₃.9H₂O, HfCl₄.2H₂O, HfCl₄.3H₂O, HfCl₄.4H₂O, HfCl₄.8H₂O, HfF₄.3H₂O, HfF₄.8H₂O, HfI₃.9H₂O, HfI₄.2H₂O, HfI₄.H₂O, KBr₄H₂O, KCl_{.4}H₂O, KI.4H₂O, LaBr₃.6H₂O, LaBr₃.9H₂O, LaCl₃.6H₂O, LaCl₃.9H₂O, LaF₃.9H₂O, LaI₂.12H₂O, LaI₃.6H₂O, LaI₃.9H₂O, LiBr₃H₂O, LiBr₄H₂O, LiCl_{.4}H₂O, LiF.4H₂O, MgBr₂.2H₂O, MgBr₂.12H₂O, MgCl₂.12H₂O, MgF₂.4H₂O, MgF₂.12H₂O, MgI₂.4H₂O, MgI₂.9H₂O, MgI₂.12H₂O, MnBr₂.12H₂O, MnBr₃.6H₂O, MnBr₄.8H₂O, MnCl₂.12H₂O, MnCl₃.6H₂O, MnCl₃.9H₂O, MnCl₄.4H₂O, MnCl₄.8H₂O, MnF₂.12H₂O, MnF₃.3H₂O, MnF₃.9H₂O, MnF₄.2H₂O, MnF₄.4H₂O, MnF₄.5H₂O, MnF₄.8H₂O, MnI₂.12H₂O, MnI₃.6H₂O, MnI₄.H₂O, MoBr₃.9H₂O, MoBr₄.8H₂O, MoCl₃.2H₂O, MoCl₃.9H₂O, MoCl₄.4H₂O, MoCl₄.8H₂O, MoF₂.H₂O, MoF₃.3H₂O, MoF₃.9H₂O, MoF₄.2H₂O, MoF₄.5H₂O, MoF₄.8H₂O, MoI₃.9H₂O, MoI₄.H₂O, NaBr.H₂O, NaBr₄H₂O, NaCl.H₂O, NaCl_{.2}H₂O, NaCl_{.4}H₂O, NaF.4H₂O, NbBr₃.6H₂O, NbBr₃.9H₂O, NbBr₄.8H₂O, NbCl₃.9H₂O, NbCl₄.8H₂O, NbF₃.H₂O, NbF₃.9H₂O, NbF₄.5H₂O, NbF₄.8H₂O, NbI₃.6H₂O, NbI₃.9H₂O, NbI₄.8H₂O, NiBr₂.12H₂O, NiBr₃.6H₂O, NiCl₂.12H₂O, NiCl₃.6H₂O, NiCl₃.9H₂O, NiF₂.2H₂O, NiF₂.12H₂O, NiF₃.2H₂O, NiF₃.3H₂O, NiF₃.9H₂O, NiI₂.12H₂O, PbBr₂.2H₂O, PbBr₂.4H₂O, PbBr₂.12H₂O, PbBr₄.8H₂O, PbCl₂.2H₂O, PbCl₂.4H₂O, PbCl₂.12H₂O, PbCl₄.3H₂O, PbCl₄.8H₂O, PbF₂.2H₂O, PbF₂.12H₂O, PbF₄.2H₂O, PbF₄.3H₂O, PbF₄.5H₂O, PbI₂.4H₂O, PbI₂.12H₂O, PbI₄.5H₂O, RbBr₄H₂O, RbCl_{.4}H₂O, RbF.2H₂O, RbF.4H₂O, RbI_{.4}H₂O, ScBr₃.6H₂O, ScBr₃.9H₂O, ScCl₃.H₂O, ScCl₃.9H₂O, ScF₃.3H₂O, ScF₃.9H₂O, ScI₃.6H₂O, ScI₃.9H₂O, SiBr₂.8H₂O, SiBr₄.8H₂O, SiBr₄.9H₂O, SiCl₂.8H₂O, SiCl₄.8H₂O, SiCl₄.9H₂O, SiF₄.2H₂O, SiF₄.5H₂O, SiF₄.8H₂O, SiI₂.8H₂O, SiI₄.9H₂O, SnBr₂.2H₂O, SnBr₂.4H₂O, SnBr₂.12H₂O, SnBr₄.5H₂O, SnCl₂.4H₂O, SnCl₂.12H₂O, SnCl₄.3H₂O, SnCl₄.4H₂O, SnCl₄.8H₂O, SnF₂.2H₂O, SnF₂.4H₂O, SnF₂.12H₂O, SnF₄.2H₂O, SnF₄.5H₂O, SnF₄.8H₂O, SnI₂.4H₂O, SnI₂.12H₂O, SnI₄.H₂O, SnI₄.2H₂O, SnI₄.3H₂O, SnI₄.5H₂O, SrBr₂.2H₂O, SrBr₂.12H₂O, SrCl₂.12H₂O, SrF₂.2H₂O, SrF₂.12H₂O, SrI₂.12H₂O, TaBr₃.6H₂O, TaBr₃.9H₂O, TaBr₄.8H₂O, TaCl₃.9H₂O, TaCl₄.8H₂O, TaF₃.H₂O, TaF₄.5H₂O, TaF₄.8H₂O, TaI₃.6H₂O, TaI₄.8H₂O, TiBr₂.H₂O, TiBr₂.12H₂O, TiBr₃.9H₂O, TiBr₄.8H₂O, TiCl₂.H₂O, TiCl₂.12H₂O, TiCl₃.H₂O, TiCl₃.9H₂O, TiCl₄.8H₂O, TiF₂.H₂O, TiF₂.12H₂O, TiF₃.3H₂O, TiF₃.9H₂O, TiF₄.5H₂O, TiF₄.8H₂O, TiI₂.12H₂O, TiI₃.6H₂O, TiI₃.9H₂O, TiI₄.8H₂O, VBr₂.12H₂O, VBr₃.9H₂O, VBr₄.8H₂O, VCl₂.H₂O, VCl₂.12H₂O, VCl₃.H₂O, VCl₃.9H₂O, VCl₄.8H₂O, VF₂.12H₂O, VF₃.9H₂O, VF₄.2H₂O, VF₄.5H₂O, VF₄.8H₂O, VI₂.12H₂O, VI₃.9H₂O, VI₄.8H₂O, WBr₄.8H₂O, WCl₄.8H₂O, WF₄.5H₂O, WF₄.8H₂O, WI₄.8H₂O, YBr₃.6H₂O, YBr₃.9H₂O, YCl₃.H₂O, YCl₃.9H₂O, YF₃.9H₂O, YI₃.6H₂O, YI₃.7H₂O, YI₃.8H₂O, YI₃.9H₂O, ZnBr₂.4H₂O, ZnBr₂.12H₂O, ZnCl₂.12H₂O, ZnF₂.12H₂O, ZnI₂.2H₂O, ZnI₁₂.12H₂O, ZrBr₂.H₂O, ZrBr₂.12H₂O, ZrBr₃.9H₂O, ZrBr₄.2H₂O, ZrBr₄.3H₂O, ZrBr₄.4H₂O, ZrBr₄.8H₂O, ZrCl₂.H₂O, ZrCl₂.12H₂O, ZrCl₃.9H₂O, ZrCl₄.2H₂O, ZrCl₄.3H₂O, ZrCl₄.4H₂O, ZrCl₄.8H₂O, ZrF₃.9H₂O, ZrF₄.8H₂O, ZrI₃.9H₂O, ZrI₄.2H₂O, ZrI₄.8H₂O, AIBr₃.3H₂O, AIBr₃.4H₂O, AIBr₃.7H₂O, AIBr₃.8H₂O, AlBr₃.10H₂O, AlCl₃.2H₂O, AlCl₃.H₂O, AlCl₃.H₂O, AlCl₃.7H₂O, AlCl₃.H₂O, AlCl₃.H₂O, AlF₃.2H₂O, AlF₃.4H₂O, AlF₃.6H₂O, AlF₃.7H₂O, AlF₃.8H₂O, AlF₃.10H₂O, AlI₃.H₂O, AlI₃.2H₂O, AlI₃.3H₂O, AlI₃.4H₂O, AlI₃.7H₂O, AlI₃.8H₂O, AlI₃.10H₂O, BaBr₂.4H₂O, BaBr₂.6H₂O, BaBr₂.7H₂O, BaBr₂.8H₂O, BaBr₂.9H₂O, BaCl₂.4H₂O, BaCl₂.8H₂O, BaCl₂.9H₂O, BaF2.H₂O, BaF₂.4H₂O, BaF₂.6H₂O, BaF₂.7H₂O, BaF₂.8H₂O, BaF₂.9H₂O, BaI₂.4H₂O, BaI₂.8H₂O, BaI₂.9H₂O, BeBr₂.H₂O, BeBr₂.2H₂O, BeBr₂.8H₂O, BeBr₂.12H₂O, BeCl₂.7H₂O, BeCl₂.8H₂O, BeCl₂.9H₂O, BeF₂.7H₂O, BeF₂.8H₂O, BeF₂.12H₂O, BeI₂.7H₂O, BeI₂.9H₂O, CaBr₂.7H₂O, CaBr₂.8H₂O, CaBr₂.9H₂O, CaCl₂.8H₂O, CaF₂.2H₂O, CaF₂.4H₂O, CaF₂.6H₂O, CaF₂.7H₂O, CaF₂.8H₂O, CaF₂.9H₂O, CaI2.H₂O, CaI₂.4H₂O, CaI₂.7H₂O, CaI₂.9H₂O, CoBr₂.H₂O, CoBr₂.2H₂O, CoBr₂.8H₂O, CoBr₂.9H₂O, CoBr₃.H₂O, CoBr₃.3H₂O, CoBr₃.4H₂O, CoBr₃.7H₂O, CoBr₃.10H₂O, CoCl₂.4H₂O, CoCl₂.7H₂O, CoCl₂.8H₂O, CoCl₂.9H₂O, CoCl₃.H₂O, CoCl₃.H₂O, CoCl₃.H₂O, CoCl₃.7H₂O, CoCl₃.H₂O, CoF₂.H₂O, CoF₂.2H₂O, CoF₂.8H₂O, CoF₂.9H₂O, CoF₃.2H₂O, CoF₃.4H₂O, CoF₃.6H₂O, CoF₃.7H₂O, CoF₃.8H₂O, CoF₃.10H₂O, CoI₂.H₂O, CoI₂.2H₂O, CoI₂.4H₂O, CoI₂.6H₂O, CoI₂.8H₂O, CoI₂.9H₂O, CoI₃.H₂O, CoI₃.6H₂O, CoI₃.7H₂O, CoI₃.9H₂O, CoI₃.H₂O, CrBr₂.H₂O, CrBr₂.2H₂O, CrBr₂.6H₂O, CrBr₂.7H₂O, CrBr₂.8H₂O, CrBr₂.9H₂O, CrBr₃.H₂O, CrBr₃.2H₂O, CrBr₃.3H₂O, CrBr₃.4H₂O, CrBr₃.6H₂O, CrBr₃.7H₂O, CrBr₃.8H₂O, CrBr₃.10H₂O, CrBr₄.2H₂O, CrBr₄.3H₂O, CrBr₄.4H₂O, CrBr₄.5H₂O, CrBr₄.9H₂O, CrCl₂.H₂O, CrCl₂.6H₂O, CrCl₂.7H₂O, CrCl₂.8H₂O, CrCl₂.9H₂O, CrCl₃.H₂O, CrCl₃.2H₂O, CrCl₃.H₂O, CrCl₃.H₂O, CrCl₃.6H₂O, CrCl₃.7H₂O, CrCl₃.H₂O, CrCl₄.2H₂O, CrCl₄.3H₂O, CrCl₄.4H₂O, CrCl₄.5H₂O, CrF2.H₂O, CrF₂.2H₂O, CrF₂.6H₂O, CrF₂.7H₂O, CrF₂.8H₂O, CrF₂.9H₂O, CrF₃.2H₂O, CrF₃.4H₂O, CrF₃.6H₂O, CrF₄.3H₂O, CrF₄.4H₂O, CrI₂.H₂O, CrI₂.2H₂O, CrI₂.6H₂O, CrI₂.7H₂O, CrI₂.8H₂O, CrI₂.9H₂O, CrI₃.H₂O, CrI₃.2H₂O, CrI₃.3H₂O, CrI₃.H₂O, CrI₃.6H₂O, CrI₃.7H₂O, CrI₃.8H₂O, CrI₃.10H₂O, CrI₄.2H₂O, CrI₄.4H₂O, CrI₄.5H₂O, CrI₄.9H₂O, CsF.3H₂O, CuBr.H₂O, CuBr₂H₂O, CuBr₃H₂O, CuBr₄H₂O, CuBr₂.2H₂O, CuBr₂.6H₂O, CuBr₂.7H₂O, CuBr₂.8H₂O, CuBr₂.9H₂O, CuCl_{.2}H₂O, CuCl_{.3}H₂O, CuCl_{.4}H₂O, CuCl₂.H₂O, CuCl₂.6H₂O, CuCl₂.7H₂O, CuCl₂.8H₂O, CuCl₂.9H₂O, CuF.3H₂O, CuF.4H₂O, CuF2.H₂O, CuF₂.6H₂O, CuF₂.8H₂O, CuF₂.9H₂O, CuI₂.2H₂O, CuI₂.6H₂O, CuI₂.8H₂O, CuI₂.9H₂O, CuI₂.12H₂O, FeBr₂.8H₂O, FeBr₂.12H₂O, FeBr₃.3H₂O, FeBr₃.4H₂O, FeBr₃.7H₂O, FeBr₃.8H₂O, FeBr₃.10H₂O, FeCl₂.8H₂O, FeCl₂.12H₂O, FeCl₃.H₂O, FeCl₃.H₂O, FeF2.H₂O, FeF₂.2H₂O, FeF₂.6H₂O, FeF₂.9H₂O, FeF₃.2H₂O, FeF₃.4H₂O, FeF₃.6H₂O, FeF₃.7H₂O, FeF₃.8H₂O, FeF₃.10H₂O, FeI₂.7H₂O, FeI₂.8H₂O, FeI₂.12H₂O, FeI₃.H₂O, FeI₃.H₂O, FeI₃.6H₂O, FeI₃.7H₂O, FeI₃.H₂O, FeI₃.9H₂O, GaBr₃.H₂O, GaBr₃.3H₂O, GaBr₃.4H₂O, GaBr₃.6H₂O, GaBr₃.7H₂O, GaBr₃.8H₂O, GaBr₃.10H₂O, GaCl₃.2H₂O, GaCl₃.H₂O, GaCl₃.H₂O, GaCl₃.6H₂O, GaCl₃.7H₂O, GaCl₃.H₂O, GaCl₃.H₂O, GaF₃.3H₂O, GaF₃.4H₂O, GaF₃.6H₂O, GaF₃.7H₂O, GaF₃.10H₂O, GaI₃.H₂O, GaI₃.H₂O, GaI₃.6H₂O, GaI₃.7H₂O, GaI₃.H₂O, GeBr₂.H₂O, GeBr₂.2H₂O, GeBr₂.6H₂O, GeBr₂.7H₂O, GeBr₂.8H₂O, GeBr₂.9H₂O, GeBr₄.3H₂O, GeBr₄.4H₂O, GeBr₄.5H₂O, GeBr₄.9H₂O, GeCl₂.H₂O, GeCl₂.6H₂O, GeCl₂.7H₂O, GeCl₂.8H₂O, GeCl₂.9H₂O, GeCl₄.3H₂O, GeCl₄.4H₂O, GeCl₄.5H₂O, GeCl₄.9H₂O, GeF₂.6H₂O, GeF₂.7H₂O, GeF₂.8H₂O, GeF₂.9H₂O, GeF₄.H₂O, GeF₄.3H₂O, GeF₄.4H₂O, GeF₄.9H₂O, GeI₂.H₂O, GeI₂.2H₂O, GeI₂.6H₂O, GeI₂.7H₂O, GeI₂.8H₂O, GeI₂.9H₂O, GeI₄.3H₂O, GeI₄.4H₂O, GeI₄.5H₂O, GeI₄.9H₂O, HfBr₃.6H₂O, HfBr₃.7H₂O, HfBr₃.8H₂O, HfBr₃.10H₂O, HfBr₄.5H₂O, HfBr₄.9H₂O, HfBr₄.10H₂O, HfCl₃.H₂O, HfCl₃.6H₂O, HfCl₃.7H₂O, HfCl₃.H₂O, HfCl₃.H₂O, HfCl₄.5H₂O, HfCl₄.9H₂O, HfCl₄.10H₂O, lifF₃.9H₂O, HfF₃.10H₂O, HfF₄.H₂O, HfF₄.2H₂O, HfF₄.4H₂O, HfF₄.5H₂O, HfF₄.9H₂O, HfI₃.6H₂O, HfI₃.7H₂O, HfI₃.H₂O, HfI₃.H₂O, HfI₄.3H₂O, HfI₄.4H₂O, HfI₄.5H₂O, HfI₄.9H₂O, HfI₄.10H₂O, KBr.H₂O, KBr₂H₂O, KBr₃H₂O, KCl.H₂O, KCl_{.2}H₂O, KCl_{.3}H₂O, KF.H₂O, KF.3H₂O, KI.H₂O, KI.2H₂O, KI₃.H₂O, LaBr₂.9H₂O, LaBr₂.12H₂O, LaBr₃.H₂O, LaBr₃.2H₂O, LaBr₃.3H₂O, LaBr₃.4H₂O, LaBr₃.7H₂O, LaBr₃.8H₂O, LaBr₃.10H₂O, LaCl_{.2}H₂O, LaCl_{.3}H₂O, LaCl_{.4}H₂O, LaCl₂.12H₂O, LaCl₃.2H₂O, LaCl₃.H₂O, LaCl₃.H₂O, LaCl₃.H₂O, LaF₂.12H₂O, LaF₃.H₂O, LaF₃.3H₂O, LaF₃.4H₂O, LaF₃.6H₂O, LaF₃.7H₂O, LaF₃.8H₂O, LaF₃.10H₂O, LaI.4H₂O, LaI₂.7H₂O, LaI₂.8H₂O, LaI₂.9H₂O, LaI₃.H₂O, LaI₃.2H₂O, LaI₃.3H₂O, LaI₃.H₂O, LaI₃.7H₂O, LaI₃.H₂O, LaI₃.H₂O, LiF.H₂O, LiF.3H₂O, LiI.4H₂O, MgBr₂.7H₂O, MgBr₂.8H₂O, MgBr₂.9H₂O, MgCl₂.7H₂O, MgCl₂.8H₂O, MgF2.H₂O, MgF₂.6H₂O, MgF₂.8H₂O, MgF₂.9H₂O, MgI₂.H₂O, MgI₂.6H₂O, MgI₂.8H₂O, MnBr₂.2H₂O, MnBr₂.7H₂O, MnBr₂.8H₂O, MnBr₂.9H₂O, MnBr₃.H₂O, MnBr₃.2H₂O, MnBr₃.3H₂O, MnBr₃.4H₂O, MnBr₃.7H₂O, MnBr₃.8H₂O, MnBr₃.9H₂O, MnBr₃.10H₂O, MnBr₄.2H₂O, MnBr₄.3H₂O, MnBr₄.4H₂O, MnBr₄.5H₂O, MnBr₄.9H₂O, MnCl₂.6H₂O, MnCl₂.8H₂O, MnCl₂.9H₂O, MnCl₃.H₂O, MnCl₃.2H₂O, MnCl₃.H₂O, MnCl₃.H₂O, MnCl₃.7H₂O, MnCl₃.H₂O, MnCl₄.2H₂O, MnCl₄.3H₂O, MnCl₄.5H₂O, MnCl₄.9H₂O, MnF₂.2H₂O, MnF₂.6H₂O, MnF₂.8H₂O, MnF₂.9H₂O, MnF₃.4H₂O, MnF₃.6H₂O, MnF₃.7H₂O, MnF₄.H₂O, MnF₄.3H₂O, MnF₄.9H₂O, MnI₂.6H₂O, MnI₂.7H₂O, MnI₂.8H₂O, MnI₂.9H₂O, MnI₃.H₂O, MnI₃.2H₂O, MnI₃.3H₂O, MnI₃.H₂O, MnI₃.7H₂O, MnI₃.8H₂O, MnI₃.9H₂O, MnI₃.10H₂O, MnI₄.2H₂O, MnI₄.3H₂O, MnI₄.4H₂O, MnI₄.5H₂O, MoBr₂.12H₂O, MoBr₃.3H₂O, MoBr₃.4H₂O, MoBr₃.6H₂O, MoBr₃.7H₂O, MoBr₃.8H₂O, MoBr₃.10H₂O, MoBr₄.2H₂O, MoBr₄.3H₂O, MoBr₄.4H₂O, MoBr₄.5H₂O, MoBr₄.9H₂O, MoCl₂.12H₂O, MoCl₃.H₂O, MoCl₃.H₂O, MoCl₃.6H₂O, MoCl₃.7H₂O, MoCl₃.H₂O, MoCl₃.H₂O, MoCl₄.H₂O, MoCl₄.2H₂O, MoCl₄.3H₂O, MoCl₄.5H₂O, MoF₂.8H₂O, MoF₂.9H₂O, MoF₂.12H₂O, MoF₃.H₂O, MoF₃.2H₂O, MoF₃.4H₂O, MoF₃.6H₂O, MoF₃.7H₂O, MoF₃.8H₂O, MoF₃.10H₂O, MoF₄.3H₂O, MoF₄.4H₂O, MoF₄.9H₂O, MoI₂.12H₂O, MoI₃.H₂O, MoI₃.H₂O, MoI₃.6H₂O, MoI₃.7H₂O, MoI₃.H₂O, MoI₃.10H₂O, MoI₄.2H₂O, MoI₄.3H₂O, MoI₄.4H₂O, MoI₄.5H₂O, MoI₄.9H₂O, NaBr₃H₂O, NaCl_{.3}H₂O, NaF.H₂O, NaF.2H₂O, NaF.3H₂O, NaI-H₂O, NaI.3H₂O, NaI.4H₂O, NbBr₃.2H₂O, NbBr₃.3H₂O, NbBr₃.4H₂O, NbBr₃.7H₂O, NbBr₃.8H₂O, NbBr₃.10H₂O, NbBr₄.2H₂O, NbBr₄.3H₂O, NbBr₄.4H₂O, NbBr₄.5H₂O, NbBr₄.9H₂O, NbCl₃.H₂O, NbCl₃.H₂O, NbCl₃.H₂O, NbCl₃.6H₂O, NbCl₃.7H₂O, NbCl₃.H₂O, NbCl₃.H₂O, NbCl₄.2H₂O, NbCl₄.3H₂O, NbCl₄.4H₂O, NbCl₄.5H₂O, NbCl₄.9H₂O, NbF₃.2H₂O, NbF₃.3H₂O, NbF₃.4H₂O, NbF₃.6H₂O, NbF₃.7H₂O, NbF₃.8H₂O, NbF₃.10H₂O, NbF₄.H₂O, NbF₄.2H₂O, NbF₄.3H₂O, NbF₄.4H₂O, NbF₄.9H₂O, NbI₃.2H₂O, NbI₃.H₂O, NbI₃.H₂O, NbI₃.7H₂O, NbI₃.H₂O, NbI₃.H₂O, NbI₄.2H₂O, NbI₄.3H₂O, NbI₄.4H₂O, NbI₄.5H₂O, NbI₄.9H₂O, NbI₄.10H₂O, NiBr₂.H₂O, NiBr₂.2H₂O, NiBr₂.4H₂O, NiBr₂.6H₂O, NiBr₂.7H₂O, NiBr₂.8H₂O, NiBr₂.9H₂O, NiBr₃.H₂O, NiBr₃.2H₂O, NiBr₃.3H₂O, NiBr₃.4H₂O, NiBr₃.7H₂O, NiBr₃.8H₂O, NiBr₃.9H₂O, NiBr₃.10H₂O, NiCl₂.1420, NiCl₂.7H₂O, NiCl₂.8H₂O, NiCl₂.9H₂O, NiCl₃.1420, NiCl₃.H₂O, NiCl₃.H₂O, NiCl₃.7H₂O, NiCl₃.H₂O, NiF2.H₂O, NiF₂.6H₂O, NiF₂.7H₂O, NiF₂.8H₂O, NiF₂.9H₂O, NiF₃.4H₂O, NiF₃.6H₂O, NiF₃.10H₂O, NiI₂.H₂O, NiI₂.2H₂O, NiI₂.4H₂O, NiI₂.7H₂O, NiI₂.8H₂O, NiI₂.9H₂O, NiI₃.2H₂O, NiI₃.3H₂O, NiI₃.6H₂O, NiI₃.7H₂O, NiI₃.8H₂O, NiI₃.9H₂O, NiI₃.H₂O, PbBr₂.H₂O, PbBr₂.6H₂O, PbBr₂.7H₂O, PbBr₂.8H₂O, PbBr₂.9H₂O, PbBr₄.3H₂O, PbBr₄.4H₂O, PbBr₄.5H₂O, PbBr₄.9H₂O, PbCl₂.1420, PbCl₂.6H₂O, PbCl₂.7H₂O, PbCl₂.8H₂O, PbCl₂.9H₂O, PbCl₄.2H₂O, PbCl₄.4H₂O, PbCl₄.5H₂O, PbF₂.4H₂O, PbF₂.6H₂O, PbF₂.7H₂O, PbF₂.8H₂O, PbF₂.9H₂O, PbF₄.H₂O, PbF₄.4H₂O, PbI₂.H₂O, PbI₂.2H₂O, PbI₂.6H₂O, PbI₂.7H₂O, PbI₂.8H₂O, PbI₂.9H₂O, PbI₄.H₂O, PbI₄.3H₂O, PbI₄.4H₂O, PbI₄.H₂O, PbI₄.9H₂O, RbBr.H₂O, RbBr₂H₂O, RbBr₃H₂O, RbCl.H₂O, RbCl_{.2}H₂O, RbCl_{.3}H₂O, RbF.3H₂O, RbI.H₂O, RbI2H₂O, RbI3H₂O, ScBr₃.2H₂O, ScBr₃.3H₂O, ScBr₃.4H₂O, ScBr₃.7H₂O, ScBr₃.8H₂O, ScBr₃.10H₂O, ScCl₃.H₂O, ScCl₃.2H₂O, ScCl₃.H₂O, ScCl₃.7H₂O, ScCl₃.H₂O, ScCl₃.H₂O, ScF₃.2H₂O, ScF₃.4H₂O, ScF₃.6H₂O, ScF₃.7H₂O, ScF₃.8H₂O, ScF₃.10H₂O, ScI₃.H₂O, ScI₃.H₂O, ScI₃.H₂O, ScI₃.7H₂O, ScI₃.H₂O, ScI₃.H₂O, SiBr₂.4H₂O, SiBr₂.9H₂O, SiBr₂.12H₂O, SiBr₄.3H₂O, SiBr₄.4H₂O, SiBr₄.5H₂O, SiCl₂.4H₂O, SiCl₂.7H₂O, SiCl₂.9H₂O, SiCl₂.12H₂O, SiCl₄.3H₂O, SiCl₄.4H₂O, SiCl₄.5H₂O, SiF₂.2H₂O, SiF₂.8H₂O, SiF₄.H₂O, SiF₄.3H₂O, SiF₄.4H₂O, SiF₄.9H₂O, SiI₂.4H₂O, SiI₂.6H₂O, SiI₂.9H₂O, SiI₂.12H₂O, SiI₄.H₂O, SnBr₂.H₂O, SnBr₂.6H₂O, SnBr₂.8H₂O, SnBr₂.9H₂O, SnBr₄.2H₂O, SnBr₄.3H₂O, SnBr₄.4H₂O, SnBr₄.9H₂O, SnCl₂.H₂O, SnCl₂.6H₂O, SnCl₂.7H₂O, SnCl₂.8H₂O, SnCl₂.9H₂O, SnCl₄.H₂O, SnCl₄.2H₂O, SnF₂.H₂O, SnF₂.6H₂O, SnF₂.7H₂O, SnF₂.8H₂O, SnF₂.9H₂O, SnF₄.H₂O, SnF₄.3H₂O, SnF₄.4H₂O, SnF₄.9H₂O, SnI₂.H₂O, SnI₂.2H₂O, SnI₂.6H₂O, SnI₂.7H₂O, SnI₂.8H₂O, SnI₂.9H₂O, SnI₄.4H₂O, SnI₄.9H₂O, SrBr₂.4H₂O, SrBr₂.7H₂O, SrBr₂.8H₂O, SrBr₂.9H₂O, SrCl₂.4H₂O, SrCl₂.7H₂O, SrCl₂.8H₂O, SrCl₂.9H₂O, SrF₂.4H₂O, SrF₂.6H₂O, SrF₂.7H₂O, SrF₂.8H₂O, SrF₂.9H₂O, SrI₂.4H₂O, SrI₂.7H₂O, SrI₂.8H₂O, SrI₂.9H₂O, TaBr₃.H₂O, TaBr₃.2H₂O, TaBr₃.3H₂O, TaBr₃.4H₂O, TaBr₃.7H₂O, TaBr₃.8H₂O, TaBr₃.10H₂O, TaBr₄.2H₂O, TaBr₄.3H₂O, TaBr₄.4H₂O, TaBr₄.5H₂O, TaBr₄.9H₂O, TaCl₃.2H₂O, TaCl₃.H₂O, TaCl₃.H₂O, TaCl₃.6H₂O, TaCl₃.7H₂O, TaCl₃.H₂O, TaCl₃.H₂O, TaCl₄.2H₂O, TaCl₄.3H₂O, TaCl₄.4H₂O, TaCl₄.5H₂O, TaCl₄.9H₂O, TaF₃.9H₂O, TaF₃.10H₂O, TaF₄.2H₂O, TaF₄.3H₂O, TaF₄.4H₂O, TaF₄.9H₂O, TaI₃.H₂O, TaI₃.H₂O, TaI₃.7H₂O, TaI₃.H₂O, TaI₃.9H₂O, TaI₃.H₂O, TaI₄.2H₂O, TaI₄.3H₂O, TaI₄.4H₂O, TaI₄.5H₂O, TaI₄.9H₂O, TaI₄.10H₂O, TiBr₂.2H₂O, TiBr₂.4H₂O, TiBr₂.6H₂O, TiBr₂.7H₂O, TiBr₂.8H₂O, TiBr₂.9H₂O, TiBr₃.H₂O, TiBr₃.2H₂O, TiBr₃.3H₂O, TiBr₃.4H₂O, TiBr₃.7H₂O, TiBr₃.8H₂O, TiBr₃.10H₂O, TiBr₄.2H₂O, TiBr₄.3H₂O, TiBr₄.4H₂O, TiBr₄.5H₂O, TiBr₄.9H₂O, TiCl₂.2H₂O, TiCl₂.4H₂O, TiCl₂.6H₂O, TiCl₂.7H₂O, TiCl₂.8H₂O, TiCl₂.9H₂O, TiCl₃.H₂O, TiCl₃.2H₂O, TiCl₃.H₂O, TiCl₃.7H₂O, TiCl₃.H₂O, TiCl₃.H₂O, TiCl₄.2H₂O, TiCl₄.3H₂O, TiCl₄.4H₂O, TiCl₄.5H₂O, TiCl₄.9H₂O, TiF₂.4H₂O, TiF₂.6H₂O, TiF₂.8H₂O, TiF₂.9H₂O, TiF₃.2H₂O, TiF₃.6H₂O, TiF₃.7H₂O, TiF₃.8H₂O, TiF₄.H₂O, TiF₄.3H₂O, TiF₄.4H₂O, TiF₄.9H₂O, TiI₂.H₂O, TiI₂.2H₂O, TiI₂.4H₂O, TiI₂.6H₂O, TiI₂.7H₂O, TiI₂.8H₂O, TiI₂.9H₂O, TiI₃.2H₂O, TiI₃.3H₂O, TiI₃.4H₂O, TiI₃.7H₂O, TiI₃.8H₂O, TiI₃.H₂O, TiI₄.2H₂O, TiI₄.3H₂O, TiI₄.4H₂O, TiI₄.5H₂O, TiI₄.9H₂O, VBr₂.H₂O, VBr₂.7H₂O, VBr₂.8H₂O, VBr₂.9H₂O, VBr₃.H₂O, VBr₃.2H₂O, VBr₃.3H₂O, VBr₃.7H₂O, VBr₃.8H₂O, VBr₄.2H₂O, VBr₄.3H₂O, VBr₄.4H₂O, VBr₄.5H₂O, VCl₂.6H₂O, VCl₂.7H₂O, VCl₂.8H₂O, VCl₂.9H₂O, VCl₃.H₂O, VCl₃.2H₂O, VCl₃.7H₂O, VCl₃.8H₂O, VCl₃.10H₂O, VCl₄.2H₂O, VCl₄.3H₂O, VCl₄.4H₂O, VCl₄.5H₂O, VF₂.2H₂O, VF₂.6H₂O, VF₂.7H₂O, VF₂.8H₂O, VF₂.9H₂O, VF₃.4H₂O, VF₃.6H₂O, VF₄.H₂O, VF₄.3H₂O, VF₄.4H₂O, VI₂.H₂O, VI₂.2H₂O, VI₂.7H₂O, VI₂.8H₂O, VI₂.9H₂O, VI₃.2H₂O, VI₃.H₂O, VI₃.H₂O, VI₃.7H₂O, VI₃.H₂O, VI₃.H₂O, VI₄.2H₂O, VI₄.3H₂O, VI₄.4H₂O, VI₄.5H₂O, VI₄.9H₂O, WBr₄.2H₂O, WBr₄.3H₂O, WBr₄.5H₂O, WBr₄.9H₂O, WCl₄.2H₂O, WCl₄.3H₂O, WCl₄.4H₂O, WCl₄.5H₂O, WCl₄.9H₂O, WF₄.2H₂O, WF₄.3H₂O, WF₄.4H₂O, WI₄.2H₂O, WI₄.3H₂O, WI₄.4H₂O, WI₄.5H₂O, WI₄.9H₂O, YBr₃.H₂O, YBr₃.2H₂O, YBr₃.3H₂O, YBr₃.4H₂O, YBr₃.7H₂O, YBr₃.8H₂O, YBr₃.10H₂O, YCl₃.H₂O, YCl₃.2H₂O, YCl₃.H₂O, YCl₃.7H₂O, YCl₃.H₂O, YCl₃.H₂O, YF₃.H₂O, YF₃.2H₂O, YF₃.3H₂O, YF₃.4H₂O, YF₃.6H₂O, YF₃.7H₂O, YF₃.8H₂O, YF₃.10H₂O, YI₃.2H₂O, YI₃.3H₂O, YI₃.4H₂O, YI₃.10H₂O, ZnBr₂.H₂O, ZnBr₂.6H₂O, ZnBr₂.7H₂O, ZnBr₂.8H₂O, ZnBr₂.9H₂O, ZnCl₂.8H₂O, ZnCl₂.9H₂O, ZnF2.H₂O, ZnF₂.2H₂O, ZnF₂.6H₂O, ZnF₂.8H₂O, ZnF₂.9H₂O, ZnI2.H₂O, ZnI₂.4H₂O, ZnI₂.6H₂O, ZnI₂.8H₂O, ZnI₂.9H₂O, ZrBr₂.6H₂O, ZrBr₂.7H₂O, ZrBr₂.8H₂O, ZrBr₂.9H₂O, ZrBr₃.2H₂O, ZrBr₃.3H₂O, ZrBr₃.4H₂O, ZrBr₃.6H₂O, ZrBr₃.7H₂O, ZrBr₃.8H₂O, ZrBr₃.10H₂O, ZrBr₄.5H₂O, ZrBr₄.9H₂O, ZrBr₄.10H₂O, ZrCl₂.6H₂O, ZrCl₂.8H₂O, ZrCl₂.9H₂O, ZrCl₃.H₂O, ZrCl₃.2H₂O, ZrCl₃.H₂O, ZrCl₃.H₂O, ZrCl₃.6H₂O, ZrCl₃.7H₂O, ZrCl₃.H₂O, ZrCl₃.H₂O, ZrCl₄.5H₂O, ZrCl₄.9H₂O, ZrCl₄.10H₂O, ZrF₃.6H₂O, ZrF₃.7H₂O, ZrF₃.8H₂O, ZrF₃.10H₂O, ZrF₄.2H₂O, ZrF₄.4H₂O, ZrF₄.5H₂O, ZrF₄.9H₂O, ZrI₂.12H₂O, ZrI₃.H₂O, ZrI₃.H₂O, ZrI₃.6H₂O, ZrI₃.7H₂O, ZrI₃.H₂O, ZrI₃.H₂O, ZrI₄.3H₂O, ZrI₄.4H₂O, ZrI₄.5H₂O, ZrI₄.9H₂O, Zr4.10H₂O, and combinations thereof. The thermal energy storage material is configured to reversibly store heat in the thermal energy system (TES) via an endothermic dehydration reaction and to release heat in in the thermal energy system (TES) via an exothermic hydration reaction.

In one aspect, the salt hydrate has a volumetric energy density of greater than or equal to about 1.3 GJ/m³.

In one aspect, a temperature hysteresis of the endothermic dehydration reaction and the exothermic hydration reaction of the salt hydrate is less than or equal to about 50° C.

In one aspect, M is selected from the group consisting of: lithium (Li), sodium (Na), potassium (K), rubidium (Rb), cesium (Cs), beryllium (Be), magnesium (Mg), calcium (Ca), strontium (Sr), barium (Ba), scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), iron (Fe), cobalt (Co), nickel (Ni), copper (Cu), zinc (Zn), aluminum (Al), gallium (Ga), silicon (Si), germanium (Ge), tin (Sn), lead (Pb)), lanthanum (La), and combinations thereof and X is selected from the group consisting of: fluorine (F), chlorine (Cl), bromine (Br), iodine (I), and combinations thereof.

In one aspect, M is selected from the group consisting of lithium (Li), sodium (Na), beryllium (Be), magnesium (Mg), and aluminum (Al). Further, X is a halide selected from the group consisting of: fluorine (F), chlorine (Cl) and bromine (Br).

In one aspect, X comprises fluorine (F), so that the metal hydrate is represented by the formula: MF_{q}.nH₂O.

In one aspect, the salt hydrate is selected from the group consisting of: AlBr₃.H₂O, AlBr₃.9H₂O, AlCl₃.H₂O, AlCl₃.9H₂O, AlF₃.9H₂O, AlI₃.6H₂O, AlI₃.9H₂O, BaBr₂.12H₂O, BaCl₂.12H₂O, BaF₂.2H₂O, BaF₂.12H₂O, BaI₂.12H₂O, BeBr₂.4H₂O, BeBr₂.9H₂O, BeCl₂.2H₂O, BeCl₂.4H₂O, BeCl₂.12H₂O, BeF₂.2H₂O, BeF₂.4H₂O, BeF₂.9H₂O, BeI₂.2H₂O, BeI₂.4H₂O, BeI₂.8H₂O, BeI₂.12H₂O, CaBr₂.H₂O, CaBr₂.2H₂O, CaBr₂⁶12H₂O, CaCl₂⁶12H₂O, CaF₂⁶12H₂O, CaI₂⁶2H₂O, CaI2⁶12H₂O, COBr₂⁶12H₂O, CoBr₃.6H₂O, CoBr₃.9H₂O, CoCl₂.12H₂O, CoCl₃.6H₂O, CoCl₃.9H₂O, CoF₂.4H₂O, CoF₂.12H₂O, CoF₃.3H₂O, CoF₃.9H₂O, CoI₂.12H₂O, CrBr₂.4H₂O, CrBr₂.12H₂O, CrBr₃.9H₂O, CrBr₄.8H₂O, CrCl₂.12H₂O, CrCl₃.9H₂O, CrCl₄.8H₂O, CrF₂.4H₂O, CrF₂.12H₂O, CrF₃.3H₂O, CrF₃.9H₂O, CrF₄.2H₂O, CrF₄.5H₂O, CrF₄.8H₂O, CrI₂.4H₂O, CrI₂.12H₂O, CrI₃.9H₂O, CrI₄.3H₂O, CrI₄.H₂O, CsF.2H₂O, CsI.4H₂O, CuBr₂.12H₂O, CuCl₂.4H₂O, CuCl₂.12H₂O, CuF.H₂O, CuF.2H₂O, CuF₂.4H₂O, CuF₂.12H₂O, CuI₂.4H₂O, FeBr₃.H₂O, FeBr₃.9H₂O, FeCl₂.9H₂O, FeCl₃.H₂O, FeCl₃.H₂O, FeCl₃.9H₂O, FeF₂.12H₂O, FeF₃.H₂O, FeF₃.9H₂O, FeI₃.2H₂O, FeI₃.H₂O, GaBr₃.2H₂O, GaBr₃.9H₂O, GaCl₃.H₂O, GaCl₃.9H₂O, GaF₃.9H₂O, GaI₃.H₂O, GaI₃.9H₂O, GeBr₂.4H₂O, GeBr₂.12H₂O, GeCl₂.2H₂O, GeCl₂.4H₂O, GeCl₂.12H₂O, GeCl₄.8H₂O, GeF₂.2H₂O, GeF₂.4H₂O, GeF₂.12H₂O, GeF₄.2H₂O, GeF₄.5H₂O, GeF₄.8H₂O, GeI₂.4H₂O, GeI₂.12H₂O, GeI₄.H₂O, HfBr₃.9H₂O, HfBr₄.2H₂O, HfBr₄.3H₂O, HfBr₄.4H₂O, HfBr₄.8H₂O, HfCl₃.9H₂O, HfCl₄.2H₂O, HfCl₄.3H₂O, HfCl₄.4H₂O, HfCl₄.8H₂O, HfF₄.3H₂O, HfF₄.8H₂O, HfI₃.9H₂O, HfI₄.2H₂O, HfI₄.H₂O, KBr₄H₂O, KCl_{.4}H₂O, KI.4H₂O, LaBr₃.6H₂O, LaBr₃.9H₂O, LaCl₃.6H₂O, LaCl₃.9H₂O, LaF₃.9H₂O, LaI₂.12H₂O, LaI₃.6H₂O, LaI₃.9H₂O, LiBr₃H₂O, LiBr₄H₂O, LiCl_{.4}H₂O, LiF.4H₂O, MgBr₂.2H₂O, MgBr₂.12H₂O, MgCl₂.12H₂O, MgF₂.4H₂O, MgF₂.12H₂O, MgI₂.4H₂O, MgI₂.9H₂O, MgI₂.12H₂O, MnBr₂.12H₂O, MnBr₃.6H₂O, MnBr₄.8H₂O, MnCl₂.12H₂O, MnCl₃.6H₂O, MnCl₃.9H₂O, MnCl₄.4H₂O, MnCl₄.8H₂O, MnF₂.12H₂O, MnF₃.3H₂O, MnF₃.9H₂O, MnF₄.2H₂O, MnF₄.4H₂O, MnF₄.5H₂O, MnF₄.8H₂O, MnI₂.12H₂O, MnI₃.6H₂O, MnI₄.H₂O, MoBr₃.9H₂O, MoBr₄.8H₂O, MoCl₃.2H₂O, MoCl₃.9H₂O, MoCl₄.4H₂O, MoCl₄.8H₂O, MoF₂.H₂O, MoF₃.3H₂O, MoF₃.9H₂O, MoF₄.2H₂O, MoF₄.5H₂O, MoF₄.8H₂O, MoI₃.9H₂O, MoI₄.H₂O, NaBr.H₂O, NaBr₄H₂O, NaCl.H₂O, NaCl_{.2}H₂O, NaCl_{.4}H₂O, NaF.4H₂O, NbBr₃.6H₂O, NbBr₃.9H₂O, NbBr₄.8H₂O, NbCl₃.9H₂O, NbCl₄.8H₂O, NbF₃.H₂O, NbF₃.9H₂O, NbF₄.5H₂O, NbF₄.8H₂O, NbI₃.6H₂O, NbI₃.9H₂O, NbI₄.8H₂O, NiBr₂.12H₂O, NiBr₃.6H₂O, NiCl₂.12H₂O, NiCl₃.6H₂O, NiCl₃.9H₂O, NiF₂.2H₂O, NiF₂.12H₂O, NiF₃.2H₂O, NiF₃.3H₂O, NiF₃.9H₂O, NiI₂.12H₂O, PbBr₂.2H₂O, PbBr₂.4H₂O, PbBr₂.12H₂O, PbBr₄.8H₂O, PbCl₂.2H₂O, PbCl₂.4H₂O, PbCl₂.12H₂O, PbCl₄.3H₂O, PbCl₄.8H₂O, PbF₂.2H₂O, PbF₂.12H₂O, PbF₄.2H₂O, PbF₄.3H₂O, PbF₄.5H₂O, PbI₂.4H₂O, PbI₂.12H₂O, PbI₄.5H₂O, RbBr₄H₂O, RbCl_{.4}H₂O, RbF.2H₂O, RbF.4H₂O, RbI4H₂O, ScBr₃.6H₂O, ScBr₃.9H₂O, ScCl₃.H₂O, ScCl₃.9H₂O, ScF₃.3H₂O, ScF₃.9H₂O, ScI₃.6H₂O, ScI₃.9H₂O, SiBr₂.8H₂O, SiBr₄.8H₂O, SiBr₄.9H₂O, SiCl₂.8H₂O, SiCl₄.8H₂O, SiCl₄.9H₂O, SiF₄.2H₂O, SiF₄.5H₂O, SiF₄.8H₂O, SiI₂.8H₂O, SiI₄.9H₂O, SnBr₂.2H₂O, SnBr₂.4H₂O, SnBr₂.12H₂O, SnBr₄.5H₂O, SnCl₂.4H₂O, SnCl₂.12H₂O, SnCl₄.3H₂O, SnCl₄.4H₂O, SnCl₄.8H₂O, SnF₂.2H₂O, SnF₂.4H₂O, SnF₂.12H₂O, SnF₄.2H₂O, SnF₄.5H₂O, SnF₄.8H₂O, SnI₂.4H₂O, SnI₂12H₂O, SnI₄. H₂O, SnI₄.2H₂O, SnI₄.3H₂O, SnI₄.5H₂O, SrBr₂.2H₂O, SrBr₂.12H₂O, SrCl₂.12H₂O, SrF₂.2H₂O, SrF₂.12H₂O, SrI₂.12H₂O, TaBr₃.6H₂O, TaBr₃.9H₂O, TaBr₄.8H₂O, TaCl₃.9H₂O, TaCl₄.8H₂O, TaF₃.H₂O, TaF₄.5H₂O, TaF₄.8H₂O, TaI₃.6H₂O, TaI₄.8H₂O, TiBr₂.H₂O, TiBr₂.12H₂O, TiBr₃.9H₂O, TiBr₄.8H₂O, TiCl₂.H₂O, TiCl₂.12H₂O, TiCl₃.H₂O, TiCl₃.9H₂O, TiCl₄.8H₂O, TiF₂.H₂O, TiF₂.12H₂O, TiF₃.3H₂O, TiF₃.9H₂O, TiF₄.5H₂O, TiF₄.8H₂O, TiI₂.12H₂O, TiI₃.6H₂O, TiI₃.9H₂O, TiI₄.H₂O, VBr₂.12H₂O, VBr₃.9H₂O, VBr₄.8H₂O, VCl₂.H₂O, VCl₂.12H₂O, VCl₃.H₂O, VCl₃.9H₂O, VCl₄.8H₂O, VF₂.12H₂O, VF₃.9H₂O, VF₄.2H₂O, VF₄.5H₂O, VF₄.8H₂O, VI₂.12H₂O, VI₃.9H₂O, VI₄.8H₂O, WBr₄.8H₂O, WCl₄.8H₂O, WF₄5H₂O, WF₄.8H₂O, WI₄.8H₂O, YBr₃.6H₂O, YBr₃.9H₂O, YCl₃.H₂O, YCl₃.9H₂O, YF₃.9H₂O, YI₃.6H₂O, YI₃.7H₂O, YI₃.8H₂O, YI₃.9H₂O, ZnBr₂.4H₂O, ZnBr₂.12H₂O, ZnCl₂.12H₂O, ZnF₂.12H₂O, ZnI₂.2H₂O, ZnI₂.12H₂O, ZrBr₂.H₂O, ZrBr₂.12H₂O, ZrBr₃.9H₂O, ZrBr₄.2H₂O, ZrBr₄.3H₂O, ZrBr₄.4H₂O, ZrBr₄.8H₂O, ZrCl₂.H₂O, ZrCl₂.12H₂O, ZrCl₃.9H₂O, ZrCl₄.2H₂O, ZrCl₄.3H₂O, ZrCl₄.4H₂O, ZrCl₄.8H₂O, ZrF₃.9H₂O, ZrF₄.8H₂O, ZrI₃.9H₂O, ZrI₄.2H₂O, ZrI₄.8H₂O, and combinations thereof.

In one aspect, the salt hydrate is selected from the group consisting of: AlBr₃.3H₂O, AlBr₃.4H₂O, AlBr₃.7H₂O, AlBr₃.8H₂O, AlBr₃.10H₂O, AlCl₃.2H₂O, AlCl₃.H₂O, AlCl₃.H₂O, AlCl₃.7H₂O, AlCl₃.H₂O, AlCl₃.H₂O, AlF₃.2H₂O, AlF₃.4H₂O, AlF₃.6H₂O, AlF₃.7H₂O, AlF₃.8H₂O, AlF₃.10H₂O, AlI₃.H₂O, AlI₃.2H₂O, AlI₃.3H₂O, AlI₃.4H₂O, AlI₃.7H₂O, AlI₃.8H₂O, AlI₃.10H₂O, BaBr₂.4H₂O, BaBr₂.6H₂O, BaBr₂.7H₂O, BaBr₂.8H₂O, BaBr₂.9H₂O, BaCl₂.4H₂O, BaCl₂.8H₂O, BaCl₂.9H₂O, BaF2.H₂O, BaF₂.4H₂O, BaF₂.6H₂O, BaF₂.7H₂O, BaF₂.8H₂O, BaF₂.9H₂O, BaI₂.4H₂O, BaI₂.8H₂O, BaI₂.9H₂O, BeBr₂.H₂O, BeBr₂.2H₂O, BeBr₂.8H₂O, BeBr₂.12H₂O, BeCl₂.7H₂O, BeCl₂.8H₂O, BeCl₂.9H₂O, BeF₂.7H₂O, BeF₂.8H₂O, BeF₂.12H₂O, BeI₂.7H₂O, BeI₂.9H₂O, CaBr₂.7H₂O, CaBr₂.8H₂O, CaBr₂.9H₂O, CaCl₂.8H₂O, CaF₂.2H₂O, CaF₂.4H₂O, CaF₂.6H₂O, CaF₂.7H₂O, CaF₂.8H₂O, CaF₂.9H₂O, CaI₂.H₂O, CaI₂.4H₂O, CaI₂.7H₂O, CaI₂.9H₂O, CoBr₂.H₂O, CoBr₂.2H₂O, CoBr₂.8H₂O, CoBr₂.9H₂O, CoBr₃.H₂O, CoBr₃.3H₂O, CoBr₃.4H₂O, CoBr₃.7H₂O, CoBr₃.10H₂O, CoCl₂.4H₂O, CoCl₂.7H₂O, CoCl₂.8H₂O, CoCl₂.9H₂O, CoCl₃.H₂O, CoCl₃.H₂O, CoCl₃.H₂O, CoCl₃.7H₂O, CoCl₃.H₂O, CoF₂.H₂O, CoF₂.2H₂O, CoF₂.8H₂O, CoF₂.9H₂O, CoF₃.2H₂O, CoF₃.4H₂O, CoF₃.6H₂O, CoF₃.7H₂O, CoF₃.8H₂O, CoF₃.10H₂O, CoI₂.H₂O, CoI₂.6H₂O, CoI₂.6H₂O, CoI₂.6H₂O, CoI₂.8H₂O, CoI₂.9H₂O, CoI₃.H₂O, CoI₃.6H₂O, CoI₃.7H₂O, CoI₃.9H₂O, CoI₃.H₂O, CrBr₂.H₂O, CrBr₂.2H₂O, CrBr₂.6H₂O, CrBr₂.7H₂O, CrBr₂.8H₂O, CrBr₂.9H₂O, CrBr₃.H₂O, CrBr₃.2H₂O, CrBr₃.3H₂O, CrBr₃.4H₂O, CrBr₃.6H₂O, CrBr₃.7H₂O, CrBr₃.8H₂O, CrBr₃.10H₂O, CrBr₄.2H₂O, CrBr₄.3H₂O, CrBr₄.4H₂O, CrBr₄.5H₂O, CrBr₄.9H₂O, CrCl₂.H₂O, CrCl₂.6H₂O, CrCl₂.7H₂O, CrCl₂.8H₂O, CrCl₂.9H₂O, CrCl₃.H₂O, CrCl₃.2H₂O, CrCl₃.H₂O, CrCl₃.H₂O, CrCl₃.6H₂O, CrCl₃.7H₂O, CrCl₃.H₂O, CrCl₄.2H₂O, CrCl₄.3H₂O, CrCl₄.4H₂O, CrCl₄.5H₂O, CrF2.H₂O, CrF₂.2H₂O, CrF₂.6H₂O, CrF₂.7H₂O, CrF₂.8H₂O, CrF₂.9H₂O, CrF₃.2H₂O, CrF₃.4H₂O, CrF₃.6H₂O, CrF₄.3H₂O, CrF₄.4H₂O, CrI₂.H₂O, CrI₂.2H₂O, CrI₂.6H₂O, CrI₂.7H₂O, CrI₂.8H₂O, CrI₂.9H₂O, CrI₃.H₂O, CrI₃.2H₂O, CrI₃.3H₂O, CrI₃.H₂O, CrI₃.6H₂O, CrI₃.7H₂O, CrI₃.8H₂O, CrI₃.10H₂O, CrI₄.2H₂O, CrI₄.4H₂O, CrI₄.5H₂O, CrI₄.9H₂O, CsF.3H₂O, CuBr.H₂O, CuBr₂H₂O, CuBr₃H₂O, CuBr₄H₂O, CuBr₂.2H₂O, CuBr₂.6H₂O, CuBr₂.7H₂O, CuBr₂.8H₂O, CuBr₂.9H₂O, CuCl_{.2}H₂O, CuCl_{.3}H₂O, CuCl_{.4}H₂O, CuCl₂.H₂O, CuCl₂.6H₂O, CuCl₂.7H₂O, CuCl₂.8H₂O, CuCl₂.9H₂O, CuF.3H₂O, CuF.4H₂O, CuF2.H₂O, CuF₂.6H₂O, CuF₂.8H₂O, CuF₂.9H₂O, CuI₂.2H₂O, CuI₂.6H₂O, CuI₂.8H₂O, CuI₂.9H₂O, CuI₂.12H₂O, FeBr₂.8H₂O, FeBr₂.12H₂O, FeBr₃.3H₂O, FeBr₃.4H₂O, FeBr₃.7H₂O, FeBr₃.8H₂O, FeBr₃.10H₂O, FeCl₂.8H₂O, FeCl₂.12H₂O, FeCl₃.H₂O, FeCl₃.H₂O, FeF2.H₂O, FeF₂.2H₂O, FeF₂.6H₂O, FeF₂.9H₂O, FeF₃.2H₂O, FeF₃.4H₂O, FeF₃.6H₂O, FeF₃.7H₂O, FeF₃.8H₂O, FeF₃.10H₂O, FeI₂.7H₂O, FeI₂.8H₂O, FeI₂.12H₂O, FeI₃.H₂O, FeI₃.H₂O, FeI₃.6H₂O, FeI₃.7H₂O, FeI₃.H₂O, FeI₃.9H₂O, GaBr₃.H₂O, GaBr₃.3H₂O, GaBr₃.4H₂O, GaBr₃.6H₂O, GaBr₃.7H₂O, GaBr₃.8H₂O, GaBr₃.10H₂O, GaCl₃.2H₂O, GaCl₃.H₂O, GaCl₃.H₂O, GaCl₃.6H₂O, GaCl₃.7H₂O, GaCl₃.H₂O, GaCl₃.H₂O, GaF₃.3H₂O, GaF₃.4H₂O, GaF₃.6H₂O, GaF₃.7H₂O, GaF₃.10H₂O, GaI₃.H₂O, GaI₃.H₂O, GaI₃.6H₂O, GaI₃.7H₂O, GaI₃.H₂O, GeBr₂.H₂O, GeBr₂.2H₂O, GeBr₂.6H₂O, GeBr₂.7H₂O, GeBr₂.8H₂O, GeBr₂.9H₂O, GeBr₄.3H₂O, GeBr₄.4H₂O, GeBr₄.5H₂O, GeBr₄.9H₂O, GeCl₂.H₂O, GeCl₂.6H₂O, GeCl₂.7H₂O, GeCl₂.8H₂O, GeCl₂.9H₂O, GeCl₄.3H₂O, GeCl₄.4H₂O, GeCl₄.5H₂O, GeCl₄.9H₂O, GeF₂.6H₂O, GeF₂.7H₂O, GeF₂.8H₂O, GeF₂.9H₂O, GeF₄.H₂O, GeF₄.3H₂O, GeF₄.4H₂O, GeF₄.9H₂O, GeI₂.H₂O, GeI₂.2H₂O, GeI₂.6H₂O, GeI₂.7H₂O, GeI₂.8H₂O, GeI₂.9H₂O, GeI₄.3H₂O, GeI₄.4H₂O, GeI₄.5H₂O, GeI₄.9H₂O, GeI₆H₂O, GeI₇H₂O, GeI₈H₂O, GeI₁₀H₂O, HfBr₄.5H₂O, HfBr₄.9H₂O, HfBr₄.10H₂O, HfCl₃.H₂O, HfCl₃.6H₂O, HfCl₃.7H₂O, HfCl₃.H₂O, HfCl₃.H₂O, HfCl₄.5H₂O, HfCl₄.9H₂O, HfCl₄.10H₂O, HfF₃.9H₂O, HfF₃.10H₂O, HfF₄.H₂O, HfF₄.2H₂O, HfF₄.4H₂O, HfF₄.5H₂O, HfF₄.9H₂O, HfI₃.6H₂O, HfI₃.7H₂O, HfI₃.H₂O, HfI₃.H₂O, HfI₄.3H₂O, HfI₄.4H₂O, HfI₄.5H₂O, HfI₄.9H₂O, HfI₄.10H₂O, KBr.H₂O, KBr₂H₂O, KBr₃H₂O, KCl.H₂O, KCl_{.2}H₂O, KCl_{.3}H₂O, KF.H₂O, KF.3H₂O, KI.H₂O, KI.2H₂O, KI.3H₂O, LaBr₂.9H₂O, LaBr₂. 12H₂O, LaBr₃.H₂O, LaBr₃.2H₂O, LaBr₃.3H₂O, LaBr₃.4H₂O, LaBr₃.7H₂O, LaBr₃.8H₂O, LaBr₃.10H₂O, LaCl_{.2}H₂O, LaCl_{.3}H₂O, LaCl_{.4}H₂O, LaCl₂.12H₂O, LaCl₃.2H₂O, LaCl₃.H₂O, LaCl₃.H₂O, LaCl₃.H₂O, LaF₂.12H₂O, LaF₃.H₂O, LaF₃.3H₂O, LaF₃.4H₂O, LaF₃.6H₂O, LaF₃.7H₂O, LaF₃.8H₂O, LaF₃.10H₂O, LaI.4H₂O, LaI₂.7H₂O, LaI₂.8H₂O, LaI₂.9H₂O, LaI₃.H₂O, LaI₃.2H₂O, LaI₃.3H₂O, LaI₃.H₂O, LaI₃.7H₂O, LaI₃.H₂O, LaI₃.H₂O, LiF.H₂O, LiF.3H₂O, LiI.4H₂O, MgBr₂.7H₂O, MgBr₂.8H₂O, MgBr₂.9H₂O, MgCl₂.7H₂O, MgCl₂.8H₂O, MgF₂.H₂O, MgF₂.6H₂O, MgF₂.8H₂O, MgF₂.9H₂O, MgI₂.H₂O, MgI₂.6H₂O, MgI₂.8H₂O, MnBr₂.2H₂O, MnBr₂.7H₂O, MnBr₂.8H₂O, MnBr₂.9H₂O, MnBr₃.H₂O, MnBr₃.2H₂O, MnBr₃.3H₂O, MnBr₃.4H₂O, MnBr₃.7H₂O, MnBr₃.8H₂O, MnBr₃.9H₂O, MnBr₃.10H₂O, MnBr₄.2H₂O, MnBr₄.3H₂O, MnBr₄.4H₂O, MnBr₄.5H₂O, MnBr₄.9H₂O, MnCl₂.6H₂O, MnCl₂.8H₂O, MnCl₂.9H₂O, MnCl₃.H₂O, MnCl₃.2H₂O, MnCl₃.H₂O, MnCl₃.4H₂O, MnCl₃.7H₂O, MnCl₃.H₂O, MnCl₄.2H₂O, MnCl₄.3H₂O, MnCl₄.5H₂O, MnCl₄.9H₂O, MnF₂.2H₂O, MnF₂.6H₂O, MnF₂.8H₂O, MnF₂.9H₂O, MnF₃.4H₂O, MnF₃.6H₂O, MnF₃.7H₂O, MnF₄.H₂O, MnF₄.3H₂O, MnF₄.9H₂O, MnI₂.6H₂O, MnI₂.7H₂O, MnI₂.8H₂O, MnI₂.9H₂O, MnI₃.H₂O, MnI₃.2H₂O, MnI₃.3H₂O, MnI₃.H₂O, MnI₃.7H₂O, MnI₃.8H₂O, MnI₃.9H₂O, MnI₃.10H₂O, MnI₄.2H₂O, MnI₄.3H₂O, MnI₄.4H₂O, MnI₄.5H₂O, MoBr₂.12H₂O, MoBr₃.3H₂O, MoBr₃.4H₂O, MoBr₃.6H₂O, MoBr₃.7H₂O, MoBr₃.8H₂O, MoBr₃.10H₂O, MoBr₄.2H₂O, MoBr₄.3H₂O, MoBr₄.4H₂O, MoBr₄.5H₂O, MoBr₄.9H₂O, MoCl₂.12H₂O, MoCl₃.3H₂O, MoCl₃.H₂O, MoCl₃.6H₂O, MoCl₃.7H₂O, MoCl₃.8H₂O, MoCl₃.10H₂O, MoCl₄.H₂O, MoCl₄.2H₂O, MoCl₄.3H₂O, MoCl₄.5H₂O, MoF₂.8H₂O, MoF₂.9H₂O, MoF₂.12H₂O, MoF₃.H₂O, MoF₃.2H₂O, MoF₃.4H₂O, MoF₃.6H₂O, MoF₃.7H₂O, MoF₃.8H₂O, MoF₃.10H₂O, MoF₄.3H₂O, MoF₄.4H₂O, MoF₄.9H₂O, MoI₂.12H₂O,₂O, MoI₃.3H₂O, MoI₃.6H₂O, MoI₃.6H₂O, MoI₃.7H₂O, MoI₃.H₂O, MoI₃.10H₂O, MoI₄.2H₂O, MoI₄.3H₂O, MoI₄.4H₂O, MoI₄.5H₂O, MoI₄.9H₂O, NaBr₃H₂O, NaCl_{.3}H₂O, NaF.H₂O, NaF.2H₂O, NaF.3H₂O, NaI-H₂O, NaI.3H₂O, NaI.4H₂O, NbBr₃.2H₂O, NbBr₃.3H₂O, NbBr₃.4H₂O, NbBr₃.7H₂O, NbBr₃.8H₂O, NbBr₃.10H₂O, NbBr₄.2H₂O, NbBr₄.3H₂O, NbBr₄.4H₂O, NbBr₄.5H₂O, NbBr₄.9H₂O, NbCl₃.H₂O, NbCl₃.H₂O, NbCl₃.H₂O, NbCl₃.6H₂O, NbCl₃.7H₂O, NbCl₃.H₂O, NbCl₃.H₂O, NbCl₄.2H₂O, NbCl₄.3H₂O, NbCl₄.4H₂O, NbCl₄.5H₂O, NbCl₄.9H₂O, NbF₃.2H₂O, NbF₃.3H₂O, NbF₃.4H₂O, NbF₃.6H₂O, NbF₃.7H₂O, NbF₃.8H₂O, NbF₃.10H₂O, NbF₄.H₂O, NbF₄.2H₂O, NbF₄.3H₂O, NbF₄.4H₂O, NbF₄.9H₂O, NbI₃.2H₂O, NbI₃.H₂O, NbI₃.H₂O, NbI₃.7H₂O, NbI₃.H₂O, NbI₃.H₂O, NbI₄.2H₂O, NbI₄.3H₂O, NbI₄.4H₂O, NbI₄.5H₂O, NbI₄.9H₂O, NbI4.10H₂O, NiBr₂.H₂O, NiBr₂.2H₂O, NiBr₂.4H₂O, NiBr₂.6H₂O, NiBr₂.7H₂O, NiBr₂.8H₂O, NiBr₂.9H₂O, NiBr₃.H₂O, NiBr₃.2H₂O, NiBr₃.3H₂O, NiBr₃.4H₂O, NiBr₃.7H₂O, NiBr₃.8H₂O, NiBr₃.9H₂O, NiBr₃.10H₂O, NiCl₂.H₂O, NiCl₂.7H₂O, NiCl₂.8H₂O, NiCl₂.9H₂O, NiCl₃.H₂O, NiCl₃.H₂O, NiCl₃.H₂O, NiCl₃.7H₂O, NiCl₃.H₂O, NiF₂.H₂O, NiF₂.6H₂O, NiF₂.7H₂O, NiF₂.8H₂O, NiF₂.9H₂O, NiF₃.4H₂O, NiF₃.6H₂O, NiF₃.10H₂O, NiI₂.H₂O, NiI₂.2H₂O, NiI₂.4H₂O, NiI₂.7H₂O, NiI₂.8H₂O, NiI₂.9H₂O, NiI₃.2H₂O, NiI₃.3H₂O, NiI₃.6H₂O, NiI₃.7H₂O, NiI₃.8H₂O, NiI₃.9H₂O, NiI₃.H₂O, PbBr₂.H₂O, PbBr₂.6H₂O, PbBr₂.7H₂O, PbBr₂.8H₂O, PbBr₂.9H₂O, PbBr₄.3H₂O, PbBr₄.4H₂O, PbBr₄.5H₂O, PbBr₄.9H₂O, PbCl₂.H₂O, PbCl₂.6H₂O, PbCl₂.7H₂O, PbCl₂.8H₂O, PbCl₂.9H₂O, PbCl₄.2H₂O, PbCl₄.4H₂O, PbCl₄.5H₂O, PbF₂.4H₂O, PbF₂.6H₂O, PbF₂.7H₂O, PbF₂.8H₂O, PbF₂.9H₂O, PbF₄.H₂O, PbF₄.4H₂O, PbI2.H₂O, PbI₂.2H₂O, PbI₂.6H₂O, PbI₂.7H₂O, PbI₂.8H₂O, PbI₂.9H₂O, PbI₄.H₂O, PbI₄.3H₂O, PbI₄.4H₂O, PbI₄.H₂O, PbI₄.9H₂O, RbBr.H₂O, RbBr₂H₂O, RbBr₃H₂O, RbCl.H₂O, RbCl_{.2}H₂O, RbCl_{.3}H₂O, RbF.3H₂O, RbIH₂O, RbI2H₂O, RbI3H₂O, ScBr₃.2H₂O, ScBr₃.3H₂O, ScBr₃.4H₂O, ScBr₃.7H₂O, ScBr₃.8H₂O, ScBr₃.10H₂O, ScCl₃.H₂O, ScCl₃.2H₂O, ScCl₃.H₂O, ScCl₃.7H₂O, ScCl₃.H₂O, ScCl₃.H₂O, ScF₃.2H₂O, ScF₃.4H₂O, ScF₃.6H₂O, ScF₃.7H₂O, ScF₃.8H₂O, ScF₃.10H₂O, ScI₃.H₂O, ScI₃.H₂O, ScI₃.H₂O, ScI₃.7H₂O, ScI₃.H₂O, ScI₃.H₂O, SiBr₂.4H₂O, SiBr₂.9H₂O, SiBr₂.12H₂O, SiBr₄.3H₂O, SiBr₄.4H₂O, SiBr₄.5H₂O, SiCl₂.4H₂O, SiCl₂.7H₂O, SiCl₂.9H₂O, SiCl₂.12H₂O, SiCl₄.3H₂O, SiCl₄.4H₂O, SiCl₄.5H₂O, SiF₂.2H₂O, SiF₂.8H₂O, SiF₄.H₂O, SiF₄.3H₂O, SiF₄.4H₂O, SiF₄.9H₂O, SiI₂.4H₂O, SiI₂.6H₂O, SiI₂.9H₂O, SiI₂.12H₂O, SiI₄.8H₂O, SnBr₂.H₂O, SnBr₂.6H₂O, SnBr₂.8H₂O, SnBr₂.9H₂O, SnBr₄.2H₂O, SnBr₄.3H₂O, SnBr₄.4H₂O, SnBr₄.9H₂O, SnCl₂.H₂O, SnCl₂.6H₂O, SnCl₂.7H₂O, SnCl₂.8H₂O, SnCl₂.9H₂O, SnCl₄.H₂O, SnCl₄.2H₂O, SnF₂.H₂O, SnF₂.6H₂O, SnF₂.7H₂O, SnF₂.8H₂O, SnF₂.9H₂O, SnF₄.H₂O, SnF₄.3H₂O, SnF₄.4H₂O, SnF₄.9H₂O, SnI₂.H₂O, SnI₂.2H₂O, SnI₂.6H₂O, SnI₂.7H₂O, SnI₂.8H₂O, SnI₂.9H₂O, SnI₄.4H₂O, SnI₄.9H₂O, SrBr₂.4H₂O, SrBr₂.7H₂O, SrBr₂.8H₂O, SrBr₂.9H₂O, SrCl₂.4H₂O, SrCl₂.7H₂O, SrCl₂.8H₂O, SrCl₂.9H₂O, SrF₂.4H₂O, SrF₂.6H₂O, SrF₂.7H₂O, SrF₂.8H₂O, SrF₂.9H₂O, SrI₂.4H₂O, SrI₂.7H₂O, SrI₂.8H₂O, SrI₂.9H₂O, TaBr₃.H₂O, TaBr₃.2H₂O, TaBr₃.3H₂O, TaBr₃.4H₂O, TaBr₃.7H₂O, TaBr₃.8H₂O, TaBr₃.10H₂O, TaBr₄.2H₂O, TaBr₄.3H₂O, TaBr₄.4H₂O, TaBr₄.5H₂O, TaBr₄.9H₂O, TaCl₃.2H₂O, TaCl₃.H₂O, TaCl₃.H₂O, TaCl₃.6H₂O, TaCl₃.7H₂O, TaCl₃.H₂O, TaCl₃.H₂O, TaCl₄.2H₂O, TaCl₄.3H₂O, TaCl₄.4H₂O, TaCl₄.5H₂O, TaCl₄.9H₂O, TaF₃.9H₂O, TaF₃.10H₂O, TaF₄.2H₂O, TaF₄.3H₂O, TaF₄.4H₂O, TaF₄.9H₂O, TaI₃.H₂O, TaI₃.H₂O, TaI₃.7H₂O, TaI₃.H₂O, TaI₃.9H₂O, TaI₃.H₂O, TaI₄.2H₂O, TaI₄.3H₂O, TaI₄.4H₂O, TaI₄.5H₂O, TaI₄.9H₂O, TaI₄.10H₂O, TiBr₂.2H₂O, TiBr₂.4H₂O, TiBr₂.6H₂O, TiBr₂.7H₂O, TiBr₂.8H₂O, TiBr₂.9H₂O, TiBr₃.H₂O, TiBr₃.2H₂O, TiBr₃.3H₂O, TiBr₃.4H₂O, TiBr₃.7H₂O, TiBr₃.8H₂O, TiBr₃.10H₂O, TiBr₄.2H₂O, TiBr₄.3H₂O, TiBr₄.4H₂O, TiBr₄.5H₂O, TiBr₄.9H₂O, TiCl₂.2H₂O, TiCl₂.4H₂O, TiCl₂.6H₂O, TiCl₂.7H₂O, TiCl₂.8H₂O, TiCl₂.9H₂O, TiCl₃.H₂O, TiCl₃.2H₂O, TiCl₃.H₂O, TiCl₃.7H₂O, TiCl₃.H₂O, TiCl₃.H₂O, TiCl₄.2H₂O, TiCl₄.3H₂O, TiCl₄.4H₂O, TiCl₄.5H₂O, TiCl₄.9H₂O, TiF₂.4H₂O, TiF₂.6H₂O, TiF₂.8H₂O, TiF₂.9H₂O, TiF₃.2H₂O, TiF₃.6H₂O, TiF₃.7H₂O, TiF₃.8H₂O, TiF₄.H₂O, TiF₄.3H₂O, TiF₄.4H₂O, TiF₄.9H₂O, TiI₂.H₂O, TiI₂.2H₂O, TiI₂.4H₂O, TiI₂.6H₂O, TiI₂.7H₂O, TiI₂.8H₂O, TiI₂.9H₂O, TiI₃.2H₂O, TiI₃.3H₂O, TiI₃.4H₂O, TiI₃.7H₂O, TiI₃.8H₂O, TiI₃.H₂O, TiI₄.2H₂O, TiI₄.3H₂O, TiI₄.4H₂O, TiI₄.5H₂O, TiI₄.9H₂O, VBr₂.H₂O, VBr₂.7H₂O, VBr₂.8H₂O, VBr₂.9H₂O, VBr₃.H₂O, VBr₃.2H₂O, VBr₃.3H₂O, VBr₃.7H₂O, VBr₃.8H₂O, VBr₄.2H₂O, VBr₄.3H₂O, VBr₄.4H₂O, VBr₄.5H₂O, VCl₂.6H₂O, VCl₂.7H₂O, VCl₂.8H₂O, VCl₂.9H₂O, VCl₃.H₂O, VCl₃.2H₂O, VCl₃.7H₂O, VCl₃.H₂O, VCl₃.H₂O, VCl₄.2H₂O, VCl₄.3H₂O, VCl₄.4H₂O, VCl₄.5H₂O, VF₂.2H₂O, VF₂.6H₂O, VF₂.7H₂O, VF₂.8H₂O, VF₂.9H₂O, VF₃.4H₂O, VF₃.6H₂O, VF₄.H₂O, VF₄.3H₂O, VF₄.4H₂O, VI₂.H₂O, VI₂.2H₂O, VI₂.7H₂O, VI₂.8H₂O, VI₂.9H₂O, VI₃.2H₂O, VI₃.H₂O, VI₃.H₂O, VI₃.7H₂O, VI₃.H₂O, VI₃.H₂O, VI₄.2H₂O, VI₄.3H₂O, VI₄.4H₂O, VI₄.5H₂O, VI₄.9H₂O, WBr₄.2H₂O, WBr₄.3H₂O, WBr₄.5H₂O, WBr₄.9H₂O, WCl₄.2H₂O, WCl₄.3H₂O, WCl₄.4H₂O, WCl₄.5H₂O, WCl₄.9H₂O, WF₄.2H₂O, WF₄.3H₂O, WF₄.4H₂O, WI₄.2H₂O, WI₄.3H₂O, WI₄.4H₂O, WI₄.5H₂O, WI₄.9H₂O, YBr₃.H₂O, YBr₃.2H₂O, YBr₃.3H₂O, YBr₃.4H₂O, YBr₃.7H₂O, YBr₃.8H₂O, YBr₃.10H₂O, YCl₃.H₂O, YCl₃.2H₂O, YCl₃.H₂O, YCl₃.7H₂O, YCl₃.H₂O, YCl₃.H₂O, YF₃.H₂O, YF₃.2H₂O, YF₃.3H₂O, YF₃.4H₂O, YF₃.6H₂O, YF₃.7H₂O, YF₃.8H₂O, YF₃.10H₂O, YI₃.2H₂O, YI₃.3H₂O, YI₃.4H₂O, YI₃.10H₂O, ZnBr₂.H₂O, ZnBr₂.6H₂O, ZnBr₂.7H₂O, ZnBr₂.8H₂O, ZnBr₂.9H₂O, ZnCl₂.8H₂O, ZnCl₂.9H₂O, ZnF2.H₂O, ZnF₂.2H₂O, ZnF₂.6H₂O, ZnF₂.8H₂O, ZnF₂.9H₂O, ZnI2.H₂O, ZnI₂.4H₂O, ZnI₂.6H₂O, ZnI₂.8H₂O, ZnI₂.9H₂O, ZrBr₂.6H₂O, ZrBr₂.7H₂O, ZrBr₂.8H₂O, ZrBr₂.9H₂O, ZrBr₃.2H₂O, ZrBr₃.3H₂O, ZrBr₃.4H₂O, ZrBr₃.6H₂O, ZrBr₃.7H₂O, ZrBr₃.8H₂O, ZrBr₃.10H₂O, ZrBr₄.5H₂O, ZrBr₄.9H₂O, ZrBr₄.10H₂O, ZrCl₂.6H₂O, ZrCl₂.8H₂O, ZrCl₂.9H₂O, ZrCl₃.H₂O, ZrCl₃.2H₂O, ZrCl₃.H₂O, ZrCl₃.H₂O, ZrCl₃.6H₂O, ZrCl₃.7H₂O, ZrCl₃.H₂O, ZrCl₃.H₂O, ZrCl₄.5H₂O, ZrCl₄.9H₂O, ZrCl₄.10H₂O, ZrF₃.6H₂O, ZrF₃.7H₂O, ZrF₃.8H₂O, ZrF₃.10H₂O, ZrF₄.2H₂O, ZrF₄.4H₂O, ZrF₄.5H₂O, ZrF₄.9H₂O, ZrI₂.12H₂O, ZrI₃.H₂O, ZrI₃.H₂O, ZrI₃.6H₂O, ZrI₃.7H₂O, ZrI₃.H₂O, ZrI₃.H₂O, ZrI₄.3H₂O, ZrI₄.4H₂O, ZrI₄.5H₂O, ZrI₄.9H₂O, ZrI₄.10H₂O, and combinations thereof.

In one aspect, the salt hydrate is selected from the group consisting of: CaF₂.12H₂O, LiF₂.4H₂O, TiF₂.12H₂O, MgF₂.12H₂O, MnF₂.12H₂O, SiF₄.5H₂O, CoF₃.3H₂O, NiF₃.3H₂O, CuF.H₂O, TiF₂.H₂O, FeF₃.H₂O, and combinations thereof.

In one aspect, at least one of the endothermic dehydration reaction and the exothermic hydration reaction occurs in a temperature range of greater than or equal to about 450° C. to less than or equal to about 600° C. and the salt hydrate comprises one or more of CuF.H₂O, TiF₂.H₂O, and FeF₃.H₂O.

In one aspect, at least one of the endothermic dehydration reaction and the exothermic hydration reaction occurs in a temperature range of greater than or equal to about 300° C. to less than or equal to about 450° C. and the salt hydrate comprises one or more of CoF₃.3H₂O and NiF₃.3H20.

In one aspect, at least one of the endothermic dehydration reaction and the exothermic hydration reaction occurs in a temperature range of greater than or equal to about 200° C. to less than or equal to about 300° C. and the salt hydrate comprises SiF₄.5H₂O.

In one aspect, at least one of the endothermic dehydration reaction and the exothermic hydration reaction occurs in a temperature range of greater than or equal to about 100° C. to less than or equal to about 200° C. and the salt hydrate comprises one or more of MgF₂.12H₂O and MnF₂.12H₂O.

In one aspect, at least one of the endothermic dehydration reaction and the exothermic hydration reaction occurs in a temperature range of greater than or equal to about 50° C. to less than or equal to about 100° C. and the salt hydrate comprises one or more of CaF₂.12H₂O, LiF.4H₂O, and TiF₂.12H₂O.

In certain aspects, the present disclosure contemplates a vehicle including any of the thermal energy systems (TES) as described above.

In yet other aspects, the present disclosure relates to a method of operating a thermal energy system (TES) comprising reversibly storing heat in a thermal energy storage material comprising a salt hydrate via an endothermic dehydration reaction and releasing heat via an exothermic hydration reaction of the salt hydrate. The thermal energy storage material comprising a salt hydrate that is represented by the formula: MX_{q}.nH₂O, where M is a cation selected from Groups 1-14 of the IUPAC Periodic Table, X is a halide of Group 17 of the IUPAC Periodic Table, q ranges from 1 to 4, and n ranges from 1 to 12. The salt hydrate is optionally selected from the group consisting of: AlBr₃.H₂O, AlBr₃.9H₂O, AlCl₃.H₂O, AlCl₃.9H₂O, AlF₃.9H₂O, AlI₃.6H₂O, AlI₃.9H₂O, BaBr₂.12H₂O, B aCl₂.12H₂O, B aF₂.2H₂O, B aF₂.12H₂O, BaI₂.12H₂O, BeBr₂.4H₂O, BeBr₂.9H₂O, BeCl₂.2H₂O, BeCl₂.4H₂O, BeCl₂.12H₂O, BeF₂.2H₂O, BeF₂.4H₂O, BeF₂.9H₂O, BeI₂.2H₂O, BeI₂.4H₂O, BeI₂.8H₂O, BeI₂.12H₂O, CaBr₂.H₂O, CaBr₂.2H₂O, CaBr₂.12H₂O, CaCl₂.12H₂O, CaF₂.12H₂O, CaI₂.2H₂O, CaI₂.12H₂O, COBr₂.12H₂O, CoBr₃.6H₂O, CoBr₃.9H₂O, CoCl₂.12H₂O, CoCl₃.6H₂O, CoCl₃.9H₂O, CoF₂.4H₂O, CoF₂.12H₂O, CoF₃.3H₂O, CoF₃.9H₂O, CoI₂.12H₂O, CrBr₂.4H₂O, CrBr₂.12H₂O, CrBr₃.9H₂O, CrBr₄.8H₂O, CrCl₂.12H₂O, CrCl₃.9H₂O, CrCl₄.8H₂O, CrF₂.4H₂O, CrF₂.12H₂O, CrF₃.3H₂O, CrF₃.9H₂O, CrF₄.2H₂O, CrF₄.5H₂O, CrF₄.8H₂O, CrI₂.4H₂O, CrI₂.12H₂O, CrI₃.9H₂O, CrI₄.3H₂O, CrI₄.H₂O, CsF.2H₂O, CsI.4H₂O, CuBr₂.12H₂O, CuCl₂.4H₂O, CuCl₂.12H₂O, CuF.H₂O, CuF.2H₂O, CuF₂.4H₂O, CuF₂.12H₂O, CuI₂.4H₂O, FeBr₃.H₂O, FeBr₃.9H₂O, FeCl₂.9H₂O, FeCl₃.H₂O, FeCl₃.H₂O, FeCl₃.9H₂O, FeF₂.12H₂O, FeF₃.H₂O, FeF₃.9H₂O, FeI₃.2H₂O, FeI₃.H₂O, GaBr₃.2H₂O, GaBr₃.9H₂O, GaCl₃.H₂O, GaCl₃.9H₂O, GaF₃.9H₂O, GaI₃.H₂O, GaI₃.9H₂O, GeBr₂.4H₂O, GeBr₂.12H₂O, GeCl₂.2H₂O, GeCl₂.4H₂O, GeCl₂.12H₂O, GeCl₄.8H₂O, GeF₂.2H₂O, GeF₂.4H₂O, GeF₂.12H₂O, GeF₄.2H₂O, GeF₄.5H₂O, GeF₄.8H₂O, GeI₂.4H₂O, GeI₂.12H₂O, GeI₄.H₂O, HfBr₃.9H₂O, HfBr₄.2H₂O, HfBr₄.3H₂O, HfBr₄.4H₂O, HfBr₄.8H₂O, HfCl₃.9H₂O, HfCl₄.2H₂O, HfCl₄.3H₂O, HfCl₄.4H₂O, HfCl₄.8H₂O, HfF₄.3H₂O, HfF₄.8H₂O, HfI₃.9H₂O, HfI₄.2H₂O, HfI₄.H₂O, KBr₄H₂O, KCl_{.4}H₂O, KI.4H₂O, LaBr₃.6H₂O, LaBr₃.9H₂O, LaCl₃.6H₂O, LaCl₃.9H₂O, LaF₃.9H₂O, LaI₂.12H₂O, LaI₃.6H₂O, LaI₃.9H₂O, LiBr₃H₂O, LiBr₄H₂O, LiCl_{.4}H₂O, LiF.4H₂O, MgBr₂.2H₂O, MgBr₂.12H₂O, MgCl₂.12H₂O, MgF₂.4H₂O, MgF₂.12H₂O, MgI₂.4H₂O, MgI₂.9H₂O, MgI₂.12H₂O, MnBr₂.12H₂O, MnBr₃.6H₂O, MnBr₄.8H₂O, MnCl₂.12H₂O, MnCl₃.6H₂O, MnCl₃.9H₂O, MnCl₄.4H₂O, MnCl₄.8H₂O, MnF₂.12H₂O, MnF₃.3H₂O, MnF₃.9H₂O, MnF₄.2H₂O, MnF₄.4H₂O, MnF₄.5H₂O, MnF₄.8H₂O, MnI₂.12H₂O, MnI₃.6H₂O, MnI₄.H₂O, MoBr₃.9H₂O, MoBr₄.8H₂O, MoCl₃.2H₂O, MoCl₃.9H₂O, MoCl₄.4H₂O, MoCl₄.8H₂O, MoF₂.H₂O, MoF₃.3H₂O, MoF₃.9H₂O, MoF₄.2H₂O, MoF₄.5H₂O, MoF₄.8H₂O, MoI₃.9H₂O, MoI₄.H₂O, NaBr.H₂O, NaBr₄H₂O, NaCl.H₂O, NaCl_{.2}H₂O, NaCl_{.4}H₂O, NaF.4H₂O, NbBr₃.6H₂O, NbBr₃.9H₂O, NbBr₄.8H₂O, NbCl₃.9H₂O, NbCl₄.8H₂O, NbF₃.H₂O, NbF₃.9H₂O, NbF₄.5H₂O, NbF₄.8H₂O, NbI₃.6H₂O, NbI₃.9H₂O, NbI₄.8H₂O, NiBr₂.12H₂O, NiBr₃.6H₂O, NiCl₂.12H₂O, NiCl₃.6H₂O, NiCl₃.9H₂O, NiF₂.2H₂O, NiF₂.12H₂O, NiF₃.2H₂O, NiF₃.3H₂O, NiF₃.9H₂O, NiI₂.12H₂O, PbBr₂.2H₂O, PbBr₂.4H₂O, PbBr₂.12H₂O, PbBr₄.8H₂O, PbCl₂.2H₂O, PbCl₂.4H₂O, PbCl₂.12H₂O, PbCl₄.3H₂O, PbCl₄.8H₂O, PbF₂.2H₂O, PbF₂.12H₂O, PbF₄.2H₂O, PbF₄.3H₂O, PbF₄.5H₂O, PbI₂.4H₂O, PbI₂.12H₂O, PbI₄.5H₂O, RbBr₄H₂O, RbCl_{.4}H₂O, RbF.2H₂O, RbF.4H₂O, RbI_{.4}H₂O, ScBr₃.6H₂O, ScBr₃.9H₂O, ScCl₃.H₂O, ScCl₃.9H₂O, ScF₃.3H₂O, ScF₃.9H₂O, ScI₃.6H₂O, ScI₃.9H₂O, SiBr₂.8H₂O, SiBr₄.8H₂O, SiBr₄.9H₂O, SiCl₂.8H₂O, SiCl₄.8H₂O, SiCl₄.9H₂O, SiF₄.2H₂O, SiF₄.5H₂O, SiF₄.8H₂O, SiI₂.8H₂O, SiI₄.9H₂O, SnBr₂.2H₂O, SnBr₂.4H₂O, SnBr₂.12H₂O, SnBr₄.5H₂O, SnCl₂.4H₂O, SnCl₂.12H₂O, SnCl₄.3H₂O, SnCl₄.4H₂O, SnCl₄.8H₂O, SnF₂.2H₂O, SnF₂.4H₂O, SnF₂.12H₂O, SnF₄.2H₂O, SnF₄.5H₂O, SnF₄.8H₂O, SnI₂.4H₂O, SnI₂.12H₂O, SnI₄.H₂O, SnI₄.2H₂O, SnI₄.3H₂O, SnI₄.5H₂O, SrBr₂.2H₂O, SrBr₂.12H₂O, SrCl₂.12H₂O, SrF₂.2H₂O, SrF₂.12H₂O, SrI₂.12H₂O, TaBr₃.6H₂O, TaBr₃.9H₂O, TaBr₄.8H₂O, TaCl₃.9H₂O, TaCl₄.8H₂O, TaF₃.H₂O, TaF₄.5H₂O, TaF₄.8H₂O, TaI₃.6H₂O, TaI₄.8H₂O, TiBr₂.H₂O, TiBr₂.12H₂O, TiBr₃.9H₂O, TiBr₄.8H₂O, TiCl₂.H₂O, TiCl₂.12H₂O, TiCl₃.H₂O, TiCl₃.9H₂O, TiCl₄.8H₂O, TiF₂.H₂O, TiF₂.12H₂O, TiF₃.3H₂O, TiF₃.9H₂O, TiF₄.5H₂O, TiF₄.8H₂O, TiI₂.12H₂O, TiI₃.6H₂O, TiI₃.9H₂O, TiI₄.8H₂O, VBr₂.12H₂O, VBr₃.9H₂O, VBr₄.8H₂O, VCl₂.H₂O, VCl₂.12H₂O, VCl₃.H₂O, VCl₃.9H₂O, VCl₄.8H₂O, VF₂.12H₂O, VF₃.9H₂O, VF₄.2H₂O, VF₄.5H₂O, VF₄.8H₂O, VI₂.12H₂O, VI₃.9H₂O, VI₄.8H₂O, WBr₄.8H₂O, WCl₄.8H₂O, WF₄.5H₂O, WF₄.8H₂O, WI₄.8H₂O, YBr₃.6H₂O, YBr₃.9H₂O, YCl₃.H₂O, YCl₃.9H₂O, YF₃.9H₂O, YI₃.6H₂O, YI₃.7H₂O, YI₃.8H₂O, YI₃.9H₂O, ZnBr₂.4H₂O, ZnBr₂.12H₂O, ZnCl₂.12H₂O, ZnF₂.12H₂O, ZnI₂.2H₂O, ZnI₂.12H₂O, ZrBr₂.H₂O, ZrBr₂.12H₂O, ZrBr₃.9H₂O, ZrBr₄.2H₂O, ZrBr₄.3H₂O, ZrBr₄.4H₂O, ZrBr₄.8H₂O, ZrCl₂.H₂O, ZrCl₂.12H₂O, ZrCl₃.9H₂O, ZrCl₄.2H₂O, ZrCl₄.3H₂O, ZrCl₄.4H₂O, ZrCl₄.8H₂O, ZrF₃.9H₂O, ZrF₄.8H₂O, ZrI₃.9H₂O, ZrI₄.2H₂O, ZrI₄.8H₂O, AIBr₃.3H₂O, AIBr₃.4H₂O, AIBr₃.7H₂O, AIBr₃.8H₂O, AlBr₃.10H₂O, AlCl₃.2H₂O, AlCl₃.H₂O, AlCl₃.H₂O, AlCl₃.7H₂O, AlCl₃.H₂O, AlCl₃.H₂O, AlF₃.2H₂O, AlF₃.4H₂O, AlF₃.6H₂O, AlF₃.7H₂O, AlF₃.8H₂O, AlF₃.10H₂O, AlI₃.H₂O, AlI₃.2H₂O, AlI₃.3H₂O, AlI₃.4H₂O, AlI₃.7H₂O, AlI₃.8H₂O, AlI₃.10H₂O, BaBr₂.4H₂O, BaBr₂.6H₂O, BaBr₂.7H₂O, BaBr₂.8H₂O, BaBr₂.9H₂O, BaCl₂.4H₂O, BaCl₂.8H₂O, BaCl₂.9H₂O, BaF₂.H₂O, BaF₂.4H₂O, BaF₂.6H₂O, BaF₂.7H₂O, BaF₂.8H₂O, BaF₂.9H₂O, BaI₂.4H₂O, BaI₂.8H₂O, BaI₂.9H₂O, BeBr₂.H₂O, BeBr₂.2H₂O, BeBr₂.8H₂O, BeBr₂.12H₂O, BeCl₂.7H₂O, BeCl₂.8H₂O, BeCl₂.9H₂O, BeF₂.7H₂O, BeF₂.8H₂O, BeF₂.12H₂O, BeI₂.7H₂O, BeI₂.9H₂O, CaBr₂.7H₂O, CaBr₂.8H₂O, CaBr₂.9H₂O, CaCl₂.8H₂O, CaF₂.2H₂O, CaF₂.4H₂O, CaF₂.6H₂O, CaF₂.7H₂O, CaF₂.8H₂O, CaF₂.9H₂O, CaI2.H₂O, CaI₂.4H₂O, CaI₂.7H₂O, CaI₂.9H₂O, CoBr₂.H₂O, CoBr₂.2H₂O, CoBr₂.8H₂O, CoBr₂.9H₂O, CoBr₃.H₂O, CoBr₃.3H₂O, CoBr₃.4H₂O, CoBr₃.7H₂O, CoBr₃.10H₂O, CoCl₂.4H₂O, CoCl₂.7H₂O, CoCl₂.8H₂O, CoCl₂.9H₂O, CoCl₃.H₂O, CoCl₃.H₂O, CoCl₃.H₂O, CoCl₃.7H₂O, CoCl₃.H₂O, CoF₂.H₂O, CoF₂.2H₂O, CoF₂.8H₂O, CoF₂.9H₂O, CoF₃.2H₂O, CoF₃.4H₂O, CoF₃.6H₂O, CoF₃.7H₂O, CoF₃.8H₂O, CoF₃.10H₂O, CoI₂.H₂O, CoI₂.2H₂O, CoI₂.4H₂O, CoI₂.6H₂O, CoI₂.8H₂O, CoI₂.9H₂O, CoI₃.H₂O, CoI₃.6H₂O, CoI₃.7H₂O, CoI₃.9H₂O, CoI₃.H₂O, CrBr₂.H₂O, CrBr₂.2H₂O, CrBr₂.6H₂O, CrBr₂.7H₂O, CrBr₂.8H₂O, CrBr₂.9H₂O, CrBr₃.H₂O, CrBr₃.2H₂O, CrBr₃.3H₂O, CrBr₃.4H₂O, CrBr₃.6H₂O, CrBr₃.7H₂O, CrBr₃.8H₂O, CrBr₃.10H₂O, CrBr₄.2H₂O, CrBr₄.3H₂O, CrBr₄.4H₂O, CrBr₄.5H₂O, CrBr₄.9H₂O, CrCl₂.H₂O, CrCl₂.6H₂O, CrCl₂.7H₂O, CrCl₂.8H₂O, CrCl₂.9H₂O, CrCl₃.H₂O, CrCl₃.2H₂O, CrCl₃.H₂O, CrCl₃.H₂O, CrCl₃.6H₂O, CrCl₃.7H₂O, CrCl₃.H₂O, CrCl₄.2H₂O, CrCl₄.3H₂O, CrCl₄.4H₂O, CrCl₄.5H₂O, CrF2.H₂O, CrF₂.2H₂O, CrF₂.6H₂O, CrF₂.7H₂O, CrF₂.8H₂O, CrF₂.9H₂O, CrF₃.2H₂O, CrF₃.4H₂O, CrF₃.6H₂O, CrF₄.3H₂O, CrF₄.4H₂O, CrI₂.H₂O, CrI₂.2H₂O, CrI₂.6H₂O, CrI₂.7H₂O, CrI₂.8H₂O, CrI₂.9H₂O, CrI₃.H₂O, CrI₃.2H₂O, CrI₃.3H₂O, CrI₃.H₂O, CrI₃.6H₂O, CrI₃.7H₂O, CrI₃.8H₂O, CrI₃.10H₂O, CrI₄.2H₂O, CrI₄.4H₂O, CrI₄.5H₂O, CrI₄.9H₂O, CsF.3H₂O, CuBr.H₂O, CuBr₂H₂O, CuBr₃H₂O, CuBr₄H₂O, CuBr₂.2H₂O, CuBr₂.6H₂O, CuBr₂.7H₂O, CuBr₂.8H₂O, CuBr₂.9H₂O, CuCl_{.2}H₂O, CuCl_{.3}H₂O, CuCl_{.4}H₂O, CuCl₂.H₂O, CuCl₂.6H₂O, CuCl₂.7H₂O, CuCl₂.8H₂O, CuCl₂.9H₂O, CuF.3H₂O, CuF.4H₂O, CuF2.H₂O, CuF₂.6H₂O, CuF₂.8H₂O, CuF₂.9H₂O, CuI₂.2H₂O, CuI₂.6H₂O, CuI₂.8H₂O, CuI₂.9H₂O, CuI₂.12H₂O, FeBr₂.8H₂O, FeBr₂.12H₂O, FeBr₃.3H₂O, FeBr₃.4H₂O, FeBr₃.7H₂O, FeBr₃.8H₂O, FeBr₃.10H₂O, FeCl₂.8H₂O, FeCl₂.12H₂O, FeCl₃.H₂O, FeCl₃.H₂O, FeF2.H₂O, FeF₂.2H₂O, FeF₂.6H₂O, FeF₂.9H₂O, FeF₃.2H₂O, FeF₃.4H₂O, FeF₃.6H₂O, FeF₃.7H₂O, FeF₃.8H₂O, FeF₃.10H₂O, FeI₂.7H₂O, FeI₂.8H₂O, FeI₂.12H₂O, FeI₃.H₂O, FeI₃.H₂O, FeI₃.6H₂O, FeI₃.7H₂O, FeI₃.H₂O, FeI₃.9H₂O, GaBr₃.H₂O, GaBr₃.3H₂O, GaBr₃.4H₂O, GaBr₃.6H₂O, GaBr₃.7H₂O, GaBr₃.8H₂O, GaBr₃.10H₂O, GaCl₃.2H₂O, GaCl₃.H₂O, GaCl₃.H₂O, GaCl₃.6H₂O, GaCl₃.7H₂O, GaCl₃.H₂O, GaCl₃.H₂O, GaF₃.3H₂O, GaF₃.4H₂O, GaF₃.6H₂O, GaF₃.7H₂O, GaF₃.10H₂O, GaI₃.H₂O, GaI₃.H₂O, GaI₃.6H₂O, GaI₃.7H₂O, GaI₃.H₂O, GeBr₂.H₂O, GeBr₂.2H₂O, GeBr₂.6H₂O, GeBr₂.7H₂O, GeBr₂.8H₂O, GeBr₂.9H₂O, GeBr₄.3H₂O, GeBr₄.4H₂O, GeBr₄.5H₂O, GeBr₄.9H₂O, GeCl₂.H₂O, GeCl₂.6H₂O, GeCl₂.7H₂O, GeCl₂.8H₂O, GeCl₂.9H₂O, GeCl₄.3H₂O, GeCl₄.4H₂O, GeCl₄.5H₂O, GeCl₄.9H₂O, GeF₂.6H₂O, GeF₂.7H₂O, GeF₂.8H₂O, GeF₂.9H₂O, GeF₄.H₂O, GeF₄.3H₂O, GeF₄.4H₂O, GeF₄.9H₂O, GeI₂.H₂O, GeI₂.2H₂O, GeI₂.6H₂O, GeI₂.7H₂O, GeI₂.8H₂O, GeI₂.9H₂O, GeI₄.3H₂O, GeI₄.4H₂O, GeI₄.5H₂O, GeI₄.9H₂O, GeI₆H₂O, GeI₇H₂O, GeI₈H₂O, GeI₁₀H₂O, HfBr₄.5H₂O, HfBr₄.9H₂O, HfBr₄.10H₂O, HfCl₃.H₂O, HfCl₃.6H₂O, HfCl₃.7H₂O, HfCl₃.H₂O, HfCl₃.H₂O, HfCl₄.5H₂O, HfCl₄.9H₂O, HfCl₄.10H₂O, HfF₃.9H₂O, HfF₃.10H₂O, HfF₄.H₂O, HfF₄.2H₂O, HfF₄.4H₂O, HfF₄.5H₂O, HfF₄.9H₂O, HfI₃.6H₂O, HfI₃.7H₂O, HfI₃.H₂O, HfI₃.H₂O, HfI₄.3H₂O, HfI₄.4H₂O, HfI₄.5H₂O, HfI₄.9H₂O, HfI₄.10H₂O, KBr.H₂O, KBr₂H₂O, KBr₃H₂O, KCl.H₂O, KCl_{.2}H₂O, KCl_{.3}H₂O, KF.H₂O, KF.3H₂O, KI. H₂O, KI.2H₂O, KI.3H₂O, LaBr₂.9H₂O, LaBr₂.12H₂O, LaBr₃.H₂O, LaBr₃.2H₂O, LaBr₃.3H₂O, LaBr₃.4H₂O, LaBr₃.7H₂O, LaBr₃.8H₂O, LaBr₃.10H₂O, LaCl_{.2}H₂O, LaCl_{.3}H₂O, LaCl_{.4}H₂O, LaCl₂.12H₂O, LaCl₃.2H₂O, LaCl₃.H₂O, LaCl₃.H₂O, LaCl₃.H₂O, LaF₂.12H₂O, LaF₃.H₂O, LaF₃.3H₂O, LaF₃.4H₂O, LaF₃.6H₂O, LaF₃.7H₂O, LaF₃.8H₂O, LaF₃.10H₂O, LaI.4H₂O, LaI₂.7H₂O, LaI₂.8H₂O, LaI₂.9H₂O, LaI₃.H₂O, LaI₃.2H₂O, LaI₃.3H₂O, LaI₃.H₂O, LaI₃.7H₂O, LaI₃.H₂O, LaI₃.H₂O, LiF.H₂O, LiF.3H₂O, LiI.4H₂O, MgBr₂.7H₂O, MgBr₂.8H₂O, MgBr₂.9H₂O, MgCl₂.7H₂O, MgCl₂.8H₂O, MgF₂.H₂O, MgF₂.6H₂O, MgF₂.8H₂O, MgF₂.9H₂O, MgI₂.H₂O, MgI₂.6H₂O, MgI₂.8H₂O, MnBr₂.2H₂O, MnBr₂.7H₂O, MnBr₂.8H₂O, MnBr₂.9H₂O, MnBr₃.H₂O, MnBr₃.2H₂O, MnBr₃.3H₂O, MnBr₃.4H₂O, MnBr₃.7H₂O, MnBr₃.8H₂O, MnBr₃.9H₂O, MnBr₃.10H₂O, MnBr₄.2H₂O, MnBr₄.3H₂O, MnBr₄.4H₂O, MnBr₄.5H₂O, MnBr₄.9H₂O, MnCl₂.6H₂O, MnCl₂.8H₂O, MnCl₂.9H₂O, MnCl₃.H₂O, MnCl₃.2H₂O, MnCl₃.H₂O, MnCl₃.H₂O, MnCl₃.7H₂O, MnCl₃.H₂O, MnCl₄.2H₂O, MnCl₄.3H₂O, MnCl₄.5H₂O, MnCl₄.9H₂O, MnF₂.2H₂O, MnF₂.6H₂O, MnF₂.8H₂O, MnF₂.9H₂O, MnF₃.4H₂O, MnF₃.6H₂O, MnF₃.7H₂O, MnF₄.H₂O, MnF₄.3H₂O, MnF₄.9H₂O, MnI₂.6H₂O, MnI₂.7H₂O, MnI₂.8H₂O, MnI₂.9H₂O, MnI₃.H₂O, MnI₃.2H₂O, MnI₃.H₂O, MnI₃.H₂O, MnI₃.7H₂O, MnI₃.H₂O, MnI₃.9H₂O, MnI₃.10H₂O, MnI₄.2H₂O, MnI₄.3H₂O, MnI₄.4H₂O, MnI₄.5H₂O, MoBr₂.12H₂O, MoBr₃.3H₂O, MoBr₃.4H₂O, MoBr₃.6H₂O, MoBr₃.7H₂O, MoBr₃.8H₂O, MoBr₃.10H₂O, MoBr₄.2H₂O, MoBr₄.3H₂O, MoBr₄.4H₂O, MoBr₄.5H₂O, MoBr₄.9H₂O, MoCl₂.12H₂O, MoCl₃.3H₂O, MoCl₃.H₂O, MoCl₃.6H₂O, MoCl₃.7H₂O, MoCl₃.8H₂O, MoCl₃.10H₂O, MoCl₄.H₂O, MoCl₄.2H₂O, MoCl₄.3H₂O, MoCl₄.5H₂O, MoF₂.8H₂O, MoF₂.9H₂O, MoF₂.12H₂O, MoF₃.H₂O, MoF₃.2H₂O, MoF₃.4H₂O, MoF₃.6H₂O, MoF₃.7H₂O, MoF₃.8H₂O, MoF₃.10H₂O, MoF₄.3H₂O, MoF₄.4H₂O, MoF₄.9H₂O, MoI₂.12H₂O,₂O, MoI₃.3H₂O, MoI₃.6H₂O, MoI₃.6H₂O, MoI₃.7H₂O, MoI₃.H₂O, MoI₃.10H₂O, MoI₄.2H₂O, MoI₄.3H₂O, MoI₄.4H₂O, MoI₄.5H₂O, MoI₄.9H₂O, NaBr₃H₂O, NaCl_{.3}H₂O, NaF.H₂O, NaF.2H₂O, NaF.3H₂O, NaI.H₂O, NaI.3H₂O, NaI.4H₂O, NbBr₃.2H₂O, NbBr₃.3H₂O, NbBr₃.4H₂O, NbBr₃.7H₂O, NbBr₃.8H₂O, NbBr₃.10H₂O, NbBr₄.2H₂O, NbBr₄.3H₂O, NbBr₄.4H₂O, NbBr₄.5H₂O, NbBr₄.9H₂O, NbCl₃.H₂O, NbCl₃.H₂O, NbCl₃.H₂O, NbCl₃.6H₂O, NbCl₃.7H₂O, NbCl₃.H₂O, NbCl₃.H₂O, NbCl₄.2H₂O, NbCl₄.3H₂O, NbCl₄.4H₂O, NbCl₄.5H₂O, NbCl₄.9H₂O, NbF₃.2H₂O, NbF₃.3H₂O, NbF₃.4H₂O, NbF₃.6H₂O, NbF₃.7H₂O, NbF₃.8H₂O, NbF₃.10H₂O, NbF₄.H₂O, NbF₄.2H₂O, NbF₄.3H₂O, NbF₄.4H₂O, NbF₄.9H₂O, NbI₃.2H₂O, NbI₃.3H₂O, NbI₃.H₂O, NbI₃.7H₂O, NbI₃.H₂O, NbI₃.H₂O, NbI₄.2H₂O, NbI₄.3H₂O, NbI₄.4H₂O, NbI₄.5H₂O, NbI₄.9H₂O, NbI4.10H₂O, NiBr₂.H₂O, NiBr₂.2H₂O, NiBr₂.4H₂O, NiBr₂.6H₂O, NiBr₂.7H₂O, NiBr₂.8H₂O, NiBr₂.9H₂O, NiBr₃.H₂O, NiBr₃.2H₂O, NiBr₃.3H₂O, NiBr₃.4H₂O, NiBr₃.7H₂O, NiBr₃.8H₂O, NiBr₃.9H₂O, NiBr₃.10H₂O, NiCl₂.H₂O, NiCl₂.7H₂O, NiCl₂.8H₂O, NiCl₂.9H₂O, NiCl₃.H₂O, NiCl₃.H₂O, NiCl₃.H₂O, NiCl₃.7H₂O, NiCl₃.H₂O, NiF₂.H₂O, NiF₂.6H₂O, NiF₂.7H₂O, NiF₂.8H₂O, NiF₂.9H₂O, NiF₃.4H₂O, NiF₃.6H₂O, NiF₃.10H₂O, NiI₂.H₂O, NiI₂.2H₂O, NiI₂.4H₂O, NiI₂.7H₂O, NiI₂.8H₂O, NiI₂.9H₂O, NiI₃.2H₂O, NiI₃.3H₂O, NiI₃.6H₂O, NiI₃.7H₂O, NiI₃.8H₂O, NiI₃.9H₂O, NiI₃.H₂O, PbBr₂.H₂O, PbBr₂.6H₂O, PbBr₂.7H₂O, PbBr₂.8H₂O, PbBr₂.9H₂O, PbBr₄.3H₂O, PbBr₄.4H₂O, PbBr₄.5H₂O, PbBr₄.9H₂O, PbCl₂.H₂O, PbCl₂.6H₂O, PbCl₂.7H₂O, PbCl₂.8H₂O, PbCl₂.9H₂O, PbCl₄.2H₂O, PbCl₄.4H₂O, PbCl₄.5H₂O, PbF₂.4H₂O, PbF₂.6H₂O, PbF₂.7H₂O, PbF₂.8H₂O, PbF₂.9H₂O, PbF₄.H₂O, PbF₄.4H₂O, PbI₂.H₂O, PbI₂.2H₂O, PbI₂.6H₂O, PbI₂.7H₂O, PbI₂.8H₂O, PbI₂.9H₂O, PbI₄.H₂O, PbI₄.3H₂O, PbI₄.4H₂O, PbI₄.H₂O, PbI₄.9H₂O, RbBr.H₂O, RbBr₂H₂O, RbBr₃H₂O, RbCl.H₂O, RbCl_{.2}H₂O, RbCl_{.3}H₂O, RbF.3H₂O, RbI.H₂O, RbI_{.2}H₂O, RbI3H₂O, ScBr₃.2H₂O, ScBr₃.3H₂O, ScBr₃.4H₂O, ScBr₃.7H₂O, ScBr₃.8H₂O, ScBr₃.10H₂O, ScCl₃.H₂O, ScCl₃.2H₂O, ScCl₃.H₂O, ScCl₃.7H₂O, ScCl₃.H₂O, ScCl₃.H₂O, ScF₃.2H₂O, ScF₃.4H₂O, ScF₃.6H₂O, ScF₃.7H₂O, ScF₃.8H₂O, ScF₃.10H₂O, ScI₃.H₂O, ScI₃.H₂O, ScI₃.H₂O, ScI₃.7H₂O, ScI₃.H₂O, ScI₃.H₂O, SiBr₂.4H₂O, SiBr₂.9H₂O, SiBr₂.12H₂O, SiBr₄.3H₂O, SiBr₄.4H₂O, SiBr₄.5H₂O, SiCl₂.4H₂O, SiCl₂.7H₂O, SiCl₂.9H₂O, SiCl₂.12H₂O, SiCl₄.3H₂O, SiCl₄.4H₂O, SiCl₄.5H₂O, SiF₂.2H₂O, SiF₂.8H₂O, SiF₄.H₂O, SiF₄.3H₂O, SiF₄.4H₂O, SiF₄.9H₂O, SiI₂.4H₂O, SiI₂.6H₂O, SiI₂.9H₂O, SiI₂.12H₂O, SiI₄.H₂O, SnBr₂.H₂O, SnBr₂.6H₂O, SnBr₂.8H₂O, SnBr₂.9H₂O, SnBr₄.2H₂O, SnBr₄.3H₂O, SnBr₄.4H₂O, SnBr₄.9H₂O, SnCl₂.H₂O, SnCl₂.6H₂O, SnCl₂.7H₂O, SnCl₂.8H₂O, SnCl₂.9H₂O, SnCl₄.H₂O, SnCl₄.2H₂O, SnF₂.H₂O, SnF₂.6H₂O, SnF₂.7H₂O, SnF₂.8H₂O, SnF₂.9H₂O, SnF₄.H₂O, SnF₄.3H₂O, SnF₄.4H₂O, SnF₄.9H₂O, SnI₂.H₂O, SnI₂.2H₂O, SnI₂.6H₂O, SnI₂.7H₂O, SnI₂.8H₂O, SnI₂.9H₂O, SnI₄.4H₂O, SnI₄.9H₂O, SrBr₂.4H₂O, SrBr₂.7H₂O, SrBr₂.8H₂O, SrBr₂.9H₂O, SrCl₂.4H₂O, SrCl₂.7H₂O, SrCl₂.8H₂O, SrCl₂.9H₂O, SrF₂.4H₂O, SrF₂.6H₂O, SrF₂.7H₂O, SrF₂.8H₂O, SrF₂.9H₂O, SrI₂.4H₂O, SrI₂.7H₂O, SrI₂.8H₂O, SrI₂.9H₂O, TaBr₃.H₂O, TaBr₃.2H₂O, TaBr₃.3H₂O, TaBr₃.4H₂O, TaBr₃.7H₂O, TaBr₃.8H₂O, TaBr₃.10H₂O, TaBr₄.2H₂O, TaBr₄.3H₂O, TaBr₄.4H₂O, TaBr₄.5H₂O, TaBr₄.9H₂O, TaCl₃.2H₂O, TaCl₃.H₂O, TaCl₃.H₂O, TaCl₃.6H₂O, TaCl₃.7H₂O, TaCl₃.H₂O, TaCl₃.H₂O, TaCl₄.2H₂O, TaCl₄.3H₂O, TaCl₄.4H₂O, TaCl₄.5H₂O, TaCl₄.9H₂O, TaF₃.9H₂O, TaF₃.10H₂O, TaF₄.2H₂O, TaF₄.3H₂O, TaF₄.4H₂O, TaF₄.9H₂O, TaI₃.H₂O, TaI₃.H₂O, TaI₃.7H₂O, TaI₃.H₂O, TaI₃.9H₂O, TaI₃.H₂O, TaI₄.2H₂O, TaI₄.3H₂O, TaI₄.4H₂O, TaI₄.5H₂O, TaI₄.9H₂O, TaI₄.10H₂O, TiBr₂.2H₂O, TiBr₂.4H₂O, TiBr₂.6H₂O, TiBr₂.7H₂O, TiBr₂.8H₂O, TiBr₂.9H₂O, TiBr₃.H₂O, TiBr₃.2H₂O, TiBr₃.3H₂O, TiBr₃.4H₂O, TiBr₃.7H₂O, TiBr₃.8H₂O, TiBr₃.10H₂O, TiBr₄.2H₂O, TiBr₄.3H₂O, TiBr₄.4H₂O, TiBr₄.5H₂O, TiBr₄.9H₂O, TiCl₂.2H₂O, TiCl₂.4H₂O, TiCl₂.6H₂O, TiCl₂.7H₂O, TiCl₂.8H₂O, TiCl₂.9H₂O, TiCl₃.H₂O, TiCl₃.2H₂O, TiCl₃.H₂O, TiCl₃.7H₂O, TiCl₃.H₂O, TiCl₃.H₂O, TiCl₄.2H₂O, TiCl₄.3H₂O, TiCl₄.4H₂O, TiCl₄.5H₂O, TiCl₄.9H₂O, TiF₂.4H₂O, TiF₂.6H₂O, TiF₂.8H₂O, TiF₂.9H₂O, TiF₃.2H₂O, TiF₃.6H₂O, TiF₃.7H₂O, TiF₃.8H₂O, TiF₄.H₂O, TiF₄.3H₂O, TiF₄.4H₂O, TiF₄.9H₂O, TiI₂.H₂O, TiI₂.2H₂O, TiI₂.4H₂O, TiI₂.6H₂O, TiI₂.7H₂O, TiI₂.8H₂O, TiI₂.9H₂O, TiI₃.2H₂O, TiI₃.3H₂O, TiI₃.4H₂O, TiI₃.7H₂O, TiI₃.8H₂O, TiI₃.H₂O, TiI₄.2H₂O, TiI₄.3H₂O, TiI₄.4H₂O, TiI₄.5H₂O, TiI₄.9H₂O, VBr₂.H₂O, VBr₂.7H₂O, VBr₂.8H₂O, VBr₂.9H₂O, VBr₃.H₂O, VBr₃.2H₂O, VBr₃.3H₂O, VBr₃.7H₂O, VBr₃.8H₂O, VBr₄.2H₂O, VBr₄.3H₂O, VBr₄.4H₂O, VBr₄.5H₂O, VCl₂.6H₂O, VCl₂.7H₂O, VCl₂.8H₂O, VCl₂.9H₂O, VCl₃.H₂O, VCl₃.2H₂O, VCl₃.7H₂O, VCl₃.H₂O, VCl₃.H₂O, VCl₄.2H₂O, VCl₄.3H₂O, VCl₄.4H₂O, VCl₄.5H₂O, VF₂.2H₂O, VF₂.6H₂O, VF₂.7H₂O, VF₂.8H₂O, VF₂.9H₂O, VF₃.4H₂O, VF₃.6H₂O, VF₄.H₂O, VF₄.3H₂O, VF₄.4H₂O, VI₂.H₂O, VI₂.2H₂O, VI₂.7H₂O, VI₂.8H₂O, VI₂.9H₂O, VI₃.2H₂O, VI₃.H₂O, VI₃.H₂O, VI₃.7H₂O, VI₃.H₂O, VI₃.H₂O, VI₄.2H₂O, VI₄.3H₂O, VI₄.4H₂O, VI₄.5H₂O, VI₄.9H₂O, WBr₄.2H₂O, WBr₄.3H₂O, WBr₄.5H₂O, WBr₄.9H₂O, WCl₄.2H₂O, WCl₄.3H₂O, WCl₄.4H₂O, WCl₄.5H₂O, WCl₄.9H₂O, WF₄.2H₂O, WF₄.3H₂O, WF₄.4H₂O, WI₄.2H₂O, WI₄.3H₂O, WI₄.4H₂O, WI₄.5H₂O, WI₄.9H₂O, YBr₃.H₂O, YBr₃.2H₂O, YBr₃.3H₂O, YBr₃.4H₂O, YBr₃.7H₂O, YBr₃.8H₂O, YBr₃.10H₂O, YCl₃.H₂O, YCl₃.2H₂O, YCl₃.H₂O, YCl₃.7H₂O, YCl₃.H₂O, YCl₃.H₂O, YF₃.H₂O, YF₃.2H₂O, YF₃.3H₂O, YF₃.4H₂O, YF₃.6H₂O, YF₃.7H₂O, YF₃.8H₂O, YF₃.10H₂O, YI₃.2H₂O, YI₃.3H₂O, YI₃.4H₂O, YI₃.10H₂O, ZnBr₂.H₂O, ZnBr₂.6H₂O, ZnBr₂.7H₂O, ZnBr₂.8H₂O, ZnBr₂.9H₂O, ZnCl₂.8H₂O, ZnCl₂.9H₂O, ZnF2.H₂O, ZnF₂.2H₂O, ZnF₂.6H₂O, ZnF₂.8H₂O, ZnF₂.9H₂O, ZnI2.H₂O, ZnI₂.4H₂O, ZnI₂.6H₂O, ZnI₂.8H₂O, ZnI₂.9H₂O, ZrBr₂.6H₂O, ZrBr₂.7H₂O, ZrBr₂.8H₂O, ZrBr₂.9H₂O, ZrBr₃.2H₂O, ZrBr₃.3H₂O, ZrBr₃.4H₂O, ZrBr₃.6H₂O, ZrBr₃.7H₂O, ZrBr₃.8H₂O, ZrBr₃.10H₂O, ZrBr₄.5H₂O, ZrBr₄.9H₂O, ZrBr₄.10H₂O, ZrCl₂.6H₂O, ZrCl₂.8H₂O, ZrCl₂.9H₂O, ZrCl₃.H₂O, ZrCl₃.2H₂O, ZrCl₃.H₂O, ZrCl₃.H₂O, ZrCl₃.6H₂O, ZrCl₃.7H₂O, ZrCl₃.H₂O, ZrCl₃.H₂O, ZrCl₄.5H₂O, ZrCl₄.9H₂O, ZrCl₄.10H₂O, ZrF₃.6H₂O, ZrF₃.7H₂O, ZrF₃.8H₂O, ZrF₃.10H₂O, ZrF₄.2H₂O, ZrF₄.4H₂O, ZrF₄.5H₂O, ZrF₄.9H₂O, ZrI₂.12H₂O, ZrI₃.H₂O, ZrI₃.H₂O, ZrI₃.6H₂O, ZrI₃.7H₂O, ZrI₃.H₂O, ZrI₃.H₂O, ZrI₄.3H₂O, ZrI₄.4H₂O, ZrI₄.5H₂O, ZrI₄.9H₂O, ZrI₄.10H₂O, and combinations thereof.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic depicting a flow chart of a screening procedure for identifying salt hydrate candidates in accordance with certain aspects of the present disclosure.

FIG. 2 is a periodic table highlighting the cations and anions used for ionic substitution. The triangles indicate the oxidation states used for the elements. Lanthanum was the only f-block element used.

FIG. 3 is a schematic depicting generation of hydrate candidates via systematic variation of hydrate crystal structure, cation, and anion, constrained by the oxidation state of the cation.

FIG. 4 is a schematic depicting a screening procedure for identifying optimum machine learning models.

FIG. 5 graphs volumetric energy density, gravimetric energy density, and temperature category for 3,656 salt (de)hydration reactions characterized by certain aspects of the present disclosure. Stars depict select leading candidate reactions.

FIG. 6 shows salt (de)hydration reactions of interest for thermal energy storage (TES) identified by certain aspects of the present disclosure for each listed temperature category, as well as a lithium ion battery for reference. Gravimetric (GED) and volumetric (VED) energy densities are depicted by horizontal bars.

FIG. 7 shows projected system energy densities for the MERITS experimental prototype for (de)hydration reactions characterized by certain aspects of the present disclosure. Experimentally known hydrates are shown with open circles, while previously undiscovered hydrates are shown with closed circles. Certain reactions of interest are depicted by a star, while other benchmarks are depicted by various other shapes. The DOE energy density target level is also shown for reference.

FIGS. 8A-8B are scatterplots showing the machine learning (ML)-predicted and DFT enthalpies of dehydration. FIG. 8A shows the optimum combined feature set (SVM) and FIG. 8B shows optimum single feature set (support vector machine (SVM)). Each observation in the dataset is represented by the predicted value in the test set during 10-fold cross validation.

FIGS. 9A-9F are partial dependence plots. In FIG. 9A, a cation's electronegativity is shown. In FIG. 9B, a molar mass of the cation is shown. In FIG. 9C, an anion's electronegativity is shown. In FIG. 9D, a hydrate number is shown. In FIG. 9E, cation-water distance is shown. In FIG. 9F, cation-cation distance is shown. The black line shows the partial dependence plot for the random forest model, while the gray line shows the partial dependence plot for the k-nearest neighbor's model.

FIG. 10 is a heatmap showing an average enthalpy of dehydration for each ion and salt family. Black entries indicate missing values.

FIG. 11 is a heatmap showing the average enthalpy of dehydration for each cation, crystal structure template, and cation-structure pair. White entries indicate missing values or not applicable pairs (e.g., when the oxidation states of the cation and structure do not match).

FIG. 12 is a heatmap showing the average enthalpy of dehydration for each anion, crystal structure template, and anion-structure pair. Black entries indicate missing values.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

The relevant portions of all patents, patent applications, articles, and literature, or databases referenced or cited in this disclosure are hereby incorporated by reference herein.

Example embodiments will now be described more fully with reference to the accompanying drawings.

All materials store sensible heat as they undergo a temperature change; however, this type of heat storage is subject to loss and low energy densities. Higher energy densities can be achieved through latent heat storage, where a material undergoes a phase change. However, TES materials that store thermochemical heat through a reversible chemical reaction or sorption process have the greatest potential. Even at the system level, where energy densities are smaller than on the material level, thermochemical heat storage is anticipated to offer higher energy densities than other heat storage systems. Furthermore, in addition to heat transfer, mass transfer also governs thermochemical heat storage, allowing heat to be stored indefinitely in these systems. However, practical complications are also associated with some forms of thermochemical heat storage (e.g., cost, toxicity, side reactions, slow kinetics due to heat and/or mass transfer, phase change, cyclic stability), although several classes of materials have been found to alleviate some of these complications.

In accordance with certain aspects of the present disclosure, a class of thermochemical heat storing materials for use in TES systems includes certain types of salt hydrates. Salt (de)hydration reactions reversibly store heat in the following way (expressed as Equation (1)):

$$heat + {M}_{p} {X}_{q} • m {H}_{2} O ↔ {M}_{p} {X}_{q} • n {H}_{2} O + ( m - n ) {H}_{2} {O}_{( g )} \qquad ( 1 )$$

where MₚX_{q} is the salt and m is greater than n. Heat is stored when the forward, endothermic, dehydration reaction occurs. This heat can in principle be stored indefinitely by separating the water and dehydrated salt until the reverse, exothermic, hydration reaction occurs, which releases the stored heat. Such (de)hydration reactions are desirable in TES systems due to the favorable properties of water (e.g., abundant, light, non-toxic, inexpensive). Additionally, these reactions generally store heat with high energy densities at moderate temperatures.

Salt hydrates have also been studied in the past; however, many salt hydrates have not yet been explicitly evaluated for use in TES, computationally or experimentally. The enthalpy of dehydration of a salt hydrate affects many aspects of TES performance, including energy density, temperature, and stability (described below in Equations 3-8). The uniformity and additivity of the enthalpy of dehydration may be a useful approximation for energy density, but it fails to aid in the design of operating temperature and stability of salt hydrates, which are more sensitive to variations in the enthalpy of dehydration. Indeed, averaged thermodynamic values (such as those from Thermodynamic Difference Rules) alone are unable to predict the relative stability of salt hydrates.

Machine learning (ML) provides a methodology to extract non-linear property-performance trends from material datasets. One common way of identifying property-performance relationships in ML models trained on materials datasets is with partial dependence plots of the input features. These plots visualize the averaged effect that each input feature has on the prediction. Even still, when extracting property-performance trends learned by ML models, there can be a risk of bias, both due to overfitting to the data as well as the inherent structure of the model.

Using known crystal structures of salt hydrates taken from the Inorganic Crystal Structure Database (ICSD) as templates, atomic substitution is performed to generate thousands of hypothetical salt hydrate candidates that are then evaluated for their applicability with TES via first-principles calculations. In one example, 3656 salt (de)hydration reactions are characterized according to their gravimetric and volumetric energy densities, operating temperature range, and stability. Fifteen particularly advantageous reactions for TES are identified, twelve of which involve salt hydrates that appear to be newly identified compounds. Thus, this material screening approach serves to both identify and characterize new salt hydrates, as well as create a dataset on which to perform interpretable ML.

In order to develop a better understanding of the thermodynamics of salt (de)hydration, four ML algorithms were trained on a multitude of datasets containing compositional and/or structural features to predict the enthalpy of dehydration. The optimum models were identified that either showed high predictive accuracy or interpretability. Design rules were then developed based on the knowledge gained from the interpretable models.

In certain aspects, the present disclosure provides select salt hydrate materials suitable for use in thermal energy systems (TES) represented by the formula: MX_{q}.nH₂O, where M is a cation, X is an anion, q is the oxidation state of cation M, and n is the hydrate number (number of water molecules of hydration per formula unit of salt hydrate). Six properties can significantly affect TES performance as described herein. In accordance with certain aspects of the present disclosure, these six properties may be as follows. In various aspects, the cation (M) electronegativity of the salt hydrate is less than or equal to about 1.8. Cations with lower electronegativities tend to have higher enthalpies of dehydration, resulting in higher energy densities. The cation (M) molar mass may be less than or equal to about 28 g/mol. Cations with lower molar masses tend to have higher enthalpies of dehydration, resulting in higher energy densities, especially gravimetrically. In certain aspects, the anion (X) has an electronegativity of greater than or equal to about 2.9 to less than or equal to about 3.2. Anions with electronegativities in this midrange tend to have slightly higher enthalpies of dehydration, resulting in higher energy densities. In certain variations, the hydrate number (n) is greater than or equal to about 2. Hydrates with higher hydrate numbers tend to have higher enthalpies of dehydration. This trend, plus the fact that the total heat stored is generally proportional to the amount of water stored, leads to the result that higher hydrate numbers tend to be associated with higher energy densities. In other aspects, a distance between a cation (M) and coordinating water molecules (of hydration) is less than or equal to about 2.1 Å. When this distance is small, the enthalpy of dehydration is larger, resulting in greater energy densities. In yet other aspects, a distance between nearest neighbor cations (M) is greater than or equal to about 4.1 Å. When this distance is large, the enthalpy of dehydration is larger, resulting in greater energy densities.

In certain variations, for domestic heating applications at lower temperatures, a salt hydrate may have a volumetric energy density of greater than or equal to about 1.3 GJ/m³, optionally greater than or equal to about 2 GJ/m³. In certain aspects, in the study Donkers et al., “A Review of Salt Hydrates for Seasonal Heat Storage in Domestic Applications,” Appl. Energy, 199, 45-68 (2017), it is estimated that a thermal energy storage system incorporating such a salt hydrate would have a system-level volumetric density of greater than or equal to about 1 GJ/m³ system. This would translate into storing 10 GJ of heat, the estimated requirement for domestic heating, in 10 m³ of space.

Regarding temperature stability, a suitable temperature range for the salt hydrate depends on the application. For example, in solar plants, heat is generally stored at several hundred degrees Celsius. For domestic heating applications, heat is generally stored at lower temperatures (less than or equal to about 100° C.). By way of example, in certain variations, at least one of the endothermic dehydration reaction and the exothermic hydration reaction of the salt hydrate occurs in a temperature range of optionally greater than or equal to about 450° C. to less than or equal to about 600° C., optionally at greater than or equal to about 300° C. to less than or equal to about 450° C., optionally at greater than or equal to about 200° C. to less than or equal to about 300° C., optionally at greater than or equal to about 100° C. to less than or equal to about 200° C., and optionally at greater than or equal to about 50° C. to less than or equal to about 100° C.

Furthermore, the salt hydrate for use in the thermal energy storage system according to certain aspects of the present disclosure has a minimal temperature hysteresis, which is a difference between the charging and discharging temperatures. Ideally, the temperature hysteresis would be 0, although in practice a larger temperature hysteresis may occur. A large temperature hysteresis indicates that the heat that charges a thermal battery must be at much higher temperature(s) than the heat that is discharged by the thermal battery. In some applications, this may be acceptable. However, in other applications, minimizing temperature hysteresis is desirable. In certain variations, salt hydrates provided in accordance with the present disclosure provide a salt (de)hydration reaction with a temperature hysteresis of less than or equal to about 50° C.

In certain aspects, the present disclosure provides select salt hydrate materials, suitable for use in thermal energy systems (TES), represented by the formula: MX_{q}.nH₂O, where M is a cation selected from Groups 1-14 of the IUPAC Periodic Table of Elements, including alkali metals (e.g., lithium (Li), sodium (Na), potassium (K), rubidium (Rb), cesium (Cs)), alkaline earth metals (e.g., beryllium (Be), magnesium (Mg), calcium (Ca), strontium (Sr), barium (Ba)), transition elements and metals (e.g., scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), iron (Fe), cobalt (Co), nickel (Ni), copper (Cu), zinc (Zn), aluminum (Al), gallium (Ga), silicon (Si), germanium (Ge), tin (Sn), and lead (Pb)), and rare earth metals or lanthanoids (e.g., lanthanum (La)). In certain variations, M is a cation selected from the group consisting of lithium (Li+), sodium (Na+), beryllium (Be²⁺), magnesium (Mg²⁺), and aluminum (Al³⁺). X is an anion selected as a halide of Group 17 of the IUPAC Periodic Table (e.g., fluorine (F⁻), chlorine (Cr), bromine (Bc), and iodine (t)), q is the oxidation state of the cation M of 1-4, and n is the hydrate number (number of water molecules of hydration) of 1-12.

In certain variations, X comprises fluorine (F) and forms a fluoride salt hydrate to define MF_{q}.nH₂O. Although fluorides on average have lower enthalpies of dehydration, a few specific fluorides have very large enthalpies of dehydration, leading to high energy densities. Furthermore, the small size and mass of fluoride further increases the energy densities.

Where X is chlorine (Cl) and M is magnesium (Mg) it forms salt hydrates, which at low temperatures are dodecahydrates. Thus, in certain aspects, a thermal energy storage material may possess a crystal structure similar to that of MgCl₂.12H₂O. In certain aspects, the salt hydrate may adopt a crystal structure similar to those of the following crystal structure templates: CaF₂.12H₂O, SrF₂.12H₂O, SnF₂.12H₂O, AlF₃.9H₂O, MgF₂.12H₂O, MnF₂.12H₂O, NiF₂.4H₂O, CrF₃.3H₂O, MgBr₂.12H₂O, CoF₃.3H₂O, AlCl₃.6H₂O, NiF₃.3H₂O, LiCl.H₂, RbF.H₂O, KF.2H₂O, NaCl.2H₂O, NaI2H₂O, LiI3H₂O, KF.4H₂O, SrCl₂.H₂O, CdCl₂.H₂O, BaCl₂.2H₂O, CaCl₂.2H₂O, CoCl₂.2H₂O, HgF₂.2H₂O, SnCl₂.2H₂O, SrCl₂.2H₂O, SrI₂.2H₂O, ZnF₂.2H₂O, BaBr₂.2H₂O, CaCl₂.4H₂O, CdBr₂.4H₂O, CuBr₂.4H₂O, FeCl₂.4H₂O, FeF₂.4H₂O, MnCl₂.4H₂O, ZnF₂.4H₂O, BeCl₂.4H₂O, CaCl₂.6H₂O, MgCl₂.6H₂O, NiCl₂.6H₂O, CaI₂.7H₂O, CaI₂.8H₂O, MgCl₂.8H₂O, MgI₂.8H₂O, CaBr₂.9H₂O, MgBr₂.9H₂O, MgCl₂.12H₂O, AlF₃.H₂O, BF₃.H₂O, BiCl₃.H₂O, BF₃.2H₂O, VF₃.2H₂O, AlF₃.3H₂O, CeCl₃.H₂O, InCl₃.H₂O, LaCl₃.H₂O, VF₃.3H₂O, CrF₃.3H₂O, FeF₃.3H₂O, InF₃.3H₂O, MnF₃.3H₂O, TlBr₃.4H₂O, VCl₃.H₂O, AlCl₃.6H₂O, GdCl₃.6H₂O, VCl₃.6H₂O, LaCl₃.7H₂O, ScCl₃.7H₂O, HoBr₃.8H₂O, ScI₃.H₂O, AlF₃.9H₂O, CrF₃.9H₂O, SmI₃.9H₂O, LuI₃.10H₂O, YBr₃.10H₂O, ZrF₄.H₂O, PtI₄.2H₂O, SnCl₄.2H₂O, UF₄.2H₂O, SnCl₄.3H₂O, ZrF₄.3H₂O, SnCl₄.4H₂O, PtCl₄.5H₂O, SnCl₄.5H₂O, SnCl₄.8H₂O, UBr₄.9H₂O, ThBr₄.10H₂O, and combinations thereof.

In some variations, the salt hydrate is a stable hydrate selected from the group consisting of: AlBr₃.H₂O, BaBr₂.12H₂O, BaF₂.2H₂O, BaF₂.12H₂O, BaI₂.12H₂O, BeBr₂.9H₂O, BeCl₂.12H₂O, BeF₂.9H₂O, BeI₂.2H₂O, BeI₂.8H₂O, BeI₂.12H₂O, CaBr₂.12H₂O, CaI₂.2H₂O, CaI₂.12H₂O, CoBr₂.12H₂O, CoBr₃.9H₂O, CoCl₂.12H₂O, CoCl₃.9H₂O, CoF₂.12H₂O, CoF₃.9H₂O, CoI₂.12H₂O, CrBr₂.4H₂O, CrBr₂.12H₂O, CrBr₄.8H₂O, CrCl₂.12H₂O, CrCl₄.8H₂O, CrF₂.4H₂O, CrF₂.12H₂O, CrF₄.5H₂O, CrF₄.8H₂O, CrI₂.4H₂O, CrI₂.12H₂O, CrI₃.9H₂O, CrI₄.3H₂O, CrI₄.8H₂O, CuBr₂.12H₂O, CuF.H₂O, CuF.2H₂O, CuF₂.4H₂O, CuF₂.12H₂O, CuI₂.4H₂O, FeBr₃.H₂O, FeBr₃.9H₂O, FeF₂.12H₂O, FeF₃.9H₂O, FeI₃.2H₂O, FeI₃.H₂O, GaBr₃.2H₂O, GaBr₃.9H₂O, GaF₃.9H₂O, GaI₃.H₂O, GaI₃.9H₂O, GeBr₂.4H₂O, GeBr₂.12H₂O, GeCl₂.2H₂O, GeCl₂.4H₂O, GeCl₂.12H₂O, GeCl₄.8H₂O, GeF₂.2H₂O, GeF₂.4H₂O, GeF₂.12H₂O, GeF₄.5H₂O, GeF₄.8H₂O, GeI₂.4H₂O, GeI₂.12H₂O, GeI₄.H₂O, HfBr₃.9H₂O, HfBr₄.2H₂O, HfBr₄.3H₂O, HfBr₄.4H₂O, HfBr₄.8H₂O, HfCl₃.9H₂O, HfCl₄.2H₂O, HfCl₄.3H₂O, HfCl₄.4H₂O, HfF₄.8H₂O, HfI₃.9H₂O, HfI₄.2H₂O, HfI₄.H₂O, LaF₃.9H₂O, LaI₂.12H₂O, LiF.4H₂O, MgBr₂.12H₂O, MgF₂.12H₂O, MgI₂.4H₂O, MgI₂.12H₂O, MnBr₂.12H₂O, MnBr₃.6H₂O, MnBr₄.8H₂O, MnCl₃.9H₂O, MnCl₄.8H₂O, MnF₂.12H₂O, MnF₃.9H₂O, MnF₄.2H₂O, MnF₄.4H₂O, MnF₄.5H₂O, MnF₄.8H₂O, MnI₂.12H₂O, MnI₃.6H₂O, MnI₄.H₂O, MoBr₃.9H₂O, MoBr₄.8H₂O, MoCl₃.2H₂O, MoCl₃.9H₂O, MoCl₄.4H₂O, MoCl₄.8H₂O, MoF₂.H₂O, MoF₃.3H₂O, MoF₃.9H₂O, MoF₄.2H₂O, MoF₄.5H₂O, MoF₄.8H₂O, MoI₃.9H₂O, MoI₄.H₂O, NaBr.H₂O, NaBr₄H₂O, NaF.4H₂O, NbBr₃.6H₂O, NbBr₃.9H₂O, NbBr₄.8H₂O, NbCl₃.9H₂O, NbCl₄.8H₂O, NbF₃.H₂O, NbF₃.9H₂O, NbF₄.5H₂O, NbF₄.8H₂O, NbI₃.6H₂O, NbI₃.9H₂O, NbI₄.8H₂O, NiBr₂.12H₂O, NiBr₃.6H₂O, NiCl₃.9H₂O, NiF₂.12H₂O, NiF₃.2H₂O, NiF₃.9H₂O, NiI₂.12H₂O, PbBr₂.2H₂O, PbBr₂.4H₂O, PbBr₂.12H₂O, PbBr₄.8H₂O, PbCl₂.12H₂O, PbCl₄.3H₂O, PbCl₄.8H₂O, PbF₂.2H₂O, PbF₂.12H₂O, PbF₄.2H₂O, PbF₄.3H₂O, PbF₄.5H₂O, PbI₂.4H₂O, PbI₂.12H₂O, PbI₄.5H₂O, RbBr₄H₂O, RbCl_{.4}H₂O, Rbl.4H₂O, ScBr₃.9H₂O, ScF₃.3H₂O, ScF₃.9H₂O, ScI₃.6H₂O, ScI₃.9H₂O, SiBr₂.8H₂O, SiBr₄.8H₂O, SiBr₄.9H₂O, SiCl₂.8H₂O, SiCl₄.8H₂O, SiCl₄.9H₂O, SiF₄.5H₂O, SiF₄.8H₂O, SiI₂.8H₂O, SiI₄.9H₂O, SnBr₂.4H₂O, SnBr₂.12H₂O, SnCl₂.12H₂O, SnF₂.4H₂O, SnF₂.12H₂O, SnF₄.2H₂O, SnF₄.5H₂O, SnF₄.8H₂O, SnI₂.4H₂O, SnI₂.12H₂O, SnI₄.H₂O, SnI₄.2H₂O, SnI₄.3H₂O, SrBr₂.12H₂O, SrCl₂.12H₂O, SrF₂.2H₂O, SrF₂.12H₂O, SrI₂.12H₂O, TaBr₃.6H₂O, TaBr₃.9H₂O, TaBr₄.8H₂O, TaCl₃.9H₂O, TaCl₄.8H₂O, TaF₃.H₂O, TaF₄.5H₂O, TaF₄.8H₂O, TaI₃.6H₂O, TaI₄.8H₂O, TiBr₂.H₂O, TiBr₂.12H₂O, TiBr₃.9H₂O, TiBr₄.8H₂O, TiCl₂.12H₂O, TiCl₃.H₂O, TiF₂.H₂O, TiF₂.12H₂O, TiF₃.3H₂O, TiF₃.9H₂O, TiF₄.5H₂O, TiF₄.8H₂O, TiI₂.12H₂O, TiI₃.9H₂O, TiI₄.8H₂O, VBr₂.12H₂O, VBr₃.9H₂O, VBr₄.8H₂O, VCl₂.H₂O, VCl₂.12H₂O, VCl₃.9H₂O, VCl₄.8H₂O, VF₂.12H₂O, VF₃.9H₂O, VF₄.2H₂O, VF₄.5H₂O, VF₄.8H₂O, VI₂.12H₂O, VI₃.9H₂O, VI₄.8H₂O, WBr₄.8H₂O, WCl₄.8H₂O, WF₄.5H₂O, WF₄.8H₂O, WI₄.8H₂O, YF₃.9H₂O, YI₃.7H₂O, YI₃.9H₂O, ZnBr₂.12H₂O, ZnCl₂.12H₂O, ZnF₂.12H₂O, ZnI₁₂.12H₂O, ZrBr₂.H₂O, ZrBr₂.12H₂O, ZrBr₃.9H₂O, ZrBr₄.2H₂O, ZrBr₄.3H₂O, ZrBr₄.4H₂O, ZrBr₄.8H₂O, ZrCl₂.H₂O, ZrCl₂.12H₂O, ZrCl₃.9H₂O, ZrF₃.9H₂O, ZrF₄.8H₂O, ZrI₃.9H₂O, ZrI₄.2H₂O, ZrI₄.8H₂O, and combinations thereof.

In some variations, the salt hydrate is a metastable hydrate selected from the group consisting: AlBr₃.4H₂O, AlBr₃.7H₂O, AlBr₃.8H₂O, AlBr₃.10H₂O, AlCl₃.H₂O, AlCl₃.H₂O, AlCl₃.H₂O, AlF₃.8H₂O, AlF₃.10H₂O, AlI₃.H₂O, AlI₃.2H₂O, AlI₃.3H₂O, AlI₃.4H₂O, AlI₃.7H₂O, AlI₃.8H₂O, AlI₃.10H₂O, BaBr₂.6H₂O, BaBr₂.7H₂O, BaBr₂.8H₂O, BaBr₂.9H₂O, B aF₂.H₂O, BaF₂.4H₂O, BaF₂.6H₂O, BaF₂.7H₂O, BaF₂.8H₂O, BaF₂.9H₂O, BaI₂.8H₂O, BaI₂.9H₂O, BeBr₂.H₂O, BeBr₂.2H₂O, BeBr₂.8H₂O, BeBr₂.12H₂O, BeCl₂.7H₂O, BeCl₂.8H₂O, BeCl₂.9H₂O, BeF₂.7H₂O, BeF₂.8H₂O, BeF₂.12H₂O, BeI₂.7H₂O, BeI₂.9H₂O, CaBr₂.7H₂O, CaBr₂.8H₂O, CaI₂.9H₂O, CoBr₂.8H₂O, CoBr₂.9H₂O, CoBr₃.H₂O, CoBr₃.3H₂O, CoBr₃.4H₂O, CoBr₃.7H₂O, CoBr₃.10H₂O, CoCl₃.H₂O, CoCl₃.H₂O, CoF₂.8H₂O, CoF₂.9H₂O, CoF₃.6H₂O, CoF₃.7H₂O, CoF₃.8H₂O, CoF₃.10H₂O, CoI₂.8H₂O, CoI₂.9H₂O, CoI₃.H₂O, CoI₃.6H₂O, CoI₃.7H₂O, CoI₃.9H₂O, CoI₃.10H₂O, CrBr₂.H₂O, CrBr₂.2H₂O, CrBr₂.7H₂O, CrBr₂.8H₂O, CrBr₂.9H₂O, CrBr₃.H₂O, CrBr₃.2H₂O, CrBr₃.3H₂O, CrBr₃.7H₂O, CrBr₃.10H₂O, CrBr₄.2H₂O, CrBr₄.3H₂O, CrBr₄.4H₂O, CrBr₄.5H₂O, CrBr₄.9H₂O, CrCl₂.H₂O, CrCl₂.7H₂O, CrCl₂.8H₂O, CrCl₂.9H₂O, CrCl₃.H₂O, CrCl₄.2H₂O, CrCl₄.3H₂O, CrCl₄.4H₂O, CrCl₄.5H₂O, CrF2.H₂O, CrF₂.6H₂O, CrF₂.7H₂O, CrF₂.8H₂O, CrF₂.9H₂O, CrF₄.3H₂O, CrF₄.4H₂O, CrI₂.H₂O, CrI₂.2H₂O, CrI₂.6H₂O, CrI₂.7H₂O, CrI₂.8H₂O, CrI₂.9H₂O, CrI₃.H₂O, CrI₃.2H₂O, CrI₃.4H₂O, CrI₃.7H₂O, CrI₃.8H₂O, CrI₃.10H₂O, CrI₄.2H₂O, CrI₄.4H₂O, CrI₄.5H₂O, CrI₄.9H₂O, CuBr₃H₂O, CuBr₂.7H₂O, CuBr₂.8H₂O, CuBr₂.9H₂O, CuCl₂.8H₂O, CuCl₂.9H₂O, CuF.3H₂O, CuF.4H₂O, CuF₂.6H₂O, CuF₂.8H₂O, CuF₂.9H₂O, CuI₂.6H₂O, CuI₂.8H₂O, CuI₂.9H₂O, CuI₂.12H₂O, FeBr₂.8H₂O, FeBr₂.12H₂O, FeBr₃.3H₂O, FeBr₃.4H₂O, FeBr₃.7H₂O, FeBr₃.8H₂O, FeBr₃.10H₂O, FeCl₂.8H₂O, FeF2.H₂O, FeF₂.2H₂O, FeF₂.6H₂O, FeF₂.9H₂O, FeF₃.2H₂O, FeF₃.4H₂O, FeF₃.6H₂O, FeF₃.7H₂O, FeF₃.8H₂O, FeF₃.10H₂O, FeI₂.7H₂O, FeI₂.8H₂O, FeI₂.12H₂O, FeI₃.H₂O, FeI₃.H₂O, FeI₃.7H₂O, FeI₃.H₂O, FeI₃.9H₂O, GaBr₃.H₂O, GaBr₃.4H₂O, GaBr₃.6H₂O, GaBr₃.7H₂O, GaBr₃.8H₂O, GaBr₃.10H₂O, GaCl₃.2H₂O, GaCl₃.H₂O, GaCl₃.H₂O, GaCl₃.7H₂O, GaCl₃.H₂O, GaCl₃.H₂O, GaF₃.4H₂O, GaF₃.6H₂O, GaF₃.7H₂O, GaF₃.10H₂O, GaI₃.H₂O, GaI₃.H₂O, GaI₃.6H₂O, GaI₃.7H₂O, GaI₃.H₂O, GeBr₂.H₂O, GeBr₂.2H₂O, GeBr₂.6H₂O, GeBr₂.7H₂O, GeBr₂.8H₂O, GeBr₂.9H₂O, GeBr₄.3H₂O, GeBr₄.4H₂O, GeBr₄.5H₂O, GeBr₄.9H₂O, GeCl₂.H₂O, GeCl₂.6H₂O, GeCl₂.7H₂O, GeCl₂.8H₂O, GeCl₂.9H₂O, GeCl₄.3H₂O, GeCl₄.4H₂O, GeCl₄.9H₂O, GeF₂.6H₂O, GeF₂.7H₂O, GeF₂.8H₂O, GeF₂.9H₂O, GeF₄.H₂O, GeF₄.4H₂O, GeF₄.9H₂O, GeI₂.H₂O, GeI₂.2H₂O, GeI₂.6H₂O, GeI₂.7H₂O, GeI₂.8H₂O, GeI₂.9H₂O, GeI₄.3H₂O, GeI₄.4H₂O, GeI₄.5H₂O, GeI₄.9H₂O, HfBr₃.6H₂O, HfBr₃.7H₂O, HfBr₃.8H₂O, HfBr₃.10H₂O, HfBr₄.5H₂O, HfBr₄.9H₂O, HfBr₄.10H₂O, HfCl₃.H₂O, HfCl₃.6H₂O, HfCl₃.7H₂O, HfCl₃.H₂O, HfCl₃.H₂O, HfCl₄.9H₂O, HfCl₄.10H₂O, tifF₃.9H₂O, HfF₃.10H₂O, HfF₄.4H₂O, HfF₄.5H₂O, HfF₄.9H₂O, HfI₃.6H₂O, HfI₃.7H₂O, HfI₃.H₂O, HfI₃.H₂O, HfI₄.3H₂O, HfI₄.4H₂O, HfI₄.5H₂O, HfI₄.9H₂O, HfI₄.10H₂O, LaBr₂.9H₂O, LaBr₂.12H₂O, LaBr₃.2H₂O, LaBr₃.10H₂O, LaCl_{.3}H₂O, LaCl_{.4}H₂O, LaCl₂.12H₂O, LaF₂.12H₂O, LaF₃.H₂O, LaF₃.4H₂O, LaF₃.7H₂O, LaF₃.8H₂O, LaF₃.10H₂O, LaI.4H₂O, LaI₂.7H₂O, LaI₂.8H₂O, LaI₂.9H₂O, LaI₃.H₂O, LaI₃.2H₂O, LaI₃.H₂O, LaI₃.H₂O, LaI₃.7H₂O, LaI₃.H₂O, LaI₃.H₂O, LiF.3H₂O, MgBr₂.7H₂O, MgF₂.6H₂O, MgF₂.8H₂O, MgI₂.H₂O, MnBr₂.7H₂O, MnBr₂.8H₂O, MnBr₂.9H₂O, MnBr₃.H₂O, MnBr₃.2H₂O, MnBr₃.3H₂O, MnBr₃.4H₂O, MnBr₃.7H₂O, MnBr₃.8H₂O, MnBr₃.9H₂O, MnBr₃.10H₂O, MnBr₄.2H₂O, MnBr₄.3H₂O, MnBr₄.5H₂O, MnBr₄.9H₂O, MnCl₃.H₂O, MnCl₃.H₂O, MnCl₃.7H₂O, MnCl₃.H₂O, MnCl₄.2H₂O, MnCl₄.3H₂O, MnCl₄.5H₂O, MnCl₄.9H₂O, MnF₂.6H₂O, MnF₂.8H₂O, MnF₂.9H₂O, MnF₃.4H₂O, MnF₃.6H₂O, MnF₃.7H₂O, MnF₄.H₂O, MnF₄.3H₂O, MnF₄.9H₂O, MnI₂.7H₂O, MnI₂.8H₂O, MnI₂.9H₂O, MnI₃.H₂O, MnI₃.2H₂O, MnI₃.3H₂O, MnI₃.H₂O, MnI₃.7H₂O, MnI₃.8H₂O, MnI₃.9H₂O, MnI₃.10H₂O, MnI₄.2H₂O, MnI₄.3H₂O, MnI₄.4H₂O, MnI₄.5H₂O, MoBr₂.12H₂O, MoBr₃.3H₂O, MoBr₃.4H₂O, MoBr₃.6H₂O, MoBr₃.7H₂O, MoBr₃.8H₂O, MoBr₃.10H₂O, MoBr₄.2H₂O, MoBr₄.3H₂O, MoBr₄.4H₂O, MoBr₄.5H₂O, MoBr₄.9H₂O, MoCl₂.12H₂O, MoCl₃.H₂O, MoCl₃.7H₂O, MoCl₃.H₂O, MoCl₃.H₂O, MoCl₄.H₂O, MoCl₄.3H₂O, MoCl₄.5H₂O, MoF₂.8H₂O, MoF₂.9H₂O, MoF₂.12H₂O, MoF₃.H₂O, MoF₃.2H₂O, MoF₃.4H₂O, MoF₃.6H₂O, MoF₃.7H₂O, MoF₃.8H₂O, MoF₃.10H₂O, MoF₄.3H₂O, MoF₄.4H₂O, MoF₄.9H₂O, MoI₂.12H₂O, MoI₃.H₂O, MoI₃.H₂O, MoI₃.6H₂O, MoI₃.7H₂O, MoI₃.H₂O, MoI₃.10H₂O, MoI₄.2H₂O, MoI₄.3H₂O, MoI₄.4H₂O, MoI₄.5H₂O, MoI₄.9H₂O, NaBr₃H₂O, NaF.H₂O, NaF.2H₂O, NaF.3H₂O, NbBr₃.2H₂O, NbBr₃.3H₂O, NbBr₃.4H₂O, NbBr₃.7H₂O, NbBr₃.8H₂O, NbBr₃.10H₂O, NbBr₄.2H₂O, NbBr₄.3H₂O, NbBr₄.4H₂O, NbBr₄.5H₂O, NbBr₄.9H₂O, NbCl₃.H₂O, NbCl₃.H₂O, NbCl₃.H₂O, NbCl₃.6H₂O, NbCl₃.7H₂O, NbCl₃.H₂O, NbCl₃.H₂O, NbCl₄.2H₂O, NbCl₄.3H₂O, NbCl₄.4H₂O, NbCl₄.5H₂O, NbCl₄.9H₂O, NbF₃.2H₂O, NbF₃.3H₂O, NbF₃.4H₂O, NbF₃.6H₂O, NbF₃.7H₂O, NbF₃.8H₂O, NbF₃.10H₂O, NbF₄.H₂O, NbF₄.2H₂O, NbF₄.3H₂O, NbF₄.4H₂O, NbF₄.9H₂O, NbI₃.2H₂O, NbI₃.H₂O, NbI₃.H₂O, NbI₃.7H₂O, NbI₃.H₂O, NbI₃.H₂O, NbI₄.2H₂O, NbI₄.3H₂O, NbI₄.4H₂O, NbI₄.5H₂O, NbI₄.9H₂O, NbI₄.10H₂O, NiBr₂.7H₂O, NiBr₂.8H₂O, NiBr₃.H₂O, NiBr₃.2H₂O, NiBr₃.3H₂O, NiBr₃.4H₂O, NiBr₃.7H₂O, NiBr₃.8H₂O, NiBr₃.9H₂O, NiBr₃.10H₂O, NiCl₃.H₂O, NiCl₃.H₂O, NiCl₃.H₂O, NiCl₃.10H₂O, NiF₂.H₂O, NiF₂.7H₂O, NiF₂.8H₂O, NiF₂.9H₂O, NiF₃.6H₂O, NiF₃.10H₂O, NiI₂.H₂O, NiI₂.2H₂O, NiI₂.7H₂O, NiI₂.8H₂O, NiI₂.9H₂O, NiI₃.2H₂O, NiI₃.3H₂O, NiI₃.6H₂O, NiI₃.7H₂O, NiI₃.8H₂O, NiI₃.9H₂O, NiI₃.H₂O, PbBr₂.6H₂O, PbBr₂.7H₂O, PbBr₂.8H₂O, PbBr₂.9H₂O, PbBr₄.3H₂O, PbBr₄.4H₂O, PbBr₄.5H₂O, PbBr₄.9H₂O, PbCl₂.H₂O, PbCl₂.7H₂O, PbCl₂.8H₂O, PbCl₂.9H₂O, PbCl₄.2H₂O, PbCl₄.4H₂O, PbCl₄.5H₂O, PbF₂.4H₂O, PbF₂.6H₂O, PbF₂.7H₂O, PbF₂.8H₂O, PbF₂.9H₂O, PbF₄.H₂O, PbF₄.4H₂O, PbI2.H₂O, PbI₂.6H₂O, PbI₂.7H₂O, PbI₂.8H₂O, PbI₂.9H₂O, PbI₄.H₂O, PbI₄.3H₂O, PbI₄.4H₂O, PbI₄.H₂O, PbI₄.9H₂O, RbBr.H₂O, RbBr₂H₂O, RbBr₃H₂O, RbCl.H₂O, RbCl_{.2}H₂O, RbCl_{.3}H₂O, Rb.IH₂O, RbI2H₂O, RbI3H₂O, ScBr₃.2H₂O, ScBr₃.8H₂O, ScBr₃.10H₂O, ScCl₃.H₂O, ScCl₃.H₂O, ScF₃.2H₂O, ScF₃.4H₂O, ScF₃.7H₂O, ScF₃.8H₂O, ScF₃.10H₂O, ScI₃.H₂O, ScI₃.H₂O, ScI₃.H₂O, ScI₃.7H₂O, ScI₃.H₂O, SiBr₂.4H₂O, SiBr₂.9H₂O, SiBr₂.12H₂O, SiBr₄.3H₂O, SiBr₄.4H₂O, SiBr₄.5H₂O, SiCl₂.4H₂O, SiCl₂.7H₂O, SiCl₂.9H₂O, SiCl₂.12H₂O, SiCl₄.3H₂O, SiCl₄.4H₂O, SiCl₄.5H₂O, SiF₂.2H₂O, SiF₂.8H₂O, SiF₄.3H₂O, SiF₄.4H₂O, SiF₄.9H₂O, SiI₂.4H₂O, SiI₂.6H₂O, SiI₂.9H₂O, SiI₂.12H₂O, SiI₄.H₂O, SnBr₂.6H₂O, SnBr₂.8H₂O, SnBr₂.9H₂O, SnBr₄.2H₂O, SnBr₄.3H₂O, SnBr₄.9H₂O, SnCl₂.8H₂O, SnF₂.6H₂O, SnF₂.7H₂O, SnF₂.8H₂O, SnF₂.9H₂O, SnF₄.H₂O, SnF₄.3H₂O, SnF₄.4H₂O, SnF₄.9H₂O, SnI₂.H₂O, SnI₂.6H₂O, SnI₂.7H₂O, SnI₂.8H₂O, SnI₂.9H₂O, SnI₄.4H₂O, SnI₄.9H₂O, SrBr₂.4H₂O, SrBr₂.7H₂O, SrBr₂.8H₂O, SrBr₂.9H₂O, SrCl₂.8H₂O, SrF₂.4H₂O, SrF₂.6H₂O, SrF₂.8H₂O, SrF₂.9H₂O, SrI₂.4H₂O, SrI₂.8H₂O, SrI₂.9H₂O, TaBr₃.H₂O, TaBr₃.2H₂O, TaBr₃.3H₂O, TaBr₃.4H₂O, TaBr₃.7H₂O, TaBr₃.8H₂O, TaBr₃.10H₂O, TaBr₄.2H₂O, TaBr₄.3H₂O, TaBr₄.4H₂O, TaBr₄.5H₂O, TaBr₄.9H₂O, TaCl₃.2H₂O, TaCl₃.H₂O, TaCl₃.H₂O, TaCl₃.6H₂O, TaCl₃.7H₂O, TaCl₃.H₂O, TaCl₃.H₂O, TaCl₄.2H₂O, TaCl₄.3H₂O, TaCl₄.4H₂O, TaCl₄.5H₂O, TaCl₄.9H₂O, TaF₃.9H₂O, TaF₃.10H₂O, TaF₄.2H₂O, TaF₄.3H₂O, TaF₄.4H₂O, TaF₄.9H₂O, TaI₃.H₂O, TaI₃.H₂O, TaI₃.7H₂O, TaI₃.H₂O, TaI₃.9H₂O, TaI₃.10H₂O, TaI₄.2H₂O, TaI₄.3H₂O, TaI₄.4H₂O, TaI₄.5H₂O, TaI₄.9H₂O, TaI₄.10H₂O, TiBr₂.2H₂O, TiBr₂.4H₂O, TiBr₂.7H₂O, TiBr₂.8H₂O, TiBr₂.9H₂O, TiBr₃.H₂O, TiBr₃.2H₂O, TiBr₃.3H₂O, TiBr₃.4H₂O, TiBr₃.7H₂O, TiBr₃.8H₂O, TiBr₃.10H₂O, TiBr₄.2H₂O, TiBr₄.3H₂O, TiBr₄.4H₂O, TiBr₄.5H₂O, TiBr₄.9H₂O, TiCl₂.4H₂O, TiCl₂.7H₂O, TiCl₂.8H₂O, TiCl₂.9H₂O, TiCl₃.H₂O, TiCl₃.2H₂O, TiCl₃.7H₂O, TiCl₃.H₂O, TiCl₃.H₂O, TiCl₄.3H₂O, TiCl₄.4H₂O, TiCl₄.9H₂O, TiF₂.4H₂O, TiF₂.6H₂O, TiF₂.8H₂O, TiF₂.9H₂O, TiF₃.2H₂O, TiF₃.6H₂O, TiF₃.7H₂O, TiF₃.8H₂O, TiF₄.3H₂O, TiF₄.9H₂O, TiI₂.H₂O, TiI₂.2H₂O, TiI₂.4H₂O, TiI₂.6H₂O, TiI₂.7H₂O, TiI₂.8H₂O, TiI₂.9H₂O, TiI₃.2H₂O, TiI₃.3H₂O, TiI₃.4H₂O, TiI₃.7H₂O, TiI₃.8H₂O, TiI₃.H₂O, TiI₄.2H₂O, TiI₄.3H₂O, TiI₄.4H₂O, TiI₄.5H₂O, TiI₄.9H₂O, VBr₂.H₂O, VBr₂.7H₂O, VBr₂.8H₂O, VBr₂.9H₂O, VBr₃.H₂O, VBr₃.2H₂O, VBr₃.3H₂O, VBr₃.7H₂O, VBr₃.8H₂O, VBr₄.2H₂O, VBr₄.3H₂O, VBr₄.4H₂O, VBr₄.5H₂O, VCl₂.6H₂O, VCl₂.7H₂O, VCl₂.8H₂O, VCl₂.9H₂O, VCl₃.H₂O, VCl₃.7H₂O, VCl₃.H₂O, VCl₃.H₂O, VCl₄.2H₂O, VCl₄.3H₂O, VCl₄.5H₂O, VF₂.2H₂O, VF₂.6H₂O, VF₂.7H₂O, VF₂.8H₂O, VF₂.9H₂O, VF₃.4H₂O, VF₃.6H₂O, VF₄.H₂O, VF₄.3H₂O, VF₄.4H₂O, VI₂.H₂O, VI₂.2H₂O, VI₂.7H₂O, VI₂.8H₂O, VI₂.9H₂O, VI₃.2H₂O, VI₃.H₂O, VI₃.H₂O, VI₃.7H₂O, VI₃.H₂O, VI₃.H₂O, VI₄.2H₂O, VI₄.3H₂O, VI₄.4H₂O, VI₄.5H₂O, VI₄.9H₂O, WBr₄.2H₂O, WBr₄.3H₂O, WBr₄.5H₂O, WBr₄.9H₂O, WCl₄.2H₂O, WCl₄.3H₂O, WCl₄.4H₂O, WCl₄.5H₂O, WCl₄.9H₂O, WF₄.2H₂O, WF₄.3H₂O, WF₄.4H₂O, WI₄.2H₂O, WI₄.3H₂O, WI₄.4H₂O, WI₄.5H₂O, WI₄.9H₂O, YBr₃.H₂O, YBr₃.2H₂O, YBr₃.4H₂O, YBr₃.7H₂O, YCl₃.H₂O, YCl₃.H₂O, YF₃.H₂O, YF₃.2H₂O, YF₃.4H₂O, YF₃.6H₂O, YF₃.7H₂O, YF₃.8H₂O, YF₃.10H₂O, YI₃.2H₂O, YI₃.4H₂O, YI₃.10H₂O, ZnBr₂.7H₂O, ZnBr₂.8H₂O, ZnBr₂.9H₂O, ZnF2.H₂O, ZnF₂.6H₂O, ZnF₂.8H₂O, ZnF₂.9H₂O, ZnI2.H₂O, ZnI₂.9H₂O, ZrBr₂.6H₂O, ZrBr₂.7H₂O, ZrBr₂.8H₂O, ZrBr₂.9H₂O, ZrBr₃.2H₂O, ZrBr₃.3H₂O, ZrBr₃.4H₂O, ZrBr₃.6H₂O, ZrBr₃.7H₂O, ZrBr₃.8H₂O, ZrBr₃.10H₂O, ZrBr₄.5H₂O, ZrBr₄.9H₂O, ZrBr₄.10H₂O, ZrCl₂.9H₂O, ZrCl₃.H₂O, ZrCl₃.2H₂O, ZrCl₃.H₂O, ZrCl₃.H₂O, ZrCl₃.6H₂O, ZrCl₃.7H₂O, ZrCl₃.H₂O, ZrCl₃.H₂O, ZrCl₄.9H₂O, ZrCl₄.10H₂O, ZrF₃.6H₂O, ZrF₃.7H₂O, ZrF₃.8H₂O, ZrF₃.10H₂O, ZrF₄.2H₂O, ZrF₄.5H₂O, ZrF₄.9H₂O, ZrI₂.12H₂O, ZrI₃.H₂O, ZrI₃.H₂O, ZrI₃.6H₂O, ZrI₃.7H₂O, ZrI₃.H₂O, ZrI₃.H₂O, ZrI₄.3H₂O, ZrI₄.4H₂O, ZrI₄.5H₂O, ZrI₄.9H₂O, ZrI₄.10H₂O, and combinations thereof.

In certain variations, the salt hydrate is selected from the group consisting of: LiCl.H₂O, RbF.H₂O, KF.2H₂O, NaCl.2H₂O, Nal.2H₂O, Lil.3H₂O, KF.4H₂O, SrCl₂.H₂O, CdCl₂.H₂O, BaCl₂.2H₂O, CaCl₂.2H₂O, CoCl₂.2H₂O, HgF₂.2H₂O, SnCl₂.2H₂O, SrCl₂.2H₂O, SrI₂.2H₂O, ZnF₂.2H₂O, BaBr₂.2H₂O, CaCl₂.4H₂O, CdBr₂.4H₂O, CuBr₂.4H₂O, FeCl₂.4H₂O, FeF₂.4H₂O, MnCl₂.4H₂O, ZnF₂.4H₂O, BeCl₂.4H₂O, CaCl₂.6H₂O, MgCl₂.6H₂O, NiCl₂.6H₂O, CaI₂.7H₂O, CaI₂.8H₂O, MgCl₂.8H₂O, MgI₂.8H₂O, CaBr₂.9H₂O, MgBr₂.9H₂O, MgCl₂.12H₂O, AlF₃.H₂O, BF₃.H₂O, BiCl₃.H₂O, BF₃.2H₂O, VF₃.2H₂O, AlF₃.3H₂O, CeCl₃.H₂O, InCl₃.H₂O, LaCl₃.H₂O, VF₃.3H₂O, CrF₃.3H₂O, FeF₃.3H₂O, InF₃.3H₂O, MnF₃.3H₂O, TlBr₃.4H₂O, VCl₃.H₂O, AlCl₃.6H₂O, GdCl₃.6H₂O, VCl₃.6H₂O, LaCl₃.7H₂O, ScCl₃.7H₂O, HoBr₃.8H₂O, ScI₃.8H₂O, AlF₃.9H₂O, CrF₃.9H₂O, SmI₃.9H₂O, LuI₃.10H₂O, YBr₃.10H₂O, ZrF₄.H₂O, Pt14.2H₂O, SnCl₄.2H₂O, UF₄.2H₂O, SnCl₄.3H₂O, ZrF₄.3H₂O, SnCl₄.4H₂O, PtCl₄.5H₂O, SnCl₄.5H₂O, SnCl₄.8H₂O, UBr₄.9H₂O, ThBr₄.10H₂O, and combinations thereof.

In certain other variations, the salt hydrate is selected from the group consisting of CaF₂.12H₂O, LiF₂.4H₂O, TiF₂.12H₂O, AlF₃.9H₂O, MgF₂.12H₂O, MnF₂.12H₂O, NiF₂.4H₂O, SiF₄.5H₂O, CrF₃.3H₂O, CoF₃.3H₂O, AlCl₃.6H₂O, NiF₃.3H₂O, CuF.H₂O, TiF₂.H₂O, FeF₃.H₂O, and combinations thereof.

While the above-described salt hydrates are particularly suitable for use in thermal energy storage systems, it will be appreciated that such materials may be used for other applications, as well. For example, some salt hydrate melts (the liquid that forms when a solid salt hydrate melts) have been used as electrolytes in Li-ion batteries. Like aqueous Li-ion batteries, they offer the potential for safer and more environmentally friendly batteries, but also possess higher (electrical) energy densities. Moreover, some salt hydrate melts appear to behave as solvents, for example, due to their ability to dissolve cellulose, which is a difficult polymer to dissolve. Salt hydrates can also be used for thermodynamically controlling the amount of water in a system. This is useful for controlling and/or catalyzing chemical reactions involving water. Some hydrates of salts containing fluoride have been found to readily capture CO₂ for carbon dioxide sequestration.

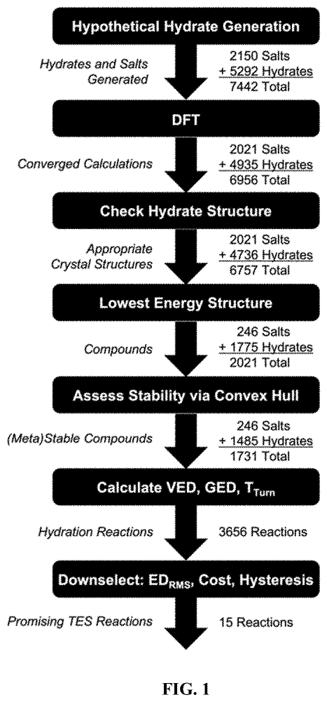

FIG. 1 shows a flow chart of a screening procedure used to identify promising TES reactions involving hydrate candidates (HC). This screening procedure was adapted to identify promising reactions from experimentally known salt hydrates. The main components of the adapted procedure are described below.

Salt Hydrate Candidate (HC) Generation.

TABLE 1

| | No. | | | |
|---|---|---|---|---|
| Cation | Crystal | No. | No. | No. Hydrate |
| Charge | Structures | Cations | Anions | candidates |
| 1+ | 7 | 10 | 4 | 280 |
| 2+ | 29 | 21 | 4 | 2436 |
| 3+ | 28 | 17 | 4 | 1904 |
| 4+ | 12 | 14 | 4 | 672 |
| Total | 76 | | | 5292 |

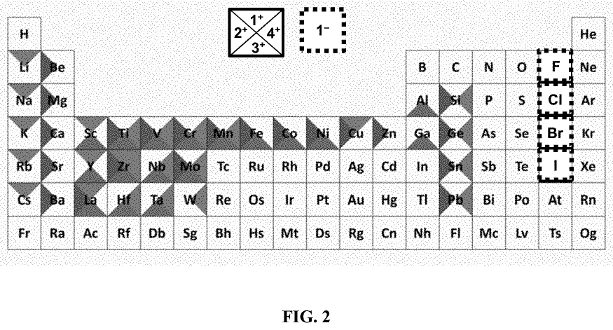

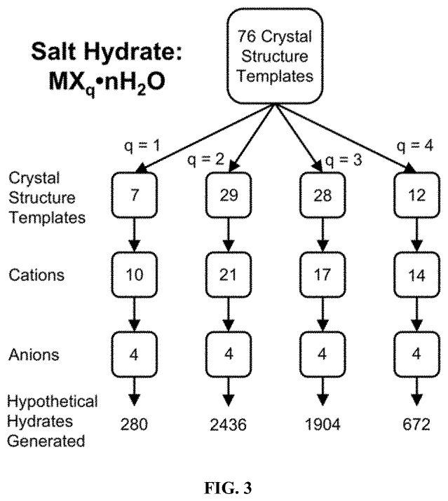

Table 1 shows a breakdown of the hydrate candidates generated by charge of cations. The number of salt hydrate (HC) candidates generated is based on the charge of the cation. To generate these HC, metal halide hydrates were identified from the ICSD, which yielded 76 distinct crystal structures that were used as templates. These templates are further divided into four categories according to the oxidation state of the cation. This is equivalent to categorizing the crystal structures as hydrates of MX, MX₂, MX₃, or MX₄ salts (with metal M and halide X). Crystal structures from hydrates of MX₂ salts could only substitute 2+cations in order to maintain charge neutrality. A similar restriction is placed on hydrates of MX, MX₃ and MX₄ salts. A total of 10 monovalent cations (Li¹⁺, Na¹⁺, K¹⁺, Rb¹⁺, Cs¹⁺, Sc¹⁺, Y¹⁺, La¹⁺, Zr¹⁺, Cu¹⁺), 21 divalent cations (Be²⁺, Mg²⁺, Ca²⁺, Sr²⁺, Ba²⁺, La²⁺, Ti²⁺, Zr²⁺, V²⁺, Cr²⁺, Mo²⁺, Mn²⁺, Fe²⁺, Co²⁺, Ni²⁺, Cu²⁺, Zn²⁺, Si²⁺, Ge²⁺Sn²⁺, Pb²⁺), trivalent cations (Sc³⁺, Y³⁺, La³⁺, Ti³⁺, Zr³⁺, Hf³⁺, V³⁺, Nb³⁺, Ta³⁺, Cr³⁺, Mo³⁺, Mn³⁺, Fe³⁺, Co³⁺, Ni³⁺, Al³⁺, Ga³⁺), and 14 tetravalent cations (Ti⁴⁺, Zr⁴⁺, Hf⁴⁺, V⁴⁺, Nb⁴⁺, Ta⁴⁺, Cr⁴⁺, Mo⁴⁺, W⁴⁺, Mn⁴⁺, Si⁴⁺, Ge⁴⁺, Sn⁴⁺, Pb⁴+) are used for cation substitution, as shown in FIG. 2. The chosen elements yield a systematic representation of the various metal groups, which is useful for the ML model, while eliminating many expensive metals. Additionally, 4 halides (F⁻, Cl⁻, BP⁻, I⁻) are used for anion substitution in all 76 templates. A total of 5292 HC were then generated by systematic substitution of the cation and anion into each template, as shown in FIG. 3.

In order to estimate energy densities for the HC, calculations are performed on the respective anhydrous salt crystal structures. When available, these are extracted from the ICSD. In the cases where the experimental crystal structure of the anhydrate was unknown, ionic substitution into crystal structures of known salts is performed, similar to the procedure used for the generation of HC. A total of 17, 37, 31, and 31 salt crystal structures are used for MX, MX₂, MX₃, and MX₄ salts, respectively. A total of 7442 DFT calculations are performed on experimentally known or hypothetical anhydrates. Additional details follow.

List of Crystal Structure Templates are shown in Table 2 below, which is complete list of the 76 experimental crystal structures from the ICSD used as crystal structure templates for generation of hydrate candidates here. 7 correspond with monovalent cations, 29 with divalent cations, 28 with trivalent cations, and 12 with tetravalent cations.

TABLE 2

| | | | | | | |
|---|---|---|---|---|---|---|
| LiCl•H₂O | RbF•H₂O | KF•2H₂O | NaCl•2H₂O | NaI•2H₂O | LiI•3H₂O | KF•4H₂O |
| SrCl₂•H₂O | CdCl₂•H₂O | BaCl₂•2H,O | CaCl₂•2H₂O | CoCl₂•2H₂O | HgF₂•2H₂O | SnCl₂•2H₂O |
| SrCl₂•2H₂O | SrI₂•2H₂O | ZnF₂•2H₂O | BaBr₂•2H₂O | CaCl₂•4H₂O | CdBr₂•4H₂O | CuBr₂•4H₂O |
| FeCl₂•4H₂O | FeF₂•4H₂O | MnCl₂•4H₂O | ZnF₂•4H₂O | BeCl₂•4H₂O | CaCl₂•6H₂O | MgCl₂•6H₂O |
| NiCl₂•6H₂O | CaI₂•7H₂O | CaI₂•8H₂O | MgCl₂•8H₂O | MgI₂•8H₂O | CaBr₂•9H₂O | MgBr₂•9H₂O |
| MgCl₂•12H₂O | AlF₃•H₂O | BF₃•H₂O | BiCl₃•H₂O | BF₃•2H₂O | VF₃•2H₂O | AlF₃•3H₂O |
| CeCl₃•3H₂O | InCl₃•3H₂O | LaCl₃•3H₂O | VF₃•3H₂O | CrF₃•3H₂O | FeF₃•3H₂O | InF₃•3H₂O |
| MnF₃•3H₂O | TlBr₃•4H₂O | VCl₃•4H₂O | AlCl₃•6H₂O | GdCl₃•6H₂O | VCl₃•6H₂O | LaCl₃•7H₂O |
| ScCl₃•7H₂O | HoBr₃•8H₂O | ScI₃•8H₂O | AlF₃•9H₂O | CrF₃•9H₂O | SmI₃•9H₂O | LuI₃•10H₂O |
| YBr₃•10H₂O | ZrF₄•H₂O | PtI₄•2H₂O | SnCl₄•2H₂O | UF₄•2H₂O | SnCl₄•3H₂O | ZrF₄•3H₂O |
| SnCl₄•4H₂O | PtCl₄•5H₂O | SnCl₄•5H₂O | SnCl₄•8H₂O | UBr₄•9H₂O | ThBr₄•10H₂O | |

For most anhydrous salts, experimental crystal structures are found in the ICSD which are used for the DFT calculations. However, for the salt compositions with missing crystal structures, a similar hypothetical crystal structure generation method as done with the hydrate candidates was performed on the salts. Table 3 shows a list of the salt compositions absent from the ICSD. Hypothetical crystal structure generation is performed for these compositions.

TABLE 3

| | | | | | | | | | | | | |
|---|---|---|---|---|---|---|---|---|---|---|---|---|
| LaF | ScBr | ScF | ScI | YBr | YF | YI | ZrF | ZrI | CuI₂ | GeCl₂ | LaCl₂ | LaF₂ |
| MoBr₂ | MoCl₂ | MoF₂ | SiBr₂ | SiF₂ | SiI₂ | TiI₂ | ZrBr₂ | ZrF₂ | CoBr₃ | CoCl₃ | CoI₃ | FeI₃ |
| HfBr₃ | HfCl₃ | HfF₃ | MnBr₃ | MnCl₃ | MnI₃ | NbBr₃ | NbCl₃ | NiBr₃ | NiCl₃ | NiI₃ | ScBr₃ | ScI₃ |
| TaBr₃ | TaCl₃ | TaI₃ | VBr₃ | VI₃ | YBr₃ | ZrF₃ | CrBr₄ | CrCl₄ | CrI₄ | HfBr₄ | MnBr₄ | MnCl₄ |
| MnI₄ | MoBr₄ | MoF₄ | MoI₄ | PbBr₄ | PbI₄ | TaBr₄ | TaF₄ | VBr₄ | VI₄ | WF₄ | WI₄ | ZrBr₄ |

A complete list of the 116 experimental crystal structures from the ICSD used as crystal structure templates for generation of hypothetical anhydrous salts in accordance with certain aspects of the present disclosure are shown in Table 4. 17 correspond with monovalent cations, 37 with divalent cations, 31 with trivalent cations, and 31 with tetravalent cations.

TABLE 4

| AgCl | AuCl | AuI | BiI | CoO | CsCl | CuBr | CuCl | CuI | InCl | LaI | NaCl | TeI |
|---|---|---|---|---|---|---|---|---|---|---|---|---|
| TlI | ZnS* | ZnS** | ZrCl | AgF₂ | AuTe₂ | BaCl₂ | BeBr₂ | BeF₂ | CaF₂ | CdCl₂ | CdI₂ | CsI₂ |
| CuCl₂ | CuZr₂ | GeBr₂ | HgBr₂ | HgCl₂ | HgI₂ | MoI₂ | MoS₂ | MoTe₂ | PbCl₂ | PbO₂ | PdBr₂ | PdCl₂ |
| PrI₂ | PtI₂ | SiCl₂ | SmF₂ | SnF₂ | SnI₂ | SrBr₂ | SrI₂ | TaS₂ | ThI₂ | TiO₂ | WTe₂ | YbCl₂ |
| ZnBt₂ | ZnCl₂ | AlBr₃ | AlF₃ | AlI₃ | AsBr₃ | AuCl₃ | BiCl₃ | BiI₃ | CrBr₃ | CsI₃ | FeF₃ | GaCl₃ |
| LaF₃ | MnF₃ | MoBr₃ | MoCl₃ | NdBr₃ | PtBr₃ | PuF₃ | ReCl₃ | ReO₃ | RhBr₃ | SbCl₃ | SbF₃ | SbI₃ |
| ScF₃ | SiCr₃ | ThI₃ | TiI₃ | UCl₃ | YF₃ | ZrCl₃ | CrF₄ | HfCl₄ | MnF₄ | MoCl₄ | NbCl₄ | NbI₄ |
| OsBr₄ | OsCl₄ | PbCl₄ | PdF₄ | ReCl₄ | SeBr₄ | SeCl₄ | SiCl₄ | SiF₄ | SnF₄ | SnI₄ | TaI₄ | TeF₄ |
| TeI₄ | ThI₄ | TiF₄ | TiI₄ | UBr₄ | UCl₄ | UF₄ | WBr₄ | WCl₄ | XeF₄ | ZrCl₄ | ZrI₄ | |

*Sphalerite phase
**Wurtzite phase

DFT Calculations. The ground state energies and relaxed geometries of all 5292 HC and 2150 anhydrates (7442 total) are evaluated using density functional theory (VASP code). Blochl's projector augmented wave method is used to model core-valence electron interactions. All calculations are spin-polarized and used a 500 eV plane-wave cutoff energy. The same calculation protocol for salt hydrates in Kiyabu, S., et al., “Computational Screening of Hydration Reactions for Thermal Energy Storage: New Materials and Design Rules,” Chem. Mater. 30, pp. 2006.2017 (2018) is used. Specifically, all lattice parameters and atomic positions in the crystal structure are initially relaxed until all atomic forces are less than 0.02 eV/Å using the van der Waals aware optPBE-vdW exchange-correlation functional. A Monkhorst-Pack k-point mesh of increasing density is used until energetic convergence of ˜2 meV/atom is achieved. Next, a single point energy calculation is performed to determine the ground state energy of the relaxed structure using the Perdew-Wang 91 (PW-91) exchange-correlation functional. This two-step process yields good agreement with the measured lattice constants and energetics of known hydrates. Of the 7442 DFT calculations attempted, only 486 failed to converge.

Determination of Lowest Energy Structures. Any given salt hydrate with distinct composition and hydrate number may have several hydrate candidates (HC) corresponding to it. For example, three HC for NiF₃.6H₂O are generated, specifically in the crystal structures of AlCl₃.6H₂O, GdCl₃.6H₂O, and VCl₃.6H₂O. For each salt hydrate, the corresponding HC with the lowest energy is assumed to be the most stable crystal structure for that hydrate and was thus considered to be the best theoretical prediction for that salt hydrate. Other HC of the salt hydrate that are higher in energy are discarded from the TES screening analysis.

Elimination of Unstable Compounds. A thermodynamic filter is applied via a convex hull analysis in order to remove thermodynamically unstable hydrates. A convex hull for each salt hydrate family is created using the lowest energy hydrates, the anhydrate, and ice. In order to apply the convex hull to a system of two “units” (the salt formula unit and water of hydration) rather than two elements, the enthalpy of formation must be normalized on a per “unit” basis rather than the conventional per atom basis. Unstable compounds are often defined in the literature as having a distance to the convex hull greater than 50 meV/atom. Unstable hydrates according to this convention are then discarded from consideration.

Characterization of Reactions by Energy Density and Operating Temperature Range. From the remaining stable/metastable hydrates and salts, a total of 3656 possible reactions are found. The enthalpy of dehydration (ΔH) for each reaction can be calculated from Equation 2 as follows,

$$Δ H = \frac{- {E}_{Hyd} + {E}_{Dehyd} + {nE}_{{H}_{2} O}}{n} \qquad ( 2 )$$

where E_{Hyd} is the energy of the salt hydrate, E_{Dehyd} is the energy of the dehydrated compound (either anhydrate or a lower hydrate), E_{H2O} is the energy of water vapor, and n is the number of moles of water liberated during dehydration per mole of salt. Knowledge of ΔH then informs several TES properties of the salt hydrate (de)hydration reaction. First, the volumetric energy density (VED) and gravimetric energy density (GED) for a salt (de)hydration reaction are given by Equations 3 and 4:

$$\begin{matrix}VED = \frac{n Δ H}{{V}_{Hyd}} & ( 3 ) \\ GED = \frac{n Δ H}{{MM}_{Hyd}} & ( 4 )\end{matrix}$$

where V_{Hyd} is the molar volume of the salt hydrate and MM_{Hyd} is the molar mass of the salt hydrate. V_{Hyd} can be determined from the DFT-relaxed crystal structure of the salt hydrate.

Additionally, the equilibrium condition for a single (de)hydration step of a salt hydrate (i.e., from a salt hydrate to the next stable hydrate) is given by the following Equation 5:

$$- RT ln ( \frac{p}{{p}_{0}} ) = Δ H - {T}_{Turn} Δ S \qquad ( 5 )$$

where p is the water vapor pressure, po is atmospheric pressure, T_{Turn} is the turning temperature, AS is the entropy of dehydration, and R is the ideal gas constant. A uniform ΔS of 146 J/(K mol H₂O) across all salt hydrates is assumed. When the water vapor pressure is 1 atmosphere, Equation 5 simplifies to Equation 6:

$${T}_{Turn} = \frac{Δ H}{Δ S} \qquad ( 6 )$$

yielding a simple metric to classify reactions by temperature.

The operating temperature range of (de)hydration reactions is indirectly dependent on the convex hull stabilities of the associated salt hydrates, which are also functions of ΔH. The coordinates of the hydrate on the convex hull plot can equivalently be calculated from n, ΔH (both with respect to the anhydrate), and the enthalpy of sublimation of water (ΔH_{subl}) using the following Equations (7)-(8).

$$\begin{matrix}{x}_{CH} = \frac{n}{n + 1} & ( 7 ) \\ {y}_{CH} = - ( Δ H - Δ {H}_{subl} ) \frac{n}{n + 1} . & ( 8 )\end{matrix}$$

The convex hull stability of salt hydrates affects the temperature range of (de)hydration reactions by determining whether or not there is a temperature hysteresis. Equations 5-6 only apply if no stable intermediates (i.e., hydrates on the convex hull) exist between the hydrated and dehydrated compounds. If stable intermediates do exist, the reaction is actually a series of step reactions across the stable intermediates, resulting in a set of turning temperatures. The full range from the maximum to the minimum turning temperature ideally may be accessible in order to reversibly cycle the full reaction. All 3656 reactions are categorized into one of several operating temperature categories (<50° C., 50° C.-100° C., 100° C.-200° C., 200° C.-300° C., 300° C.-450° C., 450° C.-600° C., and >600° C.) based on the mean of their maximum and minimum turning temperatures. However, reactions that spanned at least three temperature categories were labeled instead as having a “Large Hysteresis.”

Three reactions with the greatest root-mean-square energy density (ED_{RMS}), where ED_{RMS}=\sqrt{GED²+VED²}, are identified for each temperature category, although no promising reactions are found below 50° C. or above 600° C. A few additional criteria are imposed on the reactions of interest. First, cost is taken into account by removing all hydrates containing metals that are more expensive than lithium according to the U.S. Geological Survey. Second, reactions with a temperature hysteresis (difference between the maximum and minimum turning temperature) greater than 50° C. are discarded to avoid complexities associated with a wide operating temperature window. Third, in order to avoid potential problems with cyclic stability due to the use of metastable hydrates, only reactions involving hydrates that lie on the convex hull are considered for promising reactions.

Machine Learning. Machine learning (ML) models were trained on the database of 4736 HC that were characterized with DFT to predict ΔH. As shown by Equations 3-8, ΔH is a critical parameter for the TES performance of salt hydrates. Thus, it would be worthwhile to accurately predict ΔH for salt hydrates as well as understand simple design rules for ΔH. Four ML algorithms were used, including Ridge Regression (Ridge), k-Nearest Neighbors (k-NN), Support Vector Machine regression (SVM), and Random Forest regression (RF). All algorithms except for k-NN (which was an in-house Matlab code) were used as implemented in Matlab. For each of the four algorithms, a rigorous feature selection process was performed, as shown in FIG. 4. The main components of the process are described below.

Model Evaluation Details. For each model that was trained, 50% of the data was randomly withheld as the unseen test set to evaluate the performance of the model. Another 10% of the data was used as the validation set to optimize the hyperparameters, except for RF, which used only a single value of the hyperparameter to reduce cost. The sets of hyperparameters are shown in Table 5. To evaluate the test error of the model, many iterations of train/validation/test set splits were performed (minimum of five) until the standard deviation of the mean of the test errors was no higher than 0.1 kJ/mol H₂O.

TABLE 5

| Algorithm | Hyperparameters (Range of Values) |
|---|---|
| Ridge | Alpha (10⁻⁶, 10⁻⁵, . . . , 10⁶) |
| k-NN | k (1, 2, . . . , 20), weight (uniform, distance), power (1, 2) |
| SVM | Kernel (Gaussian, linear, polynomial) |
| RF | Trees (200) |

Feature Set Generation. A total of 35 feature sets were computed for the 4736 HC. Of these, 33 were computed using composition and structure featurizers from Matminer, one from a simple categorical representation of the HC, and one from chemical intuition. The categorical representation of a HC considers the three categorical features that define the HC during generation: the identity of the cation, the identity of the anion, and the identity of the crystal structure template. A one hot encoding scheme was used to represent the three categorical features, resulting in 142 boolean features (62 cations+4 anions+76 structures). Another feature set from chemical intuition contained 18 features, including fundamental cation and anion features (e.g., ionic radius, electronegativity, mass) as well as structural features of the DFT-relaxed crystal structure (e.g., nearest neighbor distances, coordination numbers).

A list of the features used and dataset are described below in Table 6 reflecting a chemically intuited salt hydrate feature set. Table 6 sets forth a description of the 18 salt hydrate features of interest. Structural features are computed from the DFT-optimized crystal structures of the hydrate candidates.

TABLE 6

| Feature | Units | Range | Description |
|---|---|---|---|
| n | — | 1-12 | Hydrate number (i.e. for MgCl₂•6H₂O, n = 6) |
| MM_{cat} | g/mol | 6.94-207.2 | Molar mass of the cation† |
| r_{cat} | Å | 0.54-1.81 | Ionic radius of cation assuming coordination number of 6‡ |
| X_{cat} | Pauling units | 0.79-2.36 | Electronegativity of cation according to Pauling Scale† |
| Z_{cat} | e | 1-4 | Formal charge of cation |
| Z_{eff, cat} | e | 1.3-7.85 | Effective nuclear charge of cation |
| PP_{cat} | e/Å | 0.55-7.41 | Polarizing power of the cation, equal to the formal charge divided by |
| | | | the ionic radius³ |
| e_{d, cat} | e | 0-10 | Number of d orbital electrons in cation |
| CN_{cat} | — | 4-8 | Preferred coordination number of the cation⁴ (assume CN_{cat} = 6 for |
| | | | cations missing from reference) |
| MMₐₙ | g/mol | 19-126.9 | Molar mass of the anion² |
| rₐₙ | Å | 1.19-2.06 | Ionic radius of anion assuming coordination number of 6‡ |
| Xₐₙ | Pauling units | 2.66-3.98 | Electronegativity of anion according to Pauling Scale† |
| r_{CW} | Å | 1.55-4.77 | Distance between nearest neighbor cations and water molecules in the |
| | | | hydrate |
| CN_{CW} | — | 1-10 | Number of nearest neighbor water molecules coordinating the cation |
| | | | in the hydrate |
| r_{CA} | Å | 1.52-5.68 | Distance between nearest neighbor cations and anions in the hydrate |
| CN_{CA} | — | 1-16 | Number of nearest neighbor anions coordinating the cation in the |
| | | | hydrate |
| r_{CC} | Å | 2.17-8.74 | Distance between nearest neighbor cations in the hydrate |
| CN_{CC} | — | 1-12 | Number of nearest neighbor cations coordinating the cation in the |
| | | | hydrate |

†Wolfram Research Inc. Mathematica. Champaign, IL 2016.
‡Shannon. R. D. Revised Effective Ionic Radii and Systematic Studies of Interatomic Distances in Halides and Chalcogenides. Acta. Cryst. 1976, 32, 751-767.

Feature Set Representations. Each original dataset was represented in 3 ways, resulting in a total of 105 single feature sets for each ML algorithm. First, a model was trained with and without normalizing the data to have a mean of 0 and a standard deviation of 1. If normalization reduced the test error, the first representation was the normalized dataset, otherwise it was the original dataset. For the second representation, Principal Component Analysis was performed on the dataset. Seven models were then trained on subsets of the principal components representing 5%, 10%, 25%, 50%, 75%, 90%, and 95% of the explained variance. The principal component subset with the lowest test error was selected for the second representation, favoring lower percentages in the case of ties. For the third representation, seven models were trained on the subset of the 5%, 10%, 25%, 50%, 75%, 90%, and 95% most important features, as determined by the magnitude of the coefficients from ordinary least squares regression performed on the normalized dataset. The feature subset with the lowest test error (favoring small feature sets in the case of ties) was chosen for the third representation. In all cases, a feature set was considered to have a lower test error than another if the test error of the first was at least one standard deviation of the mean (0.1 kJ/mol H₂O) lower than the second.

Feature Set Combination. A systematic search for the best feature set pair was performed. A total of 595 feature set pairs are possible among the 35 original feature sets. After accounting for the 3² ways to represent each feature set in each pair, a total of 5355 models were trained on these feature set pairs. Of these, the top performing models were identified. These top performing models demonstrated both high accuracy (within two standard deviations of the mean of the lowest test error) as well as significant improvement from constituent feature subsets (at least two standard deviations of the mean). If the same combination of original feature sets were represented multiple times (with different representations), redundant entries were removed. Each of these top performing feature sets was then combined with each representation of the original feature sets that were not included in that top performing feature set. After these models were evaluated, top performers were again identified. This process was repeated, each time adding another feature set, until convergence.

Genetic Algorithm Feature Selection. After the best feature set combination was identified, a genetic algorithm (GA), as implemented in Matlab, was used to perform feature selection on the best feature set. Each individual in the GA population was a ML model trained on the training set using a distinct subset of features. The fitness of each individual was the test error. The GA population of 100 individuals was allowed to evolve via mutation and crossover for 200 generations, or until convergence, in order to identify the optimal subset of features.

A genetic algorithm, as implemented in Matlab, is used to find the optimal feature subset that minimized the test error. K-Nearest Neighbor Regression: Matlab Code is as follows in Table 7.

```
TABLE 7
function y_pred = kNN_Regr(X_tr, Y_tr, X_tst, k, weight, power)
%Find Nearest Neighbors
[index, distance] = knnsearch(X_tr,X_tst,‘K’,k,‘Distance’,‘minkowski’,‘P’,power);
Y_k = Y_tr(index);
%Determine weight vector
switch weight
  case ‘uniform’
  w = 1/k * ones(size(index));
  case ‘distance’
  w = 1./distance;
  w = w./repmat(sum(w,2),l,size(w,2));
  otherwise
    %Default ‘uniform’ case
    w = 1/k * ones(size(index));
end
y_pred = sum(w.*Y_k,2);
end
```

The genetic algorithm created multiple generations of populations of ML models. Each generation includes 100 individuals (e.g., ML models trained on a subset of features). For each generation after the first, the 5 best individuals are kept from the previous generation, while the other 95 are generated (76 from scattered crossover and 19 from Gaussian mutation) using a stochastic uniform selection process for the parents. The genetic algorithm stops when convergence is reached (the relative change is less than 1e-6 over 50 generations) or after 200 generations, whichever occurs first.

Final Model Evaluation. The final model for each of the four ML algorithms was trained on the optimal feature set identified for the respective algorithm. Unlike the previous model evaluations during feature selection, the test accuracy of the final model was evaluated using 10-fold cross validation (i.e., 10% test set).

Hydrate candidates of monovalent cations, divalent cations, trivalent cations, and tetravalent cations are also analyzed. Stable hydrate, metastable hydrate, and hydrate salts are found experimentally in the ICSD.

Table 8 summarizes the 3,656 candidate (de)hydration reactions sorted by volumetric and gravimetric energy densities, charging and discharging temperatures, temperature hysteresis, temperature category, and largest distance to the convex hull between the hydrated and dehydrated compounds. (The suffix “_S1, _S2,” etc. associated with the hydrate name/composition identifies the crystal structure template that minimizes the energy of the hydrate.) Reactions are ordered by descending energy densities or ED_{R}ms. Because metastable compounds are included in this list, some reaction steps are endothermic, leading to unphysical temperatures when calculating the thermodynamic turning temperature.

TABLE 8

| | | | | | | | | E_{Hull} |
|---|---|---|---|---|---|---|---|---|
| | | VED | GED | T_{discharge} | T_{charge} | T_{hyst} | | (meV/ |
| Dehydrated | Hydrated | (GJ/m³) | (MJ/kg) | (° C.) | (° C.) | (° C.) | T_{category} | atom) |
| CoF3 | CoF3_9H2O_S2 | 4.397 | 2.498 | 203 | 361 | 158 | 200-300 C. | 0.0 |
| CoF3 | CoF3_6H2O_S1 | 4.480 | 2.053 | 143 | 361 | 218 | Large | 12.4 |
| | | | | | | | Hysteresis | |
| FeF3 | FeF3_9H2O_S2 | 4.054 | 2.368 | 182 | 551 | 370 | Large | 0.0 |
| | | | | | | | Hysteresis | |
| NiF3 | NiF3_9H2O_S2 | 4.035 | 2.331 | 174 | 328 | 154 | Large | 0.0 |
| | | | | | | | Hysteresis | |
| FeF3 | FeF3_6H2O_S1 | 4.201 | 1.979 | 161 | 551 | 390 | Large | 7.1 |
| | | | | | | | Hysteresis | |
| BeCl2 | BeCl2_4H2O_S8 | 3.816 | 2.508 | 375 | 384 | 9 | 300-450 C. | 0.0 |
| FeF3 | FeF3_10H2O_S2 | 3.973 | 2.222 | −275 | 551 | 826 | Large | 14.3 |
| | | | | | | | Hysteresis | |
| AlCl3 | AlCl3_9H2O_S2 | 3.714 | 2.585 | 202 | 401 | 198 | 300-450 C. | 0.0 |
| BeCl2 | BeCl2_7H2O_S1 | 3.718 | 2.558 | 60 | 384 | 324 | Large | 2.4 |
| | | | | | | | Hysteresis | |
| CoF3 | CoF3_3H2O_S9 | 4.171 | 1.635 | 361 | 361 | 0 | 300-450 C. | 0.0 |
| AlCl3 | AlCl3_6H2O_S1 | 3.833 | 2.302 | 353 | 401 | 47 | 300-450 C. | 0.0 |
| CoF3 | CoF3_7H2O_S1 | 4.023 | 1.940 | 55 | 361 | 306 | Large | 35.7 |
| | | | | | | | Hysteresis | |
| NiF3 | NiF3_6H2O_S2 | 4.001 | 1.977 | 152 | 328 | 176 | Large | 4.5 |
| | | | | | | | Hysteresis | |
| CoF3 | CoF3_8H2O_S2 | 3.957 | 2.035 | 71 | 361 | 290 | Large | 35.6 |
| | | | | | | | Hysteresis | |
| BeCl2 | BeCl2_9H2O_S1 | 3.660 | 2.529 | 43 | 384 | 341 | Large | 7.4 |
| | | | | | | | Hysteresis | |
| CrF3 | CrF3_9H2O_S2 | 3.765 | 2.311 | 177 | 257 | 80 | 200-300 C. | 0.0 |
| CoF3 | CoF3_10H2O_S2 | 3.857 | 2.132 | −708 | 361 | 1069 | Large | 33.6 |
| | | | | | | | Hysteresis | |
| NiF2 | NiF2_12H2O_S1 | 3.716 | 2.367 | 124 | 217 | 93 | 100-200 C. | 0.0 |
| BeCl2 | BeCl2_8H2O_S1 | 3.584 | 2.517 | 40 | 384 | 345 | Large | 7.4 |
| | | | | | | | Hysteresis | |
| CoF3 | CoF3_4H2O_S2 | 4.034 | 1.661 | −38 | 361 | 399 | Large | 22.8 |
| | | | | | | | Hysteresis | |
| MgCl2 | MgCl2_12H2O_S1 | 3.392 | 2.701 | 194 | 288 | 94 | 200-300 C. | 0.0 |
| BeCl2 | BeCl2_12H2O_S1 | 3.408 | 2.651 | 73 | 384 | 312 | Large | 0.0 |
| | | | | | | | Hysteresis | |
| MnF4 | MnF4_9H2O_S1 | 3.799 | 2.028 | −228 | 424 | 651 | Large | 13.0 |
| | | | | | | | Hysteresis | |
| MgCl2 | MgCl2_9H2O_S2 | 3.560 | 2.401 | 168 | 288 | 120 | 200-300 C. | 6.5 |
| MnF4 | MnF4_8H2O_S1 | 3.719 | 2.136 | 115 | 424 | 309 | Large | 0.0 |
| | | | | | | | Hysteresis | |
| CoF2 | CoF2_12H2O_S1 | 3.587 | 2.318 | 120 | 185 | 65 | 100-200 C. | 0.0 |
| FeF3 | FeF3_7H2O_S1 | 3.844 | 1.841 | 92 | 551 | 459 | Large | 32.6 |
| | | | | | | | Hysteresis | |
| GeF4 | GeF4_8H2O_S1 | 3.738 | 2.025 | 110 | 440 | 330 | Large | 0.0 |
| | | | | | | | Hysteresis | |
| A1F3 | AlF3_9H2O_S2 | 3.537 | 2.349 | 156 | 190 | 34 | 100-200 C. | 0.0 |
| VF2 | VF2_12H2O_S1 | 3.522 | 2.364 | 121 | 174 | 53 | 100-200 C. | 0.0 |
| AlCl3 | AlCl3_10H2O_S2 | 3.529 | 2.284 | −602 | 401 | 1003 | Large | 28.9 |
| | | | | | | | Hysteresis | |
| ZnF2 | ZnF2_12H2O_S1 | 3.533 | 2.249 | 119 | 174 | 55 | 100-200 C. | 0.0 |
| MnF4 | MnF4_5H2O_S2 | 3.736 | 1.890 | 215 | 424 | 209 | 300-450 C. | 0.0 |
| GeF4 | GeF4_5H2O_S2 | 3.789 | 1.782 | 223 | 440 | 217 | 300-450 C. | 0.0 |
| MoF3 | MoF3_9H2O_S2 | 3.662 | 2.019 | 191 | 252 | 61 | 200-300 C. | 0.0 |
| MgF2 | MgF2_12H2O_S1 | 3.375 | 2.459 | 116 | 121 | 4 | 100-200 C. | 0.0 |
| CuF2 | CuF2_12H2O_S1 | 3.515 | 2.238 | 110 | 179 | 70 | 100-200 C. | 0.0 |
| NiF3 | NiF3_3H2O_S9 | 3.867 | 1.509 | 280 | 328 | 49 | 300-450 C. | 0.0 |
| AlCl3 | AlCl3_8H2O_S2 | 3.526 | 2.179 | −106 | 401 | 506 | Large | 33.3 |
| | | | | | | | Hysteresis | |
| NiF3 | NiF3_10H2O_S2 | 3.636 | 1.960 | −737 | 328 | 1065 | Large | 34.9 |
| | | | | | | | Hysteresis | |
| NiF2 | NiF2_4H2O_S4 | 3.759 | 1.640 | 185 | 217 | 32 | 200-300 C. | 0.0 |
| MnF2 | MnF2_12H2O_S1 | 3.402 | 2.289 | 117 | 159 | 42 | 100-200 C. | 0.0 |
| BeBr2 | BeBr2_9H2O_S1 | 3.553 | 2.040 | 95 | 423 | 329 | Large | 0.0 |
| | | | | | | | Hysteresis | |
| BeBr2 | BeBr2_8H2O_S1 | 3.595 | 1.954 | 78 | 423 | 346 | Large | 3.8 |
| | | | | | | | Hysteresis | |
| CrF3 | CrF3_6H2O_S1 | 3.664 | 1.819 | 99 | 257 | 158 | Large | 16.2 |
| | | | | | | | Hysteresis | |
| TiF2 | TiF2_12H2O_S1 | 3.371 | 2.315 | 95 | 466 | 370 | Large | 0.0 |
| | | | | | | | Hysteresis | |
| FeF3 | FeF3_8H2O_S2 | 3.633 | 1.866 | 78 | 551 | 473 | Large | 39.0 |
| | | | | | | | Hysteresis | |
| CrF4 | CrF4_8H2O_S1 | 3.504 | 2.062 | 121 | 342 | 222 | Large | 0.0 |
| | | | | | | | Hysteresis | |
| CrF2 | CrF2_12H2O_S1 | 3.370 | 2.267 | 113 | 143 | 30 | 100-200 C. | 0.0 |
| NiF2 | NiF2_6H2O_S3 | 3.657 | 1.742 | 1 | 217 | 216 | Large | 17.8 |
| | | | | | | | Hysteresis | |
| BeBr2 | BeBr2_4H2O_S8 | 3.681 | 1.688 | 423 | 423 | 0 | 300-450 C. | 0.0 |
| CuF2 | CuF2_6H2O_S3 | 3.670 | 1.703 | 45 | 179 | 135 | Large | 9.4 |
| | | | | | | | Hysteresis | |
| NiF2_1H2O_S2 | NiF2_12H2O_S1 | 3.406 | 2.170 | 124 | 284 | 159 | 200-300 C. | 16.9 |
| VF3 | VF3_9H2O_S2 | 3.416 | 2.151 | 157 | 193 | 35 | 100-200 C. | 0.0 |
| GeF4 | GeF4_9H2O_S1 | 3.564 | 1.832 | −435 | 440 | 874 | Large | 22.8 |
| | | | | | | | Hysteresis | |
| MgBr2 | MgBr2_9H2O_S2 | 3.519 | 1.873 | 191 | 285 | 94 | 200-300 C. | 2.2 |
| FeF3 | FeF3_4H2O_S2 | 3.659 | 1.566 | 113 | 551 | 438 | Large | 19.4 |
| | | | | | | | Hysteresis | |
| FeF3 | FeF3_3H2O_S5 | 3.689 | 1.482 | 162 | 551 | 389 | Large | 4.5 |
| | | | | | | | Hysteresis | |
| AlCl3 | AlCl3_7H2O_S1 | 3.387 | 2.081 | −380 | 401 | 781 | Large | 35.3 |
| | | | | | | | Hysteresis | |
| VF2_1H2O_S2 | VF2_12H2O_S1 | 3.297 | 2.213 | 121 | 218 | 97 | 100-200 C. | 33.1 |
| AlBr3 | AlBr3_9H2O_S2 | 3.524 | 1.813 | 183 | 443 | 259 | Large | 0.0 |
| | | | | | | | Hysteresis | |
| CoF2_1H2O_S2 | CoF2_12H2O_S1 | 3.318 | 2.144 | 120 | 213 | 93 | 100-200 C. | 21.5 |
| NiF2 | NiF2_9H2O_S2 | 3.455 | 1.915 | 27 | 217 | 190 | Large | 24.5 |
| | | | | | | | Hysteresis | |
| SiF4 | SiF4_8H2O_S1 | 3.344 | 2.089 | 103 | 214 | 111 | 100-200 C. | 0.0 |
| AlCl3_1H2O_S2 | AlCl3_9H2O_S2 | 3.236 | 2.253 | 202 | 353 | 151 | 200-300 C. | 0.0 |
| MgF2_1H2O_S2 | MgF2_12H2O_S1 | 3.181 | 2.318 | 116 | 162 | 46 | 100-200 C. | 31.4 |
| CoF3 | CoF3_2H2O_S2 | 3.750 | 1.194 | 348 | 348 | 0 | 300-450 C. | 4.0 |
| BeBr2 | BeBr2_12H2O_S1 | 3.315 | 2.116 | 46 | 423 | 378 | Large | 0.1 |
| | | | | | | | Hysteresis | |
| MgBr2 | MgBr2_12H2O_S1 | 3.290 | 2.153 | 200 | 285 | 85 | 200-300 C. | 0.0 |
| MnF4 | MnF4_4H2O_S1 | 3.537 | 1.707 | 217 | 424 | 207 | 300-450 C. | 0.0 |
| CuF2 | CuF2_8H2O_S1 | 3.456 | 1.858 | 56 | 179 | 123 | 100-200 C. | 11.9 |
| MgCl2 | MgCl2_6H2O_S3 | 3.351 | 2.027 | 124 | 288 | 164 | 200-300 C. | 10.0 |
| MgCl2_1H2O_S2 | MgCl2_12H2O_S1 | 3.062 | 2.438 | 194 | 245 | 51 | 200-300 C. | 0.0 |
| FeF2 | FeF2_12H2O_S1 | 3.310 | 2.086 | 55 | 178 | 123 | 100-200 C. | 0.0 |
| MnF3 | MnF3_9H2O_S2 | 3.344 | 2.016 | 128 | 187 | 60 | 100-200 C. | 0.0 |
| GeF4 | GeF4_4H2O_S1 | 3.565 | 1.591 | 217 | 440 | 222 | 300-450 C. | 1.0 |
| CuF2 | CuF2_9H2O_S1 | 3.421 | 1.872 | 41 | 179 | 138 | Large | 17.2 |
| | | | | | | | Hysteresis | |
| CrF4 | CrF4_5H2O_S2 | 3.460 | 1.782 | 204 | 342 | 138 | 200-300 C. | 0.0 |
| AlBr3 | AlBr3_6H2O_S1 | 3.564 | 1.542 | 375 | 443 | 67 | 300-450 C. | 0.0 |
| SnF4 | SnF4_8H2O_S1 | 3.482 | 1.700 | 124 | 354 | 230 | Large | 0.0 |
| | | | | | | | Hysteresis | |
| CuF2_1H2O_S2 | CuF2_12H2O_S1 | 3.262 | 2.077 | 110 | 213 | 104 | 100-200 C. | 25.6 |
| CrF2_1H2O_S2 | CrF2_12H2O_S1 | 3.208 | 2.158 | 113 | 206 | 93 | 100-200 C. | 47.3 |
| CoF2 | CoF2_4H2O_S7 | 3.526 | 1.581 | 185 | 185 | 0 | 100-200 C. | 0.0 |
| CuF2 | CuF2_4H2O_S7 | 3.549 | 1.522 | 179 | 179 | 0 | 100-200 C. | 0.0 |
| ZnF2_1H2O_S2 | ZnF2_12H2O_S1 | 3.246 | 2.066 | 119 | 189 | 70 | 100-200 C. | 11.7 |
| VF4 | VF4_8H2O_S1 | 3.290 | 1.991 | 129 | 281 | 151 | 200-300 C. | 0.0 |
| NiF2 | NiF2_8H2O_S2 | 3.337 | 1.892 | 33 | 217 | 183 | Large | 20.4 |
| | | | | | | | Hysteresis | |
| CoF2 | CoF2_6H2O_S3 | 3.458 | 1.656 | −25 | 185 | 210 | Large | 20.9 |
| | | | | | | | Hysteresis | |
| BeF2 | BeF2_12H2O_S1 | 3.102 | 2.251 | 41 | 134 | 93 | Large | 0.7 |
| | | | | | | | Hysteresis | |
| VCl2 | VCl2_12H2O_S1 | 3.083 | 2.272 | 164 | 179 | 16 | 100-200 C. | 0.0 |
| MgCl2 | MgCl2_8H2O_S2 | 3.091 | 2.260 | 146 | 288 | 141 | 200-300 C. | 10.6 |
| FeF3_1H2O_S2 | FeF3_9H2O_S2 | 3.305 | 1.931 | 182 | 182 | 0 | 100-200 C. | 0.0 |
| AlF3 | AlF3_6H2O_S1 | 3.350 | 1.821 | 63 | 190 | 127 | 100-200 C. | 19.1 |
| GaF3 | GaF3_9H2O_S2 | 3.301 | 1.906 | 146 | 146 | 0 | 100-200 C. | 0.0 |
| BeF2 | BeF2_9H2O_S1 | 3.128 | 2.176 | 48 | 134 | 85 | Large | 0.0 |
| | | | | | | | Hysteresis | |
| MnF2_1H2O_S2 | MnF2_12H2O_S1 | 3.155 | 2.123 | 117 | 186 | 69 | 100-200 C. | 20.3 |
| AlF3 | AlF3_10H2O_S2 | 3.218 | 1.999 | −616 | 190 | 805 | Large | 29.5 |
| | | | | | | | Hysteresis | |
| MoF3 | MoF3_6H2O_S1 | 3.466 | 1.525 | 111 | 252 | 140 | 100-200 C. | 16.4 |
| TiF4 | TiF4_8H2O_S1 | 3.219 | 1.993 | 121 | 241 | 120 | 100-200 C. | 0.0 |
| CaCl2 | CaCl2_12H2O_S1 | 2.944 | 2.375 | 169 | 187 | 18 | 100-200 C. | 0.0 |
| NiF3 | NiF3_4H2O_S2 | 3.487 | 1.458 | −153 | 328 | 481 | Large | 30.9 |
| | | | | | | | Hysteresis | |
| CoF2 | CoF2_8H2O_S1 | 3.318 | 1.807 | 15 | 185 | 169 | Large | 23.4 |
| | | | | | | | Hysteresis | |
| TiF3 | TiF3_9H2O_S2 | 3.156 | 2.058 | 143 | 149 | 5 | 100-200 C. | 0.0 |
| AlBr3 | AlBr3_10H2O_S2 | 3.371 | 1.668 | −493 | 443 | 936 | Large | 24.0 |
| | | | | | | | Hysteresis | |
| SiF4 | SiF4_5H2O_S2 | 3.273 | 1.821 | 210 | 214 | 5 | 200-300 C. | 0.0 |
| ZnF2 | ZnF2_4H2O_S4 | 3.433 | 1.487 | 174 | 174 | 0 | 100-200 C. | 0.0 |
| ZnF2 | ZnF2_6H2O_S3 | 3.386 | 1.592 | −14 | 174 | 188 | Large | 19.2 |
| | | | | | | | Hysteresis | |
| CuF1 | CuF1_2H2O_S3 | 3.477 | 1.372 | 111 | 458 | 347 | Large | 0.0 |
| | | | | | | | Hysteresis | |
| CoF3_2H2O_S2 | CoF3_9H2O_S2 | 3.249 | 1.846 | 203 | 388 | 185 | 200-300 C. | 4.0 |
| VF2 | VF2_4H2O_S4 | 3.366 | 1.621 | 174 | 174 | 0 | 100-200 C. | 0.0 |
| CuF1 | CuF1_3H2O_S1 | 3.411 | 1.506 | 22 | 458 | 436 | Large | 3.5 |
| | | | | | | | Hysteresis | |
| FeF2 | FeF2_4H2O_S7 | 3.372 | 1.588 | 178 | 178 | 0 | 100-200 C. | 0.0 |
| BeI2 | BeI2_8H2O_S1 | 3.377 | 1.574 | 99 | 461 | 363 | Large | 0.0 |
| | | | | | | | Hysteresis | |
| MgCl2_1H2O_S2 | MgCl2_9H2O_S2 | 3.088 | 2.083 | 168 | 245 | 77 | 200-300 C. | 6.5 |
| AlBr3 | AlBr3_8H2O_S2 | 3.382 | 1.559 | −58 | 443 | 500 | Large | 26.0 |
| | | | | | | | Hysteresis | |
| MoF4_S19 | MoF4_8H2O_S1 | 3.301 | 1.722 | 128 | 235 | 108 | 100-200 C. | 0.0 |
| FeF2 | FeF2_9H2O_S2 | 3.221 | 1.853 | 16 | 178 | 163 | Large | 10.0 |
| | | | | | | | Hysteresis | |
| BeF2 | BeF2_8H2O_S1 | 3.051 | 2.121 | 44 | 134 | 90 | Large | 1.1 |
| | | | | | | | Hysteresis | |
| BeI2 | BeI2_7H2O_S1 | 3.401 | 1.494 | 86 | 461 | 375 | Large | 2.3 |
| | | | | | | | Hysteresis | |
| VF2 | VF2_6H2O_S3 | 3.305 | 1.693 | −25 | 174 | 199 | Large | 21.0 |
| | | | | | | | Hysteresis | |
| FeF3_1H2O_S2 | FeF3_10H2O_S2 | 3.238 | 1.811 | −275 | 182 | 456 | Large | 14.3 |
| | | | | | | | Hysteresis | |
| ZnF2 | ZnF2_9H2O_S1 | 3.248 | 1.786 | 19 | 174 | 155 | Large | 25.2 |
| | | | | | | | Hysteresis | |
| MoF3_1H2O_S2 | MoF3_9H2O_S2 | 3.244 | 1.788 | 191 | 265 | 74 | 200-300 C. | 5.7 |
| MnF4_1H2O_S1 | MnF4_8H2O_S1 | 3.211 | 1.844 | 115 | 570 | 455 | Large | 27.6 |
| | | | | | | | Hysteresis | |
| NaF1 | NaF1_4H2O_S1 | 3.103 | 2.019 | 121 | 121 | 0 | 100-200 C. | 0.0 |
| CaF2 | CaF2_12H2O_S1 | 2.971 | 2.205 | 97 | 97 | 0 | 50-100 C. | 0.0 |
| MgI2 | MgI2_9H2O_S2 | 3.365 | 1.525 | 209 | 284 | 75 | 200-300 C. | 0.0 |
| VF3 | VF3_6H2O_S1 | 3.296 | 1.667 | 84 | 193 | 109 | 100-200 C. | 15.2 |
| MnF4 | MnF4_3H2O_S1 | 3.386 | 1.465 | 190 | 424 | 233 | Large | 2.9 |
| | | | | | | | Hysteresis | |
| VF2 | VF2_9H2O_S2 | 3.179 | 1.868 | 12 | 174 | 162 | Large | 27.5 |
| | | | | | | | Hysteresis | |
| FeF2 | FeF2_6H2O_S3 | 3.297 | 1.640 | −41 | 178 | 219 | Large | 13.9 |
| | | | | | | | Hysteresis | |
| AlCl3_1H2O_S2 | AlCl3_6H2O_S1 | 3.154 | 1.894 | 353 | 353 | 0 | 300-450 C. | 0.0 |
| NiF3 | NiF3_2H2O_S2 | 3.492 | 1.157 | 328 | 328 | 0 | 300-450 C. | 0.0 |
| VF2 | VF2_8H2O_S2 | 3.151 | 1.875 | 28 | 174 | 145 | Large | 20.7 |
| | | | | | | | Hysteresis | |
| VCl2 | VCl2_9H2O_S2 | 3.118 | 1.927 | 124 | 179 | 56 | 100-200 C. | 10.1 |
| MnCl2 | MnCl2_12H2O_S1 | 2.944 | 2.175 | 146 | 174 | 28 | 100-200 C. | 0.0 |
| SiF4 | SiF4_9H2O_S1 | 3.179 | 1.813 | −518 | 214 | 733 | Large | 26.7 |
| | | | | | | | Hysteresis | |
| FeF2 | FeF2_8H2O_S2 | 3.167 | 1.834 | 23 | 178 | 155 | Large | 7.2 |
| | | | | | | | Hysteresis | |
| SnF4 | SnF4_5H2O_S2 | 3.371 | 1.413 | 227 | 354 | 127 | 200-300 C. | 0.0 |
| GeF4 | GeF4_3H2O_S1 | 3.388 | 1.355 | 183 | 440 | 256 | Large | 4.3 |
| | | | | | | | Hysteresis | |
| BeI2 | BeI2_9H2O_S1 | 3.293 | 1.568 | −96 | 461 | 557 | Large | 7.6 |
| | | | | | | | Hysteresis | |
| TiCl2 | TiCl2_12H2O_S1 | 2.911 | 2.196 | 130 | 329 | 199 | Large | 0.0 |
| | | | | | | | Hysteresis | |
| CoF2 | CoF2_9H2O_S2 | 3.203 | 1.734 | −24 | 185 | 208 | Large | 36.1 |
| | | | | | | | Hysteresis | |
| BeF2 | BeF2_4H2O_S8 | 3.134 | 1.852 | 76 | 134 | 58 | 100-200 C. | 0.0 |
| BeF2 | BeF2_7H2O_S1 | 2.994 | 2.070 | 41 | 134 | 92 | Large | 1.3 |
| | | | | | | | Hysteresis | |
| CrCl2 | CrCl2_12H2O_S1 | 2.928 | 2.157 | 122 | 190 | 69 | 100-200 C. | 0.0 |
| NbF3 | NbF3_9H2O_S2 | 3.149 | 1.819 | 134 | 362 | 229 | Large | 0.0 |
| | | | | | | | Hysteresis | |
| GeF4_1H2O_S1 | GeF4_8H2O_S1 | 3.197 | 1.732 | 110 | 564 | 455 | Large | 23.6 |
| | | | | | | | Hysteresis | |
| CrF2 | CrF2_9H2O_S1 | 3.137 | 1.837 | 28 | 143 | 115 | Large | 21.3 |
| | | | | | | | Hysteresis | |
| CuF1 | CuF1_4H2O_S1 | 3.278 | 1.566 | −1 | 458 | 459 | Large | 10.4 |
| | | | | | | | Hysteresis | |
| ZnF2 | ZnF2_8H2O_S2 | 3.173 | 1.764 | 28 | 174 | 146 | Large | 20.5 |
| | | | | | | | Hysteresis | |
| MoF4_S19 | MoF4_9H2O_S1 | 3.302 | 1.501 | −567 | 235 | 802 | Large | 29.0 |
| | | | | | | | Hysteresis | |
| AlCl3_1H2O_S2 | AlCl3_10H2O_S2 | 3.044 | 1.970 | −602 | 353 | 955 | Large | 28.9 |
| | | | | | | | Hysteresis | |
| CrF2 | CrF2_6H2O_S3 | 3.229 | 1.643 | 9 | 143 | 134 | Large | 15.0 |
| | | | | | | | Hysteresis | |
| SiF4_1H2O_S1 | SiF4_8H2O_S1 | 3.062 | 1.913 | 103 | 402 | 299 | Large | 35.6 |
| | | | | | | | Hysteresis | |
| CoCl2 | CoCl2_12H2O_S1 | 2.951 | 2.078 | 137 | 137 | 0 | 100-200 C. | 0.0 |
| BeBr2_1H2O_S1 | BeBr2_9H2O_S1 | 3.129 | 1.796 | 95 | 471 | 377 | Large | 36.2 |
| | | | | | | | Hysteresis | |
| TaF3 | TaF3_9H2O_S2 | 3.292 | 1.462 | 98 | 762 | 664 | Large | 13.5 |
| | | | | | | | Hysteresis | |
| ScCl3 | ScCl3_9H2O_S2 | 2.935 | 2.081 | 215 | 240 | 25 | 200-300 C. | 0.0 |
| MgF2_2H2O_S3 | MgF2_12H2O_S1 | 2.900 | 2.113 | 116 | 184 | 68 | 100-200 C. | 21.3 |
| BeI2 | BeI2_12H2O_S1 | 3.137 | 1.737 | 54 | 461 | 407 | Large | 0.0 |
| | | | | | | | Hysteresis | |
| NiCl2 | NiCl2_12H2O_S1 | 2.942 | 2.042 | 130 | 130 | 0 | 100-200 C. | 0.0 |
| FeF2_1H2O_S2 | FeF2_12H2O_S1 | 3.029 | 1.909 | 55 | 203 | 148 | Large | 18.9 |
| | | | | | | | Hysteresis | |
| ZnCl2 | ZnCl2_12H2O_S1 | 2.926 | 2.047 | 139 | 139 | 0 | 100-200 C. | 0.0 |
| VF4 | VF4_5H2O_S2 | 3.153 | 1.675 | 188 | 281 | 93 | 200-300 C. | 0.0 |
| BeI2 | BeI2_4H2O_S8 | 3.336 | 1.265 | 443 | 461 | 18 | 450-600 C. | 0.0 |
| ScF3 | ScF3_9H2O_S2 | 2.970 | 1.976 | 123 | 125 | 2 | 100-200 C. | 0.0 |
| AlCl3_2H2O_S1 | AlCl3_9H2O_S2 | 2.926 | 2.037 | 202 | 401 | 198 | 300-450 C. | 28.7 |
| CrF4 | CrF4_4H2O_S1 | 3.196 | 1.574 | 190 | 342 | 152 | Large | 2.4 |
| | | | | | | | Hysteresis | |
| MgBr2_1H2O_S2 | MgBr2_12H2O_S1 | 2.979 | 1.949 | 200 | 270 | 70 | 200-300 C. | 0.0 |
| NiF2_2H2O_S4 | NiF2_12H2O_S1 | 2.998 | 1.910 | 124 | 185 | 61 | 100-200 C. | 0.0 |
| NbF4 | NbF4_8H2O_S1 | 3.120 | 1.699 | 143 | 206 | 63 | 100-200 C. | 0.0 |
| MgI2 | MgI2_12H2O_S1 | 3.077 | 1.773 | 195 | 284 | 89 | 200-300 C. | 0.0 |
| CuF1 | CuF1_1H2O_S2 | 3.389 | 1.061 | 458 | 458 | 0 | 450-600 C. | 0.0 |
| MgF2 | MgF2_9H2O_S2 | 2.981 | 1.921 | 3 | 121 | 118 | Large | 28.7 |
| | | | | | | | Hysteresis | |
| CrF3 | CrF3_3H2O_S9 | 3.241 | 1.424 | 257 | 257 | 0 | 200-300 C. | 0.0 |
| CoF2_2H2O_S4 | CoF2_12H2O_S1 | 2.972 | 1.921 | 120 | 216 | 96 | 100-200 C. | 10.5 |
| CrCl2 | CrCl2_9H2O_S2 | 3.016 | 1.846 | 77 | 190 | 113 | 100-200 C. | 11.2 |
| AlCl3 | AlCl3_4H2O_S2 | 3.107 | 1.681 | 291 | 401 | 110 | 300-450 C. | 17.8 |
| VF2_2H2O_S4 | VF2_12H2O_S1 | 2.933 | 1.968 | 121 | 208 | 87 | 100-200 C. | 11.3 |
| LiF1 | LiF1_4H2O_S1 | 2.944 | 1.949 | 54 | 54 | 0 | 50-100 C. | 0.0 |
| MgCl2_2H2O_S8 | MgCl2_12H2O_S1 | 2.757 | 2.196 | 194 | 202 | 8 | 100-200 C. | 0.0 |
| MnF2 | MnF2_6H2O_S3 | 3.129 | 1.608 | −30 | 159 | 188 | Large | 21.1 |
| | | | | | | | Hysteresis | |
| AlBr3 | AlBr3_7H2O_S1 | 3.202 | 1.427 | −392 | 443 | 835 | Large | 34.8 |
| | | | | | | | Hysteresis | |
| MnF2 | MnF2_9H2O_S2 | 3.020 | 1.778 | 3 | 159 | 156 | Large | 28.7 |
| | | | | | | | Hysteresis | |
| ScCl3 | ScCl3_10H2O_S2 | 2.999 | 1.807 | −638 | 240 | 879 | Large | 30.5 |
| | | | | | | | Hysteresis | |
| VCl2_1H2O_S2 | VCl2_12H2O_S1 | 2.818 | 2.076 | 164 | 165 | 1 | 100-200 C. | 0.0 |
| MgF2 | MgF2_4H2O_S7 | 3.052 | 1.711 | 121 | 121 | 0 | 100-200 C. | 0.0 |
| MnF2 | MnF2_4H2O_S7 | 3.143 | 1.528 | 159 | 159 | 0 | 100-200 C. | 0.0 |
| TiF4 | TiF4_5H2O_S2 | 3.058 | 1.689 | 209 | 241 | 32 | 200-300 C. | 0.0 |
| CrF3_2H2O_S2 | CrF3_9H2O_S2 | 2.976 | 1.827 | 177 | 417 | 240 | Large | 24.2 |
| | | | | | | | Hysteresis | |
| MnF2 | MnF2_8H2O_S2 | 2.993 | 1.788 | 21 | 159 | 138 | Large | 21.5 |
| | | | | | | | Hysteresis | |
| MgBr2_1H2O_S2 | MgBr2_9H2O_S2 | 3.077 | 1.637 | 191 | 270 | 78 | 200-300 C. | 2.2 |
| CaCl2 | CaCl2_9H2O_S2 | 2.868 | 1.973 | 107 | 187 | 80 | 100-200 C. | 15.4 |
| TiF2 | TiF2_8H2O_S2 | 2.978 | 1.801 | 27 | 466 | 439 | Large | 26.8 |
| | | | | | | | Hysteresis | |
| TiF2 | TiF2_9H2O_S2 | 2.969 | 1.799 | 17 | 466 | 449 | Large | 31.7 |
| | | | | | | | Hysteresis | |
| AlCl3_1H2O_S2 | AlCl3_8H2O_S2 | 2.952 | 1.824 | −106 | 353 | 459 | Large | 33.3 |
| | | | | | | | Hysteresis | |
| MoF3 | MoF3_10H2O_S2 | 3.097 | 1.564 | −1061 | 252 | 1312 | Large | 49.3 |
| | | | | | | | Hysteresis | |
| GeF2 | GeF2_12H2O_S1 | 2.893 | 1.912 | 64 | 153 | 89 | 100-200 C. | 0.0 |
| CrF2 | CrF2_8H2O_S1 | 2.994 | 1.750 | 12 | 143 | 131 | Large | 22.6 |
| | | | | | | | Hysteresis | |
| ZnF2_2H2O_S4 | ZnF2_12H2O_S1 | 2.918 | 1.858 | 119 | 192 | 73 | 100-200 C. | 6.1 |
| CuF2_2H2O_S3 | CuF2_12H2O_S1 | 2.918 | 1.857 | 110 | 218 | 108 | 100-200 C. | 13.0 |
| TiF2_1H2O_S2 | TiF2_12H2O_S1 | 2.851 | 1.958 | 95 | 95 | 0 | 50-100 C. | 0.0 |
| ScCl3 | ScCl3_8H2O_S2 | 2.969 | 1.773 | 137 | 240 | 104 | 100-200 C. | 21.2 |
| CoCl2 | CoCl2_9H2O_S2 | 2.990 | 1.735 | 112 | 112 | 0 | 100-200 C. | 11.3 |
| CaCl2_1H2O_S2 | CaCl2_12H2O_S1 | 2.689 | 2.170 | 169 | 170 | 2 | 100-200 C. | 0.0 |
| NiF2 | NiF2_7H2O_S1 | 3.065 | 1.591 | −96 | 217 | 312 | Large | 41.6 |
| | | | | | | | Hysteresis | |
| KF1 | KF1_4H2O_S1 | 2.834 | 1.971 | 157 | 176 | 20 | 100-200 C. | 0.0 |
| MgBr2 | MgBr2_8H2O_S2 | 2.992 | 1.714 | 160 | 285 | 125 | 200-300 C. | 8.8 |
| VBr2 | VBr2_12H2O_S1 | 2.933 | 1.814 | 167 | 173 | 6 | 100-200 C. | 0.0 |
| MnF4 | MnF4_2H2O_S2 | 3.226 | 1.218 | 424 | 424 | 0 | 300-450 C. | 0.0 |
| MgF2 | MgF2_8H2O_S2 | 2.869 | 1.911 | 9 | 121 | 112 | Large | 24.1 |
| | | | | | | | Hysteresis | |
| TiCl2 | TiCl2_9H2O_S2 | 2.923 | 1.828 | 91 | 329 | 238 | Large | 15.7 |
| | | | | | | | Hysteresis | |
| MgF2 | MgF2_6H2O_S3 | 2.978 | 1.731 | −50 | 121 | 171 | Large | 24.0 |
| | | | | | | | Hysteresis | |
| GeF4 | GeF4_2H2O_S2 | 3.254 | 1.127 | 440 | 440 | 0 | 300-450 C. | 0.0 |
| MnCl2 | MnCl2_9H2O_S2 | 2.931 | 1.805 | 91 | 174 | 83 | 100-200 C. | 14.0 |
| MnF2_2H2O_S3 | MnF2_12H2O_S1 | 2.855 | 1.921 | 117 | 201 | 84 | 100-200 C. | 14.1 |
| VCl2 | VCl2_6H2O_S3 | 3.033 | 1.624 | 123 | 179 | 56 | 100-200 C. | 5.9 |
| TaF3 | TaF3_10H2O_S2 | 3.202 | 1.246 | 9 | 762 | 754 | Large | 46.0 |
| | | | | | | | Hysteresis | |
| GaCl3 | GaCl3_9H2O_S2 | 2.911 | 1.822 | 187 | 267 | 80 | 200-300 C. | 0.0 |
| AlF3 | AlF3_7H2O_S1 | 2.938 | 1.778 | 19 | 190 | 170 | Large | 33.0 |
| | | | | | | | Hysteresis | |
| MgBr2 | MgBr2_6H2O_S2 | 3.094 | 1.489 | 157 | 285 | 128 | 200-300 C. | 6.2 |
| CaBr2 | CaBr2_12H2O_S1 | 2.844 | 1.924 | 178 | 245 | 67 | 200-300 C. | 0.0 |
| CrCl3 | CrCl3_9H2O_S2 | 2.861 | 1.897 | 190 | 190 | 0 | 100-200 C. | 0.0 |
| LiCl1 | LiCl1_4H2O_S1 | 2.800 | 1.982 | 75 | 173 | 98 | 100-200 C. | 0.0 |
| AlBr3_1H2O_S2 | AlBr3_9H2O_S2 | 3.050 | 1.570 | 183 | 375 | 192 | Large | 0.0 |
| | | | | | | | Hysteresis | |
| FeF3_2H2O_S1 | FeF3_9H2O_S2 | 2.960 | 1.729 | 192 | 192 | 0 | 100-200 C. | 11.3 |
| CrF3 | CrF3_4H2O_S2 | 3.108 | 1.443 | −74 | 257 | 331 | Large | 23.8 |
| | | | | | | | Hysteresis | |
| YCl3 | YCl3_10H2O_S2 | 2.991 | 1.670 | −231 | 217 | 449 | Large | 12.4 |
| | | | | | | | Hysteresis | |
| FeCl2 | FeCl2_9H2O_S2 | 2.925 | 1.774 | 101 | 137 | 36 | 100-200 C. | 0.0 |
| TiCl3 | TiCl3_9H2O_S2 | 2.800 | 1.952 | 195 | 202 | 7 | 100-200 C. | 0.0 |
| MoF4_S19 | MoF4_5H2O_S2 | 3.109 | 1.408 | 230 | 235 | 5 | 200-300 C. | 0.0 |
| MnF3 | MnF3_6H2O_S3 | 3.025 | 1.579 | 60 | 187 | 128 | 100-200 C. | 14.0 |
| NiF2 | NiF2_2H2O_S4 | 3.236 | 1.078 | 217 | 217 | 0 | 200-300 C. | 0.0 |
| TiF3 | TiF3_6H2O_S3 | 3.010 | 1.599 | 83 | 149 | 66 | 100-200 C. | 12.5 |
| MoF3 | MoF3_7H2O_S1 | 3.097 | 1.422 | 13 | 252 | 239 | Large | 43.1 |
| | | | | | | | Hysteresis | |
| VCl3 | VCl3_9H2O_S2 | 2.826 | 1.904 | 179 | 199 | 20 | 100-200 C. | 0.0 |
| NbF3 | NbF3_10H2O_S2 | 3.049 | 1.513 | −739 | 362 | 1101 | Large | 35.0 |
| | | | | | | | Hysteresis | |
| TiF2 | TiF2_4H2O_S7 | 3.032 | 1.542 | 37 | 466 | 429 | Large | 17.7 |
| | | | | | | | Hysteresis | |
| SnF4 | SnF4_9H2O_S1 | 3.115 | 1.357 | −903 | 354 | 1257 | Large | 44.9 |
| | | | | | | | Hysteresis | |
| NiF3_2H2O_S2 | NiF3_9H2O_S2 | 2.941 | 1.699 | 174 | 280 | 106 | 200-300 C. | 0.0 |
| MgCl2 | MgCl2_7H2O_S1 | 2.856 | 1.836 | −21 | 288 | 309 | Large | 40.7 |
| | | | | | | | Hysteresis | |
| TaF4_S5 | TaF4_8H2O_S1 | 3.121 | 1.330 | 151 | 203 | 52 | 100-200 C. | 0.0 |
| TiF2 | TiF2_6H2O_S3 | 2.995 | 1.591 | 2 | 466 | 464 | Large | 33.6 |
| | | | | | | | Hysteresis | |
| VBr2 | VBr2_9H2O_S2 | 3.033 | 1.512 | 142 | 173 | 31 | 100-200 C. | 6.2 |
| MnF4_1H2O_S1 | MnF4_5H2O_S2 | 3.017 | 1.526 | 215 | 570 | 355 | Large | 27.6 |
| | | | | | | | Hysteresis | |
| TaF4_S5 | TaF4_9H2O_S1 | 3.188 | 1.117 | −721 | 203 | 925 | Large | 36.3 |
| | | | | | | | Hysteresis | |
| TiF2 | TiF2_1H2O_S2 | 3.213 | 1.038 | 466 | 466 | 0 | 450-600 C. | 0.0 |
| MgCl2 | MgCl2_4H2O_S7 | 2.875 | 1.770 | 202 | 288 | 86 | 200-300 C. | 0.0 |
| CrF2_2H2O_S4 | CrF2_12H2O_S1 | 2.799 | 1.883 | 113 | 157 | 44 | 100-200 C. | 4.7 |
| AlI3 | AlI3_9H2O_S2 | 3.103 | 1.322 | 142 | 379 | 237 | Large | 0.0 |
| | | | | | | | Hysteresis | |
| ZnCl2 | ZnCl2_9H2O_S2 | 2.914 | 1.694 | 112 | 112 | 0 | 100-200 C. | 12.3 |
| CrCl2_1H2O_S2 | CrCl2_12H2O_S1 | 2.713 | 1.999 | 122 | 222 | 100 | 100-200 C. | 24.1 |
| FeF3_1H2O_S2 | FeF3_6H2O_S1 | 3.044 | 1.434 | 161 | 161 | 0 | 100-200 C. | 7.1 |
| TiBr2 | TiBr2_12H2O_S1 | 2.848 | 1.792 | 146 | 316 | 169 | Large | 0.0 |
| | | | | | | | Hysteresis | |
| NiCl2 | NiCl2_9H2O_S2 | 2.903 | 1.695 | 103 | 103 | 0 | 100-200 C. | 12.1 |
| ScCl3 | ScCl3_7H2O_S2 | 2.912 | 1.672 | 136 | 240 | 104 | 100-200 C. | 19.1 |
| ZnCl2_1H2O_S2 | ZnCl2_12H2O_S1 | 2.750 | 1.924 | 149 | 149 | 0 | 100-200 C. | 28.6 |
| CuCl2 | CuCl2_12H2O_S1 | 2.756 | 1.903 | 89 | 145 | 56 | 100-200 C. | 0.0 |
| SiF4 | SiF4_4H2O_S1 | 2.946 | 1.592 | 200 | 214 | 14 | 200-300 C. | 1.7 |
| SnF4 | SnF4_4H2O_S1 | 3.115 | 1.221 | 215 | 354 | 139 | 200-300 C. | 2.2 |
| MoF3 | MoF3_8H2O_S1 | 3.004 | 1.471 | 11 | 252 | 241 | Large | 48.6 |
| | | | | | | | Hysteresis | |
| AlI3 | AlI3_10H2O_S2 | 3.083 | 1.294 | −220 | 379 | 599 | Large | 11.9 |
| | | | | | | | Hysteresis | |
| ScCl3_1H2O_S2 | ScCl3_9H2O_S2 | 2.726 | 1.933 | 215 | 338 | 123 | 200-300 C. | 42.2 |
| GeF4_1H2O_S1 | GeF4_5H2O_S2 | 3.024 | 1.422 | 223 | 564 | 341 | Large | 23.6 |
| | | | | | | | Hysteresis | |
| CrCl2 | CrCl2_6H2O_S3 | 2.945 | 1.577 | 48 | 190 | 142 | Large | 10.6 |
| | | | | | | | Hysteresis | |
| SnF4_1H2O_S1 | SnF4_8H2O_S1 | 3.002 | 1.466 | 124 | 438 | 314 | Large | 15.8 |
| | | | | | | | Hysteresis | |
| NbF4_1H2O_S1 | NbF4_8H2O_S1 | 2.933 | 1.598 | 143 | 271 | 128 | 200-300 C. | 49.4 |
| MnCl2_1H2O_S2 | MnCl2_12H2O_S1 | 2.686 | 1.984 | 146 | 158 | 11 | 100-200 C. | 0.0 |
| VF4_1H2O_S1 | VF4_8H2O_S1 | 2.857 | 1.729 | 129 | 348 | 218 | Large | 12.7 |
| | | | | | | | Hysteresis | |
| CrF2 | CrF2_4H2O_S7 | 2.980 | 1.500 | 143 | 143 | 0 | 100-200 C. | 0.0 |
| CoCl2_1H2O_S2 | CoCl2_12H2O_S1 | 2.723 | 1.918 | 140 | 140 | 0 | 100-200 C. | 7.5 |
| NiCl2_1H2O_S2 | NiCl2_12H2O_S1 | 2.735 | 1.898 | 136 | 136 | 0 | 100-200 C. | 15.8 |
| WF4_S20 | WF4_8H2O_S1 | 3.082 | 1.258 | 130 | 181 | 52 | 100-200 C. | 0.0 |
| FeCl2 | FeCl2_12H2O_S1 | 2.744 | 1.883 | 31 | 137 | 106 | Large | 1.8 |
| | | | | | | | Hysteresis | |
| RbF1 | RbF1_4H2O_S1 | 2.923 | 1.586 | 155 | 344 | 190 | Large | 0.0 |
| | | | | | | | Hysteresis | |
| MgI2 | MgI2_8H2O_S3 | 3.015 | 1.403 | 195 | 284 | 89 | 200-300 C. | 3.2 |
| NbF4 | NbF4_9H2O_S1 | 3.035 | 1.349 | −857 | 206 | 1063 | Large | 42.8 |
| | | | | | | | Hysteresis | |
| SrF2 | SrF2_12H2O_S1 | 2.750 | 1.845 | 86 | 94 | 8 | 50-100 C. | 0.0 |
| SrCl2 | SrCl2_12H2O_S1 | 2.662 | 1.957 | 140 | 172 | 31 | 100-200 C. | 0.0 |
| AlF3_2H2O_S2 | AlF3_9H2O_S2 | 2.750 | 1.827 | 156 | 234 | 79 | 100-200 C. | 6.7 |
| TiF4_1H2O_S1 | TiF4_8H2O_S1 | 2.798 | 1.732 | 121 | 278 | 157 | 100-200 C. | 6.9 |
| TiBr2 | TiBr2_9H2O_S2 | 2.934 | 1.487 | 124 | 316 | 192 | Large | 9.0 |
| | | | | | | | Hysteresis | |
| GaCl3 | GaCl3_10H2O_S2 | 2.851 | 1.640 | −493 | 267 | 761 | Large | 24.0 |
| | | | | | | | Hysteresis | |
| CaBr2 | CaBr2_9H2O_S2 | 2.878 | 1.586 | 150 | 245 | 95 | 100-200 C. | 9.9 |
| SiF4_1H2O_S1 | SiF4_5H2O_S2 | 2.869 | 1.596 | 210 | 402 | 193 | 300-450 C. | 35.6 |
| CaCl2 | CaCl2_6H2O_S1 | 2.839 | 1.646 | 67 | 187 | 120 | 100-200 C. | 14.6 |
| AlF3 | AlF3_3H2O_S9 | 2.932 | 1.468 | 190 | 190 | 0 | 100-200 C. | 0.0 |
| CrBr2 | CrBr2_12H2O_S1 | 2.783 | 1.720 | 126 | 190 | 65 | 100-200 C. | 0.0 |
| ScCl3 | ScCl3_6H2O_S1 | 2.798 | 1.690 | 215 | 240 | 26 | 200-300 C. | 0.1 |
| NbF3 | NbF3_6H2O_S1 | 2.976 | 1.352 | 78 | 362 | 284 | Large | 19.2 |
| | | | | | | | Hysteresis | |
| PbF4 | PbF4_5H2O_S2 | 3.104 | 1.020 | 188 | 309 | 121 | Large | 0.0 |
| | | | | | | | Hysteresis | |
| BeCl2_2H2O_S8 | BeCl2_12H2O_S1 | 2.574 | 2.003 | 73 | 375 | 303 | Large | 0.0 |
| | | | | | | | Hysteresis | |
| MnCl4_S1 | MnCl4_8H2O_S1 | 2.833 | 1.615 | 185 | 211 | 26 | 100-200 C. | 0.0 |
| CrF4 | CrF4_3H2O_S1 | 2.979 | 1.325 | 149 | 342 | 194 | Large | 6.0 |
| | | | | | | | Hysteresis | |
| AlF3 | AlF3_8H2O_S1 | 2.791 | 1.685 | −24 | 190 | 214 | Large | 48.5 |
| | | | | | | | Hysteresis | |
| MgI2_1H2O_S2 | MgI2_9H2O_S2 | 2.967 | 1.344 | 209 | 298 | 89 | 200-300 C. | 3.5 |
| MnBr2 | MnBr2_12H2O_S1 | 2.766 | 1.721 | 145 | 162 | 17 | 100-200 C. | 0.0 |
| TaF3 | TaF3_1H2O_S2 | 3.203 | 0.591 | 762 | 762 | 0 | >600 C. | 0.0 |
| GaF3 | GaF3_6H2O_S1 | 2.958 | 1.360 | 91 | 91 | 0 | 50-100 C. | 22.5 |
| ZnBr2 | ZnBr2_12H2O_S1 | 2.804 | 1.654 | 141 | 149 | 9 | 100-200 C. | 0.0 |
| VCl2 | VCl2_8H2O_S2 | 2.711 | 1.801 | 106 | 179 | 74 | 100-200 C. | 13.0 |
| AlCl3_1H2O_S2 | AlCl3_7H2O_S1 | 2.770 | 1.702 | −380 | 353 | 734 | Large | 35.3 |
| | | | | | | | Hysteresis | |
| MgCl2_1H2O_S2 | MgCl2_8H2O_S2 | 2.623 | 1.918 | 146 | 245 | 98 | 100-200 C. | 10.6 |
| ZrF3_S12 | ZrF3_9H2O_S2 | 2.794 | 1.656 | 118 | 118 | 0 | 100-200 C. | 0.0 |
| GaF3 | GaF3_10H2O_S2 | 2.859 | 1.540 | −808 | 146 | 954 | Large | 38.1 |
| | | | | | | | Hysteresis | |
| BeBr2_1H2O_S1 | BeBr2_4H2O_S8 | 2.951 | 1.353 | 471 | 471 | 0 | 450-600 C. | 36.2 |
| CrBr2 | CrBr2_9H2O_S2 | 2.903 | 1.442 | 95 | 190 | 95 | 100-200 C. | 7.7 |
| AlBr3_1H2O_S2 | AlBr3_10H2O_S2 | 2.899 | 1.434 | −493 | 375 | 869 | Large | 24.0 |
| | | | | | | | Hysteresis | |
| AlI3 | AlI3_6H2O_S1 | 3.034 | 1.108 | 379 | 379 | 0 | 300-450 C. | 0.0 |
| MgI2_1H2O_S2 | MgI2_12H2O_S1 | 2.799 | 1.612 | 195 | 298 | 103 | 200-300 C. | 3.5 |
| CoCl2 | CoCl2_6H2O_S3 | 2.880 | 1.458 | 123 | 123 | 0 | 100-200 C. | 6.2 |
| CaF2 | CaF2_9H2O_S1 | 2.742 | 1.701 | 38 | 38 | 0 | <50 C. | 27.0 |
| SnF2 | SnF2_12H2O_S1 | 2.759 | 1.668 | 73 | 115 | 42 | 50-100 C. | 0.0 |
| VCl2_1H2O_S2 | VCl2_9H2O_S2 | 2.742 | 1.695 | 124 | 165 | 41 | 100-200 C. | 10.1 |
| YCl3 | YCl3_8H2O_S2 | 2.818 | 1.558 | 78 | 217 | 140 | Large | 10.0 |
| | | | | | | | Hysteresis | |
| CrCl3_1H2O_S3 | CrCl3_9H2O_S2 | 2.683 | 1.779 | 215 | 215 | 0 | 200-300 C. | 43.8 |
| TiCl2_1H2O_S2 | TiCl2_12H2O_S1 | 2.564 | 1.934 | 130 | 130 | 0 | 100-200 C. | 0.0 |
| YCl3 | YCl3_6H2O_S2 | 2.887 | 1.406 | 210 | 217 | 7 | 200-300 C. | 0.0 |
| YF3 | YF3_10H2O_S2 | 2.856 | 1.465 | −477 | 113 | 590 | Large | 23.3 |
| | | | | | | | Hysteresis | |
| BeCl2 | BeCl2_2H2O_S8 | 2.748 | 1.655 | 384 | 384 | 0 | 300-450 C. | 0.0 |
| TiF4 | TiF4_9H2O_S1 | 2.821 | 1.524 | −946 | 241 | 1187 | Large | 46.9 |
| | | | | | | | Hysteresis | |
| MoF3_2H2O_S1 | MoF3_9H2O_S2 | 2.805 | 1.546 | 191 | 281 | 91 | 200-300 C. | 4.5 |
| TiCl3 | TiCl3_10H2O_S2 | 2.758 | 1.629 | −772 | 202 | 974 | Large | 36.5 |
| | | | | | | | Hysteresis | |
| MnF3 | MnF3_7H2O_S1 | 2.840 | 1.479 | −16 | 187 | 203 | Large | 34.6 |
| | | | | | | | Hysteresis | |
| ZrF4 | ZrF4_8H2O_S1 | 2.805 | 1.542 | 108 | 189 | 82 | 100-200 C. | 0.0 |
| AlI3 | AlI3_8H2O_S2 | 2.976 | 1.177 | −6 | 379 | 385 | Large | 16.0 |
| | | | | | | | Hysteresis | |
| MgCl2_2H2O_S8 | MgCl2_9H2O_S2 | 2.653 | 1.789 | 168 | 202 | 34 | 100-200 C. | 6.5 |
| MgBr2_2H2O_S8 | MgBr2_12H2O_S1 | 2.677 | 1.751 | 200 | 237 | 37 | 200-300 C. | 0.0 |
| MnCl2 | MnCl2_6H2O_S3 | 2.812 | 1.519 | 74 | 174 | 100 | 100-200 C. | 10.5 |
| GeF2 | GeF2_9H2O_S1 | 2.803 | 1.531 | −17 | 153 | 171 | Large | 20.6 |
| | | | | | | | Hysteresis | |
| SrCl2 | SrCl2_9H2O_S1 | 2.775 | 1.581 | 96 | 172 | 76 | 100-200 C. | 15.7 |
| CoBr2 | CoBr2_12H2O_S1 | 2.743 | 1.633 | 132 | 132 | 0 | 100-200 C. | 0.0 |
| YBr3_S7 | YBr3_10H2O_S2 | 2.920 | 1.289 | −94 | 227 | 321 | Large | 6.3 |
| | | | | | | | Hysteresis | |
| NiF2_1H2O_S2 | NiF2_4H2O_S4 | 2.921 | 1.274 | 185 | 284 | 98 | 200-300 C. | 16.9 |
| GeCl2_S21 | GeCl2_12H2O_S1 | 2.578 | 1.872 | 86 | 176 | 90 | 100-200 C. | 0.0 |
| VCl2_2H2O_S8 | VCl2_12H2O_S1 | 2.565 | 1.890 | 164 | 168 | 5 | 100-200 C. | 1.2 |
| CuCl2_1H2O_S2 | CuCl2_12H2O_S1 | 2.618 | 1.808 | 89 | 208 | 119 | Large | 47.7 |
| | | | | | | | Hysteresis | |
| AlBr3_1H2O_S2 | AlBr3_6H2O_S1 | 2.920 | 1.263 | 375 | 375 | 0 | 300-450 C. | 0.0 |
| CuCl2 | CuCl2_9H2O_S2 | 2.764 | 1.574 | 32 | 145 | 113 | Large | 14.5 |
| | | | | | | | Hysteresis | |
| ZrCl4 | ZrCl4_8H2O_S1 | 2.792 | 1.514 | 194 | 260 | 66 | 200-300 C. | 0.0 |
| TiCl3 | TiCl3_6H2O_S3 | 2.765 | 1.561 | 187 | 202 | 14 | 100-200 C. | 1.5 |
| VCl3 | VCl3_10H2O_S2 | 2.712 | 1.649 | −627 | 199 | 826 | Large | 30.0 |
| | | | | | | | Hysteresis | |
| CrCl3 | CrCl3_6H2O_S3 | 2.799 | 1.494 | 181 | 181 | 0 | 100-200 C. | 3.4 |
| TiCl2 | TiCl2_6H2O_S3 | 2.776 | 1.535 | 84 | 329 | 245 | Large | 16.8 |
| | | | | | | | Hysteresis | |
| VF2 | VF2_7H2O_S1 | 2.759 | 1.565 | −100 | 174 | 274 | Large | 41.9 |
| | | | | | | | Hysteresis | |
| VBr2_1H2O_S2 | VBr2_12H2O_S1 | 2.696 | 1.667 | 167 | 179 | 12 | 100-200 C. | 4.3 |
| NbF4 | NbF4_5H2O_S2 | 2.867 | 1.350 | 206 | 206 | 0 | 200-300 C. | 0.0 |
| AlCl3_2H2O_S1 | AlCl3_6H2O_S1 | 2.715 | 1.630 | 401 | 401 | 0 | 300-450 C. | 28.7 |
| VF4 | VF4_4H2O_S1 | 2.819 | 1.440 | 154 | 281 | 126 | 200-300 C. | 5.9 |
| HfCl4 | HfCl4_8H2O_S1 | 2.898 | 1.270 | 199 | 306 | 108 | Large | 0.0 |
| | | | | | | | Hysteresis | |
| NiCl2 | NiCl2_6H2O_S3 | 2.826 | 1.422 | 113 | 113 | 0 | 100-200 C. | 7.5 |
| HfF4 | HfF4_8H2O_S1 | 2.906 | 1.245 | 125 | 196 | 71 | 100-200 C. | 0.0 |
| LiCl1 | LiCl1_3H2O_S1 | 2.588 | 1.815 | 67 | 173 | 106 | 100-200 C. | 1.0 |
| YF3 | YF3_9H2O_S2 | 2.695 | 1.647 | 113 | 113 | 0 | 100-200 C. | 0.0 |
| VCl3 | VCl3_6H2O_S1 | 2.751 | 1.546 | 192 | 199 | 7 | 100-200 C. | 0.0 |
| ZnBr2 | ZnBr2_9H2O_S2 | 2.846 | 1.355 | 108 | 149 | 41 | 100-200 C. | 8.3 |
| CrF2 | CrF2_7H2O_S1 | 2.752 | 1.537 | −70 | 143 | 213 | Large | 34.6 |
| | | | | | | | Hysteresis | |
| SrF2 | SrF2_9H2O_S1 | 2.765 | 1.513 | 48 | 94 | 46 | 50-100 C. | 13.2 |
| TiCl4 | TiCl4_8H2O_S1 | 2.707 | 1.612 | 188 | 188 | 0 | 100-200 C. | 0.0 |
| YCl3 | YCl3_7H2O_S2 | 2.787 | 1.461 | 22 | 217 | 196 | Large | 9.0 |
| | | | | | | | Hysteresis | |
| VCl3_1H2O_S3 | VCl3_9H2O_S2 | 2.609 | 1.758 | 179 | 275 | 96 | 200-300 C. | 32.9 |
| ZrF3_S12 | ZrF3_10H2O_S2 | 2.819 | 1.394 | −657 | 118 | 775 | Large | 31.3 |
| | | | | | | | Hysteresis | |
| MgBr2 | MgBr2_7H2O_S1 | 2.813 | 1.405 | 15 | 285 | 270 | Large | 34.9 |
| | | | | | | | Hysteresis | |
| CaCl2_2H2O_S2 | CaCl2_12H2O_S1 | 2.447 | 1.974 | 169 | 173 | 4 | 100-200 C. | 0.9 |
| YCl3 | YCl3_9H2O_S2 | 2.619 | 1.737 | 171 | 217 | 47 | 100-200 C. | 0.0 |
| HfCl4 | HfCl4_9H2O_S1 | 2.893 | 1.224 | −268 | 306 | 574 | Large | 14.9 |
| | | | | | | | Hysteresis | |
| NiBr2 | NiBr2_12H2O_S1 | 2.716 | 1.577 | 118 | 118 | 0 | 100-200 C. | 0.0 |
| AlF3 | AlF3_4H2O_S2 | 2.793 | 1.436 | −126 | 190 | 315 | Large | 26.6 |
| | | | | | | | Hysteresis | |
| MgCl2_1H2O_S2 | MgCl2_6H2O_S3 | 2.685 | 1.624 | 124 | 245 | 121 | 100-200 C. | 10.0 |
| ZrCl3 | ZrCl3_10H2O_S2 | 2.755 | 1.502 | −218 | 153 | 370 | Large | 11.8 |
| | | | | | | | Hysteresis | |
| ScBr3_S25 | ScBr3_10H2O_S2 | 2.837 | 1.336 | −511 | 243 | 754 | Large | 24.8 |
| | | | | | | | Hysteresis | |
| NbF3 | NbF3_8H2O_S2 | 2.831 | 1.346 | 23 | 362 | 339 | Large | 41.7 |
| | | | | | | | Hysteresis | |
| MnBr2 | MnBr2_9H2O_S2 | 2.803 | 1.403 | 103 | 162 | 58 | 100-200 C. | 10.4 |
| MoF3 | MoF3_3H2O_S9 | 2.929 | 1.110 | 252 | 252 | 0 | 200-300 C. | 0.0 |
| ZrCl4 | ZrCl4_9H2O_S1 | 2.800 | 1.399 | −399 | 260 | 659 | Large | 21.1 |
| | | | | | | | Hysteresis | |
| CaCl2 | CaCl2_8H2O_S2 | 2.479 | 1.909 | 114 | 187 | 73 | 100-200 C. | 12.3 |
| ScBr3_S25 | ScBr3_9H2O_S2 | 2.763 | 1.468 | 193 | 243 | 50 | 200-300 C. | 0.0 |
| BaF2 | BaF2_9H2O_S1 | 2.821 | 1.349 | 52 | 149 | 97 | 100-200 C. | 5.7 |
| CaF2_2H2O_S4 | CaF2_12H2O_S1 | 2.510 | 1.863 | 102 | 102 | 0 | 100-200 C. | 8.6 |
| FeF2_2H2O_S7 | FeF2_12H2O_S1 | 2.643 | 1.666 | 55 | 183 | 128 | 100-200 C. | 1.6 |
| TiF4 | TiF4_4H2O_S1 | 2.758 | 1.459 | 192 | 241 | 50 | 200-300 C. | 3.1 |
| VF3_2H2O_S2 | VF3_9H2O_S2 | 2.640 | 1.663 | 157 | 220 | 63 | 100-200 C. | 4.2 |
| AlBr3_1H2O_S2 | AlBr3_8H2O_S2 | 2.830 | 1.305 | −58 | 375 | 433 | Large | 26.0 |
| | | | | | | | Hysteresis | |
| TiCl3_1H2O_S3 | TiCl3_9H2O_S2 | 2.557 | 1.783 | 195 | 255 | 61 | 200-300 C. | 23.1 |
| 2-Feb | FeBr2_9H2O_S2 | 2.796 | 1.375 | 106 | 142 | 36 | 100-200 C. | 0.0 |
| MoF3 | MoF3_4H2O_S2 | 2.883 | 1.176 | −35 | 252 | 286 | Large | 21.3 |
| | | | | | | | Hysteresis | |
| ScBr3_S25 | ScBr3_8H2O_S2 | 2.839 | 1.279 | 57 | 243 | 186 | Large | 14.6 |
| | | | | | | | Hysteresis | |
| CuF2_1H2O_S2 | CuF2_4H2O_S7 | 2.861 | 1.227 | 213 | 213 | 0 | 200-300 C. | 25.6 |
| VCl2 | VCl2_7H2O_S1 | 2.698 | 1.551 | 17 | 179 | 163 | Large | 27.8 |
| | | | | | | | Hysteresis | |
| CoBr2 | CoBr2_9H2O_S2 | 2.810 | 1.336 | 114 | 114 | 0 | 100-200 C. | 8.3 |
| CaBr2_1H2O_S2 | CaBr2_12H2O_S1 | 2.575 | 1.743 | 178 | 179 | 1 | 100-200 C. | 0.0 |
| TiCl2_2H2O_S8 | TiCl2_12H2O_S1 | 2.482 | 1.872 | 157 | 157 | 0 | 100-200 C. | 44.1 |
| AlI3 | AlI3_7H2O_S1 | 2.907 | 1.086 | −215 | 379 | 594 | Large | 21.6 |
| | | | | | | | Hysteresis | |
| HfF3_S12 | HfF3_9H2O_S2 | 2.824 | 1.280 | 114 | 114 | 0 | 100-200 C. | 17.8 |
| MoCl4 | MoCl4_8H2O_S1 | 2.746 | 1.439 | 188 | 206 | 18 | 100-200 C. | 0.0 |
| ZnCl2 | ZnCl2_6H2O_S3 | 2.770 | 1.388 | 114 | 114 | 0 | 100-200 C. | 10.6 |
| VCl4 | VCl4_8H2O_S1 | 2.679 | 1.556 | 176 | 176 | 0 | 100-200 C. | 0.0 |
| FeF3_1H2O_S2 | FeF3_7H2O_S1 | 2.792 | 1.337 | 92 | 92 | 0 | 50-100 C. | 32.6 |
| ZnCl2_2H2O_S5 | ZnCl2_12H2O_S1 | 2.534 | 1.773 | 155 | 155 | 0 | 100-200 C. | 27.2 |
| CaI2 | CaI2_12H2O_S1 | 2.657 | 1.581 | 181 | 219 | 38 | 200-300 C. | 0.0 |
| VF3 | VF3_3H2O_S8 | 2.822 | 1.259 | 193 | 193 | 0 | 100-200 C. | 0.0 |
| TiCl3 | TiCl3_7H2O_S2 | 2.695 | 1.506 | 94 | 202 | 108 | Large | 24.5 |
| | | | | | | | Hysteresis | |
| FeCl3 | FeCl3_9H2O_S2 | 2.606 | 1.652 | 95 | 337 | 242 | Large | 0.0 |
| | | | | | | | Hysteresis | |
| GaCl3 | GaCl3_6H2O_S1 | 2.735 | 1.426 | 174 | 267 | 93 | 200-300 C. | 4.5 |
| SrBr2 | SrBr2_9H2O_S1 | 2.785 | 1.320 | 124 | 192 | 68 | 100-200 C. | 10.6 |
| LiBr1 | LiBr1_4H2O_S1 | 2.702 | 1.482 | 48 | 222 | 173 | Large | 0.0 |
| | | | | | | | Hysteresis | |
| CoF2_1H2O_S2 | CoF2_4H2O_S7 | 2.809 | 1.260 | 213 | 213 | 0 | 200-300 C. | 21.5 |
| PbF4 | PbF4_3H2O_S2 | 2.989 | 0.730 | 248 | 309 | 61 | 200-300 C. | 0.0 |
| VF2_1H2O_S2 | VF2_4H2O_S4 | 2.772 | 1.335 | 218 | 218 | 0 | 200-300 C. | 33.1 |
| NiCl2_2H2O_S5 | NiCl2_12H2O_S1 | 2.526 | 1.753 | 142 | 142 | 0 | 100-200 C. | 20.6 |
| GaCl3 | GaCl3_8H2O_S2 | 2.698 | 1.471 | 111 | 267 | 156 | 100-200 C. | 28.8 |
| LiF1_1H2O_S1 | LiF1_4H2O_S1 | 2.562 | 1.697 | 107 | 107 | 0 | 100-200 C. | 47.7 |
| MoF2_S16 | MoF2_12H2O_S1 | 2.645 | 1.560 | 36 | 73 | 38 | 50-100 C. | 4.8 |
| PbF2 | PbF2_12H2O_S1 | 2.750 | 1.365 | 81 | 115 | 35 | 50-100 C. | 0.0 |
| MgI2 | MgI2_6H2O_S2 | 2.828 | 1.189 | 206 | 284 | 78 | 200-300 C. | 0.4 |
| BeF2_2H2O_S5 | BeF2_12H2O_S1 | 2.480 | 1.800 | 41 | 76 | 35 | 50-100 C. | 0.7 |
| MoF4_S19 | MoF4_4H2O_S1 | 2.818 | 1.202 | 223 | 235 | 12 | 200-300 C. | 1.2 |
| SiCl4 | SiCl4_9H2O_S1 | 2.597 | 1.622 | 68 | 145 | 77 | 100-200 C. | 0.0 |
| SrBr2 | SrBr2_12H2O_S1 | 2.586 | 1.635 | 153 | 192 | 38 | 100-200 C. | 0.0 |
| CrCl4_S19 | CrCl4_8H2O_S1 | 2.653 | 1.522 | 167 | 167 | 0 | 100-200 C. | 0.0 |
| CoCl2_2H2O_S3 | CoCl2_12H2O_S1 | 2.501 | 1.761 | 144 | 144 | 0 | 100-200 C. | 11.7 |
| FeF3_1H2O_S2 | FeF3_8H2O_S2 | 2.721 | 1.397 | 78 | 78 | 0 | 50-100 C. | 39.0 |
| BeCl2_2H2O_S8 | BeCl2_9H2O_S1 | 2.512 | 1.736 | 43 | 375 | 332 | Large | 7.4 |
| | | | | | | | Hysteresis | |
| FeCl2_1H2O_S2 | FeCl2_9H2O_S2 | 2.610 | 1.583 | 101 | 148 | 46 | 100-200 C. | 8.2 |
| MgBr2 | MgBr2_4H2O_S4 | 2.803 | 1.208 | 237 | 285 | 48 | 200-300 C. | 0.0 |
| VI2 | VI2_12H2O_S1 | 2.678 | 1.463 | 162 | 162 | 0 | 100-200 C. | 0.0 |
| SrCl2_1H2O_S1 | SrCl2_12H2O_S1 | 2.457 | 1.807 | 140 | 230 | 89 | 100-200 C. | 14.6 |
| CrCl2 | CrCl2_8H2O_S2 | 2.568 | 1.641 | 14 | 190 | 176 | Large | 24.2 |
| | | | | | | | Hysteresis | |
| SnCl4 | SnCl4_8H2O_S1 | 2.723 | 1.368 | 191 | 214 | 23 | 200-300 C. | 0.0 |
| CaCl2_1H2O_S2 | CaCl2_9H2O_S2 | 2.510 | 1.727 | 107 | 170 | 63 | 100-200 C. | 15.4 |
| SnF2_1H2O_S2 | SnF2_12H2O_S1 | 2.606 | 1.576 | 73 | 268 | 195 | Large | 38.5 |
| | | | | | | | Hysteresis | |
| MnCl2_2H2O_S8 | MnCl2_12H2O_S1 | 2.448 | 1.808 | 146 | 167 | 21 | 100-200 C. | 3.2 |
| NbF3_1H2O_S2 | NbF3_9H2O_S2 | 2.634 | 1.522 | 134 | 134 | 0 | 100-200 C. | 0.0 |
| VBr2 | VBr2_6H2O_S3 | 2.801 | 1.180 | 123 | 173 | 50 | 100-200 C. | 6.3 |
| CrCl3 | CrCl3_8H2O_S2 | 2.630 | 1.517 | 120 | 120 | 0 | 100-200 C. | 30.3 |
| CoF3_3H2O_S9 | CoF3_9H2O_S2 | 2.639 | 1.499 | 203 | 203 | 0 | 200-300 C. | 0.0 |
| ZrF4 | ZrF4_9H2O_S1 | 2.741 | 1.302 | −625 | 189 | 814 | Large | 31.8 |
| | | | | | | | Hysteresis | |
| NbF3 | NbF3_7H2O_S2 | 2.755 | 1.270 | 21 | 362 | 341 | Large | 40.8 |
| | | | | | | | Hysteresis | |
| LiCl1 | LiCl1_2H2O_S2 | 2.578 | 1.599 | 140 | 173 | 33 | 100-200 C. | 0.0 |
| CaI2 | CaI2_9H2O_S2 | 2.738 | 1.304 | 168 | 219 | 51 | 100-200 C. | 4.5 |
| SrCl2 | SrCl2_8H2O_S1 | 2.652 | 1.469 | 86 | 172 | 85 | 100-200 C. | 18.2 |
| CaBr2 | CaBr2_6H2O_S1 | 2.764 | 1.241 | 139 | 245 | 106 | 100-200 C. | 11.4 |
| BaF2 | BaF2_12H2O_S1 | 2.580 | 1.587 | 68 | 149 | 80 | 100-200 C. | 0.0 |
| AlCl3 | AlCl3_3H2O_S9 | 2.655 | 1.458 | 326 | 401 | 75 | 300-450 C. | 6.4 |
| SnF4 | SnF4_3H2O_S1 | 2.855 | 1.011 | 195 | 354 | 159 | Large | 3.5 |
| | | | | | | | Hysteresis | |
| CrCl2 | CrCl2_4H2O_S3 | 2.690 | 1.388 | 190 | 190 | 0 | 100-200 C. | 0.0 |
| PbF2 | PbF2_9H2O_S1 | 2.825 | 1.086 | 49 | 115 | 67 | Large | 11.3 |
| | | | | | | | Hysteresis | |
| CrCl2_2H2O_S3 | CrCl2_12H2O_S1 | 2.436 | 1.795 | 122 | 233 | 111 | 100-200 C. | 14.3 |
| CrBr2_1H2O_S2 | CrBr2_12H2O_S1 | 2.574 | 1.591 | 126 | 218 | 92 | 100-200 C. | 21.0 |
| TaF4_S5 | TaF4_5H2O_S2 | 2.852 | 1.002 | 203 | 203 | 0 | 200-300 C. | 0.0 |
| SiF2_S25 | SiF2_8H2O_S1 | 2.507 | 1.688 | 31 | 31 | 0 | <50 C. | 39.0 |
| FeF3 | FeF3_2H2O_S1 | 2.782 | 1.181 | 107 | 551 | 444 | Large | 11.3 |
| | | | | | | | Hysteresis | |
| CaBr2 | CaBr2_7H2O_S1 | 2.719 | 1.316 | 121 | 245 | 124 | 100-200 C. | 18.2 |
| ZnBr2_1H2O_S2 | ZnBr2_12H2O_S1 | 2.601 | 1.534 | 141 | 169 | 29 | 100-200 C. | 15.2 |
| VCl3 | VCl3_8H2O_S2 | 2.628 | 1.487 | −143 | 199 | 342 | Large | 34.8 |
| | | | | | | | Hysteresis | |
| CoCl3_S22 | CoCl3_9H2O_S2 | 2.569 | 1.586 | 121 | 123 | 3 | 100-200 C. | 0.0 |
| TiCl3 | TiCl3_8H2O_S2 | 2.611 | 1.516 | 62 | 202 | 140 | Large | 35.9 |
| | | | | | | | Hysteresis | |
| MnCl2 | MnCl2_8H2O_S2 | 2.505 | 1.682 | 70 | 174 | 104 | 100-200 C. | 17.2 |
| SiCl4 | SiCl4_8H2O_S1 | 2.585 | 1.556 | 145 | 145 | 0 | 100-200 C. | 0.0 |
| MnF3 | MnF3_3H2O_S8 | 2.762 | 1.215 | 187 | 187 | 0 | 100-200 C. | 0.0 |
| MnF4_1H2O_S1 | MnF4_4H2O_S1 | 2.716 | 1.311 | 217 | 570 | 353 | Large | 27.6 |
| | | | | | | | Hysteresis | |
| VI2 | VI2_9H2O_S2 | 2.764 | 1.205 | 155 | 155 | 0 | 100-200 C. | 3.1 |
| NaF1_1H2O_S1 | NaF1_4H2O_S1 | 2.523 | 1.642 | 154 | 154 | 0 | 100-200 C. | 30.1 |
| ScF3 | ScF3_10H2O_S2 | 2.631 | 1.462 | −1022 | 125 | 1147 | Large | 47.6 |
| | | | | | | | Hysteresis | |
| MnCl2_1H2O_S2 | MnCl2_9H2O_S2 | 2.563 | 1.578 | 91 | 158 | 67 | 100-200 C. | 14.0 |
| HfCl3_S28 | HfCl3_10H2O_S2 | 2.757 | 1.206 | −335 | 161 | 496 | Large | 17.0 |
| | | | | | | | Hysteresis | |
| CrBr2 | CrBr2_6H2O_S3 | 2.771 | 1.165 | 77 | 190 | 113 | 100-200 C. | 7.0 |
| HfF3_S12 | HfF3_10H2O_S2 | 2.806 | 1.076 | 33 | 33 | 0 | <50 C. | 49.4 |
| SiCl2 | SiCl2_9H2O_S1 | 2.486 | 1.687 | −140 | 88 | 228 | <50 C. | 9.4 |
| MnCl3_S25 | MnCl3_9H2O_S2 | 2.522 | 1.632 | 73 | 156 | 83 | 100-200 C. | 0.0 |
| VF3 | VF3_4H2O_S2 | 2.718 | 1.274 | −99 | 193 | 292 | Large | 24.3 |
| | | | | | | | Hysteresis | |
| ScBr3_S25 | ScBr3_7H2O_S2 | 2.758 | 1.179 | −51 | 243 | 293 | Large | 14.7 |
| | | | | | | | Hysteresis | |
| MgBr2_2H2O_S8 | MgBr2_9H2O_S2 | 2.647 | 1.408 | 191 | 237 | 46 | 200-300 C. | 2.2 |
| SnF2 | SnF2_8H2O_S1 | 2.708 | 1.285 | 16 | 115 | 99 | Large | 12.8 |
| | | | | | | | Hysteresis | |
| GaCl3_1H2O_S2 | GaCl3_9H2O_S2 | 2.539 | 1.589 | 187 | 187 | 0 | 100-200 C. | 0.0 |
| FeF2 | FeF2_2H2O_S7 | 2.821 | 1.004 | 174 | 174 | 0 | 100-200 C. | 1.6 |
| TiF3 | TiF3_8H2O_S2 | 2.621 | 1.447 | −32 | 149 | 181 | Large | 47.5 |
| | | | | | | | Hysteresis | |
| CrF4 | CrF4_2H2O_S2 | 2.785 | 1.095 | 342 | 342 | 0 | 300-450 C. | 0.0 |
| SnCl2 | SnCl2_12H2O_S1 | 2.485 | 1.666 | 95 | 169 | 75 | 100-200 C. | 0.0 |
| PbF4 | PbF4_4H2O_S1 | 2.863 | 0.868 | 154 | 309 | 156 | Large | 3.1 |
| | | | | | | | Hysteresis | |
| MnBr2_1H2O_S2 | MnBr2_12H2O_S1 | 2.539 | 1.580 | 145 | 168 | 23 | 100-200 C. | 4.8 |
| CoF2 | CoF2_2H2O_S4 | 2.838 | 0.936 | 153 | 153 | 0 | 100-200 C. | 10.5 |
| 2-Feb | FeBr2_12H2O_S1 | 2.591 | 1.481 | 1 | 142 | 142 | Large | 5.4 |
| | | | | | | | Hysteresis | |
| CaF2 | CaF2_8H2O_S2 | 2.474 | 1.669 | 45 | 45 | 0 | <50 C. | 23.7 |
| TiBr2_1H2O_S2 | TiBr2_12H2O_S1 | 2.526 | 1.589 | 146 | 146 | 0 | 100-200 C. | 0.0 |
| NaCl1 | NaCl1_4H2O_S1 | 2.456 | 1.685 | 101 | 106 | 5 | 100-200 C. | 0.0 |
| SnF2 | SnF2_9H2O_S1 | 2.681 | 1.297 | −5 | 115 | 120 | Large | 19.7 |
| | | | | | | | Hysteresis | |
| SiF4 | SiF4_3H2O_S1 | 2.673 | 1.307 | 168 | 214 | 47 | 100-200 C. | 4.5 |
| TiBr2 | TiBr2_6H2O_S3 | 2.730 | 1.181 | 120 | 316 | 196 | Large | 9.5 |
| | | | | | | | Hysteresis | |
| GeCl2_1H2O_S2 | GeCl2_12H2O_S1 | 2.406 | 1.747 | 86 | 315 | 229 | Large | 35.2 |
| | | | | | | | Hysteresis | |
| AlI3_1H2O_S2 | AlI3_9H2O_S2 | 2.734 | 1.165 | 142 | 387 | 245 | Large | 8.4 |
| | | | | | | | Hysteresis | |
| NiBr2 | NiBr2_9H2O_S2 | 2.682 | 1.278 | 97 | 97 | 0 | 50-100 C. | 9.7 |
| CoBr2_1H2O_S2 | CoBr2_12H2O_S1 | 2.545 | 1.515 | 137 | 137 | 0 | 100-200 C. | 13.5 |
| NbCl4 | NbCl4_8H2O_S1 | 2.613 | 1.393 | 179 | 179 | 0 | 100-200 C. | 0.0 |
| LaCl2_S27 | LaCl2_12H2O_S1 | 2.483 | 1.614 | 119 | 119 | 0 | 100-200 C. | 18.3 |
| YF3_1H2O_S2 | YF3_9H2O_S2 | 2.526 | 1.544 | 134 | 134 | 0 | 100-200 C. | 36.5 |
| TiF3_2H2O_S2 | TiF3_9H2O_S2 | 2.478 | 1.616 | 143 | 184 | 40 | 100-200 C. | 5.3 |
| NiCl2 | NiCl2_8H2O_S2 | 2.521 | 1.547 | 90 | 90 | 0 | 50-100 C. | 18.1 |
| YBr3_S7 | YBr3_8H2O_S2 | 2.715 | 1.173 | 127 | 227 | 100 | 100-200 C. | 4.3 |
| ZnCl2 | ZnCl2_8H2O_S2 | 2.516 | 1.549 | 99 | 99 | 0 | 50-100 C. | 17.9 |
| FeCl3 | FeCl3_6H2O_S3 | 2.631 | 1.341 | 67 | 337 | 270 | Large | 5.8 |
| | | | | | | | Hysteresis | |
| TiBr3 | TiBr3_9H2O_S2 | 2.614 | 1.371 | 186 | 201 | 16 | 100-200 C. | 0.0 |
| AlBr3 | AlBr3_4H2O_S2 | 2.766 | 1.028 | 284 | 443 | 159 | 300-450 C. | 26.0 |
| FeF2_1H2O_S2 | FeF2_4H2O_S7 | 2.669 | 1.257 | 203 | 203 | 0 | 200-300 C. | 18.9 |
| WF4_S20 | WF4_5H2O_S2 | 2.794 | 0.948 | 181 | 181 | 0 | 100-200 C. | 0.0 |
| TiCl2 | TiCl2_8H2O_S2 | 2.413 | 1.697 | 77 | 329 | 251 | Large | 20.7 |
| | | | | | | | Hysteresis | |
| MgBr2_1H2O_S2 | MgBr2_8H2O_S2 | 2.559 | 1.466 | 160 | 270 | 109 | 200-300 C. | 8.8 |
| CrBr2 | CrBr2_8H2O_S2 | 2.644 | 1.305 | 59 | 190 | 131 | 100-200 C. | 15.0 |
| NiBr2_1H2O_S2 | NiBr2_12H2O_S1 | 2.546 | 1.479 | 127 | 127 | 0 | 100-200 C. | 24.6 |
| VCl2 | VCl2_4H2O_S3 | 2.626 | 1.330 | 165 | 179 | 15 | 100-200 C. | 0.0 |
| ZrF3_S12 | ZrF3_7H2O_S1 | 2.697 | 1.171 | 41 | 41 | 0 | <50 C. | 39.4 |
| HfF4 | HfF4_9H2O_S1 | 2.755 | 1.024 | −750 | 196 | 946 | Large | 37.7 |
| | | | | | | | Hysteresis | |
| SiCl2 | SiCl2_8H2O_S1 | 2.373 | 1.732 | 88 | 88 | 0 | 50-100 C. | 0.0 |
| SnF4_1H2O_S1 | SnF4_5H2O_S2 | 2.705 | 1.134 | 227 | 438 | 210 | 300-450 C. | 15.8 |
| TiI2_S16 | TiI2_12H2O_S1 | 2.564 | 1.423 | 148 | 148 | 0 | 100-200 C. | 0.0 |
| VCl3 | VCl3_7H2O_S2 | 2.584 | 1.386 | −393 | 199 | 592 | Large | 34.6 |
| | | | | | | | Hysteresis | |
| FeCl2 | FeCl2_8H2O_S2 | 2.457 | 1.583 | 52 | 137 | 85 | 50-100 C. | 11.1 |
| CoCl2 | CoCl2_8H2O_S2 | 2.476 | 1.552 | 91 | 91 | 0 | 50-100 C. | 20.8 |
| MnCl3_S25 | MnCl3_6H2O_S3 | 2.564 | 1.397 | 156 | 156 | 0 | 100-200 C. | 0.0 |
| SrCl2 | SrCl2_6H2O_S1 | 2.599 | 1.326 | 110 | 172 | 62 | 100-200 C. | 8.8 |
| NiCl3_S25 | NiCl3_9H2O_S1 | 2.521 | 1.465 | 57 | 109 | 52 | 50-100 C. | 0.0 |
| FeF3_3H2O_S5 | FeF3_9H2O_S2 | 2.514 | 1.469 | 188 | 188 | 0 | 100-200 C. | 4.5 |
| AlCl3_3H2O_S9 | AlCl3_9H2O_S2 | 2.386 | 1.661 | 202 | 372 | 169 | 200-300 C. | 6.4 |
| LiBr1 | LiBr1_3H2O_S1 | 2.579 | 1.339 | 71 | 222 | 150 | Large | 0.0 |
| | | | | | | | Hysteresis | |
| CrBr3 | CrBr3_9H2O_S2 | 2.600 | 1.294 | 174 | 174 | 0 | 100-200 C. | 0.0 |
| CuCl2 | CuCl2_6H2O_S3 | 2.603 | 1.287 | −40 | 145 | 185 | Large | 18.6 |
| | | | | | | | Hysteresis | |
| ZnF2_1H2O_S2 | ZnF2_4H2O_S4 | 2.664 | 1.154 | 189 | 189 | 0 | 100-200 C. | 11.7 |
| MgF2_1H2O_S2 | MgF2_4H2O_S7 | 2.530 | 1.418 | 162 | 162 | 0 | 100-200 C. | 31.4 |
| NbF3_2H2O_S2 | NbF3_9H2O_S2 | 2.510 | 1.450 | 170 | 170 | 0 | 100-200 C. | 38.2 |
| LaCl3 | LaCl3_10H2O_S2 | 2.570 | 1.332 | −136 | 170 | 306 | Large | 8.1 |
| | | | | | | | Hysteresis | |
| MgI2_2H2O_S8 | MgI2_12H2O_S1 | 2.506 | 1.444 | 195 | 263 | 68 | 200-300 C. | 0.0 |
| VBr2 | VBr2_8H2O_S2 | 2.553 | 1.351 | 102 | 173 | 71 | 100-200 C. | 14.6 |
| VBr2_2H2O_S8 | VBr2_12H2O_S1 | 2.457 | 1.519 | 167 | 189 | 22 | 100-200 C. | 5.2 |
| BeCl2_2H2O_S8 | BeCl2_8H2O_S1 | 2.364 | 1.660 | 40 | 375 | 336 | Large | 7.4 |
| | | | | | | | Hysteresis | |
| MnCl4_S1 | MnCl4_9H2O_S1 | 2.503 | 1.438 | −508 | 211 | 719 | Large | 26.2 |
| | | | | | | | Hysteresis | |
| BaCl2 | BaCl2_12H2O_S1 | 2.389 | 1.620 | 113 | 152 | 39 | 100-200 C. | 0.0 |
| SrF2 | SrF2_6H2O_S1 | 2.622 | 1.207 | 26 | 94 | 67 | 50-100 C. | 17.0 |
| VBr3_S31 | VBr3_9H2O_S2 | 2.573 | 1.309 | 156 | 189 | 33 | 100-200 C. | 0.0 |
| GaCl3 | GaCl3_7H2O_S1 | 2.547 | 1.354 | 104 | 267 | 163 | 100-200 C. | 30.2 |
| ZrCl4 | ZrCl4_10H2O_S1 | 2.582 | 1.283 | −414 | 260 | 674 | Large | 39.8 |
| | | | | | | | Hysteresis | |
| SrF2 | SrF2_8H2O_S1 | 2.560 | 1.322 | 12 | 94 | 82 | 50-100 C. | 24.8 |
| HfF4_1H2O_S1 | HfF4_8H2O_S1 | 2.648 | 1.134 | 125 | 280 | 155 | 200-300 C. | 31.7 |
| ScF3_2H2O_S2 | ScF3_9H2O_S2 | 2.399 | 1.596 | 123 | 235 | 111 | 100-200 C. | 16.6 |
| NbF4_1H2O_S1 | NbF4_5H2O_S2 | 2.606 | 1.227 | 271 | 271 | 0 | 200-300 C. | 49.4 |
| NiF3_2H2O_S2 | NiF3_10H2O_S2 | 2.535 | 1.366 | −737 | 280 | 1016 | Large | 34.9 |
| | | | | | | | Hysteresis | |
| CrF2_1H2O_S2 | CrF2_4H2O_S7 | 2.571 | 1.294 | 206 | 206 | 0 | 200-300 C. | 47.3 |
| TiI2_S16 | TiI2_9H2O_S2 | 2.631 | 1.167 | 139 | 139 | 0 | 100-200 C. | 4.0 |
| MnI2 | MnI2_12H2O_S1 | 2.516 | 1.391 | 144 | 144 | 0 | 100-200 C. | 0.0 |
| SrI2 | SrI2_9H2O_S1 | 2.646 | 1.121 | 128 | 187 | 59 | 100-200 C. | 4.9 |
| ZnI2 | ZnI2_12H2O_S1 | 2.544 | 1.336 | 124 | 191 | 67 | 100-200 C. | 0.0 |
| TiF3 | TiF3_7H2O_S2 | 2.539 | 1.344 | −58 | 149 | 206 | Large | 48.7 |
| | | | | | | | Hysteresis | |
| VF4_1H2O_S1 | VF4_5H2O_S2 | 2.536 | 1.348 | 188 | 348 | 160 | Large | 12.7 |
| | | | | | | | Hysteresis | |
| HfCl4 | HfCl4_10H2O_S1 | 2.660 | 1.082 | −440 | 306 | 746 | Large | 42.1 |
| | | | | | | | Hysteresis | |
| LaF2_S18 | LaF2_12H2O_S1 | 2.472 | 1.459 | 54 | 54 | 0 | 50-100 C. | 43.5 |
| BeCl2_2H2O_S8 | BeCl2_7H2O_S1 | 2.364 | 1.627 | 60 | 375 | 315 | Large | 2.4 |
| | | | | | | | Hysteresis | |
| YF3 | YF3_6H2O_S2 | 2.635 | 1.136 | 57 | 57 | 0 | 50-100 C. | 23.4 |
| ScCl3_2H2O_S2 | ScCl3_9H2O_S2 | 2.340 | 1.660 | 215 | 361 | 146 | 200-300 C. | 18.3 |
| BeF2 | BeF2_2H2O_S5 | 2.485 | 1.430 | 134 | 134 | 0 | 100-200 C. | 0.0 |
| BeBr2_2H2O_S2 | BeBr2_9H2O_S1 | 2.485 | 1.427 | 95 | 425 | 330 | Large | 0.4 |
| | | | | | | | Hysteresis | |
| ZrCl3 | ZrCl3_9H2O_S2 | 2.406 | 1.555 | 153 | 153 | 0 | 100-200 C. | 0.0 |
| SnCl4_1H2O_S1 | SnCl4_8H2O_S1 | 2.559 | 1.286 | 191 | 343 | 152 | Large | 48.8 |
| | | | | | | | Hysteresis | |
| VF4 | VF4_3H2O_S1 | 2.598 | 1.204 | 112 | 281 | 169 | 100-200 C. | 8.2 |
| CrCl3 | CrCl3_7H2O_S2 | 2.476 | 1.436 | 127 | 127 | 0 | 100-200 C. | 26.7 |
| SiF4_2H2O_S1 | SiF4_8H2O_S1 | 2.427 | 1.516 | 103 | 210 | 106 | 100-200 C. | 0.0 |
| BaF2_1H2O_S1 | BaF2_12H2O_S1 | 2.436 | 1.499 | 68 | 334 | 266 | Large | 46.7 |
| | | | | | | | Hysteresis | |
| MoCl3 | MoCl3_9H2O_S2 | 2.441 | 1.492 | 131 | 175 | 44 | 100-200 C. | 0.0 |
| YBr3_S7 | YBr3_7H2O_S2 | 2.645 | 1.081 | 96 | 227 | 130 | Large | 4.2 |
| | | | | | | | Hysteresis | |
| TiCl2_1H2O_S2 | TiCl2_9H2O_S2 | 2.422 | 1.515 | 91 | 91 | 0 | 50-100 C. | 15.7 |
| YBr3_S7 | YBr3_6H2O_S2 | 2.675 | 1.002 | 227 | 227 | 0 | 200-300 C. | 0.0 |
| CrI2 | CrI2_12H2O_S1 | 2.501 | 1.376 | 127 | 157 | 30 | 100-200 C. | 0.0 |
| CaBr2_1H2O_S2 | CaBr2_9H2O_S2 | 2.499 | 1.377 | 150 | 179 | 29 | 100-200 C. | 9.9 |
| CrI2 | CrI2_9H2O_S2 | 2.617 | 1.134 | 110 | 157 | 46 | 100-200 C. | 4.2 |
| AlBr3_1H2O_S2 | AlBr3_7H2O_S1 | 2.605 | 1.161 | −392 | 375 | 767 | Large | 34.8 |
| | | | | | | | Hysteresis | |
| CoCl3_1H2O_S3 | CoCl3_9H2O_S2 | 2.426 | 1.498 | 121 | 163 | 42 | 100-200 C. | 42.9 |
| LaCl3 | LaCl3_7H2O_S1 | 2.601 | 1.161 | 23 | 170 | 146 | Large | 4.0 |
| | | | | | | | Hysteresis | |
| ZrF3_S12 | ZrF3_6H2O_S3 | 2.575 | 1.213 | 82 | 82 | 0 | 50-100 C. | 26.7 |
| CuCl2_2H2O_S5 | CuCl2_12H2O_S1 | 2.341 | 1.617 | 89 | 219 | 130 | Large | 24.9 |
| | | | | | | | Hysteresis | |
| GaF3 | GaF3_7H2O_S1 | 2.556 | 1.250 | 36 | 36 | 0 | <50 C. | 46.5 |
| GaCl3_1H2O_S2 | GaCl3_10H2O_S2 | 2.466 | 1.418 | −493 | 187 | 680 | Large | 24.0 |
| | | | | | | | Hysteresis | |
| CuBr2 | CuBr2_12H2O_S1 | 2.458 | 1.427 | 74 | 108 | 34 | 50-100 C. | 0.0 |
| CrCl3_2H2O_S2 | CrCl3_9H2O_S2 | 2.369 | 1.571 | 220 | 220 | 0 | 200-300 C. | 31.6 |
| TiBr3 | TiBr3_10H2O_S2 | 2.578 | 1.195 | −666 | 201 | 867 | Large | 31.7 |
| | | | | | | | Hysteresis | |
| MnCl2 | MnCl2_4H2O_S3 | 2.535 | 1.283 | 158 | 174 | 16 | 100-200 C. | 0.0 |
| CoCl3_S22 | CoCl3_6H2O_S3 | 2.541 | 1.269 | 123 | 123 | 0 | 100-200 C. | 0.0 |
| TiBr2_2H2O_S3 | TiBr2_12H2O_S1 | 2.401 | 1.511 | 166 | 166 | 0 | 100-200 C. | 32.2 |
| ScBr3_S25 | ScBr3_6H2O_S1 | 2.593 | 1.151 | 243 | 243 | 0 | 200-300 C. | 0.0 |
| PbCl2 | PbCl2_12H2O_S1 | 2.478 | 1.378 | 106 | 144 | 38 | 100-200 C. | 0.0 |
| GaBr3 | GaBr3_9H2O_S2 | 2.555 | 1.227 | 151 | 225 | 75 | 100-200 C. | 0.0 |
| ScF3 | ScF3_8H2O_S2 | 2.470 | 1.387 | −44 | 125 | 170 | Large | 45.3 |
| | | | | | | | Hysteresis | |
| MnF4_2H2O_S2 | MnF4_9H2O_S1 | 2.499 | 1.334 | −228 | 217 | 445 | Large | 13.0 |
| | | | | | | | Hysteresis | |
| VCl2_1H2O_S2 | VCl2_6H2O_S3 | 2.497 | 1.337 | 123 | 165 | 42 | 100-200 C. | 5.9 |
| CaBr2 | CaBr2_8H2O_S2 | 2.415 | 1.477 | 145 | 245 | 100 | 100-200 C. | 11.1 |
| CaF2 | CaF2_6H2O_S3 | 2.430 | 1.450 | 35 | 35 | 0 | <50 C. | 26.9 |
| YCl3_1H2O_S3 | YCl3_9H2O_S2 | 2.358 | 1.564 | 171 | 250 | 80 | 200-300 C. | 14.3 |
| VI2_1H2O_S2 | VI2_12H2O_S1 | 2.482 | 1.356 | 167 | 167 | 0 | 100-200 C. | 13.2 |
| BaF2 | BaF2_8H2O_S1 | 2.559 | 1.199 | 24 | 149 | 125 | Large | 15.0 |
| | | | | | | | Hysteresis | |
| CaBr2_2H2O_S3 | CaBr2_12H2O_S1 | 2.341 | 1.584 | 178 | 178 | 0 | 100-200 C. | 0.0 |
| ZnF2 | ZnF2_2H2O_S4 | 2.679 | 0.898 | 156 | 156 | 0 | 100-200 C. | 6.1 |
| ZnBr2 | ZnBr2_6H2O_S3 | 2.620 | 1.052 | 83 | 149 | 67 | 100-200 C. | 8.4 |
| CaI2_1H2O_S2 | CaI2_12H2O_S1 | 2.425 | 1.444 | 181 | 229 | 48 | 200-300 C. | 2.5 |
| SrBr2 | SrBr2_8H2O_S1 | 2.555 | 1.192 | 105 | 192 | 86 | 100-200 C. | 16.3 |
| TiF4_1H2O_S1 | TiF4_5H2O_S2 | 2.468 | 1.363 | 209 | 278 | 69 | 200-300 C. | 6.9 |
| BeF2_2H2O_S5 | BeF2_9H2O_S1 | 2.312 | 1.608 | 48 | 76 | 27 | 50-100 C. | 0.0 |
| TaCl4 | TaCl4_8H2O_S1 | 2.586 | 1.115 | 173 | 173 | 0 | 100-200 C. | 0.0 |
| NiF3_3H2O_S9 | NiF3_9H2O_S2 | 2.438 | 1.408 | 174 | 174 | 0 | 100-200 C. | 0.0 |
| MnF3 | MnF3_4H2O_S2 | 2.537 | 1.221 | −116 | 187 | 303 | Large | 23.0 |
| | | | | | | | Hysteresis | |
| CoBr2 | CoBr2_6H2O_S3 | 2.613 | 1.047 | 118 | 118 | 0 | 100-200 C. | 6.4 |
| FeBr2_1H2O_S2 | FeBr2_9H2O_S2 | 2.526 | 1.242 | 106 | 166 | 60 | 100-200 C. | 18.1 |
| NbF4 | NbF4_3H2O_S2 | 2.656 | 0.930 | 201 | 201 | 0 | 200-300 C. | 1.7 |
| MoCl4_1H2O_S1 | MoCl4_8H2O_S1 | 2.491 | 1.305 | 188 | 250 | 62 | 200-300 C. | 24.8 |
| YI3 | YI3_10H2O_S2 | 2.613 | 1.041 | 31 | 234 | 203 | Large | 0.7 |
| | | | | | | | Hysteresis | |
| NiF2_2H2O_S4 | NiF2_9H2O_S2 | 2.458 | 1.363 | 27 | 185 | 158 | Large | 24.5 |
| | | | | | | | Hysteresis | |
| MgCl2_4H2O_S7 | MgCl2_12H2O_S1 | 2.198 | 1.750 | 194 | 194 | 0 | 100-200 C. | 0.0 |
| GeF2 | GeF2_4H2O_S2 | 2.506 | 1.264 | 92 | 153 | 62 | 100-200 C. | 0.0 |
| GaBr3 | GaBr3_10H2O_S2 | 2.554 | 1.162 | −340 | 225 | 565 | Large | 17.2 |
| | | | | | | | Hysteresis | |
| GeF2 | GeF2_8H2O_S2 | 2.435 | 1.394 | −60 | 153 | 214 | Large | 28.0 |
| | | | | | | | Hysteresis | |
| VCl2_1H2O_S2 | VCl2_8H2O_S2 | 2.337 | 1.553 | 106 | 165 | 59 | 100-200 C. | 13.0 |
| GeCl2_S21 | GeCl2_9H2O_S2 | 2.400 | 1.451 | −14 | 176 | 189 | Large | 25.1 |
| | | | | | | | Hysteresis | |
| MnF4_2H2O_S2 | MnF4_8H2O_S1 | 2.432 | 1.397 | 115 | 217 | 102 | 100-200 C. | 0.0 |
| TiBr3 | TiBr3_8H2O_S2 | 2.566 | 1.129 | −27 | 201 | 228 | Large | 23.0 |
| | | | | | | | Hysteresis | |
| ZnI2 | ZnI2_9H2O_S2 | 2.588 | 1.075 | 101 | 191 | 90 | 100-200 C. | 8.3 |
| HfBr4_S31 | HfBr4_8H2O_S1 | 2.654 | 0.899 | 192 | 296 | 104 | 200-300 C. | 0.0 |
| MnI2 | MnI2_9H2O_S2 | 2.568 | 1.120 | 128 | 128 | 0 | 100-200 C. | 6.9 |
| GeF2 | GeF2_7H2O_S1 | 2.477 | 1.309 | −93 | 153 | 246 | Large | 29.8 |
| | | | | | | | Hysteresis | |
| ZrBr3 | ZrBr3_10H2O_S1 | 2.559 | 1.139 | −95 | 150 | 245 | Large | 6.3 |
| | | | | | | | Hysteresis | |
| TiF4 | TiF4_3H2O_S1 | 2.525 | 1.210 | 173 | 241 | 69 | 200-300 C. | 3.9 |
| CaF2 | CaF2_7H2O_S1 | 2.411 | 1.422 | 11 | 11 | 0 | <50 C. | 38.1 |
| MgI2_2H2O_S8 | MgI2_9H2O_S2 | 2.550 | 1.155 | 209 | 263 | 54 | 200-300 C. | 0.0 |
| VCl3_1H2O_S3 | VCl3_6H2O_S1 | 2.438 | 1.370 | 192 | 275 | 83 | 200-300 C. | 32.9 |
| YI3 | YI3_9H2O_S3 | 2.612 | 1.001 | 100 | 234 | 134 | Large | 0.0 |
| | | | | | | | Hysteresis | |
| SrI2 | SrI2_12H2O_S1 | 2.433 | 1.379 | 160 | 187 | 27 | 100-200 C. | 0.0 |
| HfCl3_S28 | HfCl3_9H2O_S2 | 2.488 | 1.275 | 161 | 161 | 0 | 100-200 C. | 0.0 |
| PbF2 | PbF2_8H2O_S1 | 2.621 | 0.972 | 30 | 115 | 86 | Large | 17.2 |
| | | | | | | | Hysteresis | |
| MgBr2_1H2O_S2 | MgBr2_6H2O_S2 | 2.515 | 1.210 | 157 | 270 | 113 | 200-300 C. | 6.2 |
| MnBr2 | MnBr2_6H2O_S3 | 2.566 | 1.099 | 72 | 162 | 89 | 100-200 C. | 10.4 |
| SnCl2_1H2O_S2 | SnCl2_12H2O_S1 | 2.317 | 1.554 | 95 | 298 | 203 | Large | 32.5 |
| | | | | | | | Hysteresis | |
| MoF2_1H2O_S2 | MoF2_12H2O_S1 | 2.400 | 1.416 | 36 | 36 | 0 | <50 C. | 4.8 |
| SrBr2_1H2O_S1 | SrBr2_12H2O_S1 | 2.355 | 1.489 | 153 | 191 | 37 | 100-200 C. | 0.0 |
| VCl3_2H2O_S2 | VCl3_9H2O_S2 | 2.311 | 1.557 | 179 | 383 | 204 | Large | 27.8 |
| | | | | | | | Hysteresis | |
| CoF3_4H2O_S2 | CoF3_9H2O_S2 | 2.421 | 1.376 | 251 | 251 | 0 | 200-300 C. | 22.8 |
| VBr2 | VBr2_7H2O_S1 | 2.519 | 1.186 | 44 | 173 | 129 | Large | 23.2 |
| | | | | | | | Hysteresis | |
| MnF2_1H2O_S2 | MnF2_4H2O_S7 | 2.504 | 1.218 | 186 | 186 | 0 | 100-200 C. | 20.3 |
| YBr3_S7 | YBr3_9H2O_S2 | 2.468 | 1.284 | 166 | 227 | 60 | 100-200 C. | 0.0 |
| LaF3 | LaF3_10H2O_S2 | 2.518 | 1.183 | −387 | 78 | 465 | <50 C. | 19.3 |
| HfCl3_S28 | HfCl3_8H2O_S1 | 2.580 | 1.039 | 109 | 109 | 0 | 100-200 C. | 25.1 |
| GeCl4 | GeCl4_8H2O_S1 | 2.440 | 1.336 | 137 | 137 | 0 | 100-200 C. | 0.0 |
| CrF3_3H2O_S9 | CrF3_9H2O_S2 | 2.370 | 1.455 | 177 | 177 | 0 | 100-200 C. | 0.0 |
| ScI3_S9 | ScI3_8H2O_S2 | 2.594 | 0.998 | 102 | 251 | 149 | 100-200 C. | 7.3 |
| LiF1 | LiF1_3H2O_S1 | 2.332 | 1.512 | 3 | 3 | 0 | <50 C. | 21.0 |
| BaF2 | BaF2_6H2O_S1 | 2.566 | 1.066 | 33 | 149 | 115 | Large | 10.0 |
| | | | | | | | Hysteresis | |
| ScF3 | ScF3_6H2O_S3 | 2.425 | 1.356 | −21 | 125 | 147 | Large | 29.9 |
| | | | | | | | Hysteresis | |
| TiBr3 | TiBr3_6H2O_S3 | 2.571 | 1.050 | 201 | 201 | 0 | 200-300 C. | 0.0 |
| GeF2_2H2O_S5 | GeF2_12H2O_S1 | 2.317 | 1.531 | 64 | 92 | 27 | 50-100 C. | 0.0 |
| SrBr2 | SrBr2_6H2O_S1 | 2.566 | 1.061 | 141 | 192 | 51 | 100-200 C. | 3.7 |
| TiBr2_1H2O_S2 | TiBr2_9H2O_S2 | 2.475 | 1.255 | 124 | 124 | 0 | 100-200 C. | 9.0 |
| ZrF3_S12 | ZrF3_8H2O_S2 | 2.484 | 1.237 | 37 | 37 | 0 | <50 C. | 38.3 |
| MgF2_4H2O_S7 | MgF2_12H2O_S1 | 2.242 | 1.633 | 116 | 116 | 0 | 100-200 C. | 0.0 |
| ZnBr2_2H2O_S8 | ZnBr2_12H2O_S1 | 2.389 | 1.409 | 141 | 201 | 60 | 100-200 C. | 17.4 |
| NbF3_1H2O_S2 | NbF3_10H2O_S2 | 2.483 | 1.232 | −739 | 134 | 873 | Large | 35.0 |
| | | | | | | | Hysteresis | |
| WCl4 | WCl4_8H2O_S1 | 2.550 | 1.080 | 161 | 161 | 0 | 100-200 C. | 0.0 |
| TiI2_1H2O_S2 | TiI2_12H2O_S1 | 2.419 | 1.343 | 160 | 160 | 0 | 100-200 C. | 34.0 |
| GeBr2 | GeBr2_12H2O_S1 | 2.353 | 1.456 | 81 | 137 | 56 | 100-200 C. | 0.0 |
| ScI3_S9 | ScI3_10H2O_S2 | 2.557 | 1.055 | −368 | 251 | 620 | Large | 18.5 |
| | | | | | | | Hysteresis | |
| CaF2 | CaF2_4H2O_S4 | 2.380 | 1.409 | 89 | 89 | 0 | 50-100 C. | 3.3 |
| CrCl2 | CrCl2_7H2O_S1 | 2.379 | 1.410 | −89 | 190 | 279 | Large | 39.9 |
| | | | | | | | Hysteresis | |
| HfF4 | HfF4_5H2O_S2 | 2.604 | 0.929 | 119 | 196 | 77 | 100-200 C. | 0.9 |
| NaF1 | NaF1_2H2O_S1 | 2.413 | 1.348 | 87 | 87 | 0 | 50-100 C. | 13.0 |
| PbCl4 | PbCl4_8H2O_S1 | 2.545 | 1.077 | 180 | 184 | 4 | 100-200 C. | 0.0 |
| LiBr1 | LiBr1_2H2O_S3 | 2.524 | 1.126 | 180 | 222 | 42 | 200-300 C. | 0.0 |
| CrF4_2H2O_S2 | CrF4_8H2O_S1 | 2.381 | 1.401 | 121 | 204 | 84 | 100-200 C. | 0.0 |
| SrCl2 | SrCl2_7H2O_S1 | 2.427 | 1.315 | 62 | 172 | 110 | 100-200 C. | 24.8 |
| PbF4_1H2O_S1 | PbF4_5H2O_S2 | 2.623 | 0.862 | 188 | 487 | 299 | Large | 33.7 |
| | | | | | | | Hysteresis | |
| NiF2_4H2O_S4 | NiF2_12H2O_S1 | 2.327 | 1.483 | 124 | 124 | 0 | 100-200 C. | 0.0 |
| GeF4_2H2O_S2 | GeF4_8H2O_S1 | 2.426 | 1.315 | 110 | 223 | 113 | 100-200 C. | 0.0 |
| ScF3 | ScF3_7H2O_S2 | 2.412 | 1.339 | −49 | 125 | 174 | Large | 41.8 |
| | | | | | | | Hysteresis | |
| SnF4 | SnF4_2H2O_S2 | 2.641 | 0.794 | 354 | 354 | 0 | 300-450 C. | 0.0 |
| ZrCl2 | ZrCl2_12H2O_S1 | 2.282 | 1.550 | 57 | 114 | 57 | 50-100 C. | 0.0 |
| AlF3_3H2O_S9 | AlF3_9H2O_S2 | 2.297 | 1.526 | 156 | 156 | 0 | 100-200 C. | 0.0 |
| CrBr3 | CrBr3_10H2O_S2 | 2.498 | 1.168 | −523 | 174 | 697 | Large | 25.3 |
| | | | | | | | Hysteresis | |
| CoCl2 | CoCl2_4H2O_S3 | 2.490 | 1.184 | 136 | 136 | 0 | 100-200 C. | 0.4 |
| FeI2 | FeI2_9H2O_S2 | 2.535 | 1.081 | 110 | 122 | 12 | 100-200 C. | 0.0 |
| FeCl3 | FeCl3_8H2O_S2 | 2.404 | 1.347 | −1 | 337 | 338 | Large | 25.8 |
| | | | | | | | Hysteresis | |
| ZrCl3 | ZrCl3_8H2O_S2 | 2.429 | 1.296 | 106 | 106 | 0 | 100-200 C. | 20.1 |
| NiCl2 | NiCl2_7H2O_S1 | 2.400 | 1.345 | 63 | 63 | 0 | 50-100 C. | 29.3 |
| TaF4_S5 | TaF4_3H2O_S2 | 2.668 | 0.667 | 201 | 201 | 0 | 200-300 C. | 0.8 |
| NiBr2_2H2O_S5 | NiBr2_12H2O_S1 | 2.378 | 1.381 | 138 | 138 | 0 | 100-200 C. | 33.3 |
| CuF2 | CuF2_2H2O_S3 | 2.606 | 0.879 | 141 | 141 | 0 | 100-200 C. | 13.0 |
| SrF2_2H2O_S1 | SrF2_12H2O_S1 | 2.283 | 1.531 | 86 | 86 | 0 | 50-100 C. | 0.0 |
| NiCl3_1H2O_S3 | NiCl3_9H2O_S1 | 2.376 | 1.381 | 57 | 148 | 91 | 100-200 C. | 41.9 |
| LaBr2 | LaBr2_12H2O_S1 | 2.385 | 1.364 | 128 | 128 | 0 | 100-200 C. | 7.5 |
| ZrBr4_S31 | ZrBr4_9H2O_S1 | 2.567 | 0.976 | −240 | 239 | 479 | Large | 13.6 |
| | | | | | | | Hysteresis | |
| TiBr3 | TiBr3_7H2O_S2 | 2.536 | 1.054 | −132 | 201 | 334 | Large | 19.3 |
| | | | | | | | Hysteresis | |
| CaI2 | CaI2_7H2O_S1 | 2.530 | 1.065 | 143 | 219 | 76 | 100-200 C. | 12.0 |
| TiCl3_2H2O_S2 | TiCl3_9H2O_S2 | 2.252 | 1.570 | 195 | 323 | 129 | Large | 18.4 |
| | | | | | | | Hysteresis | |
| YCl3_1H2O_S3 | YCl3_6H2O_S2 | 2.468 | 1.202 | 210 | 250 | 40 | 200-300 C. | 14.3 |
| HfBr4_S31 | HfBr4_9H2O_S1 | 2.608 | 0.854 | −368 | 296 | 663 | Large | 19.6 |
| | | | | | | | Hysteresis | |
| NbCl3_S22 | NbCl3_10H2O_S2 | 2.405 | 1.320 | −393 | 122 | 514 | Large | 19.6 |
| | | | | | | | Hysteresis | |
| AlF3 | AlF3_2H2O_S2 | 2.526 | 1.071 | 167 | 167 | 0 | 100-200 C. | 6.7 |
| KF1 | KF1_3H2O_S1 | 2.328 | 1.451 | −57 | 176 | 233 | Large | 29.3 |
| | | | | | | | Hysteresis | |
| LaBr3 | LaBr3_10H2O_S2 | 2.521 | 1.080 | −35 | 194 | 229 | Large | 3.7 |
| | | | | | | | Hysteresis | |
| GeF2 | GeF2_6H2O_S3 | 2.449 | 1.235 | −139 | 153 | 292 | Large | 29.3 |
| | | | | | | | Hysteresis | |
| ZrCl3 | ZrCl3_7H2O_S2 | 2.448 | 1.232 | 117 | 117 | 0 | 100-200 C. | 15.0 |
| RbF1 | RbF1_3H2O_S1 | 2.469 | 1.182 | −51 | 344 | 395 | Large | 28.3 |
| | | | | | | | Hysteresis | |
| FeCl2 | FeCl2_4H2O_S3 | 2.458 | 1.204 | 137 | 137 | 0 | 100-200 C. | 0.0 |
| NbF4 | NbF4_4H2O_S1 | 2.508 | 1.092 | 177 | 177 | 0 | 100-200 C. | 10.1 |
| BaCl2 | BaCl2_9H2O_S1 | 2.420 | 1.271 | 66 | 152 | 86 | 100-200 C. | 16.5 |
| CuCl2 | CuCl2_4H2O_S3 | 2.463 | 1.183 | 145 | 145 | 0 | 100-200 C. | 0.0 |
| MnBr2_2H2O_S8 | MnBr2_12H2O_S1 | 2.318 | 1.442 | 145 | 185 | 41 | 100-200 C. | 7.9 |
| HfBr3_S28 | HfBr3_10H2O_S2 | 2.556 | 0.953 | −309 | 165 | 474 | Large | 15.8 |
| | | | | | | | Hysteresis | |
| GeCl2_S21 | GeCl2_8H2O_S1 | 2.375 | 1.338 | −49 | 176 | 225 | Large | 30.3 |
| | | | | | | | Hysteresis | |
| AlI3_1H2O_S2 | AlI3_6H2O_S1 | 2.559 | 0.934 | 387 | 387 | 0 | 300-450 C. | 8.4 |
| TiBr2 | TiBr2_8H2O_S2 | 2.383 | 1.319 | 97 | 316 | 219 | Large | 19.5 |
| | | | | | | | Hysteresis | |
| ScI3_S9 | ScI3_9H2O_S2 | 2.486 | 1.111 | 170 | 251 | 81 | 200-300 C. | 0.0 |
| CoI2 | CoI2_12H2O_S1 | 2.410 | 1.264 | 109 | 109 | 0 | 100-200 C. | 0.0 |
| TiF4_2H2O_S2 | TiF4_8H2O_S1 | 2.314 | 1.432 | 121 | 209 | 88 | 100-200 C. | 0.0 |
| ZrBr4_S31 | ZrBr4_8H2O_S1 | 2.531 | 0.999 | 184 | 239 | 55 | 200-300 C. | 0.0 |
| YF3 | YF3_8H2O_S2 | 2.408 | 1.263 | 41 | 41 | 0 | <50 C. | 31.3 |
| SrCl2_2H2O_S4 | SrCl2_12H2O_S1 | 2.191 | 1.611 | 140 | 140 | 0 | 100-200 C. | 0.0 |
| SrF2 | SrF2_7H2O_S1 | 2.428 | 1.224 | 2 | 94 | 91 | <50 C. | 26.2 |
| RbF1 | RbF1_2H2O_S1 | 2.485 | 1.103 | 171 | 344 | 173 | Large | 0.0 |
| | | | | | | | Hysteresis | |
| CrBr2_2H2O_S8 | CrBr2_12H2O_S1 | 2.312 | 1.429 | 126 | 227 | 101 | 100-200 C. | 12.2 |
| CoBr2_2H2O_S8 | CoBr2_12H2O_S1 | 2.334 | 1.389 | 141 | 141 | 0 | 100-200 C. | 14.2 |
| PbCl2 | PbCl2_9H2O_S1 | 2.509 | 1.040 | 28 | 144 | 116 | Large | 19.7 |
| | | | | | | | Hysteresis | |
| MgCl2_2H2O_S8 | MgCl2_8H2O_S2 | 2.191 | 1.603 | 146 | 202 | 56 | 100-200 C. | 10.6 |
| ZrF4 | ZrF4_5H2O_S2 | 2.441 | 1.182 | 75 | 189 | 114 | 100-200 C. | 4.9 |
| MgCl2_1H2O_S2 | MgCl2_7H2O_S1 | 2.281 | 1.466 | −21 | 245 | 266 | Large | 40.7 |
| | | | | | | | Hysteresis | |
| CuBr2 | CuBr2_9H2O_S2 | 2.455 | 1.148 | 28 | 108 | 79 | Large | 11.4 |
| | | | | | | | Hysteresis | |
| NbF4_2H2O_S2 | NbF4_8H2O_S1 | 2.378 | 1.296 | 143 | 237 | 93 | 100-200 C. | 12.6 |
| MoF4_2H2O_S2 | MoF4_8H2O_S1 | 2.401 | 1.253 | 128 | 230 | 102 | 100-200 C. | 0.0 |
| VF2_4H2O_S4 | VF2_12H2O_S1 | 2.247 | 1.508 | 121 | 121 | 0 | 100-200 C. | 0.0 |
| ZrCl3_1H2O_S2 | ZrCl3_9H2O_S2 | 2.273 | 1.469 | 179 | 179 | 0 | 100-200 C. | 46.2 |
| VF2 | VF2_2H2O_S4 | 2.526 | 0.965 | 140 | 140 | 0 | 100-200 C. | 11.3 |
| TiBr3_1H2O_S3 | TiBr3_9H2O_S2 | 2.391 | 1.253 | 186 | 224 | 38 | 200-300 C. | 24.5 |
| TiF3 | TiF3_3H2O_S8 | 2.436 | 1.162 | 149 | 149 | 0 | 100-200 C. | 0.0 |
| CoF2_4H2O_S7 | CoF2_12H2O_S1 | 2.266 | 1.465 | 120 | 120 | 0 | 100-200 C. | 0.0 |
| CaCl2_1H2O_S2 | CaCl2_8H2O_S2 | 2.137 | 1.646 | 114 | 170 | 57 | 100-200 C. | 12.3 |
| SrBr2_1H2O_S1 | SrBr2_9H2O_S1 | 2.436 | 1.155 | 124 | 191 | 67 | 100-200 C. | 10.6 |
| VF4_2H2O_S2 | VF4_8H2O_S1 | 2.304 | 1.395 | 129 | 188 | 59 | 100-200 C. | 0.0 |
| YF3 | YF3_7H2O_S2 | 2.404 | 1.212 | 50 | 50 | 0 | <50 C. | 26.9 |
| NbCl3_S22 | NbCl3_9H2O_S2 | 2.278 | 1.435 | 122 | 122 | 0 | 100-200 C. | 0.0 |
| NiF3_2H2O_S2 | NiF3_6H2O_S2 | 2.413 | 1.192 | 152 | 280 | 128 | 200-300 C. | 4.5 |
| CrBr3_1H2O_S3 | CrBr3_9H2O_S2 | 2.409 | 1.199 | 193 | 193 | 0 | 100-200 C. | 32.8 |
| VBr3_1H2O_S3 | VBr3_9H2O_S2 | 2.398 | 1.220 | 156 | 226 | 70 | 100-200 C. | 40.4 |
| CrBr3 | CrBr3_6H2O_S3 | 2.507 | 0.975 | 172 | 172 | 0 | 100-200 C. | 0.9 |
| NiF3_4H2O_S2 | NiF3_9H2O_S2 | 2.329 | 1.345 | 239 | 239 | 0 | 200-300 C. | 30.9 |
| KF1 | KF1_2H2O_S1 | 2.301 | 1.393 | 176 | 176 | 0 | 100-200 C. | 0.0 |
| NiBr2 | NiBr2_6H2O_S3 | 2.496 | 0.994 | 98 | 98 | 0 | 50-100 C. | 8.9 |
| BaBr2 | BaBr2_12H2O_S1 | 2.310 | 1.369 | 122 | 172 | 50 | 100-200 C. | 0.0 |
| ZnI2_1H2O_S2 | ZnI2_12H2O_S1 | 2.377 | 1.248 | 124 | 334 | 210 | Large | 36.0 |
| | | | | | | | Hysteresis | |
| LaCl3 | LaCl3_6H2O_S2 | 2.450 | 1.098 | 170 | 170 | 0 | 100-200 C. | 0.0 |
| CuCl2 | CuCl2_8H2O_S2 | 2.312 | 1.363 | −41 | 145 | 186 | Large | 29.2 |
| | | | | | | | Hysteresis | |
| SrBr2 | SrBr2_7H2O_S1 | 2.450 | 1.087 | 97 | 192 | 94 | 100-200 C. | 17.7 |
| TiCl2 | TiCl2_7H2O_S1 | 2.303 | 1.366 | 9 | 329 | 320 | Large | 46.0 |
| | | | | | | | Hysteresis | |
| HfBr4_S31 | HfBr4_10H2O_S1 | 2.542 | 0.842 | −296 | 296 | 591 | Large | 29.6 |
| | | | | | | | Hysteresis | |
| NiCl3_S25 | NiCl3_6H2O_S3 | 2.378 | 1.226 | 109 | 109 | 0 | 100-200 C. | 0.0 |
| YI3 | YI3_8H2O_S2 | 2.503 | 0.941 | 181 | 234 | 53 | 200-300 C. | 0.0 |
| PbF2 | PbF2_6H2O_S1 | 2.554 | 0.788 | 10 | 115 | 106 | Large | 20.5 |
| | | | | | | | Hysteresis | |
| SnF2 | SnF2_7H2O_S1 | 2.431 | 1.111 | −53 | 115 | 168 | Large | 23.8 |
| | | | | | | | Hysteresis | |
| CrBr2 | CrBr2_4H2O_S3 | 2.497 | 0.953 | 190 | 190 | 0 | 100-200 C. | 0.0 |
| TaF3_1H2O_S2 | TaF3_9H2O_S2 | 2.441 | 1.084 | 98 | 98 | 0 | 50-100 C. | 13.5 |
| MoF3_3H2O_S9 | MoF3_9H2O_S2 | 2.339 | 1.289 | 191 | 191 | 0 | 100-200 C. | 0.0 |
| ZrF4 | ZrF4_3H2O_S2 | 2.509 | 0.915 | 189 | 189 | 0 | 100-200 C. | 0.0 |
| CaCl2_1H2O_S2 | CaCl2_6H2O_S1 | 2.310 | 1.340 | 67 | 170 | 103 | 100-200 C. | 14.6 |
| LiI1 | LiI1_4H2O_S1 | 2.415 | 1.138 | 2 | 225 | 223 | Large | 4.8 |
| | | | | | | | Hysteresis | |
| SiCl2 | SiCl2_12H2O_S1 | 2.070 | 1.684 | −85 | 88 | 173 | <50 C. | 20.5 |
| ZnF2_4H2O_S4 | ZnF2_12H2O_S1 | 2.251 | 1.433 | 119 | 119 | 0 | 100-200 C. | 0.0 |
| FeCl2_2H2O_S8 | FeCl2_9H2O_S2 | 2.281 | 1.383 | 101 | 160 | 59 | 100-200 C. | 7.9 |
| HfF4 | HfF4_3H2O_S2 | 2.581 | 0.666 | 196 | 196 | 0 | 100-200 C. | 0.0 |
| TiF2_4H2O_S7 | TiF2_12H2O_S1 | 2.197 | 1.509 | 117 | 117 | 0 | 100-200 C. | 17.7 |
| GaF3_3H2O_S9 | GaF3_9H2O_S2 | 2.308 | 1.333 | 166 | 166 | 0 | 100-200 C. | 14.3 |
| BaF2 | BaF2_7H2O_S1 | 2.431 | 1.090 | 8 | 149 | 140 | Large | 18.8 |
| | | | | | | | Hysteresis | |
| MoCl3 | MoCl3_10H2O_S1 | 2.338 | 1.277 | −652 | 175 | 827 | Large | 31.1 |
| | | | | | | | Hysteresis | |
| HfCl3_S28 | HfCl3_7H2O_S2 | 2.480 | 0.973 | 118 | 118 | 0 | 100-200 C. | 23.8 |
| MnBr4_S31 | MnBr4_8H2O_S1 | 2.470 | 0.999 | 171 | 171 | 0 | 100-200 C. | 0.0 |
| AlI3_2H2O_S2 | AlI3_9H2O_S2 | 2.451 | 1.044 | 142 | 434 | 292 | Large | 33.3 |
| | | | | | | | Hysteresis | |
| SiBr4 | SiBr4_9H2O_S1 | 2.444 | 1.055 | 129 | 137 | 9 | 100-200 C. | 0.0 |
| BeI2_2H2O_S9 | BeI2_12H2O_S1 | 2.329 | 1.289 | 54 | 443 | 389 | Large | 0.0 |
| | | | | | | | Hysteresis | |
| GaCl3_2H2O_S1 | GaCl3_9H2O_S2 | 2.256 | 1.412 | 194 | 194 | 0 | 100-200 C. | 7.6 |
| SnBr2 | SnBr2_12H2O_S1 | 2.304 | 1.331 | 90 | 139 | 50 | 100-200 C. | 0.0 |
| MnI2_1H2O_S2 | MnI2_12H2O_S1 | 2.329 | 1.287 | 148 | 148 | 0 | 100-200 C. | 11.1 |
| LaBr3 | LaBr3_7H2O_S1 | 2.503 | 0.897 | 30 | 194 | 163 | Large | 3.8 |
| | | | | | | | Hysteresis | |
| CrI2_1H2O_S2 | CrI2_12H2O_S1 | 2.327 | 1.280 | 127 | 186 | 59 | 100-200 C. | 22.1 |
| CrBr2 | CrBr2_7H2O_S1 | 2.414 | 1.107 | −37 | 190 | 227 | Large | 30.7 |
| | | | | | | | Hysteresis | |
| ZnBr2 | ZnBr2_8H2O_S2 | 2.374 | 1.186 | 55 | 149 | 94 | 100-200 C. | 19.3 |
| MnCl3_1H2O_S2 | MnCl3_9H2O_S2 | 2.226 | 1.441 | 73 | 157 | 84 | 100-200 C. | 1.1 |
| MgI2 | MgI2_4H2O_S4 | 2.486 | 0.912 | 263 | 284 | 21 | 200-300 C. | 0.0 |
| VBr3_S31 | VBr3_8H2O_S2 | 2.433 | 1.046 | −101 | 189 | 290 | Large | 27.8 |
| | | | | | | | Hysteresis | |
| MoF4_S19 | MoF4_3H2O_S1 | 2.465 | 0.963 | 201 | 235 | 34 | 200-300 C. | 3.2 |
| LaF3 | LaF3_9H2O_S2 | 2.311 | 1.289 | 78 | 78 | 0 | 50-100 C. | 0.0 |
| BeBr2 | BeBr2_2H2O_S2 | 2.454 | 0.991 | 422 | 422 | 0 | 300-450 C. | 0.4 |
| NiI2 | NiI2_12H2O_S1 | 2.346 | 1.222 | 96 | 96 | 0 | 50-100 C. | 0.0 |
| TaF4_2H2O_S1 | TaF4_8H2O_S1 | 2.433 | 1.037 | 151 | 252 | 102 | 200-300 C. | 20.3 |
| VI2 | VI2_8H2O_S3 | 2.420 | 1.066 | 137 | 137 | 0 | 100-200 C. | 11.4 |
| NbCl4 | NbCl4_9H2O_S1 | 2.365 | 1.182 | −674 | 179 | 853 | Large | 34.1 |
| | | | | | | | Hysteresis | |
| LiI1 | LiI1_3H2O_S1 | 2.433 | 1.033 | 61 | 225 | 163 | Large | 0.0 |
| | | | | | | | Hysteresis | |
| FeCl2 | FeCl2_6H2O_S2 | 2.318 | 1.270 | −71 | 137 | 208 | Large | 24.8 |
| | | | | | | | Hysteresis | |
| SnF4_2H2O_S2 | SnF4_8H2O_S1 | 2.375 | 1.160 | 124 | 227 | 104 | 100-200 C. | 0.0 |
| MnCl4_S1 | MnCl4_5H2O_S2 | 2.352 | 1.206 | 159 | 211 | 53 | 100-200 C. | 2.0 |
| HfCl4 | HfCl4_5H2O_S2 | 2.472 | 0.932 | 192 | 306 | 114 | Large | 0.5 |
| | | | | | | | Hysteresis | |
| NaF1 | NaF1_3H2O_S1 | 2.252 | 1.381 | 30 | 30 | 0 | <50 C. | 37.8 |
| BaBr2 | BaBr2_9H2O_S1 | 2.408 | 1.080 | 89 | 172 | 83 | 100-200 C. | 11.7 |
| MnF2_4H2O_S7 | MnF2_12H2O_S1 | 2.189 | 1.473 | 117 | 117 | 0 | 100-200 C. | 0.0 |
| BaCl2_1H2O_S1 | BaCl2_12H2O_S1 | 2.184 | 1.481 | 113 | 172 | 59 | 100-200 C. | 5.1 |
| CrF2_4H2O_S7 | CrF2_12H2O_S1 | 2.189 | 1.473 | 113 | 113 | 0 | 100-200 C. | 0.0 |
| ScI3_S9 | ScI3_7H2O_S2 | 2.474 | 0.911 | 25 | 251 | 226 | Large | 8.8 |
| | | | | | | | Hysteresis | |
| SnF2_2H2O_S5 | SnF2_12H2O_S1 | 2.256 | 1.364 | 73 | 84 | 11 | 50-100 C. | 0.0 |
| VBr3_S31 | VBr3_6H2O_S1 | 2.432 | 1.015 | 189 | 189 | 0 | 100-200 C. | 0.0 |
| NiF2_2H2O_S4 | NiF2_8H2O_S2 | 2.290 | 1.298 | 33 | 185 | 152 | Large | 20.4 |
| | | | | | | | Hysteresis | |
| TiF2_1H2O_S2 | TiF2_9H2O_S2 | 2.251 | 1.364 | 17 | 17 | 0 | <50 C. | 31.7 |
| CrBr4_S17 | CrBr4_8H2O_S1 | 2.442 | 0.972 | 156 | 156 | 0 | 100-200 C. | 0.0 |
| BeF2_2H2O_S5 | BeF2_8H2O_S1 | 2.157 | 1.500 | 44 | 76 | 32 | 50-100 C. | 1.1 |
| TiBr4 | TiBr4_8H2O_S1 | 2.425 | 1.008 | 169 | 169 | 0 | 100-200 C. | 0.0 |
| PbCl2_1H2O_S1 | PbCl2_12H2O_S1 | 2.294 | 1.275 | 106 | 214 | 109 | 100-200 C. | 17.9 |
| VCl3 | VCl3_4H2O_S2 | 2.345 | 1.178 | 161 | 199 | 38 | 100-200 C. | 3.0 |
| SiCl2 | SiCl2_7H2O_S1 | 2.148 | 1.507 | 59 | 59 | 0 | 50-100 C. | 12.6 |
| MnBr2 | MnBr2_8H2O_S2 | 2.316 | 1.227 | 46 | 162 | 115 | Large | 22.0 |
| | | | | | | | Hysteresis | |
| LaCl3 | LaCl3_8H2O_S2 | 2.336 | 1.188 | −17 | 170 | 186 | Large | 11.5 |
| | | | | | | | Hysteresis | |
| VBr2 | VBr2_4H2O_S3 | 2.453 | 0.921 | 173 | 173 | 0 | 100-200 C. | 0.0 |
| GeCl2_S21 | GeCl2_6H2O_S3 | 2.309 | 1.240 | −75 | 176 | 251 | Large | 23.2 |
| | | | | | | | Hysteresis | |
| CrBr3 | CrBr3_8H2O_S2 | 2.396 | 1.059 | 122 | 122 | 0 | 100-200 C. | 22.5 |
| VF3_3H2O_S8 | VF3_9H2O_S2 | 2.216 | 1.396 | 157 | 157 | 0 | 100-200 C. | 0.0 |
| MoCl3 | MoCl3_6H2O_S3 | 2.364 | 1.128 | 103 | 175 | 73 | 100-200 C. | 7.8 |
| NaBr1 | NaBr1_4H2O_S1 | 2.302 | 1.249 | 77 | 127 | 50 | 100-200 C. | 0.0 |
| CuF2_4H2O_S7 | CuF2_12H2O_S1 | 2.209 | 1.406 | 110 | 110 | 0 | 100-200 C. | 0.0 |
| ZnCl2 | ZnCl2_4H2O_S3 | 2.369 | 1.110 | 123 | 123 | 0 | 100-200 C. | 6.4 |
| NbF3 | NbF3_4H2O_S2 | 2.416 | 0.998 | 21 | 362 | 341 | Large | 31.9 |
| | | | | | | | Hysteresis | |
| LaBr2 | LaBr2_9H2O_S1 | 2.399 | 1.037 | 91 | 91 | 0 | 50-100 C. | 38.8 |
| SiF4 | SiF4_2H2O_S1 | 2.407 | 1.016 | 214 | 214 | 0 | 200-300 C. | 0.0 |
| VF4 | VF4_2H2O_S2 | 2.414 | 0.992 | 281 | 281 | 0 | 200-300 C. | 0.0 |
| MnCl2_1H2O_S2 | MnCl2_6H2O_S3 | 2.295 | 1.239 | 74 | 158 | 84 | 100-200 C. | 10.5 |
| FeCl3 | FeCl3_7H2O_S2 | 2.296 | 1.237 | −28 | 337 | 366 | Large | 29.8 |
| | | | | | | | Hysteresis | |
| FeF3_4H2O_S2 | FeF3_9H2O_S2 | 2.252 | 1.315 | 222 | 222 | 0 | 200-300 C. | 19.4 |
| KF1_1H2O_S2 | KF1_4H2O_S1 | 2.138 | 1.487 | 157 | 194 | 37 | 100-200 C. | 5.3 |
| NiCl3_S25 | NiCl3_10H2O_S2 | 2.255 | 1.302 | −477 | 109 | 586 | Large | 23.3 |
| | | | | | | | Hysteresis | |
| YF3_2H2O_S2 | YF3_9H2O_S2 | 2.222 | 1.358 | 136 | 136 | 0 | 100-200 C. | 24.5 |
| CoCl3_1H2O_S3 | CoCl3_6H2O_S3 | 2.329 | 1.164 | 163 | 163 | 0 | 100-200 C. | 42.9 |
| CaCl2 | CaCl2_4H2O_S7 | 2.177 | 1.427 | 170 | 187 | 17 | 100-200 C. | 0.0 |
| SrI2 | SrI2_8H2O_S1 | 2.399 | 1.010 | 74 | 187 | 113 | 100-200 C. | 9.7 |
| FeI2 | FeI2_12H2O_S1 | 2.319 | 1.181 | −20 | 122 | 143 | Large | 7.8 |
| | | | | | | | Hysteresis | |
| TiCl2 | TiCl2_4H2O_S3 | 2.304 | 1.207 | 52 | 329 | 277 | Large | 23.6 |
| | | | | | | | Hysteresis | |
| AlF3_4H2O_S2 | AlF3_9H2O_S2 | 2.166 | 1.438 | 212 | 212 | 0 | 200-300 C. | 26.6 |
| CoI2 | CoI2_9H2O_S2 | 2.396 | 1.007 | 91 | 91 | 0 | 50-100 C. | 8.0 |
| MnCl3_S25 | MnCl3_7H2O_S1 | 2.259 | 1.279 | −331 | 156 | 488 | Large | 24.5 |
| | | | | | | | Hysteresis | |
| TaF4_S5 | TaF4_4H2O_S1 | 2.470 | 0.795 | 175 | 175 | 0 | 100-200 C. | 10.1 |
| CoI2_1H2O_S2 | CoI2_12H2O_S1 | 2.298 | 1.205 | 124 | 124 | 0 | 100-200 C. | 42.5 |
| ZrBr3 | ZrBr3_8H2O_S1 | 2.404 | 0.975 | 124 | 124 | 0 | 100-200 C. | 11.5 |
| ZrCl4 | ZrCl4_5H2O_S2 | 2.335 | 1.131 | 183 | 260 | 76 | 200-300 C. | 0.8 |
| ZrCl3 | ZrCl3_6H2O_S3 | 2.311 | 1.171 | 136 | 136 | 0 | 100-200 C. | 7.1 |
| ScCl3 | ScCl3_4H2O_S2 | 2.265 | 1.253 | 105 | 240 | 135 | 100-200 C. | 10.4 |
| VI2_2H2O_S8 | VI2_12H2O_S1 | 2.271 | 1.241 | 170 | 170 | 0 | 100-200 C. | 12.8 |
| PbBr2 | PbBr2_12H2O_S1 | 2.316 | 1.154 | 97 | 148 | 52 | 100-200 C. | 0.0 |
| HfBr3_S28 | HfBr3_8H2O_S1 | 2.449 | 0.833 | 128 | 128 | 0 | 100-200 C. | 22.2 |
| CoCl3_S22 | CoCl3_7H2O_S1 | 2.282 | 1.216 | −223 | 123 | 346 | Large | 20.8 |
| | | | | | | | Hysteresis | |
| CrBr3 | CrBr3_7H2O_S1 | 2.374 | 1.024 | 146 | 146 | 0 | 100-200 C. | 12.0 |
| NbBr3_S12 | NbBr3_10H2O_S2 | 2.374 | 1.025 | −228 | 135 | 363 | Large | 12.2 |
| | | | | | | | Hysteresis | |
| MnCl2_1H2O_S2 | MnCl2_8H2O_S2 | 2.145 | 1.440 | 70 | 158 | 88 | 100-200 C. | 17.2 |
| FeF3 | FeF3_1H2O_S2 | 2.414 | 0.920 | 551 | 551 | 0 | 450-600 C. | 0.0 |
| CrF2 | CrF2_2H2O_S4 | 2.409 | 0.932 | 129 | 129 | 0 | 100-200 C. | 4.7 |
| VI2 | VI2_6H2O_S3 | 2.425 | 0.888 | 146 | 146 | 0 | 100-200 C. | 7.1 |
| WF4_2H2O_S1 | WF4_8H2O_S1 | 2.391 | 0.975 | 130 | 224 | 94 | 100-200 C. | 17.6 |
| SiF4_2H2O_S1 | SiF4_9H2O_S1 | 2.242 | 1.279 | −518 | 210 | 728 | Large | 26.7 |
| | | | | | | | Hysteresis | |
| SnCl2 | SnCl2_9H2O_S2 | 2.265 | 1.236 | −15 | 169 | 185 | Large | 27.7 |
| | | | | | | | Hysteresis | |
| VBr4_S17 | VBr4_8H2O_S1 | 2.390 | 0.973 | 156 | 156 | 0 | 100-200 C. | 0.0 |
| GeBr2_1H2O_S2 | GeBr2_12H2O_S1 | 2.194 | 1.358 | 81 | 174 | 93 | 100-200 C. | 27.5 |
| AlBr3_3H2O_S9 | AlBr3_9H2O_S2 | 2.294 | 1.180 | 183 | 426 | 243 | Large | 17.8 |
| | | | | | | | Hysteresis | |
| VCl2_1H2O_S2 | VCl2_7H2O_S1 | 2.234 | 1.285 | 17 | 165 | 148 | Large | 27.8 |
| | | | | | | | Hysteresis | |
| TiBr2 | TiBr2_7H2O_S1 | 2.328 | 1.104 | 50 | 316 | 266 | Large | 36.6 |
| | | | | | | | Hysteresis | |
| CrF3_4H2O_S2 | CrF3_9H2O_S2 | 2.195 | 1.348 | 228 | 228 | 0 | 200-300 C. | 23.8 |
| CrF3 | CrF3_2H2O_S2 | 2.411 | 0.906 | 177 | 177 | 0 | 100-200 C. | 24.2 |
| WF4_S20 | WF4_4H2O_S1 | 2.456 | 0.772 | 166 | 166 | 0 | 100-200 C. | 5.6 |
| TiF2_1H2O_S2 | TiF2_8H2O_S2 | 2.203 | 1.332 | 27 | 27 | 0 | <50 C. | 26.8 |
| ZrBr4_S31 | ZrBr4_10H2O_S1 | 2.402 | 0.921 | −309 | 239 | 548 | Large | 30.7 |
| | | | | | | | Hysteresis | |
| FeCl3_1H2O_S2 | FeCl3_9H2O_S2 | 2.173 | 1.378 | 95 | 154 | 59 | 100-200 C. | 0.0 |
| LaCl3 | LaCl3_9H2O_S2 | 2.194 | 1.342 | 90 | 170 | 80 | 100-200 C. | 0.0 |
| 2-Feb | FeBr2_8H2O_S2 | 2.279 | 1.189 | 44 | 142 | 98 | Large | 13.9 |
| | | | | | | | Hysteresis | |
| GaBr3 | GaBr3_8H2O_S2 | 2.364 | 1.003 | 80 | 225 | 145 | Large | 22.8 |
| | | | | | | | Hysteresis | |
| GeCl2_2H2O_S5 | GeCl2_12H2O_S1 | 2.077 | 1.508 | 86 | 149 | 62 | 100-200 C. | 0.0 |
| SnCl2 | SnCl2_8H2O_S1 | 2.299 | 1.134 | −48 | 169 | 217 | Large | 31.9 |
| | | | | | | | Hysteresis | |
| NbF3 | NbF3_3H2O_S8 | 2.382 | 0.943 | 68 | 362 | 294 | Large | 15.2 |
| | | | | | | | Hysteresis | |
| ZrBr2_S17 | ZrBr2_12H2O_S1 | 2.207 | 1.297 | 68 | 130 | 63 | 50-100 C. | 0.0 |
| GaCl3_1H2O_S2 | GaCl3_8H2O_S2 | 2.247 | 1.225 | 111 | 111 | 0 | 100-200 C. | 28.8 |
| MgBr2_1H2O_S2 | MgBr2_7H2O_S1 | 2.287 | 1.143 | 15 | 270 | 254 | Large | 34.9 |
| | | | | | | | Hysteresis | |
| PbF2 | PbF2_7H2O_S1 | 2.414 | 0.832 | −5 | 115 | 121 | Large | 27.1 |
| | | | | | | | Hysteresis | |
| MoF4_2H2O_S2 | MoF4_9H2O_S1 | 2.324 | 1.057 | −567 | 230 | 797 | Large | 29.0 |
| | | | | | | | Hysteresis | |
| SrI2_1H2O_S1 | SrI2_12H2O_S1 | 2.221 | 1.258 | 160 | 171 | 11 | 100-200 C. | 0.0 |
| YBr3_1H2O_S3 | YBr3_9H2O_S2 | 2.264 | 1.177 | 166 | 255 | 89 | 200-300 C. | 30.7 |
| YI3 | YI3_7H2O_S2 | 2.402 | 0.858 | 189 | 234 | 44 | 200-300 C. | 0.0 |
| CrI2 | CrI2_6H2O_S3 | 2.396 | 0.876 | 110 | 157 | 47 | 100-200 C. | 2.5 |
| BaCl2 | BaCl2_8H2O_S1 | 2.279 | 1.142 | 44 | 152 | 108 | Large | 23.0 |
| | | | | | | | Hysteresis | |
| TaCl4 | TaCl4_9H2O_S1 | 2.359 | 0.967 | −627 | 173 | 800 | Large | 31.9 |
| | | | | | | | Hysteresis | |
| NbBr4 | NbBr4_8H2O_S1 | 2.376 | 0.922 | 166 | 166 | 0 | 100-200 C. | 0.0 |
| GaBr3 | GaBr3_6H2O_S3 | 2.382 | 0.898 | 120 | 225 | 105 | 100-200 C. | 8.5 |
| VCl2_4H2O_S3 | VCl2_12H2O_S1 | 2.048 | 1.509 | 164 | 164 | 0 | 100-200 C. | 0.0 |
| GeF4_2H2O_S2 | GeF4_9H2O_S1 | 2.261 | 1.162 | −435 | 223 | 658 | Large | 22.8 |
| | | | | | | | Hysteresis | |
| CaI2_2H2O_S8 | CaI2_12H2O_S1 | 2.184 | 1.300 | 181 | 181 | 0 | 100-200 C. | 0.0 |
| HfBr3_S28 | HfBr3_9H2O_S2 | 2.337 | 0.992 | 165 | 165 | 0 | 100-200 C. | 0.0 |
| VBr3_S31 | VBr3_7H2O_S2 | 2.351 | 0.955 | −318 | 189 | 507 | Large | 28.7 |
| | | | | | | | Hysteresis | |
| LaF3 | LaF3_7H2O_S1 | 2.355 | 0.941 | 23 | 23 | 0 | <50 C. | 23.2 |
| NbCl3_S22 | NbCl3_6H2O_S3 | 2.277 | 1.116 | 119 | 119 | 0 | 100-200 C. | 1.2 |
| LaI3 | LaI3_9H2O_S3 | 2.375 | 0.884 | 141 | 208 | 66 | 100-200 C. | 0.0 |
| MnCl3_2H2O_S2 | MnCl3_9H2O_S2 | 2.127 | 1.376 | 73 | 230 | 156 | Large | 44.3 |
| | | | | | | | Hysteresis | |
| MnCl3_S25 | MnCl3_8H2O_S2 | 2.208 | 1.242 | −262 | 156 | 418 | Large | 36.2 |
| | | | | | | | Hysteresis | |
| SiBr4 | SiBr4_8H2O_S1 | 2.338 | 0.974 | 137 | 137 | 0 | 100-200 C. | 0.0 |
| LaF3_1H2O_S3 | LaF3_9H2O_S2 | 2.211 | 1.233 | 105 | 105 | 0 | 100-200 C. | 46.4 |
| SrI2_1H2O_S1 | SrI2_9H2O_S1 | 2.331 | 0.988 | 128 | 171 | 43 | 100-200 C. | 4.9 |
| CoBr2 | CoBr2_8H2O_S2 | 2.257 | 1.144 | 82 | 82 | 0 | 50-100 C. | 22.4 |
| TiI2_2H2O_S3 | TiI2_12H2O_S1 | 2.212 | 1.228 | 162 | 162 | 0 | 100-200 C. | 24.9 |
| LaI3 | LaI3_10H2O_S2 | 2.360 | 0.907 | −52 | 208 | 260 | Large | 4.4 |
| | | | | | | | Hysteresis | |
| NbCl3_S22 | NbCl3_8H2O_S2 | 2.239 | 1.172 | 71 | 71 | 0 | 50-100 C. | 21.7 |
| ScBr3_2H2O_S2 | ScBr3_9H2O_S2 | 2.231 | 1.185 | 193 | 285 | 92 | 200-300 C. | 25.3 |
| AlCl3_1H2O_S2 | AlCl3_4H2O_S2 | 2.222 | 1.202 | 291 | 291 | 0 | 200-300 C. | 17.8 |
| SiBr2_S25 | SiBr2_9H2O_S1 | 2.229 | 1.185 | −190 | 72 | 262 | <50 C. | 11.9 |
| TiCl3 | TiCl3_4H2O_S2 | 2.234 | 1.175 | 124 | 202 | 78 | 100-200 C. | 6.7 |
| TiCl4 | TiCl4_9H2O_S1 | 2.190 | 1.253 | −941 | 188 | 1129 | Large | 46.7 |
| | | | | | | | Hysteresis | |
| GeCl2_S21 | GeCl2_4H2O_S2 | 2.231 | 1.179 | 149 | 176 | 27 | 100-200 C. | 0.0 |
| CaI2 | CaI2_8H2O_S2 | 2.234 | 1.168 | 147 | 219 | 72 | 100-200 C. | 11.5 |
| MoBr4_S18 | MoBr4_8H2O_S1 | 2.355 | 0.896 | 156 | 156 | 0 | 100-200 C. | 0.0 |
| VF3 | VF3_2H2O_S2 | 2.347 | 0.917 | 179 | 179 | 0 | 100-200 C. | 4.2 |
| MgBr2_4H2O_S4 | MgBr2_12H2O_S1 | 2.108 | 1.379 | 200 | 200 | 0 | 100-200 C. | 0.0 |
| FeI2_1H2O_S2 | FeI2_9H2O_S2 | 2.316 | 0.988 | 110 | 153 | 43 | 100-200 C. | 23.5 |
| PbF2_2H2O_S4 | PbF2_12H2O_S1 | 2.255 | 1.119 | 81 | 81 | 0 | 50-100 C. | 0.0 |
| YBr3_1H2O_S3 | YBr3_6H2O_S2 | 2.356 | 0.883 | 255 | 255 | 0 | 200-300 C. | 30.7 |
| BaI2 | BaI2_9H2O_S1 | 2.329 | 0.950 | 111 | 226 | 114 | 100-200 C. | 5.5 |
| NiI2_1H2O_S2 | NiI2_12H2O_S1 | 2.230 | 1.161 | 109 | 109 | 0 | 100-200 C. | 37.7 |
| 3-Feb | FeBr3_9H2O_S2 | 2.264 | 1.092 | 83 | 306 | 223 | Large | 0.0 |
| | | | | | | | Hysteresis | |
| SrBr2_2H2O_S4 | SrBr2_12H2O_S1 | 2.124 | 1.343 | 153 | 153 | 0 | 100-200 C. | 0.0 |
| ScF3 | ScF3_3H2O_S8 | 2.249 | 1.119 | 125 | 125 | 0 | 100-200 C. | 0.0 |
| LaBr3 | LaBr3_8H2O_S2 | 2.324 | 0.952 | 32 | 194 | 162 | Large | 6.5 |
| | | | | | | | Hysteresis | |
| MoF3 | MoF3_2H2O_S1 | 2.384 | 0.788 | 237 | 237 | 0 | 200-300 C. | 4.5 |
| CaCl2_4H2O_S7 | CaCl2_12H2O_S1 | 1.954 | 1.576 | 169 | 169 | 0 | 100-200 C. | 0.0 |
| TiCl4 | TiCl4_5H2O_S2 | 2.211 | 1.187 | 182 | 182 | 0 | 100-200 C. | 2.2 |
| SnF2 | SnF2_6H2O_S3 | 2.293 | 1.021 | −93 | 115 | 209 | Large | 24.0 |
| | | | | | | | Hysteresis | |
| LiF1 | LiF1_2H2O_S2 | 2.186 | 1.230 | −12 | −12 | 0 | <50 C. | 25.0 |
| HfCl3_S28 | HfCl3_6H2O_S3 | 2.335 | 0.915 | 137 | 137 | 0 | 100-200 C. | 19.6 |
| PbBr2 | PbBr2_9H2O_S1 | 2.353 | 0.867 | 25 | 148 | 123 | Large | 18.1 |
| | | | | | | | Hysteresis | |
| SrI2 | SrI2_6H2O_S1 | 2.352 | 0.866 | 167 | 187 | 20 | 100-200 C. | 0.0 |
| KCl1 | KCl1_4H2O_S1 | 2.000 | 1.509 | 106 | 106 | 0 | 100-200 C. | 0.0 |
| TiCl2_4H2O_S3 | TiCl2_12H2O_S1 | 1.999 | 1.508 | 159 | 159 | 0 | 100-200 C. | 23.6 |
| TiF3_3H2O_S8 | TiF3_9H2O_S2 | 2.095 | 1.366 | 143 | 143 | 0 | 100-200 C. | 0.0 |
| GaBr3_1H2O_S2 | GaBr3_9H2O_S2 | 2.253 | 1.082 | 151 | 256 | 105 | 200-300 C. | 6.6 |
| PbCl2 | PbCl2_8H2O_S1 | 2.328 | 0.908 | −25 | 144 | 169 | Large | 29.3 |
| | | | | | | | Hysteresis | |
| SnBr2 | SnBr2_9H2O_S1 | 2.289 | 0.998 | 7 | 139 | 132 | Large | 20.7 |
| | | | | | | | Hysteresis | |
| MoCl4 | MoCl4_5H2O_S2 | 2.267 | 1.048 | 162 | 206 | 45 | 100-200 C. | 2.0 |
| BaCl2 | BaCl2_6H2O_S1 | 2.261 | 1.057 | 87 | 152 | 66 | 100-200 C. | 7.6 |
| CoCl3_S22 | CoCl3_10H2O_S2 | 2.157 | 1.253 | −865 | 123 | 988 | Large | 40.6 |
| | | | | | | | Hysteresis | |
| CaF2_4H2O_S4 | CaF2_12H2O_S1 | 2.003 | 1.486 | 101 | 101 | 0 | 100-200 C. | 3.3 |
| MgCl2 | MgCl2_2H2O_S8 | 2.186 | 1.200 | 245 | 288 | 43 | 200-300 C. | 0.0 |
| NbCl3_1H2O_S2 | NbCl3_9H2O_S2 | 2.109 | 1.328 | 138 | 138 | 0 | 100-200 C. | 28.4 |
| ZrCl2_1H2O_S2 | ZrCl2_12H2O_S1 | 2.062 | 1.400 | 57 | 57 | 0 | 50-100 C. | 0.0 |
| ZrBr3 | ZrBr3_9H2O_S2 | 2.222 | 1.128 | 150 | 150 | 0 | 100-200 C. | 0.0 |
| MnBr2 | MnBr2_4H2O_S3 | 2.329 | 0.885 | 162 | 162 | 0 | 100-200 C. | 0.0 |
| SrI2 | SrI2_7H2O_S1 | 2.314 | 0.921 | 9 | 187 | 178 | Large | 9.5 |
| | | | | | | | Hysteresis | |
| NiBr2 | NiBr2_8H2O_S2 | 2.232 | 1.104 | 70 | 70 | 0 | 50-100 C. | 21.8 |
| BaF2 | BaF2_4H2O_S1 | 2.339 | 0.853 | 28 | 149 | 120 | Large | 8.0 |
| | | | | | | | Hysteresis | |
| NiCl2 | NiCl2_4H2O_S3 | 2.238 | 1.089 | 103 | 103 | 0 | 100-200 C. | 10.9 |
| SiBr2_S25 | SiBr2_8H2O_S1 | 2.173 | 1.213 | 72 | 72 | 0 | 50-100 C. | 0.0 |
| CaBr2_1H2O_S2 | CaBr2_7H2O_S1 | 2.239 | 1.084 | 121 | 179 | 58 | 100-200 C. | 18.2 |
| BaI2 | BaI2_12H2O_S1 | 2.190 | 1.180 | 127 | 226 | 99 | 100-200 C. | 0.0 |
| GaF3_4H2O_S2 | GaF3_9H2O_S2 | 2.153 | 1.243 | 219 | 219 | 0 | 200-300 C. | 34.5 |
| LaBr3 | LaBr3_6H2O_S2 | 2.339 | 0.840 | 194 | 194 | 0 | 100-200 C. | 0.0 |
| TaBr4_S18 | TaBr4_8H2O_S1 | 2.356 | 0.788 | 162 | 162 | 0 | 100-200 C. | 0.0 |
| TiI2_S16 | TiI2_6H2O_S3 | 2.326 | 0.872 | 135 | 135 | 0 | 100-200 C. | 5.5 |
| GaCl3_1H2O_S2 | GaCl3_6H2O_S1 | 2.203 | 1.148 | 174 | 174 | 0 | 100-200 C. | 4.5 |
| FeBr2_2H2O_S3 | FeBr2_9H2O_S2 | 2.229 | 1.096 | 106 | 197 | 91 | 100-200 C. | 18.4 |
| GaF3 | GaF3_3H2O_S9 | 2.308 | 0.916 | 105 | 105 | 0 | 100-200 C. | 14.3 |
| HfBr3_S28 | HfBr3_7H2O_S2 | 2.359 | 0.773 | 138 | 138 | 0 | 100-200 C. | 25.3 |
| GeBr2 | GeBr2_9H2O_S2 | 2.222 | 1.105 | −4 | 137 | 142 | Large | 21.5 |
| | | | | | | | Hysteresis | |
| NiI2 | NiI2_9H2O_S2 | 2.289 | 0.955 | 72 | 72 | 0 | 50-100 C. | 10.7 |
| MnBr3_S12 | MnBr3_10H2O_S2 | 2.245 | 1.055 | −30 | 137 | 167 | Large | 13.7 |
| | | | | | | | Hysteresis | |
| AlCl3_4H2O_S2 | AlCl3_9H2O_S2 | 2.036 | 1.417 | 202 | 448 | 245 | 300-450 C. | 17.8 |
| TaCl3_S22 | TaCl3_10H2O_S2 | 2.267 | 1.006 | −357 | 94 | 452 | <50 C. | 18.0 |
| MnF3_3H2O_S8 | MnF3_9H2O_S2 | 2.124 | 1.280 | 128 | 128 | 0 | 100-200 C. | 0.0 |
| BeI2_2H2O_S9 | BeI2_8H2O_S1 | 2.247 | 1.047 | 99 | 443 | 345 | Large | 0.0 |
| | | | | | | | Hysteresis | |
| YI3 | YI3_6H2O_S2 | 2.356 | 0.768 | 234 | 234 | 0 | 200-300 C. | 0.0 |
| CuBr2_2H2O_S5 | CuBr2_12H2O_S1 | 2.142 | 1.244 | 74 | 213 | 139 | Large | 35.3 |
| | | | | | | | Hysteresis | |
| CaBr2_2H2O_S3 | CaBr2_9H2O_S2 | 2.168 | 1.195 | 150 | 150 | 0 | 100-200 C. | 9.9 |
| GeCl2_S21 | GeCl2_7H2O_S1 | 2.179 | 1.171 | −132 | 176 | 308 | Large | 41.3 |
| | | | | | | | Hysteresis | |
| BeI2_2H2O_S9 | BeI2_9H2O_S1 | 2.234 | 1.064 | −96 | 443 | 540 | Large | 7.6 |
| | | | | | | | Hysteresis | |
| ZnBr2 | ZnBr2_4H2O_S3 | 2.330 | 0.830 | 149 | 149 | 0 | 100-200 C. | 0.0 |
| SnBr2_1H2O_S2 | SnBr2_12H2O_S1 | 2.140 | 1.237 | 90 | 230 | 141 | Large | 22.9 |
| | | | | | | | Hysteresis | |
| CaBr2 | CaBr2_4H2O_S3 | 2.261 | 0.996 | 170 | 245 | 75 | 200-300 C. | 1.7 |
| GaF3 | GaF3_4H2O_S2 | 2.274 | 0.963 | 55 | 55 | 0 | 50-100 C. | 34.5 |
| ZrI3 | ZrI3_10H2O_S1 | 2.302 | 0.893 | 25 | 137 | 113 | Large | 1.0 |
| | | | | | | | Hysteresis | |
| NiCl2_4H2O_S3 | NiCl2_12H2O_S1 | 2.027 | 1.407 | 144 | 144 | 0 | 100-200 C. | 10.9 |
| CoF3_3H2O_S9 | CoF3_10H2O_S2 | 2.160 | 1.194 | −708 | 203 | 911 | Large | 33.6 |
| | | | | | | | Hysteresis | |
| ScI3_S9 | ScI3_6H2O_S1 | 2.312 | 0.860 | 251 | 251 | 0 | 200-300 C. | 0.0 |
| YCl3_2H2O_S2 | YCl3_9H2O_S2 | 2.056 | 1.363 | 171 | 283 | 113 | 200-300 C. | 10.0 |
| MnCl4_2H2O_S2 | MnCl4_8H2O_S1 | 2.142 | 1.221 | 185 | 236 | 50 | 200-300 C. | 6.7 |
| MgBr2_2H2O_S8 | MgBr2_8H2O_S2 | 2.138 | 1.225 | 160 | 237 | 77 | 100-200 C. | 8.8 |
| GaBr3 | GaBr3_7H2O_S1 | 2.288 | 0.911 | 71 | 225 | 154 | Large | 24.0 |
| | | | | | | | Hysteresis | |
| CrBr3_2H2O_S2 | CrBr3_9H2O_S2 | 2.202 | 1.096 | 214 | 214 | 0 | 200-300 C. | 42.0 |
| TiI3 | TiI3_9H2O_S2 | 2.250 | 0.992 | 155 | 182 | 27 | 100-200 C. | 0.0 |
| CoCl2 | CoCl2_7H2O_S1 | 2.151 | 1.190 | 25 | 25 | 0 | <50 C. | 49.6 |
| ZrBr3 | ZrBr3_7H2O_S2 | 2.288 | 0.898 | 129 | 129 | 0 | 100-200 C. | 9.1 |
| SnCl4 | SnCl4_5H2O_S2 | 2.247 | 0.993 | 177 | 214 | 37 | 100-200 C. | 1.1 |
| AlBr3 | AlBr3_3H2O_S9 | 2.305 | 0.846 | 299 | 443 | 144 | 300-450 C. | 17.8 |
| NiCl3_1H2O_S3 | NiCl3_6H2O_S3 | 2.182 | 1.125 | 148 | 148 | 0 | 100-200 C. | 41.9 |
| NbCl3_S22 | NbCl3_7H2O_S2 | 2.206 | 1.077 | 70 | 70 | 0 | 50-100 C. | 21.9 |
| CrCl3 | CrCl3_4H2O_S2 | 2.198 | 1.086 | 155 | 155 | 0 | 100-200 C. | 13.0 |
| TiBr2 | TiBr2_4H2O_S3 | 2.285 | 0.887 | 97 | 316 | 219 | Large | 15.0 |
| | | | | | | | Hysteresis | |
| 2-Feb | FeBr2_4H2O_S3 | 2.300 | 0.843 | 142 | 142 | 0 | 100-200 C. | 0.0 |
| LiCl1_1H2O_S1 | LiCl1_4H2O_S1 | 1.997 | 1.414 | 75 | 140 | 65 | 100-200 C. | 0.0 |
| SnCl2 | SnCl2_7H2O_S1 | 2.208 | 1.049 | −80 | 169 | 249 | Large | 33.0 |
| | | | | | | | Hysteresis | |
| VF3_4H2O_S2 | VF3_9H2O_S2 | 2.067 | 1.302 | 209 | 209 | 0 | 200-300 C. | 24.3 |
| MgCl2_1H2O_S2 | MgCl2_4H2O_S7 | 2.080 | 1.281 | 202 | 245 | 43 | 200-300 C. | 0.0 |
| MoF3_4H2O_S2 | MoF3_9H2O_S2 | 2.139 | 1.179 | 236 | 236 | 0 | 200-300 C. | 21.3 |
| MnF2 | MnF2_2H2O_S3 | 2.276 | 0.883 | 117 | 117 | 0 | 100-200 C. | 14.1 |
| ZnBr2 | ZnBr2_7H2O_S1 | 2.221 | 1.011 | −25 | 149 | 174 | Large | 31.3 |
| | | | | | | | Hysteresis | |
| HfI3 | HfI3_10H2O_S2 | 2.311 | 0.784 | −193 | 159 | 352 | Large | 10.7 |
| | | | | | | | Hysteresis | |
| MnCl3_1H2O_S2 | MnCl3_6H2O_S3 | 2.142 | 1.167 | 157 | 157 | 0 | 100-200 C. | 1.1 |
| TaF3_1H2O_S2 | TaF3_10H2O_S2 | 2.273 | 0.885 | 9 | 9 | 0 | <50 C. | 46.0 |
| BaBr2_1H2O_S1 | BaBr2_12H2O_S1 | 2.097 | 1.243 | 122 | 146 | 24 | 100-200 C. | 0.0 |
| MnBr3_S12 | MnBr3_9H2O_S2 | 2.191 | 1.066 | 19 | 137 | 118 | Large | 4.1 |
| | | | | | | | Hysteresis | |
| SnF2 | SnF2_4H2O_S2 | 2.240 | 0.952 | 84 | 115 | 31 | 50-100 C. | 0.0 |
| LaI2 | LaI2_12H2O_S1 | 2.157 | 1.127 | 119 | 119 | 0 | 100-200 C. | 0.0 |
| BeF2_2H2O_S5 | BeF2_7H2O_S1 | 2.002 | 1.384 | 41 | 76 | 34 | 50-100 C. | 1.3 |
| MoBr3 | MoBr3_9H2O_S2 | 2.195 | 1.048 | 124 | 124 | 0 | 100-200 C. | 0.0 |
| WBr4 | WBr4_8H2O_S1 | 2.309 | 0.763 | 150 | 150 | 0 | 100-200 C. | 0.0 |
| CaI2 | CaI2_6H2O_S2 | 2.229 | 0.972 | 150 | 219 | 69 | 100-200 C. | 9.0 |
| GeCl4 | GeCl4_9H2O_S1 | 2.131 | 1.171 | −534 | 137 | 671 | Large | 27.4 |
| | | | | | | | Hysteresis | |
| CaBr2_1H2O_S2 | CaBr2_6H2O_S1 | 2.217 | 0.995 | 139 | 179 | 40 | 100-200 C. | 11.4 |
| MnI2_2H2O_S8 | MnI2_12H2O_S1 | 2.126 | 1.175 | 149 | 149 | 0 | 100-200 C. | 9.7 |
| BaF2_2H2O_S1 | BaF2_12H2O_S1 | 2.069 | 1.273 | 68 | 68 | 0 | 50-100 C. | 0.0 |
| VCl4 | VCl4_5H2O_S2 | 2.153 | 1.124 | 162 | 162 | 0 | 100-200 C. | 5.0 |
| LaF3 | LaF3_6H2O_S2 | 2.261 | 0.885 | 34 | 34 | 0 | <50 C. | 18.2 |
| NiF2_2H2O_S4 | NiF2_6H2O_S3 | 2.191 | 1.044 | 1 | 185 | 184 | Large | 17.8 |
| | | | | | | | Hysteresis | |
| ZnCl2_4H2O_S3 | ZnCl2_12H2O_S1 | 1.989 | 1.391 | 147 | 147 | 0 | 100-200 C. | 6.4 |
| CrCl2_1H2O_S2 | CrCl2_4H2O_S3 | 2.156 | 1.112 | 222 | 222 | 0 | 200-300 C. | 24.1 |
| CrI2 | CrI2_8H2O_S3 | 2.217 | 0.983 | 55 | 157 | 102 | 100-200 C. | 16.2 |
| TiBr3_1H2O_S3 | TiBr3_6H2O_S3 | 2.245 | 0.917 | 224 | 224 | 0 | 200-300 C. | 24.5 |
| LiI1 | LiI1_2H2O_S3 | 2.268 | 0.855 | 225 | 225 | 0 | 200-300 C. | 0.0 |
| ZrF4_2H2O_S1 | ZrF4_8H2O_S1 | 2.124 | 1.168 | 108 | 314 | 207 | Large | 17.2 |
| | | | | | | | Hysteresis | |
| 3-Feb | FeBr3_6H2O_S3 | 2.269 | 0.846 | 79 | 306 | 227 | Large | 1.2 |
| | | | | | | | Hysteresis | |
| SnCl2_2H2O_S5 | SnCl2_12H2O_S1 | 2.011 | 1.348 | 95 | 129 | 34 | 100-200 C. | 0.0 |
| MnBr3_S12 | MnBr3_6H2O_S3 | 2.250 | 0.892 | 137 | 137 | 0 | 100-200 C. | 0.0 |
| PbF4 | PbF4_2H2O_S2 | 2.361 | 0.532 | 309 | 309 | 0 | 300-450 C. | 0.0 |
| MgCl2_2H2O_S8 | MgCl2_6H2O_S3 | 2.071 | 1.252 | 124 | 202 | 78 | 100-200 C. | 10.0 |
| VCl4_2H2O_S2 | VCl4_8H2O_S1 | 2.092 | 1.215 | 194 | 194 | 0 | 100-200 C. | 15.3 |
| MnI2 | MnI2_8H2O_S3 | 2.211 | 0.981 | 107 | 107 | 0 | 100-200 C. | 16.3 |
| GaCl3 | GaCl3_4H2O_S2 | 2.191 | 1.020 | 125 | 267 | 142 | 100-200 C. | 17.6 |
| TiI3 | TiI3_10H2O_S2 | 2.241 | 0.904 | −519 | 182 | 701 | Large | 25.2 |
| | | | | | | | Hysteresis | |
| TiBr3_2H2O_S2 | TiBr3_9H2O_S2 | 2.139 | 1.122 | 186 | 247 | 61 | 200-300 C. | 27.6 |
| ZnI2 | ZnI2_8H2O_S3 | 2.222 | 0.941 | 70 | 191 | 121 | 100-200 C. | 18.2 |
| HfI4 | HfI4_9H2O_S1 | 2.315 | 0.676 | −77 | 271 | 348 | Large | 5.9 |
| | | | | | | | Hysteresis | |
| MgI2_2H2O_S8 | MgI2_8H2O_S3 | 2.187 | 1.018 | 195 | 263 | 68 | 200-300 C. | 3.2 |
| CuCl2 | CuCl2_7H2O_S1 | 2.112 | 1.163 | −139 | 145 | 284 | Large | 43.1 |
| | | | | | | | Hysteresis | |
| MnCl2_4H2O_S3 | MnCl2_12H2O_S1 | 1.939 | 1.433 | 146 | 146 | 0 | 100-200 C. | 0.0 |
| SrBr2_1H2O_S1 | SrBr2_8H2O_S1 | 2.184 | 1.019 | 105 | 191 | 85 | 100-200 C. | 16.3 |
| CaBr2_1H2O_S2 | CaBr2_8H2O_S2 | 2.055 | 1.257 | 145 | 179 | 34 | 100-200 C. | 11.1 |
| CoCl2_4H2O_S3 | CoCl2_12H2O_S1 | 1.970 | 1.387 | 138 | 138 | 0 | 100-200 C. | 0.4 |
| TiCl4_2H2O_S2 | TiCl4_8H2O_S1 | 2.068 | 1.232 | 196 | 196 | 0 | 100-200 C. | 7.1 |
| BeF2_4H2O_S8 | BeF2_12H2O_S1 | 1.947 | 1.413 | 41 | 48 | 8 | <50 C. | 0.7 |
| VI3_S15 | VI3_10H2O_S2 | 2.236 | 0.887 | −370 | 168 | 539 | Large | 18.6 |
| | | | | | | | Hysteresis | |
| FeI2 | FeI2_8H2O_S1 | 2.212 | 0.941 | 63 | 122 | 59 | 50-100 C. | 10.4 |
| NbF3_3H2O_S8 | NbF3_9H2O_S2 | 2.082 | 1.202 | 155 | 155 | 0 | 100-200 C. | 15.2 |
| SiBr2_S25 | SiBr2_12H2O_S1 | 1.993 | 1.338 | −37 | 72 | 108 | <50 C. | 13.0 |
| CoI2_2H2O_S3 | CoI2_12H2O_S1 | 2.126 | 1.115 | 131 | 131 | 0 | 100-200 C. | 37.5 |
| NbF3_1H2O_S2 | NbF3_8H2O_S2 | 2.168 | 1.030 | 23 | 23 | 0 | <50 C. | 41.7 |
| NbF3_1H2O_S2 | NbF3_6H2O_S1 | 2.185 | 0.992 | 78 | 78 | 0 | 50-100 C. | 19.2 |
| ZrCl3_2H2O_S2 | ZrCl3_9H2O_S2 | 2.016 | 1.302 | 185 | 185 | 0 | 100-200 C. | 34.7 |
| CoBr3_S16 | CoBr3_9H2O_S2 | 2.172 | 1.018 | 73 | 90 | 17 | 50-100 C. | 0.0 |
| VI3_S15 | VI3_9H2O_S2 | 2.207 | 0.938 | 116 | 168 | 53 | 100-200 C. | 0.0 |
| TaCl3_S22 | TaCl3_9H2O_S2 | 2.141 | 1.074 | 94 | 94 | 0 | 50-100 C. | 0.0 |
| CrI2_2H2O_S8 | CrI2_12H2O_S1 | 2.098 | 1.154 | 127 | 190 | 63 | 100-200 C. | 11.3 |
| BaBr2 | BaBr2_8H2O_S1 | 2.194 | 0.958 | 66 | 172 | 106 | 100-200 C. | 19.0 |
| TiI3 | TiI3_8H2O_S2 | 2.241 | 0.843 | 15 | 182 | 167 | Large | 15.1 |
| | | | | | | | Hysteresis | |
| MnCl4_S1 | MnCl4_4H2O_S1 | 2.149 | 1.052 | 211 | 211 | 0 | 200-300 C. | 0.0 |
| CrCl4_2H2O_S2 | CrCl4_8H2O_S1 | 2.074 | 1.190 | 186 | 186 | 0 | 100-200 C. | 15.4 |
| CrCl4_S19 | CrCl4_5H2O_S2 | 2.125 | 1.096 | 153 | 153 | 0 | 100-200 C. | 5.4 |
| HfI4 | HfI4_10H2O_S1 | 2.291 | 0.678 | −129 | 271 | 400 | Large | 15.2 |
| | | | | | | | Hysteresis | |
| NbCl4_2H2O_S2 | NbCl4_8H2O_S1 | 2.107 | 1.123 | 213 | 213 | 0 | 200-300 C. | 28.0 |
| VBr3_2H2O_S2 | VBr3_9H2O_S2 | 2.127 | 1.082 | 156 | 244 | 88 | 200-300 C. | 33.4 |
| TiF4 | TiF4_2H2O_S2 | 2.189 | 0.939 | 241 | 241 | 0 | 200-300 C. | 0.0 |
| CrI3 | CrI3_10H2O_S2 | 2.206 | 0.897 | −194 | 136 | 330 | Large | 10.7 |
| | | | | | | | Hysteresis | |
| VI2 | VI2_7H2O_S1 | 2.197 | 0.916 | 113 | 113 | 0 | 100-200 C. | 21.6 |
| PbBr2_1H2O_S2 | PbBr2_12H2O_S1 | 2.129 | 1.061 | 97 | 198 | 102 | 100-200 C. | 12.6 |
| MgF2_6H2O_S3 | MgF2_12H2O_S1 | 1.921 | 1.400 | 172 | 172 | 0 | 100-200 C. | 24.0 |
| SnCl2 | SnCl2_6H2O_S3 | 2.140 | 1.033 | −64 | 169 | 234 | Large | 22.9 |
| | | | | | | | Hysteresis | |
| YF3 | YF3_4H2O_S1 | 2.206 | 0.884 | 57 | 57 | 0 | 50-100 C. | 21.3 |
| SrF2_2H2O_S1 | SrF2_9H2O_S1 | 2.084 | 1.141 | 48 | 48 | 0 | <50 C. | 13.2 |
| SrCl2_2H2O_S4 | SrCl2_9H2O_S1 | 2.064 | 1.176 | 96 | 96 | 0 | 50-100 C. | 15.7 |
| CoBr3_S16 | CoBr3_10H2O_S2 | 2.161 | 0.984 | −260 | 90 | 349 | <50 C. | 13.7 |
| ScF3_3H2O_S8 | ScF3_9H2O_S2 | 1.976 | 1.315 | 123 | 123 | 0 | 100-200 C. | 0.0 |
| VBr3_1H2O_S3 | VBr3_6H2O_S1 | 2.190 | 0.914 | 226 | 226 | 0 | 200-300 C. | 40.4 |
| MnI2 | MnI2_6H2O_S3 | 2.223 | 0.832 | 123 | 123 | 0 | 100-200 C. | 8.9 |
| TiCl2_1H2O_S2 | TiCl2_6H2O_S3 | 2.076 | 1.148 | 84 | 84 | 0 | 50-100 C. | 16.8 |
| SiF4_3H2O_S1 | SiF4_8H2O_S1 | 2.012 | 1.256 | 103 | 230 | 127 | 100-200 C. | 4.5 |
| ZnI2 | ZnI2_6H2O_S3 | 2.233 | 0.791 | 73 | 191 | 118 | 100-200 C. | 14.6 |
| TiCl2_1H2O_S2 | TiCl2_8H2O_S2 | 1.938 | 1.362 | 77 | 77 | 0 | 50-100 C. | 20.7 |
| HfF4_2H2O_S1 | HfF4_8H2O_S1 | 2.176 | 0.932 | 125 | 281 | 156 | 200-300 C. | 11.6 |
| NbBr3_S12 | NbBr3_9H2O_S2 | 2.122 | 1.049 | 96 | 135 | 39 | 100-200 C. | 0.0 |
| BaCl2_2H2O_S4 | BaCl2_12H2O_S1 | 1.958 | 1.328 | 113 | 113 | 0 | 100-200 C. | 0.0 |
| MnBr2 | MnBr2_7H2O_S1 | 2.159 | 0.967 | −100 | 162 | 261 | Large | 46.2 |
| | | | | | | | Hysteresis | |
| MoCl3 | MoCl3_7H2O_S1 | 2.102 | 1.083 | 35 | 175 | 141 | Large | 29.1 |
| | | | | | | | Hysteresis | |
| 2-Feb | FeBr2_6H2O_S2 | 2.165 | 0.945 | −56 | 142 | 199 | Large | 23.4 |
| | | | | | | | Hysteresis | |
| NiI2_2H2O_S8 | NiI2_12H2O_S1 | 2.094 | 1.090 | 122 | 122 | 0 | 100-200 C. | 44.0 |
| LaBr3 | LaBr3_9H2O_S2 | 2.113 | 1.052 | 92 | 194 | 101 | 100-200 C. | 0.0 |
| GeBr2 | GeBr2_8H2O_S1 | 2.139 | 0.998 | −40 | 137 | 178 | Large | 27.1 |
| | | | | | | | Hysteresis | |
| HfCl4 | HfCl4_4H2O_S1 | 2.219 | 0.802 | 212 | 306 | 94 | 200-300 C. | 0.0 |
| CuCl2_1H2O_S2 | CuCl2_4H2O_S3 | 2.126 | 1.021 | 208 | 208 | 0 | 200-300 C. | 47.7 |
| ScCl3_3H2O_S9 | ScCl3_9H2O_S2 | 1.924 | 1.364 | 215 | 215 | 0 | 200-300 C. | 0.0 |
| GeF2 | GeF2_2H2O_S5 | 2.194 | 0.849 | 153 | 153 | 0 | 100-200 C. | 0.0 |
| CrI3 | CrI3_9H2O_S2 | 2.171 | 0.904 | 136 | 136 | 0 | 100-200 C. | 0.0 |
| MoCl4_2H2O_S2 | MoCl4_8H2O_S1 | 2.080 | 1.090 | 188 | 230 | 42 | 200-300 C. | 6.5 |
| HfF4 | HfF4_4H2O_S1 | 2.229 | 0.739 | −29 | 196 | 225 | Large | 13.7 |
| | | | | | | | Hysteresis | |
| MoCl3 | MoCl3_8H2O_S1 | 2.087 | 1.076 | 3 | 175 | 172 | Large | 41.4 |
| | | | | | | | Hysteresis | |
| NiBr2 | NiBr2_4H2O_S3 | 2.213 | 0.782 | 116 | 116 | 0 | 100-200 C. | 0.8 |
| NiBr3_S25 | NiBr3_10H2O_S2 | 2.117 | 1.010 | 20 | 83 | 63 | 50-100 C. | 4.8 |
| LaI2 | LaI2_9H2O_S1 | 2.181 | 0.861 | 91 | 91 | 0 | 50-100 C. | 22.6 |
| BeI2_2H2O_S9 | BeI2_7H2O_S1 | 2.146 | 0.943 | 86 | 443 | 357 | Large | 2.3 |
| | | | | | | | Hysteresis | |
| PbCl2 | PbCl2_7H2O_S1 | 2.195 | 0.818 | −62 | 144 | 206 | Large | 31.8 |
| | | | | | | | Hysteresis | |
| NiBr3_S25 | NiBr3_9H2O_S1 | 2.145 | 0.935 | −3 | 83 | 86 | <50 C. | 7.3 |
| PbF4_1H2O_S1 | PbF4_3H2O_S2 | 2.272 | 0.555 | 248 | 487 | 239 | Large | 33.7 |
| | | | | | | | Hysteresis | |
| BaBr2 | BaBr2_6H2O_S1 | 2.175 | 0.858 | 106 | 172 | 65 | 100-200 C. | 4.5 |
| ZrI2 | ZrI2_12H2O_S1 | 2.066 | 1.090 | 76 | 76 | 0 | 50-100 C. | 23.7 |
| AlI3_2H2O_S2 | AlI3_6H2O_S1 | 2.193 | 0.801 | 434 | 434 | 0 | 300-450 C. | 33.3 |
| AlF3_3H2O_S9 | AlF3_10H2O_S2 | 1.983 | 1.232 | −616 | 156 | 771 | Large | 29.5 |
| | | | | | | | Hysteresis | |
| MgF2 | MgF2_2H2O_S3 | 2.117 | 0.981 | 57 | 57 | 0 | 50-100 C. | 21.3 |
| NiBr2 | NiBr2_7H2O_S1 | 2.127 | 0.958 | 50 | 50 | 0 | <50 C. | 30.2 |
| LaCl3_1H2O_S3 | LaCl3_9H2O_S2 | 1.987 | 1.216 | 90 | 188 | 98 | 100-200 C. | 19.4 |
| LaI3 | LaI3_8H2O_S2 | 2.189 | 0.794 | 88 | 208 | 119 | Large | 5.7 |
| | | | | | | | Hysteresis | |
| ZnI2_2H2O_S1 | ZnI2_12H2O_S1 | 2.062 | 1.083 | 124 | 124 | 0 | 100-200 C. | 0.0 |
| GaCl3_1H2O_S2 | GaCl3_7H2O_S1 | 2.056 | 1.093 | 104 | 104 | 0 | 100-200 C. | 30.2 |
| PbCl2_2H2O_S5 | PbCl2_12H2O_S1 | 2.035 | 1.131 | 106 | 127 | 21 | 100-200 C. | 0.0 |
| LaCl3_1H2O_S3 | LaCl3_6H2O_S2 | 2.124 | 0.952 | 188 | 188 | 0 | 100-200 C. | 19.4 |
| NbBr3_S12 | NbBr3_8H2O_S2 | 2.153 | 0.884 | −52 | 135 | 187 | Large | 16.0 |
| | | | | | | | Hysteresis | |
| GaCl3_3H2O_S9 | GaCl3_9H2O_S2 | 1.973 | 1.235 | 204 | 204 | 0 | 200-300 C. | 11.6 |
| BeI2 | BeI2_2H2O_S9 | 2.213 | 0.717 | 461 | 461 | 0 | 450-600 C. | 0.0 |
| WCl4_2H2O_S2 | WCl4_8H2O_S1 | 2.142 | 0.907 | 213 | 213 | 0 | 200-300 C. | 43.0 |
| FeF3_1H2O_S2 | FeF3_4H2O_S2 | 2.138 | 0.915 | 113 | 113 | 0 | 100-200 C. | 19.4 |
| SiI4 | SiI4_9H2O_S1 | 2.175 | 0.822 | 164 | 164 | 0 | 100-200 C. | 0.0 |
| MoF2_S16 | MoF2_9H2O_S2 | 2.082 | 1.031 | −55 | 73 | 128 | <50 C. | 41.1 |
| GeI2 | GeI2_12H2O_S1 | 2.039 | 1.110 | 63 | 87 | 24 | 50-100 C. | 0.0 |
| TaCl4_2H2O_S2 | TaCl4_8H2O_S1 | 2.132 | 0.919 | 217 | 217 | 0 | 200-300 C. | 36.6 |
| CuI2_S15 | CuI2_12H2O_S1 | 2.062 | 1.065 | 45 | 64 | 18 | 50-100 C. | 0.5 |
| HfI3 | HfI3_8H2O_S1 | 2.215 | 0.689 | 142 | 142 | 0 | 100-200 C. | 11.9 |
| FeI2 | FeI2_6H2O_S3 | 2.180 | 0.792 | 70 | 122 | 52 | 50-100 C. | 5.7 |
| FeF2_4H2O_S7 | FeF2_12H2O_S1 | 1.962 | 1.236 | 55 | 55 | 0 | 50-100 C. | 0.0 |
| TiI2_S16 | TiI2_8H2O_S2 | 2.086 | 1.011 | 113 | 113 | 0 | 100-200 C. | 15.7 |
| MnF3_4H2O_S2 | MnF3_9H2O_S2 | 1.985 | 1.196 | 176 | 176 | 0 | 100-200 C. | 23.0 |
| CrF4_3H2O_S1 | CrF4_8H2O_S1 | 1.997 | 1.175 | 121 | 232 | 111 | 100-200 C. | 6.0 |
| SrI2_2H2O_S7 | SrI2_12H2O_S1 | 2.015 | 1.142 | 160 | 167 | 7 | 100-200 C. | 0.0 |
| NbBr3_S12 | NbBr3_6H2O_S3 | 2.170 | 0.811 | 135 | 135 | 0 | 100-200 C. | 0.0 |
| CuBr2 | CuBr2_6H2O_S3 | 2.155 | 0.849 | −71 | 108 | 179 | Large | 20.8 |
| | | | | | | | Hysteresis | |
| ScF3_4H2O_S2 | ScF3_9H2O_S2 | 1.927 | 1.282 | 191 | 191 | 0 | 100-200 C. | 31.8 |
| NaCl1 | NaCl1_3H2O_S1 | 1.931 | 1.271 | −52 | 106 | 158 | Large | 21.1 |
| | | | | | | | Hysteresis | |
| HfBr3_S28 | HfBr3_6H2O_S3 | 2.204 | 0.697 | 146 | 146 | 0 | 100-200 C. | 31.9 |
| ZrBr2_1H2O_S2 | ZrBr2_12H2O_S1 | 1.993 | 1.171 | 68 | 68 | 0 | 50-100 C. | 0.0 |
| ZrCl4_2H2O_S2 | ZrCl4_8H2O_S1 | 2.032 | 1.102 | 194 | 228 | 34 | 200-300 C. | 0.0 |
| LaI3_1H2O_S3 | LaI3_9H2O_S3 | 2.166 | 0.806 | 141 | 231 | 90 | 100-200 C. | 25.4 |
| MnF4_3H2O_S1 | MnF4_8H2O_S1 | 2.004 | 1.151 | 115 | 244 | 129 | 100-200 C. | 2.9 |
| SrBr2_2H2O_S4 | SrBr2_9H2O_S1 | 2.087 | 0.990 | 124 | 124 | 0 | 100-200 C. | 10.6 |
| SnBr2 | SnBr2_8H2O_S1 | 2.124 | 0.905 | −21 | 139 | 160 | Large | 24.7 |
| | | | | | | | Hysteresis | |
| SrF2 | SrF2_4H2O_S4 | 2.067 | 1.026 | 54 | 94 | 39 | 50-100 C. | 6.3 |
| CrCl3_3H2O_S9 | CrCl3_9H2O_S2 | 1.923 | 1.275 | 193 | 193 | 0 | 100-200 C. | 2.6 |
| NiF3_3H2O_S9 | NiF3_10H2O_S2 | 2.029 | 1.094 | −737 | 174 | 910 | Large | 34.9 |
| | | | | | | | Hysteresis | |
| NbCl4 | NbCl4_5H2O_S2 | 2.084 | 0.982 | 164 | 164 | 0 | 100-200 C. | 5.6 |
| VCl3_2H2O_S2 | VCl3_6H2O_S1 | 2.007 | 1.128 | 192 | 383 | 191 | Large | 27.8 |
| | | | | | | | Hysteresis | |
| SiI2_S25 | SiI2_9H2O_S1 | 2.089 | 0.965 | −71 | 69 | 140 | <50 C. | 6.0 |
| CaI2_2H2O_S8 | CaI2_9H2O_S2 | 2.077 | 0.989 | 168 | 168 | 0 | 100-200 C. | 4.5 |
| HfI4 | HfI4_8H2O_S1 | 2.203 | 0.657 | 168 | 271 | 103 | 200-300 C. | 0.0 |
| ZrCl4 | ZrCl4_4H2O_S1 | 2.080 | 0.979 | 207 | 260 | 53 | 200-300 C. | 0.0 |
| CaF2 | CaF2_2H2O_S4 | 2.122 | 0.882 | 72 | 72 | 0 | 50-100 C. | 8.6 |
| NiF2_7H2O_S1 | NiF2_12H2O_S1 | 1.938 | 1.234 | 256 | 256 | 0 | 200-300 C. | 41.6 |
| PbF2 | PbF2_4H2O_S4 | 2.194 | 0.677 | 75 | 115 | 41 | 50-100 C. | 1.2 |
| BaBr2_1H2O_S1 | BaBr2_9H2O_S1 | 2.093 | 0.939 | 89 | 146 | 58 | 100-200 C. | 11.7 |
| VF4_3H2O_S1 | VF4_8H2O_S1 | 1.962 | 1.187 | 129 | 226 | 97 | 100-200 C. | 8.2 |
| SnI2 | SnI2_12H2O_S1 | 2.033 | 1.059 | 73 | 102 | 28 | 50-100 C. | 0.0 |
| CrCl2_4H2O_S3 | CrCl2_12H2O_S1 | 1.845 | 1.360 | 122 | 122 | 0 | 100-200 C. | 0.0 |
| CoBr3_1H2O_S3 | CoBr3_9H2O_S2 | 2.075 | 0.973 | 73 | 133 | 61 | 100-200 C. | 47.3 |
| MoF2_S16 | MoF2_8H2O_S2 | 2.050 | 1.023 | −44 | 73 | 117 | <50 C. | 35.7 |
| ZrBr3 | ZrBr3_6H2O_S3 | 2.138 | 0.823 | 140 | 140 | 0 | 100-200 C. | 4.4 |
| TiBr2_1H2O_S2 | TiBr2_6H2O_S3 | 2.101 | 0.909 | 120 | 120 | 0 | 100-200 C. | 9.5 |
| SnCl4_2H2O_S2 | SnCl4_8H2O_S1 | 2.045 | 1.028 | 191 | 244 | 53 | 200-300 C. | 4.1 |
| BaBr2 | BaBr2_7H2O_S1 | 2.116 | 0.874 | 61 | 172 | 111 | 100-200 C. | 19.3 |
| 3-Feb | FeBr3_8H2O_S2 | 2.102 | 0.904 | 33 | 306 | 272 | Large | 18.6 |
| | | | | | | | Hysteresis | |
| VBr2_4H2O_S3 | VBr2_12H2O_S1 | 1.946 | 1.203 | 167 | 167 | 0 | 100-200 C. | 0.0 |
| WF4_S20 | WF4_3H2O_S2 | 2.210 | 0.592 | 151 | 151 | 0 | 100-200 C. | 9.8 |
| LaF3 | LaF3_8H2O_S2 | 2.063 | 0.986 | 14 | 14 | 0 | <50 C. | 27.7 |
| TiF2_6H2O_S3 | TiF2_12H2O_S1 | 1.883 | 1.293 | 173 | 173 | 0 | 100-200 C. | 33.6 |
| NiF2_6H2O_S3 | NiF2_12H2O_S1 | 1.926 | 1.227 | 165 | 165 | 0 | 100-200 C. | 17.8 |
| SiCl4_3H2O_S2 | SiCl4_9H2O_S1 | 1.936 | 1.209 | 68 | 209 | 141 | Large | 34.2 |
| | | | | | | | Hysteresis | |
| NbBr4 | NbBr4_9H2O_S1 | 2.133 | 0.813 | −590 | 166 | 757 | Large | 30.1 |
| | | | | | | | Hysteresis | |
| BaF2_2H2O_S1 | BaF2_9H2O_S1 | 2.058 | 0.985 | 52 | 52 | 0 | 50-100 C. | 5.7 |
| GeF4_3H2O_S1 | GeF4_8H2O_S1 | 2.006 | 1.087 | 110 | 243 | 133 | 100-200 C. | 4.3 |
| GeBr2_2H2O_S5 | GeBr2_12H2O_S1 | 1.940 | 1.200 | 81 | 155 | 74 | 100-200 C. | 5.9 |
| VF2_6H2O_S3 | VF2_12H2O_S1 | 1.893 | 1.271 | 170 | 170 | 0 | 100-200 C. | 21.0 |
| TiI3 | TiI3_7H2O_S2 | 2.144 | 0.776 | −56 | 182 | 238 | Large | 12.7 |
| | | | | | | | Hysteresis | |
| CoBr2 | CoBr2_4H2O_S2 | 2.146 | 0.765 | 108 | 108 | 0 | 100-200 C. | 9.9 |
| MnCl3_2H2O_S2 | MnCl3_6H2O_S3 | 2.001 | 1.090 | 230 | 230 | 0 | 200-300 C. | 44.3 |
| AlI3 | AlI3_4H2O_S2 | 2.172 | 0.688 | 292 | 292 | 0 | 200-300 C. | 33.1 |
| NaI1 | NaI1_4H2O_S1 | 2.065 | 0.960 | 38 | 146 | 108 | Large | 1.9 |
| | | | | | | | Hysteresis | |
| SrBr2_1H2O_S1 | SrBr2_6H2O_S1 | 2.104 | 0.870 | 141 | 191 | 50 | 100-200 C. | 3.7 |
| TaBr4_S18 | TaBr4_9H2O_S1 | 2.160 | 0.712 | −521 | 162 | 683 | Large | 26.8 |
| | | | | | | | Hysteresis | |
| NaCl1 | NaCl1_2H2O_S2 | 1.949 | 1.172 | 106 | 106 | 0 | 100-200 C. | 0.0 |
| CoF2_6H2O_S3 | CoF2_12H2O_S1 | 1.909 | 1.234 | 168 | 168 | 0 | 100-200 C. | 20.9 |
| AlCl3_3H2O_S9 | AlCl3_6H2O_S1 | 1.948 | 1.170 | 372 | 372 | 0 | 300-450 C. | 6.4 |
| CaBr2_4H2O_S3 | CaBr2_12H2O_S1 | 1.881 | 1.273 | 180 | 180 | 0 | 100-200 C. | 1.7 |
| BeCl2_2H2O_S8 | BeCl2_4H2O_S8 | 1.895 | 1.246 | 375 | 375 | 0 | 300-450 C. | 0.0 |
| ZrF4 | ZrF4_4H2O_S1 | 2.061 | 0.944 | −112 | 189 | 301 | Large | 19.5 |
| | | | | | | | Hysteresis | |
| TiBr2_4H2O_S3 | TiBr2_12H2O_S1 | 1.918 | 1.207 | 165 | 165 | 0 | 100-200 C. | 15.0 |
| AlI3_3H2O_S3 | AlI3_9H2O_S2 | 2.084 | 0.888 | 142 | 467 | 325 | Large | 30.6 |
| | | | | | | | Hysteresis | |
| CoBr3_S16 | CoBr3_6H2O_S3 | 2.126 | 0.781 | 90 | 90 | 0 | 50-100 C. | 0.0 |
| SnCl2 | SnCl2_4H2O_S2 | 2.059 | 0.943 | 129 | 169 | 40 | 100-200 C. | 0.0 |
| TiCl3_3H2O_S9 | TiCl3_9H2O_S2 | 1.857 | 1.295 | 195 | 195 | 0 | 100-200 C. | 0.0 |
| HfBr4_S31 | HfBr4_5H2O_S2 | 2.174 | 0.629 | 164 | 296 | 131 | 200-300 C. | 2.1 |
| VF2_7H2O_S1 | VF2_12H2O_S1 | 1.878 | 1.261 | 254 | 254 | 0 | 200-300 C. | 41.9 |
| TiF4_3H2O_S1 | TiF4_8H2O_S1 | 1.921 | 1.189 | 121 | 227 | 106 | 100-200 C. | 3.9 |
| MgI2_4H2O_S4 | MgI2_12H2O_S1 | 1.956 | 1.127 | 195 | 209 | 14 | 200-300 C. | 0.0 |
| HfCl4_2H2O_S2 | HfCl4_8H2O_S1 | 2.067 | 0.906 | 199 | 238 | 40 | 200-300 C. | 0.0 |
| MoCl2_S16 | MoCl2_12H2O_S1 | 1.889 | 1.233 | −3 | −3 | 0 | <50 C. | 23.4 |
| RbF1_1H2O_S2 | RbF1_4H2O_S1 | 1.982 | 1.075 | 155 | 171 | 16 | 100-200 C. | 0.0 |
| MoBr3 | MoBr3_6H2O_S3 | 2.118 | 0.771 | 118 | 118 | 0 | 100-200 C. | 2.6 |
| FeCl3 | FeCl3_4H2O_S1 | 2.013 | 1.014 | −111 | 337 | 448 | Large | 19.4 |
| | | | | | | | Hysteresis | |
| ScF3 | ScF3_4H2O_S2 | 1.992 | 1.053 | −213 | 125 | 338 | Large | 31.8 |
| | | | | | | | Hysteresis | |
| YCl3_3H2O_S9 | YCl3_10H2O_S2 | 1.966 | 1.098 | −231 | 210 | 442 | Large | 12.4 |
| | | | | | | | Hysteresis | |
| PbCl2 | PbCl2_6H2O_S3 | 2.105 | 0.800 | −32 | 144 | 176 | Large | 19.9 |
| | | | | | | | Hysteresis | |
| PbF2_2H2O_S4 | PbF2_9H2O_S1 | 2.100 | 0.807 | 49 | 49 | 0 | <50 C. | 11.3 |
| BaI2 | BaI2_8H2O_S1 | 2.088 | 0.840 | 89 | 226 | 137 | Large | 12.8 |
| | | | | | | | Hysteresis | |
| HfI3 | HfI3_9H2O_S2 | 2.107 | 0.788 | 159 | 159 | 0 | 100-200 C. | 0.0 |
| VCl3_3H2O_S9 | VCl3_9H2O_S2 | 1.866 | 1.257 | 179 | 192 | 13 | 100-200 C. | 0.0 |
| MgBr2_1H2O_S2 | MgBr2_4H2O_S4 | 2.065 | 0.890 | 237 | 270 | 33 | 200-300 C. | 0.0 |
| ZrCl4_2H2O_S2 | ZrCl4_9H2O_S1 | 2.012 | 1.005 | −399 | 228 | 627 | Large | 21.1 |
| | | | | | | | Hysteresis | |
| ZrI4 | ZrI4_9H2O_S1 | 2.137 | 0.699 | −182 | 198 | 380 | Large | 10.8 |
| | | | | | | | Hysteresis | |
| SrF2_4H2O_S4 | SrF2_12H2O_S1 | 1.866 | 1.252 | 93 | 93 | 0 | 50-100 C. | 6.3 |
| SrI2_1H2O_S1 | SrI2_8H2O_S1 | 2.071 | 0.872 | 74 | 171 | 97 | 100-200 C. | 9.7 |
| NbBr3_S12 | NbBr3_7H2O_S2 | 2.097 | 0.806 | −188 | 135 | 323 | Large | 17.2 |
| | | | | | | | Hysteresis | |
| SrCl2_4H2O_S3 | SrCl2_12H2O_S1 | 1.808 | 1.329 | 153 | 153 | 0 | 100-200 C. | 10.6 |
| SiCl4 | SiCl4_5H2O_S2 | 1.973 | 1.066 | 107 | 107 | 0 | 100-200 C. | 14.6 |
| GeBr2 | GeBr2_6H2O_S3 | 2.061 | 0.883 | −64 | 137 | 201 | Large | 20.8 |
| | | | | | | | Hysteresis | |
| HfCl4_2H2O_S2 | HfCl4_9H2O_S1 | 2.065 | 0.874 | −268 | 238 | 507 | Large | 14.9 |
| | | | | | | | Hysteresis | |
| GeF2_2H2O_S5 | GeF2_9H2O_S1 | 1.967 | 1.075 | −17 | 92 | 109 | <50 C. | 20.6 |
| CsF1 | CsF1_3H2O_S1 | 2.104 | 0.774 | −127 | 249 | 376 | Large | 24.0 |
| | | | | | | | Hysteresis | |
| MgCl2_7H2O_S1 | MgCl2_12H2O_S1 | 1.753 | 1.396 | 323 | 323 | 0 | 300-450 C. | 40.7 |
| SiF4_2H2O_S1 | SiF4_5H2O_S2 | 1.956 | 1.089 | 210 | 210 | 0 | 200-300 C. | 0.0 |
| VI3_S15 | VI3_8H2O_S2 | 2.099 | 0.775 | −69 | 168 | 237 | Large | 19.9 |
| | | | | | | | Hysteresis | |
| MgCl2_4H2O_S7 | MgCl2_9H2O_S2 | 1.854 | 1.251 | 168 | 168 | 0 | 100-200 C. | 6.5 |
| MoF4_3H2O_S1 | MoF4_8H2O_S1 | 1.981 | 1.034 | 128 | 245 | 117 | 100-200 C. | 3.2 |
| ZrI3 | ZrI3_8H2O_S1 | 2.102 | 0.759 | 127 | 127 | 0 | 100-200 C. | 5.4 |
| BaI2_1H2O_S1 | BaI2_12H2O_S1 | 1.967 | 1.060 | 127 | 135 | 8 | 100-200 C. | 0.0 |
| ScCl3 | ScCl3_3H2O_S9 | 1.948 | 1.095 | 240 | 240 | 0 | 200-300 C. | 0.0 |
| SrBr2_1H2O_S1 | SrBr2_7H2O_S1 | 2.041 | 0.905 | 97 | 191 | 93 | 100-200 C. | 17.7 |
| NbF3_1H2O_S2 | NbF3_7H2O_S2 | 2.026 | 0.934 | 21 | 21 | 0 | <50 C. | 40.8 |
| CrI2 | CrI2_7H2O_S1 | 2.062 | 0.852 | −6 | 157 | 163 | Large | 25.1 |
| | | | | | | | Hysteresis | |
| NaCl1_1H2O_S1 | NaCl1_4H2O_S1 | 1.838 | 1.261 | 101 | 106 | 5 | 100-200 C. | 0.0 |
| FeCl3_1H2O_S2 | FeCl3_6H2O_S3 | 1.985 | 1.012 | 67 | 154 | 88 | 100-200 C. | 5.8 |
| MoCl4 | MoCl4_4H2O_S1 | 2.036 | 0.904 | 206 | 206 | 0 | 200-300 C. | 0.0 |
| ZnF2_6H2O_S3 | ZnF2_12H2O_S1 | 1.879 | 1.196 | 163 | 163 | 0 | 100-200 C. | 19.2 |
| MnF2_6H2O_S3 | MnF2_12H2O_S1 | 1.848 | 1.243 | 166 | 166 | 0 | 100-200 C. | 21.1 |
| TaCl3_S22 | TaCl3_6H2O_S3 | 2.081 | 0.791 | 84 | 84 | 0 | 50-100 C. | 4.3 |
| CoI2 | CoI2_6H2O_S3 | 2.099 | 0.739 | 82 | 82 | 0 | 50-100 C. | 11.6 |
| YI3_2H2O_S2 | YI3_9H2O_S3 | 2.078 | 0.796 | 100 | 266 | 166 | Large | 19.5 |
| | | | | | | | Hysteresis | |
| ZrI4 | ZrI4_10H2O_S1 | 2.112 | 0.699 | −184 | 198 | 382 | Large | 19.9 |
| | | | | | | | Hysteresis | |
| CuBr2 | CuBr2_4H2O_S3 | 2.093 | 0.753 | 108 | 108 | 0 | 100-200 C. | 0.0 |
| MoF4_S19 | MoF4_2H2O_S2 | 2.105 | 0.714 | 235 | 235 | 0 | 200-300 C. | 0.0 |
| PbI2 | PbI2_12H2O_S1 | 2.017 | 0.933 | 86 | 90 | 4 | 50-100 C. | 0.0 |
| BeCl2_4H2O_S8 | BeCl2_12H2O_S1 | 1.753 | 1.363 | 73 | 73 | 0 | 50-100 C. | 0.0 |
| TiBr2_1H2O_S2 | TiBr2_8H2O_S2 | 1.941 | 1.074 | 97 | 97 | 0 | 50-100 C. | 19.5 |
| YF3_3H2O_S8 | YF3_9H2O_S2 | 1.892 | 1.156 | 134 | 134 | 0 | 100-200 C. | 14.3 |
| GaI3 | GaI3_9H2O_S2 | 2.052 | 0.838 | 113 | 153 | 40 | 100-200 C. | 0.0 |
| NbF3_4H2O_S2 | NbF3_9H2O_S2 | 1.920 | 1.109 | 201 | 201 | 0 | 200-300 C. | 31.9 |
| FeCl3_2H2O_S1 | FeCl3_9H2O_S2 | 1.872 | 1.187 | 95 | 157 | 63 | 100-200 C. | 0.5 |
| TiCl4 | TiCl4_4H2O_S1 | 1.965 | 1.024 | 186 | 186 | 0 | 100-200 C. | 0.7 |
| SrCl2 | SrCl2_4H2O_S3 | 1.966 | 1.020 | 88 | 172 | 83 | 100-200 C. | 10.6 |
| YBr3_2H2O_S2 | YBr3_9H2O_S2 | 1.963 | 1.021 | 166 | 255 | 89 | 200-300 C. | 17.5 |
| ZrBr2_S17 | ZrBr2_9H2O_S2 | 2.006 | 0.933 | 7 | 130 | 124 | Large | 24.6 |
| | | | | | | | Hysteresis | |
| MgCl2_6H2O_S3 | MgCl2_12H2O_S1 | 1.730 | 1.378 | 217 | 217 | 0 | 200-300 C. | 10.0 |
| RbF1 | RbF1_1H2O_S2 | 2.085 | 0.736 | 344 | 344 | 0 | 300-450 C. | 0.0 |
| TaCl3_S22 | TaCl3_8H2O_S2 | 2.041 | 0.850 | 41 | 41 | 0 | <50 C. | 23.1 |
| YCl3 | YCl3_4H2O_S2 | 1.972 | 0.993 | 75 | 217 | 142 | Large | 12.8 |
| | | | | | | | Hysteresis | |
| GeI2_1H2O_S2 | GeI2_12H2O_S1 | 1.938 | 1.056 | 63 | 139 | 76 | 100-200 C. | 39.3 |
| ScBr3_S25 | ScBr3_4H2O_S2 | 2.060 | 0.790 | 210 | 210 | 0 | 200-300 C. | 12.5 |
| TiF2_1H2O_S2 | TiF2_6H2O_S3 | 1.948 | 1.035 | 2 | 2 | 0 | <50 C. | 33.6 |
| YCl3_2H2O_S2 | YCl3_6H2O_S2 | 1.983 | 0.966 | 210 | 283 | 73 | 200-300 C. | 10.0 |
| ZrCl2 | ZrCl2_9H2O_S2 | 1.928 | 1.071 | −24 | 114 | 138 | Large | 32.7 |
| | | | | | | | Hysteresis | |
| MnBr3_1H2O_S3 | MnBr3_6H2O_S3 | 2.050 | 0.813 | 175 | 175 | 0 | 100-200 C. | 41.3 |
| HfI3 | HfI3_7H2O_S2 | 2.112 | 0.633 | 151 | 151 | 0 | 100-200 C. | 13.3 |
| LaI3 | LaI3_6H2O_S2 | 2.099 | 0.671 | 208 | 208 | 0 | 200-300 C. | 0.0 |
| BaBr2_2H2O_S4 | BaBr2_12H2O_S1 | 1.895 | 1.124 | 122 | 122 | 0 | 100-200 C. | 0.0 |
| TiI2_S16 | TiI2_7H2O_S1 | 2.036 | 0.841 | 79 | 79 | 0 | 50-100 C. | 30.3 |
| NbI3 | NbI3_10H2O_S2 | 2.053 | 0.796 | −146 | 139 | 285 | Large | 8.6 |
| | | | | | | | Hysteresis | |
| FeI2_2H2O_S8 | FeI2_9H2O_S2 | 2.026 | 0.864 | 110 | 166 | 56 | 100-200 C. | 14.8 |
| SrI2_2H2O_S7 | SrI2_9H2O_S1 | 2.027 | 0.859 | 128 | 167 | 40 | 100-200 C. | 4.9 |
| PbBr2 | PbBr2_8H2O_S1 | 2.074 | 0.736 | −42 | 148 | 190 | Large | 31.0 |
| | | | | | | | Hysteresis | |
| CrI3_1H2O_S3 | CrI3_9H2O_S2 | 2.027 | 0.844 | 157 | 157 | 0 | 100-200 C. | 35.7 |
| ZrI4 | ZrI4_8H2O_S1 | 2.081 | 0.698 | 162 | 198 | 37 | 100-200 C. | 0.0 |
| CoBr2_4H2O_S2 | CoBr2_12H2O_S1 | 1.884 | 1.122 | 145 | 145 | 0 | 100-200 C. | 9.9 |
| NiBr3_S25 | NiBr3_6H2O_S3 | 2.051 | 0.768 | 83 | 83 | 0 | 50-100 C. | 0.0 |
| RbCl1 | RbCl1_4H2O_S1 | 1.866 | 1.147 | 106 | 106 | 0 | 100-200 C. | 0.0 |
| TiI4 | TiI4_8H2O_S1 | 2.072 | 0.708 | 151 | 151 | 0 | 100-200 C. | 0.0 |
| VCl2_1H2O_S2 | VCl2_4H2O_S3 | 1.953 | 0.989 | 165 | 165 | 0 | 100-200 C. | 0.0 |
| LiCl1 | LiCl1_1H2O_S1 | 1.904 | 1.078 | 173 | 173 | 0 | 100-200 C. | 0.0 |
| AlBr3_4H2O_S2 | AlBr3_9H2O_S2 | 1.945 | 1.001 | 183 | 513 | 330 | Large | 26.0 |
| | | | | | | | Hysteresis | |
| ScCl3_3H2O_S9 | ScCl3_10H2O_S2 | 1.874 | 1.129 | −638 | 215 | 854 | Large | 30.5 |
| | | | | | | | Hysteresis | |
| GeF2_4H2O_S2 | GeF2_12H2O_S1 | 1.824 | 1.206 | 64 | 64 | 0 | 50-100 C. | 0.0 |
| LaI3 | LaI3_7H2O_S2 | 2.064 | 0.719 | 22 | 208 | 185 | Large | 7.2 |
| | | | | | | | Hysteresis | |
| PbCl4 | PbCl4_5H2O_S2 | 2.052 | 0.749 | 167 | 184 | 18 | 100-200 C. | 2.1 |
| SnF4_3H2O_S1 | SnF4_8H2O_S1 | 1.962 | 0.958 | 124 | 243 | 120 | 100-200 C. | 3.5 |
| TaBr3_S22 | TaBr3_9H2O_S2 | 2.014 | 0.840 | 88 | 106 | 18 | 50-100 C. | 0.0 |
| CrBr4_S17 | CrBr4_9H2O_S1 | 2.004 | 0.863 | −550 | 156 | 706 | Large | 28.2 |
| | | | | | | | Hysteresis | |
| NiCl3_S25 | NiCl3_7H2O_S1 | 1.920 | 1.034 | −504 | 109 | 613 | Large | 34.0 |
| | | | | | | | Hysteresis | |
| BaI2 | BaI2_7H2O_S1 | 2.041 | 0.764 | 87 | 226 | 139 | Large | 12.7 |
| | | | | | | | Hysteresis | |
| TaCl4 | TaCl4_5H2O_S2 | 2.042 | 0.754 | 153 | 153 | 0 | 100-200 C. | 7.3 |
| CuBr2 | CuBr2_8H2O_S2 | 1.962 | 0.940 | −62 | 108 | 170 | Large | 30.4 |
| | | | | | | | Hysteresis | |
| SnBr2_2H2O_S5 | SnBr2_12H2O_S1 | 1.883 | 1.088 | 90 | 120 | 31 | 100-200 C. | 0.0 |
| MnBr3_S12 | MnBr3_7H2O_S1 | 2.003 | 0.844 | −300 | 137 | 437 | Large | 21.0 |
| | | | | | | | Hysteresis | |
| TiI3 | TiI3_6H2O_S1 | 2.041 | 0.743 | 182 | 182 | 0 | 100-200 C. | 0.0 |
| MoCl3_2H2O_S1 | MoCl3_9H2O_S2 | 1.853 | 1.132 | 131 | 131 | 0 | 100-200 C. | 0.0 |
| SiCl4_3H2O_S2 | SiCl4_8H2O_S1 | 1.860 | 1.120 | 209 | 209 | 0 | 200-300 C. | 34.2 |
| VCl3 | VCl3_3H2O_S9 | 1.936 | 0.978 | 199 | 199 | 0 | 100-200 C. | 0.0 |
| CoI2 | CoI2_8H2O_S3 | 1.995 | 0.851 | 60 | 60 | 0 | 50-100 C. | 21.8 |
| NbF4_3H2O_S2 | NbF4_8H2O_S1 | 1.903 | 1.037 | 143 | 214 | 71 | 100-200 C. | 1.7 |
| ScI3_2H2O_S2 | ScI3_9H2O_S2 | 1.978 | 0.884 | 170 | 285 | 115 | 200-300 C. | 20.3 |
| TiBr4 | TiBr4_9H2O_S1 | 1.998 | 0.838 | −765 | 169 | 934 | Large | 38.4 |
| | | | | | | | Hysteresis | |
| BaI2_1H2O_S1 | BaI2_9H2O_S1 | 2.006 | 0.818 | 111 | 135 | 23 | 100-200 C. | 5.5 |
| SnCl4 | SnCl4_4H2O_S1 | 1.993 | 0.850 | 202 | 214 | 12 | 200-300 C. | 0.0 |
| MgBr2_2H2O_S8 | MgBr2_6H2O_S2 | 1.952 | 0.939 | 157 | 237 | 80 | 100-200 C. | 6.2 |
| GeBr2 | GeBr2_4H2O_S2 | 2.016 | 0.787 | 137 | 137 | 0 | 100-200 C. | 0.0 |
| KBr1 | KBr1_4H2O_S1 | 1.846 | 1.126 | 95 | 95 | 0 | 50-100 C. | 0.0 |
| SnF2_2H2O_S5 | SnF2_9H2O_S1 | 1.946 | 0.941 | −5 | 84 | 89 | <50 C. | 19.7 |
| FeCl3_1H2O_S2 | FeCl3_8H2O_S2 | 1.885 | 1.056 | −1 | 154 | 155 | Large | 25.8 |
| | | | | | | | Hysteresis | |
| CaF2_6H2O_S3 | CaF2_12H2O_S1 | 1.735 | 1.288 | 160 | 160 | 0 | 100-200 C. | 26.9 |
| CrI2 | CrI2_4H2O_S3 | 2.056 | 0.664 | 157 | 157 | 0 | 100-200 C. | 0.0 |
| VI2 | VI2_4H2O_S3 | 2.058 | 0.656 | 150 | 150 | 0 | 100-200 C. | 4.8 |
| CrI4_S8 | CrI4_8H2O_S1 | 2.051 | 0.676 | 128 | 143 | 15 | 100-200 C. | 0.0 |
| BaI2 | BaI2_6H2O_S1 | 2.029 | 0.730 | 125 | 226 | 101 | 100-200 C. | 0.7 |
| CrF2_6H2O_S3 | CrF2_12H2O_S1 | 1.789 | 1.204 | 148 | 148 | 0 | 100-200 C. | 15.0 |
| SiI2_S25 | SiI2_8H2O_S1 | 1.942 | 0.937 | 69 | 69 | 0 | 50-100 C. | 0.0 |
| ZnBr2_4H2O_S3 | ZnBr2_12H2O_S1 | 1.857 | 1.095 | 141 | 141 | 0 | 100-200 C. | 0.0 |
| 3-Feb | FeBr3_10H2O_S2 | 1.947 | 0.919 | −703 | 306 | 1008 | Large | 33.4 |
| | | | | | | | Hysteresis | |
| FeCl3 | FeCl3_3H2O_S8 | 1.908 | 0.989 | 154 | 337 | 183 | Large | 0.0 |
| | | | | | | | Hysteresis | |
| MnF4_2H2O_S2 | MnF4_5H2O_S2 | 1.917 | 0.969 | 215 | 217 | 2 | 200-300 C. | 0.0 |
| TiF3 | TiF3_2H2O_S2 | 1.977 | 0.837 | 131 | 131 | 0 | 100-200 C. | 5.3 |
| SrCl2_2H2O_S4 | SrCl2_8H2O_S1 | 1.878 | 1.040 | 86 | 86 | 0 | 50-100 C. | 18.2 |
| CoBr3_S16 | CoBr3_7H2O_S1 | 1.986 | 0.813 | −85 | 90 | 175 | <50 C. | 9.5 |
| ZrBr4_S31 | ZrBr4_5H2O_S2 | 2.029 | 0.697 | 150 | 239 | 89 | 100-200 C. | 2.6 |
| TaBr3_S22 | TaBr3_10H2O_S2 | 2.012 | 0.741 | −580 | 106 | 686 | Large | 27.9 |
| | | | | | | | Hysteresis | |
| CrI3 | CrI3_8H2O_S2 | 2.003 | 0.766 | 105 | 105 | 0 | 100-200 C. | 13.5 |
| VCl4 | VCl4_4H2O_S1 | 1.915 | 0.963 | 164 | 164 | 0 | 100-200 C. | 4.4 |
| MnBr2_4H2O_S3 | MnBr2_12H2O_S1 | 1.819 | 1.132 | 145 | 145 | 0 | 100-200 C. | 0.0 |
| TiBr3 | TiBr3_4H2O_S2 | 2.008 | 0.745 | 186 | 186 | 0 | 100-200 C. | 5.9 |
| LaBr3_1H2O_S3 | LaBr3_6H2O_S2 | 2.016 | 0.724 | 209 | 209 | 0 | 200-300 C. | 17.1 |
| MoF3_1H2O_S2 | MoF3_3H2O_S9 | 2.002 | 0.759 | 265 | 265 | 0 | 200-300 C. | 5.7 |
| ZrI3 | ZrI3_9H2O_S2 | 1.965 | 0.850 | 137 | 137 | 0 | 100-200 C. | 0.0 |
| SnI2 | SnI2_9H2O_S1 | 1.990 | 0.786 | 3 | 102 | 99 | Large | 17.8 |
| | | | | | | | Hysteresis | |
| GeF4_2H2O_S2 | GeF4_5H2O_S2 | 1.935 | 0.910 | 223 | 223 | 0 | 200-300 C. | 0.0 |
| LiBr1_1H2O_S1 | LiBr1_4H2O_S1 | 1.873 | 1.028 | 48 | 180 | 131 | Large | 0.0 |
| | | | | | | | Hysteresis | |
| VBr3_S31 | VBr3_4H2O_S2 | 2.012 | 0.719 | 174 | 174 | 0 | 100-200 C. | 5.8 |
| CrI3 | CrI3_6H2O_S3 | 2.031 | 0.663 | 136 | 136 | 0 | 100-200 C. | 0.1 |
| ZrBr3_2H2O_S2 | ZrBr3_9H2O_S2 | 1.903 | 0.966 | 193 | 193 | 0 | 100-200 C. | 45.5 |
| SnI2_1H2O_S2 | SnI2_12H2O_S1 | 1.891 | 0.985 | 73 | 127 | 54 | 100-200 C. | 19.5 |
| VI3_S15 | VI3_6H2O_S1 | 2.007 | 0.717 | 168 | 168 | 0 | 100-200 C. | 0.0 |
| WCl4 | WCl4_9H2O_S1 | 1.965 | 0.823 | −997 | 161 | 1159 | Large | 49.4 |
| | | | | | | | Hysteresis | |
| NiI2 | NiI2_6H2O_S3 | 2.011 | 0.697 | 62 | 62 | 0 | 50-100 C. | 14.7 |
| PbBr2 | PbBr2_7H2O_S1 | 2.022 | 0.665 | −75 | 148 | 224 | Large | 32.6 |
| | | | | | | | Hysteresis | |
| MnBr3_S12 | MnBr3_8H2O_S2 | 1.954 | 0.842 | −238 | 137 | 375 | Large | 30.8 |
| | | | | | | | Hysteresis | |
| PbI2 | PbI2_9H2O_S1 | 2.012 | 0.689 | 25 | 90 | 65 | 50-100 C. | 15.4 |
| LaBr3_1H2O_S3 | LaBr3_9H2O_S2 | 1.903 | 0.947 | 92 | 209 | 117 | Large | 17.1 |
| | | | | | | | Hysteresis | |
| MnI3_S16 | MnI3_10H2O_S2 | 1.958 | 0.828 | 38 | 102 | 64 | Large | 1.6 |
| | | | | | | | Hysteresis | |
| NaBr1 | NaBr1_3H2O_S1 | 1.887 | 0.977 | −20 | 127 | 146 | Large | 13.3 |
| | | | | | | | Hysteresis | |
| CrBr2_1H2O_S2 | CrBr2_4H2O_S3 | 1.984 | 0.758 | 218 | 218 | 0 | 200-300 C. | 21.0 |
| CsF1 | CsF1_2H2O_S1 | 1.993 | 0.735 | 151 | 249 | 99 | 100-200 C. | 0.0 |
| CuCl2_4H2O_S3 | CuCl2_12H2O_S1 | 1.748 | 1.207 | 89 | 89 | 0 | 50-100 C. | 0.0 |
| LiF1_2H2O_S2 | LiF1_4H2O_S1 | 1.769 | 1.172 | 120 | 120 | 0 | 100-200 C. | 25.0 |
| TiCl3 | TiCl3_3H2O_S9 | 1.872 | 0.998 | 202 | 202 | 0 | 200-300 C. | 0.0 |
| GaBr3_2H2O_S1 | GaBr3_9H2O_S2 | 1.912 | 0.918 | 151 | 151 | 0 | 100-200 C. | 0.0 |
| MoBr3 | MoBr3_8H2O_S2 | 1.959 | 0.813 | 61 | 61 | 0 | 50-100 C. | 27.1 |
| CuI2_S15 | CuI2_9H2O_S2 | 1.958 | 0.812 | −9 | 64 | 73 | <50 C. | 14.1 |
| MnCl3_S25 | MnCl3_4H2O_S2 | 1.891 | 0.959 | 110 | 110 | 0 | 100-200 C. | 17.5 |
| CrF2_7H2O_S1 | CrF2_12H2O_S1 | 1.758 | 1.182 | 223 | 223 | 0 | 200-300 C. | 34.6 |
| SnF2_2H2O_S5 | SnF2_8H2O_S1 | 1.913 | 0.908 | 16 | 84 | 68 | 50-100 C. | 12.8 |
| ZrI3 | ZrI3_7H2O_S2 | 2.000 | 0.694 | 133 | 133 | 0 | 100-200 C. | 4.3 |
| SiF2_S25 | SiF2_2H2O_S4 | 1.897 | 0.937 | 55 | 55 | 0 | 50-100 C. | 45.0 |
| CoBr3_1H2O_S3 | CoBr3_6H2O_S3 | 1.986 | 0.730 | 133 | 133 | 0 | 100-200 C. | 47.3 |
| TaBr3_S22 | TaBr3_6H2O_S3 | 2.020 | 0.627 | 106 | 106 | 0 | 100-200 C. | 0.0 |
| TaBr3_S22 | TaBr3_8H2O_S2 | 1.999 | 0.692 | −70 | 106 | 176 | Large | 17.1 |
| | | | | | | | Hysteresis | |
| PbBr2_2H2O_S5 | PbBr2_12H2O_S1 | 1.893 | 0.943 | 97 | 132 | 35 | 100-200 C. | 0.0 |
| CoCl3_3H2O_S9 | CoCl3_9H2O_S2 | 1.799 | 1.111 | 121 | 164 | 43 | 100-200 C. | 14.2 |
| TaCl3_S22 | TaCl3_7H2O_S2 | 1.975 | 0.756 | 33 | 33 | 0 | <50 C. | 26.1 |
| CoF3_3H2O_S9 | CoF3_8H2O_S2 | 1.879 | 0.966 | 71 | 71 | 0 | 50-100 C. | 35.6 |
| SnF4_2H2O_S2 | SnF4_9H2O_S1 | 1.936 | 0.844 | −903 | 227 | 1130 | Large | 44.9 |
| | | | | | | | Hysteresis | |
| WF4_3H2O_S2 | WF4_8H2O_S1 | 1.955 | 0.798 | 130 | 227 | 97 | 100-200 C. | 9.8 |
| MnCl2_1H2O_S2 | MnCl2_4H2O_S3 | 1.884 | 0.953 | 158 | 158 | 0 | 100-200 C. | 0.0 |
| WCl4 | WCl4_5H2O_S2 | 1.983 | 0.719 | 136 | 136 | 0 | 100-200 C. | 9.5 |
| CrCl4_S19 | CrCl4_4H2O_S1 | 1.891 | 0.934 | 152 | 152 | 0 | 100-200 C. | 5.5 |
| CrCl3 | CrCl3_3H2O_S9 | 1.888 | 0.939 | 182 | 182 | 0 | 100-200 C. | 2.6 |
| SiI2_S25 | SiI2_12H2O_S1 | 1.819 | 1.067 | −46 | 69 | 115 | <50 C. | 14.5 |
| FeCl2_1H2O_S2 | FeCl2_4H2O_S3 | 1.892 | 0.927 | 148 | 148 | 0 | 100-200 C. | 8.2 |
| 3-Feb | FeBr3_7H2O_S1 | 1.943 | 0.809 | 20 | 306 | 286 | Large | 22.7 |
| | | | | | | | Hysteresis | |
| PbCl2 | PbCl2_4H2O_S3 | 1.991 | 0.681 | 127 | 144 | 17 | 100-200 C. | 0.0 |
| SrI2_1H2O_S1 | SrI2_7H2O_S1 | 1.953 | 0.777 | 9 | 171 | 162 | Large | 9.5 |
| | | | | | | | Hysteresis | |
| TiF4_2H2O_S2 | TiF4_9H2O_S1 | 1.849 | 0.999 | −946 | 209 | 1155 | Large | 46.9 |
| | | | | | | | Hysteresis | |
| PbF2 | PbF2_2H2O_S4 | 2.061 | 0.403 | 115 | 115 | 0 | 100-200 C. | 0.0 |
| NiBr2_4H2O_S3 | NiBr2_12H2O_S1 | 1.816 | 1.054 | 119 | 119 | 0 | 100-200 C. | 0.8 |
| SnF2_4H2O_S2 | SnF2_12H2O_S1 | 1.793 | 1.084 | 73 | 73 | 0 | 50-100 C. | 0.0 |
| MoBr3 | MoBr3_10H2O_S2 | 1.922 | 0.834 | −897 | 124 | 1021 | Large | 42.0 |
| | | | | | | | Hysteresis | |
| CuF2_2H2O_S3 | CuF2_4H2O_S7 | 1.926 | 0.826 | 218 | 218 | 0 | 200-300 C. | 13.0 |
| PbCl4_2H2O_S2 | PbCl4_8H2O_S1 | 1.929 | 0.817 | 180 | 218 | 38 | 100-200 C. | 4.7 |
| HfF4_1H2O_S1 | HfF4_3H2O_S2 | 2.028 | 0.523 | 280 | 280 | 0 | 200-300 C. | 31.7 |
| FeCl2_4H2O_S3 | FeCl2_12H2O_S1 | 1.727 | 1.185 | 31 | 101 | 70 | Large | 1.8 |
| | | | | | | | Hysteresis | |
| CrF4_2H2O_S2 | CrF4_5H2O_S2 | 1.861 | 0.958 | 204 | 204 | 0 | 200-300 C. | 0.0 |
| NiI2 | NiI2_8H2O_S3 | 1.930 | 0.809 | 43 | 43 | 0 | <50 C. | 23.5 |
| PbI2_1H2O_S2 | PbI2_12H2O_S1 | 1.897 | 0.877 | 86 | 125 | 39 | 100-200 C. | 26.8 |
| FeBr3_1H2O_S2 | FeBr3_9H2O_S2 | 1.881 | 0.907 | 83 | 83 | 0 | 50-100 C. | 0.0 |
| GaBr3_2H2O_S1 | GaBr3_10H2O_S2 | 1.901 | 0.864 | −340 | 151 | 490 | Large | 17.2 |
| | | | | | | | Hysteresis | |
| MnBr4_2H2O_S2 | MnBr4_8H2O_S1 | 1.934 | 0.783 | 190 | 190 | 0 | 100-200 C. | 16.2 |
| MnF4_1H2O_S1 | MnF4_2H2O_S2 | 1.951 | 0.737 | 570 | 570 | 0 | 450-600 C. | 27.6 |
| GeBr2 | GeBr2_7H2O_S1 | 1.912 | 0.829 | −142 | 137 | 279 | Large | 42.1 |
| | | | | | | | Hysteresis | |
| MgBr2_4H2O_S4 | MgBr2_9H2O_S2 | 1.839 | 0.978 | 191 | 191 | 0 | 100-200 C. | 2.2 |
| VI4_S17 | VI4_8H2O_S1 | 1.974 | 0.658 | 123 | 123 | 0 | 100-200 C. | 0.0 |
| CoCl2_7H2O_S1 | CoCl2_12H2O_S1 | 1.701 | 1.198 | 295 | 295 | 0 | 200-300 C. | 49.6 |
| MgCl2_2H2O_S8 | MgCl2_7H2O_S1 | 1.750 | 1.125 | −21 | 202 | 223 | Large | 40.7 |
| | | | | | | | Hysteresis | |
| SnBr2 | SnBr2_6H2O_S3 | 1.927 | 0.776 | −51 | 139 | 191 | Large | 20.3 |
| | | | | | | | Hysteresis | |
| MgBr2 | MgBr2_2H2O_S8 | 1.944 | 0.730 | 270 | 285 | 15 | 200-300 C. | 0.0 |
| YI3_2H2O_S2 | YI3_8H2O_S2 | 1.943 | 0.731 | 181 | 266 | 85 | 200-300 C. | 19.5 |
| MnI2 | MnI2_7H2O_S1 | 1.929 | 0.766 | 53 | 53 | 0 | 50-100 C. | 40.0 |
| CuF2_6H2O_S3 | CuF2_12H2O_S1 | 1.750 | 1.114 | 131 | 131 | 0 | 100-200 C. | 9.4 |
| GeCl2_1H2O_S2 | GeCl2_4H2O_S2 | 1.835 | 0.969 | 149 | 315 | 167 | Large | 35.2 |
| | | | | | | | Hysteresis | |
| SrI2_1H2O_S1 | SrI2_6H2O_S1 | 1.946 | 0.716 | 167 | 171 | 4 | 100-200 C. | 0.0 |
| TaF4_3H2O_S2 | TaF4_8H2O_S1 | 1.907 | 0.813 | 151 | 207 | 56 | 100-200 C. | 0.8 |
| CrBr2_4H2O_S3 | CrBr2_12H2O_S1 | 1.760 | 1.088 | 126 | 126 | 0 | 100-200 C. | 0.0 |
| ZnI2_2H2O_S1 | ZnI2_9H2O_S2 | 1.910 | 0.794 | 101 | 101 | 0 | 100-200 C. | 8.3 |
| MnI2 | MnI2_4H2O_S3 | 1.967 | 0.635 | 141 | 141 | 0 | 100-200 C. | 1.1 |
| VI3_S15 | VI3_7H2O_S1 | 1.933 | 0.730 | −132 | 168 | 300 | Large | 15.0 |
| | | | | | | | Hysteresis | |
| AlBr3_1H2O_S2 | AlBr3_4H2O_S2 | 1.936 | 0.720 | 284 | 284 | 0 | 200-300 C. | 26.0 |
| CoF2_2H2O_S4 | CoF2_4H2O_S7 | 1.884 | 0.845 | 216 | 216 | 0 | 200-300 C. | 10.5 |
| LaCl3_2H2O_S1 | LaCl3_9H2O_S2 | 1.761 | 1.077 | 90 | 206 | 117 | Large | 22.2 |
| | | | | | | | Hysteresis | |
| CrBr4_2H2O_S2 | CrBr4_8H2O_S1 | 1.917 | 0.763 | 176 | 176 | 0 | 100-200 C. | 16.6 |
| ScBr3_3H2O_S9 | ScBr3_9H2O_S2 | 1.822 | 0.968 | 193 | 249 | 56 | 200-300 C. | 2.0 |
| VI2_4H2O_S3 | VI2_12H2O_S1 | 1.810 | 0.989 | 168 | 168 | 0 | 100-200 C. | 4.8 |
| SrBr2_4H2O_S3 | SrBr2_12H2O_S1 | 1.743 | 1.102 | 164 | 164 | 0 | 100-200 C. | 8.8 |
| ZnI2 | ZnI2_4H2O_S2 | 1.961 | 0.636 | 115 | 191 | 76 | 100-200 C. | 1.9 |
| NiF2_2H2O_S4 | NiF2_7H2O_S1 | 1.828 | 0.949 | −96 | 185 | 281 | Large | 41.6 |
| | | | | | | | Hysteresis | |
| AlBr3_3H2O_S9 | AlBr3_6H2O_S1 | 1.890 | 0.817 | 426 | 426 | 0 | 300-450 C. | 17.8 |
| NbI3 | NbI3_8H2O_S2 | 1.937 | 0.696 | −38 | 139 | 177 | Large | 9.3 |
| | | | | | | | Hysteresis | |
| NbI4 | NbI4_8H2O_S1 | 1.954 | 0.639 | 135 | 135 | 0 | 100-200 C. | 0.0 |
| YCl3_3H2O_S9 | YCl3_9H2O_S2 | 1.713 | 1.136 | 171 | 210 | 40 | 100-200 C. | 0.0 |
| ScCl3_4H2O_S2 | ScCl3_9H2O_S2 | 1.675 | 1.188 | 237 | 237 | 0 | 200-300 C. | 10.4 |
| GeI2 | GeI2_9H2O_S2 | 1.879 | 0.828 | −7 | 87 | 94 | <50 C. | 17.6 |
| SrBr2 | SrBr2_4H2O_S3 | 1.901 | 0.774 | 110 | 192 | 82 | 100-200 C. | 8.8 |
| MnBr4_S31 | MnBr4_5H2O_S2 | 1.937 | 0.672 | 155 | 155 | 0 | 100-200 C. | 6.1 |
| SnF2_1H2O_S2 | SnF2_4H2O_S2 | 1.886 | 0.802 | 84 | 268 | 184 | Large | 38.5 |
| | | | | | | | Hysteresis | |
| TiI2_4H2O_S3 | TiI2_12H2O_S1 | 1.792 | 0.995 | 168 | 168 | 0 | 100-200 C. | 16.4 |
| NbBr4_2H2O_S2 | NbBr4_8H2O_S1 | 1.911 | 0.742 | 198 | 198 | 0 | 100-200 C. | 26.2 |
| PbBr2 | PbBr2_6H2O_S3 | 1.943 | 0.647 | −47 | 148 | 195 | Large | 20.7 |
| | | | | | | | Hysteresis | |
| VBr4_2H2O_S2 | VBr4_8H2O_S1 | 1.896 | 0.772 | 181 | 181 | 0 | 100-200 C. | 20.5 |
| CaI2 | CaI2_4H2O_S4 | 1.904 | 0.751 | 176 | 219 | 44 | 100-200 C. | 1.1 |
| SrF2 | SrF2_2H2O_S1 | 1.935 | 0.663 | 94 | 94 | 0 | 50-100 C. | 0.0 |
| CaF2_7H2O_S1 | CaF2_12H2O_S1 | 1.642 | 1.218 | 218 | 218 | 0 | 200-300 C. | 38.1 |
| ScBr3_2H2O_S2 | ScBr3_6H2O_S1 | 1.869 | 0.829 | 285 | 285 | 0 | 200-300 C. | 25.3 |
| FeF3_1H2O_S2 | FeF3_3H2O_S5 | 1.894 | 0.761 | 162 | 162 | 0 | 100-200 C. | 4.5 |
| CaBr2_2H2O_S3 | CaBr2_8H2O_S2 | 1.741 | 1.065 | 145 | 145 | 0 | 100-200 C. | 11.1 |
| TiF4_2H2O_S2 | TiF4_5H2O_S2 | 1.787 | 0.987 | 209 | 209 | 0 | 200-300 C. | 0.0 |
| NbF3 | NbF3_1H2O_S2 | 1.965 | 0.552 | 362 | 362 | 0 | 300-450 C. | 0.0 |
| TiBr4_2H2O_S2 | TiBr4_8H2O_S1 | 1.884 | 0.783 | 184 | 184 | 0 | 100-200 C. | 13.0 |
| ZrCl3_3H2O_S9 | ZrCl3_9H2O_S2 | 1.713 | 1.107 | 182 | 182 | 0 | 100-200 C. | 20.2 |
| MoF4_2H2O_S2 | MoF4_5H2O_S2 | 1.858 | 0.841 | 230 | 230 | 0 | 200-300 C. | 0.0 |
| CaI2_4H2O_S4 | CaI2_12H2O_S1 | 1.752 | 1.043 | 182 | 182 | 0 | 100-200 C. | 1.1 |
| TaBr4_2H2O_S2 | TaBr4_8H2O_S1 | 1.934 | 0.647 | 203 | 203 | 0 | 200-300 C. | 33.8 |
| GeCl4 | GeCl4_5H2O_S2 | 1.835 | 0.889 | 98 | 98 | 0 | 50-100 C. | 14.8 |
| GaCl3 | GaCl3_3H2O_S9 | 1.846 | 0.863 | 137 | 267 | 130 | 200-300 C. | 11.6 |
| NbBr3_2H2O_S2 | NbBr3_9H2O_S2 | 1.826 | 0.903 | 96 | 215 | 119 | Large | 48.5 |
| | | | | | | | Hysteresis | |
| ZrCl4_2H2O_S2 | ZrCl4_10H2O_S1 | 1.824 | 0.906 | −414 | 228 | 642 | Large | 39.8 |
| | | | | | | | Hysteresis | |
| NbI3 | NbI3_6H2O_S3 | 1.938 | 0.621 | 139 | 139 | 0 | 100-200 C. | 0.0 |
| HfI3 | HfI3_6H2O_S3 | 1.958 | 0.553 | 149 | 149 | 0 | 100-200 C. | 21.3 |
| SiBr4_3H2O_S1 | SiBr4_9H2O_S1 | 1.867 | 0.806 | 129 | 210 | 81 | 100-200 C. | 39.1 |
| MnI4_S31 | MnI4_8H2O_S1 | 1.927 | 0.648 | 119 | 119 | 0 | 100-200 C. | 0.0 |
| CuF1_1H2O_S2 | CuF1_4H2O_S1 | 1.834 | 0.876 | −1 | 111 | 112 | Large | 10.4 |
| | | | | | | | Hysteresis | |
| NbI3 | NbI3_9H2O_S2 | 1.872 | 0.790 | 49 | 139 | 91 | Large | 0.0 |
| | | | | | | | Hysteresis | |
| MgF2_2H2O_S3 | MgF2_4H2O_S7 | 1.772 | 0.993 | 184 | 184 | 0 | 100-200 C. | 21.3 |
| LaI3_2H2O_S1 | LaI3_9H2O_S3 | 1.903 | 0.708 | 141 | 243 | 102 | 100-200 C. | 21.3 |
| TiBr3_2H2O_S2 | TiBr3_6H2O_S3 | 1.879 | 0.767 | 247 | 247 | 0 | 200-300 C. | 27.6 |
| LaI2 | LaI2_7H2O_S1 | 1.909 | 0.688 | 76 | 76 | 0 | 50-100 C. | 39.1 |
| WBr4_2H2O_S2 | WBr4_8H2O_S1 | 1.926 | 0.637 | 198 | 198 | 0 | 100-200 C. | 39.3 |
| BeBr2_2H2O_S2 | BeBr2_4H2O_S8 | 1.844 | 0.846 | 425 | 425 | 0 | 300-450 C. | 0.4 |
| BaI2_2H2O_S9 | BaI2_12H2O_S1 | 1.785 | 0.962 | 127 | 127 | 0 | 100-200 C. | 0.0 |
| CaCl2_6H2O_S1 | CaCl2_12H2O_S1 | 1.577 | 1.273 | 202 | 202 | 0 | 200-300 C. | 14.6 |
| BaBr2_1H2O_S1 | BaBr2_8H2O_S1 | 1.857 | 0.811 | 66 | 146 | 81 | 100-200 C. | 19.0 |
| TaI3_S15 | TaI3_10H2O_S2 | 1.916 | 0.656 | −9 | 106 | 116 | Large | 10.0 |
| | | | | | | | Hysteresis | |
| FeI2 | FeI2_4H2O_S3 | 1.932 | 0.605 | 122 | 122 | 0 | 100-200 C. | 0.0 |
| CrI3 | CrI3_7H2O_S1 | 1.902 | 0.690 | 104 | 104 | 0 | 100-200 C. | 13.5 |
| GaCl3_4H2O_S2 | GaCl3_9H2O_S2 | 1.715 | 1.073 | 224 | 224 | 0 | 200-300 C. | 17.6 |
| CaBr2_2H2O_S3 | CaBr2_7H2O_S1 | 1.821 | 0.882 | 121 | 121 | 0 | 100-200 C. | 18.2 |
| GeF4_1H2O_S1 | GeF4_2H2O_S2 | 1.912 | 0.662 | 564 | 564 | 0 | 450-600 C. | 23.6 |
| TaI4 | TaI4_8H2O_S1 | 1.942 | 0.568 | 132 | 132 | 0 | 100-200 C. | 0.0 |
| NbF4_2H2O_S2 | NbF4_5H2O_S2 | 1.830 | 0.862 | 237 | 237 | 0 | 200-300 C. | 12.6 |
| PbF2_4H2O_S4 | PbF2_12H2O_S1 | 1.812 | 0.899 | 82 | 82 | 0 | 50-100 C. | 1.2 |
| CrCl3_4H2O_S2 | CrCl3_9H2O_S2 | 1.684 | 1.117 | 217 | 217 | 0 | 200-300 C. | 13.0 |
| TaBr3_S22 | TaBr3_7H2O_S2 | 1.923 | 0.616 | −240 | 106 | 345 | Large | 19.8 |
| | | | | | | | Hysteresis | |
| SnI4 | SnI4_5H2O_S2 | 1.946 | 0.537 | 97 | 634 | 537 | Large | 0.0 |
| | | | | | | | Hysteresis | |
| SrF2_2H2O_S1 | SrF2_8H2O_S1 | 1.791 | 0.925 | 12 | 12 | 0 | <50 C. | 24.8 |
| MoBr4_2H2O_S2 | MoBr4_8H2O_S1 | 1.883 | 0.717 | 185 | 185 | 0 | 100-200 C. | 23.5 |
| YBr3_2H2O_S2 | YBr3_6H2O_S2 | 1.887 | 0.707 | 255 | 255 | 0 | 200-300 C. | 17.5 |
| NaBr1 | NaBr1_2H2O_S3 | 1.831 | 0.838 | 124 | 127 | 2 | 100-200 C. | 0.0 |
| MoI4_S28 | MoI4_8H2O_S1 | 1.918 | 0.612 | 119 | 119 | 0 | 100-200 C. | 0.0 |
| BaCl2_2H2O_S4 | BaCl2_9H2O_S1 | 1.782 | 0.936 | 66 | 66 | 0 | 50-100 C. | 16.5 |
| ZrBr4_2H2O_S2 | ZrBr4_9H2O_S1 | 1.881 | 0.715 | −240 | 207 | 447 | Large | 13.6 |
| | | | | | | | Hysteresis | |
| NaF1_2H2O_S1 | NaF1_4H2O_S1 | 1.686 | 1.097 | 156 | 156 | 0 | 100-200 C. | 13.0 |
| VF2_2H2O_S4 | VF2_4H2O_S4 | 1.810 | 0.872 | 208 | 208 | 0 | 200-300 C. | 11.3 |
| MnCl4_3H2O_S1 | MnCl4_8H2O_S1 | 1.744 | 0.994 | 185 | 215 | 30 | 200-300 C. | 0.4 |
| GeI2_2H2O_S5 | GeI2_12H2O_S1 | 1.763 | 0.960 | 63 | 168 | 105 | 100-200 C. | 27.1 |
| AlCl3 | AlCl3_2H2O_S1 | 1.764 | 0.957 | 164 | 401 | 237 | Large | 28.7 |
| | | | | | | | Hysteresis | |
| TaBr3_1H2O_S2 | TaBr3_9H2O_S2 | 1.851 | 0.773 | 88 | 127 | 39 | 100-200 C. | 23.3 |
| HfCl4 | HfCl4_3H2O_S1 | 1.897 | 0.651 | 238 | 306 | 68 | 200-300 C. | 0.0 |
| HfBr4_S31 | HfBr4_4H2O_S1 | 1.933 | 0.536 | 201 | 296 | 94 | 200-300 C. | 0.0 |
| MoCl3_3H2O_S9 | MoCl3_9H2O_S2 | 1.711 | 1.045 | 162 | 162 | 0 | 100-200 C. | 21.7 |
| MoBr2_S16 | MoBr2_12H2O_S1 | 1.746 | 0.982 | −8 | −8 | 0 | <50 C. | 25.7 |
| PbBr4_S20 | PbBr4_8H2O_S1 | 1.900 | 0.633 | 91 | 91 | 0 | 50-100 C. | 0.0 |
| TiBr4 | TiBr4_5H2O_S2 | 1.885 | 0.676 | 151 | 151 | 0 | 100-200 C. | 6.8 |
| BaF2 | BaF2_2H2O_S1 | 1.914 | 0.583 | 149 | 149 | 0 | 100-200 C. | 0.0 |
| TaF4_2H2O_S1 | TaF4_5H2O_S2 | 1.888 | 0.663 | 252 | 252 | 0 | 200-300 C. | 20.3 |
| SrBr2_2H2O_S4 | SrBr2_8H2O_S1 | 1.813 | 0.846 | 105 | 105 | 0 | 100-200 C. | 16.3 |
| BaF2_4H2O_S1 | BaF2_12H2O_S1 | 1.703 | 1.048 | 78 | 78 | 0 | 50-100 C. | 8.0 |
| LaI2 | LaI2_8H2O_S1 | 1.860 | 0.731 | 63 | 63 | 0 | 50-100 C. | 39.4 |
| VCl4_3H2O_S1 | VCl4_8H2O_S1 | 1.728 | 1.004 | 190 | 190 | 0 | 100-200 C. | 7.8 |
| HfBr4_2H2O_S2 | HfBr4_8H2O_S1 | 1.891 | 0.641 | 192 | 210 | 18 | 200-300 C. | 0.0 |
| GeBr4 | GeBr4_9H2O_S1 | 1.849 | 0.752 | 44 | 44 | 0 | <50 C. | 1.1 |
| MnCl4_S1 | MnCl4_3H2O_S1 | 1.809 | 0.844 | 210 | 210 | 0 | 200-300 C. | 0.4 |
| VCl3_3H2O_S9 | VCl3_10H2O_S2 | 1.704 | 1.037 | −627 | 192 | 819 | Large | 30.0 |
| | | | | | | | Hysteresis | |
| GeCl4_3H2O_S1 | GeCl4_8H2O_S1 | 1.750 | 0.958 | 197 | 197 | 0 | 100-200 C. | 32.7 |
| PbCl2_2H2O_S5 | PbCl2_9H2O_S1 | 1.842 | 0.764 | 28 | 127 | 99 | Large | 19.7 |
| | | | | | | | Hysteresis | |
| SnF4_2H2O_S2 | SnF4_5H2O_S2 | 1.836 | 0.770 | 227 | 227 | 0 | 200-300 C. | 0.0 |
| MgI2_1H2O_S2 | MgI2_4H2O_S4 | 1.869 | 0.685 | 263 | 298 | 35 | 200-300 C. | 3.5 |
| VBr2_1H2O_S2 | VBr2_4H2O_S3 | 1.863 | 0.700 | 179 | 179 | 0 | 100-200 C. | 4.3 |
| NiBr3_1H2O_S3 | NiBr3_6H2O_S3 | 1.863 | 0.698 | 115 | 115 | 0 | 100-200 C. | 34.6 |
| ZrCl2 | ZrCl2_8H2O_S2 | 1.740 | 0.962 | −40 | 114 | 154 | Large | 38.0 |
| | | | | | | | Hysteresis | |
| TiCl2_7H2O_S1 | TiCl2_12H2O_S1 | 1.587 | 1.197 | 276 | 276 | 0 | 200-300 C. | 46.0 |
| CrCl4_3H2O_S1 | CrCl4_8H2O_S1 | 1.724 | 0.989 | 185 | 185 | 0 | 100-200 C. | 9.5 |
| NbCl4 | NbCl4_4H2O_S1 | 1.809 | 0.823 | 160 | 160 | 0 | 100-200 C. | 6.8 |
| ZrBr4_2H2O_S2 | ZrBr4_8H2O_S1 | 1.849 | 0.730 | 184 | 207 | 22 | 100-200 C. | 0.0 |
| MgBr2_2H2O_S8 | MgBr2_7H2O_S1 | 1.776 | 0.887 | 15 | 237 | 222 | Large | 34.9 |
| | | | | | | | Hysteresis | |
| LiCl1_1H2O_S1 | LiCl1_3H2O_S1 | 1.625 | 1.140 | 67 | 140 | 73 | 100-200 C. | 1.0 |
| BaCl2_4H2O_S2 | BaCl2_12H2O_S1 | 1.643 | 1.114 | 132 | 132 | 0 | 100-200 C. | 15.2 |
| MoBr3 | MoBr3_7H2O_S1 | 1.849 | 0.721 | 53 | 53 | 0 | 50-100 C. | 30.1 |
| GeCl2_4H2O_S2 | GeCl2_12H2O_S1 | 1.606 | 1.166 | 86 | 86 | 0 | 50-100 C. | 0.0 |
| CrBr3_3H2O_S9 | CrBr3_9H2O_S2 | 1.775 | 0.884 | 185 | 185 | 0 | 100-200 C. | 7.5 |
| LiBr1 | LiBr1_1H2O_S1 | 1.859 | 0.689 | 222 | 222 | 0 | 200-300 C. | 0.0 |
| NiF2_2H2O_S4 | NiF2_4H2O_S4 | 1.817 | 0.793 | 185 | 185 | 0 | 100-200 C. | 0.0 |
| MoI3 | MoI3_10H2O_S2 | 1.849 | 0.716 | −253 | 83 | 336 | <50 C. | 13.3 |
| VF4_2H2O_S2 | VF4_5H2O_S2 | 1.751 | 0.930 | 188 | 188 | 0 | 100-200 C. | 0.0 |
| BaCl2 | BaCl2_4H2O_S2 | 1.827 | 0.766 | 37 | 152 | 115 | Large | 15.2 |
| | | | | | | | Hysteresis | |
| MgI2_2H2O_S8 | MgI2_6H2O_S2 | 1.826 | 0.768 | 206 | 263 | 57 | 200-300 C. | 0.4 |
| SnBr2 | SnBr2_4H2O_S3 | 1.863 | 0.671 | 120 | 139 | 19 | 100-200 C. | 0.0 |
| TiCl3_3H2O_S9 | TiCl3_10H2O_S2 | 1.705 | 1.007 | −772 | 195 | 967 | Large | 36.5 |
| | | | | | | | Hysteresis | |
| MnI3_S16 | MnI3_9H2O_S2 | 1.818 | 0.780 | 42 | 102 | 59 | Large | 0.7 |
| | | | | | | | Hysteresis | |
| TiCl4_3H2O_S1 | TiCl4_8H2O_S1 | 1.698 | 1.011 | 189 | 189 | 0 | 100-200 C. | 0.9 |
| GeCl2_2H2O_S5 | GeCl2_9H2O_S2 | 1.691 | 1.022 | −14 | 149 | 162 | Large | 25.1 |
| | | | | | | | Hysteresis | |
| TiBr2_1H2O_S2 | TiBr2_7H2O_S1 | 1.785 | 0.847 | 50 | 50 | 0 | <50 C. | 36.6 |
| HfCl4_2H2O_S2 | HfCl4_10H2O_S1 | 1.829 | 0.744 | −440 | 238 | 678 | Large | 42.1 |
| | | | | | | | Hysteresis | |
| TiCl2_1H2O_S2 | TiCl2_7H2O_S1 | 1.698 | 1.007 | 9 | 9 | 0 | <50 C. | 46.0 |
| ScCl3_3H2O_S9 | ScCl3_8H2O_S2 | 1.695 | 1.012 | 137 | 137 | 0 | 100-200 C. | 21.2 |
| SnI2 | SnI2_8H2O_S2 | 1.835 | 0.724 | −7 | 102 | 109 | Large | 18.0 |
| | | | | | | | Hysteresis | |
| CrI4_S8 | CrI4_9H2O_S1 | 1.855 | 0.665 | −240 | 143 | 383 | Large | 13.5 |
| | | | | | | | Hysteresis | |
| NiCl3_3H2O_S8 | NiCl3_9H2O_S1 | 1.704 | 0.990 | 57 | 137 | 80 | 50-100 C. | 9.6 |
| BeBr2_4H2O_S8 | BeBr2_12H2O_S1 | 1.660 | 1.060 | 46 | 95 | 49 | 50-100 C. | 0.1 |
| GeF2_6H2O_S3 | GeF2_12H2O_S1 | 1.643 | 1.086 | 132 | 132 | 0 | 100-200 C. | 29.3 |
| TiI3_2H2O_S2 | TiI3_9H2O_S2 | 1.802 | 0.794 | 155 | 210 | 55 | 100-200 C. | 16.7 |
| BaBr2_2H2O_S4 | BaBr2_9H2O_S1 | 1.795 | 0.805 | 89 | 89 | 0 | 50-100 C. | 11.7 |
| VCl2_6H2O_S3 | VCl2_12H2O_S1 | 1.584 | 1.167 | 177 | 177 | 0 | 100-200 C. | 5.9 |
| VBr3_2H2O_S2 | VBr3_6H2O_S1 | 1.815 | 0.757 | 244 | 244 | 0 | 200-300 C. | 33.4 |
| TiBr3_3H2O_S9 | TiBr3_9H2O_S2 | 1.741 | 0.913 | 186 | 206 | 20 | 100-200 C. | 1.6 |
| MnCl3_3H2O_S8 | MnCl3_9H2O_S2 | 1.650 | 1.068 | 73 | 169 | 96 | 100-200 C. | 4.5 |
| CrBr3 | CrBr3_4H2O_S2 | 1.854 | 0.652 | 133 | 133 | 0 | 100-200 C. | 15.4 |
| BeF2_4H2O_S8 | BeF2_9H2O_S1 | 1.612 | 1.122 | 48 | 48 | 0 | <50 C. | 0.0 |
| VCl2 | VCl2_2H2O_S8 | 1.785 | 0.817 | 158 | 179 | 21 | 100-200 C. | 1.2 |
| ZrI3 | ZrI3_6H2O_S3 | 1.863 | 0.615 | 134 | 134 | 0 | 100-200 C. | 5.7 |
| CoCl3_4H2O_S2 | CoCl3_9H2O_S2 | 1.669 | 1.030 | 121 | 292 | 172 | 200-300 C. | 32.0 |
| SiI4 | SiI4_8H2O_S1 | 1.854 | 0.637 | 98 | 98 | 0 | 50-100 C. | 27.5 |
| YF3_4H2O_S1 | YF3_9H2O_S2 | 1.672 | 1.022 | 158 | 158 | 0 | 100-200 C. | 21.3 |
| MnBr4_S31 | MnBr4_9H2O_S1 | 1.801 | 0.768 | −1000 | 171 | 1171 | Large | 49.5 |
| | | | | | | | Hysteresis | |
| PbF2_2H2O_S4 | PbF2_8H2O_S1 | 1.836 | 0.681 | 30 | 30 | 0 | <50 C. | 17.2 |
| NbI3 | NbI3_7H2O_S2 | 1.853 | 0.628 | −165 | 139 | 305 | Large | 13.0 |
| | | | | | | | Hysteresis | |
| FeCl3_1H2O_S2 | FeCl3_7H2O_S2 | 1.723 | 0.928 | −28 | 154 | 183 | Large | 29.8 |
| | | | | | | | Hysteresis | |
| NbCl4_3H2O_S1 | NbCl4_8H2O_S1 | 1.724 | 0.919 | 204 | 204 | 0 | 200-300 C. | 13.5 |
| CoF3_3H2O_S9 | CoF3_6H2O_S1 | 1.774 | 0.813 | 143 | 143 | 0 | 100-200 C. | 12.4 |
| PbBr2 | PbBr2_4H2O_S3 | 1.871 | 0.549 | 132 | 148 | 16 | 100-200 C. | 0.0 |
| MoCl3_2H2O_S1 | MoCl3_10H2O_S1 | 1.711 | 0.935 | −652 | 131 | 783 | Large | 31.1 |
| | | | | | | | Hysteresis | |
| GaI3_1H2O_S2 | GaI3_9H2O_S2 | 1.803 | 0.736 | 113 | 113 | 0 | 100-200 C. | 0.0 |
| ZnF2_2H2O_S4 | ZnF2_4H2O_S4 | 1.786 | 0.774 | 192 | 192 | 0 | 100-200 C. | 6.1 |
| MgBr2_6H2O_S2 | MgBr2_12H2O_S1 | 1.629 | 1.066 | 214 | 214 | 0 | 200-300 C. | 6.2 |
| TiCl3_4H2O_S2 | TiCl3_9H2O_S2 | 1.595 | 1.112 | 209 | 209 | 0 | 200-300 C. | 6.7 |
| MgBr2_7H2O_S1 | MgBr2_12H2O_S1 | 1.626 | 1.064 | 310 | 310 | 0 | 300-450 C. | 34.9 |
| FeBr2_1H2O_S2 | FeBr2_4H2O_S3 | 1.824 | 0.669 | 166 | 166 | 0 | 100-200 C. | 18.1 |
| ZnBr2_1H2O_S2 | ZnBr2_4H2O_S3 | 1.830 | 0.652 | 169 | 169 | 0 | 100-200 C. | 15.2 |
| GaI3 | GaI3_6H2O_S3 | 1.850 | 0.591 | 94 | 153 | 59 | 100-200 C. | 6.5 |
| RbBr1 | RbBr1_4H2O_S1 | 1.734 | 0.873 | 82 | 82 | 0 | 50-100 C. | 0.0 |
| SnF2 | SnF2_2H2O_S5 | 1.848 | 0.588 | 115 | 115 | 0 | 100-200 C. | 0.0 |
| MoF3_3H2O_S9 | MoF3_10H2O_S2 | 1.731 | 0.874 | −1061 | 191 | 1251 | Large | 49.3 |
| | | | | | | | Hysteresis | |
| VCl2_4H2O_S3 | VCl2_9H2O_S2 | 1.649 | 1.019 | 124 | 124 | 0 | 100-200 C. | 10.1 |
| AlCl3_1H2O_S2 | AlCl3_3H2O_S9 | 1.699 | 0.933 | 326 | 326 | 0 | 300-450 C. | 6.4 |
| NiF2_1H2O_S2 | NiF2_2H2O_S4 | 1.839 | 0.612 | 284 | 284 | 0 | 200-300 C. | 16.9 |
| MoF2_1H2O_S2 | MoF2_9H2O_S2 | 1.737 | 0.860 | −55 | −55 | 0 | <50 C. | 41.1 |
| LaCl3_2H2O_S1 | LaCl3_6H2O_S2 | 1.768 | 0.792 | 206 | 206 | 0 | 200-300 C. | 22.2 |
| NaI1 | NaI1_3H2O_S1 | 1.771 | 0.785 | −13 | 146 | 159 | Large | 8.3 |
| | | | | | | | Hysteresis | |
| MgI2_4H2O_S4 | MgI2_9H2O_S2 | 1.765 | 0.799 | 209 | 209 | 0 | 200-300 C. | 0.0 |
| CrBr4_S17 | CrBr4_5H2O_S2 | 1.830 | 0.634 | 128 | 128 | 0 | 100-200 C. | 10.5 |
| WF4_2H2O_S1 | WF4_5H2O_S2 | 1.834 | 0.622 | 224 | 224 | 0 | 200-300 C. | 17.6 |
| VBr3_3H2O_S9 | VBr3_9H2O_S2 | 1.725 | 0.877 | 156 | 205 | 49 | 100-200 C. | 5.7 |
| HfBr4_2H2O_S2 | HfBr4_9H2O_S1 | 1.839 | 0.602 | −368 | 210 | 578 | Large | 19.6 |
| | | | | | | | Hysteresis | |
| CaCl2_1H2O_S2 | CaCl2_4H2O_S7 | 1.618 | 1.061 | 170 | 170 | 0 | 100-200 C. | 0.0 |
| YBr3_S7 | YBr3_4H2O_S2 | 1.811 | 0.675 | 190 | 190 | 0 | 100-200 C. | 13.7 |
| CuBr2 | CuBr2_7H2O_S1 | 1.764 | 0.787 | −153 | 108 | 261 | Large | 42.9 |
| | | | | | | | Hysteresis | |
| MoCl4_3H2O_S1 | MoCl4_8H2O_S1 | 1.710 | 0.896 | 188 | 225 | 37 | 200-300 C. | 2.0 |
| ZrCl4 | ZrCl4_3H2O_S1 | 1.756 | 0.797 | 228 | 260 | 32 | 200-300 C. | 0.0 |
| MoI3 | MoI3_9H2O_S2 | 1.782 | 0.731 | 83 | 83 | 0 | 50-100 C. | 0.0 |
| VI3_2H2O_S2 | VI3_9H2O_S2 | 1.773 | 0.753 | 116 | 201 | 86 | 100-200 C. | 20.0 |
| LaI3_1H2O_S3 | LaI3_6H2O_S2 | 1.835 | 0.587 | 231 | 231 | 0 | 200-300 C. | 25.4 |
| VBr4_S17 | VBr4_5H2O_S2 | 1.817 | 0.639 | 130 | 130 | 0 | 100-200 C. | 9.7 |
| MnBr4_3H2O_S2 | MnBr4_8H2O_S1 | 1.785 | 0.722 | 240 | 240 | 0 | 200-300 C. | 37.5 |
| MnI2_4H2O_S3 | MnI2_12H2O_S1 | 1.683 | 0.930 | 145 | 145 | 0 | 100-200 C. | 1.1 |
| TaI4 | TaI4_9H2O_S1 | 1.843 | 0.545 | −337 | 132 | 469 | Large | 18.1 |
| | | | | | | | Hysteresis | |
| CrCl2 | CrCl2_2H2O_S3 | 1.760 | 0.773 | 148 | 148 | 0 | 100-200 C. | 14.3 |
| NbCl3_3H2O_S9 | NbCl3_9H2O_S2 | 1.626 | 1.024 | 149 | 149 | 0 | 100-200 C. | 19.5 |
| TiCl2_6H2O_S3 | TiCl2_12H2O_S1 | 1.533 | 1.156 | 169 | 169 | 0 | 100-200 C. | 16.8 |
| MoBr4_S18 | MoBr4_9H2O_S1 | 1.787 | 0.701 | −936 | 156 | 1093 | Large | 46.5 |
| | | | | | | | Hysteresis | |
| NaBr1_1H2O_S1 | NaBr1_4H2O_S1 | 1.687 | 0.916 | 77 | 124 | 48 | 100-200 C. | 0.0 |
| TaCl3_2H2O_S1 | TaCl3_9H2O_S2 | 1.716 | 0.860 | 105 | 105 | 0 | 100-200 C. | 11.7 |
| MnF2_2H2O_S3 | MnF2_4H2O_S7 | 1.724 | 0.839 | 201 | 201 | 0 | 200-300 C. | 14.1 |
| SnI2_2H2O_S5 | SnI2_12H2O_S1 | 1.701 | 0.886 | 73 | 127 | 54 | 100-200 C. | 8.7 |
| BaF2_2H2O_S1 | BaF2_8H2O_S1 | 1.736 | 0.813 | 24 | 24 | 0 | <50 C. | 15.0 |
| PbI2 | PbI2_8H2O_S2 | 1.816 | 0.614 | 0 | 90 | 90 | <50 C. | 19.3 |
| YCl3_3H2O_S9 | YCl3_8H2O_S2 | 1.674 | 0.926 | 78 | 210 | 133 | Large | 10.0 |
| | | | | | | | Hysteresis | |
| MnCl2_6H2O_S3 | MnCl2_12H2O_S1 | 1.538 | 1.136 | 171 | 171 | 0 | 100-200 C. | 10.5 |
| WI4_S18 | WI4_8H2O_S1 | 1.838 | 0.527 | 104 | 104 | 0 | 100-200 C. | 0.0 |
| WBr4 | WBr4_9H2O_S1 | 1.809 | 0.618 | −840 | 150 | 990 | Large | 41.9 |
| | | | | | | | Hysteresis | |
| VCl2_7H2O_S1 | VCl2_12H2O_S1 | 1.539 | 1.134 | 252 | 252 | 0 | 200-300 C. | 27.8 |
| NbBr4 | NbBr4_5H2O_S2 | 1.812 | 0.606 | 145 | 145 | 0 | 100-200 C. | 8.3 |
| KCl1_1H2O_S1 | KCl1_4H2O_S1 | 1.526 | 1.151 | 112 | 112 | 0 | 100-200 C. | 5.9 |
| SnCl4_1H2O_S1 | SnCl4_4H2O_S1 | 1.757 | 0.749 | 202 | 343 | 141 | 200-300 C. | 48.8 |
| FeF2_6H2O_S3 | FeF2_12H2O_S1 | 1.615 | 1.018 | 87 | 87 | 0 | 50-100 C. | 13.9 |
| NbF3 | NbF3_2H2O_S2 | 1.805 | 0.620 | −119 | 362 | 481 | Large | 38.2 |
| | | | | | | | Hysteresis | |
| PbCl4 | PbCl4_4H2O_S1 | 1.800 | 0.632 | 178 | 184 | 6 | 100-200 C. | 0.2 |
| CaBr2_2H2O_S3 | CaBr2_6H2O_S1 | 1.740 | 0.781 | 139 | 139 | 0 | 100-200 C. | 11.4 |
| YI3_2H2O_S2 | YI3_7H2O_S2 | 1.795 | 0.642 | 189 | 266 | 77 | 200-300 C. | 19.5 |
| YCl3 | YCl3_3H2O_S9 | 1.699 | 0.861 | 217 | 217 | 0 | 200-300 C. | 0.0 |
| ZrCl4_3H2O_S1 | ZrCl4_8H2O_S1 | 1.674 | 0.908 | 194 | 207 | 13 | 200-300 C. | 0.0 |
| SrI2_2H2O_S7 | SrI2_8H2O_S1 | 1.753 | 0.738 | 74 | 167 | 93 | 100-200 C. | 9.7 |
| CrI3_2H2O_S2 | CrI3_9H2O_S2 | 1.756 | 0.731 | 153 | 153 | 0 | 100-200 C. | 17.3 |
| BaBr2_1H2O_S1 | BaBr2_6H2O_S1 | 1.769 | 0.698 | 106 | 146 | 40 | 100-200 C. | 4.5 |
| SnCl2_4H2O_S2 | SnCl2_12H2O_S1 | 1.579 | 1.059 | 95 | 95 | 0 | 50-100 C. | 0.0 |
| MnI3_S16 | MnI3_6H2O_S3 | 1.802 | 0.603 | 102 | 102 | 0 | 100-200 C. | 0.0 |
| HfBr4_2H2O_S2 | HfBr4_10H2O_S1 | 1.802 | 0.597 | −296 | 210 | 506 | Large | 29.6 |
| | | | | | | | Hysteresis | |
| WCl4_3H2O_S1 | WCl4_8H2O_S1 | 1.746 | 0.740 | 203 | 203 | 0 | 200-300 C. | 22.5 |
| AlI3_4H2O_S2 | AlI3_9H2O_S2 | 1.744 | 0.743 | 142 | 554 | 412 | Large | 33.1 |
| | | | | | | | Hysteresis | |
| MnBr2_1H2O_S2 | MnBr2_4H2O_S3 | 1.772 | 0.673 | 168 | 168 | 0 | 100-200 C. | 4.8 |
| GaBr3_3H2O_S4 | GaBr3_9H2O_S2 | 1.709 | 0.820 | 169 | 169 | 0 | 100-200 C. | 12.6 |
| MoBr4_S18 | MoBr4_5H2O_S2 | 1.802 | 0.588 | 134 | 134 | 0 | 100-200 C. | 8.4 |
| TiF2_1H2O_S2 | TiF2_4H2O_S7 | 1.689 | 0.859 | 37 | 37 | 0 | <50 C. | 17.7 |
| VCl3_4H2O_S2 | VCl3_9H2O_S2 | 1.571 | 1.059 | 179 | 208 | 29 | 100-200 C. | 3.0 |
| ZnCl2_6H2O_S3 | ZnCl2_12H2O_S1 | 1.550 | 1.085 | 163 | 163 | 0 | 100-200 C. | 10.6 |
| SiCl4 | SiCl4_4H2O_S1 | 1.678 | 0.874 | 89 | 89 | 0 | 50-100 C. | 20.1 |
| TiI2_S16 | TiI2_4H2O_S3 | 1.796 | 0.594 | 107 | 107 | 0 | 100-200 C. | 16.4 |
| CrCl2_7H2O_S1 | CrCl2_12H2O_S1 | 1.523 | 1.122 | 248 | 248 | 0 | 200-300 C. | 39.9 |
| TaCl4_3H2O_S1 | TaCl4_8H2O_S1 | 1.736 | 0.749 | 206 | 206 | 0 | 200-300 C. | 17.9 |
| YF3 | YF3_3H2O_S8 | 1.731 | 0.756 | 72 | 72 | 0 | 50-100 C. | 14.3 |
| ZrBr4_S31 | ZrBr4_4H2O_S1 | 1.793 | 0.595 | 193 | 239 | 46 | 200-300 C. | 0.0 |
| NbCl3_S22 | NbCl3_4H2O_S2 | 1.720 | 0.780 | 89 | 89 | 0 | 50-100 C. | 12.1 |
| TiI4 | TiI4_9H2O_S1 | 1.776 | 0.642 | −509 | 151 | 660 | Large | 26.3 |
| | | | | | | | Hysteresis | |
| CoI2 | CoI2_4H2O_S3 | 1.806 | 0.550 | 89 | 89 | 0 | 50-100 C. | 7.9 |
| NbF4 | NbF4_2H2O_S2 | 1.784 | 0.617 | 160 | 160 | 0 | 100-200 C. | 12.6 |
| BaBr2_1H2O_S1 | BaBr2_7H2O_S1 | 1.744 | 0.720 | 61 | 146 | 86 | 100-200 C. | 19.3 |
| AlI3 | AlI3_3H2O_S3 | 1.809 | 0.536 | 292 | 292 | 0 | 200-300 C. | 30.6 |
| SrI2_4H2O_S4 | SrI2_12H2O_S1 | 1.642 | 0.930 | 160 | 203 | 43 | 100-200 C. | 7.3 |
| NbI4 | NbI4_9H2O_S1 | 1.791 | 0.592 | −442 | 135 | 577 | Large | 23.1 |
| | | | | | | | Hysteresis | |
| PbI2_2H2O_S5 | PbI2_12H2O_S1 | 1.712 | 0.792 | 86 | 126 | 40 | 100-200 C. | 12.2 |
| BaI2_1H2O_S1 | BaI2_8H2O_S1 | 1.749 | 0.704 | 89 | 135 | 46 | 100-200 C. | 12.8 |
| MoF2_1H2O_S2 | MoF2_8H2O_S2 | 1.686 | 0.841 | −44 | −44 | 0 | <50 C. | 35.7 |
| FeF2_2H2O_S7 | FeF2_4H2O_S7 | 1.704 | 0.802 | 183 | 183 | 0 | 100-200 C. | 1.6 |
| LaF3_4H2O_S1 | LaF3_9H2O_S2 | 1.645 | 0.917 | 177 | 177 | 0 | 100-200 C. | 46.6 |
| MnCl3_S25 | MnCl3_3H2O_S8 | 1.680 | 0.848 | 144 | 144 | 0 | 100-200 C. | 4.5 |
| MnBr3_2H2O_S2 | MnBr3_6H2O_S3 | 1.749 | 0.693 | 205 | 205 | 0 | 200-300 C. | 41.2 |
| BaI2_2H2O_S9 | BaI2_9H2O_S1 | 1.742 | 0.710 | 111 | 111 | 0 | 100-200 C. | 5.5 |
| FeI2 | FeI2_7H2O_S1 | 1.746 | 0.698 | −105 | 122 | 227 | Large | 40.6 |
| | | | | | | | Hysteresis | |
| NiF3_3H2O_S9 | NiF3_6H2O_S2 | 1.684 | 0.832 | 152 | 152 | 0 | 100-200 C. | 4.5 |
| NiCl3_4H2O_S2 | NiCl3_9H2O_S1 | 1.622 | 0.943 | 57 | 288 | 231 | Large | 33.9 |
| | | | | | | | Hysteresis | |
| HfF4 | HfF4_2H2O_S1 | 1.825 | 0.429 | 154 | 154 | 0 | 100-200 C. | 11.6 |
| ZrBr2_1H2O_S2 | ZrBr2_9H2O_S2 | 1.699 | 0.790 | 7 | 7 | 0 | <50 C. | 24.6 |
| ZnI2_4H2O_S2 | ZnI2_12H2O_S1 | 1.659 | 0.872 | 126 | 126 | 0 | 100-200 C. | 1.9 |
| SnCl4_3H2O_S1 | SnCl4_8H2O_S1 | 1.674 | 0.841 | 191 | 202 | 10 | 100-200 C. | 0.0 |
| BaBr2_4H2O_S1 | BaBr2_12H2O_S1 | 1.611 | 0.955 | 147 | 147 | 0 | 100-200 C. | 20.0 |
| SnBr4 | SnBr4_5H2O_S2 | 1.778 | 0.575 | 143 | 143 | 0 | 100-200 C. | 0.0 |
| CaCl2 | CaCl2_2H2O_S2 | 1.642 | 0.892 | 165 | 187 | 22 | 100-200 C. | 0.9 |
| NiI2 | NiI2_4H2O_S3 | 1.789 | 0.539 | 82 | 82 | 0 | 50-100 C. | 5.6 |
| TaCl4 | TaCl4_4H2O_S1 | 1.762 | 0.620 | 146 | 146 | 0 | 100-200 C. | 9.4 |
| CoCl2_6H2O_S3 | CoCl2_12H2O_S1 | 1.527 | 1.075 | 152 | 152 | 0 | 100-200 C. | 6.2 |
| TaI3_S15 | TaI3_9H2O_S2 | 1.752 | 0.646 | 35 | 106 | 71 | Large | 1.7 |
| | | | | | | | Hysteresis | |
| NiCl2_6H2O_S3 | NiCl2_12H2O_S1 | 1.534 | 1.065 | 147 | 147 | 0 | 100-200 C. | 7.5 |
| ZrBr4_2H2O_S2 | ZrBr4_10H2O_S1 | 1.743 | 0.668 | −309 | 207 | 515 | Large | 30.7 |
| | | | | | | | Hysteresis | |
| KI1 | KI1_4H2O_S1 | 1.650 | 0.869 | 81 | 81 | 0 | 50-100 C. | 0.0 |
| TiCl2 | TiCl2_1H2O_S2 | 1.751 | 0.642 | 329 | 329 | 0 | 300-450 C. | 0.0 |
| CaI2_2H2O_S8 | CaI2_7H2O_S1 | 1.718 | 0.723 | 143 | 143 | 0 | 100-200 C. | 12.0 |
| TaBr3_1H2O_S2 | TaBr3_6H2O_S3 | 1.779 | 0.553 | 127 | 127 | 0 | 100-200 C. | 23.3 |
| SiBr4_3H2O_S1 | SiBr4_8H2O_S1 | 1.718 | 0.716 | 210 | 210 | 0 | 200-300 C. | 39.1 |
| CoI2_4H2O_S3 | CoI2_12H2O_S1 | 1.647 | 0.864 | 118 | 118 | 0 | 100-200 C. | 7.9 |
| LaF3_3H2O_S2 | LaF3_9H2O_S2 | 1.625 | 0.906 | 97 | 97 | 0 | 50-100 C. | 13.4 |
| SiCl4_4H2O_S1 | SiCl4_9H2O_S1 | 1.577 | 0.985 | 68 | 202 | 134 | Large | 20.1 |
| | | | | | | | Hysteresis | |
| NiF2 | NiF2_1H2O_S2 | 1.780 | 0.538 | 150 | 150 | 0 | 100-200 C. | 16.9 |
| ZrCl3 | ZrCl3_4H2O_S2 | 1.680 | 0.796 | 95 | 95 | 0 | 50-100 C. | 22.0 |
| TaI3_S15 | TaI3_8H2O_S2 | 1.773 | 0.556 | −68 | 106 | 174 | Large | 12.4 |
| | | | | | | | Hysteresis | |
| HfCl4_3H2O_S1 | HfCl4_8H2O_S1 | 1.701 | 0.745 | 199 | 212 | 14 | 200-300 C. | 0.0 |
| CrI2_4H2O_S3 | CrI2_12H2O_S1 | 1.627 | 0.895 | 127 | 127 | 0 | 100-200 C. | 0.0 |
| FeCl3_3H2O_S8 | FeCl3_9H2O_S2 | 1.566 | 0.993 | 95 | 95 | 0 | 50-100 C. | 0.0 |
| GeI2 | GeI2_8H2O_S1 | 1.709 | 0.719 | −53 | 87 | 140 | <50 C. | 26.0 |
| TaBr4_S18 | TaBr4_5H2O_S2 | 1.784 | 0.504 | 135 | 135 | 0 | 100-200 C. | 10.2 |
| MoCl3 | MoCl3_4H2O_S2 | 1.694 | 0.753 | −14 | 175 | 189 | Large | 27.4 |
| | | | | | | | Hysteresis | |
| LaBr3_2H2O_S1 | LaBr3_9H2O_S2 | 1.659 | 0.826 | 92 | 218 | 125 | Large | 14.5 |
| | | | | | | | Hysteresis | |
| FeBr2_4H2O_S3 | FeBr2_12H2O_S1 | 1.608 | 0.919 | 1 | 106 | 105 | Large | 5.4 |
| | | | | | | | Hysteresis | |
| ZrF4_3H2O_S2 | ZrF4_8H2O_S1 | 1.623 | 0.892 | 108 | 108 | 0 | 100-200 C. | 0.0 |
| HfF4_3H2O_S2 | HfF4_8H2O_S1 | 1.702 | 0.729 | 125 | 125 | 0 | 100-200 C. | 0.0 |
| NbBr3_2H2O_S2 | NbBr3_6H2O_S3 | 1.731 | 0.647 | 215 | 215 | 0 | 200-300 C. | 48.5 |
| TaI3_S15 | TaI3_6H2O_S3 | 1.780 | 0.496 | 106 | 106 | 0 | 100-200 C. | 0.0 |
| ZrCl2_1H2O_S2 | ZrCl2_9H2O_S2 | 1.614 | 0.896 | −24 | −24 | 0 | <50 C. | 32.7 |
| SrCl2_2H2O_S4 | SrCl2_6H2O_S1 | 1.645 | 0.839 | 110 | 110 | 0 | 100-200 C. | 8.8 |
| HfCl4_3H2O_S1 | HfCl4_9H2O_S1 | 1.699 | 0.719 | −268 | 212 | 480 | Large | 14.9 |
| | | | | | | | Hysteresis | |
| MnCl2 | MnCl2_2H2O_S8 | 1.674 | 0.775 | 139 | 174 | 35 | 100-200 C. | 3.2 |
| SnCl2_1H2O_S2 | SnCl2_4H2O_S2 | 1.677 | 0.767 | 129 | 298 | 169 | 200-300 C. | 32.5 |
| ZrBr2_S17 | ZrBr2_8H2O_S3 | 1.673 | 0.776 | −31 | 130 | 161 | Large | 38.6 |
| | | | | | | | Hysteresis | |
| ScI3_S9 | ScI3_4H2O_S2 | 1.752 | 0.573 | 216 | 216 | 0 | 200-300 C. | 13.4 |
| PbCl2_4H2O_S3 | PbCl2_12H2O_S1 | 1.610 | 0.895 | 106 | 106 | 0 | 100-200 C. | 0.0 |
| ScBr3_S25 | ScBr3_3H2O_S9 | 1.720 | 0.660 | 237 | 237 | 0 | 200-300 C. | 2.0 |
| YI3_3H2O_S9 | YI3_9H2O_S3 | 1.719 | 0.658 | 100 | 247 | 147 | Large | 4.7 |
| | | | | | | | Hysteresis | |
| NiCl2_7H2O_S1 | NiCl2_12H2O_S1 | 1.509 | 1.047 | 223 | 223 | 0 | 200-300 C. | 29.3 |
| LaCl3 | LaCl3_4H2O_S1 | 1.707 | 0.677 | 95 | 95 | 0 | 50-100 C. | 28.4 |
| SrCl2 | SrCl2_2H2O_S4 | 1.710 | 0.667 | 172 | 172 | 0 | 100-200 C. | 0.0 |
| ZrCl4_3H2O_S1 | ZrCl4_9H2O_S1 | 1.642 | 0.820 | −399 | 207 | 606 | Large | 21.1 |
| | | | | | | | Hysteresis | |
| PbBr2_2H2O_S5 | PbBr2_9H2O_S1 | 1.722 | 0.634 | 25 | 132 | 107 | Large | 18.1 |
| | | | | | | | Hysteresis | |
| MnBr4_S31 | MnBr4_4H2O_S1 | 1.743 | 0.574 | 166 | 166 | 0 | 100-200 C. | 1.7 |
| CuBr2_4H2O_S3 | CuBr2_12H2O_S1 | 1.586 | 0.921 | 74 | 74 | 0 | 50-100 C. | 0.0 |
| YBr3_3H2O_S9 | YBr3_9H2O_S2 | 1.627 | 0.846 | 166 | 236 | 70 | 200-300 C. | 3.2 |
| TiCl4 | TiCl4_3H2O_S1 | 1.638 | 0.823 | 185 | 185 | 0 | 100-200 C. | 0.9 |
| AlI3_3H2O_S3 | AlI3_6H2O_S1 | 1.721 | 0.628 | 467 | 467 | 0 | 450-600 C. | 30.6 |
| HfCl3_S28 | HfCl3_4H2O_S2 | 1.728 | 0.607 | 98 | 98 | 0 | 50-100 C. | 46.5 |
| SrF2_6H2O_S1 | SrF2_12H2O_S1 | 1.520 | 1.020 | 125 | 125 | 0 | 100-200 C. | 17.0 |
| MoCl4 | MoCl4_3H2O_S1 | 1.686 | 0.710 | 200 | 200 | 0 | 200-300 C. | 2.0 |
| CuCl2_7H2O_S1 | CuCl2_12H2O_S1 | 1.505 | 1.039 | 226 | 226 | 0 | 200-300 C. | 43.1 |
| CrCl2_6H2O_S3 | CrCl2_12H2O_S1 | 1.470 | 1.083 | 146 | 146 | 0 | 100-200 C. | 10.6 |
| ZrCl2_6H2O_S3 | ZrCl2_12H2O_S1 | 1.509 | 1.025 | 170 | 170 | 0 | 100-200 C. | 48.8 |
| SnF2_6H2O_S3 | SnF2_12H2O_S1 | 1.560 | 0.944 | 129 | 129 | 0 | 100-200 C. | 24.0 |
| CoF3_3H2O_S9 | CoF3_7H2O_S1 | 1.643 | 0.792 | 55 | 55 | 0 | 50-100 C. | 35.7 |
| KF1 | KF1_1H2O_S2 | 1.625 | 0.827 | 158 | 158 | 0 | 100-200 C. | 5.3 |
| FeCl2_4H2O_S3 | FeCl2_9H2O_S2 | 1.559 | 0.945 | 101 | 101 | 0 | 100-200 C. | 0.0 |
| VBr2_4H2O_S3 | VBr2_9H2O_S2 | 1.631 | 0.813 | 142 | 142 | 0 | 100-200 C. | 6.2 |
| MoCl4_1H2O_S1 | MoCl4_4H2O_S1 | 1.666 | 0.739 | 250 | 250 | 0 | 200-300 C. | 24.8 |
| GeCl2_S21 | GeCl2_2H2O_S5 | 1.670 | 0.730 | 176 | 176 | 0 | 100-200 C. | 0.0 |
| FeBr3_1H2O_S2 | FeBr3_6H2O_S3 | 1.707 | 0.637 | 79 | 79 | 0 | 50-100 C. | 1.2 |
| GeF2_2H2O_S5 | GeF2_8H2O_S2 | 1.581 | 0.905 | −60 | 92 | 152 | <50 C. | 28.0 |
| FeI3_S3 | FeI3_9H2O_S2 | 1.685 | 0.684 | 22 | 73 | 51 | <50 C. | 7.4 |
| SiCl2_4H2O_S8 | SiCl2_8H2O_S1 | 1.469 | 1.072 | 173 | 173 | 0 | 100-200 C. | 34.6 |
| WCl4 | WCl4_4H2O_S1 | 1.717 | 0.592 | 130 | 130 | 0 | 100-200 C. | 11.1 |
| TaCl3_3H2O_S9 | TaCl3_9H2O_S2 | 1.622 | 0.813 | 144 | 144 | 0 | 100-200 C. | 34.9 |
| SnBr2_2H2O_S5 | SnBr2_9H2O_S1 | 1.663 | 0.725 | 7 | 120 | 113 | Large | 20.7 |
| | | | | | | | Hysteresis | |
| SnCl2_2H2O_S5 | SnCl2_9H2O_S2 | 1.592 | 0.869 | −15 | 129 | 144 | Large | 27.7 |
| | | | | | | | Hysteresis | |
| CuF2_4H2O_S7 | CuF2_9H2O_S1 | 1.590 | 0.870 | 41 | 41 | 0 | <50 C. | 17.2 |
| CaI2_2H2O_S8 | CaI2_8H2O_S2 | 1.606 | 0.840 | 147 | 147 | 0 | 100-200 C. | 11.5 |
| KCl1 | KCl1_3H2O_S1 | 1.533 | 0.965 | 10 | 10 | 0 | <50 C. | 39.4 |
| SiF4_4H2O_S1 | SiF4_8H2O_S1 | 1.536 | 0.959 | 103 | 229 | 125 | 100-200 C. | 1.7 |
| SiF4_1H2O_S1 | SiF4_2H2O_S1 | 1.668 | 0.704 | 402 | 402 | 0 | 300-450 C. | 35.6 |
| MnBr2_7H2O_S1 | MnBr2_12H2O_S1 | 1.536 | 0.956 | 291 | 291 | 0 | 200-300 C. | 46.2 |
| PbF4_2H2O_S2 | PbF4_5H2O_S2 | 1.718 | 0.565 | 188 | 248 | 60 | 200-300 C. | 0.0 |
| NiBr3_S25 | NiBr3_7H2O_S1 | 1.658 | 0.719 | −320 | 83 | 404 | <50 C. | 22.2 |
| BaI2 | BaI2_4H2O_S6 | 1.728 | 0.531 | 116 | 226 | 110 | 100-200 C. | 2.3 |
| SnI4 | SnI4_4H2O_S1 | 1.743 | 0.473 | 93 | 634 | 541 | Large | 0.4 |
| | | | | | | | Hysteresis | |
| VF4_4H2O_S1 | VF4_8H2O_S1 | 1.543 | 0.934 | 129 | 254 | 125 | 100-200 C. | 5.9 |
| SnCl4 | SnCl4_3H2O_S1 | 1.671 | 0.678 | 214 | 214 | 0 | 200-300 C. | 0.0 |
| SrCl2_2H2O_S4 | SrCl2_7H2O_S1 | 1.586 | 0.859 | 62 | 62 | 0 | 50-100 C. | 24.8 |
| ZrBr2_S17 | ZrBr2_7H2O_S1 | 1.664 | 0.694 | −41 | 130 | 172 | Large | 41.2 |
| | | | | | | | Hysteresis | |
| LaCl3 | LaCl3_3H2O_S2 | 1.685 | 0.639 | 164 | 164 | 0 | 100-200 C. | 2.1 |
| FeBr3_1H2O_S2 | FeBr3_8H2O_S2 | 1.656 | 0.712 | 33 | 33 | 0 | <50 C. | 18.6 |
| GaI3 | GaI3_8H2O_S2 | 1.695 | 0.606 | 18 | 153 | 135 | Large | 35.8 |
| | | | | | | | Hysteresis | |
| GaBr3_4H2O_S2 | GaBr3_9H2O_S2 | 1.622 | 0.779 | 230 | 230 | 0 | 200-300 C. | 37.5 |
| YCl3_4H2O_S2 | YCl3_9H2O_S2 | 1.499 | 0.994 | 171 | 278 | 108 | 200-300 C. | 12.8 |
| GeCl2_2H2O_S5 | GeCl2_8H2O_S1 | 1.567 | 0.882 | −49 | 149 | 198 | Large | 30.3 |
| | | | | | | | Hysteresis | |
| WBr4 | WBr4_5H2O_S2 | 1.731 | 0.484 | 120 | 120 | 0 | 100-200 C. | 11.2 |
| NiI2_4H2O_S3 | NiI2_12H2O_S1 | 1.593 | 0.830 | 103 | 103 | 0 | 100-200 C. | 5.6 |
| NiBr3_S25 | NiBr3_8H2O_S2 | 1.650 | 0.710 | −267 | 83 | 351 | <50 C. | 33.9 |
| ScI3_3H2O_S9 | ScI3_9H2O_S2 | 1.640 | 0.733 | 170 | 268 | 98 | 200-300 C. | 5.8 |
| NbF4_4H2O_S1 | NbF4_8H2O_S1 | 1.577 | 0.859 | 143 | 320 | 176 | Large | 10.1 |
| | | | | | | | Hysteresis | |
| MnF4_4H2O_S1 | MnF4_9H2O_S1 | 1.584 | 0.845 | −228 | 215 | 442 | Large | 13.0 |
| | | | | | | | Hysteresis | |
| CuF1_1H2O_S2 | CuF1_3H2O_S1 | 1.643 | 0.725 | 22 | 111 | 89 | Large | 3.5 |
| | | | | | | | Hysteresis | |
| CaBr2_6H2O_S1 | CaBr2_12H2O_S1 | 1.486 | 1.006 | 205 | 205 | 0 | 200-300 C. | 11.4 |
| HfI4 | HfI4_5H2O_S2 | 1.740 | 0.439 | 142 | 271 | 129 | 200-300 C. | 5.9 |
| CaCl2_4H2O_S7 | CaCl2_9H2O_S2 | 1.477 | 1.017 | 107 | 107 | 0 | 100-200 C. | 15.4 |
| LiBr1_1H2O_S1 | LiBr1_3H2O_S1 | 1.592 | 0.826 | 71 | 180 | 108 | 100-200 C. | 0.0 |
| TaBr3_2H2O_S1 | TaBr3_9H2O_S2 | 1.655 | 0.691 | 88 | 145 | 57 | 100-200 C. | 24.1 |
| NaI1 | NaI1_2H2O_S3 | 1.668 | 0.658 | 146 | 146 | 0 | 100-200 C. | 0.0 |
| ZrBr3_3H2O_S9 | ZrBr3_9H2O_S2 | 1.598 | 0.811 | 183 | 183 | 0 | 100-200 C. | 23.3 |
| SrF2_2H2O_S1 | SrF2_6H2O_S1 | 1.626 | 0.748 | 26 | 26 | 0 | <50 C. | 17.0 |
| CoCl2 | CoCl2_2H2O_S3 | 1.661 | 0.661 | 103 | 103 | 0 | 100-200 C. | 11.7 |
| NiI2 | NiI2_7H2O_S1 | 1.658 | 0.664 | 12 | 12 | 0 | <50 C. | 37.0 |
| SrBr2_2H2O_S4 | SrBr2_7H2O_S1 | 1.632 | 0.724 | 97 | 97 | 0 | 50-100 C. | 17.7 |
| ScF3 | ScF3_2H2O_S2 | 1.630 | 0.727 | 71 | 71 | 0 | 50-100 C. | 16.6 |
| ScBr3_4H2O_S2 | ScBr3_9H2O_S2 | 1.575 | 0.837 | 193 | 309 | 117 | Large | 12.5 |
| | | | | | | | Hysteresis | |
| CrF4_4H2O_S1 | CrF4_8H2O_S1 | 1.536 | 0.904 | 121 | 231 | 111 | 100-200 C. | 2.4 |
| CuCl2_6H2O_S3 | CuCl2_12H2O_S1 | 1.467 | 1.013 | 132 | 132 | 0 | 100-200 C. | 18.6 |
| CaBr2_1H2O_S2 | CaBr2_4H2O_S3 | 1.630 | 0.718 | 170 | 179 | 9 | 100-200 C. | 1.7 |
| SrBr2_2H2O_S4 | SrBr2_6H2O_S1 | 1.644 | 0.679 | 141 | 141 | 0 | 100-200 C. | 3.7 |
| SiBr4 | SiBr4_5H2O_S2 | 1.676 | 0.592 | 82 | 82 | 0 | 50-100 C. | 20.9 |
| BaI2_1H2O_S1 | BaI2_7H2O_S1 | 1.665 | 0.623 | 87 | 135 | 48 | 100-200 C. | 12.7 |
| SrF2_2H2O_S1 | SrF2_7H2O_S1 | 1.584 | 0.799 | 2 | 2 | 0 | <50 C. | 26.2 |
| MoCl3_4H2O_S2 | MoCl3_9H2O_S2 | 1.514 | 0.925 | 189 | 189 | 0 | 100-200 C. | 27.4 |
| VBr2_6H2O_S3 | VBr2_12H2O_S1 | 1.508 | 0.933 | 181 | 181 | 0 | 100-200 C. | 6.3 |
| ScCl3_1H2O_S2 | ScCl3_3H2O_S9 | 1.546 | 0.869 | 338 | 338 | 0 | 300-450 C. | 42.2 |
| 3-Feb | FeBr3_4H2O_S1 | 1.667 | 0.602 | 39 | 306 | 266 | Large | 12.3 |
| | | | | | | | Hysteresis | |
| CoCl3_S22 | CoCl3_4H2O_S2 | 1.598 | 0.767 | 39 | 39 | 0 | <50 C. | 32.0 |
| MoI3 | MoI3_6H2O_S3 | 1.690 | 0.530 | 81 | 81 | 0 | 50-100 C. | 0.8 |
| MgF2_8H2O_S2 | MgF2_12H2O_S1 | 1.431 | 1.042 | 224 | 224 | 0 | 200-300 C. | 24.1 |
| ZrF4 | ZrF4_2H2O_S1 | 1.675 | 0.574 | 126 | 126 | 0 | 100-200 C. | 17.2 |
| GeBr2_1H2O_S2 | GeBr2_4H2O_S2 | 1.645 | 0.643 | 174 | 174 | 0 | 100-200 C. | 27.5 |
| ZrCl3_4H2O_S2 | ZrCl3_9H2O_S2 | 1.483 | 0.958 | 199 | 199 | 0 | 100-200 C. | 22.0 |
| TaF4_S5 | TaF4_2H2O_S1 | 1.719 | 0.401 | 130 | 130 | 0 | 100-200 C. | 20.3 |
| CoI3_S25 | CoI3_10H2O_S2 | 1.632 | 0.670 | 12 | 12 | 0 | <50 C. | 15.7 |
| SnI4 | SnI4_9H2O_S1 | 1.664 | 0.579 | −150 | 634 | 783 | Large | 37.2 |
| | | | | | | | Hysteresis | |
| BaCl2_2H2O_S4 | BaCl2_8H2O_S1 | 1.576 | 0.789 | 44 | 44 | 0 | <50 C. | 23.0 |
| BeI2_2H2O_S9 | BeI2_4H2O_S8 | 1.648 | 0.625 | 443 | 443 | 0 | 300-450 C. | 0.0 |
| MnCl2_4H2O_S3 | MnCl2_9H2O_S2 | 1.499 | 0.923 | 91 | 91 | 0 | 50-100 C. | 14.0 |
| MnF4_4H2O_S1 | MnF4_8H2O_S1 | 1.526 | 0.877 | 115 | 215 | 100 | 100-200 C. | 0.0 |
| BeI2_4H2O_S8 | BeI2_12H2O_S1 | 1.540 | 0.852 | 54 | 99 | 44 | 50-100 C. | 0.0 |
| TiF4_4H2O_S1 | TiF4_8H2O_S1 | 1.496 | 0.926 | 121 | 243 | 122 | 100-200 C. | 3.1 |
| YI3_2H2O_S2 | YI3_6H2O_S2 | 1.671 | 0.545 | 266 | 266 | 0 | 200-300 C. | 19.5 |
| FeCl3 | FeCl3_2H2O_S1 | 1.582 | 0.762 | 151 | 337 | 186 | Large | 0.5 |
| | | | | | | | Hysteresis | |
| GeBr2_4H2O_S2 | GeBr2_12H2O_S1 | 1.489 | 0.922 | 81 | 81 | 0 | 50-100 C. | 0.0 |
| ScI3_2H2O_S2 | ScI3_6H2O_S1 | 1.640 | 0.610 | 285 | 285 | 0 | 200-300 C. | 20.3 |
| LaI3_3H2O_S4 | LaI3_9H2O_S3 | 1.640 | 0.611 | 141 | 263 | 121 | 200-300 C. | 19.2 |
| SiCl2 | SiCl2_4H2O_S8 | 1.477 | 0.938 | 2 | 2 | 0 | <50 C. | 34.6 |
| GeF2_7H2O_S1 | GeF2_12H2O_S1 | 1.459 | 0.964 | 159 | 159 | 0 | 100-200 C. | 29.8 |
| GaBr3_2H2O_S1 | GaBr3_8H2O_S2 | 1.608 | 0.682 | 80 | 80 | 0 | 50-100 C. | 22.8 |
| TaI3_S15 | TaI3_7H2O_S2 | 1.675 | 0.493 | −227 | 106 | 334 | Large | 16.6 |
| | | | | | | | Hysteresis | |
| TiBr4 | TiBr4_4H2O_S1 | 1.649 | 0.570 | 156 | 156 | 0 | 100-200 C. | 4.4 |
| CoBr3_3H2O_S9 | CoBr3_9H2O_S2 | 1.580 | 0.741 | 73 | 160 | 88 | 100-200 C. | 24.7 |
| SrI2 | SrI2_4H2O_S4 | 1.636 | 0.605 | 131 | 187 | 56 | 100-200 C. | 7.3 |
| NiF2_4H2O_S4 | NiF2_9H2O_S2 | 1.526 | 0.846 | 27 | 27 | 0 | <50 C. | 24.5 |
| HfI4_2H2O_S1 | HfI4_9H2O_S1 | 1.674 | 0.489 | −77 | 168 | 245 | Large | 5.9 |
| | | | | | | | Hysteresis | |
| TiBr3 | TiBr3_3H2O_S9 | 1.636 | 0.602 | 197 | 197 | 0 | 100-200 C. | 1.6 |
| HfI4_2H2O_S1 | HfI4_10H2O_S1 | 1.671 | 0.494 | −129 | 168 | 297 | Large | 15.2 |
| | | | | | | | Hysteresis | |
| LaBr3_2H2O_S1 | LaBr3_6H2O_S2 | 1.640 | 0.589 | 218 | 218 | 0 | 200-300 C. | 14.5 |
| LaF3 | LaF3_3H2O_S2 | 1.654 | 0.548 | 40 | 40 | 0 | <50 C. | 13.4 |
| GeI2 | GeI2_6H2O_S3 | 1.628 | 0.617 | −74 | 87 | 161 | <50 C. | 19.8 |
| VCl4 | VCl4_3H2O_S1 | 1.568 | 0.754 | 152 | 152 | 0 | 100-200 C. | 7.8 |
| MoBr3_3H2O_S9 | MoBr3_9H2O_S2 | 1.568 | 0.748 | 152 | 152 | 0 | 100-200 C. | 19.8 |
| LaCl1 | LaCl1_4H2O_S1 | 1.629 | 0.602 | −19 | −19 | 0 | <50 C. | 28.4 |
| FeBr3_1H2O_S2 | FeBr3_10H2O_S2 | 1.571 | 0.741 | −703 | 83 | 785 | <50 C. | 33.4 |
| ScF3_3H2O_S8 | ScF3_10H2O_S2 | 1.518 | 0.843 | −1022 | 123 | 1145 | Large | 47.6 |
| | | | | | | | Hysteresis | |
| MgCl2_4H2O_S7 | MgCl2_8H2O_S2 | 1.399 | 1.023 | 146 | 146 | 0 | 100-200 C. | 10.6 |
| GeF4_4H2O_S1 | GeF4_8H2O_S1 | 1.524 | 0.826 | 110 | 234 | 125 | 100-200 C. | 1.0 |
| TiBr2_7H2O_S1 | TiBr2_12H2O_S1 | 1.466 | 0.923 | 263 | 263 | 0 | 200-300 C. | 36.6 |
| HfCl3_4H2O_S2 | HfCl3_9H2O_S2 | 1.542 | 0.790 | 211 | 211 | 0 | 200-300 C. | 46.5 |
| MnI3_1H2O_S3 | MnI3_6H2O_S3 | 1.642 | 0.550 | 137 | 137 | 0 | 100-200 C. | 38.0 |
| CrBr4_3H2O_S1 | CrBr4_8H2O_S1 | 1.609 | 0.640 | 179 | 179 | 0 | 100-200 C. | 12.5 |
| MnCl3_4H2O_S2 | MnCl3_9H2O_S2 | 1.453 | 0.940 | 73 | 249 | 176 | Large | 17.5 |
| | | | | | | | Hysteresis | |
| CrBr3_4H2O_S2 | CrBr3_9H2O_S2 | 1.550 | 0.771 | 206 | 206 | 0 | 200-300 C. | 15.4 |
| ScCl3_3H2O_S9 | ScCl3_7H2O_S2 | 1.501 | 0.862 | 136 | 136 | 0 | 100-200 C. | 19.1 |
| CrI2_1H2O_S2 | CrI2_4H2O_S3 | 1.647 | 0.532 | 186 | 186 | 0 | 100-200 C. | 22.1 |
| FeCl2 | FeCl2_2H2O_S8 | 1.584 | 0.693 | 113 | 113 | 0 | 100-200 C. | 7.9 |
| NiCl2 | NiCl2_2H2O_S5 | 1.620 | 0.602 | 69 | 69 | 0 | 50-100 C. | 20.6 |
| CuCl1 | CuCl1_4H2O_S1 | 1.535 | 0.793 | −41 | −41 | 0 | <50 C. | 37.8 |
| TaF4_4H2O_S1 | TaF4_8H2O_S1 | 1.590 | 0.677 | 151 | 316 | 165 | Large | 10.1 |
| | | | | | | | Hysteresis | |
| CoCl3_S22 | CoCl3_3H2O_S9 | 1.575 | 0.710 | 82 | 82 | 0 | 50-100 C. | 14.2 |
| CrF2_4H2O_S7 | CrF2_9H2O_S1 | 1.491 | 0.873 | 28 | 28 | 0 | <50 C. | 21.3 |
| SrI2_2H2O_S7 | SrI2_7H2O_S1 | 1.604 | 0.638 | 9 | 167 | 158 | Large | 9.5 |
| | | | | | | | Hysteresis | |
| BaI2_1H2O_S1 | BaI2_6H2O_S1 | 1.624 | 0.584 | 125 | 135 | 10 | 100-200 C. | 0.7 |
| CrF2_2H2O_S4 | CrF2_4H2O_S7 | 1.540 | 0.775 | 157 | 157 | 0 | 100-200 C. | 4.7 |
| PbCl4_3H2O_S1 | PbCl4_8H2O_S1 | 1.586 | 0.671 | 180 | 180 | 0 | 100-200 C. | 0.0 |
| CrCl2_4H2O_S3 | CrCl2_9H2O_S2 | 1.466 | 0.897 | 77 | 77 | 0 | 50-100 C. | 11.2 |
| FeCl3_4H2O_S1 | FeCl3_9H2O_S2 | 1.451 | 0.920 | 136 | 136 | 0 | 100-200 C. | 19.4 |
| NiBr3_2H2O_S2 | NiBr3_6H2O_S3 | 1.609 | 0.603 | 146 | 146 | 0 | 100-200 C. | 38.1 |
| MoF4_4H2O_S1 | MoF4_8H2O_S1 | 1.522 | 0.794 | 128 | 244 | 116 | 100-200 C. | 1.2 |
| NiCl3_S25 | NiCl3_3H2O_S8 | 1.563 | 0.709 | 82 | 82 | 0 | 50-100 C. | 9.6 |
| CrCl4_S19 | CrCl4_3H2O_S1 | 1.555 | 0.727 | 138 | 138 | 0 | 100-200 C. | 9.5 |
| KCl1 | KCl1_2H2O_S1 | 1.413 | 0.972 | 95 | 95 | 0 | 50-100 C. | 4.1 |
| PbF2_6H2O_S1 | PbF2_12H2O_S1 | 1.534 | 0.762 | 128 | 128 | 0 | 100-200 C. | 20.5 |
| TiBr2_6H2O_S3 | TiBr2_12H2O_S1 | 1.450 | 0.912 | 168 | 168 | 0 | 100-200 C. | 9.5 |
| GeCl4 | GeCl4_4H2O_S1 | 1.552 | 0.722 | 81 | 81 | 0 | 50-100 C. | 19.8 |
| SiCl4_4H2O_S1 | SiCl4_8H2O_S1 | 1.466 | 0.883 | 202 | 202 | 0 | 200-300 C. | 20.1 |
| SrCl2_6H2O_S1 | SrCl2_12H2O_S1 | 1.379 | 1.014 | 161 | 161 | 0 | 100-200 C. | 8.8 |
| SnBr2_4H2O_S3 | SnBr2_12H2O_S1 | 1.482 | 0.856 | 90 | 90 | 0 | 50-100 C. | 0.0 |
| GeCl2_6H2O_S3 | GeCl2_12H2O_S1 | 1.384 | 1.005 | 140 | 140 | 0 | 100-200 C. | 23.2 |
| SnI2 | SnI2_6H2O_S3 | 1.607 | 0.583 | −62 | 102 | 164 | Large | 19.5 |
| | | | | | | | Hysteresis | |
| CoF3_6H2O_S1 | CoF3_9H2O_S2 | 1.486 | 0.844 | 263 | 263 | 0 | 200-300 C. | 12.4 |
| CuI2_S15 | CuI2_4H2O_S2 | 1.633 | 0.505 | 64 | 64 | 0 | 50-100 C. | 0.0 |
| MgI2 | MgI2_2H2O_S8 | 1.628 | 0.518 | 284 | 284 | 0 | 200-300 C. | 0.0 |
| SnF2_2H2O_S5 | SnF2_7H2O_S1 | 1.554 | 0.710 | −53 | 84 | 137 | <50 C. | 23.8 |
| YCl3_3H2O_S9 | YCl3_7H2O_S2 | 1.513 | 0.793 | 22 | 210 | 189 | Large | 9.0 |
| | | | | | | | Hysteresis | |
| CoF2_8H2O_S1 | CoF2_12H2O_S1 | 1.434 | 0.927 | 224 | 224 | 0 | 200-300 C. | 23.4 |
| PbCl2_2H2O_S5 | PbCl2_8H2O_S1 | 1.589 | 0.620 | −25 | 127 | 152 | Large | 29.3 |
| | | | | | | | Hysteresis | |
| SnBr4 | SnBr4_9H2O_S1 | 1.595 | 0.602 | −175 | 143 | 319 | Large | 42.0 |
| | | | | | | | Hysteresis | |
| MnI4_2H2O_S1 | MnI4_8H2O_S1 | 1.615 | 0.543 | 165 | 165 | 0 | 100-200 C. | 38.0 |
| CrBr4_S17 | CrBr4_4H2O_S1 | 1.617 | 0.535 | 133 | 133 | 0 | 100-200 C. | 8.1 |
| SnI2 | SnI2_7H2O_S1 | 1.600 | 0.580 | −112 | 102 | 214 | Large | 35.1 |
| | | | | | | | Hysteresis | |
| VBr3_S31 | VBr3_3H2O_S9 | 1.605 | 0.566 | 173 | 173 | 0 | 100-200 C. | 5.7 |
| MoI3 | MoI3_8H2O_S2 | 1.597 | 0.587 | 39 | 39 | 0 | <50 C. | 18.7 |
| VBr4_3H2O_S1 | VBr4_8H2O_S1 | 1.575 | 0.642 | 179 | 179 | 0 | 100-200 C. | 12.6 |
| CoI3_S25 | CoI3_9H2O_S2 | 1.580 | 0.628 | 14 | 14 | 0 | <50 C. | 14.2 |
| MnBr2_6H2O_S3 | MnBr2_12H2O_S1 | 1.443 | 0.898 | 169 | 169 | 0 | 100-200 C. | 10.4 |
| WF4_S20 | WF4_2H2O_S1 | 1.654 | 0.385 | 117 | 117 | 0 | 100-200 C. | 17.6 |
| RbI1 | RbI1_4H2O_S1 | 1.545 | 0.701 | 68 | 68 | 0 | 50-100 C. | 0.0 |
| NiF2_8H2O_S2 | NiF2_12H2O_S1 | 1.430 | 0.911 | 215 | 215 | 0 | 200-300 C. | 20.4 |
| MoI2 | MoI2_12H2O_S1 | 1.514 | 0.764 | −26 | −26 | 0 | <50 C. | 34.1 |
| ZrF4_4H2O_S1 | ZrF4_8H2O_S1 | 1.485 | 0.817 | 162 | 162 | 0 | 100-200 C. | 19.5 |
| TaI4 | TaI4_10H2O_S1 | 1.621 | 0.493 | −424 | 132 | 555 | Large | 40.7 |
| | | | | | | | Hysteresis | |
| CuI2_S15 | CuI2_8H2O_S3 | 1.561 | 0.660 | −88 | 64 | 152 | <50 C. | 30.2 |
| BeF2_4H2O_S8 | BeF2_8H2O_S1 | 1.391 | 0.967 | 44 | 44 | 0 | <50 C. | 1.1 |
| AlCl3_4H2O_S2 | AlCl3_6H2O_S1 | 1.452 | 0.872 | 448 | 448 | 0 | 300-450 C. | 17.8 |
| SrF2_7H2O_S1 | SrF2_12H2O_S1 | 1.406 | 0.943 | 169 | 169 | 0 | 100-200 C. | 26.2 |
| GeCl2_7H2O_S1 | GeCl2_12H2O_S1 | 1.370 | 0.995 | 217 | 217 | 0 | 200-300 C. | 41.3 |
| ZnBr2_6H2O_S3 | ZnBr2_12H2O_S1 | 1.458 | 0.860 | 160 | 160 | 0 | 100-200 C. | 8.4 |
| VBr4_S17 | VBr4_4H2O_S1 | 1.604 | 0.539 | 135 | 135 | 0 | 100-200 C. | 7.4 |
| CuCl1 | CuCl1_3H2O_S1 | 1.526 | 0.727 | −19 | −19 | 0 | <50 C. | 27.2 |
| MgI2_6H2O_S2 | MgI2_12H2O_S1 | 1.465 | 0.844 | 195 | 211 | 16 | 200-300 C. | 0.4 |
| LiI1_1H2O_S1 | LiI1_3H2O_S1 | 1.556 | 0.660 | 61 | 243 | 181 | Large | 5.4 |
| | | | | | | | Hysteresis | |
| SnCl2_2H2O_S5 | SnCl2_8H2O_S1 | 1.514 | 0.746 | −48 | 129 | 177 | Large | 31.9 |
| | | | | | | | Hysteresis | |
| NiI3_S25 | NiI3_10H2O_S2 | 1.563 | 0.638 | −2 | −2 | 0 | <50 C. | 21.9 |
| KF1_2H2O_S1 | KF1_4H2O_S1 | 1.386 | 0.964 | 157 | 157 | 0 | 100-200 C. | 0.0 |
| ZnF2 | ZnF2_1H2O_S2 | 1.618 | 0.482 | 127 | 127 | 0 | 100-200 C. | 11.7 |
| NbI3_2H2O_S2 | NbI3_9H2O_S2 | 1.555 | 0.656 | 49 | 200 | 151 | Large | 36.6 |
| | | | | | | | Hysteresis | |
| PbI2 | PbI2_7H2O_S1 | 1.610 | 0.502 | −84 | 90 | 174 | <50 C. | 32.3 |
| CrF3_3H2O_S9 | CrF3_6H2O_S1 | 1.510 | 0.750 | 99 | 99 | 0 | 50-100 C. | 16.2 |
| NbBr4_3H2O_S1 | NbBr4_8H2O_S1 | 1.571 | 0.610 | 192 | 192 | 0 | 100-200 C. | 13.8 |
| SnF4_4H2O_S1 | SnF4_8H2O_S1 | 1.514 | 0.739 | 124 | 252 | 128 | 100-200 C. | 2.2 |
| GeI2 | GeI2_4H2O_S3 | 1.599 | 0.527 | 87 | 87 | 0 | 50-100 C. | 0.0 |
| TiI3 | TiI3_4H2O_S2 | 1.606 | 0.505 | 160 | 160 | 0 | 100-200 C. | 8.5 |
| TiBr4_3H2O_S1 | TiBr4_8H2O_S1 | 1.553 | 0.645 | 179 | 179 | 0 | 100-200 C. | 5.8 |
| BeF2_2H2O_S5 | BeF2_4H2O_S8 | 1.447 | 0.855 | 76 | 76 | 0 | 50-100 C. | 0.0 |
| BaBr2_2H2O_S4 | BaBr2_8H2O_S1 | 1.540 | 0.672 | 66 | 66 | 0 | 50-100 C. | 19.0 |
| SnCl2 | SnCl2_2H2O_S5 | 1.579 | 0.573 | 169 | 169 | 0 | 100-200 C. | 0.0 |
| SiBr4_4H2O_S1 | SiBr4_9H2O_S1 | 1.542 | 0.666 | 129 | 208 | 79 | 100-200 C. | 25.0 |
| VCl3_1H2O_S3 | VCl3_3H2O_S9 | 1.499 | 0.757 | 275 | 275 | 0 | 200-300 C. | 32.9 |
| ZrCl2 | ZrCl2_6H2O_S3 | 1.510 | 0.734 | −79 | 114 | 193 | Large | 48.8 |
| | | | | | | | Hysteresis | |
| BeCl2_4H2O_S8 | BeCl2_9H2O_S1 | 1.380 | 0.954 | 43 | 43 | 0 | <50 C. | 7.4 |
| AlF3_6H2O_S1 | AlF3_9H2O_S2 | 1.397 | 0.928 | 248 | 248 | 0 | 200-300 C. | 19.1 |
| NbBr3_S12 | NbBr3_4H2O_S2 | 1.588 | 0.538 | 100 | 100 | 0 | 100-200 C. | 13.1 |
| CrI4_2H2O_S2 | CrI4_8H2O_S1 | 1.593 | 0.525 | 128 | 248 | 120 | 100-200 C. | 14.4 |
| ZrBr2_S17 | ZrBr2_6H2O_S3 | 1.556 | 0.620 | −49 | 130 | 179 | Large | 41.9 |
| | | | | | | | Hysteresis | |
| GeF2_2H2O_S5 | GeF2_7H2O_S1 | 1.481 | 0.783 | −93 | 92 | 185 | <50 C. | 29.8 |
| YI3_3H2O_S9 | YI3_8H2O_S2 | 1.566 | 0.589 | 181 | 247 | 66 | 200-300 C. | 4.7 |
| HfBr4_S31 | HfBr4_3H2O_S1 | 1.617 | 0.429 | 210 | 296 | 85 | 200-300 C. | 0.0 |
| ZrI4 | ZrI4_5H2O_S2 | 1.608 | 0.463 | 141 | 198 | 57 | 100-200 C. | 4.6 |
| NbBr3_3H2O_S9 | NbBr3_9H2O_S2 | 1.499 | 0.741 | 96 | 195 | 99 | 100-200 C. | 21.0 |
| LaCl3_3H2O_S2 | LaCl3_9H2O_S2 | 1.426 | 0.872 | 90 | 176 | 86 | 100-200 C. | 2.1 |
| VF2_8H2O_S2 | VF2_12H2O_S1 | 1.388 | 0.931 | 214 | 214 | 0 | 200-300 C. | 20.7 |
| TaBr4_3H2O_S1 | TaBr4_8H2O_S1 | 1.585 | 0.530 | 195 | 195 | 0 | 100-200 C. | 17.8 |
| ZnBr2_7H2O_S1 | ZnBr2_12H2O_S1 | 1.439 | 0.849 | 240 | 240 | 0 | 200-300 C. | 31.3 |
| GaI3 | GaI3_7H2O_S1 | 1.578 | 0.550 | 18 | 153 | 136 | Large | 34.7 |
| | | | | | | | Hysteresis | |
| ZnBr2_4H2O_S3 | ZnBr2_9H2O_S2 | 1.508 | 0.718 | 108 | 108 | 0 | 100-200 C. | 8.3 |
| ZrBr4_3H2O_S1 | ZrBr4_9H2O_S1 | 1.560 | 0.593 | −240 | 193 | 433 | Large | 13.6 |
| | | | | | | | Hysteresis | |
| VBr2_7H2O_S1 | VBr2_12H2O_S1 | 1.419 | 0.878 | 240 | 240 | 0 | 200-300 C. | 23.2 |
| MnI3_S16 | MnI3_8H2O_S2 | 1.561 | 0.589 | −227 | 102 | 329 | Large | 29.6 |
| | | | | | | | Hysteresis | |
| CuI2_S15 | CuI2_6H2O_S3 | 1.574 | 0.555 | −138 | 64 | 202 | <50 C. | 26.6 |
| TiBr3_4H2O_S2 | TiBr3_9H2O_S2 | 1.478 | 0.775 | 186 | 232 | 47 | 200-300 C. | 5.9 |
| TiI3_3H2O_S9 | TiI3_9H2O_S2 | 1.525 | 0.673 | 155 | 206 | 51 | 100-200 C. | 8.4 |
| ZnF2_4H2O_S4 | ZnF2_9H2O_S1 | 1.460 | 0.803 | 19 | 19 | 0 | <50 C. | 25.2 |
| GeF4 | GeF4_1H2O_S1 | 1.585 | 0.515 | 315 | 315 | 0 | 300-450 C. | 23.6 |
| TiF2_8H2O_S2 | TiF2_12H2O_S1 | 1.374 | 0.943 | 215 | 215 | 0 | 200-300 C. | 26.8 |
| BaF2_2H2O_S1 | BaF2_7H2O_S1 | 1.520 | 0.682 | 8 | 8 | 0 | <50 C. | 18.8 |
| RbCl1_1H2O_S1 | RbCl1_4H2O_S1 | 1.420 | 0.872 | 111 | 111 | 0 | 100-200 C. | 4.9 |
| NaF1 | NaF1_1H2O_S1 | 1.504 | 0.717 | 22 | 22 | 0 | <50 C. | 30.1 |
| ZrI4_2H2O_S1 | ZrI4_9H2O_S1 | 1.584 | 0.518 | −182 | 162 | 343 | Large | 10.8 |
| | | | | | | | Hysteresis | |
| GaCl3_1H2O_S2 | GaCl3_4H2O_S2 | 1.508 | 0.702 | 125 | 125 | 0 | 100-200 C. | 17.6 |
| SrBr2 | SrBr2_2H2O_S4 | 1.593 | 0.478 | 191 | 192 | 1 | 100-200 C. | 0.0 |
| CrF2_8H2O_S1 | CrF2_12H2O_S1 | 1.380 | 0.928 | 214 | 214 | 0 | 200-300 C. | 22.6 |
| ZnI2_2H2O_S1 | ZnI2_8H2O_S3 | 1.531 | 0.648 | 70 | 70 | 0 | 50-100 C. | 18.2 |
| WBr4_3H2O_S1 | WBr4_8H2O_S1 | 1.578 | 0.522 | 190 | 190 | 0 | 100-200 C. | 21.5 |
| BaBr2 | BaBr2_4H2O_S1 | 1.560 | 0.576 | 23 | 172 | 149 | Large | 20.0 |
| | | | | | | | Hysteresis | |
| ZrI4_2H2O_S1 | ZrI4_10H2O_S1 | 1.578 | 0.522 | −184 | 162 | 345 | Large | 19.9 |
| | | | | | | | Hysteresis | |
| VI4_2H2O_S2 | VI4_8H2O_S1 | 1.576 | 0.526 | 149 | 149 | 0 | 100-200 C. | 21.0 |
| FeBr2_4H2O_S3 | FeBr2_9H2O_S2 | 1.490 | 0.733 | 106 | 106 | 0 | 100-200 C. | 0.0 |
| GeI4 | GeI4_8H2O_S1 | 1.574 | 0.526 | 53 | 53 | 0 | 50-100 C. | 0.0 |
| PbBr2_4H2O_S3 | PbBr2_12H2O_S1 | 1.486 | 0.740 | 97 | 97 | 0 | 50-100 C. | 0.0 |
| VI3_S15 | VI3_4H2O_S2 | 1.588 | 0.485 | 146 | 146 | 0 | 100-200 C. | 8.7 |
| MoBr4_3H2O_S1 | MoBr4_8H2O_S1 | 1.551 | 0.590 | 180 | 180 | 0 | 100-200 C. | 12.5 |
| NbI4_2H2O_S2 | NbI4_8H2O_S1 | 1.577 | 0.516 | 165 | 165 | 0 | 100-200 C. | 25.5 |
| PbCl2_1H2O_S1 | PbCl2_4H2O_S3 | 1.569 | 0.537 | 127 | 214 | 88 | 100-200 C. | 17.9 |
| SrI2_2H2O_S7 | SrI2_6H2O_S1 | 1.554 | 0.572 | 167 | 167 | 0 | 100-200 C. | 0.0 |
| TiI4_2H2O_S2 | TiI4_8H2O_S1 | 1.567 | 0.535 | 155 | 155 | 0 | 100-200 C. | 2.9 |
| GaBr3 | GaBr3_4H2O_S2 | 1.560 | 0.554 | −48 | 225 | 273 | Large | 37.5 |
| | | | | | | | Hysteresis | |
| MgF2_4H2O_S7 | MgF2_9H2O_S2 | 1.391 | 0.896 | 3 | 3 | 0 | <50 C. | 28.7 |
| CoBr2_6H2O_S3 | CoBr2_12H2O_S1 | 1.422 | 0.846 | 147 | 147 | 0 | 100-200 C. | 6.4 |
| HfBr4_3H2O_S1 | HfBr4_8H2O_S1 | 1.566 | 0.531 | 192 | 201 | 9 | 100-200 C. | 0.0 |
| NiBr2_6H2O_S3 | NiBr2_12H2O_S1 | 1.430 | 0.830 | 139 | 139 | 0 | 100-200 C. | 8.9 |
| CuF2_4H2O_S7 | CuF2_8H2O_S1 | 1.456 | 0.783 | 56 | 56 | 0 | 50-100 C. | 11.9 |
| CrCl2_2H2O_S3 | CrCl2_4H2O_S3 | 1.468 | 0.757 | 233 | 233 | 0 | 200-300 C. | 14.3 |
| WI4_2H2O_S1 | WI4_8H2O_S1 | 1.588 | 0.455 | 161 | 161 | 0 | 100-200 C. | 47.2 |
| TaI4_2H2O_S1 | TaI4_8H2O_S1 | 1.585 | 0.463 | 167 | 167 | 0 | 100-200 C. | 29.5 |
| TiCl2 | TiCl2_2H2O_S8 | 1.495 | 0.701 | −132 | 329 | 461 | Large | 44.1 |
| | | | | | | | Hysteresis | |
| FeF2_4H2O_S7 | FeF2_9H2O_S2 | 1.431 | 0.823 | 16 | 16 | 0 | <50 C. | 10.0 |
| WF4_4H2O_S1 | WF4_8H2O_S1 | 1.528 | 0.623 | 130 | 244 | 114 | 100-200 C. | 5.6 |
| SiF4_2H2O_S1 | SiF4_4H2O_S1 | 1.451 | 0.784 | 200 | 200 | 0 | 200-300 C. | 1.7 |
| NbBr4 | NbBr4_4H2O_S1 | 1.570 | 0.506 | 147 | 147 | 0 | 100-200 C. | 7.1 |
| YI3 | YI3_4H2O_S2 | 1.570 | 0.504 | 194 | 194 | 0 | 100-200 C. | 14.9 |
| LaBr3 | LaBr3_3H2O_S2 | 1.581 | 0.468 | 190 | 190 | 0 | 100-200 C. | 1.4 |
| BaF2_2H2O_S1 | BaF2_6H2O_S1 | 1.520 | 0.631 | 33 | 33 | 0 | <50 C. | 10.0 |
| KBr1_1H2O_S1 | KBr1_4H2O_S1 | 1.405 | 0.857 | 101 | 101 | 0 | 100-200 C. | 5.0 |
| ZnF2_8H2O_S2 | ZnF2_12H2O_S1 | 1.387 | 0.883 | 210 | 210 | 0 | 200-300 C. | 20.5 |
| MoI4_2H2O_S2 | MoI4_8H2O_S1 | 1.566 | 0.500 | 153 | 153 | 0 | 100-200 C. | 28.7 |
| MnF2_8H2O_S2 | MnF2_12H2O_S1 | 1.364 | 0.918 | 213 | 213 | 0 | 200-300 C. | 21.5 |
| ZrBr4_3H2O_S1 | ZrBr4_8H2O_S1 | 1.529 | 0.604 | 184 | 193 | 8 | 100-200 C. | 0.0 |
| MoBr4_S18 | MoBr4_4H2O_S1 | 1.568 | 0.493 | 139 | 139 | 0 | 100-200 C. | 6.3 |
| FeI3_S3 | FeI3_8H2O_S2 | 1.540 | 0.573 | −25 | 73 | 97 | <50 C. | 19.3 |
| CrI3_3H2O_S9 | CrI3_9H2O_S2 | 1.517 | 0.632 | 156 | 156 | 0 | 100-200 C. | 13.8 |
| CaBr2 | CaBr2_2H2O_S3 | 1.529 | 0.601 | 179 | 245 | 66 | 200-300 C. | 0.0 |
| CuCl2 | CuCl2_2H2O_S5 | 1.533 | 0.590 | 71 | 71 | 0 | 50-100 C. | 24.9 |
| MoCl3_2H2O_S1 | MoCl3_6H2O_S3 | 1.480 | 0.707 | 103 | 103 | 0 | 100-200 C. | 7.8 |
| PbI2 | PbI2_6H2O_S3 | 1.566 | 0.487 | −50 | 90 | 140 | <50 C. | 19.6 |
| TiF3_7H2O_S2 | TiF3_9H2O_S2 | 1.374 | 0.896 | 546 | 546 | 0 | 450-600 C. | 48.7 |
| ZrCl4_3H2O_S1 | ZrCl4_10H2O_S1 | 1.468 | 0.729 | −414 | 207 | 620 | Large | 39.8 |
| | | | | | | | Hysteresis | |
| CoF3_7H2O_S1 | CoF3_9H2O_S2 | 1.425 | 0.810 | 498 | 498 | 0 | 450-600 C. | 35.7 |
| MnBr3_S12 | MnBr3_4H2O_S2 | 1.541 | 0.557 | 77 | 77 | 0 | 50-100 C. | 22.7 |
| FeI2_1H2O_S2 | FeI2_4H2O_S3 | 1.563 | 0.489 | 153 | 153 | 0 | 100-200 C. | 23.5 |
| CrBr3 | CrBr3_3H2O_S9 | 1.545 | 0.539 | 153 | 153 | 0 | 100-200 C. | 7.5 |
| VF2_4H2O_S4 | VF2_9H2O_S2 | 1.410 | 0.828 | 12 | 12 | 0 | <50 C. | 27.5 |
| FeI2_4H2O_S3 | FeI2_12H2O_S1 | 1.457 | 0.742 | −20 | 110 | 130 | Large | 7.8 |
| | | | | | | | Hysteresis | |
| FeI3_S3 | FeI3_6H2O_S3 | 1.559 | 0.493 | −5 | 73 | 78 | <50 C. | 10.8 |
| BaI2_4H2O_S6 | BaI2_12H2O_S1 | 1.438 | 0.775 | 130 | 130 | 0 | 100-200 C. | 2.3 |
| NbI4 | NbI4_10H2O_S1 | 1.547 | 0.523 | −504 | 135 | 639 | Large | 47.7 |
| | | | | | | | Hysteresis | |
| CrF3_6H2O_S1 | CrF3_9H2O_S2 | 1.392 | 0.855 | 256 | 256 | 0 | 200-300 C. | 16.2 |
| MgCl2 | MgCl2_1H2O_S2 | 1.464 | 0.723 | 288 | 288 | 0 | 200-300 C. | 0.0 |
| TiCl3_3H2O_S9 | TiCl3_8H2O_S2 | 1.411 | 0.819 | 62 | 62 | 0 | 50-100 C. | 35.9 |
| SnCl2_6H2O_S3 | SnCl2_12H2O_S1 | 1.355 | 0.908 | 148 | 148 | 0 | 100-200 C. | 22.9 |
| NiBr2_7H2O_S1 | NiBr2_12H2O_S1 | 1.409 | 0.818 | 214 | 214 | 0 | 200-300 C. | 30.2 |
| BeBr2_4H2O_S8 | BeBr2_9H2O_S1 | 1.413 | 0.811 | 95 | 95 | 0 | 50-100 C. | 0.0 |
| MnBr2_4H2O_S3 | MnBr2_9H2O_S2 | 1.457 | 0.729 | 103 | 103 | 0 | 100-200 C. | 10.4 |
| HfI4_2H2O_S1 | HfI4_8H2O_S1 | 1.561 | 0.465 | 168 | 168 | 0 | 100-200 C. | 0.0 |
| SnI2 | SnI2_4H2O_S2 | 1.552 | 0.492 | 102 | 102 | 0 | 100-200 C. | 0.0 |
| TiI4 | TiI4_5H2O_S2 | 1.561 | 0.459 | 133 | 133 | 0 | 100-200 C. | 6.7 |
| CoF2_9H2O_S2 | CoF2_12H2O_S1 | 1.367 | 0.883 | 358 | 358 | 0 | 300-450 C. | 36.1 |
| VCl3_3H2O_S9 | VCl3_8H2O_S2 | 1.416 | 0.801 | −143 | 192 | 335 | Large | 34.8 |
| | | | | | | | Hysteresis | |
| TaBr3_3H2O_S9 | TaBr3_9H2O_S2 | 1.501 | 0.626 | 88 | 199 | 111 | 100-200 C. | 32.7 |
| VI3_3H2O_S9 | VI3_9H2O_S2 | 1.495 | 0.636 | 116 | 200 | 84 | 100-200 C. | 10.9 |
| HfF4_4H2O_S1 | HfF4_8H2O_S1 | 1.493 | 0.640 | 164 | 164 | 0 | 100-200 C. | 13.7 |
| NiCl3_S25 | NiCl3_4H2O_S2 | 1.455 | 0.721 | 20 | 20 | 0 | <50 C. | 33.9 |
| GaF3_7H2O_S1 | GaF3_9H2O_S2 | 1.406 | 0.812 | 530 | 530 | 0 | 450-600 C. | 46.5 |
| MnF4_2H2O_S2 | MnF4_4H2O_S1 | 1.460 | 0.705 | 217 | 217 | 0 | 200-300 C. | 0.0 |
| ScF3_6H2O_S3 | ScF3_9H2O_S2 | 1.349 | 0.897 | 268 | 268 | 0 | 200-300 C. | 29.9 |
| ZrBr2_6H2O_S3 | ZrBr2_12H2O_S1 | 1.396 | 0.820 | 165 | 165 | 0 | 100-200 C. | 41.9 |
| CsF1 | CsF1_1H2O_S2 | 1.556 | 0.449 | 249 | 249 | 0 | 200-300 C. | 0.0 |
| KBr1 | KBr1_3H2O_S1 | 1.445 | 0.730 | 15 | 15 | 0 | <50 C. | 33.1 |
| SrCl2_7H2O_S1 | SrCl2_12H2O_S1 | 1.303 | 0.958 | 219 | 219 | 0 | 200-300 C. | 24.8 |
| GaBr3 | GaBr3_3H2O_S4 | 1.530 | 0.527 | 43 | 225 | 183 | Large | 12.6 |
| | | | | | | | Hysteresis | |
| YBr3_S7 | YBr3_3H2O_S9 | 1.516 | 0.561 | 217 | 217 | 0 | 200-300 C. | 3.2 |
| PbF2_2H2O_S4 | PbF2_7H2O_S1 | 1.528 | 0.526 | −5 | −5 | 0 | <50 C. | 27.1 |
| VBr3_4H2O_S2 | VBr3_9H2O_S2 | 1.440 | 0.732 | 156 | 219 | 63 | 100-200 C. | 5.8 |
| CrBr2_6H2O_S3 | CrBr2_12H2O_S1 | 1.374 | 0.849 | 142 | 142 | 0 | 100-200 C. | 7.0 |
| CrBr2_4H2O_S3 | CrBr2_9H2O_S2 | 1.447 | 0.719 | 95 | 95 | 0 | 50-100 C. | 7.7 |
| MoI3 | MoI3_7H2O_S1 | 1.531 | 0.510 | 28 | 28 | 0 | <50 C. | 23.2 |
| ZrI4_2H2O_S1 | ZrI4_8H2O_S1 | 1.528 | 0.512 | 162 | 162 | 0 | 100-200 C. | 0.0 |
| VBr2 | VBr2_2H2O_S8 | 1.528 | 0.509 | 157 | 157 | 0 | 100-200 C. | 5.2 |
| CoF2 | CoF2_1H2O_S2 | 1.539 | 0.473 | 99 | 99 | 0 | 50-100 C. | 21.5 |
| CrBr2_7H2O_S1 | CrBr2_12H2O_S1 | 1.369 | 0.846 | 223 | 223 | 0 | 200-300 C. | 30.7 |
| TiCl2_1H2O_S2 | TiCl2_4H2O_S3 | 1.425 | 0.747 | 52 | 52 | 0 | 50-100 C. | 23.6 |
| CuCl2_2H2O_S5 | CuCl2_4H2O_S3 | 1.450 | 0.696 | 219 | 219 | 0 | 200-300 C. | 24.9 |
| ZrCl2_1H2O_S2 | ZrCl2_8H2O_S2 | 1.407 | 0.777 | −40 | −40 | 0 | <50 C. | 38.0 |
| CoBr3_4H2O_S2 | CoBr3_9H2O_S2 | 1.454 | 0.681 | 73 | 283 | 211 | Large | 36.7 |
| | | | | | | | Hysteresis | |
| AlF3_3H2O_S9 | AlF3_6H2O_S1 | 1.409 | 0.766 | 63 | 63 | 0 | 50-100 C. | 19.1 |
| ZrF4_3H2O_S2 | ZrF4_9H2O_S1 | 1.447 | 0.687 | −625 | 108 | 733 | Large | 31.8 |
| | | | | | | | Hysteresis | |
| VF3_3H2O_S8 | VF3_6H2O_S1 | 1.429 | 0.723 | 84 | 84 | 0 | 50-100 C. | 15.2 |
| GaF3_6H2O_S1 | GaF3_9H2O_S2 | 1.387 | 0.801 | 255 | 255 | 0 | 200-300 C. | 22.5 |
| TiBr2_1H2O_S2 | TiBr2_4H2O_S3 | 1.493 | 0.579 | 97 | 97 | 0 | 50-100 C. | 15.0 |
| MoF3_3H2O_S9 | MoF3_6H2O_S1 | 1.465 | 0.645 | 111 | 111 | 0 | 100-200 C. | 16.4 |
| CoI3_S25 | CoI3_6H2O_S3 | 1.529 | 0.471 | 22 | 22 | 0 | <50 C. | 10.4 |
| SnBr4 | SnBr4_4H2O_S1 | 1.526 | 0.476 | 143 | 143 | 0 | 100-200 C. | 0.1 |
| FeBr3_3H2O_S7 | FeBr3_9H2O_S2 | 1.439 | 0.694 | 90 | 90 | 0 | 50-100 C. | 4.9 |
| CuBr2_7H2O_S1 | CuBr2_12H2O_S1 | 1.381 | 0.802 | 210 | 210 | 0 | 200-300 C. | 42.9 |
| SnF2_7H2O_S1 | SnF2_12H2O_S1 | 1.365 | 0.826 | 149 | 149 | 0 | 100-200 C. | 23.8 |
| ZrBr3 | ZrBr3_4H2O_S2 | 1.504 | 0.529 | 92 | 92 | 0 | 50-100 C. | 22.0 |
| CaI2_6H2O_S2 | CaI2_12H2O_S1 | 1.370 | 0.816 | 202 | 202 | 0 | 200-300 C. | 9.0 |
| YCl3_3H2O_S9 | YCl3_6H2O_S2 | 1.433 | 0.698 | 210 | 210 | 0 | 200-300 C. | 0.0 |
| CaBr2_7H2O_S1 | CaBr2_12H2O_S1 | 1.320 | 0.893 | 236 | 236 | 0 | 200-300 C. | 18.2 |
| NbCl3_4H2O_S2 | NbCl3_9H2O_S2 | 1.348 | 0.849 | 147 | 147 | 0 | 100-200 C. | 12.1 |
| ScCl3_3H2O_S9 | ScCl3_6H2O_S1 | 1.363 | 0.823 | 215 | 215 | 0 | 200-300 C. | 0.1 |
| HfBr4_3H2O_S1 | HfBr4_9H2O_S1 | 1.513 | 0.495 | −368 | 201 | 569 | Large | 19.6 |
| | | | | | | | Hysteresis | |
| CrBr2 | CrBr2_2H2O_S8 | 1.510 | 0.503 | 154 | 154 | 0 | 100-200 C. | 12.2 |
| VCl4_4H2O_S1 | VCl4_8H2O_S1 | 1.376 | 0.799 | 188 | 188 | 0 | 100-200 C. | 4.4 |
| GeF4_2H2O_S2 | GeF4_4H2O_S1 | 1.453 | 0.649 | 217 | 217 | 0 | 200-300 C. | 1.0 |
| SnI4 | SnI4_3H2O_S1 | 1.537 | 0.407 | 175 | 634 | 459 | Large | 0.0 |
| | | | | | | | Hysteresis | |
| PbCl4 | PbCl4_3H2O_S1 | 1.510 | 0.497 | 184 | 184 | 0 | 100-200 C. | 0.0 |
| YI3_4H2O_S2 | YI3_9H2O_S3 | 1.484 | 0.568 | 100 | 312 | 213 | Large | 14.9 |
| | | | | | | | Hysteresis | |
| RbCl1 | RbCl1_3H2O_S1 | 1.413 | 0.725 | 17 | 17 | 0 | <50 C. | 36.8 |
| BaI2_2H2O_S9 | BaI2_8H2O_S1 | 1.473 | 0.592 | 89 | 89 | 0 | 50-100 C. | 12.8 |
| TaBr4_S18 | TaBr4_4H2O_S1 | 1.532 | 0.414 | 133 | 133 | 0 | 100-200 C. | 10.3 |
| YBr3_4H2O_S2 | YBr3_9H2O_S2 | 1.408 | 0.732 | 166 | 299 | 133 | 200-300 C. | 13.7 |
| MoF3_3H2O_S9 | MoF3_8H2O_S1 | 1.425 | 0.698 | 11 | 11 | 0 | <50 C. | 48.6 |
| FeF2 | FeF2_1H2O_S2 | 1.508 | 0.491 | 103 | 103 | 0 | 100-200 C. | 18.9 |
| SnBr2_1H2O_S2 | SnBr2_4H2O_S3 | 1.492 | 0.537 | 120 | 230 | 110 | 100-200 C. | 22.9 |
| MnCl4_4H2O_S1 | MnCl4_8H2O_S1 | 1.377 | 0.785 | 185 | 185 | 0 | 100-200 C. | 0.0 |
| CaF2_8H2O_S2 | CaF2_12H2O_S1 | 1.273 | 0.944 | 203 | 203 | 0 | 200-300 C. | 23.7 |
| PbF2_2H2O_S4 | PbF2_6H2O_S1 | 1.514 | 0.467 | 10 | 10 | 0 | <50 C. | 20.5 |
| FeBr3_1H2O_S2 | FeBr3_7H2O_S1 | 1.462 | 0.609 | 20 | 20 | 0 | <50 C. | 22.7 |
| VI2_6H2O_S3 | VI2_12H2O_S1 | 1.389 | 0.759 | 178 | 178 | 0 | 100-200 C. | 7.1 |
| ScCl3 | ScCl3_2H2O_S2 | 1.417 | 0.706 | 180 | 180 | 0 | 100-200 C. | 18.3 |
| CrCl4_4H2O_S1 | CrCl4_8H2O_S1 | 1.373 | 0.788 | 183 | 183 | 0 | 100-200 C. | 5.5 |
| SnBr2_2H2O_S5 | SnBr2_8H2O_S1 | 1.456 | 0.620 | −21 | 120 | 141 | Large | 24.7 |
| | | | | | | | Hysteresis | |
| TiCl4_4H2O_S1 | TiCl4_8H2O_S1 | 1.359 | 0.810 | 190 | 190 | 0 | 100-200 C. | 0.7 |
| RbBr1 | RbBr1_3H2O_S1 | 1.452 | 0.626 | 41 | 41 | 0 | <50 C. | 16.9 |
| MgCl2_2H2O_S8 | MgCl2_4H2O_S7 | 1.346 | 0.829 | 202 | 202 | 0 | 200-300 C. | 0.0 |
| CrI3_4H2O_S1 | CrI3_9H2O_S2 | 1.459 | 0.608 | 222 | 222 | 0 | 200-300 C. | 40.6 |
| PbF4_1H2O_S1 | PbF4_2H2O_S2 | 1.541 | 0.348 | 487 | 487 | 0 | 450-600 C. | 33.7 |
| CsI1 | CsI1_4H2O_S1 | 1.458 | 0.607 | 72 | 72 | 0 | 50-100 C. | 0.0 |
| GeCl4_4H2O_S1 | GeCl4_8H2O_S1 | 1.385 | 0.758 | 193 | 193 | 0 | 100-200 C. | 19.8 |
| HfCl4_3H2O_S1 | HfCl4_10H2O_S1 | 1.462 | 0.594 | −440 | 212 | 652 | Large | 42.1 |
| | | | | | | | Hysteresis | |
| GaCl3 | GaCl3_2H2O_S1 | 1.435 | 0.654 | 137 | 267 | 130 | 200-300 C. | 7.6 |
| LaI3_2H2O_S1 | LaI3_6H2O_S2 | 1.502 | 0.480 | 243 | 243 | 0 | 200-300 C. | 21.3 |
| GaI3_1H2O_S2 | GaI3_6H2O_S3 | 1.501 | 0.480 | 94 | 94 | 0 | 50-100 C. | 6.5 |
| PbBr4_S20 | PbBr4_9H2O_S1 | 1.481 | 0.537 | −647 | 91 | 737 | <50 C. | 32.8 |
| LaF3 | LaF3_4H2O_S1 | 1.495 | 0.497 | −45 | −45 | 0 | <50 C. | 46.6 |
| TaCl3_S22 | TaCl3_4H2O_S2 | 1.491 | 0.507 | 39 | 39 | 0 | <50 C. | 21.0 |
| HfCl4 | HfCl4_2H2O_S2 | 1.501 | 0.475 | 306 | 306 | 0 | 300-450 C. | 0.0 |
| TiCl3_1H2O_S3 | TiCl3_3H2O_S9 | 1.389 | 0.741 | 255 | 255 | 0 | 200-300 C. | 23.1 |
| MoCl3 | MoCl3_3H2O_S9 | 1.440 | 0.634 | −56 | 175 | 231 | Large | 21.7 |
| | | | | | | | Hysteresis | |
| MoF3_7H2O_S1 | MoF3_9H2O_S2 | 1.378 | 0.760 | 547 | 547 | 0 | 450-600 C. | 43.1 |
| AlF3_3H2O_S9 | AlF3_7H2O_S1 | 1.344 | 0.813 | 19 | 19 | 0 | <50 C. | 33.0 |
| NaF1_3H2O_S1 | NaF1_4H2O_S1 | 1.316 | 0.856 | 396 | 396 | 0 | 300-450 C. | 37.8 |
| BaCl2_2H2O_S4 | BaCl2_6H2O_S1 | 1.421 | 0.664 | 87 | 87 | 0 | 50-100 C. | 7.6 |
| HfBr4_3H2O_S1 | HfBr4_10H2O_S1 | 1.488 | 0.493 | −296 | 201 | 497 | Large | 29.6 |
| | | | | | | | Hysteresis | |
| CuBr2_6H2O_S3 | CuBr2_12H2O_S1 | 1.355 | 0.787 | 122 | 122 | 0 | 100-200 C. | 20.8 |
| CoCl3_3H2O_S9 | CoCl3_6H2O_S3 | 1.401 | 0.700 | 164 | 164 | 0 | 100-200 C. | 14.2 |
| VCl3_3H2O_S9 | VCl3_6H2O_S1 | 1.365 | 0.767 | 192 | 192 | 0 | 100-200 C. | 0.0 |
| TiCl3_3H2O_S9 | TiCl3_7H2O_S2 | 1.367 | 0.764 | 94 | 94 | 0 | 50-100 C. | 24.5 |
| PbF2_7H2O_S1 | PbF2_12H2O_S1 | 1.402 | 0.696 | 167 | 167 | 0 | 100-200 C. | 27.1 |
| MoF3_6H2O_S1 | MoF3_9H2O_S2 | 1.370 | 0.755 | 270 | 270 | 0 | 200-300 C. | 16.4 |
| TiCl3_3H2O_S9 | TiCl3_6H2O_S3 | 1.361 | 0.769 | 187 | 187 | 0 | 100-200 C. | 1.5 |
| CuBr1 | CuBr1_3H2O_S1 | 1.459 | 0.561 | −20 | −20 | 0 | <50 C. | 27.6 |
| SnF4_1H2O_S1 | SnF4_2H2O_S2 | 1.496 | 0.450 | 438 | 438 | 0 | 300-450 C. | 15.8 |
| MnI2_7H2O_S1 | MnI2_12H2O_S1 | 1.367 | 0.756 | 270 | 270 | 0 | 200-300 C. | 40.0 |
| MnF4 | MnF4_1H2O_S1 | 1.466 | 0.540 | 277 | 277 | 0 | 200-300 C. | 27.6 |
| LaCl3_4H2O_S1 | LaCl3_9H2O_S2 | 1.332 | 0.815 | 90 | 320 | 230 | Large | 28.4 |
| | | | | | | | Hysteresis | |
| ZnCl2 | ZnCl2_2H2O_S5 | 1.457 | 0.561 | 58 | 58 | 0 | 50-100 C. | 27.2 |
| TiF3_3H2O_S8 | TiF3_6H2O_S3 | 1.378 | 0.732 | 83 | 83 | 0 | 50-100 C. | 12.5 |
| GaBr3_2H2O_S1 | GaBr3_7H2O_S1 | 1.449 | 0.577 | 71 | 71 | 0 | 50-100 C. | 24.0 |
| TaBr3_2H2O_S1 | TaBr3_6H2O_S3 | 1.488 | 0.462 | 145 | 145 | 0 | 100-200 C. | 24.1 |
| GaBr3_2H2O_S1 | GaBr3_6H2O_S3 | 1.458 | 0.549 | 120 | 120 | 0 | 100-200 C. | 8.5 |
| SiF4_3H2O_S1 | SiF4_5H2O_S2 | 1.361 | 0.757 | 230 | 230 | 0 | 200-300 C. | 4.5 |
| WI4_S18 | WI4_9H2O_S1 | 1.485 | 0.466 | −561 | 104 | 665 | Large | 28.7 |
| | | | | | | | Hysteresis | |
| BaF2_6H2O_S1 | BaF2_12H2O_S1 | 1.325 | 0.815 | 91 | 91 | 0 | 50-100 C. | 10.0 |
| MnF2_4H2O_S7 | MnF2_9H2O_S2 | 1.341 | 0.790 | 3 | 3 | 0 | <50 C. | 28.7 |
| CoF3_2H2O_S2 | CoF3_3H2O_S9 | 1.448 | 0.568 | 388 | 388 | 0 | 300-450 C. | 4.0 |
| NbI3_2H2O_S2 | NbI3_6H2O_S3 | 1.481 | 0.475 | 200 | 200 | 0 | 100-200 C. | 36.6 |
| LiI1 | LiI1_1H2O_S1 | 1.486 | 0.461 | 207 | 207 | 0 | 200-300 C. | 5.4 |
| TiBr2 | TiBr2_2H2O_S3 | 1.475 | 0.489 | −45 | 316 | 361 | Large | 32.2 |
| | | | | | | | Hysteresis | |
| NbCl4 | NbCl4_3H2O_S1 | 1.423 | 0.622 | 137 | 137 | 0 | 100-200 C. | 13.5 |
| ZrBr4_S31 | ZrBr4_3H2O_S1 | 1.479 | 0.472 | 207 | 239 | 32 | 200-300 C. | 0.0 |
| MgBr2_4H2O_S4 | MgBr2_8H2O_S2 | 1.346 | 0.771 | 160 | 160 | 0 | 100-200 C. | 8.8 |
| PbCl2_6H2O_S3 | PbCl2_12H2O_S1 | 1.354 | 0.753 | 152 | 152 | 0 | 100-200 C. | 19.9 |
| NiI3_S25 | NiI3_6H2O_S3 | 1.477 | 0.464 | 17 | 17 | 0 | <50 C. | 12.3 |
| MgF2_9H2O_S2 | MgF2_12H2O_S1 | 1.250 | 0.911 | 306 | 306 | 0 | 300-450 C. | 28.7 |
| MgCl2_8H2O_S2 | MgCl2_12H2O_S1 | 1.210 | 0.964 | 241 | 241 | 0 | 200-300 C. | 10.6 |
| HfI4 | HfI4_4H2O_S1 | 1.501 | 0.370 | 144 | 271 | 127 | 200-300 C. | 4.3 |
| BaCl2 | BaCl2_2H2O_S4 | 1.458 | 0.508 | 152 | 152 | 0 | 100-200 C. | 0.0 |
| NbCl4_4H2O_S1 | NbCl4_8H2O_S1 | 1.362 | 0.726 | 198 | 198 | 0 | 100-200 C. | 6.8 |
| FeF3_6H2O_S1 | FeF3_9H2O_S2 | 1.333 | 0.779 | 216 | 216 | 0 | 200-300 C. | 7.1 |
| AlBr3_4H2O_S2 | AlBr3_6H2O_S1 | 1.416 | 0.612 | 513 | 513 | 0 | 450-600 C. | 26.0 |
| AlF3_3H2O_S9 | AlF3_8H2O_S1 | 1.320 | 0.797 | −24 | −24 | 0 | <50 C. | 48.5 |
| ZrI3_3H2O_S9 | ZrI3_9H2O_S2 | 1.414 | 0.612 | 170 | 170 | 0 | 100-200 C. | 37.5 |
| LaI3_4H2O_S2 | LaI3_9H2O_S3 | 1.444 | 0.538 | 141 | 361 | 219 | Large | 28.9 |
| | | | | | | | Hysteresis | |
| FeI3_S3 | FeI3_7H2O_S1 | 1.447 | 0.526 | −25 | 73 | 98 | <50 C. | 17.4 |
| SrBr2_6H2O_S1 | SrBr2_12H2O_S1 | 1.300 | 0.822 | 162 | 162 | 0 | 100-200 C. | 3.7 |
| MoF3 | MoF3_1H2O_S2 | 1.477 | 0.425 | 225 | 225 | 0 | 200-300 C. | 5.7 |
| CaI2_2H2O_S8 | CaI2_6H2O_S2 | 1.409 | 0.614 | 150 | 150 | 0 | 100-200 C. | 9.0 |
| CrF3_2H2O_S2 | CrF3_3H2O_S9 | 1.407 | 0.618 | 417 | 417 | 0 | 300-450 C. | 24.2 |
| ZrBr3_4H2O_S2 | ZrBr3_9H2O_S2 | 1.370 | 0.695 | 197 | 197 | 0 | 100-200 C. | 22.0 |
| TiI3_2H2O_S2 | TiI3_6H2O_S1 | 1.443 | 0.525 | 210 | 210 | 0 | 200-300 C. | 16.7 |
| ZrBr4_3H2O_S1 | ZrBr4_10H2O_S1 | 1.433 | 0.549 | −309 | 193 | 501 | Large | 30.7 |
| | | | | | | | Hysteresis | |
| 3-Feb | FeBr3_3H2O_S7 | 1.444 | 0.521 | 61 | 306 | 244 | Large | 4.9 |
| | | | | | | | Hysteresis | |
| LiCl1_2H2O_S2 | LiCl1_4H2O_S1 | 1.253 | 0.887 | 75 | 75 | 0 | 50-100 C. | 0.0 |
| VF3_6H2O_S1 | VF3_9H2O_S2 | 1.298 | 0.818 | 231 | 231 | 0 | 200-300 C. | 15.2 |
| VI4_S17 | VI4_9H2O_S1 | 1.446 | 0.509 | −927 | 123 | 1050 | Large | 46.1 |
| | | | | | | | Hysteresis | |
| MoBr3_4H2O_S2 | MoBr3_9H2O_S2 | 1.384 | 0.660 | 177 | 177 | 0 | 100-200 C. | 25.3 |
| MgI2_4H2O_S4 | MgI2_8H2O_S3 | 1.390 | 0.647 | 195 | 195 | 0 | 100-200 C. | 3.2 |
| ScI3_4H2O_S2 | ScI3_9H2O_S2 | 1.400 | 0.626 | 170 | 322 | 152 | Large | 13.4 |
| | | | | | | | Hysteresis | |
| CrI4_S8 | CrI4_5H2O_S2 | 1.469 | 0.429 | 58 | 143 | 85 | 100-200 C. | 10.7 |
| CrF4_2H2O_S2 | CrF4_4H2O_S1 | 1.373 | 0.676 | 190 | 190 | 0 | 100-200 C. | 2.4 |
| TiBr2 | TiBr2_1H2O_S2 | 1.480 | 0.381 | 316 | 316 | 0 | 300-450 C. | 0.0 |
| VI3_2H2O_S2 | VI3_6H2O_S1 | 1.438 | 0.513 | 201 | 201 | 0 | 200-300 C. | 20.0 |
| SnCl2_7H2O_S1 | SnCl2_12H2O_S1 | 1.268 | 0.850 | 200 | 200 | 0 | 100-200 C. | 33.0 |
| PbI2 | PbI2_4H2O_S2 | 1.472 | 0.398 | 90 | 90 | 0 | 50-100 C. | 0.0 |
| FeF3_7H2O_S1 | FeF3_9H2O_S2 | 1.316 | 0.769 | 451 | 451 | 0 | 450-600 C. | 32.6 |
| MoCl3_2H2O_S1 | MoCl3_8H2O_S1 | 1.354 | 0.698 | 3 | 3 | 0 | <50 C. | 41.4 |
| HfF4_3H2O_S2 | HfF4_9H2O_S1 | 1.427 | 0.530 | −750 | 125 | 875 | Large | 37.7 |
| | | | | | | | Hysteresis | |
| SnCl4_1H2O_S1 | SnCl4_3H2O_S1 | 1.410 | 0.572 | 343 | 343 | 0 | 300-450 C. | 48.8 |
| ScI3_S9 | ScI3_3H2O_S9 | 1.448 | 0.464 | 235 | 235 | 0 | 200-300 C. | 5.8 |
| NbF3_1H2O_S2 | NbF3_4H2O_S2 | 1.405 | 0.580 | 21 | 21 | 0 | <50 C. | 31.9 |
| MoCl4_4H2O_S1 | MoCl4_8H2O_S1 | 1.346 | 0.705 | 188 | 188 | 0 | 100-200 C. | 0.0 |
| GeCl2_2H2O_S5 | GeCl2_6H2O_S3 | 1.339 | 0.719 | −75 | 149 | 224 | Large | 23.2 |
| | | | | | | | Hysteresis | |
| LaBr3_3H2O_S2 | LaBr3_9H2O_S2 | 1.360 | 0.677 | 92 | 197 | 105 | 100-200 C. | 1.4 |
| CuI2_4H2O_S2 | CuI2_12H2O_S1 | 1.349 | 0.697 | 45 | 45 | 0 | <50 C. | 0.5 |
| ZnI2_6H2O_S3 | ZnI2_12H2O_S1 | 1.343 | 0.705 | 158 | 158 | 0 | 100-200 C. | 14.6 |
| CuCl2_4H2O_S3 | CuCl2_9H2O_S2 | 1.318 | 0.750 | 32 | 32 | 0 | <50 C. | 14.5 |
| ZrCl4_4H2O_S1 | ZrCl4_8H2O_S1 | 1.332 | 0.723 | 194 | 194 | 0 | 100-200 C. | 0.0 |
| MoF4_2H2O_S2 | MoF4_4H2O_S1 | 1.392 | 0.594 | 223 | 223 | 0 | 200-300 C. | 1.2 |
| GeBr4 | GeBr4_5H2O_S2 | 1.434 | 0.481 | 45 | 45 | 0 | <50 C. | 0.7 |
| PbBr2_1H2O_S2 | PbBr2_4H2O_S3 | 1.451 | 0.426 | 132 | 198 | 66 | 100-200 C. | 12.6 |
| TiCl3 | TiCl3_2H2O_S2 | 1.372 | 0.635 | 141 | 141 | 0 | 100-200 C. | 18.4 |
| GeI2_4H2O_S3 | GeI2_12H2O_S1 | 1.328 | 0.723 | 63 | 63 | 0 | 50-100 C. | 0.0 |
| PbCl2 | PbCl2_2H2O_S5 | 1.461 | 0.387 | 144 | 144 | 0 | 100-200 C. | 0.0 |
| TiI2_6H2O_S3 | TiI2_12H2O_S1 | 1.321 | 0.733 | 160 | 160 | 0 | 100-200 C. | 5.5 |
| AlBr3_1H2O_S2 | AlBr3_3H2O_S9 | 1.418 | 0.521 | 299 | 299 | 0 | 200-300 C. | 17.8 |
| LaBr3 | LaBr3_4H2O_S2 | 1.423 | 0.507 | 118 | 118 | 0 | 100-200 C. | 28.6 |
| FeI2_4H2O_S3 | FeI2_9H2O_S2 | 1.388 | 0.592 | 110 | 110 | 0 | 100-200 C. | 0.0 |
| MnI2_6H2O_S3 | MnI2_12H2O_S1 | 1.320 | 0.730 | 164 | 164 | 0 | 100-200 C. | 8.9 |
| BaBr2_2H2O_S4 | BaBr2_7H2O_S1 | 1.394 | 0.576 | 61 | 61 | 0 | 50-100 C. | 19.3 |
| GeBr2_7H2O_S1 | GeBr2_12H2O_S1 | 1.282 | 0.794 | 215 | 215 | 0 | 200-300 C. | 42.1 |
| CuF2 | CuF2_1H2O_S2 | 1.444 | 0.428 | 78 | 78 | 0 | 50-100 C. | 25.6 |
| NaCl1 | NaCl1_1H2O_S1 | 1.321 | 0.724 | 106 | 106 | 0 | 100-200 C. | 0.0 |
| NiF2_4H2O_S4 | NiF2_8H2O_S2 | 1.310 | 0.743 | 33 | 33 | 0 | <50 C. | 20.4 |
| CrI2_4H2O_S3 | CrI2_9H2O_S2 | 1.380 | 0.598 | 110 | 110 | 0 | 100-200 C. | 4.2 |
| MnCl3_3H2O_S8 | MnCl3_6H2O_S3 | 1.320 | 0.719 | 169 | 169 | 0 | 100-200 C. | 4.5 |
| AlF3_7H2O_S1 | AlF3_9H2O_S2 | 1.252 | 0.832 | 428 | 428 | 0 | 300-450 C. | 33.0 |
| VCl2_4H2O_S3 | VCl2_8H2O_S2 | 1.252 | 0.832 | 106 | 106 | 0 | 100-200 C. | 13.0 |
| MoBr3 | MoBr3_4H2O_S2 | 1.425 | 0.473 | 57 | 57 | 0 | 50-100 C. | 25.3 |
| TiI2_7H2O_S1 | TiI2_12H2O_S1 | 1.312 | 0.728 | 244 | 244 | 0 | 200-300 C. | 30.3 |
| GaI3_3H2O_S2 | GaI3_9H2O_S2 | 1.388 | 0.567 | 123 | 123 | 0 | 100-200 C. | 7.1 |
| GeF2_8H2O_S2 | GeF2_12H2O_S1 | 1.249 | 0.826 | 189 | 189 | 0 | 100-200 C. | 28.0 |
| GeI2 | GeI2_7H2O_S1 | 1.396 | 0.541 | −194 | 87 | 281 | <50 C. | 48.6 |
| CuBr1 | CuBr1_4H2O_S1 | 1.370 | 0.598 | −52 | −52 | 0 | <50 C. | 42.9 |
| MoCl3_2H2O_S1 | MoCl3_7H2O_S1 | 1.328 | 0.684 | 35 | 35 | 0 | <50 C. | 29.1 |
| MnBr2 | MnBr2_2H2O_S8 | 1.415 | 0.479 | 138 | 138 | 0 | 100-200 C. | 7.9 |
| GeBr2_6H2O_S3 | GeBr2_12H2O_S1 | 1.269 | 0.785 | 129 | 129 | 0 | 100-200 C. | 20.8 |
| SnCl4_4H2O_S1 | SnCl4_8H2O_S1 | 1.333 | 0.670 | 191 | 191 | 0 | 100-200 C. | 0.0 |
| TaCl3_4H2O_S2 | TaCl3_9H2O_S2 | 1.333 | 0.669 | 139 | 139 | 0 | 100-200 C. | 21.0 |
| CuF2_8H2O_S1 | CuF2_12H2O_S1 | 1.258 | 0.801 | 163 | 163 | 0 | 100-200 C. | 11.9 |
| TaCl4_4H2O_S1 | TaCl4_8H2O_S1 | 1.370 | 0.591 | 199 | 199 | 0 | 100-200 C. | 9.4 |
| SnCl2_2H2O_S5 | SnCl2_7H2O_S1 | 1.346 | 0.640 | −80 | 129 | 209 | Large | 33.0 |
| | | | | | | | Hysteresis | |
| BaBr2_2H2O_S4 | BaBr2_6H2O_S1 | 1.386 | 0.547 | 106 | 106 | 0 | 100-200 C. | 4.5 |
| SiBr2_S25 | SiBr2_4H2O_S6 | 1.344 | 0.643 | 13 | 13 | 0 | <50 C. | 23.6 |
| SrBr2_1H2O_S1 | SrBr2_4H2O_S3 | 1.380 | 0.562 | 110 | 191 | 81 | 100-200 C. | 8.8 |
| ZrCl4_2H2O_S2 | ZrCl4_5H2O_S2 | 1.341 | 0.649 | 183 | 228 | 44 | 200-300 C. | 0.8 |
| ZrBr2_1H2O_S2 | ZrBr2_8H2O_S3 | 1.351 | 0.627 | −31 | −31 | 0 | <50 C. | 38.6 |
| GaI3_1H2O_S2 | GaI3_8H2O_S2 | 1.402 | 0.501 | 18 | 18 | 0 | <50 C. | 35.8 |
| SnI2_4H2O_S2 | SnI2_12H2O_S1 | 1.319 | 0.687 | 73 | 73 | 0 | 50-100 C. | 0.0 |
| ZrCl3 | ZrCl3_3H2O_S9 | 1.343 | 0.640 | 95 | 95 | 0 | 50-100 C. | 20.2 |
| MoI4_S28 | MoI4_9H2O_S1 | 1.406 | 0.481 | −883 | 119 | 1001 | Large | 44.0 |
| | | | | | | | Hysteresis | |
| SiCl4_5H2O_S2 | SiCl4_9H2O_S1 | 1.260 | 0.787 | 68 | 210 | 142 | Large | 14.6 |
| | | | | | | | Hysteresis | |
| MnI4_S31 | MnI4_5H2O_S2 | 1.427 | 0.409 | 92 | 92 | 0 | 50-100 C. | 10.2 |
| RbF1_2H2O_S1 | RbF1_4H2O_S1 | 1.305 | 0.708 | 155 | 155 | 0 | 100-200 C. | 0.0 |
| WCl4_4H2O_S1 | WCl4_8H2O_S1 | 1.367 | 0.579 | 193 | 193 | 0 | 100-200 C. | 11.1 |
| BaCl2_6H2O_S1 | BaCl2_12H2O_S1 | 1.228 | 0.833 | 131 | 131 | 0 | 100-200 C. | 7.6 |
| VF2_9H2O_S2 | VF2_12H2O_S1 | 1.232 | 0.827 | 303 | 303 | 0 | 300-450 C. | 27.5 |
| SiBr4_4H2O_S1 | SiBr4_8H2O_S1 | 1.369 | 0.571 | 208 | 208 | 0 | 200-300 C. | 25.0 |
| GeF4_3H2O_S1 | GeF4_5H2O_S2 | 1.342 | 0.631 | 243 | 243 | 0 | 200-300 C. | 4.3 |
| PbBr4_3H2O_S1 | PbBr4_8H2O_S1 | 1.406 | 0.468 | 158 | 158 | 0 | 100-200 C. | 36.1 |
| PbBr2_2H2O_S5 | PbBr2_8H2O_S1 | 1.396 | 0.496 | −42 | 132 | 174 | Large | 31.0 |
| | | | | | | | Hysteresis | |
| TiF4_2H2O_S2 | TiF4_4H2O_S1 | 1.309 | 0.693 | 192 | 192 | 0 | 100-200 C. | 3.1 |
| PbCl2_2H2O_S5 | PbCl2_7H2O_S1 | 1.388 | 0.517 | −62 | 127 | 189 | Large | 31.8 |
| | | | | | | | Hysteresis | |
| ZrCl4 | ZrCl4_2H2O_S2 | 1.363 | 0.578 | 260 | 260 | 0 | 200-300 C. | 0.0 |
| TiF2_9H2O_S2 | TiF2_12H2O_S1 | 1.221 | 0.838 | 305 | 305 | 0 | 300-450 C. | 31.7 |
| ScF3_7H2O_S2 | ScF3_9H2O_S2 | 1.232 | 0.820 | 468 | 468 | 0 | 450-600 C. | 41.8 |
| NaCl1_2H2O_S2 | NaCl1_4H2O_S1 | 1.220 | 0.837 | 101 | 101 | 0 | 100-200 C. | 0.0 |
| NiI3_S25 | NiI3_7H2O_S1 | 1.393 | 0.498 | 2 | 2 | 0 | <50 C. | 18.9 |
| GeF2_2H2O_S5 | GeF2_6H2O_S3 | 1.320 | 0.666 | −139 | 92 | 231 | <50 C. | 29.3 |
| HfCl4_4H2O_S1 | HfCl4_8H2O_S1 | 1.353 | 0.593 | 199 | 199 | 0 | 100-200 C. | 0.0 |
| VF2_4H2O_S4 | VF2_8H2O_S2 | 1.269 | 0.755 | 28 | 28 | 0 | <50 C. | 20.7 |
| NiF3_6H2O_S2 | NiF3_9H2O_S2 | 1.278 | 0.738 | 195 | 195 | 0 | 100-200 C. | 4.5 |
| MnI3_S16 | MnI3_7H2O_S1 | 1.382 | 0.519 | −522 | 102 | 623 | Large | 34.4 |
| | | | | | | | Hysteresis | |
| NbI4 | NbI4_5H2O_S2 | 1.422 | 0.398 | 104 | 104 | 0 | 100-200 C. | 11.7 |
| CrF4_3H2O_S1 | CrF4_5H2O_S2 | 1.312 | 0.676 | 232 | 232 | 0 | 200-300 C. | 6.0 |
| PbI2_4H2O_S2 | PbI2_12H2O_S1 | 1.340 | 0.620 | 86 | 86 | 0 | 50-100 C. | 0.0 |
| CoF2_4H2O_S7 | CoF2_9H2O_S2 | 1.298 | 0.703 | −24 | −24 | 0 | <50 C. | 36.1 |
| CoCl2_8H2O_S2 | CoCl2_12H2O_S1 | 1.206 | 0.850 | 230 | 230 | 0 | 200-300 C. | 20.8 |
| TaBr3_S22 | TaBr3_4H2O_S2 | 1.421 | 0.396 | 61 | 61 | 0 | 50-100 C. | 16.7 |
| SiBr4 | SiBr4_4H2O_S1 | 1.397 | 0.473 | 67 | 67 | 0 | 50-100 C. | 25.0 |
| HfCl4_2H2O_S2 | HfCl4_5H2O_S2 | 1.379 | 0.520 | 192 | 238 | 46 | 200-300 C. | 0.5 |
| YI3_3H2O_S9 | YI3_7H2O_S2 | 1.387 | 0.496 | 189 | 247 | 58 | 200-300 C. | 4.7 |
| VI2_7H2O_S1 | VI2_12H2O_S1 | 1.292 | 0.706 | 231 | 231 | 0 | 200-300 C. | 21.6 |
| VI4_S17 | VI4_5H2O_S2 | 1.414 | 0.408 | 89 | 89 | 0 | 50-100 C. | 12.8 |
| MnF2_9H2O_S2 | MnF2_12H2O_S1 | 1.221 | 0.822 | 307 | 307 | 0 | 300-450 C. | 28.7 |
| VCl2_2H2O_S8 | VCl2_4H2O_S3 | 1.312 | 0.665 | 168 | 168 | 0 | 100-200 C. | 1.2 |
| MnF4_3H2O_S1 | MnF4_5H2O_S2 | 1.312 | 0.663 | 215 | 244 | 29 | 200-300 C. | 2.9 |
| HfCl4_4H2O_S1 | HfCl4_9H2O_S1 | 1.352 | 0.572 | −268 | 199 | 467 | Large | 14.9 |
| | | | | | | | Hysteresis | |
| MgBr2_2H2O_S8 | MgBr2_4H2O_S4 | 1.348 | 0.581 | 237 | 237 | 0 | 200-300 C. | 0.0 |
| RbCl1 | RbCl1_2H2O_S1 | 1.293 | 0.691 | 98 | 98 | 0 | 50-100 C. | 2.9 |
| SnF4_2H2O_S2 | SnF4_4H2O_S1 | 1.363 | 0.534 | 215 | 215 | 0 | 200-300 C. | 2.2 |
| RbBr1_1H2O_S1 | RbBr1_4H2O_S1 | 1.308 | 0.658 | 84 | 84 | 0 | 50-100 C. | 1.9 |
| VF4_1H2O_S1 | VF4_2H2O_S2 | 1.353 | 0.556 | 348 | 348 | 0 | 300-450 C. | 12.7 |
| NiI3_S25 | NiI3_8H2O_S2 | 1.372 | 0.504 | −21 | −21 | 0 | <50 C. | 29.5 |
| ZnF2_4H2O_S4 | ZnF2_8H2O_S2 | 1.277 | 0.710 | 28 | 28 | 0 | <50 C. | 20.5 |
| CoF2_4H2O_S7 | CoF2_8H2O_S1 | 1.283 | 0.699 | 15 | 15 | 0 | <50 C. | 23.4 |
| TiF3_3H2O_S8 | TiF3_8H2O_S2 | 1.277 | 0.705 | −32 | −32 | 0 | <50 C. | 47.5 |
| CrCl2_8H2O_S2 | CrCl2_12H2O_S1 | 1.174 | 0.865 | 229 | 229 | 0 | 200-300 C. | 24.2 |
| LiCl1_1H2O_S1 | LiCl1_2H2O_S2 | 1.239 | 0.769 | 140 | 140 | 0 | 100-200 C. | 0.0 |
| PbCl2_7H2O_S1 | PbCl2_12H2O_S1 | 1.274 | 0.708 | 207 | 207 | 0 | 200-300 C. | 31.8 |
| NiF2_9H2O_S2 | NiF2_12H2O_S1 | 1.229 | 0.783 | 286 | 286 | 0 | 200-300 C. | 24.5 |
| SnF2_2H2O_S5 | SnF2_6H2O_S3 | 1.330 | 0.592 | −93 | 84 | 178 | <50 C. | 24.0 |
| CoI2_6H2O_S3 | CoI2_12H2O_S1 | 1.289 | 0.676 | 135 | 135 | 0 | 100-200 C. | 11.6 |
| SiBr2_4H2O_S6 | SiBr2_8H2O_S1 | 1.271 | 0.709 | 130 | 130 | 0 | 100-200 C. | 23.6 |
| YBr3_3H2O_S9 | YBr3_6H2O_S2 | 1.362 | 0.510 | 236 | 236 | 0 | 200-300 C. | 3.2 |
| ZrBr2_7H2O_S1 | ZrBr2_12H2O_S1 | 1.254 | 0.737 | 198 | 198 | 0 | 100-200 C. | 41.2 |
| MoCl3 | MoCl3_2H2O_S1 | 1.346 | 0.549 | 175 | 175 | 0 | 100-200 C. | 0.0 |
| NiI2_7H2O_S1 | NiI2_12H2O_S1 | 1.289 | 0.671 | 213 | 213 | 0 | 200-300 C. | 37.0 |
| CaCl2_4H2O_S7 | CaCl2_8H2O_S2 | 1.149 | 0.885 | 114 | 114 | 0 | 100-200 C. | 12.3 |
| MnF3_6H2O_S3 | MnF3_9H2O_S2 | 1.242 | 0.748 | 195 | 195 | 0 | 100-200 C. | 14.0 |
| SnBr2_6H2O_S3 | SnBr2_12H2O_S1 | 1.255 | 0.725 | 136 | 136 | 0 | 100-200 C. | 20.3 |
| FeF2_4H2O_S7 | FeF2_8H2O_S2 | 1.254 | 0.726 | 23 | 23 | 0 | <50 C. | 7.2 |
| BaI2_2H2O_S9 | BaI2_7H2O_S1 | 1.357 | 0.508 | 87 | 87 | 0 | 50-100 C. | 12.7 |
| GaI3_4H2O_S1 | GaI3_9H2O_S2 | 1.341 | 0.547 | 186 | 186 | 0 | 100-200 C. | 34.6 |
| GeCl2_2H2O_S5 | GeCl2_7H2O_S1 | 1.275 | 0.685 | −132 | 149 | 281 | Large | 41.3 |
| | | | | | | | Hysteresis | |
| FeCl2_2H2O_S8 | FeCl2_4H2O_S3 | 1.299 | 0.636 | 160 | 160 | 0 | 100-200 C. | 7.9 |
| GeI2_1H2O_S2 | GeI2_4H2O_S3 | 1.373 | 0.453 | 139 | 139 | 0 | 100-200 C. | 39.3 |
| NiI2_6H2O_S3 | NiI2_12H2O_S1 | 1.281 | 0.667 | 130 | 130 | 0 | 100-200 C. | 14.7 |
| TaI4 | TaI4_5H2O_S2 | 1.402 | 0.346 | 96 | 96 | 0 | 50-100 C. | 13.4 |
| CuCl2_8H2O_S2 | CuCl2_12H2O_S1 | 1.188 | 0.820 | 220 | 220 | 0 | 200-300 C. | 29.2 |
| CrBr2_2H2O_S8 | CrBr2_4H2O_S3 | 1.346 | 0.514 | 227 | 227 | 0 | 200-300 C. | 12.2 |
| VCl2_8H2O_S2 | VCl2_12H2O_S1 | 1.160 | 0.855 | 222 | 222 | 0 | 200-300 C. | 13.0 |
| GeI4 | GeI4_9H2O_S1 | 1.349 | 0.505 | −317 | 53 | 370 | <50 C. | 17.2 |
| BaF2_1H2O_S1 | BaF2_2H2O_S1 | 1.378 | 0.419 | 334 | 334 | 0 | 300-450 C. | 46.7 |
| TaCl4 | TaCl4_3H2O_S1 | 1.366 | 0.454 | 117 | 117 | 0 | 100-200 C. | 17.9 |
| NbI3 | NbI3_4H2O_S2 | 1.380 | 0.410 | 110 | 110 | 0 | 100-200 C. | 11.1 |
| MnCl4_S1 | MnCl4_2H2O_S2 | 1.318 | 0.577 | 187 | 187 | 0 | 100-200 C. | 6.7 |
| SrF2_8H2O_S1 | SrF2_12H2O_S1 | 1.195 | 0.802 | 196 | 196 | 0 | 100-200 C. | 24.8 |
| ZrCl4_4H2O_S1 | ZrCl4_9H2O_S1 | 1.287 | 0.643 | −399 | 194 | 593 | Large | 21.1 |
| | | | | | | | Hysteresis | |
| MnCl2_2H2O_S8 | MnCl2_4H2O_S3 | 1.284 | 0.650 | 167 | 167 | 0 | 100-200 C. | 3.2 |
| VCl3 | VCl3_2H2O_S2 | 1.319 | 0.574 | 107 | 107 | 0 | 100-200 C. | 27.8 |
| MgF2_4H2O_S7 | MgF2_8H2O_S2 | 1.197 | 0.797 | 9 | 9 | 0 | <50 C. | 24.1 |
| TiCl2_8H2O_S2 | TiCl2_12H2O_S1 | 1.146 | 0.864 | 223 | 223 | 0 | 200-300 C. | 20.7 |
| ScBr3_3H2O_S9 | ScBr3_6H2O_S1 | 1.311 | 0.582 | 249 | 249 | 0 | 200-300 C. | 2.0 |
| 2-Feb | FeBr2_2H2O_S3 | 1.372 | 0.419 | 88 | 88 | 0 | 50-100 C. | 18.4 |
| MoF2_S16 | MoF2_1H2O_S2 | 1.395 | 0.333 | 73 | 73 | 0 | 50-100 C. | 0.0 |
| MoF3_3H2O_S9 | MoF3_7H2O_S1 | 1.303 | 0.598 | 13 | 13 | 0 | <50 C. | 43.1 |
| NiCl3_3H2O_S8 | NiCl3_6H2O_S3 | 1.274 | 0.657 | 137 | 137 | 0 | 100-200 C. | 9.6 |
| NiCl2_8H2O_S2 | NiCl2_12H2O_S1 | 1.177 | 0.817 | 211 | 211 | 0 | 200-300 C. | 18.1 |
| ZrI4 | ZrI4_4H2O_S1 | 1.379 | 0.388 | 147 | 198 | 51 | 100-200 C. | 2.5 |
| TiF3_6H2O_S3 | TiF3_9H2O_S2 | 1.200 | 0.782 | 204 | 204 | 0 | 200-300 C. | 12.5 |
| MnF3_3H2O_S8 | MnF3_6H2O_S3 | 1.269 | 0.662 | 60 | 60 | 0 | 50-100 C. | 14.0 |
| VF4_3H2O_S1 | VF4_5H2O_S2 | 1.264 | 0.671 | 226 | 226 | 0 | 200-300 C. | 8.2 |
| FeCl2_6H2O_S2 | FeCl2_9H2O_S2 | 1.222 | 0.741 | 216 | 216 | 0 | 200-300 C. | 24.8 |
| GeF2_4H2O_S2 | GeF2_9H2O_S1 | 1.253 | 0.684 | −17 | −17 | 0 | <50 C. | 20.6 |
| KI1 | KI1_3H2O_S1 | 1.303 | 0.581 | 19 | 19 | 0 | <50 C. | 25.6 |
| BaF2_7H2O_S1 | BaF2_12H2O_S1 | 1.215 | 0.748 | 128 | 128 | 0 | 100-200 C. | 18.8 |
| MnCl2_8H2O_S2 | MnCl2_12H2O_S1 | 1.147 | 0.847 | 223 | 223 | 0 | 200-300 C. | 17.2 |
| ZnF2_9H2O_S1 | ZnF2_12H2O_S1 | 1.203 | 0.766 | 286 | 286 | 0 | 200-300 C. | 25.2 |
| MoI4_S28 | MoI4_5H2O_S2 | 1.373 | 0.378 | 86 | 86 | 0 | 50-100 C. | 12.2 |
| KBr1 | KBr1_2H2O_S1 | 1.252 | 0.676 | 86 | 86 | 0 | 50-100 C. | 3.7 |
| AlF3_8H2O_S1 | AlF3_9H2O_S2 | 1.185 | 0.787 | 1054 | 1054 | 0 | >600 C. | 48.5 |
| SrBr2_7H2O_S1 | SrBr2_12H2O_S1 | 1.202 | 0.760 | 209 | 209 | 0 | 200-300 C. | 17.7 |
| ZnCl2_8H2O_S2 | ZnCl2_12H2O_S1 | 1.165 | 0.815 | 219 | 219 | 0 | 200-300 C. | 17.9 |
| RbF1_1H2O_S2 | RbF1_3H2O_S1 | 1.282 | 0.614 | −51 | 171 | 222 | Large | 28.3 |
| | | | | | | | Hysteresis | |
| PbI4_S19 | PbI4_9H2O_S1 | 1.351 | 0.437 | −39 | 65 | 104 | <50 C. | 16.2 |
| NbCl3_S22 | NbCl3_3H2O_S9 | 1.293 | 0.586 | 66 | 66 | 0 | 50-100 C. | 19.5 |
| PbI4_S19 | PbI4_8H2O_S1 | 1.361 | 0.404 | −45 | 65 | 110 | <50 C. | 14.4 |
| CuBr2_2H2O_S5 | CuBr2_4H2O_S3 | 1.335 | 0.480 | 213 | 213 | 0 | 200-300 C. | 35.3 |
| BeCl2_7H2O_S1 | BeCl2_12H2O_S1 | 1.120 | 0.871 | 80 | 80 | 0 | 50-100 C. | 2.4 |
| BeCl2_4H2O_S8 | BeCl2_8H2O_S1 | 1.161 | 0.815 | 40 | 40 | 0 | <50 C. | 7.4 |
| ZnI2_2H2O_S1 | ZnI2_6H2O_S3 | 1.337 | 0.473 | 73 | 73 | 0 | 50-100 C. | 14.6 |
| MnF3_7H2O_S1 | MnF3_9H2O_S2 | 1.214 | 0.732 | 414 | 414 | 0 | 300-450 C. | 34.6 |
| NaCl1_1H2O_S1 | NaCl1_3H2O_S1 | 1.183 | 0.779 | −52 | 106 | 158 | Large | 21.1 |
| | | | | | | | Hysteresis | |
| CrI2_6H2O_S3 | CrI2_12H2O_S1 | 1.238 | 0.681 | 133 | 133 | 0 | 100-200 C. | 2.5 |
| LaBr3_4H2O_S2 | LaBr3_9H2O_S2 | 1.265 | 0.629 | 92 | 345 | 252 | Large | 28.6 |
| | | | | | | | Hysteresis | |
| MnF2_4H2O_S7 | MnF2_8H2O_S2 | 1.212 | 0.724 | 21 | 21 | 0 | <50 C. | 21.5 |
| TiF4_3H2O_S1 | TiF4_5H2O_S2 | 1.236 | 0.683 | 227 | 227 | 0 | 200-300 C. | 3.9 |
| CaCl2_8H2O_S2 | CaCl2_12H2O_S1 | 1.099 | 0.886 | 224 | 224 | 0 | 200-300 C. | 12.3 |
| CrF2_4H2O_S7 | CrF2_8H2O_S1 | 1.218 | 0.712 | 12 | 12 | 0 | <50 C. | 22.6 |
| KI1_1H2O_S1 | KI1_4H2O_S1 | 1.248 | 0.657 | 84 | 84 | 0 | 50-100 C. | 2.7 |
| YI3_4H2O_S2 | YI3_8H2O_S2 | 1.320 | 0.496 | 181 | 312 | 132 | Large | 14.9 |
| | | | | | | | Hysteresis | |
| SnF2_4H2O_S2 | SnF2_9H2O_S1 | 1.269 | 0.614 | −5 | −5 | 0 | <50 C. | 19.7 |
| FeCl3_1H2O_S2 | FeCl3_4H2O_S1 | 1.258 | 0.634 | −111 | 154 | 265 | Large | 19.4 |
| | | | | | | | Hysteresis | |
| PbBr2_6H2O_S3 | PbBr2_12H2O_S1 | 1.259 | 0.627 | 145 | 145 | 0 | 100-200 C. | 20.7 |
| TiI4 | TiI4_4H2O_S1 | 1.351 | 0.387 | 143 | 143 | 0 | 100-200 C. | 3.1 |
| MoI3_3H2O_S4 | MoI3_9H2O_S2 | 1.297 | 0.532 | 115 | 115 | 0 | 100-200 C. | 22.8 |
| NbF3_6H2O_S1 | NbF3_9H2O_S2 | 1.214 | 0.701 | 227 | 227 | 0 | 200-300 C. | 19.2 |
| TiBr3_3H2O_S9 | TiBr3_6H2O_S3 | 1.298 | 0.530 | 206 | 206 | 0 | 200-300 C. | 1.6 |
| NbI3_3H2O_S9 | NbI3_9H2O_S2 | 1.291 | 0.545 | 49 | 196 | 147 | Large | 19.8 |
| | | | | | | | Hysteresis | |
| FeBr3_4H2O_S1 | FeBr3_9H2O_S2 | 1.262 | 0.609 | 109 | 109 | 0 | 100-200 C. | 12.3 |
| CoBr2 | CoBr2_2H2O_S8 | 1.338 | 0.416 | 90 | 90 | 0 | 50-100 C. | 14.2 |
| BeF2_4H2O_S8 | BeF2_7H2O_S1 | 1.151 | 0.796 | 41 | 41 | 0 | <50 C. | 1.3 |
| MoF4_3H2O_S1 | MoF4_5H2O_S2 | 1.275 | 0.577 | 245 | 245 | 0 | 200-300 C. | 3.2 |
| TiI3_4H2O_S2 | TiI3_9H2O_S2 | 1.280 | 0.564 | 155 | 227 | 72 | 100-200 C. | 8.5 |
| KF1_1H2O_S2 | KF1_2H2O_S1 | 1.196 | 0.724 | 194 | 194 | 0 | 100-200 C. | 5.3 |
| ZrBr2_1H2O_S2 | ZrBr2_7H2O_S1 | 1.290 | 0.538 | −41 | −41 | 0 | <50 C. | 41.2 |
| TiBr4 | TiBr4_3H2O_S1 | 1.326 | 0.440 | 151 | 151 | 0 | 100-200 C. | 5.8 |
| GeBr2 | GeBr2_2H2O_S5 | 1.329 | 0.427 | 120 | 120 | 0 | 100-200 C. | 5.9 |
| VF4 | VF4_1H2O_S1 | 1.306 | 0.490 | 214 | 214 | 0 | 200-300 C. | 12.7 |
| MnF2 | MnF2_1H2O_S2 | 1.313 | 0.462 | 78 | 78 | 0 | 50-100 C. | 20.3 |
| CrI2_7H2O_S1 | CrI2_12H2O_S1 | 1.219 | 0.671 | 206 | 206 | 0 | 200-300 C. | 25.1 |
| NbF3_7H2O_S2 | NbF3_9H2O_S2 | 1.205 | 0.696 | 470 | 470 | 0 | 450-600 C. | 40.8 |
| ZnBr2 | ZnBr2_2H2O_S8 | 1.328 | 0.414 | 98 | 98 | 0 | 50-100 C. | 17.4 |
| BaBr2 | BaBr2_2H2O_S4 | 1.338 | 0.379 | 146 | 172 | 25 | 100-200 C. | 0.0 |
| VI4_3H2O_S1 | VI4_8H2O_S1 | 1.319 | 0.440 | 150 | 150 | 0 | 100-200 C. | 14.8 |
| YCl3 | YCl3_2H2O_S2 | 1.265 | 0.577 | 184 | 184 | 0 | 100-200 C. | 10.0 |
| VCl3_3H2O_S9 | VCl3_7H2O_S2 | 1.224 | 0.657 | −393 | 192 | 585 | Large | 34.6 |
| | | | | | | | Hysteresis | |
| ZnBr2_2H2O_S8 | ZnBr2_4H2O_S3 | 1.308 | 0.466 | 201 | 201 | 0 | 200-300 C. | 17.4 |
| CrCl3 | CrCl3_2H2O_S2 | 1.278 | 0.538 | 85 | 85 | 0 | 50-100 C. | 31.6 |
| FeBr2_2H2O_S3 | FeBr2_4H2O_S3 | 1.301 | 0.477 | 197 | 197 | 0 | 100-200 C. | 18.4 |
| ScF3_3H2O_S8 | ScF3_8H2O_S2 | 1.207 | 0.678 | −44 | −44 | 0 | <50 C. | 45.3 |
| MnBr3_S12 | MnBr3_3H2O_S9 | 1.304 | 0.466 | 98 | 98 | 0 | 50-100 C. | 13.6 |
| CrBr4_4H2O_S1 | CrBr4_8H2O_S1 | 1.286 | 0.512 | 179 | 179 | 0 | 100-200 C. | 8.1 |
| SnBr2 | SnBr2_2H2O_S5 | 1.329 | 0.383 | 139 | 139 | 0 | 100-200 C. | 0.0 |
| SrI2_6H2O_S1 | SrI2_12H2O_S1 | 1.201 | 0.681 | 160 | 160 | 0 | 100-200 C. | 0.0 |
| NiI3_S25 | NiI3_9H2O_S2 | 1.270 | 0.541 | −25 | −25 | 0 | <50 C. | 31.8 |
| TiI4_3H2O_S1 | TiI4_8H2O_S1 | 1.306 | 0.446 | 155 | 155 | 0 | 100-200 C. | 2.0 |
| NbI4_3H2O_S1 | NbI4_8H2O_S1 | 1.312 | 0.429 | 165 | 165 | 0 | 100-200 C. | 16.3 |
| PbCl4_4H2O_S1 | PbCl4_8H2O_S1 | 1.270 | 0.538 | 181 | 181 | 0 | 100-200 C. | 0.2 |
| SiBr4_5H2O_S2 | SiBr4_9H2O_S1 | 1.266 | 0.547 | 129 | 229 | 101 | 100-200 C. | 20.9 |
| VF4_2H2O_S2 | VF4_4H2O_S1 | 1.228 | 0.627 | 154 | 154 | 0 | 100-200 C. | 5.9 |
| MnI3_S16 | MnI3_4H2O_S1 | 1.316 | 0.413 | 86 | 86 | 0 | 50-100 C. | 6.0 |
| GeI2_7H2O_S1 | GeI2_12H2O_S1 | 1.211 | 0.659 | 217 | 217 | 0 | 200-300 C. | 48.6 |
| SnCl2_2H2O_S5 | SnCl2_6H2O_S3 | 1.241 | 0.599 | −64 | 129 | 193 | Large | 22.9 |
| | | | | | | | Hysteresis | |
| SnF4 | SnF4_1H2O_S1 | 1.327 | 0.373 | 271 | 271 | 0 | 200-300 C. | 15.8 |
| CaI2_7H2O_S1 | CaI2_12H2O_S1 | 1.183 | 0.704 | 219 | 219 | 0 | 200-300 C. | 12.0 |
| HfI4_3H2O_S1 | HfI4_8H2O_S1 | 1.320 | 0.393 | 174 | 174 | 0 | 100-200 C. | 3.4 |
| TaI4_3H2O_S1 | TaI4_8H2O_S1 | 1.319 | 0.386 | 167 | 167 | 0 | 100-200 C. | 19.0 |
| BaI2_2H2O_S9 | BaI2_6H2O_S1 | 1.292 | 0.465 | 125 | 125 | 0 | 100-200 C. | 0.7 |
| NbBr3_4H2O_S2 | NbBr3_9H2O_S2 | 1.231 | 0.608 | 96 | 204 | 108 | Large | 13.1 |
| | | | | | | | Hysteresis | |
| ZrCl2_8H2O_S2 | ZrCl2_12H2O_S1 | 1.135 | 0.771 | 226 | 226 | 0 | 200-300 C. | 38.0 |
| BeBr2_4H2O_S8 | BeBr2_8H2O_S1 | 1.205 | 0.655 | 78 | 78 | 0 | 50-100 C. | 3.8 |
| CaF2_9H2O_S1 | CaF2_12H2O_S1 | 1.100 | 0.817 | 276 | 276 | 0 | 200-300 C. | 27.0 |
| FeI3_2H2O_S1 | FeI3_9H2O_S2 | 1.270 | 0.515 | 22 | 72 | 50 | <50 C. | 7.4 |
| SnF4_3H2O_S1 | SnF4_5H2O_S2 | 1.263 | 0.529 | 243 | 243 | 0 | 200-300 C. | 3.5 |
| WCl4 | WCl4_3H2O_S1 | 1.302 | 0.421 | 92 | 92 | 0 | 50-100 C. | 22.5 |
| MnF3_3H2O_S8 | MnF3_7H2O_S1 | 1.213 | 0.632 | −16 | −16 | 0 | <50 C. | 34.6 |
| PbBr2 | PbBr2_2H2O_S5 | 1.333 | 0.305 | 148 | 148 | 0 | 100-200 C. | 0.0 |
| GeCl2_8H2O_S1 | GeCl2_12H2O_S1 | 1.105 | 0.803 | 221 | 221 | 0 | 200-300 C. | 30.3 |
| AlI3_4H2O_S2 | AlI3_6H2O_S1 | 1.283 | 0.468 | 554 | 554 | 0 | 450-600 C. | 33.1 |
| MoI4_3H2O_S1 | MoI4_8H2O_S1 | 1.300 | 0.415 | 152 | 152 | 0 | 100-200 C. | 17.9 |
| MgBr2_8H2O_S2 | MgBr2_12H2O_S1 | 1.142 | 0.747 | 239 | 239 | 0 | 200-300 C. | 8.8 |
| PbCl2_2H2O_S5 | PbCl2_6H2O_S3 | 1.276 | 0.485 | −32 | 127 | 159 | Large | 19.9 |
| | | | | | | | Hysteresis | |
| VBr3_3H2O_S9 | VBr3_6H2O_S1 | 1.258 | 0.525 | 205 | 205 | 0 | 200-300 C. | 5.7 |
| WI4_3H2O_S1 | WI4_8H2O_S1 | 1.310 | 0.375 | 157 | 157 | 0 | 100-200 C. | 28.6 |
| YI3 | YI3_3H2O_S9 | 1.298 | 0.413 | 220 | 220 | 0 | 200-300 C. | 4.7 |
| YF3_6H2O_S2 | YF3_9H2O_S2 | 1.162 | 0.710 | 226 | 226 | 0 | 200-300 C. | 23.4 |
| LaCl3_3H2O_S2 | LaCl3_6H2O_S2 | 1.241 | 0.556 | 176 | 176 | 0 | 100-200 C. | 2.1 |
| BaBr2_6H2O_S1 | BaBr2_12H2O_S1 | 1.167 | 0.692 | 133 | 133 | 0 | 100-200 C. | 4.5 |
| VBr2_2H2O_S8 | VBr2_4H2O_S3 | 1.269 | 0.477 | 189 | 189 | 0 | 100-200 C. | 5.2 |
| ZrI4_3H2O_S1 | ZrI4_8H2O_S1 | 1.286 | 0.431 | 166 | 166 | 0 | 100-200 C. | 2.2 |
| YCl3_1H2O_S3 | YCl3_3H2O_S9 | 1.209 | 0.613 | 250 | 250 | 0 | 200-300 C. | 14.3 |
| NiF3_2H2O_S2 | NiF3_4H2O_S2 | 1.251 | 0.523 | −153 | 280 | 433 | Large | 30.9 |
| | | | | | | | Hysteresis | |
| SiI2_S25 | SiI2_6H2O_S3 | 1.253 | 0.513 | −44 | −44 | 0 | <50 C. | 48.9 |
| CoBr3_3H2O_S9 | CoBr3_6H2O_S3 | 1.271 | 0.467 | 160 | 160 | 0 | 100-200 C. | 24.7 |
| VBr4_4H2O_S1 | VBr4_8H2O_S1 | 1.253 | 0.510 | 177 | 177 | 0 | 100-200 C. | 7.4 |
| SnF2_1H2O_S2 | SnF2_2H2O_S5 | 1.288 | 0.410 | 268 | 268 | 0 | 200-300 C. | 38.5 |
| CrF2_9H2O_S1 | CrF2_12H2O_S1 | 1.121 | 0.754 | 254 | 254 | 0 | 200-300 C. | 21.3 |
| CoCl3_4H2O_S2 | CoCl3_6H2O_S3 | 1.208 | 0.604 | 292 | 292 | 0 | 200-300 C. | 32.0 |
| CrBr4_S17 | CrBr4_3H2O_S1 | 1.289 | 0.402 | 117 | 117 | 0 | 100-200 C. | 12.5 |
| TiBr4_4H2O_S1 | TiBr4_8H2O_S1 | 1.246 | 0.518 | 181 | 181 | 0 | 100-200 C. | 4.4 |
| MnI3_2H2O_S1 | MnI3_6H2O_S3 | 1.279 | 0.428 | 126 | 126 | 0 | 100-200 C. | 14.8 |
| CuBr2_4H2O_S3 | CuBr2_9H2O_S2 | 1.221 | 0.571 | 28 | 28 | 0 | <50 C. | 11.4 |
| AlCl3 | AlCl3_1H2O_S2 | 1.179 | 0.650 | 401 | 401 | 0 | 300-450 C. | 0.0 |
| MnBr4_4H2O_S1 | MnBr4_8H2O_S1 | 1.248 | 0.505 | 175 | 175 | 0 | 100-200 C. | 1.7 |
| LaI3 | LaI3_4H2O_S2 | 1.285 | 0.399 | 132 | 132 | 0 | 100-200 C. | 28.9 |
| VI3_4H2O_S2 | VI3_9H2O_S2 | 1.239 | 0.526 | 116 | 214 | 99 | 100-200 C. | 8.7 |
| PbBr4_S20 | PbBr4_5H2O_S2 | 1.292 | 0.370 | 40 | 40 | 0 | <50 C. | 19.2 |
| PbF4_2H2O_S2 | PbF4_4H2O_S1 | 1.285 | 0.390 | 154 | 248 | 95 | 200-300 C. | 3.1 |
| SrI2 | SrI2_2H2O_S7 | 1.296 | 0.350 | 171 | 187 | 16 | 100-200 C. | 0.0 |
| GaI3_1H2O_S2 | GaI3_7H2O_S1 | 1.268 | 0.442 | 18 | 18 | 0 | <50 C. | 34.7 |
| ZnI2 | ZnI2_2H2O_S1 | 1.282 | 0.382 | 191 | 191 | 0 | 100-200 C. | 0.0 |
| MoCl4 | MoCl4_2H2O_S2 | 1.244 | 0.486 | 183 | 183 | 0 | 100-200 C. | 6.5 |
| ZrBr4_4H2O_S1 | ZrBr4_9H2O_S1 | 1.248 | 0.475 | −240 | 184 | 424 | Large | 13.6 |
| | | | | | | | Hysteresis | |
| MnI4_3H2O_S1 | MnI4_8H2O_S1 | 1.265 | 0.426 | 139 | 139 | 0 | 100-200 C. | 10.7 |
| NbBr4_4H2O_S1 | NbBr4_8H2O_S1 | 1.242 | 0.482 | 186 | 186 | 0 | 100-200 C. | 7.1 |
| TiI3 | TiI3_3H2O_S9 | 1.273 | 0.391 | 158 | 158 | 0 | 100-200 C. | 8.4 |
| CrI4_3H2O_S2 | CrI4_8H2O_S1 | 1.264 | 0.416 | 128 | 128 | 0 | 100-200 C. | 0.0 |
| MnCl2_4H2O_S3 | MnCl2_8H2O_S2 | 1.104 | 0.741 | 70 | 70 | 0 | 50-100 C. | 17.2 |
| PbBr2_2H2O_S5 | PbBr2_7H2O_S1 | 1.263 | 0.415 | −75 | 132 | 207 | Large | 32.6 |
| | | | | | | | Hysteresis | |
| TiF4 | TiF4_1H2O_S1 | 1.236 | 0.491 | 205 | 205 | 0 | 200-300 C. | 6.9 |
| NbBr3_3H2O_S9 | NbBr3_6H2O_S3 | 1.245 | 0.465 | 195 | 195 | 0 | 100-200 C. | 21.0 |
| BeI2_4H2O_S8 | BeI2_9H2O_S1 | 1.200 | 0.571 | −96 | 99 | 195 | <50 C. | 7.6 |
| VBr4_S17 | VBr4_3H2O_S1 | 1.265 | 0.402 | 117 | 117 | 0 | 100-200 C. | 12.6 |
| GeI4_3H2O_S1 | GeI4_8H2O_S1 | 1.259 | 0.421 | 145 | 145 | 0 | 100-200 C. | 49.3 |
| FeCl3_3H2O_S8 | FeCl3_8H2O_S2 | 1.158 | 0.649 | −1 | −1 | 0 | <50 C. | 25.8 |
| PbBr2_7H2O_S1 | PbBr2_12H2O_S1 | 1.188 | 0.592 | 200 | 200 | 0 | 100-200 C. | 32.6 |
| NbF3_1H2O_S2 | NbF3_3H2O_S8 | 1.234 | 0.489 | 68 | 68 | 0 | 50-100 C. | 15.2 |
| AlCl3_7H2O_S1 | AlCl3_9H2O_S2 | 1.089 | 0.758 | 494 | 494 | 0 | 450-600 C. | 35.3 |
| CoBr2_8H2O_S2 | CoBr2_12H2O_S1 | 1.140 | 0.678 | 232 | 232 | 0 | 200-300 C. | 22.4 |
| ZrI3 | ZrI3_4H2O_S2 | 1.268 | 0.387 | 87 | 87 | 0 | 50-100 C. | 28.8 |
| MnBr3_3H2O_S9 | MnBr3_6H2O_S3 | 1.232 | 0.488 | 176 | 176 | 0 | 100-200 C. | 13.6 |
| TaBr4_4H2O_S1 | TaBr4_8H2O_S1 | 1.257 | 0.420 | 191 | 191 | 0 | 100-200 C. | 10.3 |
| SnI4_1H2O_S1 | SnI4_5H2O_S2 | 1.276 | 0.352 | 97 | 267 | 171 | Large | 0.0 |
| | | | | | | | Hysteresis | |
| WI4_S18 | WI4_5H2O_S2 | 1.286 | 0.313 | 62 | 62 | 0 | 50-100 C. | 15.8 |
| GaBr3 | GaBr3_2H2O_S1 | 1.255 | 0.421 | 225 | 225 | 0 | 200-300 C. | 0.0 |
| MnBr2_8H2O_S2 | MnBr2_12H2O_S1 | 1.124 | 0.699 | 243 | 243 | 0 | 200-300 C. | 22.0 |
| NaBr1 | NaBr1_1H2O_S1 | 1.231 | 0.483 | 127 | 127 | 0 | 100-200 C. | 0.0 |
| TiCl4 | TiCl4_2H2O_S2 | 1.195 | 0.563 | 162 | 162 | 0 | 100-200 C. | 7.1 |
| LiBr1_1H2O_S1 | LiBr1_2H2O_S3 | 1.206 | 0.538 | 180 | 180 | 0 | 100-200 C. | 0.0 |
| TaBr3_3H2O_S9 | TaBr3_6H2O_S3 | 1.260 | 0.391 | 199 | 199 | 0 | 100-200 C. | 32.7 |
| LaI1 | LaI1_4H2O_S1 | 1.261 | 0.387 | −49 | −49 | 0 | <50 C. | 41.5 |
| VBr2_4H2O_S3 | VBr2_8H2O_S2 | 1.166 | 0.617 | 102 | 102 | 0 | 100-200 C. | 14.6 |
| SnCl2_8H2O_S1 | SnCl2_12H2O_S1 | 1.095 | 0.734 | 237 | 237 | 0 | 200-300 C. | 31.9 |
| HfBr4_4H2O_S1 | HfBr4_8H2O_S1 | 1.248 | 0.423 | 192 | 192 | 0 | 100-200 C. | 0.0 |
| YF3 | YF3_2H2O_S2 | 1.223 | 0.490 | 32 | 32 | 0 | <50 C. | 24.5 |
| NaBr1_1H2O_S1 | NaBr1_3H2O_S1 | 1.169 | 0.605 | −20 | 124 | 144 | Large | 13.3 |
| | | | | | | | Hysteresis | |
| SnI4 | SnI4_2H2O_S2 | 1.276 | 0.319 | 267 | 634 | 366 | Large | 0.0 |
| | | | | | | | Hysteresis | |
| CrI4_S8 | CrI4_4H2O_S1 | 1.267 | 0.351 | −2 | 143 | 145 | Large | 11.6 |
| | | | | | | | Hysteresis | |
| BaI2 | BaI2_2H2O_S9 | 1.277 | 0.310 | 135 | 226 | 91 | 100-200 C. | 0.0 |
| AlI3 | AlI3_2H2O_S2 | 1.264 | 0.357 | 269 | 269 | 0 | 200-300 C. | 33.3 |
| VBr2_8H2O_S2 | VBr2_12H2O_S1 | 1.117 | 0.691 | 232 | 232 | 0 | 200-300 C. | 14.6 |
| MnBr2_2H2O_S8 | MnBr2_4H2O_S3 | 1.227 | 0.466 | 185 | 185 | 0 | 100-200 C. | 7.9 |
| MgBr2 | MgBr2_1H2O_S2 | 1.249 | 0.403 | 285 | 285 | 0 | 200-300 C. | 0.0 |
| TaBr3_4H2O_S2 | TaBr3_9H2O_S2 | 1.211 | 0.505 | 88 | 194 | 106 | 100-200 C. | 16.7 |
| MoBr4_4H2O_S1 | MoBr4_8H2O_S1 | 1.226 | 0.467 | 174 | 174 | 0 | 100-200 C. | 6.3 |
| TiBr2_8H2O_S2 | TiBr2_12H2O_S1 | 1.109 | 0.698 | 234 | 234 | 0 | 200-300 C. | 19.5 |
| ZrBr4_4H2O_S1 | ZrBr4_8H2O_S1 | 1.219 | 0.481 | 184 | 184 | 0 | 100-200 C. | 0.0 |
| NiCl3_4H2O_S2 | NiCl3_6H2O_S3 | 1.164 | 0.600 | 288 | 288 | 0 | 200-300 C. | 33.9 |
| LaI3 | LaI3_3H2O_S4 | 1.268 | 0.325 | 153 | 153 | 0 | 100-200 C. | 19.2 |
| SnF2_4H2O_S2 | SnF2_8H2O_S1 | 1.182 | 0.561 | 16 | 16 | 0 | <50 C. | 12.8 |
| MoF3_8H2O_S1 | MoF3_9H2O_S2 | 1.145 | 0.631 | 1090 | 1090 | 0 | >600 C. | 48.6 |
| NiF3_2H2O_S2 | NiF3_3H2O_S9 | 1.218 | 0.475 | 280 | 280 | 0 | 200-300 C. | 0.0 |
| NiBr2_8H2O_S2 | NiBr2_12H2O_S1 | 1.130 | 0.656 | 216 | 216 | 0 | 200-300 C. | 21.8 |
| CaI2 | CaI2_2H2O_S8 | 1.231 | 0.436 | 219 | 219 | 0 | 200-300 C. | 0.0 |
| SiCl4_5H2O_S2 | SiCl4_8H2O_S1 | 1.118 | 0.673 | 210 | 210 | 0 | 200-300 C. | 14.6 |
| ZrI3_4H2O_S2 | ZrI3_9H2O_S2 | 1.198 | 0.518 | 177 | 177 | 0 | 100-200 C. | 28.8 |
| SnI2_1H2O_S2 | SnI2_4H2O_S2 | 1.244 | 0.394 | 127 | 127 | 0 | 100-200 C. | 19.5 |
| MnCl4_4H2O_S1 | MnCl4_9H2O_S1 | 1.132 | 0.650 | −508 | 185 | 693 | Large | 26.2 |
| | | | | | | | Hysteresis | |
| SnCl4 | SnCl4_2H2O_S2 | 1.218 | 0.465 | 199 | 199 | 0 | 100-200 C. | 4.1 |
| PbCl2_4H2O_S3 | PbCl2_9H2O_S1 | 1.203 | 0.499 | 28 | 28 | 0 | <50 C. | 19.7 |
| RbI1 | RbI1_3H2O_S1 | 1.215 | 0.467 | 11 | 11 | 0 | <50 C. | 23.5 |
| VI3_S15 | VI3_3H2O_S9 | 1.248 | 0.370 | 137 | 137 | 0 | 100-200 C. | 10.9 |
| ZnBr2_8H2O_S2 | ZnBr2_12H2O_S1 | 1.121 | 0.661 | 227 | 227 | 0 | 200-300 C. | 19.3 |
| SrCl2_8H2O_S1 | SrCl2_12H2O_S1 | 1.048 | 0.771 | 222 | 222 | 0 | 200-300 C. | 18.2 |
| MgI2_2H2O_S8 | MgI2_4H2O_S4 | 1.220 | 0.447 | 263 | 263 | 0 | 200-300 C. | 0.0 |
| WF4_3H2O_S2 | WF4_5H2O_S2 | 1.229 | 0.417 | 227 | 227 | 0 | 200-300 C. | 9.8 |
| HfBr4_S31 | HfBr4_2H2O_S2 | 1.260 | 0.311 | 296 | 296 | 0 | 200-300 C. | 0.0 |
| TiF3_8H2O_S2 | TiF3_9H2O_S2 | 1.086 | 0.709 | 1023 | 1023 | 0 | >600 C. | 47.5 |
| CaCl2_2H2O_S2 | CaCl2_4H2O_S7 | 1.085 | 0.711 | 173 | 173 | 0 | 100-200 C. | 0.9 |
| LiF1_3H2O_S1 | LiF1_4H2O_S1 | 1.080 | 0.715 | 207 | 207 | 0 | 200-300 C. | 21.0 |
| GeF2_2H2O_S5 | GeF2_4H2O_S2 | 1.155 | 0.583 | 92 | 92 | 0 | 50-100 C. | 0.0 |
| FeCl2_4H2O_S3 | FeCl2_8H2O_S2 | 1.086 | 0.700 | 52 | 52 | 0 | 50-100 C. | 11.1 |
| VF2 | VF2_1H2O_S2 | 1.217 | 0.431 | 43 | 43 | 0 | <50 C. | 33.1 |
| MnI4_S31 | MnI4_4H2O_S1 | 1.244 | 0.342 | 98 | 98 | 0 | 50-100 C. | 7.5 |
| SiI2_4H2O_S6 | SiI2_8H2O_S1 | 1.161 | 0.560 | 136 | 136 | 0 | 100-200 C. | 27.0 |
| NbF4_3H2O_S2 | NbF4_5H2O_S2 | 1.166 | 0.549 | 214 | 214 | 0 | 200-300 C. | 1.7 |
| GeI2_6H2O_S3 | GeI2_12H2O_S1 | 1.131 | 0.616 | 109 | 109 | 0 | 100-200 C. | 19.8 |
| KCl1_2H2O_S1 | KCl1_4H2O_S1 | 1.028 | 0.776 | 117 | 117 | 0 | 100-200 C. | 4.1 |
| CuF1_1H2O_S2 | CuF1_2H2O_S3 | 1.198 | 0.473 | 111 | 111 | 0 | 100-200 C. | 0.0 |
| CoBr3_S16 | CoBr3_4H2O_S2 | 1.218 | 0.419 | −7 | −7 | 0 | <50 C. | 36.7 |
| LaCl3 | LaCl3_2H2O_S1 | 1.228 | 0.384 | 96 | 96 | 0 | 50-100 C. | 22.2 |
| RbI1_1H2O_S1 | RbI1_4H2O_S1 | 1.169 | 0.530 | 71 | 71 | 0 | 50-100 C. | 2.6 |
| ZrF3_6H2O_S3 | ZrF3_9H2O_S2 | 1.103 | 0.654 | 190 | 190 | 0 | 100-200 C. | 26.7 |
| NiBr3_3H2O_S7 | NiBr3_6H2O_S3 | 1.201 | 0.450 | 144 | 144 | 0 | 100-200 C. | 21.3 |
| FeBr2_6H2O_S2 | FeBr2_9H2O_S2 | 1.150 | 0.565 | 215 | 215 | 0 | 200-300 C. | 23.4 |
| MnF4_5H2O_S2 | MnF4_9H2O_S1 | 1.129 | 0.603 | −228 | 115 | 343 | Large | 13.0 |
| | | | | | | | Hysteresis | |
| VCl2 | VCl2_1H2O_S2 | 1.189 | 0.472 | 179 | 179 | 0 | 100-200 C. | 0.0 |
| CuBr2_8H2O_S2 | CuBr2_12H2O_S1 | 1.104 | 0.641 | 209 | 209 | 0 | 200-300 C. | 30.4 |
| SrI2_1H2O_S1 | SrI2_4H2O_S4 | 1.197 | 0.442 | 131 | 171 | 40 | 100-200 C. | 7.3 |
| TiF4_1H2O_S1 | TiF4_2H2O_S2 | 1.173 | 0.503 | 278 | 278 | 0 | 200-300 C. | 6.9 |
| BeBr2 | BeBr2_1H2O_S1 | 1.200 | 0.432 | 280 | 280 | 0 | 200-300 C. | 36.2 |
| MoBr4_S18 | MoBr4_3H2O_S1 | 1.222 | 0.365 | 118 | 118 | 0 | 100-200 C. | 12.5 |
| CuF2_9H2O_S1 | CuF2_12H2O_S1 | 1.074 | 0.684 | 223 | 223 | 0 | 200-300 C. | 17.2 |
| FeF2_8H2O_S2 | FeF2_12H2O_S1 | 1.077 | 0.679 | 87 | 87 | 0 | 50-100 C. | 7.2 |
| BaBr2_7H2O_S1 | BaBr2_12H2O_S1 | 1.095 | 0.649 | 183 | 183 | 0 | 100-200 C. | 19.3 |
| VI4_S17 | VI4_4H2O_S1 | 1.227 | 0.340 | 94 | 94 | 0 | 50-100 C. | 10.4 |
| ScI3_3H2O_S9 | ScI3_6H2O_S1 | 1.192 | 0.444 | 268 | 268 | 0 | 200-300 C. | 5.8 |
| BaI2_1H2O_S1 | BaI2_4H2O_S6 | 1.216 | 0.374 | 116 | 135 | 19 | 100-200 C. | 2.3 |
| YI3_3H2O_S9 | YI3_6H2O_S2 | 1.209 | 0.394 | 247 | 247 | 0 | 200-300 C. | 4.7 |
| LiBr1_2H2O_S3 | LiBr1_4H2O_S1 | 1.115 | 0.612 | 48 | 71 | 23 | 50-100 C. | 0.0 |
| NbBr4 | NbBr4_3H2O_S1 | 1.213 | 0.373 | 124 | 124 | 0 | 100-200 C. | 13.8 |
| SnBr4 | SnBr4_3H2O_S1 | 1.216 | 0.362 | 134 | 134 | 0 | 100-200 C. | 3.1 |
| SiCl4 | SiCl4_3H2O_S2 | 1.108 | 0.612 | 40 | 40 | 0 | <50 C. | 34.2 |
| ZrBr2_8H2O_S3 | ZrBr2_12H2O_S1 | 1.091 | 0.641 | 240 | 240 | 0 | 200-300 C. | 38.6 |
| KF1_3H2O_S1 | KF1_4H2O_S1 | 1.037 | 0.721 | 370 | 370 | 0 | 300-450 C. | 29.3 |
| BeI2_4H2O_S8 | BeI2_8H2O_S1 | 1.144 | 0.533 | 99 | 99 | 0 | 50-100 C. | 0.0 |
| SnI2_6H2O_S3 | SnI2_12H2O_S1 | 1.118 | 0.582 | 118 | 118 | 0 | 100-200 C. | 19.5 |
| NiBr2 | NiBr2_2H2O_S5 | 1.215 | 0.335 | 19 | 19 | 0 | <50 C. | 33.3 |
| ZrCl4_4H2O_S1 | ZrCl4_10H2O_S1 | 1.127 | 0.560 | −414 | 194 | 608 | Large | 39.8 |
| | | | | | | | Hysteresis | |
| MoI3_4H2O_S2 | MoI3_9H2O_S2 | 1.163 | 0.477 | 145 | 145 | 0 | 100-200 C. | 29.4 |
| MnCl4_2H2O_S2 | MnCl4_4H2O_S1 | 1.128 | 0.553 | 236 | 236 | 0 | 200-300 C. | 6.7 |
| LiI1_1H2O_S1 | LiI1_2H2O_S3 | 1.175 | 0.443 | 243 | 243 | 0 | 200-300 C. | 5.4 |
| HfI4 | HfI4_3H2O_S1 | 1.220 | 0.295 | 136 | 271 | 135 | 200-300 C. | 3.4 |
| PbI2_1H2O_S2 | PbI2_4H2O_S2 | 1.212 | 0.327 | 125 | 125 | 0 | 100-200 C. | 26.8 |
| VF4_5H2O_S2 | VF4_8H2O_S1 | 1.074 | 0.650 | 129 | 129 | 0 | 100-200 C. | 0.0 |
| CaBr2_8H2O_S2 | CaBr2_12H2O_S1 | 1.039 | 0.703 | 228 | 228 | 0 | 200-300 C. | 11.1 |
| HfBr4_4H2O_S1 | HfBr4_9H2O_S1 | 1.192 | 0.390 | −368 | 192 | 560 | Large | 19.6 |
| | | | | | | | Hysteresis | |
| TaI3_S15 | TaI3_4H2O_S2 | 1.216 | 0.310 | 63 | 63 | 0 | 50-100 C. | 16.3 |
| SiF4_5H2O_S2 | SiF4_8H2O_S1 | 1.063 | 0.664 | 103 | 103 | 0 | 100-200 C. | 0.0 |
| FeCl3_1H2O_S2 | FeCl3_3H2O_S8 | 1.113 | 0.577 | 154 | 154 | 0 | 100-200 C. | 0.0 |
| LaBr3_3H2O_S2 | LaBr3_6H2O_S2 | 1.179 | 0.423 | 197 | 197 | 0 | 100-200 C. | 1.4 |
| SnI4_1H2O_S1 | SnI4_9H2O_S1 | 1.182 | 0.411 | −150 | 267 | 417 | Large | 37.2 |
| | | | | | | | Hysteresis | |
| CrF4_5H2O_S2 | CrF4_8H2O_S1 | 1.076 | 0.633 | 121 | 121 | 0 | 100-200 C. | 0.0 |
| BeCl2_4H2O_S8 | BeCl2_7H2O_S1 | 1.029 | 0.708 | 60 | 60 | 0 | 50-100 C. | 2.4 |
| NbI4 | NbI4_4H2O_S1 | 1.204 | 0.328 | 105 | 105 | 0 | 100-200 C. | 10.7 |
| PbI2_6H2O_S3 | PbI2_12H2O_S1 | 1.132 | 0.523 | 132 | 132 | 0 | 100-200 C. | 19.6 |
| HfBr4_2H2O_S2 | HfBr4_5H2O_S2 | 1.197 | 0.346 | 164 | 210 | 46 | 100-200 C. | 2.1 |
| SnBr2_2H2O_S5 | SnBr2_6H2O_S3 | 1.154 | 0.464 | −51 | 120 | 172 | Large | 20.3 |
| | | | | | | | Hysteresis | |
| HfBr4_4H2O_S1 | HfBr4_10H2O_S1 | 1.180 | 0.391 | −296 | 192 | 488 | Large | 29.6 |
| | | | | | | | Hysteresis | |
| MnF4_5H2O_S2 | MnF4_8H2O_S1 | 1.076 | 0.618 | 115 | 115 | 0 | 100-200 C. | 0.0 |
| VI2 | VI2_2H2O_S8 | 1.192 | 0.340 | 124 | 124 | 0 | 100-200 C. | 12.8 |
| PbCl2_8H2O_S1 | PbCl2_12H2O_S1 | 1.083 | 0.602 | 237 | 237 | 0 | 200-300 C. | 29.3 |
| FeF3_8H2O_S2 | FeF3_9H2O_S2 | 1.069 | 0.625 | 904 | 904 | 0 | >600 C. | 39.0 |
| GeCl4 | GeCl4_3H2O_S1 | 1.130 | 0.504 | 36 | 36 | 0 | <50 C. | 32.7 |
| NbBr3_S12 | NbBr3_3H2O_S9 | 1.173 | 0.394 | 75 | 75 | 0 | 50-100 C. | 21.0 |
| RbBr1 | RbBr1_2H2O_S1 | 1.127 | 0.510 | 79 | 79 | 0 | 50-100 C. | 1.1 |
| AlCl3_6H2O_S1 | AlCl3_9H2O_S2 | 1.013 | 0.705 | 202 | 202 | 0 | 200-300 C. | 0.0 |
| ScF3_8H2O_S2 | ScF3_9H2O_S2 | 1.026 | 0.683 | 962 | 962 | 0 | >600 C. | 45.3 |
| ZrBr2_1H2O_S2 | ZrBr2_6H2O_S3 | 1.145 | 0.456 | −49 | −49 | 0 | <50 C. | 41.9 |
| CrCl4_S19 | CrCl4_2H2O_S2 | 1.131 | 0.488 | 111 | 111 | 0 | 100-200 C. | 15.4 |
| SrI2_7H2O_S1 | SrI2_12H2O_S1 | 1.071 | 0.607 | 191 | 191 | 0 | 100-200 C. | 9.5 |
| CrBr2_4H2O_S3 | CrBr2_8H2O_S2 | 1.104 | 0.545 | 59 | 59 | 0 | 50-100 C. | 15.0 |
| NiBr3_4H2O_S2 | NiBr3_6H2O_S3 | 1.152 | 0.431 | 328 | 328 | 0 | 300-450 C. | 46.2 |
| GaCl3_1H2O_S2 | GaCl3_3H2O_S9 | 1.113 | 0.521 | 137 | 137 | 0 | 100-200 C. | 11.6 |
| SnI2_7H2O_S1 | SnI2_12H2O_S1 | 1.090 | 0.567 | 185 | 185 | 0 | 100-200 C. | 35.1 |
| PbBr2_2H2O_S5 | PbBr2_6H2O_S3 | 1.165 | 0.388 | −47 | 132 | 179 | Large | 20.7 |
| | | | | | | | Hysteresis | |
| ZrBr4_2H2O_S2 | ZrBr4_5H2O_S2 | 1.161 | 0.399 | 150 | 207 | 56 | 100-200 C. | 2.6 |
| LaI3_3H2O_S4 | LaI3_6H2O_S2 | 1.169 | 0.374 | 263 | 263 | 0 | 200-300 C. | 19.2 |
| CoI3_S25 | CoI3_7H2O_S1 | 1.151 | 0.424 | −39 | −39 | 0 | <50 C. | 36.2 |
| CrI2 | CrI2_2H2O_S8 | 1.178 | 0.338 | 123 | 123 | 0 | 100-200 C. | 11.3 |
| PbF2_8H2O_S1 | PbF2_12H2O_S1 | 1.097 | 0.545 | 157 | 157 | 0 | 100-200 C. | 17.2 |
| TiF4_5H2O_S2 | TiF4_8H2O_S1 | 1.041 | 0.645 | 121 | 121 | 0 | 100-200 C. | 0.0 |
| NaBr1_2H2O_S3 | NaBr1_4H2O_S1 | 1.076 | 0.584 | 77 | 77 | 0 | 50-100 C. | 0.0 |
| ScBr3_S25 | ScBr3_2H2O_S2 | 1.159 | 0.394 | 159 | 159 | 0 | 100-200 C. | 25.3 |
| VCl4 | VCl4_2H2O_S2 | 1.115 | 0.502 | 120 | 120 | 0 | 100-200 C. | 15.3 |
| CrI4_3H2O_S2 | CrI4_9H2O_S1 | 1.151 | 0.413 | −240 | 128 | 368 | Large | 13.5 |
| | | | | | | | Hysteresis | |
| ZrBr3 | ZrBr3_3H2O_S9 | 1.153 | 0.406 | 84 | 84 | 0 | 50-100 C. | 23.3 |
| MoBr3 | MoBr3_3H2O_S9 | 1.161 | 0.382 | 67 | 67 | 0 | 50-100 C. | 19.8 |
| GeCl2_2H2O_S5 | GeCl2_4H2O_S2 | 1.081 | 0.571 | 149 | 149 | 0 | 100-200 C. | 0.0 |
| GeBr4 | GeBr4_4H2O_S1 | 1.162 | 0.378 | 27 | 27 | 0 | <50 C. | 7.0 |
| BaI2_6H2O_S1 | BaI2_12H2O_S1 | 1.076 | 0.580 | 129 | 129 | 0 | 100-200 C. | 0.7 |
| MgF2 | MgF2_1H2O_S2 | 1.119 | 0.489 | −4 | −4 | 0 | <50 C. | 31.4 |
| SnF2_8H2O_S1 | SnF2_12H2O_S1 | 1.045 | 0.632 | 130 | 130 | 0 | 100-200 C. | 12.8 |
| VCl4_5H2O_S2 | VCl4_8H2O_S1 | 1.054 | 0.612 | 198 | 198 | 0 | 100-200 C. | 5.0 |
| TaF4_3H2O_S2 | TaF4_5H2O_S2 | 1.150 | 0.404 | 207 | 207 | 0 | 200-300 C. | 0.8 |
| KI1 | KI1_2H2O_S3 | 1.111 | 0.500 | 73 | 73 | 0 | 50-100 C. | 3.0 |
| MnCl2 | MnCl2_1H2O_S2 | 1.131 | 0.454 | 174 | 174 | 0 | 100-200 C. | 0.0 |
| SnBr4_2H2O_S2 | SnBr4_5H2O_S2 | 1.159 | 0.375 | 179 | 179 | 0 | 100-200 C. | 14.9 |
| NbF4_5H2O_S2 | NbF4_8H2O_S1 | 1.070 | 0.583 | 143 | 143 | 0 | 100-200 C. | 0.0 |
| ZrF3_7H2O_S1 | ZrF3_9H2O_S2 | 1.047 | 0.621 | 387 | 387 | 0 | 300-450 C. | 39.4 |
| SiI2_S25 | SiI2_4H2O_S6 | 1.129 | 0.453 | 2 | 2 | 0 | <50 C. | 27.0 |
| BeCl2_8H2O_S1 | BeCl2_12H2O_S1 | 0.960 | 0.747 | 106 | 106 | 0 | 100-200 C. | 7.4 |
| ZrBr4_4H2O_S1 | ZrBr4_10H2O_S1 | 1.133 | 0.434 | −309 | 184 | 493 | Large | 30.7 |
| | | | | | | | Hysteresis | |
| YCl3_4H2O_S2 | YCl3_6H2O_S2 | 1.090 | 0.531 | 278 | 278 | 0 | 200-300 C. | 12.8 |
| MnCl4_5H2O_S2 | MnCl4_8H2O_S1 | 1.053 | 0.600 | 194 | 194 | 0 | 100-200 C. | 2.0 |
| FeCl3_3H2O_S8 | FeCl3_6H2O_S3 | 1.080 | 0.550 | 67 | 67 | 0 | 50-100 C. | 5.8 |
| GeCl4_5H2O_S2 | GeCl4_8H2O_S1 | 1.060 | 0.581 | 202 | 202 | 0 | 200-300 C. | 14.8 |
| CrCl4_5H2O_S2 | CrCl4_8H2O_S1 | 1.049 | 0.602 | 191 | 191 | 0 | 100-200 C. | 5.4 |
| LiF1 | LiF1_1H2O_S1 | 1.069 | 0.564 | −103 | −103 | 0 | <50 C. | 47.7 |
| CrBr2_8H2O_S2 | CrBr2_12H2O_S1 | 1.027 | 0.635 | 192 | 192 | 0 | 100-200 C. | 15.0 |
| VCl3_7H2O_S2 | VCl3_9H2O_S2 | 1.001 | 0.674 | 464 | 464 | 0 | 450-600 C. | 34.6 |
| TiCl4_5H2O_S2 | TiCl4_8H2O_S1 | 1.036 | 0.617 | 197 | 197 | 0 | 100-200 C. | 2.2 |
| CoF3_8H2O_S2 | CoF3_9H2O_S2 | 1.048 | 0.596 | 862 | 862 | 0 | >600 C. | 35.6 |
| TaBr4_S18 | TaBr4_3H2O_S1 | 1.167 | 0.300 | 107 | 107 | 0 | 100-200 C. | 17.8 |
| NiBr3_S25 | NiBr3_3H2O_S7 | 1.146 | 0.367 | 23 | 23 | 0 | <50 C. | 21.3 |
| TaI4 | TaI4_4H2O_S1 | 1.170 | 0.281 | 93 | 93 | 0 | 50-100 C. | 13.7 |
| HfCl4_4H2O_S1 | HfCl4_10H2O_S1 | 1.114 | 0.453 | −440 | 199 | 638 | Large | 42.1 |
| | | | | | | | Hysteresis | |
| GeF4_5H2O_S2 | GeF4_8H2O_S1 | 1.057 | 0.573 | 110 | 110 | 0 | 100-200 C. | 0.0 |
| MoF4_5H2O_S2 | MoF4_8H2O_S1 | 1.065 | 0.555 | 128 | 128 | 0 | 100-200 C. | 0.0 |
| ZrCl2_1H2O_S2 | ZrCl2_6H2O_S3 | 1.080 | 0.525 | −79 | −79 | 0 | <50 C. | 48.8 |
| MoI4_S28 | MoI4_4H2O_S1 | 1.160 | 0.309 | 84 | 84 | 0 | 50-100 C. | 12.2 |
| LaCl3_4H2O_S1 | LaCl3_6H2O_S2 | 1.094 | 0.490 | 320 | 320 | 0 | 300-450 C. | 28.4 |
| BaCl2_8H2O_S1 | BaCl2_12H2O_S1 | 0.992 | 0.673 | 216 | 216 | 0 | 200-300 C. | 23.0 |
| AlF3_2H2O_S2 | AlF3_3H2O_S9 | 1.071 | 0.536 | 234 | 234 | 0 | 200-300 C. | 6.7 |
| CrI3 | CrI3_4H2O_S1 | 1.146 | 0.349 | 29 | 29 | 0 | <50 C. | 40.6 |
| GeCl2_4H2O_S2 | GeCl2_9H2O_S2 | 1.025 | 0.620 | −14 | −14 | 0 | <50 C. | 25.1 |
| MgCl2_1H2O_S2 | MgCl2_2H2O_S8 | 1.049 | 0.576 | 245 | 245 | 0 | 200-300 C. | 0.0 |
| GeCl2_1H2O_S2 | GeCl2_2H2O_S5 | 1.094 | 0.478 | 315 | 315 | 0 | 300-450 C. | 35.2 |
| PbBr4_4H2O_S1 | PbBr4_8H2O_S1 | 1.132 | 0.377 | 160 | 160 | 0 | 100-200 C. | 24.8 |
| CoBr3_S16 | CoBr3_3H2O_S9 | 1.136 | 0.363 | 19 | 19 | 0 | <50 C. | 24.7 |
| CuF1_2H2O_S3 | CuF1_4H2O_S1 | 1.075 | 0.514 | −1 | −1 | 0 | <50 C. | 10.4 |
| YI3_4H2O_S2 | YI3_7H2O_S2 | 1.120 | 0.400 | 189 | 312 | 123 | Large | 14.9 |
| | | | | | | | Hysteresis | |
| PbBr2_4H2O_S3 | PbBr2_9H2O_S1 | 1.115 | 0.411 | 25 | 25 | 0 | <50 C. | 18.1 |
| CrCl3_6H2O_S3 | CrCl3_9H2O_S2 | 0.988 | 0.655 | 206 | 206 | 0 | 200-300 C. | 3.4 |
| PbI2_7H2O_S1 | PbI2_12H2O_S1 | 1.076 | 0.498 | 189 | 189 | 0 | 100-200 C. | 32.3 |
| MnCl3_4H2O_S2 | MnCl3_6H2O_S3 | 1.039 | 0.566 | 249 | 249 | 0 | 200-300 C. | 17.5 |
| ScF3_3H2O_S8 | ScF3_7H2O_S2 | 1.033 | 0.573 | −49 | −49 | 0 | <50 C. | 41.8 |
| TaF4_5H2O_S2 | TaF4_8H2O_S1 | 1.086 | 0.463 | 151 | 151 | 0 | 100-200 C. | 0.0 |
| ScCl3_6H2O_S1 | ScCl3_9H2O_S2 | 0.963 | 0.683 | 216 | 216 | 0 | 200-300 C. | 0.1 |
| CaBr2_2H2O_S3 | CaBr2_4H2O_S3 | 1.079 | 0.476 | 170 | 170 | 0 | 100-200 C. | 1.7 |
| CrI3 | CrI3_3H2O_S9 | 1.131 | 0.333 | 97 | 97 | 0 | 50-100 C. | 13.8 |
| GaCl3_6H2O_S1 | GaCl3_9H2O_S2 | 0.997 | 0.624 | 209 | 209 | 0 | 200-300 C. | 4.5 |
| SrBr2_8H2O_S1 | SrBr2_12H2O_S1 | 0.994 | 0.629 | 226 | 226 | 0 | 200-300 C. | 16.3 |
| GeBr2_8H2O_S1 | GeBr2_12H2O_S1 | 0.999 | 0.618 | 202 | 202 | 0 | 200-300 C. | 27.1 |
| ZrF4_5H2O_S2 | ZrF4_8H2O_S1 | 1.029 | 0.566 | 129 | 129 | 0 | 100-200 C. | 4.9 |
| ZrBr4_S31 | ZrBr4_2H2O_S2 | 1.123 | 0.335 | 239 | 239 | 0 | 200-300 C. | 0.0 |
| MnI2 | MnI2_2H2O_S8 | 1.125 | 0.328 | 115 | 115 | 0 | 100-200 C. | 9.7 |
| NbCl4_5H2O_S2 | NbCl4_8H2O_S1 | 1.034 | 0.551 | 203 | 203 | 0 | 200-300 C. | 5.6 |
| CsF1_1H2O_S2 | CsF1_3H2O_S1 | 1.097 | 0.404 | −127 | 151 | 278 | Large | 24.0 |
| | | | | | | | Hysteresis | |
| SnF4_5H2O_S2 | SnF4_8H2O_S1 | 1.050 | 0.513 | 124 | 124 | 0 | 100-200 C. | 0.0 |
| LaI2_7H2O_S1 | LaI2_12H2O_S1 | 1.036 | 0.541 | 178 | 178 | 0 | 100-200 C. | 39.1 |
| MoCl4_2H2O_S2 | MoCl4_4H2O_S1 | 1.068 | 0.474 | 230 | 230 | 0 | 200-300 C. | 6.5 |
| GaI3 | GaI3_4H2O_S1 | 1.117 | 0.341 | −9 | 153 | 162 | Large | 34.6 |
| | | | | | | | Hysteresis | |
| MgI2_6H2O_S2 | MgI2_9H2O_S2 | 1.063 | 0.482 | 211 | 211 | 0 | 200-300 C. | 0.4 |
| SnF2_2H2O_S5 | SnF2_4H2O_S2 | 1.074 | 0.456 | 84 | 84 | 0 | 50-100 C. | 0.0 |
| CrCl2_4H2O_S3 | CrCl2_8H2O_S2 | 0.982 | 0.627 | 14 | 14 | 0 | <50 C. | 24.2 |
| CrI2_2H2O_S8 | CrI2_4H2O_S3 | 1.108 | 0.358 | 190 | 190 | 0 | 100-200 C. | 11.3 |
| TiF3_3H2O_S8 | TiF3_7H2O_S2 | 1.028 | 0.544 | −58 | −58 | 0 | <50 C. | 48.7 |
| SiBr4_5H2O_S2 | SiBr4_8H2O_S1 | 1.073 | 0.447 | 229 | 229 | 0 | 200-300 C. | 20.9 |
| BaF2_8H2O_S1 | BaF2_12H2O_S1 | 0.990 | 0.609 | 135 | 135 | 0 | 100-200 C. | 15.0 |
| MoCl4_5H2O_S2 | MoCl4_8H2O_S1 | 1.029 | 0.539 | 197 | 197 | 0 | 100-200 C. | 2.0 |
| SnBr2_4H2O_S3 | SnBr2_9H2O_S1 | 1.065 | 0.464 | 7 | 7 | 0 | <50 C. | 20.7 |
| TiBr3 | TiBr3_2H2O_S2 | 1.108 | 0.346 | 110 | 110 | 0 | 100-200 C. | 27.6 |
| TaI3_3H2O_S9 | TaI3_6H2O_S3 | 1.117 | 0.312 | 203 | 203 | 0 | 200-300 C. | 33.9 |
| ZnBr2_4H2O_S3 | ZnBr2_8H2O_S2 | 1.037 | 0.518 | 55 | 55 | 0 | 50-100 C. | 19.3 |
| CaCl2_9H2O_S2 | CaCl2_12H2O_S1 | 0.902 | 0.728 | 270 | 270 | 0 | 200-300 C. | 15.4 |
| CoBr3_4H2O_S2 | CoBr3_6H2O_S3 | 1.088 | 0.400 | 283 | 283 | 0 | 200-300 C. | 36.7 |
| NbI3_3H2O_S9 | NbI3_6H2O_S3 | 1.102 | 0.353 | 196 | 196 | 0 | 100-200 C. | 19.8 |
| PbF4_3H2O_S2 | PbF4_5H2O_S2 | 1.098 | 0.361 | 188 | 188 | 0 | 100-200 C. | 0.0 |
| WF4_5H2O_S2 | WF4_8H2O_S1 | 1.070 | 0.437 | 130 | 130 | 0 | 100-200 C. | 0.0 |
| BaBr2_1H2O_S1 | BaBr2_4H2O_S1 | 1.083 | 0.400 | 23 | 146 | 124 | Large | 20.0 |
| | | | | | | | Hysteresis | |
| GaCl3_7H2O_S1 | GaCl3_9H2O_S2 | 0.978 | 0.612 | 436 | 436 | 0 | 300-450 C. | 30.2 |
| CuCl1 | CuCl1_2H2O_S3 | 1.069 | 0.433 | −73 | −73 | 0 | <50 C. | 45.2 |
| WBr4 | WBr4_3H2O_S1 | 1.117 | 0.280 | 84 | 84 | 0 | 50-100 C. | 21.5 |
| CrI4_4H2O_S1 | CrI4_8H2O_S1 | 1.094 | 0.360 | 161 | 161 | 0 | 100-200 C. | 11.6 |
| GeF2_9H2O_S1 | GeF2_12H2O_S1 | 0.960 | 0.634 | 200 | 200 | 0 | 200-300 C. | 20.6 |
| MgCl2_9H2O_S2 | MgCl2_12H2O_S1 | 0.900 | 0.717 | 237 | 237 | 0 | 200-300 C. | 6.5 |
| MgI2_8H2O_S3 | MgI2_12H2O_S1 | 0.997 | 0.574 | 195 | 267 | 72 | 200-300 C. | 3.2 |
| PbI4_S19 | PbI4_5H2O_S1 | 1.108 | 0.307 | 65 | 65 | 0 | 50-100 C. | 0.0 |
| TiCl3_6H2O_S3 | TiCl3_9H2O_S2 | 0.943 | 0.658 | 202 | 202 | 0 | 200-300 C. | 1.5 |
| FeI3_3H2O_S7 | FeI3_9H2O_S2 | 1.062 | 0.431 | 22 | 22 | 0 | <50 C. | 7.4 |
| ZrI4 | ZrI4_3H2O_S1 | 1.105 | 0.303 | 141 | 198 | 57 | 100-200 C. | 2.2 |
| ZrCl4_5H2O_S2 | ZrCl4_8H2O_S1 | 1.006 | 0.546 | 197 | 197 | 0 | 100-200 C. | 0.8 |
| LaCl1 | LaCl1_3H2O_S1 | 1.077 | 0.388 | −71 | −71 | 0 | <50 C. | 48.6 |
| FeI3_2H2O_S1 | FeI3_8H2O_S2 | 1.073 | 0.399 | −25 | 72 | 97 | <50 C. | 19.3 |
| TiI3_3H2O_S9 | TiI3_6H2O_S1 | 1.075 | 0.391 | 206 | 206 | 0 | 200-300 C. | 8.4 |
| FeCl3 | FeCl3_1H2O_S2 | 1.030 | 0.494 | 337 | 337 | 0 | 300-450 C. | 0.0 |
| PbCl4 | PbCl4_2H2O_S2 | 1.092 | 0.334 | 167 | 167 | 0 | 100-200 C. | 4.7 |
| VI3_3H2O_S9 | VI3_6H2O_S1 | 1.075 | 0.384 | 200 | 200 | 0 | 100-200 C. | 10.9 |
| PbBr2_8H2O_S1 | PbBr2_12H2O_S1 | 1.021 | 0.509 | 235 | 235 | 0 | 200-300 C. | 31.0 |
| TiI2_8H2O_S2 | TiI2_12H2O_S1 | 0.997 | 0.553 | 218 | 218 | 0 | 200-300 C. | 15.7 |
| CoI2_8H2O_S3 | CoI2_12H2O_S1 | 1.008 | 0.529 | 206 | 206 | 0 | 200-300 C. | 21.8 |
| WCl4_5H2O_S2 | WCl4_8H2O_S1 | 1.048 | 0.444 | 203 | 203 | 0 | 200-300 C. | 9.5 |
| RbF1_1H2O_S2 | RbF1_2H2O_S1 | 1.040 | 0.462 | 171 | 171 | 0 | 100-200 C. | 0.0 |
| NaCl1_1H2O_S1 | NaCl1_2H2O_S2 | 0.974 | 0.586 | 106 | 106 | 0 | 100-200 C. | 0.0 |
| VI2_8H2O_S3 | VI2_12H2O_S1 | 0.997 | 0.544 | 213 | 213 | 0 | 200-300 C. | 11.4 |
| NaI1 | NaI1_1H2O_S1 | 1.074 | 0.362 | 143 | 143 | 0 | 100-200 C. | 0.8 |
| NiI2_8H2O_S3 | NiI2_12H2O_S1 | 1.004 | 0.523 | 200 | 200 | 0 | 200-300 C. | 23.5 |
| TaCl4_5H2O_S2 | TaCl4_8H2O_S1 | 1.040 | 0.448 | 205 | 205 | 0 | 200-300 C. | 7.3 |
| ZrF4_2H2O_S1 | ZrF4_3H2O_S2 | 1.063 | 0.388 | 314 | 314 | 0 | 300-450 C. | 17.2 |
| CaI2_8H2O_S2 | CaI2_12H2O_S1 | 0.972 | 0.579 | 232 | 232 | 0 | 200-300 C. | 11.5 |
| SnCl4_5H2O_S2 | SnCl4_8H2O_S1 | 1.010 | 0.508 | 196 | 196 | 0 | 100-200 C. | 1.1 |
| GeBr2_2H2O_S5 | GeBr2_4H2O_S2 | 1.051 | 0.410 | 155 | 155 | 0 | 100-200 C. | 5.9 |
| CrCl3_7H2O_S2 | CrCl3_9H2O_S2 | 0.939 | 0.623 | 410 | 410 | 0 | 300-450 C. | 26.7 |
| NbI3_4H2O_S2 | NbI3_9H2O_S2 | 1.038 | 0.438 | 49 | 198 | 149 | Large | 11.1 |
| | | | | | | | Hysteresis | |
| MnI2_8H2O_S3 | MnI2_12H2O_S1 | 0.985 | 0.544 | 216 | 216 | 0 | 200-300 C. | 16.3 |
| FeI2_2H2O_S8 | FeI2_4H2O_S3 | 1.074 | 0.336 | 166 | 166 | 0 | 100-200 C. | 14.8 |
| ZrCl2_9H2O_S2 | ZrCl2_12H2O_S1 | 0.930 | 0.632 | 273 | 273 | 0 | 200-300 C. | 32.7 |
| AlBr3 | AlBr3_1H2O_S2 | 1.061 | 0.367 | 443 | 443 | 0 | 300-450 C. | 0.0 |
| ZnI2_8H2O_S3 | ZnI2_12H2O_S1 | 0.994 | 0.522 | 205 | 205 | 0 | 200-300 C. | 18.2 |
| HfF4_5H2O_S2 | HfF4_8H2O_S1 | 1.031 | 0.442 | 129 | 129 | 0 | 100-200 C. | 0.9 |
| CrI4_S8 | CrI4_3H2O_S2 | 1.080 | 0.297 | 143 | 143 | 0 | 100-200 C. | 0.0 |
| CoCl2 | CoCl2_1H2O_S2 | 1.054 | 0.376 | 108 | 108 | 0 | 100-200 C. | 7.5 |
| YBr3_S7 | YBr3_2H2O_S2 | 1.060 | 0.354 | 169 | 169 | 0 | 100-200 C. | 17.5 |
| VI4_4H2O_S1 | VI4_8H2O_S1 | 1.060 | 0.354 | 152 | 152 | 0 | 100-200 C. | 10.4 |
| GeBr2_4H2O_S2 | GeBr2_9H2O_S2 | 1.000 | 0.497 | −4 | −4 | 0 | <50 C. | 21.5 |
| TiI4_4H2O_S1 | TiI4_8H2O_S1 | 1.057 | 0.361 | 160 | 160 | 0 | 100-200 C. | 3.1 |
| SnCl2_4H2O_S2 | SnCl2_9H2O_S2 | 0.980 | 0.535 | −15 | −15 | 0 | <50 C. | 27.7 |
| RbCl1_2H2O_S1 | RbCl1_4H2O_S1 | 0.952 | 0.585 | 113 | 113 | 0 | 100-200 C. | 2.9 |
| TiI4 | TiI4_3H2O_S1 | 1.076 | 0.300 | 145 | 145 | 0 | 100-200 C. | 2.0 |
| HfI4_4H2O_S1 | HfI4_8H2O_S1 | 1.069 | 0.319 | 180 | 180 | 0 | 100-200 C. | 4.3 |
| BaI2_7H2O_S1 | BaI2_12H2O_S1 | 0.982 | 0.529 | 167 | 167 | 0 | 100-200 C. | 12.7 |
| SnBr2_8H2O_S1 | SnBr2_12H2O_S1 | 0.966 | 0.558 | 200 | 200 | 0 | 100-200 C. | 24.7 |
| FeBr2_4H2O_S3 | FeBr2_8H2O_S2 | 0.987 | 0.515 | 44 | 44 | 0 | <50 C. | 13.9 |
| HfCl4_5H2O_S2 | HfCl4_8H2O_S1 | 1.019 | 0.447 | 201 | 201 | 0 | 200-300 C. | 0.5 |
| FeI2_7H2O_S1 | FeI2_9H2O_S2 | 1.023 | 0.436 | 432 | 432 | 0 | 300-450 C. | 40.6 |
| CaCl2 | CaCl2_1H2O_S2 | 0.983 | 0.521 | 187 | 187 | 0 | 100-200 C. | 0.0 |
| CuBr2 | CuBr2_2H2O_S5 | 1.067 | 0.311 | 3 | 3 | 0 | <50 C. | 35.3 |
| MnBr2_4H2O_S3 | MnBr2_8H2O_S2 | 0.981 | 0.520 | 46 | 46 | 0 | <50 C. | 22.0 |
| SnCl4_2H2O_S2 | SnCl4_4H2O_S1 | 1.021 | 0.435 | 202 | 244 | 42 | 200-300 C. | 4.1 |
| KBr1_2H2O_S1 | KBr1_4H2O_S1 | 0.947 | 0.578 | 105 | 105 | 0 | 100-200 C. | 3.7 |
| VCl3_6H2O_S1 | VCl3_9H2O_S2 | 0.919 | 0.619 | 179 | 179 | 0 | 100-200 C. | 0.0 |
| TaI4_4H2O_S1 | TaI4_8H2O_S1 | 1.063 | 0.311 | 170 | 170 | 0 | 100-200 C. | 13.7 |
| AlBr3_7H2O_S1 | AlBr3_9H2O_S2 | 0.984 | 0.507 | 471 | 471 | 0 | 450-600 C. | 34.8 |
| YF3_7H2O_S2 | YF3_9H2O_S2 | 0.943 | 0.577 | 335 | 335 | 0 | 300-450 C. | 26.9 |
| FeI2_4H2O_S3 | FeI2_8H2O_S1 | 1.017 | 0.433 | 63 | 63 | 0 | 50-100 C. | 10.4 |
| NbI4_4H2O_S1 | NbI4_8H2O_S1 | 1.049 | 0.343 | 165 | 165 | 0 | 100-200 C. | 10.7 |
| LaF3_6H2O_S2 | LaF3_9H2O_S2 | 0.964 | 0.537 | 166 | 166 | 0 | 100-200 C. | 18.2 |
| MoF3_2H2O_S1 | MoF3_3H2O_S9 | 1.032 | 0.391 | 281 | 281 | 0 | 200-300 C. | 4.5 |
| MnCl2_9H2O_S2 | MnCl2_12H2O_S1 | 0.887 | 0.655 | 239 | 239 | 0 | 200-300 C. | 14.0 |
| MgCl2_4H2O_S7 | MgCl2_6H2O_S3 | 0.943 | 0.570 | 124 | 124 | 0 | 100-200 C. | 10.0 |
| NiBr3_S25 | NiBr3_4H2O_S2 | 1.038 | 0.370 | −39 | −39 | 0 | <50 C. | 46.2 |
| ZrCl4_2H2O_S2 | ZrCl4_4H2O_S1 | 0.997 | 0.469 | 207 | 228 | 21 | 200-300 C. | 0.0 |
| NbF3_8H2O_S2 | NbF3_9H2O_S2 | 0.954 | 0.551 | 904 | 904 | 0 | >600 C. | 41.7 |
| TiCl2_9H2O_S2 | TiCl2_12H2O_S1 | 0.879 | 0.663 | 234 | 234 | 0 | 200-300 C. | 15.7 |
| FeI2 | FeI2_2H2O_S8 | 1.060 | 0.297 | 78 | 78 | 0 | 50-100 C. | 14.8 |
| VCl2_9H2O_S2 | VCl2_12H2O_S1 | 0.886 | 0.653 | 231 | 231 | 0 | 200-300 C. | 10.1 |
| KCl1_3H2O_S1 | KCl1_4H2O_S1 | 0.878 | 0.663 | 392 | 392 | 0 | 300-450 C. | 39.4 |
| VBr3_S31 | VBr3_2H2O_S2 | 1.054 | 0.314 | 78 | 78 | 0 | 50-100 C. | 33.4 |
| GaI3 | GaI3_3H2O_S2 | 1.049 | 0.329 | 83 | 153 | 71 | 100-200 C. | 7.1 |
| RbF1_3H2O_S1 | RbF1_4H2O_S1 | 0.966 | 0.524 | 361 | 361 | 0 | 300-450 C. | 28.3 |
| MnBr4_S31 | MnBr4_3H2O_S2 | 1.046 | 0.335 | 55 | 55 | 0 | 50-100 C. | 37.5 |
| LaBr3 | LaBr3_2H2O_S1 | 1.058 | 0.295 | 146 | 146 | 0 | 100-200 C. | 14.5 |
| LaBr3_4H2O_S2 | LaBr3_6H2O_S2 | 1.032 | 0.371 | 345 | 345 | 0 | 300-450 C. | 28.6 |
| CrI2_8H2O_S3 | CrI2_12H2O_S1 | 0.960 | 0.528 | 199 | 199 | 0 | 100-200 C. | 16.2 |
| FeBr3_1H2O_S2 | FeBr3_4H2O_S1 | 1.031 | 0.372 | 39 | 39 | 0 | <50 C. | 12.3 |
| WI4_4H2O_S1 | WI4_8H2O_S1 | 1.053 | 0.302 | 159 | 159 | 0 | 100-200 C. | 19.5 |
| MoI4_4H2O_S1 | MoI4_8H2O_S1 | 1.043 | 0.333 | 153 | 153 | 0 | 100-200 C. | 12.2 |
| YCl3_6H2O_S2 | YCl3_10H2O_S2 | 0.956 | 0.534 | −231 | 171 | 402 | Large | 12.4 |
| | | | | | | | Hysteresis | |
| GeI4_4H2O_S1 | GeI4_8H2O_S1 | 1.037 | 0.347 | 157 | 157 | 0 | 100-200 C. | 36.8 |
| CrBr4_5H2O_S2 | CrBr4_8H2O_S1 | 1.015 | 0.404 | 202 | 202 | 0 | 200-300 C. | 10.5 |
| ZrI4_4H2O_S1 | ZrI4_8H2O_S1 | 1.035 | 0.347 | 169 | 169 | 0 | 100-200 C. | 2.5 |
| HfCl4_2H2O_S2 | HfCl4_4H2O_S1 | 1.026 | 0.371 | 212 | 238 | 26 | 200-300 C. | 0.0 |
| VF3_2H2O_S2 | VF3_3H2O_S8 | 0.996 | 0.445 | 220 | 220 | 0 | 200-300 C. | 4.2 |
| FeCl2 | FeCl2_1H2O_S2 | 1.022 | 0.381 | 104 | 104 | 0 | 100-200 C. | 8.2 |
| YBr3_4H2O_S2 | YBr3_6H2O_S2 | 1.021 | 0.382 | 299 | 299 | 0 | 200-300 C. | 13.7 |
| TiI2_S16 | TiI2_2H2O_S3 | 1.048 | 0.300 | 74 | 74 | 0 | 50-100 C. | 24.9 |
| GeCl2_9H2O_S2 | GeCl2_12H2O_S1 | 0.881 | 0.639 | 252 | 252 | 0 | 200-300 C. | 25.1 |
| SrF2_2H2O_S1 | SrF2_4H2O_S4 | 0.975 | 0.484 | 54 | 54 | 0 | 50-100 C. | 6.3 |
| KCl1 | KCl1_1H2O_S1 | 0.928 | 0.567 | 86 | 86 | 0 | 50-100 C. | 5.9 |
| NiCl3_7H2O_S1 | NiCl3_9H2O_S1 | 0.938 | 0.545 | 338 | 338 | 0 | 300-450 C. | 34.0 |
| PbF2_2H2O_S4 | PbF2_4H2O_S4 | 1.036 | 0.320 | 75 | 75 | 0 | 50-100 C. | 1.2 |
| SnCl2_1H2O_S2 | SnCl2_2H2O_S5 | 1.019 | 0.370 | 298 | 298 | 0 | 200-300 C. | 32.5 |
| TaCl3_S22 | TaCl3_3H2O_S9 | 1.027 | 0.343 | −6 | −6 | 0 | <50 C. | 34.9 |
| FeI3_S3 | FeI3_4H2O_S1 | 1.033 | 0.320 | −196 | 73 | 269 | <50 C. | 23.0 |
| SnI4_1H2O_S1 | SnI4_4H2O_S1 | 1.044 | 0.283 | 93 | 267 | 175 | Large | 0.4 |
| | | | | | | | Hysteresis | |
| SnF2_9H2O_S1 | SnF2_12H2O_S1 | 0.925 | 0.560 | 204 | 204 | 0 | 200-300 C. | 19.7 |
| BeI2_7H2O_S1 | BeI2_12H2O_S1 | 0.946 | 0.524 | 54 | 135 | 80 | 50-100 C. | 2.3 |
| TiCl3_7H2O_S2 | TiCl3_9H2O_S2 | 0.887 | 0.618 | 397 | 397 | 0 | 300-450 C. | 24.5 |
| VCl3_4H2O_S2 | VCl3_6H2O_S1 | 0.941 | 0.529 | 208 | 208 | 0 | 200-300 C. | 3.0 |
| SnCl2_2H2O_S5 | SnCl2_4H2O_S2 | 0.980 | 0.449 | 129 | 129 | 0 | 100-200 C. | 0.0 |
| PbI2_4H2O_S2 | PbI2_9H2O_S1 | 1.019 | 0.349 | 25 | 25 | 0 | <50 C. | 15.4 |
| ScF3_3H2O_S8 | ScF3_6H2O_S3 | 0.939 | 0.525 | −21 | −21 | 0 | <50 C. | 29.9 |
| WI4_S18 | WI4_4H2O_S1 | 1.047 | 0.246 | 49 | 49 | 0 | <50 C. | 19.5 |
| SiI2_6H2O_S3 | SiI2_8H2O_S1 | 0.968 | 0.467 | 408 | 408 | 0 | 300-450 C. | 48.9 |
| PbBr4_S20 | PbBr4_4H2O_S1 | 1.035 | 0.287 | 21 | 21 | 0 | <50 C. | 24.8 |
| NiCl2_9H2O_S2 | NiCl2_12H2O_S1 | 0.882 | 0.612 | 210 | 210 | 0 | 200-300 C. | 12.1 |
| MnI4_4H2O_S1 | MnI4_8H2O_S1 | 1.015 | 0.342 | 140 | 140 | 0 | 100-200 C. | 7.5 |
| BaBr2_8H2O_S1 | BaBr2_12H2O_S1 | 0.920 | 0.546 | 207 | 207 | 0 | 200-300 C. | 19.0 |
| ZnCl2_9H2O_S2 | ZnCl2_12H2O_S1 | 0.877 | 0.613 | 220 | 220 | 0 | 200-300 C. | 12.3 |
| ZrCl2 | ZrCl2_1H2O_S2 | 1.022 | 0.314 | 114 | 114 | 0 | 100-200 C. | 0.0 |
| SnCl2_9H2O_S2 | SnCl2_12H2O_S1 | 0.887 | 0.595 | 278 | 278 | 0 | 200-300 C. | 27.7 |
| MoI3 | MoI3_4H2O_S2 | 1.026 | 0.296 | 5 | 5 | 0 | <50 C. | 29.4 |
| ScF3_2H2O_S2 | ScF3_3H2O_S8 | 0.956 | 0.475 | 235 | 235 | 0 | 200-300 C. | 16.6 |
| ScBr3_4H2O_S2 | ScBr3_6H2O_S1 | 0.975 | 0.433 | 309 | 309 | 0 | 300-450 C. | 12.5 |
| CoCl2_9H2O_S2 | CoCl2_12H2O_S1 | 0.872 | 0.614 | 212 | 212 | 0 | 200-300 C. | 11.3 |
| NbI3 | NbI3_3H2O_S9 | 1.025 | 0.295 | 83 | 83 | 0 | 50-100 C. | 19.8 |
| VCl2_4H2O_S3 | VCl2_6H2O_S3 | 0.939 | 0.503 | 123 | 123 | 0 | 100-200 C. | 5.9 |
| VBr4_5H2O_S2 | VBr4_8H2O_S1 | 0.986 | 0.402 | 199 | 199 | 0 | 100-200 C. | 9.7 |
| YBr3_6H2O_S2 | YBr3_10H2O_S2 | 0.972 | 0.429 | −94 | 166 | 260 | Large | 6.3 |
| | | | | | | | Hysteresis | |
| PbF4 | PbF4_1H2O_S1 | 1.042 | 0.196 | 131 | 131 | 0 | 100-200 C. | 33.7 |
| MnBr4_5H2O_S2 | MnBr4_8H2O_S1 | 0.982 | 0.397 | 198 | 198 | 0 | 100-200 C. | 6.1 |
| MnCl3_S25 | MnCl3_2H2O_S2 | 0.970 | 0.419 | 10 | 10 | 0 | <50 C. | 44.3 |
| MnI3_S16 | MnI3_3H2O_S7 | 1.011 | 0.304 | 66 | 66 | 0 | 50-100 C. | 12.2 |
| PbCl4_5H2O_S2 | PbCl4_8H2O_S1 | 0.971 | 0.411 | 190 | 190 | 0 | 100-200 C. | 2.1 |
| ScI3_S9 | ScI3_2H2O_S2 | 1.014 | 0.289 | 184 | 184 | 0 | 100-200 C. | 20.3 |
| TiBr4_5H2O_S2 | TiBr4_8H2O_S1 | 0.971 | 0.404 | 199 | 199 | 0 | 100-200 C. | 6.8 |
| RbI1 | RbI1_2H2O_S3 | 0.979 | 0.384 | 54 | 54 | 0 | 50-100 C. | 5.5 |
| CuF2_4H2O_S7 | CuF2_6H2O_S3 | 0.953 | 0.442 | 45 | 45 | 0 | <50 C. | 9.4 |
| CrI2_4H2O_S3 | CrI2_8H2O_S3 | 0.960 | 0.426 | 55 | 55 | 0 | 50-100 C. | 16.2 |
| CuI2_4H2O_S2 | CuI2_9H2O_S2 | 0.969 | 0.402 | −9 | −9 | 0 | <50 C. | 14.1 |
| LaCl1 | LaCl1_2H2O_S1 | 1.004 | 0.305 | −53 | −53 | 0 | <50 C. | 38.0 |
| HfF4_2H2O_S1 | HfF4_3H2O_S2 | 1.015 | 0.262 | 281 | 281 | 0 | 200-300 C. | 11.6 |
| CuBr1 | CuBr1_2H2O_S3 | 0.994 | 0.334 | −68 | −68 | 0 | <50 C. | 43.4 |
| FeCl3_3H2O_S8 | FeCl3_7H2O_S2 | 0.920 | 0.495 | −28 | −28 | 0 | <50 C. | 29.8 |
| FeF2_9H2O_S2 | FeF2_12H2O_S1 | 0.883 | 0.557 | 121 | 121 | 0 | 100-200 C. | 10.0 |
| MnBr3_4H2O_S2 | MnBr3_6H2O_S3 | 0.970 | 0.384 | 257 | 257 | 0 | 200-300 C. | 22.7 |
| NaCl1_3H2O_S1 | NaCl1_4H2O_S1 | 0.859 | 0.590 | 254 | 254 | 0 | 200-300 C. | 21.1 |
| LaI2_8H2O_S1 | LaI2_12H2O_S1 | 0.924 | 0.483 | 230 | 230 | 0 | 200-300 C. | 39.4 |
| HfI4 | HfI4_2H2O_S1 | 1.018 | 0.220 | 271 | 271 | 0 | 200-300 C. | 0.0 |
| CuI2_2H2O_S1 | CuI2_4H2O_S2 | 0.994 | 0.307 | 137 | 137 | 0 | 100-200 C. | 24.7 |
| ScCl3_7H2O_S2 | ScCl3_9H2O_S2 | 0.848 | 0.602 | 373 | 373 | 0 | 300-450 C. | 19.1 |
| MnI3_3H2O_S7 | MnI3_6H2O_S3 | 0.985 | 0.330 | 137 | 137 | 0 | 100-200 C. | 12.2 |
| PbI4_1H2O_S1 | PbI4_5H2O_S1 | 1.000 | 0.277 | 109 | 109 | 0 | 100-200 C. | 32.9 |
| BaF2_2H2O_S1 | BaF2_4H2O_S1 | 0.975 | 0.356 | 28 | 28 | 0 | <50 C. | 8.0 |
| SrCl2_1H2O_S1 | SrCl2_2H2O_S4 | 0.966 | 0.377 | 230 | 230 | 0 | 200-300 C. | 14.6 |
| NbBr4_5H2O_S2 | NbBr4_8H2O_S1 | 0.965 | 0.375 | 203 | 203 | 0 | 200-300 C. | 8.3 |
| CaBr2 | CaBr2_1H2O_S2 | 0.975 | 0.347 | 245 | 245 | 0 | 200-300 C. | 0.0 |
| HfCl3_6H2O_S3 | HfCl3_9H2O_S2 | 0.919 | 0.471 | 207 | 207 | 0 | 200-300 C. | 19.6 |
| FeCl3_7H2O_S2 | FeCl3_9H2O_S2 | 0.872 | 0.553 | 341 | 341 | 0 | 300-450 C. | 29.8 |
| ZrCl3_6H2O_S3 | ZrCl3_9H2O_S2 | 0.867 | 0.560 | 187 | 187 | 0 | 100-200 C. | 7.1 |
| GeI2_2H2O_S5 | GeI2_4H2O_S3 | 0.979 | 0.323 | 168 | 168 | 0 | 100-200 C. | 27.1 |
| CrCl2 | CrCl2_1H2O_S2 | 0.958 | 0.381 | 95 | 95 | 0 | 50-100 C. | 24.1 |
| PbCl2_2H2O_S5 | PbCl2_4H2O_S3 | 0.975 | 0.333 | 127 | 127 | 0 | 100-200 C. | 0.0 |
| TaBr4_5H2O_S2 | TaBr4_8H2O_S1 | 0.975 | 0.326 | 207 | 207 | 0 | 200-300 C. | 10.2 |
| MoBr4_5H2O_S2 | MoBr4_8H2O_S1 | 0.959 | 0.365 | 193 | 193 | 0 | 100-200 C. | 8.4 |
| VCl2_4H2O_S3 | VCl2_7H2O_S1 | 0.889 | 0.511 | 17 | 17 | 0 | <50 C. | 27.8 |
| SnI2_4H2O_S2 | SnI2_9H2O_S1 | 0.954 | 0.377 | 3 | 3 | 0 | <50 C. | 17.8 |
| SrF2_9H2O_S1 | SrF2_12H2O_S1 | 0.851 | 0.571 | 173 | 173 | 0 | 100-200 C. | 13.2 |
| TaCl3_S22 | TaCl3_2H2O_S1 | 0.980 | 0.297 | 56 | 56 | 0 | 50-100 C. | 11.7 |
| MgBr2_1H2O_S2 | MgBr2_2H2O_S8 | 0.959 | 0.360 | 270 | 270 | 0 | 200-300 C. | 0.0 |
| MgI2 | MgI2_1H2O_S2 | 0.988 | 0.268 | 270 | 270 | 0 | 200-300 C. | 3.5 |
| SiBr4 | SiBr4_3H2O_S1 | 0.972 | 0.316 | 17 | 17 | 0 | <50 C. | 39.1 |
| SrCl2_9H2O_S1 | SrCl2_12H2O_S1 | 0.822 | 0.605 | 244 | 244 | 0 | 200-300 C. | 15.7 |
| CrCl2_9H2O_S2 | CrCl2_12H2O_S1 | 0.821 | 0.605 | 196 | 196 | 0 | 100-200 C. | 11.2 |
| FeI3_2H2O_S1 | FeI3_6H2O_S3 | 0.973 | 0.308 | −5 | 72 | 78 | <50 C. | 10.8 |
| WBr4_5H2O_S2 | WBr4_8H2O_S1 | 0.967 | 0.320 | 200 | 200 | 0 | 100-200 C. | 11.2 |
| AlBr3_6H2O_S1 | AlBr3_9H2O_S2 | 0.906 | 0.466 | 183 | 183 | 0 | 100-200 C. | 0.0 |
| VBr2 | VBr2_1H2O_S2 | 0.980 | 0.274 | 156 | 156 | 0 | 100-200 C. | 4.3 |
| MoCl3_6H2O_S3 | MoCl3_9H2O_S2 | 0.868 | 0.531 | 168 | 168 | 0 | 100-200 C. | 7.8 |
| GeI2_8H2O_S1 | GeI2_12H2O_S1 | 0.893 | 0.486 | 179 | 179 | 0 | 100-200 C. | 26.0 |
| NiCl2 | NiCl2_1H2O_S2 | 0.959 | 0.337 | 67 | 67 | 0 | 50-100 C. | 15.8 |
| FeI3_2H2O_S1 | FeI3_7H2O_S1 | 0.954 | 0.347 | −25 | 72 | 97 | <50 C. | 17.4 |
| LiI1_2H2O_S3 | LiI1_4H2O_S1 | 0.917 | 0.432 | 2 | 61 | 59 | <50 C. | 4.8 |
| GeF4_5H2O_S2 | GeF4_9H2O_S1 | 0.901 | 0.463 | −435 | 110 | 545 | Large | 22.8 |
| | | | | | | | Hysteresis | |
| SrI2_8H2O_S1 | SrI2_12H2O_S1 | 0.881 | 0.499 | 203 | 203 | 0 | 200-300 C. | 9.7 |
| HfBr4_5H2O_S2 | HfBr4_8H2O_S1 | 0.955 | 0.323 | 201 | 201 | 0 | 200-300 C. | 2.1 |
| GaCl3 | GaCl3_1H2O_S2 | 0.922 | 0.406 | 267 | 267 | 0 | 200-300 C. | 0.0 |
| CuCl2_9H2O_S2 | CuCl2_12H2O_S1 | 0.829 | 0.572 | 185 | 185 | 0 | 100-200 C. | 14.5 |
| ZrBr4_5H2O_S2 | ZrBr4_8H2O_S1 | 0.937 | 0.370 | 196 | 196 | 0 | 100-200 C. | 2.6 |
| BeI2_4H2O_S8 | BeI2_7H2O_S1 | 0.922 | 0.405 | 86 | 86 | 0 | 50-100 C. | 2.3 |
| VCl3_2H2O_S2 | VCl3_3H2O_S9 | 0.897 | 0.453 | 383 | 383 | 0 | 300-450 C. | 27.8 |
| NaBr1_1H2O_S1 | NaBr1_2H2O_S3 | 0.913 | 0.418 | 124 | 124 | 0 | 100-200 C. | 0.0 |
| CoCl3_6H2O_S3 | CoCl3_9H2O_S2 | 0.853 | 0.526 | 121 | 121 | 0 | 100-200 C. | 0.0 |
| TaBr3_S22 | TaBr3_3H2O_S9 | 0.967 | 0.263 | 12 | 12 | 0 | <50 C. | 32.7 |
| SnI2 | SnI2_2H2O_S5 | 0.970 | 0.249 | 76 | 76 | 0 | 50-100 C. | 8.7 |
| MnI4_S31 | MnI4_3H2O_S1 | 0.968 | 0.255 | 86 | 86 | 0 | 50-100 C. | 10.7 |
| ZrCl3 | ZrCl3_2H2O_S2 | 0.922 | 0.389 | 38 | 38 | 0 | <50 C. | 34.7 |
| NbCl4 | NbCl4_2H2O_S2 | 0.927 | 0.377 | 77 | 77 | 0 | 50-100 C. | 28.0 |
| ZrI3 | ZrI3_3H2O_S9 | 0.957 | 0.287 | 72 | 72 | 0 | 50-100 C. | 37.5 |
| SrBr2 | SrBr2_1H2O_S1 | 0.965 | 0.255 | 192 | 192 | 0 | 100-200 C. | 0.0 |
| FeCl3_6H2O_S3 | FeCl3_9H2O_S2 | 0.843 | 0.535 | 123 | 123 | 0 | 100-200 C. | 5.8 |
| GaBr3_6H2O_S3 | GaBr3_9H2O_S2 | 0.899 | 0.431 | 192 | 192 | 0 | 100-200 C. | 8.5 |
| FeI3_S3 | FeI3_3H2O_S7 | 0.946 | 0.309 | 72 | 73 | 1 | 50-100 C. | 0.0 |
| SrCl2_2H2O_S4 | SrCl2_4H2O_S3 | 0.881 | 0.457 | 88 | 88 | 0 | 50-100 C. | 10.6 |
| MgBr2_4H2O_S4 | MgBr2_6H2O_S2 | 0.893 | 0.430 | 157 | 157 | 0 | 100-200 C. | 6.2 |
| MoCl3_7H2O_S1 | MoCl3_9H2O_S2 | 0.844 | 0.516 | 371 | 371 | 0 | 300-450 C. | 29.1 |
| HfF4_3H2O_S2 | HfF4_5H2O_S2 | 0.932 | 0.332 | 119 | 119 | 0 | 100-200 C. | 0.9 |
| TiBr3_4H2O_S2 | TiBr3_6H2O_S3 | 0.913 | 0.373 | 232 | 232 | 0 | 200-300 C. | 5.9 |
| GeI2_4H2O_S3 | GeI2_9H2O_S2 | 0.903 | 0.398 | −7 | −7 | 0 | <50 C. | 17.6 |
| YCl3_6H2O_S2 | YCl3_9H2O_S2 | 0.820 | 0.544 | 171 | 171 | 0 | 100-200 C. | 0.0 |
| GeF2_4H2O_S2 | GeF2_8H2O_S2 | 0.851 | 0.487 | −60 | −60 | 0 | <50 C. | 28.0 |
| CrBr4_S17 | CrBr4_2H2O_S2 | 0.944 | 0.264 | 96 | 96 | 0 | 50-100 C. | 16.6 |
| MnBr4_S31 | MnBr4_2H2O_S2 | 0.939 | 0.274 | 112 | 112 | 0 | 100-200 C. | 16.2 |
| SiF4_5H2O_S2 | SiF4_9H2O_S1 | 0.850 | 0.485 | −518 | 103 | 622 | Large | 26.7 |
| | | | | | | | Hysteresis | |
| RbBr1_2H2O_S1 | RbBr1_4H2O_S1 | 0.874 | 0.440 | 85 | 85 | 0 | 50-100 C. | 1.1 |
| CrBr3_6H2O_S3 | CrBr3_9H2O_S2 | 0.875 | 0.436 | 179 | 179 | 0 | 100-200 C. | 0.9 |
| TiBr4 | TiBr4_2H2O_S2 | 0.935 | 0.285 | 121 | 121 | 0 | 100-200 C. | 13.0 |
| CaI2_2H2O_S8 | CaI2_4H2O_S4 | 0.908 | 0.358 | 176 | 176 | 0 | 100-200 C. | 1.1 |
| TiF3_2H2O_S2 | TiF3_3H2O_S8 | 0.880 | 0.420 | 184 | 184 | 0 | 100-200 C. | 5.3 |
| MgBr2_9H2O_S2 | MgBr2_12H2O_S1 | 0.815 | 0.533 | 214 | 214 | 0 | 200-300 C. | 2.2 |
| ScBr3_6H2O_S1 | ScBr3_9H2O_S2 | 0.859 | 0.456 | 193 | 193 | 0 | 100-200 C. | 0.0 |
| CaBr2_9H2O_S2 | CaBr2_12H2O_S1 | 0.804 | 0.544 | 244 | 244 | 0 | 200-300 C. | 9.9 |
| VI4_S17 | VI4_3H2O_S1 | 0.938 | 0.251 | 77 | 77 | 0 | 50-100 C. | 14.8 |
| NaI1_2H2O_S3 | NaI1_4H2O_S1 | 0.880 | 0.409 | 38 | 38 | 0 | <50 C. | 1.9 |
| ZrCl4_3H2O_S1 | ZrCl4_5H2O_S2 | 0.873 | 0.423 | 183 | 207 | 23 | 100-200 C. | 0.8 |
| CrBr3 | CrBr3_2H2O_S2 | 0.930 | 0.274 | 35 | 35 | 0 | <50 C. | 42.0 |
| SrCl2 | SrCl2_1H2O_S1 | 0.916 | 0.320 | 113 | 113 | 0 | 100-200 C. | 14.6 |
| VBr2_4H2O_S3 | VBr2_7H2O_S1 | 0.877 | 0.413 | 44 | 44 | 0 | <50 C. | 23.2 |
| FeI2_6H2O_S3 | FeI2_9H2O_S2 | 0.890 | 0.380 | 136 | 136 | 0 | 100-200 C. | 5.7 |
| LaI3_4H2O_S2 | LaI3_6H2O_S2 | 0.922 | 0.295 | 361 | 361 | 0 | 300-450 C. | 28.9 |
| SnBr2_2H2O_S5 | SnBr2_4H2O_S3 | 0.910 | 0.328 | 120 | 120 | 0 | 100-200 C. | 0.0 |
| YI3_6H2O_S2 | YI3_10H2O_S2 | 0.898 | 0.358 | 31 | 189 | 158 | Large | 0.7 |
| | | | | | | | Hysteresis | |
| ZrF3_8H2O_S2 | ZrF3_9H2O_S2 | 0.828 | 0.491 | 770 | 770 | 0 | >600 C. | 38.3 |
| TiBr3_6H2O_S3 | TiBr3_9H2O_S2 | 0.852 | 0.447 | 186 | 186 | 0 | 100-200 C. | 0.0 |
| MoF4_5H2O_S2 | MoF4_9H2O_S1 | 0.874 | 0.397 | −567 | 128 | 694 | Large | 29.0 |
| | | | | | | | Hysteresis | |
| CoCl3_7H2O_S1 | CoCl3_9H2O_S2 | 0.816 | 0.504 | 292 | 292 | 0 | 200-300 C. | 20.8 |
| HfCl4_3H2O_S1 | HfCl4_5H2O_S2 | 0.897 | 0.338 | 192 | 212 | 20 | 200-300 C. | 0.5 |
| ZrBr2_S17 | ZrBr2_1H2O_S2 | 0.933 | 0.219 | 130 | 130 | 0 | 100-200 C. | 0.0 |
| CuCl2_4H2O_S3 | CuCl2_8H2O_S2 | 0.825 | 0.486 | −41 | −41 | 0 | <50 C. | 29.2 |
| HfI4_2H2O_S1 | HfI4_5H2O_S2 | 0.929 | 0.234 | 142 | 142 | 0 | 100-200 C. | 5.9 |
| VCl2_1H2O_S2 | VCl2_2H2O_S8 | 0.871 | 0.399 | 158 | 158 | 0 | 100-200 C. | 1.2 |
| PbBr2_2H2O_S5 | PbBr2_4H2O_S3 | 0.917 | 0.269 | 132 | 132 | 0 | 100-200 C. | 0.0 |
| YI3_4H2O_S2 | YI3_6H2O_S2 | 0.907 | 0.296 | 312 | 312 | 0 | 300-450 C. | 14.9 |
| KI1_2H2O_S3 | KI1_4H2O_S1 | 0.844 | 0.444 | 89 | 89 | 0 | 50-100 C. | 3.0 |
| FeF3_1H2O_S2 | FeF3_2H2O_S1 | 0.877 | 0.372 | 107 | 107 | 0 | 100-200 C. | 11.3 |
| SnCl4_3H2O_S1 | SnCl4_5H2O_S2 | 0.871 | 0.385 | 177 | 202 | 25 | 100-200 C. | 1.1 |
| PbF4_2H2O_S2 | PbF4_3H2O_S2 | 0.925 | 0.226 | 248 | 248 | 0 | 200-300 C. | 0.0 |
| ZrI4_2H2O_S1 | ZrI4_5H2O_S2 | 0.914 | 0.263 | 141 | 141 | 0 | 100-200 C. | 4.6 |
| CsF1_1H2O_S2 | CsF1_2H2O_S1 | 0.893 | 0.329 | 151 | 151 | 0 | 100-200 C. | 0.0 |
| MnBr2 | MnBr2_1H2O_S2 | 0.914 | 0.261 | 143 | 143 | 0 | 100-200 C. | 4.8 |
| BeCl2_9H2O_S1 | BeCl2_12H2O_S1 | 0.750 | 0.584 | 122 | 122 | 0 | 100-200 C. | 7.4 |
| VBr3_7H2O_S2 | VBr3_9H2O_S2 | 0.845 | 0.430 | 393 | 393 | 0 | 300-450 C. | 28.7 |
| SnI4_2H2O_S2 | SnI4_9H2O_S1 | 0.894 | 0.311 | −150 | 175 | 325 | Large | 37.2 |
| | | | | | | | Hysteresis | |
| YI3 | YI3_2H2O_S2 | 0.911 | 0.255 | 169 | 169 | 0 | 100-200 C. | 19.5 |
| PbCl2_4H2O_S3 | PbCl2_8H2O_S1 | 0.880 | 0.343 | −25 | −25 | 0 | <50 C. | 29.3 |
| AlCl3_8H2O_S2 | AlCl3_9H2O_S2 | 0.775 | 0.540 | 819 | 819 | 0 | >600 C. | 33.3 |
| AlCl3_6H2O_S1 | AlCl3_10H2O_S2 | 0.790 | 0.511 | −602 | 202 | 804 | Large | 28.9 |
| | | | | | | | Hysteresis | |
| TiI3 | TiI3_2H2O_S2 | 0.907 | 0.251 | 127 | 127 | 0 | 100-200 C. | 16.7 |
| NbI4 | NbI4_3H2O_S1 | 0.908 | 0.239 | 84 | 84 | 0 | 50-100 C. | 16.3 |
| ZnI2_2H2O_S1 | ZnI2_4H2O_S2 | 0.892 | 0.289 | 115 | 115 | 0 | 100-200 C. | 1.9 |
| VBr2_9H2O_S2 | VBr2_12H2O_S1 | 0.797 | 0.493 | 208 | 208 | 0 | 200-300 C. | 6.2 |
| VBr3_4H2O_S2 | VBr3_6H2O_S1 | 0.864 | 0.361 | 219 | 219 | 0 | 200-300 C. | 5.8 |
| MnBr2_9H2O_S2 | MnBr2_12H2O_S1 | 0.794 | 0.494 | 213 | 213 | 0 | 200-300 C. | 10.4 |
| MgI2_4H2O_S4 | MgI2_6H2O_S2 | 0.862 | 0.362 | 206 | 206 | 0 | 200-300 C. | 0.4 |
| RbCl1_3H2O_S1 | RbCl1_4H2O_S1 | 0.796 | 0.489 | 374 | 374 | 0 | 300-450 C. | 36.8 |
| VBr2_4H2O_S3 | VBr2_6H2O_S3 | 0.861 | 0.363 | 123 | 123 | 0 | 100-200 C. | 6.3 |
| ScI3_4H2O_S2 | ScI3_6H2O_S1 | 0.875 | 0.326 | 322 | 322 | 0 | 300-450 C. | 13.4 |
| ZrBr2_9H2O_S2 | ZrBr2_12H2O_S1 | 0.803 | 0.472 | 231 | 231 | 0 | 200-300 C. | 24.6 |
| TiBr2_9H2O_S2 | TiBr2_12H2O_S1 | 0.786 | 0.495 | 206 | 206 | 0 | 200-300 C. | 9.0 |
| PbCl2_9H2O_S1 | PbCl2_12H2O_S1 | 0.812 | 0.451 | 236 | 236 | 0 | 200-300 C. | 19.7 |
| SrBr2_2H2O_S4 | SrBr2_4H2O_S3 | 0.859 | 0.350 | 110 | 110 | 0 | 100-200 C. | 8.8 |
| BaI2_8H2O_S1 | BaI2_12H2O_S1 | 0.816 | 0.440 | 184 | 184 | 0 | 100-200 C. | 12.8 |
| SiF4_2H2O_S1 | SiF4_3H2O_S1 | 0.832 | 0.407 | 168 | 168 | 0 | 100-200 C. | 4.5 |
| PbBr4_5H2O_S2 | PbBr4_8H2O_S1 | 0.879 | 0.293 | 175 | 175 | 0 | 100-200 C. | 19.2 |
| GeCl2_4H2O_S2 | GeCl2_8H2O_S1 | 0.807 | 0.454 | −49 | −49 | 0 | <50 C. | 30.3 |
| MoI3 | MoI3_3H2O_S4 | 0.893 | 0.239 | 17 | 17 | 0 | <50 C. | 22.8 |
| MgCl2_4H2O_S7 | MgCl2_7H2O_S1 | 0.775 | 0.498 | −21 | −21 | 0 | <50 C. | 40.7 |
| MnF4_2H2O_S2 | MnF4_3H2O_S1 | 0.845 | 0.366 | 190 | 190 | 0 | 100-200 C. | 2.9 |
| HfBr3_6H2O_S3 | HfBr3_9H2O_S2 | 0.847 | 0.360 | 203 | 203 | 0 | 200-300 C. | 31.9 |
| ScCl3_2H2O_S2 | ScCl3_3H2O_S9 | 0.802 | 0.451 | 361 | 361 | 0 | 300-450 C. | 18.3 |
| GeBr2_9H2O_S2 | GeBr2_12H2O_S1 | 0.782 | 0.484 | 223 | 223 | 0 | 200-300 C. | 21.5 |
| RbCl1 | RbCl1_1H2O_S1 | 0.837 | 0.381 | 90 | 90 | 0 | 50-100 C. | 4.9 |
| CrF2 | CrF2_1H2O_S2 | 0.866 | 0.309 | −44 | −44 | 0 | <50 C. | 47.3 |
| VI3_S15 | VI3_2H2O_S2 | 0.887 | 0.234 | 102 | 102 | 0 | 100-200 C. | 20.0 |
| CrF2_4H2O_S7 | CrF2_6H2O_S3 | 0.817 | 0.416 | 9 | 9 | 0 | <50 C. | 15.0 |
| HfBr4_2H2O_S2 | HfBr4_4H2O_S1 | 0.883 | 0.245 | 201 | 210 | 9 | 200-300 C. | 0.0 |
| GeI4 | GeI4_5H2O_S1 | 0.876 | 0.268 | −27 | −27 | 0 | <50 C. | 30.3 |
| SnI2_8H2O_S2 | SnI2_12H2O_S1 | 0.813 | 0.423 | 154 | 154 | 0 | 100-200 C. | 18.0 |
| VBr3_6H2O_S1 | VBr3_9H2O_S2 | 0.816 | 0.415 | 156 | 156 | 0 | 100-200 C. | 0.0 |
| ZnBr2_9H2O_S2 | ZnBr2_12H2O_S1 | 0.788 | 0.465 | 195 | 195 | 0 | 100-200 C. | 8.3 |
| PbI2_8H2O_S2 | PbI2_12H2O_S1 | 0.830 | 0.384 | 172 | 172 | 0 | 100-200 C. | 19.3 |
| PbF2_9H2O_S1 | PbF2_12H2O_S1 | 0.819 | 0.407 | 155 | 155 | 0 | 100-200 C. | 11.3 |
| LaCl3_6H2O_S2 | LaCl3_10H2O_S2 | 0.811 | 0.421 | −136 | 90 | 226 | <50 C. | 8.1 |
| TiCl3_8H2O_S2 | TiCl3_9H2O_S2 | 0.749 | 0.522 | 859 | 859 | 0 | >600 C. | 35.9 |
| NiBr2_9H2O_S2 | NiBr2_12H2O_S1 | 0.790 | 0.459 | 182 | 182 | 0 | 100-200 C. | 9.7 |
| CaCl2_1H2O_S2 | CaCl2_2H2O_S2 | 0.801 | 0.435 | 165 | 165 | 0 | 100-200 C. | 0.9 |
| MnCl2_4H2O_S3 | MnCl2_6H2O_S3 | 0.802 | 0.433 | 74 | 74 | 0 | 50-100 C. | 10.5 |
| MnCl3_7H2O_S1 | MnCl3_9H2O_S2 | 0.765 | 0.495 | 275 | 275 | 0 | 200-300 C. | 24.5 |
| MgBr2_4H2O_S4 | MgBr2_7H2O_S1 | 0.815 | 0.407 | 15 | 15 | 0 | <50 C. | 34.9 |
| NbCl3_6H2O_S3 | NbCl3_9H2O_S2 | 0.771 | 0.485 | 128 | 128 | 0 | 100-200 C. | 1.2 |
| BaCl2_9H2O_S1 | BaCl2_12H2O_S1 | 0.753 | 0.511 | 222 | 222 | 0 | 200-300 C. | 16.5 |
| SnI4_2H2O_S2 | SnI4_5H2O_S2 | 0.877 | 0.242 | 97 | 175 | 79 | 100-200 C. | 0.0 |
| PbI2 | PbI2_2H2O_S5 | 0.889 | 0.192 | 54 | 54 | 0 | 50-100 C. | 12.2 |
| LaF3_7H2O_S1 | LaF3_9H2O_S2 | 0.794 | 0.443 | 270 | 270 | 0 | 200-300 C. | 23.2 |
| NiF2_4H2O_S4 | NiF2_6H2O_S3 | 0.820 | 0.391 | 1 | 1 | 0 | <50 C. | 17.8 |
| ZrBr4_2H2O_S2 | ZrBr4_4H2O_S1 | 0.861 | 0.286 | 193 | 207 | 14 | 100-200 C. | 0.0 |
| ZrF4_3H2O_S2 | ZrF4_5H2O_S2 | 0.816 | 0.395 | 75 | 75 | 0 | 50-100 C. | 4.9 |
| CoBr2_9H2O_S2 | CoBr2_12H2O_S1 | 0.779 | 0.464 | 187 | 187 | 0 | 100-200 C. | 8.3 |
| CaCl2_4H2O_S7 | CaCl2_6H2O_S1 | 0.782 | 0.454 | 67 | 67 | 0 | 50-100 C. | 14.6 |
| NbBr3_4H2O_S2 | NbBr3_6H2O_S3 | 0.846 | 0.316 | 204 | 204 | 0 | 200-300 C. | 13.1 |
| MoI4_S28 | MoI4_3H2O_S1 | 0.874 | 0.224 | 63 | 63 | 0 | 50-100 C. | 17.9 |
| NaI1_1H2O_S1 | NaI1_2H2O_S3 | 0.839 | 0.331 | 148 | 148 | 0 | 100-200 C. | 0.8 |
| MnCl3_S25 | MnCl3_1H2O_S2 | 0.833 | 0.345 | 151 | 151 | 0 | 100-200 C. | 1.1 |
| CoI2 | CoI2_2H2O_S3 | 0.873 | 0.226 | −3 | −3 | 0 | <50 C. | 37.5 |
| VBr4_S17 | VBr4_2H2O_S2 | 0.865 | 0.255 | 81 | 81 | 0 | 50-100 C. | 20.5 |
| TaI4 | TaI4_3H2O_S1 | 0.876 | 0.204 | 73 | 73 | 0 | 50-100 C. | 19.0 |
| MoCl3_8H2O_S1 | MoCl3_9H2O_S2 | 0.767 | 0.469 | 898 | 898 | 0 | >600 C. | 41.4 |
| KBr1 | KBr1_1H2O_S1 | 0.814 | 0.375 | 79 | 79 | 0 | 50-100 C. | 5.0 |
| LiCl1_2H2O_S2 | LiCl1_3H2O_S1 | 0.734 | 0.515 | 67 | 67 | 0 | 50-100 C. | 1.0 |
| VCl3_8H2O_S2 | VCl3_9H2O_S2 | 0.743 | 0.501 | 823 | 823 | 0 | >600 C. | 34.8 |
| ZrI4 | ZrI4_2H2O_S1 | 0.870 | 0.217 | 198 | 198 | 0 | 100-200 C. | 0.0 |
| FeI3_3H2O_S7 | FeI3_8H2O_S2 | 0.840 | 0.312 | −25 | −25 | 0 | <50 C. | 19.3 |
| SrI2_4H2O_S4 | SrI2_6H2O_S1 | 0.840 | 0.309 | 203 | 203 | 0 | 200-300 C. | 7.3 |
| KBr1_3H2O_S1 | KBr1_4H2O_S1 | 0.763 | 0.466 | 336 | 336 | 0 | 300-450 C. | 33.1 |
| CrBr2 | CrBr2_1H2O_S2 | 0.860 | 0.242 | 107 | 107 | 0 | 100-200 C. | 21.0 |
| SrI2_6H2O_S1 | SrI2_9H2O_S1 | 0.822 | 0.349 | 128 | 128 | 0 | 100-200 C. | 4.9 |
| CrI4_5H2O_S2 | CrI4_8H2O_S1 | 0.848 | 0.279 | 176 | 176 | 0 | 100-200 C. | 10.7 |
| SnCl2_4H2O_S2 | SnCl2_8H2O_S1 | 0.800 | 0.395 | −48 | −48 | 0 | <50 C. | 31.9 |
| VI4_5H2O_S2 | VI4_8H2O_S1 | 0.846 | 0.282 | 180 | 180 | 0 | 100-200 C. | 12.8 |
| GaBr3_7H2O_S1 | GaBr3_9H2O_S2 | 0.802 | 0.385 | 349 | 349 | 0 | 300-450 C. | 24.0 |
| SnBr2_4H2O_S3 | SnBr2_8H2O_S1 | 0.818 | 0.349 | −21 | −21 | 0 | <50 C. | 24.7 |
| BeF2_9H2O_S1 | BeF2_12H2O_S1 | 0.719 | 0.522 | 41 | 41 | 0 | <50 C. | 0.7 |
| TiCl3_2H2O_S2 | TiCl3_3H2O_S9 | 0.784 | 0.418 | 323 | 323 | 0 | 300-450 C. | 18.4 |
| BaCl2 | BaCl2_1H2O_S1 | 0.846 | 0.261 | 132 | 132 | 0 | 100-200 C. | 5.1 |
| LaBr3_6H2O_S2 | LaBr3_10H2O_S2 | 0.814 | 0.348 | −35 | 92 | 128 | <50 C. | 3.7 |
| GeF4_2H2O_S2 | GeF4_3H2O_S1 | 0.822 | 0.329 | 183 | 183 | 0 | 100-200 C. | 4.3 |
| RbI1_2H2O_S3 | RbI1_4H2O_S1 | 0.806 | 0.365 | 83 | 83 | 0 | 50-100 C. | 5.5 |
| SnBr2_9H2O_S1 | SnBr2_12H2O_S1 | 0.766 | 0.442 | 227 | 227 | 0 | 200-300 C. | 20.7 |
| MnCl2_1H2O_S2 | MnCl2_2H2O_S8 | 0.803 | 0.371 | 139 | 139 | 0 | 100-200 C. | 3.2 |
| PbCl2_1H2O_S1 | PbCl2_2H2O_S5 | 0.854 | 0.227 | 214 | 214 | 0 | 200-300 C. | 17.9 |
| 3-Feb | FeBr3_1H2O_S2 | 0.840 | 0.269 | 306 | 306 | 0 | 300-450 C. | 0.0 |
| NiCl3_6H2O_S3 | NiCl3_9H2O_S1 | 0.760 | 0.442 | 57 | 57 | 0 | 50-100 C. | 0.0 |
| MoBr3_7H2O_S1 | MoBr3_9H2O_S2 | 0.793 | 0.379 | 372 | 372 | 0 | 300-450 C. | 30.1 |
| TiI4_5H2O_S2 | TiI4_8H2O_S1 | 0.831 | 0.284 | 181 | 181 | 0 | 100-200 C. | 6.7 |
| YF3_8H2O_S2 | YF3_9H2O_S2 | 0.749 | 0.458 | 693 | 693 | 0 | >600 C. | 31.3 |
| SrBr2_9H2O_S1 | SrBr2_12H2O_S1 | 0.742 | 0.469 | 223 | 223 | 0 | 200-300 C. | 10.6 |
| GeI4_5H2O_S1 | GeI4_8H2O_S1 | 0.832 | 0.278 | 187 | 187 | 0 | 100-200 C. | 30.3 |
| SiF4 | SiF4_1H2O_S1 | 0.799 | 0.358 | 26 | 26 | 0 | <50 C. | 35.6 |
| MgI2_1H2O_S2 | MgI2_2H2O_S8 | 0.834 | 0.265 | 298 | 298 | 0 | 200-300 C. | 3.5 |
| CrBr2_9H2O_S2 | CrBr2_12H2O_S1 | 0.745 | 0.460 | 177 | 177 | 0 | 100-200 C. | 7.7 |
| SnI4 | SnI4_1H2O_S1 | 0.850 | 0.206 | 634 | 634 | 0 | >600 C. | 0.0 |
| ZnI2_1H2O_S2 | ZnI2_2H2O_S1 | 0.838 | 0.249 | 334 | 334 | 0 | 300-450 C. | 36.0 |
| NbCl3_7H2O_S2 | NbCl3_9H2O_S2 | 0.738 | 0.465 | 302 | 302 | 0 | 300-450 C. | 21.9 |
| ZrBr3_6H2O_S3 | ZrBr3_9H2O_S2 | 0.778 | 0.395 | 171 | 171 | 0 | 100-200 C. | 4.4 |
| TaCl4 | TaCl4_2H2O_S2 | 0.834 | 0.255 | 40 | 40 | 0 | <50 C. | 36.6 |
| LaI3 | LaI3_2H2O_S1 | 0.844 | 0.216 | 137 | 137 | 0 | 100-200 C. | 21.3 |
| SnI2_2H2O_S5 | SnI2_4H2O_S2 | 0.829 | 0.263 | 127 | 127 | 0 | 100-200 C. | 8.7 |
| TaBr3_4H2O_S2 | TaBr3_6H2O_S3 | 0.831 | 0.258 | 194 | 194 | 0 | 100-200 C. | 16.7 |
| TaI4_5H2O_S2 | TaI4_8H2O_S1 | 0.835 | 0.244 | 191 | 191 | 0 | 100-200 C. | 13.4 |
| CoBr2 | CoBr2_1H2O_S2 | 0.842 | 0.217 | 79 | 79 | 0 | 50-100 C. | 13.5 |
| NbI4_5H2O_S2 | NbI4_8H2O_S1 | 0.825 | 0.270 | 186 | 186 | 0 | 100-200 C. | 11.7 |
| TaF4_5H2O_S2 | TaF4_9H2O_S1 | 0.819 | 0.287 | −721 | 151 | 872 | Large | 36.3 |
| | | | | | | | Hysteresis | |
| TiBr3_7H2O_S2 | TiBr3_9H2O_S2 | 0.765 | 0.401 | 345 | 345 | 0 | 300-450 C. | 19.3 |
| MnCl3_6H2O_S3 | MnCl3_9H2O_S2 | 0.725 | 0.469 | 73 | 73 | 0 | 50-100 C. | 0.0 |
| HfI4_5H2O_S2 | HfI4_8H2O_S1 | 0.826 | 0.246 | 194 | 194 | 0 | 100-200 C. | 5.9 |
| CrCl2_4H2O_S3 | CrCl2_6H2O_S3 | 0.759 | 0.406 | 48 | 48 | 0 | <50 C. | 10.6 |
| MoI4_5H2O_S2 | MoI4_8H2O_S1 | 0.818 | 0.261 | 172 | 172 | 0 | 100-200 C. | 12.2 |
| MnF4_3H2O_S1 | MnF4_4H2O_S1 | 0.770 | 0.372 | 244 | 244 | 0 | 200-300 C. | 2.9 |
| YCl3 | YCl3_1H2O_S3 | 0.804 | 0.290 | 151 | 151 | 0 | 100-200 C. | 14.3 |
| CrI3 | CrI3_2H2O_S2 | 0.826 | 0.219 | 79 | 79 | 0 | 50-100 C. | 17.3 |
| GeBr2_4H2O_S2 | GeBr2_8H2O_S1 | 0.774 | 0.361 | −40 | −40 | 0 | <50 C. | 27.1 |
| ScBr3_6H2O_S1 | ScBr3_10H2O_S2 | 0.773 | 0.364 | −511 | 193 | 703 | Large | 24.8 |
| | | | | | | | Hysteresis | |
| PbCl4_3H2O_S1 | PbCl4_5H2O_S2 | 0.802 | 0.292 | 167 | 167 | 0 | 100-200 C. | 2.1 |
| LaI3_6H2O_S2 | LaI3_10H2O_S2 | 0.795 | 0.305 | −52 | 141 | 194 | Large | 4.4 |
| | | | | | | | Hysteresis | |
| MnI4_5H2O_S2 | MnI4_8H2O_S1 | 0.805 | 0.271 | 164 | 164 | 0 | 100-200 C. | 10.2 |
| WI4_5H2O_S2 | WI4_8H2O_S1 | 0.817 | 0.234 | 173 | 173 | 0 | 100-200 C. | 15.8 |
| YBr3_6H2O_S2 | YBr3_9H2O_S2 | 0.754 | 0.392 | 166 | 166 | 0 | 100-200 C. | 0.0 |
| GaI3_7H2O_S1 | GaI3_9H2O_S2 | 0.785 | 0.320 | 399 | 399 | 0 | 300-450 C. | 34.7 |
| BaBr2 | BaBr2_1H2O_S1 | 0.823 | 0.206 | 172 | 172 | 0 | 100-200 C. | 0.0 |
| TaBr3_S22 | TaBr3_2H2O_S1 | 0.825 | 0.191 | 26 | 26 | 0 | <50 C. | 24.1 |
| TiF4_2H2O_S2 | TiF4_3H2O_S1 | 0.763 | 0.366 | 173 | 173 | 0 | 100-200 C. | 3.9 |
| AlBr3_6H2O_S1 | AlBr3_10H2O_S2 | 0.758 | 0.375 | −493 | 183 | 677 | Large | 24.0 |
| | | | | | | | Hysteresis | |
| TaCl3_7H2O_S2 | TaCl3_9H2O_S2 | 0.756 | 0.379 | 310 | 310 | 0 | 300-450 C. | 26.1 |
| MnCl3_8H2O_S2 | MnCl3_9H2O_S2 | 0.709 | 0.459 | 744 | 744 | 0 | >600 C. | 36.2 |
| HfF4 | HfF4_1H2O_S1 | 0.829 | 0.162 | 29 | 29 | 0 | <50 C. | 31.7 |
| CrF2_4H2O_S7 | CrF2_7H2O_S1 | 0.737 | 0.412 | −70 | −70 | 0 | <50 C. | 34.6 |
| MoBr4_S18 | MoBr4_2H2O_S2 | 0.814 | 0.222 | 71 | 71 | 0 | 50-100 C. | 23.5 |
| GeI2 | GeI2_2H2O_S5 | 0.814 | 0.225 | 6 | 6 | 0 | <50 C. | 27.1 |
| SnBr2_1H2O_S2 | SnBr2_2H2O_S5 | 0.811 | 0.233 | 230 | 230 | 0 | 200-300 C. | 22.9 |
| TaCl3_6H2O_S3 | TaCl3_9H2O_S2 | 0.754 | 0.378 | 115 | 115 | 0 | 100-200 C. | 4.3 |
| ZrI4_5H2O_S2 | ZrI4_8H2O_S1 | 0.800 | 0.268 | 182 | 182 | 0 | 100-200 C. | 4.6 |
| CrCl3_8H2O_S2 | CrCl3_9H2O_S2 | 0.703 | 0.466 | 750 | 750 | 0 | >600 C. | 30.3 |
| CuI2_S15 | CuI2_2H2O_S1 | 0.814 | 0.217 | −10 | −10 | 0 | <50 C. | 24.7 |
| TaI3_S15 | TaI3_3H2O_S9 | 0.818 | 0.201 | 9 | 9 | 0 | <50 C. | 33.9 |
| ZnBr2 | ZnBr2_1H2O_S2 | 0.813 | 0.217 | 89 | 89 | 0 | 50-100 C. | 15.2 |
| MoF4_2H2O_S2 | MoF4_3H2O_S1 | 0.784 | 0.306 | 201 | 201 | 0 | 200-300 C. | 3.2 |
| ZnF2_4H2O_S4 | ZnF2_6H2O_S3 | 0.761 | 0.358 | −14 | −14 | 0 | <50 C. | 19.2 |
| ZnCl2 | ZnCl2_1H2O_S2 | 0.791 | 0.283 | 26 | 26 | 0 | <50 C. | 28.6 |
| PbI2_2H2O_S5 | PbI2_4H2O_S2 | 0.810 | 0.219 | 126 | 126 | 0 | 100-200 C. | 12.2 |
| CuBr2_9H2O_S2 | CuBr2_12H2O_S1 | 0.724 | 0.420 | 149 | 149 | 0 | 100-200 C. | 11.4 |
| MoBr3_6H2O_S3 | MoBr3_9H2O_S2 | 0.755 | 0.360 | 136 | 136 | 0 | 100-200 C. | 2.6 |
| ZnBr2_4H2O_S3 | ZnBr2_6H2O_S3 | 0.776 | 0.312 | 83 | 83 | 0 | 50-100 C. | 8.4 |
| BaCl2_2H2O_S4 | BaCl2_4H2O_S2 | 0.771 | 0.323 | 37 | 37 | 0 | <50 C. | 15.2 |
| BaI2_2H2O_S9 | BaI2_4H2O_S6 | 0.798 | 0.245 | 116 | 116 | 0 | 100-200 C. | 2.3 |
| HfCl3_7H2O_S2 | HfCl3_9H2O_S2 | 0.742 | 0.380 | 309 | 309 | 0 | 300-450 C. | 23.8 |
| VCl3_6H2O_S1 | VCl3_10H2O_S2 | 0.712 | 0.433 | −627 | 179 | 806 | Large | 30.0 |
| | | | | | | | Hysteresis | |
| BaF2 | BaF2_1H2O_S1 | 0.814 | 0.179 | −37 | −37 | 0 | <50 C. | 46.7 |
| AlI3_6H2O_S1 | AlI3_10H2O_S2 | 0.768 | 0.322 | −220 | 142 | 362 | Large | 11.9 |
| | | | | | | | Hysteresis | |
| YI3_6H2O_S2 | YI3_9H2O_S3 | 0.777 | 0.298 | 100 | 189 | 89 | 100-200 C. | 0.0 |
| CrF4_2H2O_S2 | CrF4_3H2O_S1 | 0.760 | 0.338 | 149 | 149 | 0 | 100-200 C. | 6.0 |
| MgI2_9H2O_S2 | MgI2_12H2O_S1 | 0.720 | 0.415 | 195 | 195 | 0 | 100-200 C. | 0.0 |
| SrBr2_1H2O_S1 | SrBr2_2H2O_S4 | 0.796 | 0.239 | 191 | 191 | 0 | 100-200 C. | 0.0 |
| NiBr3_6H2O_S3 | NiBr3_10H2O_S2 | 0.749 | 0.358 | 20 | 20 | 0 | <50 C. | 4.8 |
| SnI4_1H2O_S1 | SnI4_3H2O_S1 | 0.802 | 0.212 | 175 | 267 | 92 | 200-300 C. | 0.0 |
| NbBr3_6H2O_S3 | NbBr3_10H2O_S2 | 0.760 | 0.328 | −228 | 96 | 324 | <50 C. | 12.2 |
| SnBr4 | SnBr4_2H2O_S2 | 0.796 | 0.223 | 90 | 90 | 0 | 50-100 C. | 14.9 |
| MnBr3_S12 | MnBr3_2H2O_S2 | 0.789 | 0.242 | 1 | 1 | 0 | <50 C. | 41.2 |
| BeI2_8H2O_S1 | BeI2_12H2O_S1 | 0.721 | 0.399 | 54 | 54 | 0 | 50-100 C. | 0.0 |
| CrBr2_4H2O_S3 | CrBr2_6H2O_S3 | 0.760 | 0.319 | 77 | 77 | 0 | 50-100 C. | 7.0 |
| PbBr2_9H2O_S1 | PbBr2_12H2O_S1 | 0.738 | 0.368 | 216 | 216 | 0 | 200-300 C. | 18.1 |
| SrI2_2H2O_S7 | SrI2_4H2O_S4 | 0.773 | 0.286 | 131 | 131 | 0 | 100-200 C. | 7.3 |
| PbI2_4H2O_S2 | PbI2_8H2O_S2 | 0.780 | 0.264 | 0 | 0 | 0 | <50 C. | 19.3 |
| SnF4_2H2O_S2 | SnF4_3H2O_S1 | 0.776 | 0.275 | 195 | 195 | 0 | 100-200 C. | 3.5 |
| FeBr3_1H2O_S2 | FeBr3_3H2O_S7 | 0.774 | 0.279 | 61 | 61 | 0 | 50-100 C. | 4.9 |
| ZrCl3_7H2O_S2 | ZrCl3_9H2O_S2 | 0.691 | 0.446 | 277 | 277 | 0 | 200-300 C. | 15.0 |
| 2-Feb | FeBr2_1H2O_S2 | 0.792 | 0.215 | 71 | 71 | 0 | 50-100 C. | 18.1 |
| SnF2_4H2O_S2 | SnF2_7H2O_S1 | 0.746 | 0.341 | −53 | −53 | 0 | <50 C. | 23.8 |
| SnI2_4H2O_S2 | SnI2_8H2O_S2 | 0.762 | 0.301 | −7 | −7 | 0 | <50 C. | 18.0 |
| ScBr3_7H2O_S2 | ScBr3_9H2O_S2 | 0.722 | 0.384 | 314 | 314 | 0 | 300-450 C. | 14.7 |
| GeBr4 | GeBr4_3H2O_S1 | 0.781 | 0.240 | −29 | −29 | 0 | <50 C. | 24.5 |
| CoF2_4H2O_S7 | CoF2_6H2O_S3 | 0.737 | 0.353 | −25 | −25 | 0 | <50 C. | 20.9 |
| PbCl2 | PbCl2_1H2O_S1 | 0.799 | 0.171 | 73 | 73 | 0 | 50-100 C. | 17.9 |
| NbBr4 | NbBr4_2H2O_S2 | 0.785 | 0.224 | 71 | 71 | 0 | 50-100 C. | 26.2 |
| TiI4 | TiI4_2H2O_S2 | 0.790 | 0.204 | 141 | 141 | 0 | 100-200 C. | 2.9 |
| SrI2 | SrI2_1H2O_S1 | 0.793 | 0.187 | 187 | 187 | 0 | 100-200 C. | 0.0 |
| HfBr4_3H2O_S1 | HfBr4_5H2O_S2 | 0.783 | 0.226 | 164 | 201 | 37 | 100-200 C. | 2.1 |
| AlI3_6H2O_S1 | AlI3_9H2O_S2 | 0.749 | 0.319 | 142 | 142 | 0 | 100-200 C. | 0.0 |
| CaI2_9H2O_S2 | CaI2_12H2O_S1 | 0.698 | 0.416 | 211 | 211 | 0 | 200-300 C. | 4.5 |
| BeF2_7H2O_S1 | BeF2_9H2O_S1 | 0.666 | 0.463 | 59 | 59 | 0 | 50-100 C. | 1.3 |
| BaF2_9H2O_S1 | BaF2_12H2O_S1 | 0.689 | 0.424 | 106 | 106 | 0 | 100-200 C. | 5.7 |
| ScI3_6H2O_S1 | ScI3_9H2O_S2 | 0.738 | 0.330 | 170 | 170 | 0 | 100-200 C. | 0.0 |
| GaCl3_8H2O_S2 | GaCl3_9H2O_S2 | 0.685 | 0.429 | 721 | 721 | 0 | >600 C. | 28.8 |
| BaCl2_1H2O_S1 | BaCl2_2H2O_S4 | 0.764 | 0.266 | 172 | 172 | 0 | 100-200 C. | 5.1 |
| VF2_4H2O_S4 | VF2_6H2O_S3 | 0.718 | 0.368 | −25 | −25 | 0 | <50 C. | 21.0 |
| BaI2 | BaI2_1H2O_S1 | 0.780 | 0.178 | 226 | 226 | 0 | 200-300 C. | 0.0 |
| VI2_9H2O_S2 | VI2_12H2O_S1 | 0.701 | 0.383 | 183 | 183 | 0 | 100-200 C. | 3.1 |
| FeBr3_7H2O_S1 | FeBr3_9H2O_S2 | 0.719 | 0.347 | 270 | 270 | 0 | 200-300 C. | 22.7 |
| ScF3_9H2O_S2 | ScF3_10H2O_S2 | −0.697 | −0.387 | −1022 | −1022 | 0 | <50 C. | 47.6 |
| MnI2_9H2O_S2 | MnI2_12H2O_S1 | 0.698 | 0.386 | 189 | 189 | 0 | 100-200 C. | 6.9 |
| ZrBr4_3H2O_S1 | ZrBr4_5H2O_S2 | 0.754 | 0.259 | 150 | 193 | 43 | 100-200 C. | 2.6 |
| FeBr3_6H2O_S3 | FeBr3_9H2O_S2 | 0.717 | 0.346 | 88 | 88 | 0 | 50-100 C. | 1.2 |
| TiI3_4H2O_S2 | TiI3_6H2O_S1 | 0.747 | 0.272 | 227 | 227 | 0 | 200-300 C. | 8.5 |
| ZnI2_9H2O_S2 | ZnI2_12H2O_S1 | 0.703 | 0.370 | 179 | 179 | 0 | 100-200 C. | 8.3 |
| WCl4 | WCl4_2H2O_S2 | 0.761 | 0.224 | 5 | 5 | 0 | <50 C. | 43.0 |
| MnBr2_4H2O_S3 | MnBr2_6H2O_S3 | 0.729 | 0.312 | 72 | 72 | 0 | 50-100 C. | 10.4 |
| TiCl3 | TiCl3_1H2O_S3 | 0.729 | 0.312 | 95 | 95 | 0 | 50-100 C. | 23.1 |
| CrI4_S8 | CrI4_2H2O_S2 | 0.772 | 0.178 | 91 | 91 | 0 | 50-100 C. | 14.4 |
| BaBr2_9H2O_S1 | BaBr2_12H2O_S1 | 0.680 | 0.403 | 199 | 199 | 0 | 100-200 C. | 11.7 |
| MnI3_S16 | MnI3_2H2O_S1 | 0.764 | 0.202 | 53 | 53 | 0 | 50-100 C. | 14.8 |
| GaI3_6H2O_S3 | GaI3_9H2O_S2 | 0.731 | 0.299 | 145 | 145 | 0 | 100-200 C. | 6.5 |
| PbBr2_4H2O_S3 | PbBr2_8H2O_S1 | 0.744 | 0.264 | −42 | −42 | 0 | <50 C. | 31.0 |
| AlCl3_1H2O_S2 | AlCl3_2H2O_S1 | 0.694 | 0.376 | 164 | 164 | 0 | 100-200 C. | 28.7 |
| CrBr3_7H2O_S1 | CrBr3_9H2O_S2 | 0.706 | 0.352 | 273 | 273 | 0 | 200-300 C. | 12.0 |
| CaI2 | CaI2_1H2O_S2 | 0.756 | 0.226 | 209 | 209 | 0 | 200-300 C. | 2.5 |
| NiI2_9H2O_S2 | NiI2_12H2O_S1 | 0.699 | 0.364 | 166 | 166 | 0 | 100-200 C. | 10.7 |
| HfI3_6H2O_S3 | HfI3_9H2O_S2 | 0.738 | 0.276 | 181 | 181 | 0 | 100-200 C. | 21.3 |
| TiI3_6H2O_S1 | TiI3_9H2O_S2 | 0.719 | 0.317 | 155 | 155 | 0 | 100-200 C. | 0.0 |
| CrI2_4H2O_S3 | CrI2_6H2O_S3 | 0.738 | 0.270 | 110 | 110 | 0 | 100-200 C. | 2.5 |
| CrI3_6H2O_S3 | CrI3_9H2O_S2 | 0.725 | 0.302 | 137 | 137 | 0 | 100-200 C. | 0.1 |
| NbF4_4H2O_S1 | NbF4_5H2O_S2 | 0.710 | 0.334 | 320 | 320 | 0 | 300-450 C. | 10.1 |
| LiCl1_3H2O_S1 | LiCl1_4H2O_S1 | 0.640 | 0.453 | 82 | 82 | 0 | 50-100 C. | 1.0 |
| VI3_4H2O_S2 | VI3_6H2O_S1 | 0.739 | 0.264 | 214 | 214 | 0 | 200-300 C. | 8.7 |
| NaBr1_3H2O_S1 | NaBr1_4H2O_S1 | 0.687 | 0.373 | 173 | 173 | 0 | 100-200 C. | 13.3 |
| CuF1_2H2O_S3 | CuF1_3H2O_S1 | 0.713 | 0.315 | 22 | 22 | 0 | <50 C. | 3.5 |
| TiI2_9H2O_S2 | TiI2_12H2O_S1 | 0.681 | 0.378 | 174 | 174 | 0 | 100-200 C. | 4.0 |
| ScI3_6H2O_S1 | ScI3_10H2O_S2 | 0.720 | 0.297 | −368 | 170 | 538 | Large | 18.5 |
| | | | | | | | Hysteresis | |
| AlI3_7H2O_S1 | AlI3_9H2O_S2 | 0.714 | 0.304 | 321 | 321 | 0 | 300-450 C. | 21.6 |
| SiF4_4H2O_S1 | SiF4_5H2O_S2 | 0.678 | 0.377 | 229 | 229 | 0 | 200-300 C. | 1.7 |
| CuBr2_4H2O_S3 | CuBr2_8H2O_S2 | 0.699 | 0.335 | −62 | −62 | 0 | <50 C. | 30.4 |
| LiBr1_2H2O_S3 | LiBr1_3H2O_S1 | 0.688 | 0.357 | 71 | 71 | 0 | 50-100 C. | 0.0 |
| CoI2_9H2O_S2 | CoI2_12H2O_S1 | 0.686 | 0.360 | 162 | 162 | 0 | 100-200 C. | 8.0 |
| NbI3_4H2O_S2 | NbI3_6H2O_S3 | 0.738 | 0.236 | 198 | 198 | 0 | 100-200 C. | 11.1 |
| CoBr3_6H2O_S3 | CoBr3_9H2O_S2 | 0.701 | 0.329 | 73 | 73 | 0 | 50-100 C. | 0.0 |
| RbBr1 | RbBr1_1H2O_S1 | 0.722 | 0.278 | 76 | 76 | 0 | 50-100 C. | 1.9 |
| MnF2_4H2O_S7 | MnF2_6H2O_S3 | 0.688 | 0.354 | −30 | −30 | 0 | <50 C. | 21.1 |
| NiI2 | NiI2_2H2O_S8 | 0.747 | 0.199 | −35 | −35 | 0 | <50 C. | 44.0 |
| SnBr4_3H2O_S1 | SnBr4_5H2O_S2 | 0.736 | 0.238 | 158 | 158 | 0 | 100-200 C. | 3.1 |
| CoBr3_6H2O_S3 | CoBr3_10H2O_S2 | 0.704 | 0.320 | −260 | 73 | 333 | <50 C. | 13.7 |
| PbI4_S19 | PbI4_4H2O_S1 | 0.748 | 0.189 | −18 | −18 | 0 | <50 C. | 29.7 |
| YCl3_7H2O_S2 | YCl3_9H2O_S2 | 0.638 | 0.423 | 245 | 245 | 0 | 200-300 C. | 9.0 |
| MoF3_9H2O_S2 | MoF3_10H2O_S2 | −0.683 | −0.345 | −1061 | −1061 | 0 | <50 C. | 49.3 |
| CaBr2_1H2O_S2 | CaBr2_2H2O_S3 | 0.713 | 0.280 | 179 | 179 | 0 | 100-200 C. | 0.0 |
| SnF2 | SnF2_1H2O_S2 | 0.739 | 0.197 | −37 | −37 | 0 | <50 C. | 38.5 |
| PbBr2_1H2O_S2 | PbBr2_2H2O_S5 | 0.746 | 0.171 | 198 | 198 | 0 | 100-200 C. | 12.6 |
| WI4_S18 | WI4_3H2O_S1 | 0.745 | 0.170 | 16 | 16 | 0 | <50 C. | 28.6 |
| AlI3 | AlI3_1H2O_S2 | 0.734 | 0.210 | 340 | 340 | 0 | 300-450 C. | 8.4 |
| GeCl2_S21 | GeCl2_1H2O_S2 | 0.711 | 0.279 | 36 | 36 | 0 | <50 C. | 35.2 |
| GeI2_9H2O_S2 | GeI2_12H2O_S1 | 0.670 | 0.365 | 179 | 179 | 0 | 100-200 C. | 17.6 |
| LaI3_6H2O_S2 | LaI3_9H2O_S3 | 0.715 | 0.266 | 141 | 141 | 0 | 100-200 C. | 0.0 |
| CuBr1 | CuBr1_1H2O_S2 | 0.735 | 0.199 | −53 | −53 | 0 | <50 C. | 30.3 |
| FeI3_S3 | FeI3_2H2O_S1 | 0.730 | 0.214 | 73 | 73 | 0 | 50-100 C. | 0.0 |
| MgF2_4H2O_S7 | MgF2_6H2O_S3 | 0.657 | 0.382 | −50 | −50 | 0 | <50 C. | 24.0 |
| GaI3_1H2O_S2 | GaI3_4H2O_S1 | 0.726 | 0.221 | −9 | −9 | 0 | <50 C. | 34.6 |
| PbBr4_S20 | PbBr4_3H2O_S1 | 0.734 | 0.190 | −21 | −21 | 0 | <50 C. | 36.1 |
| YF3 | YF3_1H2O_S2 | 0.733 | 0.194 | −56 | −56 | 0 | <50 C. | 36.5 |
| MnI3_6H2O_S3 | MnI3_10H2O_S2 | 0.697 | 0.295 | 38 | 38 | 0 | <50 C. | 1.6 |
| NiF2_4H2O_S4 | NiF2_7H2O_S1 | 0.671 | 0.349 | −96 | −96 | 0 | <50 C. | 41.6 |
| VF4_4H2O_S1 | VF4_5H2O_S2 | 0.668 | 0.355 | 254 | 254 | 0 | 200-300 C. | 5.9 |
| TaI3_4H2O_S2 | TaI3_6H2O_S3 | 0.728 | 0.203 | 192 | 192 | 0 | 100-200 C. | 16.3 |
| FeI3_3H2O_S7 | FeI3_7H2O_S1 | 0.708 | 0.257 | −25 | −25 | 0 | <50 C. | 17.4 |
| FeF2_4H2O_S7 | FeF2_6H2O_S3 | 0.674 | 0.335 | −41 | −41 | 0 | <50 C. | 13.9 |
| GeI4 | GeI4_4H2O_S1 | 0.723 | 0.200 | −50 | −50 | 0 | <50 C. | 36.8 |
| TaF4_4H2O_S1 | TaF4_5H2O_S2 | 0.706 | 0.248 | 316 | 316 | 0 | 300-450 C. | 10.1 |
| LaCl3_6H2O_S2 | LaCl3_9H2O_S2 | 0.638 | 0.390 | 90 | 90 | 0 | 50-100 C. | 0.0 |
| SnI2_9H2O_S1 | SnI2_12H2O_S1 | 0.663 | 0.345 | 191 | 191 | 0 | 100-200 C. | 17.8 |
| ZnBr2_4H2O_S3 | ZnBr2_7H2O_S1 | 0.680 | 0.309 | −25 | −25 | 0 | <50 C. | 31.3 |
| CrI2_9H2O_S2 | CrI2_12H2O_S1 | 0.652 | 0.359 | 155 | 155 | 0 | 100-200 C. | 4.2 |
| VI2 | VI2_1H2O_S2 | 0.723 | 0.173 | 109 | 109 | 0 | 100-200 C. | 13.2 |
| NiBr3_S25 | NiBr3_2H2O_S2 | 0.715 | 0.201 | −42 | −42 | 0 | <50 C. | 38.1 |
| SrI2_9H2O_S1 | SrI2_12H2O_S1 | 0.646 | 0.366 | 193 | 193 | 0 | 100-200 C. | 4.9 |
| ZrBr3 | ZrBr3_2H2O_S2 | 0.708 | 0.217 | 0 | 0 | 0 | <50 C. | 45.5 |
| LaI2_9H2O_S1 | LaI2_12H2O_S1 | 0.656 | 0.343 | 204 | 204 | 0 | 200-300 C. | 22.6 |
| VF4_2H2O_S2 | VF4_3H2O_S1 | 0.670 | 0.310 | 112 | 112 | 0 | 100-200 C. | 8.2 |
| CrF4_4H2O_S1 | CrF4_5H2O_S2 | 0.656 | 0.338 | 231 | 231 | 0 | 200-300 C. | 2.4 |
| NbBr3_6H2O_S3 | NbBr3_9H2O_S2 | 0.661 | 0.327 | 96 | 96 | 0 | 50-100 C. | 0.0 |
| KI1 | KI1_1H2O_S1 | 0.683 | 0.274 | 72 | 72 | 0 | 50-100 C. | 2.7 |
| TaBr4_S18 | TaBr4_2H2O_S2 | 0.716 | 0.170 | 39 | 39 | 0 | <50 C. | 33.8 |
| CrBr2_4H2O_S3 | CrBr2_7H2O_S1 | 0.668 | 0.306 | −37 | −37 | 0 | <50 C. | 30.7 |
| VI3_6H2O_S1 | VI3_9H2O_S2 | 0.675 | 0.287 | 116 | 116 | 0 | 100-200 C. | 0.0 |
| NiBr2 | NiBr2_1H2O_S2 | 0.709 | 0.181 | 21 | 21 | 0 | <50 C. | 24.6 |
| TiBr3_6H2O_S3 | TiBr3_10H2O_S2 | 0.662 | 0.307 | −666 | 186 | 852 | Large | 31.7 |
| | | | | | | | Hysteresis | |
| PbI4_S19 | PbI4_3H2O_S1 | 0.711 | 0.164 | 15 | 15 | 0 | <50 C. | 16.4 |
| GeF4_4H2O_S1 | GeF4_5H2O_S2 | 0.660 | 0.310 | 234 | 234 | 0 | 200-300 C. | 1.0 |
| TiF4_4H2O_S1 | TiF4_5H2O_S2 | 0.638 | 0.352 | 243 | 243 | 0 | 200-300 C. | 3.1 |
| NiI3_S25 | NiI3_3H2O_S6 | 0.701 | 0.195 | −53 | −53 | 0 | <50 C. | 34.9 |
| ZrI3_6H2O_S3 | ZrI3_9H2O_S2 | 0.665 | 0.288 | 144 | 144 | 0 | 100-200 C. | 5.7 |
| LaF3_8H2O_S2 | LaF3_9H2O_S2 | 0.631 | 0.352 | 591 | 591 | 0 | 450-600 C. | 27.7 |
| TiF4_8H2O_S1 | TiF4_9H2O_S1 | −0.636 | −0.343 | −946 | −946 | 0 | <50 C. | 46.9 |
| NbF4_5H2O_S2 | NbF4_9H2O_S1 | 0.660 | 0.293 | −857 | 143 | 1001 | Large | 42.8 |
| | | | | | | | Hysteresis | |
| YCl3_2H2O_S2 | YCl3_3H2O_S9 | 0.643 | 0.326 | 283 | 283 | 0 | 200-300 C. | 10.0 |
| FeCl3_1H2O_S2 | FeCl3_2H2O_S1 | 0.648 | 0.312 | 151 | 151 | 0 | 100-200 C. | 0.5 |
| MnF4_4H2O_S1 | MnF4_5H2O_S2 | 0.637 | 0.322 | 215 | 215 | 0 | 200-300 C. | 0.0 |
| FeI3_3H2O_S7 | FeI3_6H2O_S3 | 0.680 | 0.215 | −5 | −5 | 0 | <50 C. | 10.8 |
| BeI2_9H2O_S1 | BeI2_12H2O_S1 | 0.624 | 0.345 | 105 | 105 | 0 | 100-200 C. | 7.6 |
| GaBr3 | GaBr3_1H2O_S2 | 0.682 | 0.208 | 195 | 195 | 0 | 100-200 C. | 6.6 |
| GeF2_4H2O_S2 | GeF2_7H2O_S1 | 0.630 | 0.333 | −93 | −93 | 0 | <50 C. | 29.8 |
| VF2_4H2O_S4 | VF2_7H2O_S1 | 0.620 | 0.352 | −100 | −100 | 0 | <50 C. | 41.9 |
| KI1_3H2O_S1 | KI1_4H2O_S1 | 0.630 | 0.331 | 267 | 267 | 0 | 200-300 C. | 25.6 |
| PbI2_9H2O_S1 | PbI2_12H2O_S1 | 0.645 | 0.298 | 188 | 188 | 0 | 100-200 C. | 15.4 |
| FeCl3_8H2O_S2 | FeCl3_9H2O_S2 | 0.600 | 0.380 | 572 | 572 | 0 | 450-600 C. | 25.8 |
| CrI2_4H2O_S3 | CrI2_7H2O_S1 | 0.656 | 0.271 | −6 | −6 | 0 | <50 C. | 25.1 |
| ScCl3_8H2O_S2 | ScCl3_9H2O_S2 | 0.578 | 0.410 | 608 | 608 | 0 | >600 C. | 21.2 |
| TaBr3_6H2O_S3 | TaBr3_9H2O_S2 | 0.650 | 0.271 | 88 | 88 | 0 | 50-100 C. | 0.0 |
| NbBr3_S12 | NbBr3_2H2O_S2 | 0.676 | 0.196 | −26 | −26 | 0 | <50 C. | 48.5 |
| GeI2_4H2O_S3 | GeI2_8H2O_S1 | 0.648 | 0.273 | −53 | −53 | 0 | <50 C. | 26.0 |
| MnBr3_6H2O_S3 | MnBr3_10H2O_S2 | 0.636 | 0.299 | −30 | −30 | 0 | <50 C. | 13.7 |
| GaBr3_1H2O_S2 | GaBr3_2H2O_S1 | 0.666 | 0.224 | 256 | 256 | 0 | 200-300 C. | 6.6 |
| FeI2_4H2O_S3 | FeI2_6H2O_S3 | 0.660 | 0.240 | 70 | 70 | 0 | 50-100 C. | 5.7 |
| VCl3 | VCl3_1H2O_S3 | 0.647 | 0.266 | 47 | 47 | 0 | <50 C. | 32.9 |
| MoF4_4H2O_S1 | MoF4_5H2O_S2 | 0.637 | 0.288 | 244 | 244 | 0 | 200-300 C. | 1.2 |
| MnI2 | MnI2_1H2O_S2 | 0.678 | 0.166 | 99 | 99 | 0 | 50-100 C. | 11.1 |
| AlBr3_8H2O_S2 | AlBr3_9H2O_S2 | 0.620 | 0.319 | 665 | 665 | 0 | >600 C. | 26.0 |
| SnF4_4H2O_S1 | SnF4_5H2O_S2 | 0.642 | 0.269 | 252 | 252 | 0 | 200-300 C. | 2.2 |
| SnI4_3H2O_S1 | SnI4_9H2O_S1 | 0.656 | 0.228 | −150 | 97 | 246 | <50 C. | 37.2 |
| CoI3_S25 | CoI3_3H2O_S3 | 0.670 | 0.178 | −72 | −72 | 0 | <50 C. | 41.5 |
| VI3_6H2O_S1 | VI3_10H2O_S2 | 0.643 | 0.255 | −370 | 116 | 486 | Large | 18.6 |
| | | | | | | | Hysteresis | |
| GaI3_1H2O_S2 | GaI3_3H2O_S2 | 0.656 | 0.206 | 83 | 83 | 0 | 50-100 C. | 7.1 |
| MnI3_4H2O_S1 | MnI3_6H2O_S3 | 0.651 | 0.218 | 133 | 133 | 0 | 100-200 C. | 6.0 |
| FeCl2_9H2O_S2 | FeCl2_12H2O_S1 | 0.566 | 0.388 | 31 | 31 | 0 | <50 C. | 1.8 |
| YI3_7H2O_S2 | YI3_10H2O_S2 | 0.638 | 0.254 | 31 | 181 | 150 | Large | 0.7 |
| | | | | | | | Hysteresis | |
| HfBr3_7H2O_S2 | HfBr3_9H2O_S2 | 0.630 | 0.267 | 258 | 258 | 0 | 200-300 C. | 25.3 |
| FeI3_1H2O_S2 | FeI3_3H2O_S7 | 0.649 | 0.212 | 72 | 93 | 21 | 50-100 C. | 4.5 |
| TaBr3_7H2O_S2 | TaBr3_9H2O_S2 | 0.630 | 0.263 | 252 | 252 | 0 | 200-300 C. | 19.8 |
| NbBr3_7H2O_S2 | NbBr3_9H2O_S2 | 0.610 | 0.301 | 238 | 238 | 0 | 200-300 C. | 17.2 |
| GaCl3_1H2O_S2 | GaCl3_2H2O_S1 | 0.619 | 0.282 | 137 | 137 | 0 | 100-200 C. | 7.6 |
| NbI3 | NbI3_2H2O_S2 | 0.658 | 0.167 | 18 | 18 | 0 | <50 C. | 36.6 |
| MoCl3_2H2O_S1 | MoCl3_4H2O_S2 | 0.620 | 0.276 | −14 | −14 | 0 | <50 C. | 27.4 |
| BaBr2_2H2O_S4 | BaBr2_4H2O_S1 | 0.634 | 0.234 | 23 | 23 | 0 | <50 C. | 20.0 |
| ZrI4_2H2O_S1 | ZrI4_4H2O_S1 | 0.650 | 0.183 | 147 | 147 | 0 | 100-200 C. | 2.5 |
| BaBr2_1H2O_S1 | BaBr2_2H2O_S4 | 0.650 | 0.184 | 146 | 146 | 0 | 100-200 C. | 0.0 |
| WBr4 | WBr4_2H2O_S2 | 0.658 | 0.152 | 7 | 7 | 0 | <50 C. | 39.3 |
| NbI3_6H2O_S3 | NbI3_10H2O_S2 | 0.629 | 0.244 | −146 | 49 | 194 | <50 C. | 8.6 |
| BeBr2_9H2O_S1 | BeBr2_12H2O_S1 | 0.568 | 0.363 | 46 | 46 | 0 | <50 C. | 0.1 |
| ScCl3 | ScCl3_1H2O_S2 | 0.615 | 0.274 | 45 | 45 | 0 | <50 C. | 42.2 |
| WF4_4H2O_S1 | WF4_5H2O_S2 | 0.636 | 0.216 | 244 | 244 | 0 | 200-300 C. | 5.6 |
| VBr3_8H2O_S2 | VBr3_9H2O_S2 | 0.598 | 0.304 | 671 | 671 | 0 | >600 C. | 27.8 |
| HfI4_2H2O_S1 | HfI4_4H2O_S1 | 0.651 | 0.161 | 144 | 144 | 0 | 100-200 C. | 4.3 |
| SnCl2 | SnCl2_1H2O_S2 | 0.629 | 0.221 | 41 | 41 | 0 | <50 C. | 32.5 |
| CaI2_1H2O_S2 | CaI2_2H2O_S8 | 0.628 | 0.222 | 229 | 229 | 0 | 200-300 C. | 2.5 |
| TiI3_6H2O_S1 | TiI3_10H2O_S2 | 0.617 | 0.249 | −519 | 155 | 674 | Large | 25.2 |
| | | | | | | | Hysteresis | |
| CrI3_7H2O_S1 | CrI3_9H2O_S2 | 0.614 | 0.256 | 248 | 248 | 0 | 200-300 C. | 13.5 |
| NiCl3_6H2O_S3 | NiCl3_10H2O_S2 | 0.576 | 0.332 | −477 | 57 | 534 | <50 C. | 23.3 |
| LiI1_2H2O_S3 | LiI1_3H2O_S1 | 0.612 | 0.260 | 61 | 61 | 0 | 50-100 C. | 0.0 |
| LaBr3_6H2O_S2 | LaBr3_9H2O_S2 | 0.595 | 0.296 | 92 | 92 | 0 | 50-100 C. | 0.0 |
| BaI2_9H2O_S1 | BaI2_12H2O_S1 | 0.584 | 0.315 | 164 | 164 | 0 | 100-200 C. | 5.5 |
| GaI3_8H2O_S2 | GaI3_9H2O_S2 | 0.612 | 0.250 | 775 | 775 | 0 | >600 C. | 35.8 |
| SrI2_1H2O_S1 | SrI2_2H2O_S7 | 0.637 | 0.172 | 171 | 171 | 0 | 100-200 C. | 0.0 |
| VI4_S17 | VI4_2H2O_S2 | 0.640 | 0.157 | 47 | 47 | 0 | <50 C. | 21.0 |
| CrI2 | CrI2_1H2O_S2 | 0.640 | 0.154 | 69 | 69 | 0 | 50-100 C. | 22.1 |
| MoI3_7H2O_S1 | MoI3_9H2O_S2 | 0.609 | 0.250 | 274 | 274 | 0 | 200-300 C. | 23.2 |
| LaCl3 | LaCl3_1H2O_S3 | 0.628 | 0.196 | 80 | 80 | 0 | 50-100 C. | 19.4 |
| CuCl2 | CuCl2_1H2O_S2 | 0.619 | 0.219 | −44 | −44 | 0 | <50 C. | 47.7 |
| PbCl2_4H2O_S3 | PbCl2_7H2O_S1 | 0.613 | 0.229 | −62 | −62 | 0 | <50 C. | 31.8 |
| NbF4 | NbF4_1H2O_S1 | 0.631 | 0.170 | −55 | −55 | 0 | <50 C. | 49.4 |
| RbBr1_3H2O_S1 | RbBr1_4H2O_S1 | 0.583 | 0.294 | 205 | 205 | 0 | 200-300 C. | 16.9 |
| TiI3_7H2O_S2 | TiI3_9H2O_S2 | 0.598 | 0.263 | 260 | 260 | 0 | 200-300 C. | 12.7 |
| ZrBr3_7H2O_S2 | ZrBr3_9H2O_S2 | 0.582 | 0.295 | 226 | 226 | 0 | 200-300 C. | 9.1 |
| SnI4_2H2O_S2 | SnI4_4H2O_S1 | 0.627 | 0.170 | 93 | 175 | 83 | 100-200 C. | 0.4 |
| MoI3_6H2O_S3 | MoI3_9H2O_S2 | 0.600 | 0.246 | 86 | 86 | 0 | 50-100 C. | 0.8 |
| PbBr2 | PbBr2_1H2O_S2 | 0.633 | 0.141 | 98 | 98 | 0 | 50-100 C. | 12.6 |
| SnF4_8H2O_S1 | SnF4_9H2O_S1 | −0.591 | −0.258 | −903 | −903 | 0 | <50 C. | 44.9 |
| VI3_7H2O_S1 | VI3_9H2O_S2 | 0.593 | 0.252 | 240 | 240 | 0 | 200-300 C. | 15.0 |
| NiBr3_6H2O_S3 | NiBr3_9H2O_S1 | 0.590 | 0.257 | −3 | −3 | 0 | <50 C. | 7.3 |
| TaI3_6H2O_S3 | TaI3_10H2O_S2 | 0.607 | 0.208 | −9 | −9 | 0 | <50 C. | 10.0 |
| MnBr3_6H2O_S3 | MnBr3_9H2O_S2 | 0.576 | 0.280 | 19 | 19 | 0 | <50 C. | 4.1 |
| SnCl4_2H2O_S2 | SnCl4_3H2O_S1 | 0.591 | 0.240 | 244 | 244 | 0 | 200-300 C. | 4.1 |
| RbI1_3H2O_S1 | RbI1_4H2O_S1 | 0.580 | 0.263 | 240 | 240 | 0 | 200-300 C. | 23.5 |
| CrCl2_4H2O_S3 | CrCl2_7H2O_S1 | 0.546 | 0.324 | −89 | −89 | 0 | <50 C. | 39.9 |
| NbF4_8H2O_S1 | NbF4_9H2O_S1 | −0.580 | −0.258 | −857 | −857 | 0 | <50 C. | 42.8 |
| CoBr3_7H2O_S1 | CoBr3_9H2O_S2 | 0.574 | 0.269 | 151 | 151 | 0 | 100-200 C. | 9.5 |
| CuCl2_4H2O_S3 | CuCl2_6H2O_S3 | 0.567 | 0.281 | −40 | −40 | 0 | <50 C. | 18.6 |
| GeBr2 | GeBr2_1H2O_S2 | 0.608 | 0.176 | 29 | 29 | 0 | <50 C. | 27.5 |
| RbI1 | RbI1_1H2O_S1 | 0.596 | 0.211 | 60 | 60 | 0 | 50-100 C. | 2.6 |
| FeCl3_2H2O_S1 | FeCl3_3H2O_S8 | 0.561 | 0.291 | 157 | 157 | 0 | 100-200 C. | 0.5 |
| ScI3_7H2O_S2 | ScI3_9H2O_S2 | 0.573 | 0.256 | 243 | 243 | 0 | 200-300 C. | 8.8 |
| SnCl2_4H2O_S2 | SnCl2_7H2O_S1 | 0.564 | 0.268 | −80 | −80 | 0 | <50 C. | 33.0 |
| YCl3_6H2O_S2 | YCl3_8H2O_S2 | 0.546 | 0.302 | 78 | 78 | 0 | 50-100 C. | 10.0 |
| CrBr3_8H2O_S2 | CrBr3_9H2O_S2 | 0.558 | 0.278 | 590 | 590 | 0 | 450-600 C. | 22.5 |
| YBr3_6H2O_S2 | YBr3_8H2O_S2 | 0.572 | 0.247 | 127 | 127 | 0 | 100-200 C. | 4.3 |
| PbF4_4H2O_S1 | PbF4_5H2O_S2 | 0.590 | 0.194 | 223 | 223 | 0 | 200-300 C. | 3.1 |
| TiBr3 | TiBr3_1H2O_S3 | 0.595 | 0.172 | 88 | 88 | 0 | 50-100 C. | 24.5 |
| YI3_6H2O_S2 | YI3_8H2O_S2 | 0.579 | 0.218 | 181 | 189 | 9 | 100-200 C. | 0.0 |
| TiBr3_8H2O_S2 | TiBr3_9H2O_S2 | 0.547 | 0.287 | 611 | 611 | 0 | >600 C. | 23.0 |
| ZrCl4_2H2O_S2 | ZrCl4_3H2O_S1 | 0.561 | 0.255 | 228 | 228 | 0 | 200-300 C. | 0.0 |
| VCl3_3H2O_S9 | VCl3_4H2O_S2 | 0.550 | 0.276 | 161 | 161 | 0 | 100-200 C. | 3.0 |
| HfCl4_2H2O_S2 | HfCl4_3H2O_S1 | 0.581 | 0.199 | 238 | 238 | 0 | 200-300 C. | 0.0 |
| LiBr1_3H2O_S1 | LiBr1_4H2O_S1 | 0.538 | 0.295 | 48 | 48 | 0 | <50 C. | 0.0 |
| SiBr2_8H2O_S1 | SiBr2_12H2O_S1 | 0.509 | 0.342 | −37 | −37 | 0 | <50 C. | 13.0 |
| LaBr3 | LaBr3_1H2O_S3 | 0.596 | 0.143 | 114 | 114 | 0 | 100-200 C. | 17.1 |
| MoBr3_8H2O_S2 | MoBr3_9H2O_S2 | 0.552 | 0.264 | 626 | 626 | 0 | >600 C. | 27.1 |
| YBr3_7H2O_S2 | YBr3_9H2O_S2 | 0.542 | 0.282 | 201 | 201 | 0 | 200-300 C. | 4.2 |
| HfCl3_8H2O_S1 | HfCl3_9H2O_S2 | 0.542 | 0.278 | 577 | 577 | 0 | 450-600 C. | 25.1 |
| GaBr3_8H2O_S2 | GaBr3_9H2O_S2 | 0.545 | 0.262 | 573 | 573 | 0 | 450-600 C. | 22.8 |
| PbF4_3H2O_S2 | PbF4_4H2O_S1 | 0.578 | 0.175 | 154 | 154 | 0 | 100-200 C. | 3.1 |
| NbCl3_8H2O_S2 | NbCl3_9H2O_S2 | 0.510 | 0.321 | 523 | 523 | 0 | 450-600 C. | 21.7 |
| MnCl4_3H2O_S1 | MnCl4_4H2O_S1 | 0.542 | 0.265 | 215 | 215 | 0 | 200-300 C. | 0.4 |
| NbI4 | NbI4_2H2O_S2 | 0.585 | 0.144 | 42 | 42 | 0 | <50 C. | 25.5 |
| CuI2_4H2O_S2 | CuI2_8H2O_S3 | 0.554 | 0.234 | −88 | −88 | 0 | <50 C. | 30.2 |
| ZnI2 | ZnI2_1H2O_S2 | 0.581 | 0.139 | 48 | 48 | 0 | <50 C. | 36.0 |
| ZrCl3_8H2O_S2 | ZrCl3_9H2O_S2 | 0.501 | 0.324 | 524 | 524 | 0 | 450-600 C. | 20.1 |
| SnBr2 | SnBr2_1H2O_S2 | 0.574 | 0.158 | 48 | 48 | 0 | <50 C. | 22.9 |
| YBr3_S7 | YBr3_1H2O_S3 | 0.573 | 0.151 | 85 | 85 | 0 | 50-100 C. | 30.7 |
| BaI2_1H2O_S1 | BaI2_2H2O_S9 | 0.574 | 0.139 | 135 | 135 | 0 | 100-200 C. | 0.0 |
| TaI4 | TaI4_2H2O_S1 | 0.579 | 0.120 | 24 | 24 | 0 | <50 C. | 29.5 |
| FeI2 | FeI2_1H2O_S2 | 0.575 | 0.135 | 29 | 29 | 0 | <50 C. | 23.5 |
| MnI3_6H2O_S3 | MnI3_9H2O_S2 | 0.538 | 0.231 | 42 | 42 | 0 | <50 C. | 0.7 |
| LaI3_7H2O_S2 | LaI3_9H2O_S3 | 0.545 | 0.203 | 201 | 201 | 0 | 200-300 C. | 7.2 |
| MoCl4_3H2O_S1 | MoCl4_4H2O_S1 | 0.529 | 0.235 | 225 | 225 | 0 | 200-300 C. | 2.0 |
| TaCl3_8H2O_S2 | TaCl3_9H2O_S2 | 0.515 | 0.258 | 522 | 522 | 0 | 450-600 C. | 23.1 |
| SnF4_5H2O_S2 | SnF4_9H2O_S1 | 0.527 | 0.229 | −903 | 124 | 1027 | Large | 44.9 |
| | | | | | | | Hysteresis | |
| CrCl3 | CrCl3_1H2O_S3 | 0.532 | 0.215 | −13 | −13 | 0 | <50 C. | 43.8 |
| MoI4_S28 | MoI4_2H2O_S2 | 0.557 | 0.131 | 14 | 14 | 0 | <50 C. | 28.7 |
| SiCl2_7H2O_S1 | SiCl2_8H2O_S1 | 0.461 | 0.337 | 288 | 288 | 0 | 200-300 C. | 12.6 |
| SiI4_8H2O_S1 | SiI4_9H2O_S1 | 0.534 | 0.202 | 691 | 691 | 0 | >600 C. | 27.5 |
| NbI3_6H2O_S3 | NbI3_9H2O_S2 | 0.525 | 0.222 | 49 | 49 | 0 | <50 C. | 0.0 |
| PbCl4_2H2O_S2 | PbCl4_3H2O_S1 | 0.541 | 0.178 | 218 | 218 | 0 | 200-300 C. | 4.7 |
| SnI4_3H2O_S1 | SnI4_5H2O_S2 | 0.546 | 0.151 | 97 | 97 | 0 | 50-100 C. | 0.0 |
| PbI4_3H2O_S1 | PbI4_5H2O_S1 | 0.543 | 0.150 | 141 | 141 | 0 | 100-200 C. | 16.4 |
| PbBr2_4H2O_S3 | PbBr2_7H2O_S1 | 0.534 | 0.175 | −75 | −75 | 0 | <50 C. | 32.6 |
| WCl4_8H2O_S1 | WCl4_9H2O_S1 | −0.517 | −0.217 | −997 | −997 | 0 | <50 C. | 49.4 |
| FeBr2_9H2O_S2 | FeBr2_12H2O_S1 | 0.486 | 0.278 | 1 | 1 | 0 | <50 C. | 5.4 |
| TiCl4_8H2O_S1 | TiCl4_9H2O_S1 | −0.485 | −0.277 | −941 | −941 | 0 | <50 C. | 46.7 |
| FeCl2_8H2O_S2 | FeCl2_9H2O_S2 | 0.477 | 0.289 | 299 | 299 | 0 | 200-300 C. | 11.1 |
| TiI2_S16 | TiI2_1H2O_S2 | 0.542 | 0.131 | 13 | 13 | 0 | <50 C. | 34.0 |
| SiCl2_8H2O_S1 | SiCl2_12H2O_S1 | 0.428 | 0.348 | −85 | −85 | 0 | <50 C. | 20.5 |
| TiCl3_3H2O_S9 | TiCl3_4H2O_S2 | 0.487 | 0.256 | 124 | 124 | 0 | 100-200 C. | 6.7 |
| FeBr2_8H2O_S2 | FeBr2_9H2O_S2 | 0.493 | 0.243 | 355 | 355 | 0 | 300-450 C. | 13.9 |
| TiF4_5H2O_S2 | TiF4_9H2O_S1 | 0.482 | 0.261 | −946 | 121 | 1067 | Large | 46.9 |
| | | | | | | | Hysteresis | |
| ScBr3_6H2O_S1 | ScBr3_8H2O_S2 | 0.499 | 0.225 | 57 | 57 | 0 | 50-100 C. | 14.6 |
| TaBr3_6H2O_S3 | TaBr3_10H2O_S2 | 0.512 | 0.189 | −580 | 88 | 668 | <50 C. | 27.9 |
| MnI4_S31 | MnI4_2H2O_S1 | 0.531 | 0.124 | −19 | −19 | 0 | <50 C. | 38.0 |
| MnBr2_4H2O_S3 | MnBr2_7H2O_S1 | 0.497 | 0.223 | −100 | −100 | 0 | <50 C. | 46.2 |
| LaCl3_7H2O_S1 | LaCl3_9H2O_S2 | 0.464 | 0.284 | 123 | 123 | 0 | 100-200 C. | 4.0 |
| MoCl4 | MoCl4_1H2O_S1 | 0.503 | 0.199 | 75 | 75 | 0 | 50-100 C. | 24.8 |
| TaI3_6H2O_S3 | TaI3_9H2O_S2 | 0.506 | 0.187 | 35 | 35 | 0 | <50 C. | 1.7 |
| ZrCl4_3H2O_S1 | ZrCl4_4H2O_S1 | 0.488 | 0.230 | 207 | 207 | 0 | 200-300 C. | 0.0 |
| SrI2_6H2O_S1 | SrI2_8H2O_S1 | 0.496 | 0.209 | 74 | 74 | 0 | 50-100 C. | 9.7 |
| GaF3_9H2O_S2 | GaF3_10H2O_S2 | −0.473 | −0.255 | −808 | −808 | 0 | <50 C. | 38.1 |
| ScI3_6H2O_S1 | ScI3_8H2O_S2 | 0.500 | 0.192 | 102 | 102 | 0 | 100-200 C. | 7.3 |
| YI3_7H2O_S2 | YI3_9H2O_S3 | 0.499 | 0.191 | 100 | 181 | 81 | 100-200 C. | 0.0 |
| KF1_2H2O_S1 | KF1_3H2O_S1 | 0.452 | 0.282 | −57 | −57 | 0 | <50 C. | 29.3 |
| HfI3_7H2O_S2 | HfI3_9H2O_S2 | 0.499 | 0.186 | 187 | 187 | 0 | 100-200 C. | 13.3 |
| HfCl4_3H2O_S1 | HfCl4_4H2O_S1 | 0.500 | 0.181 | 212 | 212 | 0 | 200-300 C. | 0.0 |
| SnCl4_3H2O_S1 | SnCl4_4H2O_S1 | 0.489 | 0.208 | 202 | 202 | 0 | 200-300 C. | 0.0 |
| CrI4_3H2O_S2 | CrI4_5H2O_S2 | 0.509 | 0.149 | 58 | 58 | 0 | 50-100 C. | 10.7 |
| SiI2_8H2O_S1 | SiI2_12H2O_S1 | 0.453 | 0.266 | −46 | −46 | 0 | <50 C. | 14.5 |
| FeCl2_4H2O_S3 | FeCl2_6H2O_S2 | 0.458 | 0.251 | −71 | −71 | 0 | <50 C. | 24.8 |
| CrBr3 | CrBr3_1H2O_S3 | 0.503 | 0.139 | 22 | 22 | 0 | <50 C. | 32.8 |
| NaCl1_2H2O_S2 | NaCl1_3H2O_S1 | 0.436 | 0.287 | −52 | −52 | 0 | <50 C. | 21.1 |
| GaBr3_2H2O_S1 | GaBr3_4H2O_S2 | 0.486 | 0.172 | −48 | −48 | 0 | <50 C. | 37.5 |
| FeBr3_8H2O_S2 | FeBr3_9H2O_S2 | 0.463 | 0.223 | 427 | 427 | 0 | 300-450 C. | 18.6 |
| PbCl2_4H2O_S3 | PbCl2_6H2O_S3 | 0.480 | 0.182 | −32 | −32 | 0 | <50 C. | 19.9 |
| ScBr3_8H2O_S2 | ScBr3_9H2O_S2 | 0.453 | 0.241 | 463 | 463 | 0 | 450-600 C. | 14.6 |
| NaBr1_2H2O_S3 | NaBr1_3H2O_S1 | 0.455 | 0.236 | −20 | −20 | 0 | <50 C. | 13.3 |
| ScCl3_3H2O_S9 | ScCl3_4H2O_S2 | 0.447 | 0.247 | 105 | 105 | 0 | 100-200 C. | 10.4 |
| NbI3_7H2O_S2 | NbI3_9H2O_S2 | 0.467 | 0.197 | 156 | 156 | 0 | 100-200 C. | 13.0 |
| PbI4_5H2O_S1 | PbI4_9H2O_S1 | 0.481 | 0.156 | −39 | −39 | 0 | <50 C. | 16.2 |
| MnBr4_8H2O_S1 | MnBr4_9H2O_S1 | −0.464 | −0.198 | −1000 | −1000 | 0 | <50 C. | 49.5 |
| GaI3 | GaI3_1H2O_S2 | 0.485 | 0.133 | 153 | 153 | 0 | 100-200 C. | 0.0 |
| HfBr4_2H2O_S2 | HfBr4_3H2O_S1 | 0.482 | 0.128 | 210 | 210 | 0 | 200-300 C. | 0.0 |
| CoCl3_9H2O_S2 | CoCl3_10H2O_S2 | −0.431 | −0.250 | −865 | −865 | 0 | <50 C. | 40.6 |
| ZrBr4_2H2O_S2 | ZrBr4_3H2O_S1 | 0.472 | 0.151 | 207 | 207 | 0 | 200-300 C. | 0.0 |
| CoCl3_6H2O_S3 | CoCl3_10H2O_S2 | 0.428 | 0.249 | −865 | 121 | 986 | Large | 40.6 |
| | | | | | | | Hysteresis | |
| ZrI3_7H2O_S2 | ZrI3_9H2O_S2 | 0.452 | 0.195 | 151 | 151 | 0 | 100-200 C. | 4.3 |
| SnI4_1H2O_S1 | SnI4_2H2O_S2 | 0.476 | 0.119 | 267 | 267 | 0 | 200-300 C. | 0.0 |
| FeBr2_4H2O_S3 | FeBr2_6H2O_S2 | 0.448 | 0.195 | −56 | −56 | 0 | <50 C. | 23.4 |
| SnF2_4H2O_S2 | SnF2_6H2O_S3 | 0.445 | 0.198 | −93 | −93 | 0 | <50 C. | 24.0 |
| GeCl2_4H2O_S2 | GeCl2_6H2O_S3 | 0.428 | 0.230 | −75 | −75 | 0 | <50 C. | 23.2 |
| CuBr2_4H2O_S3 | CuBr2_6H2O_S3 | 0.451 | 0.178 | −71 | −71 | 0 | <50 C. | 20.8 |
| GeCl2_4H2O_S2 | GeCl2_7H2O_S1 | 0.425 | 0.229 | −132 | −132 | 0 | <50 C. | 41.3 |
| NiF3_9H2O_S2 | NiF3_10H2O_S2 | −0.425 | −0.229 | −737 | −737 | 0 | <50 C. | 34.9 |
| VBr3_S31 | VBr3_1H2O_S3 | 0.465 | 0.130 | 2 | 2 | 0 | <50 C. | 40.4 |
| MnCl4_4H2O_S1 | MnCl4_5H2O_S2 | 0.429 | 0.220 | 159 | 159 | 0 | 100-200 C. | 2.0 |
| NbCl3_S22 | NbCl3_1H2O_S2 | 0.447 | 0.177 | −10 | −10 | 0 | <50 C. | 28.4 |
| LaBr3_7H2O_S1 | LaBr3_9H2O_S2 | 0.430 | 0.214 | 123 | 123 | 0 | 100-200 C. | 3.8 |
| CoF3_3H2O_S9 | CoF3_4H2O_S2 | 0.444 | 0.183 | −38 | −38 | 0 | <50 C. | 22.8 |
| HfF4_8H2O_S1 | HfF4_9H2O_S1 | −0.450 | −0.167 | −750 | −750 | 0 | <50 C. | 37.7 |
| VI3_8H2O_S2 | VI3_9H2O_S2 | 0.438 | 0.186 | 485 | 485 | 0 | 450-600 C. | 19.9 |
| RbF1_2H2O_S1 | RbF1_3H2O_S1 | 0.427 | 0.205 | −51 | −51 | 0 | <50 C. | 28.3 |
| ZrCl4_4H2O_S1 | ZrCl4_5H2O_S2 | 0.426 | 0.206 | 183 | 183 | 0 | 100-200 C. | 0.8 |
| PbI2_4H2O_S2 | PbI2_7H2O_S1 | 0.451 | 0.141 | −84 | −84 | 0 | <50 C. | 32.3 |
| TaF4_8H2O_S1 | TaF4_9H2O_S1 | −0.446 | −0.156 | −721 | −721 | 0 | <50 C. | 36.3 |
| HfBr3_8H2O_S1 | HfBr3_9H2O_S2 | 0.435 | 0.185 | 460 | 460 | 0 | 450-600 C. | 22.2 |
| PbCl4_3H2O_S1 | PbCl4_4H2O_S1 | 0.446 | 0.157 | 178 | 178 | 0 | 100-200 C. | 0.2 |
| SnCl2_4H2O_S2 | SnCl2_6H2O_S3 | 0.424 | 0.205 | −64 | −64 | 0 | <50 C. | 22.9 |
| HfCl4_4H2O_S1 | HfCl4_5H2O_S2 | 0.439 | 0.166 | 192 | 192 | 0 | 100-200 C. | 0.5 |
| CuCl2_4H2O_S3 | CuCl2_7H2O_S1 | 0.410 | 0.226 | −139 | −139 | 0 | <50 C. | 43.1 |
| CrI4_2H2O_S2 | CrI4_3H2O_S2 | 0.451 | 0.124 | 248 | 248 | 0 | 200-300 C. | 14.4 |
| LaI3 | LaI3_1H2O_S3 | 0.456 | 0.099 | 90 | 90 | 0 | 50-100 C. | 25.4 |
| LaI3_6H2O_S2 | LaI3_8H2O_S2 | 0.439 | 0.159 | 88 | 88 | 0 | 50-100 C. | 5.7 |
| CoCl3_S22 | CoCl3_1H2O_S3 | 0.439 | 0.158 | −75 | −75 | 0 | <50 C. | 42.9 |
| GeI4 | GeI4_3H2O_S1 | 0.450 | 0.120 | −99 | −99 | 0 | <50 C. | 49.3 |
| YCl3_8H2O_S2 | YCl3_9H2O_S2 | 0.388 | 0.257 | 357 | 357 | 0 | 300-450 C. | 10.0 |
| AlI3_8H2O_S2 | AlI3_9H2O_S2 | 0.428 | 0.182 | 438 | 438 | 0 | 300-450 C. | 16.0 |
| SnI2 | SnI2_1H2O_S2 | 0.451 | 0.111 | 24 | 24 | 0 | <50 C. | 19.5 |
| NbF3_9H2O_S2 | NbF3_10H2O_S2 | −0.416 | −0.206 | −739 | −739 | 0 | <50 C. | 35.0 |
| FeI2_9H2O_S2 | FeI2_12H2O_S1 | 0.413 | 0.210 | −20 | −20 | 0 | <50 C. | 7.8 |
| SnCl4_4H2O_S1 | SnCl4_5H2O_S2 | 0.424 | 0.187 | 177 | 177 | 0 | 100-200 C. | 1.1 |
| MoCl4_4H2O_S1 | MoCl4_5H2O_S2 | 0.419 | 0.194 | 162 | 162 | 0 | 100-200 C. | 2.0 |
| MoBr4_8H2O_S1 | MoBr4_9H2O_S1 | −0.427 | −0.168 | −936 | −936 | 0 | <50 C. | 46.5 |
| NaI1_2H2O_S3 | NaI1_3H2O_S1 | 0.419 | 0.186 | −13 | −13 | 0 | <50 C. | 8.3 |
| LiI1_3H2O_S1 | LiI1_4H2O_S1 | 0.414 | 0.195 | 2 | 2 | 0 | <50 C. | 4.8 |
| PbI4_4H2O_S1 | PbI4_5H2O_S1 | 0.440 | 0.122 | 399 | 399 | 0 | 300-450 C. | 29.7 |
| GeBr2_4H2O_S2 | GeBr2_6H2O_S3 | 0.419 | 0.180 | −64 | −64 | 0 | <50 C. | 20.8 |
| FeI2_4H2O_S3 | FeI2_7H2O_S1 | 0.422 | 0.169 | −105 | −105 | 0 | <50 C. | 40.6 |
| HfBr4_3H2O_S1 | HfBr4_4H2O_S1 | 0.438 | 0.121 | 201 | 201 | 0 | 200-300 C. | 0.0 |
| NiI3_S25 | NiI3_2H2O_S2 | 0.441 | 0.107 | −99 | −99 | 0 | <50 C. | 44.1 |
| LaBr3_6H2O_S2 | LaBr3_8H2O_S2 | 0.416 | 0.170 | 32 | 32 | 0 | <50 C. | 6.5 |
| NiI2 | NiI2_1H2O_S2 | 0.438 | 0.097 | −54 | −54 | 0 | <50 C. | 37.7 |
| FeI2_8H2O_S1 | FeI2_9H2O_S2 | 0.412 | 0.176 | 296 | 296 | 0 | 200-300 C. | 10.4 |
| SnBr2_4H2O_S3 | SnBr2_6H2O_S3 | 0.416 | 0.167 | −51 | −51 | 0 | <50 C. | 20.3 |
| ZrBr4_3H2O_S1 | ZrBr4_4H2O_S1 | 0.424 | 0.141 | 193 | 193 | 0 | 100-200 C. | 0.0 |
| MoBr3_9H2O_S2 | MoBr3_10H2O_S2 | −0.407 | −0.177 | −897 | −897 | 0 | <50 C. | 42.0 |
| NbBr3_8H2O_S2 | NbBr3_9H2O_S2 | 0.397 | 0.196 | 392 | 392 | 0 | 300-450 C. | 16.0 |
| CoF3_9H2O_S2 | CoF3_10H2O_S2 | −0.388 | −0.214 | −708 | −708 | 0 | <50 C. | 33.6 |
| TaBr3_8H2O_S2 | TaBr3_9H2O_S2 | 0.407 | 0.170 | 404 | 404 | 0 | 300-450 C. | 17.1 |
| NiCl3_S25 | NiCl3_1H2O_S3 | 0.414 | 0.150 | −84 | −84 | 0 | <50 C. | 41.9 |
| PbBr2_4H2O_S3 | PbBr2_6H2O_S3 | 0.417 | 0.139 | −47 | −47 | 0 | <50 C. | 20.7 |
| MgI2_8H2O_S3 | MgI2_9H2O_S2 | 0.395 | 0.179 | 267 | 267 | 0 | 200-300 C. | 3.2 |
| TiBr2_1H2O_S2 | TiBr2_2H2O_S3 | 0.411 | 0.136 | −45 | −45 | 0 | <50 C. | 32.2 |
| TiI3_8H2O_S2 | TiI3_9H2O_S2 | 0.396 | 0.175 | 434 | 434 | 0 | 300-450 C. | 15.1 |
| CoI2 | CoI2_1H2O_S2 | 0.421 | 0.094 | −60 | −60 | 0 | <50 C. | 42.5 |
| TiCl3_9H2O_S2 | TiCl3_10H2O_S2 | −0.369 | −0.218 | −772 | −772 | 0 | <50 C. | 36.5 |
| LaCl3_6H2O_S2 | LaCl3_8H2O_S2 | 0.378 | 0.192 | −17 | −17 | 0 | <50 C. | 11.5 |
| MoI3_8H2O_S2 | MoI3_9H2O_S2 | 0.391 | 0.161 | 429 | 429 | 0 | 300-450 C. | 18.7 |
| YCl3_3H2O_S9 | YCl3_4H2O_S2 | 0.377 | 0.190 | 75 | 75 | 0 | 50-100 C. | 12.8 |
| CrI3_8H2O_S2 | CrI3_9H2O_S2 | 0.388 | 0.162 | 385 | 385 | 0 | 300-450 C. | 13.5 |
| TiI3_6H2O_S1 | TiI3_8H2O_S2 | 0.391 | 0.147 | 15 | 15 | 0 | <50 C. | 15.1 |
| BeF2_8H2O_S1 | BeF2_9H2O_S1 | 0.342 | 0.238 | 68 | 68 | 0 | 50-100 C. | 1.1 |
| ZrBr3_8H2O_S1 | ZrBr3_9H2O_S2 | 0.371 | 0.188 | 363 | 363 | 0 | 300-450 C. | 11.5 |
| WI4_S18 | WI4_2H2O_S1 | 0.408 | 0.082 | −68 | −68 | 0 | <50 C. | 47.2 |
| SnI2_4H2O_S2 | SnI2_7H2O_S1 | 0.390 | 0.141 | −112 | −112 | 0 | <50 C. | 35.1 |
| TiBr3_6H2O_S3 | TiBr3_8H2O_S2 | 0.378 | 0.166 | −27 | −27 | 0 | <50 C. | 23.0 |
| YI3_8H2O_S2 | YI3_10H2O_S2 | 0.382 | 0.152 | 31 | 100 | 69 | 50-100 C. | 0.7 |
| FeI3_2H2O_S1 | FeI3_4H2O_S1 | 0.392 | 0.121 | −196 | 72 | 268 | <50 C. | 23.0 |
| MoF3_3H2O_S9 | MoF3_4H2O_S2 | 0.379 | 0.155 | −35 | −35 | 0 | <50 C. | 21.3 |
| PbI4_5H2O_S1 | PbI4_8H2O_S1 | 0.392 | 0.116 | −45 | −45 | 0 | <50 C. | 14.4 |
| TaBr3_S22 | TaBr3_1H2O_S2 | 0.399 | 0.090 | −2 | −2 | 0 | <50 C. | 23.3 |
| FeI3_1H2O_S2 | FeI3_2H2O_S1 | 0.387 | 0.113 | 93 | 93 | 0 | 50-100 C. | 4.5 |
| GeBr2_4H2O_S2 | GeBr2_7H2O_S1 | 0.370 | 0.160 | −142 | −142 | 0 | <50 C. | 42.1 |
| FeI3_S3 | FeI3_1H2O_S2 | 0.387 | 0.104 | 52 | 52 | 0 | 50-100 C. | 4.5 |
| VI4_8H2O_S1 | VI4_9H2O_S1 | −0.376 | −0.133 | −927 | −927 | 0 | <50 C. | 46.1 |
| GeF2_4H2O_S2 | GeF2_6H2O_S3 | 0.355 | 0.179 | −139 | −139 | 0 | <50 C. | 29.3 |
| LaCl3_8H2O_S2 | LaCl3_9H2O_S2 | 0.337 | 0.206 | 302 | 302 | 0 | 300-450 C. | 11.5 |
| MnBr3_S12 | MnBr3_1H2O_S3 | 0.378 | 0.102 | −54 | −54 | 0 | <50 C. | 41.3 |
| HfBr4_4H2O_S1 | HfBr4_5H2O_S2 | 0.375 | 0.109 | 164 | 164 | 0 | 100-200 C. | 2.1 |
| LaF3 | LaF3_1H2O_S3 | 0.379 | 0.093 | −136 | −136 | 0 | <50 C. | 46.4 |
| GaBr3_2H2O_S1 | GaBr3_3H2O_S4 | 0.368 | 0.127 | 43 | 43 | 0 | <50 C. | 12.6 |
| BeBr2_8H2O_S1 | BeBr2_9H2O_S1 | 0.334 | 0.192 | 162 | 162 | 0 | 100-200 C. | 3.8 |
| PbI2_4H2O_S2 | PbI2_6H2O_S3 | 0.368 | 0.114 | −50 | −50 | 0 | <50 C. | 19.6 |
| ZrF3_9H2O_S2 | ZrF3_10H2O_S2 | −0.345 | −0.171 | −657 | −657 | 0 | <50 C. | 31.3 |
| WBr4_8H2O_S1 | WBr4_9H2O_S1 | −0.364 | −0.124 | −840 | −840 | 0 | <50 C. | 41.9 |
| AlI3_6H2O_S1 | AlI3_8H2O_S2 | 0.357 | 0.141 | −6 | −6 | 0 | <50 C. | 16.0 |
| PbI2 | PbI2_1H2O_S2 | 0.374 | 0.078 | −16 | −16 | 0 | <50 C. | 26.8 |
| CrF3_3H2O_S9 | CrF3_4H2O_S2 | 0.346 | 0.161 | −74 | −74 | 0 | <50 C. | 23.8 |
| ZrBr4_4H2O_S1 | ZrBr4_5H2O_S2 | 0.359 | 0.123 | 150 | 150 | 0 | 100-200 C. | 2.6 |
| GeI2_4H2O_S3 | GeI2_6H2O_S3 | 0.352 | 0.134 | −74 | −74 | 0 | <50 C. | 19.8 |
| SnI4_2H2O_S2 | SnI4_3H2O_S1 | 0.364 | 0.096 | 175 | 175 | 0 | 100-200 C. | 0.0 |
| SnI2_4H2O_S2 | SnI2_6H2O_S3 | 0.353 | 0.128 | −62 | −62 | 0 | <50 C. | 19.5 |
| NiBr3_S25 | NiBr3_1H2O_S3 | 0.363 | 0.091 | −76 | −76 | 0 | <50 C. | 34.6 |
| SnBr4_4H2O_S1 | SnBr4_5H2O_S2 | 0.356 | 0.115 | 144 | 144 | 0 | 100-200 C. | 0.1 |
| ZrCl3 | ZrCl3_1H2O_S2 | 0.344 | 0.144 | −61 | −61 | 0 | <50 C. | 46.2 |
| NbF3_1H2O_S2 | NbF3_2H2O_S2 | 0.352 | 0.121 | −119 | −119 | 0 | <50 C. | 38.2 |
| CuBr2_4H2O_S3 | CuBr2_7H2O_S1 | 0.337 | 0.150 | −153 | −153 | 0 | <50 C. | 42.9 |
| AlBr3_6H2O_S1 | AlBr3_8H2O_S2 | 0.332 | 0.153 | −58 | −58 | 0 | <50 C. | 26.0 |
| ZrF4_8H2O_S1 | ZrF4_9H2O_S1 | −0.329 | −0.156 | −625 | −625 | 0 | <50 C. | 31.8 |
| MoI4_8H2O_S1 | MoI4_9H2O_S1 | −0.340 | −0.116 | −883 | −883 | 0 | <50 C. | 44.0 |
| AlF3_9H2O_S2 | AlF3_10H2O_S2 | −0.305 | −0.189 | −616 | −616 | 0 | <50 C. | 29.5 |
| NbBr3_6H2O_S3 | NbBr3_8H2O_S2 | 0.329 | 0.135 | −52 | −52 | 0 | <50 C. | 16.0 |
| GeI2 | GeI2_1H2O_S2 | 0.343 | 0.086 | −69 | −69 | 0 | <50 C. | 39.3 |
| ScI3_8H2O_S2 | ScI3_9H2O_S2 | 0.321 | 0.144 | 305 | 305 | 0 | 300-450 C. | 7.3 |
| TiBr4_8H2O_S1 | TiBr4_9H2O_S1 | −0.323 | −0.136 | −765 | −765 | 0 | <50 C. | 38.4 |
| ZrI4_2H2O_S1 | ZrI4_3H2O_S1 | 0.337 | 0.093 | 141 | 141 | 0 | 100-200 C. | 2.2 |
| HfF4_3H2O_S2 | HfF4_4H2O_S1 | 0.330 | 0.109 | −29 | −29 | 0 | <50 C. | 13.7 |
| BeI2_7H2O_S1 | BeI2_8H2O_S1 | 0.314 | 0.146 | 135 | 135 | 0 | 100-200 C. | 2.3 |
| HfI4_2H2O_S1 | HfI4_3H2O_S1 | 0.334 | 0.081 | 136 | 136 | 0 | 100-200 C. | 3.4 |
| CrI3 | CrI3_1H2O_S3 | 0.329 | 0.079 | −29 | −29 | 0 | <50 C. | 35.7 |
| YI3_6H2O_S2 | YI3_7H2O_S2 | 0.317 | 0.113 | 189 | 189 | 0 | 100-200 C. | 0.0 |
| AlCl3_6H2O_S1 | AlCl3_8H2O_S2 | 0.285 | 0.176 | −106 | −106 | 0 | <50 C. | 33.3 |
| YBr3_8H2O_S2 | YBr3_9H2O_S2 | 0.296 | 0.154 | 245 | 245 | 0 | 200-300 C. | 4.3 |
| VF3_3H2O_S8 | VF3_4H2O_S2 | 0.301 | 0.141 | −99 | −99 | 0 | <50 C. | 24.3 |
| FeI3_2H2O_S1 | FeI3_3H2O_S7 | 0.315 | 0.103 | 72 | 72 | 0 | 50-100 C. | 0.0 |
| NbCl4_8H2O_S1 | NbCl4_9H2O_S1 | −0.295 | −0.148 | −674 | −674 | 0 | <50 C. | 34.1 |
| HfI3_8H2O_S1 | HfI3_9H2O_S2 | 0.309 | 0.115 | 297 | 297 | 0 | 200-300 C. | 11.9 |
| NbI3_6H2O_S3 | NbI3_8H2O_S2 | 0.310 | 0.111 | −38 | −38 | 0 | <50 C. | 9.3 |
| SnCl4 | SnCl4_1H2O_S1 | 0.301 | 0.120 | −44 | −44 | 0 | <50 C. | 48.8 |
| TaBr3_6H2O_S3 | TaBr3_8H2O_S2 | 0.303 | 0.105 | −70 | −70 | 0 | <50 C. | 17.1 |
| LaI3_8H2O_S2 | LaI3_9H2O_S3 | 0.299 | 0.111 | 247 | 247 | 0 | 200-300 C. | 5.7 |
| YBr3_6H2O_S2 | YBr3_7H2O_S2 | 0.290 | 0.119 | 96 | 96 | 0 | 50-100 C. | 4.2 |
| TiCl2_1H2O_S2 | TiCl2_2H2O_S8 | 0.284 | 0.133 | −132 | −132 | 0 | <50 C. | 44.1 |
| ScCl3_9H2O_S2 | ScCl3_10H2O_S2 | −0.267 | −0.161 | −638 | −638 | 0 | <50 C. | 30.5 |
| MoF4_8H2O_S1 | MoF4_9H2O_S1 | −0.282 | −0.128 | −567 | −567 | 0 | <50 C. | 29.0 |
| FeBr3_9H2O_S2 | FeBr3_10H2O_S2 | −0.280 | −0.132 | −703 | −703 | 0 | <50 C. | 33.4 |
| MoCl3_2H2O_S1 | MoCl3_3H2O_S9 | 0.281 | 0.124 | −56 | −56 | 0 | <50 C. | 21.7 |
| YI3_7H2O_S2 | YI3_8H2O_S2 | 0.287 | 0.108 | 181 | 181 | 0 | 100-200 C. | 0.0 |
| MoCl3_9H2O_S2 | MoCl3_10H2O_S1 | −0.265 | −0.145 | −652 | −652 | 0 | <50 C. | 31.1 |
| AlF3_3H2O_S9 | AlF3_4H2O_S2 | 0.268 | 0.138 | −126 | −126 | 0 | <50 C. | 26.6 |
| CsF1_2H2O_S1 | CsF1_3H2O_S1 | 0.281 | 0.103 | −127 | −127 | 0 | <50 C. | 24.0 |
| VI3_6H2O_S1 | VI3_8H2O_S2 | 0.281 | 0.104 | −69 | −69 | 0 | <50 C. | 19.9 |
| VCl3_9H2O_S2 | VCl3_10H2O_S2 | −0.252 | −0.153 | −627 | −627 | 0 | <50 C. | 30.0 |
| LaBr3_8H2O_S2 | LaBr3_9H2O_S2 | 0.264 | 0.131 | 213 | 213 | 0 | 200-300 C. | 6.5 |
| SnI4_3H2O_S1 | SnI4_4H2O_S1 | 0.282 | 0.076 | 93 | 93 | 0 | 50-100 C. | 0.4 |
| NbI3_8H2O_S2 | NbI3_9H2O_S2 | 0.269 | 0.113 | 221 | 221 | 0 | 200-300 C. | 9.3 |
| TiBr3_9H2O_S2 | TiBr3_10H2O_S2 | −0.265 | −0.123 | −666 | −666 | 0 | <50 C. | 31.7 |
| VBr3_6H2O_S1 | VBr3_8H2O_S2 | 0.268 | 0.115 | −101 | −101 | 0 | <50 C. | 27.8 |
| SiBr4_8H2O_S1 | SiBr4_9H2O_S1 | 0.266 | 0.115 | 129 | 129 | 0 | 100-200 C. | 0.0 |
| YCl3_6H2O_S2 | YCl3_7H2O_S2 | 0.255 | 0.134 | 22 | 22 | 0 | <50 C. | 9.0 |
| MnF3_3H2O_S8 | MnF3_4H2O_S2 | 0.260 | 0.125 | −116 | −116 | 0 | <50 C. | 23.0 |
| SnI4_4H2O_S1 | SnI4_5H2O_S2 | 0.276 | 0.076 | 101 | 101 | 0 | 100-200 C. | 0.4 |
| LaCl3_6H2O_S2 | LaCl3_7H2O_S1 | 0.261 | 0.117 | 23 | 23 | 0 | <50 C. | 4.0 |
| ZrI3_8H2O_S1 | ZrI3_9H2O_S2 | 0.261 | 0.113 | 217 | 217 | 0 | 200-300 C. | 5.4 |
| TaI3_6H2O_S3 | TaI3_8H2O_S2 | 0.271 | 0.085 | −68 | −68 | 0 | <50 C. | 12.4 |
| SiCl4_8H2O_S1 | SiCl4_9H2O_S1 | 0.240 | 0.150 | 68 | 68 | 0 | 50-100 C. | 0.0 |
| AlCl3_9H2O_S2 | AlCl3_10H2O_S2 | −0.237 | −0.153 | −602 | −602 | 0 | <50 C. | 28.9 |
| TaCl4_8H2O_S1 | TaCl4_9H2O_S1 | −0.260 | −0.107 | −627 | −627 | 0 | <50 C. | 31.9 |
| CuI2_4H2O_S2 | CuI2_6H2O_S3 | 0.263 | 0.093 | −138 | −138 | 0 | <50 C. | 26.6 |
| SnI4_5H2O_S2 | SnI4_9H2O_S1 | 0.263 | 0.091 | −150 | −150 | 0 | <50 C. | 37.2 |
| MnI3_S16 | MnI3_1H2O_S3 | 0.268 | 0.064 | −74 | −74 | 0 | <50 C. | 38.0 |
| CoBr3_S16 | CoBr3_1H2O_S3 | 0.265 | 0.066 | −129 | −129 | 0 | <50 C. | 47.3 |
| SiF4_8H2O_S1 | SiF4_9H2O_S1 | −0.236 | −0.135 | −518 | −518 | 0 | <50 C. | 26.7 |
| NbI4_8H2O_S1 | NbI4_10H2O_S1 | −0.256 | −0.087 | −504 | −504 | 0 | <50 C. | 47.7 |
| SnBr4_5H2O_S2 | SnBr4_9H2O_S1 | 0.253 | 0.095 | −175 | −175 | 0 | <50 C. | 42.0 |
| LaBr3_6H2O_S2 | LaBr3_7H2O_S1 | 0.245 | 0.088 | 30 | 30 | 0 | <50 C. | 3.8 |
| HfCl4_8H2O_S1 | HfCl4_10H2O_S1 | −0.239 | −0.097 | −440 | −440 | 0 | <50 C. | 42.1 |
| VCl3_6H2O_S1 | VCl3_8H2O_S2 | 0.222 | 0.126 | −143 | −143 | 0 | <50 C. | 34.8 |
| NiCl3_6H2O_S3 | NiCl3_7H2O_S1 | −0.215 | −0.116 | −504 | −504 | 0 | <50 C. | 34.0 |
| NiF3_3H2O_S9 | NiF3_4H2O_S2 | 0.223 | 0.093 | −153 | −153 | 0 | <50 C. | 30.9 |
| YI3_8H2O_S2 | YI3_9H2O_S3 | 0.225 | 0.086 | 100 | 100 | 0 | 50-100 C. | 0.0 |
| SrI2_6H2O_S1 | SrI2_7H2O_S1 | 0.221 | 0.088 | 9 | 9 | 0 | <50 C. | 9.5 |
| ZrF4_3H2O_S2 | ZrF4_4H2O_S1 | 0.215 | 0.098 | −112 | −112 | 0 | <50 C. | 19.5 |
| CrI4_3H2O_S2 | CrI4_4H2O_S1 | 0.226 | 0.063 | −2 | −2 | 0 | <50 C. | 11.6 |
| PbBr4_8H2O_S1 | PbBr4_9H2O_S1 | −0.218 | −0.079 | −647 | −647 | 0 | <50 C. | 32.8 |
| ScI3_6H2O_S1 | ScI3_7H2O_S2 | 0.214 | 0.079 | 25 | 25 | 0 | <50 C. | 8.8 |
| NbBr4_8H2O_S1 | NbBr4_9H2O_S1 | −0.212 | −0.081 | −590 | −590 | 0 | <50 C. | 30.1 |
| FeCl3_3H2O_S8 | FeCl3_4H2O_S1 | 0.201 | 0.101 | −111 | −111 | 0 | <50 C. | 19.4 |
| ZrCl4_8H2O_S1 | ZrCl4_10H2O_S1 | −0.200 | −0.100 | −414 | −414 | 0 | <50 C. | 39.8 |
| TaBr3_9H2O_S2 | TaBr3_10H2O_S2 | −0.203 | −0.075 | −580 | −580 | 0 | <50 C. | 27.9 |
| GeI2_4H2O_S3 | GeI2_7H2O_S1 | 0.198 | 0.077 | −194 | −194 | 0 | <50 C. | 48.6 |
| GeCl4_8H2O_S1 | GeCl4_9H2O_S1 | −0.184 | −0.101 | −534 | −534 | 0 | <50 C. | 27.4 |
| LaI3_6H2O_S2 | LaI3_7H2O_S2 | 0.192 | 0.067 | 22 | 22 | 0 | <50 C. | 7.2 |
| ScBr3_6H2O_S1 | ScBr3_7H2O_S2 | 0.185 | 0.079 | −51 | −51 | 0 | <50 C. | 14.7 |
| YF3_9H2O_S2 | YF3_10H2O_S2 | −0.178 | −0.091 | −477 | −477 | 0 | <50 C. | 23.3 |
| MnCl4_8H2O_S1 | MnCl4_9H2O_S1 | −0.166 | −0.096 | −508 | −508 | 0 | <50 C. | 26.2 |
| CrBr4_8H2O_S1 | CrBr4_9H2O_S1 | −0.176 | −0.076 | −550 | −550 | 0 | <50 C. | 28.2 |
| YI3_9H2O_S3 | YI3_10H2O_S2 | 0.172 | 0.068 | 31 | 31 | 0 | <50 C. | 0.7 |
| ZrI3_9H2O_S2 | ZrI3_10H2O_S1 | 0.172 | 0.067 | 25 | 25 | 0 | <50 C. | 1.0 |
| MnI3_6H2O_S3 | MnI3_7H2O_S1 | −0.172 | −0.065 | −522 | −522 | 0 | <50 C. | 34.4 |
| CrBr3_9H2O_S2 | CrBr3_10H2O_S2 | −0.165 | −0.077 | −523 | −523 | 0 | <50 C. | 25.3 |
| GaCl3_9H2O_S2 | GaCl3_10H2O_S2 | −0.157 | −0.090 | −493 | −493 | 0 | <50 C. | 24.0 |
| ScBr3_9H2O_S2 | ScBr3_10H2O_S2 | −0.159 | −0.075 | −511 | −511 | 0 | <50 C. | 24.8 |
| TaBr4_8H2O_S1 | TaBr4_9H2O_S1 | −0.166 | −0.055 | −521 | −521 | 0 | <50 C. | 26.8 |
| TaI4_8H2O_S1 | TaI4_10H2O_S1 | −0.166 | −0.051 | −424 | −424 | 0 | <50 C. | 40.7 |
| NiCl3_9H2O_S1 | NiCl3_10H2O_S2 | −0.150 | −0.086 | −477 | −477 | 0 | <50 C. | 23.3 |
| CoBr3_6H2O_S3 | CoBr3_7H2O_S1 | 0.158 | 0.065 | −85 | −85 | 0 | <50 C. | 9.5 |
| HfI4_8H2O_S1 | HfI4_10H2O_S1 | 0.164 | 0.048 | −129 | −129 | 0 | <50 C. | 15.2 |
| TiI3_6H2O_S1 | TiI3_7H2O_S2 | 0.158 | 0.057 | −56 | −56 | 0 | <50 C. | 12.7 |
| GeF4_8H2O_S1 | GeF4_9H2O_S1 | −0.148 | −0.076 | −435 | −435 | 0 | <50 C. | 22.8 |
| WI4_8H2O_S1 | WI4_9H2O_S1 | −0.157 | −0.049 | −561 | −561 | 0 | <50 C. | 28.7 |
| AlBr3_9H2O_S2 | AlBr3_10H2O_S2 | −0.146 | −0.072 | −493 | −493 | 0 | <50 C. | 24.0 |
| SiI2_8H2O_S1 | SiI2_9H2O_S1 | 0.143 | 0.066 | −71 | −71 | 0 | <50 C. | 6.0 |
| TiI3_9H2O_S2 | TiI3_10H2O_S2 | −0.146 | −0.059 | −519 | −519 | 0 | <50 C. | 25.2 |
| LaBr3_9H2O_S2 | LaBr3_10H2O_S2 | 0.145 | 0.062 | −35 | −35 | 0 | <50 C. | 3.7 |
| PbI4_S19 | PbI4_1H2O_S1 | 0.153 | 0.033 | −109 | −109 | 0 | <50 C. | 32.9 |
| TiI4_8H2O_S1 | TiI4_9H2O_S1 | −0.133 | −0.048 | −509 | −509 | 0 | <50 C. | 26.3 |
| BeI2_8H2O_S1 | BeI2_9H2O_S1 | 0.128 | 0.061 | −96 | −96 | 0 | <50 C. | 7.6 |
| SiCl2_8H2O_S1 | SiCl2_9H2O_S1 | 0.109 | 0.074 | −140 | −140 | 0 | <50 C. | 9.4 |
| VCl3_6H2O_S1 | VCl3_7H2O_S2 | −0.115 | −0.062 | −393 | −393 | 0 | <50 C. | 34.6 |
| TiBr3_6H2O_S3 | TiBr3_7H2O_S2 | 0.119 | 0.050 | −132 | −132 | 0 | <50 C. | 19.3 |
| LaI3_9H2O_S3 | LaI3_10H2O_S2 | 0.120 | 0.046 | −52 | −52 | 0 | <50 C. | 4.4 |
| YBr3_9H2O_S2 | YBr3_10H2O_S2 | 0.116 | 0.051 | −94 | −94 | 0 | <50 C. | 6.3 |
| ZrBr3_9H2O_S2 | ZrBr3_10H2O_S1 | 0.114 | 0.051 | −95 | −95 | 0 | <50 C. | 6.3 |
| HfI4_8H2O_S1 | HfI4_9H2O_S1 | 0.115 | 0.034 | −77 | −77 | 0 | <50 C. | 5.9 |
| AlCl3_6H2O_S1 | AlCl3_7H2O_S1 | −0.098 | −0.060 | −380 | −380 | 0 | <50 C. | 35.3 |
| AlBr3_6H2O_S1 | AlBr3_7H2O_S1 | −0.099 | −0.044 | −392 | −392 | 0 | <50 C. | 34.8 |
| ScF3_3H2O_S8 | ScF3_4H2O_S2 | 0.095 | 0.050 | −213 | −213 | 0 | <50 C. | 31.8 |
| ZrI4_8H2O_S1 | ZrI4_10H2O_S1 | 0.101 | 0.034 | −184 | −184 | 0 | <50 C. | 19.9 |
| VI3_6H2O_S1 | VI3_7H2O_S1 | 0.098 | 0.037 | −132 | −132 | 0 | <50 C. | 15.0 |
| LaF3_9H2O_S2 | LaF3_10H2O_S2 | −0.094 | −0.044 | −387 | −387 | 0 | <50 C. | 19.3 |
| ZrCl4_8H2O_S1 | ZrCl4_9H2O_S1 | −0.093 | −0.047 | −399 | −399 | 0 | <50 C. | 21.1 |
| NbI4_8H2O_S1 | NbI4_9H2O_S1 | −0.098 | −0.032 | −442 | −442 | 0 | <50 C. | 23.1 |
| LaCl3_9H2O_S2 | LaCl3_10H2O_S2 | 0.091 | 0.047 | −136 | −136 | 0 | <50 C. | 8.1 |
| NbCl3_9H2O_S2 | NbCl3_10H2O_S2 | −0.084 | −0.046 | −393 | −393 | 0 | <50 C. | 19.6 |
| NbI3_6H2O_S3 | NbI3_7H2O_S2 | 0.077 | 0.026 | −165 | −165 | 0 | <50 C. | 13.0 |
| NbI3_9H2O_S2 | NbI3_10H2O_S2 | 0.073 | 0.028 | −146 | −146 | 0 | <50 C. | 8.6 |
| NbBr3_6H2O_S3 | NbBr3_7H2O_S2 | 0.071 | 0.027 | −188 | −188 | 0 | <50 C. | 17.2 |
| FeI3_3H2O_S7 | FeI3_4H2O_S1 | 0.072 | 0.022 | −196 | −196 | 0 | <50 C. | 23.0 |
| SiBr2_8H2O_S1 | SiBr2_9H2O_S1 | 0.065 | 0.035 | −190 | −190 | 0 | <50 C. | 11.9 |
| HfBr4_8H2O_S1 | HfBr4_9H2O_S1 | −0.064 | −0.021 | −368 | −368 | 0 | <50 C. | 19.6 |
| MnI3_6H2O_S3 | MnI3_8H2O_S2 | 0.061 | 0.023 | −227 | −227 | 0 | <50 C. | 29.6 |
| TaCl3_9H2O_S2 | TaCl3_10H2O_S2 | −0.059 | −0.026 | −357 | −357 | 0 | <50 C. | 18.0 |
| VI3_9H2O_S2 | VI3_10H2O_S2 | −0.059 | −0.023 | −370 | −370 | 0 | <50 C. | 18.6 |
| ScI3_9H2O_S2 | ScI3_10H2O_S2 | −0.056 | −0.023 | −368 | −368 | 0 | <50 C. | 18.5 |
| MnCl3_6H2O_S3 | MnCl3_7H2O_S1 | −0.052 | −0.030 | −331 | −331 | 0 | <50 C. | 24.5 |
| MnBr3_6H2O_S3 | MnBr3_8H2O_S2 | 0.054 | 0.023 | −238 | −238 | 0 | <50 C. | 30.8 |
| ZrI4_8H2O_S1 | ZrI4_9H2O_S1 | 0.054 | 0.017 | −182 | −182 | 0 | <50 C. | 10.8 |
| CoCl3_6H2O_S3 | CoCl3_7H2O_S1 | 0.047 | 0.025 | −223 | −223 | 0 | <50 C. | 20.8 |
| CrI3_9H2O_S2 | CrI3_10H2O_S2 | 0.046 | 0.019 | −194 | −194 | 0 | <50 C. | 10.7 |
| HfI3_9H2O_S2 | HfI3_10H2O_S2 | 0.047 | 0.016 | −193 | −193 | 0 | <50 C. | 10.7 |
| ZrBr4_8H2O_S1 | ZrBr4_10H2O_S1 | −0.046 | −0.018 | −309 | −309 | 0 | <50 C. | 30.7 |
| HfCl3_9H2O_S2 | HfCl3_10H2O_S2 | −0.045 | −0.020 | −335 | −335 | 0 | <50 C. | 17.0 |
| MnF4_8H2O_S1 | MnF4_9H2O_S1 | 0.042 | 0.023 | −228 | −228 | 0 | <50 C. | 13.0 |
| GaBr3_9H2O_S2 | GaBr3_10H2O_S2 | −0.044 | −0.020 | −340 | −340 | 0 | <50 C. | 17.2 |
| AlI3_6H2O_S1 | AlI3_7H2O_S1 | 0.042 | 0.016 | −215 | −215 | 0 | <50 C. | 21.6 |
| ZrCl3_9H2O_S2 | ZrCl3_10H2O_S2 | 0.039 | 0.021 | −218 | −218 | 0 | <50 C. | 11.8 |
| VBr3_6H2O_S1 | VBr3_7H2O_S2 | −0.039 | −0.016 | −318 | −318 | 0 | <50 C. | 28.7 |
| NiBr3_6H2O_S3 | NiBr3_7H2O_S1 | −0.037 | −0.016 | −320 | −320 | 0 | <50 C. | 22.2 |
| TaI4_8H2O_S1 | TaI4_9H2O_S1 | −0.037 | −0.011 | −337 | −337 | 0 | <50 C. | 18.1 |
| TaI3_6H2O_S3 | TaI3_7H2O_S2 | 0.033 | 0.010 | −227 | −227 | 0 | <50 C. | 16.6 |
| AlI3_9H2O_S2 | AlI3_10H2O_S2 | 0.031 | 0.013 | −220 | −220 | 0 | <50 C. | 11.9 |
| YCl3_9H2O_S2 | YCl3_10H2O_S2 | 0.029 | 0.016 | −231 | −231 | 0 | <50 C. | 12.4 |
| NbBr3_9H2O_S2 | NbBr3_10H2O_S2 | 0.030 | 0.013 | −228 | −228 | 0 | <50 C. | 12.2 |
| HfBr4_8H2O_S1 | HfBr4_10H2O_S1 | −0.030 | −0.010 | −296 | −296 | 0 | <50 C. | 29.6 |
| TaBr3_6H2O_S3 | TaBr3_7H2O_S2 | 0.028 | 0.009 | −240 | −240 | 0 | <50 C. | 19.8 |
| HfBr3_9H2O_S2 | HfBr3_10H2O_S2 | −0.023 | −0.009 | −309 | −309 | 0 | <50 C. | 15.8 |
| GeI4_8H2O_S1 | GeI4_9H2O_S1 | −0.023 | −0.009 | −317 | −317 | 0 | <50 C. | 17.2 |
| MnBr3_6H2O_S3 | MnBr3_7H2O_S1 | −0.023 | −0.010 | −300 | −300 | 0 | <50 C. | 21.0 |
| ZrBr4_8H2O_S1 | ZrBr4_9H2O_S1 | 0.022 | 0.008 | −240 | −240 | 0 | <50 C. | 13.6 |
| MnCl3_6H2O_S3 | MnCl3_8H2O_S2 | 0.019 | 0.010 | −262 | −262 | 0 | <50 C. | 36.2 |
| CrI4_8H2O_S1 | CrI4_9H2O_S1 | 0.019 | 0.007 | −240 | −240 | 0 | <50 C. | 13.5 |
| MoI3_9H2O_S2 | MoI3_10H2O_S2 | 0.011 | 0.004 | −253 | −253 | 0 | <50 C. | 13.3 |
| NiBr3_6H2O_S3 | NiBr3_8H2O_S2 | 0.009 | 0.004 | −267 | −267 | 0 | <50 C. | 33.9 |
| CoBr3_9H2O_S2 | CoBr3_10H2O_S2 | 0.009 | 0.004 | −260 | −260 | 0 | <50 C. | 13.7 |
| HfCl4_8H2O_S1 | HfCl4_9H2O_S1 | 0.003 | 0.001 | −268 | −268 | 0 | <50 C. | 14.9 |
| FeF3_9H2O_S2 | FeF3_10H2O_S2 | −0.001 | −0.001 | −275 | −275 | 0 | <50 C. | 14.3 |

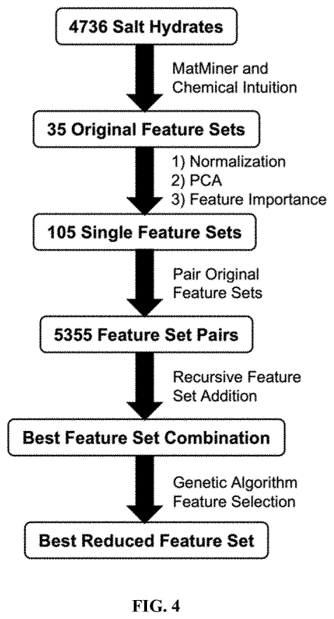

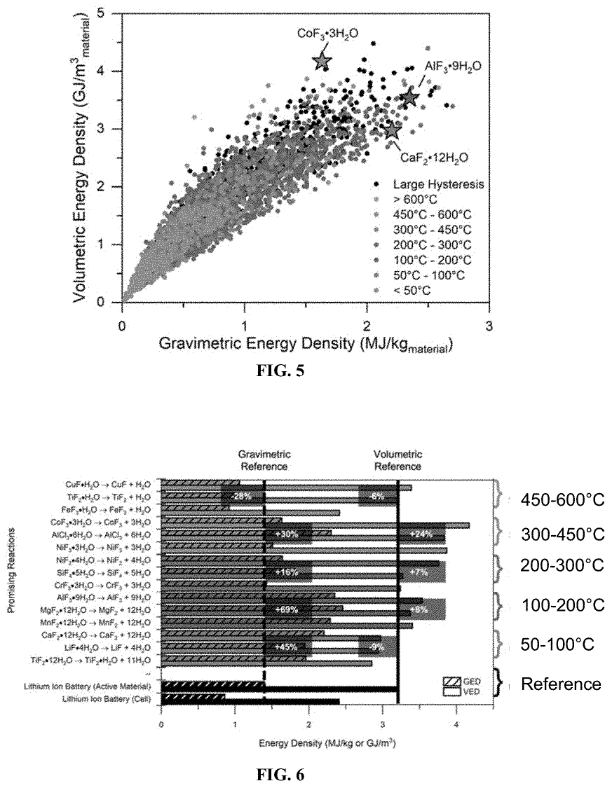

FIG. 5 shows the screening results of 3,656 salt (de)hydration reactions characterized by VED, GED, and operating temperature category. The range of energy densities for HC reactions is consistent with those seen in experimentally known salt hydrates. However, given both the large number of reactions screened as well as the higher values of n possible in the HC generated described in accordance with certain aspects of the present disclosure, a significant number of the screened HC reactions fall on the higher end of the energy density spectrum.

From the 3,656 HC reactions screened, 15 reactions are particularly suitable variations in accordance with certain aspects of the present disclosure on the basis of cost, stability, temperature hysteresis, and energy density, as shown in FIG. 6. Of these 15 promising HC reactions, 3 involve experimentally known hydrates that have been previously characterized (AlCl₃.6H₂O, CrF₃.3H₂O, AlF₃.9H₂O), while the other 12 appear to be new compounds. This overlap with known salt hydrates is due to the fact that the systematic scheme used to generate HC includes the generation of experimentally known salt hydrates in their known crystal structures. Table 9 shows the details of salt (de)hydration reactions of interest.

TABLE 9

| | Predicted | | | | | | | |
|---|---|---|---|---|---|---|---|---|
| | Structure of | | | | | Predicted | Hydrates | |
| Hydrated | Hydrated | T_{Low} | T_{High} | GED | VED | Stable | Within 10 | Hydrates |
| Compound | Compound | (° C.) | (° C.) | (MJ/kg) | (GJ/m³) | Hydrates | meV/atom | in ICSD |
| CaF₂•12H₂O | MgCl₂•12H₂O | 97 | 97 | 2.20 | 2.97 | n = 12 | n = 2, 4 | — |
| LiF•4H₂O | KF•4H₂O | 54 | 54 | 1.95 | 2.94 | n = 4 | — | — |
| TiF₂•12H₂O | MgCl₂•12H₂O | 95 | 95 | 1.96 | 2.85 | n = 1, 12 | — | — |
| AlF₃•9H₂O | CrF₃•9H₂O | 156 | 190 | 2.35 | 3.54 | n = 3, 9 | n = 2 | n = 1, 3, 6, 9 |
| MgF₂•12H₂O | MgCl₂•12H₂O | 116 | 121 | 2.46 | 3.38 | n = 4, 12 | — | — |
| MnF₂•12H₂O | MgCl₂•12H₂O | 117 | 159 | 2.29 | 3.40 | n = 4, 12 | — | — |
| NiF₂•4H₂O | FeCl₂•4H₂O | 185 | 217 | 1.64 | 3.76 | n = 2, 4, 12 | — | — |
| SiF₄•5H₂O | SnCl₄•5H₂O | 210 | 214 | 1.82 | 3.27 | n = 2, 5, 8 | n = 3, 4 | — |
| CrF₃•3H₂O | MnF₃•3H₂O | 257 | 257 | 1.42 | 3.24 | n = 3, 9 | — | n = 3, 5, 9 |
| CoF₃•3H₂O | MnF₃•3H₂O | 361 | 361 | 1.63 | 4.17 | n = 3, 9 | n = 2 | — |
| AlCl₃•6H₂O | AlCl₃•6H₂O | 353 | 401 | 2.30 | 3.83 | n = 1, 6, 9 | n = 3 | n = 6, 15 |
| NiF₃•3H₂O | MnF₃•3H₂O | 280 | 328 | 1.51 | 3.87 | n = 2, 3, 9 | n = 6 | — |
| CuF•H₂O | RbF•H₂O | 458 | 458 | 1.06 | 3.39 | n = 1, 2 | n = 3 | — |
| TiF₂•H₂O | CdCl₂•H₂O | 466 | 466 | 1.04 | 3.21 | n = 1, 12 | — | — |
| FeF₃•H₂O | BF₃•H₂O | 551 | 551 | 0.92 | 2.41 | n = 1, 9 | n = 3, 6 | n = 1/3, 3 |

Table 9 Reactions of Interest in a temperature range of greater than or equal to about 50° C. to less than or equal to about 100° C. Specific details of the promising reactions involving CaF₂.12H₂O, LiF.4H₂O, and TiF₂.12H₂O can be found in Table 9. Both CaF₂.12H₂O and TiF₂.12H₂O possess the crystal structure of MgCl₂.12H₂O, while LiF.4H₂O possesses the crystal structure of KF.4H₂O. While CaF₂.12H₂O and LiF.4H₂O both dehydrate to their respective anhydrous salts, TiF₂.12H₂O dehydrates to TiF₂.H₂O. The ICSD does not contain any hydrates for the salt families of CaF₂, LiF, and TiF₂. The DFT calculations predict that the dodecahydrate is the only stable hydrate of CaF₂, although the dihydrate and tetrahydrate are within 10 meV/atom of the convex hull. Since these hydrates are so close to the convex hull, it is quite possible that they could form during (de)hydration, thus incurring a temperature hysteresis from the multiple reaction steps. However, if these intermediates do not form, CaF₂.12H₂O will dehydrate to CaF₂ in a single reaction step with a T_{Turn} of 97° C., a GED of 2.20 MJ/kg, and a VED of 2.97 GJ/m³. For LiF, only the tetrahydrate is predicted to be stable, with no other hydrates within 10 meV/atom of the convex hull. The (de)hydration reaction proceeds in a single step at 54° C. and has a GED of 1.95 MJ/kg and a VED of 2.94 GJ/m³. For TiF₂, only the monohydrate and dodecahydrate are predicted to be stable while no other hydrates of TiF₂ are within 10 meV/atom of the convex hull. The reaction possesses a T_{Turn} of 95° C., a GED of 1.96 MJ/kg and a VED of 2.85 GJ/m³. These promising reactions were compared against experimentally known salt hydrates characterized in two large screenings of salt hydration reactions for TES using tabulated thermodynamic data, as well as one using density functional theory calculations. Note that only salt hydration reactions were considered. Only four salt hydrates in this turning temperature range that possess both higher GED and VED than these three reactions of interest were identified in the experimental studies.

Reactions of Interest in a temperature range of greater than or equal to about 100° C. to less than or equal to about 200° C. Three promising reactions of interest involving AlF₃.9H₂O, MgF₂.12H₂O, and MnF₂.12H₂O are found in Table 9. Each reaction is described by the predicted crystal structure of the HC, the operating temperature window for the reaction, the energy densities, the hydrates in the salt family that are predicted to be either stable or within 10 meV/atom of the convex hull, as well as which hydrates, if any, are found experimentally in the ICSD. Note that the temperature window is calculated assuming only the stable hydrates form as intermediates. If the hydrates close to the convex hull also form as intermediates, the operating temperature window will widen. AlF₃.9H₂O is experimentally known, and its dehydration reaction has been previously characterized by DFT. However, it is found this reaction has higher energy densities than previously reported. The previous study had performed DFT on AlF₃.9H₂O using a crystal structure extracted from the ICSD. However, here AlF₃.9H₂O is found to have a lower energy by 28 meV/atom when in the crystal structure of CrF₃.9H₂O, resulting in a larger ΔH and therefore higher energy densities. Both crystal structures are in the “R −3 H” space group. However, the crystal structure of CrF₃.9H₂O comprises cations 6-coordinated by water molecules, whereas the crystal structure of AlF₃.9H₂O from the ICSD comprises cations 6-coordinated by 3 water molecules and 3 anions. All three promising reactions of interest for this temperature category possess either a higher GED or VED than every salt (de)hydration reaction between 100° C. and 200° C. found in the three screening studies used for comparison, with the exception of the dehydration of NaOH.7H₂O to NaOH. However, this reaction is regarded as unpromising for most applications, as it has a temperature hysteresis of 103° C. In certain aspects, where a target temperature range is greater than or equal to about 100° C. to less than or equal to about 200° C., the salt hydrate comprises one or more of MgF₂.12H₂O, and MnF₂.12H₂O.

Reactions of Interest in a temperature range of greater than or equal to about 200° C. to less than or equal to about 300° C. Reactions of interest include NiF₂.4H₂O, SiF₄.5H₂O, and CrF₃.3H₂O, and are found in Table 9. All three experimentally known CrF3 hydrates were previously characterized for TES via DFT and the dehydration of CrF₃.9H₂O was identified as a promising reaction for medium temperature TES. However, certain aspects of the present disclosure found that CrF₃.3H₂O has a lower energy by 23 meV/atom when it crystalizes in the structure of MnF₃.3H₂O rather than in the structure of CrF₃.3H₂O found in the ICSD. Both crystal structures comprise two distinct, 6-coordinated cation clusters: one cluster that's coordinated by 2 water molecules and 4 anions and the other cluster that's coordinated by 4 water molecules and 2 anions. However, CrF₃.3H₂O is in the space group of “R −3 m R”, while MnF₃.3H₂O is in the space group of “P 1 21/c 1”. As a result, the dehydration of CrF₃.9H₂O, which previously was predicted to have no temperature hysteresis, is predicted in the present disclosure to have a temperature hysteresis of 80° C. due to the newfound stability of CrF₃.3H₂O. However, the dehydration of CrF₃.3H₂O is still of interest. Regarding the comparison to other hydrate screenings, one salt (de)hydration reaction in this temperature range was found to possess both a higher GED and VED than NiF₂.4H₂O and SiF₄.5H₂O, while two were found that surpass CrF₃.3H₂O. In certain aspects, where a target temperature range is greater than or equal to about 200° C. to less than or equal to about 300° C., the salt hydrate comprises SiF₄.5H₂O.

Reactions of Interest in a temperature range of greater than or equal to about 300° C. to less than or equal to about 450° C. Reactions of interest include CoF₃.3H₂O, AlCl₃.6H₂O, and NiF₃.3H₂O, and are described in Table 9. AlCl₃.6H₂O is an experimentally known salt hydrate and a promising material for TES. With respect to other salt hydrates in the literature, AlCl₃.6H₂O possesses a higher GED or VED than every salt (de)hydration reaction between 300° C. and 450° C. found in the three screening studies used for comparison. The only reaction found in this temperature range that outperforms CoF₃.3H₂O and NiF₃.3H₂O in both GED and VED is the dehydration of MgBr₂.4H₂O to MgBr₂.H₂O, although this has a large temperature hysteresis of 203° C. In certain aspects, where a target temperature range is greater than or equal to about 300° C. to less than or equal to about 450° C., the salt hydrate comprises one or more of CoF₃.3H₂O and NiF₃.3H₂O.

Reactions of Interest in a temperature range of greater than or equal to about 450° C. to less than or equal to about 600° C. Promising reactions involving CuF.H₂O, TiF₂.H₂O, and FeF₃.H₂O are described in Table 9. When compared with other salt (de)hydration reactions in the experimental studies, one reaction was found to surpass these three reactions in both GED and VED, while another reaction was to surpass only FeF₃.H₂O in both GED and VED. In certain aspects, where a target temperature range is greater than or equal to about 450° C. to less than or equal to about 600° C., the salt hydrate comprises one or more of CuF.H₂O, TiF₂.H₂O, and FeF₃.H₂O.

System Analysis. The impact that the high-capacity HC investigated here would have on the performance of a TES system has been quantified. System-level energy densities were estimated for the TES prototype system developed by the MERITS project (More Effective use of Renewables Including compact seasonal Thermal energy Storage). The MERITS system is a closed, modular system that stores solar energy for use in domestic heating applications. The hydrate Na₂S.5H₂O was adopted in the MERITS project as the storage medium. Na₂S.5H₂O operates within a temperature range of 65-80° C., which is sufficient for building applications (that would typically operate below 100° C.). The system's power output was rated to 600-700 W and the optimized system energy density was projected to be ˜0.8 GJ/m³_{system}.

De-Jong et al., “Thermochemical Heat Storage—From Reaction Storage Density to System Storage Density,” Energy Procedia, 91, pp. 128-137 (2016) developed a numerical model that can predict the MERITS system energy density as a function of the energy density of the storage material and the system geometry. The model accounts for losses arising from heat transfer to/from the ambient and for-the mass and volume of the hydrate/salt, heat exchanger, evaporator/condenser, insulation, and reactor materials used within each module. (Details regarding the masses for the heat exchanger and evaporator/condenser are not provided in the MERITS model description; hence, for the present analyses, these data were extracted from commercial technologies that are consistent with the module dimensions.)

MERITS System Analysis is conducted as follows. De-Jong et al., “Thermochemical Heat Storage—From Reaction Storage Density to System Storage Density,” Energy Procedia, 91, pp. 128-137 (2016) outlines a numerical model to predict the system volumetric energy density of Na₂S.5H₂O for an optimized system design based on the MERITS prototype. This model is used in addition to added constraints to expand predictions for system volumetric and gravimetric energy densities of the HC. The system analysis with system components is presented below (Table 10).

TABLE 10

| Component | Value | | Source |
|---|---|---|---|
| Active Modules | 7 | | Cuypers et al.¹ |
| Module Volume | 0.60 | m³ | Cuypers et al.¹ |
| Volume Active Material/Module | 0.27 | m³ | De Jong et al.², |
| | | | Added Constraint |
| Volume Stainless Steel/Module | 0.11 | m³ | Added Constraint |
| Mass Stainless Steel/Module | 200 | kg | Added Constraint |
| Mass Heat Exchanger/Module | 16 | kg | Added Constraint |
| Mass (Evaporator/Condenser)/ | 20 | kg | Added Constraint |
| Module | | | |

¹De Jong, A. -J., et al. “Thermochemical Heat Storage - From Reaction Storage Density to System Storage Density,” Energy Procedia, 91, pp. 128-137 (2016).
²Cuypers, R. et al. “A Novel Heat Battery to Save Energy & Reduce CO₂ Production,” In International Solar Energy Society; Palma de Mallorca, Spain; pp. 1-7 (2016).

An optimized module component configuration is shown in Table 11.

TABLE 11

| Component | Volume Fraction of Module |
|---|---|
| Reactor | 0.67 |
| Evaporator/Condenser | 0.28 |
| Insulation | 0.05 |

The optimized system model calls for the reactor to take up two-thirds of the entire module. However, the reactor is composed of both active material and the heat exchanger, so the volume fraction of active material will in practice be less than two-thirds of the module's volume. In addition, the mass/volume of stainless steel is based on a set of assumptions about the surface area of the modular prototypes adopted in the MERITS project. These assumptions will be discussed in the related sections below.

Related quantities for energy density calculations are based on the De Jong et al. reference, Cuypers, R. et al. reference, and Sole, A., et al., “Corrosion of Metals and Salt Hydrates Used for Thermochemical Energy Storage,” Renew. Energy, 75, pp. 519-523 (2015).

TABLE 12

| Symbol | Parameter | Units | Value | |
|---|---|---|---|---|
| VED_{system} | Volumetric energy density of system | GJ/m³ | Material dependent | |
| GED_{system} | Gravimetric energy density of system | MJ/kg | Material dependent | |
| Qₛ | Total theoretical available sorption heat | GJ | Material dependent | |
| Q₀ | Actual stored heat | GJ | Material dependent | |
| η | Heat loss fraction | — | Material dependent | |
| A_{surf} | Estimated surface area | m² | 3.93 | m² |
| r | Estimated module radius | m | 0.3352 | m |
| h | Estimated module height | m | 1.7 | m |
| λ | Insulation thermal conductivity | W/m-K | 0.04 | W/m-K |
| T_{S} | Sorption temperature | ° C. | Material dependent | |
| T_{A} | Ambient temperature | ° C. | 25° | C. |
| b | Insulation thickness | m | 0.02 | m |
| Pₒ | Power output | W | 700 | W |
| V_{mod} | Volume of individual module | m³ | 0.6 | m³ |
| V_{water} | Volume of water | m³ | Material dependent | |
| Vₛₐₗₜ | Volume of salt | m³ | 0.27 | m³ |
| Vₜₒₜₐₗ | Total volume | m³ | Material dependent | |
| N_{mod} | Number of modules | — | 7 | |
| Mₜₒₜₐₗ | Total mass | kg | Material dependent | |
| Mₛₐₗₜ | Mass of salt | kg | Material dependent | |
| M_{EC} | Mass of evaporator/condenser per module | kg | 20 | kg |
| M_{HX} | Mass of heat exchanger per module | kg | 16 | kg |
| M_{SS} | Mass of stainless steel per module | kg | 200 | kg |
| Mᵢₙₛᵤₗ | Mass of insulation per module | kg | 3.54 | kg |

| | | | |
|---|---|---|---|
| V_{hyd} | Molar volume of salt hydrate | cm³/mol | Material dependent |
| | | salt | |
| n | Moles of water transferred per mole of salt | moles | Material dependent |
| ΔH | Enthalpy of dehydration | kJ/kg | Material dependent |

The following set of equations are presented in order to solve for the system volumetric and gravimetric energy densities of the optimized MERITS system. They are a combination of equations outlined in De Jong et al. and added equations that take into account additional information to solve for the system gravimetric energy density. The surface area, module height, and module radius are estimated from pictures given due to the lack of information given in literature. However, changing the module height and module radius given the volume of the module does not significantly impact the value for either system gravimetric or volumetric energy densities. The equations outlined in De Jong et al. were slightly modified to fit the actual module prototypes tested in Cuypers et al. An optimization for the insulation thickness was also outlined in De Jong et al., which helps determine the thickness of insulation within a given range that gives the highest energy densities for each material. The power of the system was 600-700 W in the experimental results from Cuypers et al. and the high end of this range, 700 W, is used for this system model.

Improving the energy density in the model also includes optimizing the packing of the material with the heat exchanger in the reactor. The volume fraction of specific components is shown in Table 8. Ideally for this specific system, the reactor takes up two-thirds of the entire module volume. Within the reactor, it is assumed that the heat exchanger would take up about one-third of the volume (or 22% of the total module volume) while the rest of the reactor volume (45% of the total module volume) could be used for active heat storage material. Based on these assumptions and the equations listed below, the system volumetric and gravimetric energy density is found for all materials solely based on the system geometry and the thermodynamics for each specific material. There is good agreement between the optimized system volumetric energy density presented in De Jong et al. and the results presented here.

$${Q}_{S} = \frac{{V}_{salt} n Δ H}{{V}_{hyd}} \\ {Q}_{0} = \frac{{Q}_{S}}{1 + η} \\ η = \frac{{A}_{surf} λ ( {T}_{S} - {T}_{A} )}{{bP}_{o}} \\ {V}_{total} = {N}_{mod} ( {V}_{mod} + {V}_{water} )$$

$${M}_{total} = {N}_{mod} ( {M}_{salt} + {M}_{EC} + {M}_{SS} + {M}_{insul} )$$

$${VED}_{system} = \frac{{Q}_{0}}{{V}_{total}}$$

$${GED}_{system} = \frac{{Q}_{0}}{{M}_{total}}$$

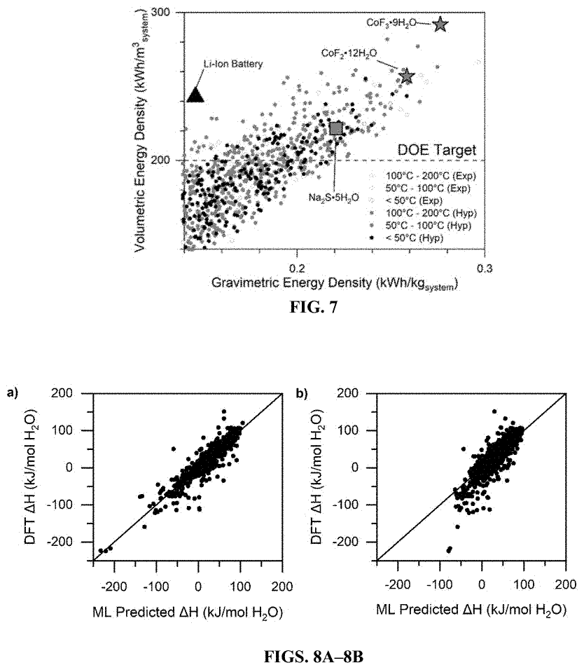

FIG. 7 shows the predicted energy densities for the MERITS prototype wherein the HC examined replace Na₂S.5H₂O. A U.S. Department of Energy target is shown at 200 kWh/m³ for various gravimetric densities. The figure includes HC having reaction temperatures below 100° C., which is relevant for domestic heating, but also projects the performance for HC that operate at slightly higher temperatures of 100-200° C. These latter materials are believed to be useful for TES applications involving power electronics, etc., that operate in this temperature range. The operating temperatures of the HC were re-evaluated using Equation 5, assuming that the (de)hydration reaction occurs at water vapor pressures consistent with the operation of the evaporator (12 mbar) and condenser (23 mbar).

The data in FIG. 7 demonstrate that several HC are predicted to out-perform the baseline Na₂S.5H₂O material used in the MERITS project. For example, at low temperatures (44-85° C.), CoF₂.12H₂O is predicted to yield a TES system whose GED (0.93 MJ/kg) is 17% greater than the analogous Na₂S.5H₂O system. Similarly, on a volumetric basis, the CoF₂.12H₂O-based system exhibits a 16% improvement, with an energy density of 0.92 GJ/m³. Further improvements in the quantity of stored thermal energy can be achieved at higher temperatures (114-215° C.) by adopting CoF₃.9H₂O as the storage material. This material is predicted to achieve system-level energy densities of 0.99 MJ/kg and 1.05 GJ/m³ (+25% and +32%, respectively versus the Na₂S.5H₂O-based system).

Finally, FIG. 7 also compares the energy densities of TES systems based on HC to that of a lithium ion battery packs (0.525 MJ/kg and 0.875 GJ/m³) from Albertus et al., “Status and Challenges in Enabling the Lithium Metal Electrode for High Energy and Low-Cost Rechargeable Batteries,” Nat. Energy, 3, pp. 16-21 (2018). The salt hydrates demonstrate comparable volumetric energy densities (+5% and +20% for CoF₂.12H₂O and CoF₃.9H₂O, respectively), but significantly higher gravimetric energy densities (+77% and +89% for CoF₂.12H₂O and CoF₃.9H₂O, respectively).

Predictive Machine Learning. The multi-step ML screening effectively increased the accuracy of the models. In every case, combining feature sets led to a reduction in test error. The GA feature selection also yielded a reduction in test error except in the case of the RF model. At every stage, the SVM model was either the most accurate model or tied for the most accurate model. Finally, it is noted that an increase in the amount of training data (from 50% to 90%) increased the accuracy of the model.

Table 13 shows the test error when the final model is evaluated via repeated 10-fold cross validation (i.e., 10% test set). The test errors range from 4.4 kJ/mol H₂O for SVM to 6.1 kJ/mol H₂O for Ridge. To put these in context, the uncertainty of ΔH for salt hydrates between DFT and experiments was estimated to be 10.0 kJ/mol H₂O, while the uncertainty among experiments was estimated to be 7.5 kJ/mol H₂O. A scatterplot demonstrating the accuracy of the top-performing SVM model is shown in FIG. 8A. Each model used several feature sets. The SVM model was trained on a subset of features from the principal components of MEGNet feature set, the categorical salt hydrate representation, and the packing efficiency. The RF model was trained on a subset of features from Pymatgen's elemental properties, orbital field properties, the Gaussian symmetry function, the salt hydrate categorical features, and the chemically intuited salt hydrate feature set. The k-NN model was trained on a subset of features from the orbital field, the chemically intuited salt hydrate features, the stoichiometry, and the structure heterogeneity. The Ridge model was trained on a subset of features from Matscholar's elemental properties, the orbital field, the principal components of the bond fraction, and the salt hydrate categorical features.

TABLE 13

| | | Interpretable |
|---|---|---|
| | Predictive Model | Model |
| ML | Test MAE | Test MAE |
| Algorithm | (kJ/mol H₂O) | (kJ/mol H₂O) |
| Support Vector Machine | 4.4 | 6.2 |
| Random Forest | 5.7 | 6.7 |
| K-Nearest Neighbors | 5.9 | 6.3 |
| Ridge Regression | 6.1 | 9.7 |

Table 14 shows the test errors after various steps in the ML screening process for the four algorithms investigated. As shown in Table 14, the test error decreases monotonically for each algorithm as one proceeds through the three screening steps, indicating that both the feature set combination (from step 1 to step 2) and the genetic algorithm feature selection (from step 2 to step 3) are effective at creating more accurate ML models. Also, the reduction of error between step 3 (best model trained on 50% of the data) and the final model (same model trained on 90% of the data) demonstrates the improvement of accuracy that results from training on more data. Finally, it should be noted that at every point, the SVM model performs the best while the RF model performs second best.

Table 14 shows mean absolute error (in kJ/mol H₂O) of the test set for the best model after each step in the screening process. Step 1 refers to the single best ML model after the three best representations have been found for the original 35 feature sets. Step 2 refers to the single best ML model after feature set pairing and subsequent feature set addition. Step 3 refers to the best ML model after the genetic algorithm feature selection, representing the test error of the final model when 50% of the data is in the test set. The final error refers to the test error of the final model when 10% of the data is in the test set.

TABLE 14

| | Step 1 | Step 2 | Step 3 | Final |
|---|---|---|---|---|
| RF | 7.5 | 6.7 | 6.5 | 5.7 |
| k-NN | 8.5 | 7.6 | 6.8 | 5.9 |
| Ridge | 10.3 | 6.9 | 6.5 | 6.1 |
| SVM | 7.4 | 6.0 | 5.5 | 4.4 |

Table 15 lists all 35 original feature sets used in ML screening. The first two feature sets are designed in accordance with certain principles of the present disclosure, while the others were implemented from Matminer (Ward, L., et al., “Matminer: An Open Source Toolkit for Materials Data Mining,” Comput. Mater. Sci., 152, pp. 60-69 (2018)) and are listed by their class names. Note that for the site featurizers, the mean, standard deviation, minimum, maximum, average deviation, range, and mode were used as features. Feature sets that are used in the predictive model are indicated by an X, while feature sets used in the interpretable model are indicated by an

TABLE 15

| Feature Set | SVM | RF | k-NN | Ridge |
|---|---|---|---|---|
| Salt Hydrate Ionic and Structural Features | | X* | X* | |
| Salt Hydrate Categorical Representation | X* | X | | X |
| composition.ElementProperty (matminer) | | X | | |
| composition.ElementProperty | | | | X* |
| (matscholar_el) | | | | |
| composition.ElementProperty (megnet_el) | X | | | |
| composition.Stoichiometry | | | X | |
| site.GaussianSymmFunc | | X | | |
| structure.BondFractions | | | | X |
| structure.MaximumPackingEfficiency | X | | | |
| structure.OrbitalFieldMatrix | | X | X | X |
| structure.StructuralHeterogeneity | | | X | |
| composition.AtomicOrbitals | | | | |
| composition.BandCenter | | | | |
| composition.ElementFraction | | | | |
| composition.ElementProperty (magpie) | | | | |
| composition.IonProperty | | | | |
| composition.Meredig | | | | |
| composition.OxidationStates | | | | |
| composition.TMetalFraction | | | | |
| composition.ValenceOrbital | | | | |
| composition.YangSolidSolution | | | | |
| site.CoordinationNumber | | | | |
| site.ElementalProperty | | | | |
| site.LocalPropertyDifference | | | | |
| site.VoronoiFingerprint | | | | |
| structure.ChemicalOrdering | | | | |
| structure.CoulombMatrix | | | | |
| structure.DensityFeatures | | | | |
| structure.Dimensionality | | | | |
| structure.EwaldEnergy | | | | |
| structure.GlobalSymmetryFeatures | | | | |
| structure.JarvisCFID | | | | |
| structure.SineCoulombMatrix | | | | |
| structure.StructuralComplexity | | | | |
| structure.XRDPowderPattern | | | | |

Interpretable Machine Learning. A general rule of thumb in machine learning is that while simpler models might be less accurate, they tend to be more interpretable. The final models from the predictive ML screening were fairly complex as they were trained on a large number of features, ranging from 69 for k-NN to 752 for Ridge. While these models make accurate predictions, it is difficult to identify strong property-performance relations since so many features are involved. In order to create simple models, the same process for screening ML models was applied, but the feature set combination step was omitted. Essentially, GA feature selection was performed on the best feature representation for a single feature set. In this way, the best model for each ML algorithm could be found for a single set of related features.

Table 13 also shows the performance of these interpretable models. The SVM model demonstrated the highest test accuracy, with the k-NN and RF models close behind. The SVM model was trained on the salt hydrate categorical feature representation, while the k-NN and RF models were trained on the chemically intuited salt hydrate features. This gives evidence to the notion that chemical intuition is crucial for feature set design in materials science ML. The best Ridge model was trained on the Matscholar elemental property feature set, although this showed significantly higher test error. Between the SVM, RF, and k-NN models, two simple design perspectives are presented, one that is based on the chemically intuited salt hydrate features (corresponding to the RF and k-NN models), and the other that is based on the categorical feature representation of the salt hydrates (corresponding to the SVM model).

k-NN and RF Models. Both the k-NN and RF interpretable models were examined through the use of partial dependence plots (PDPs), which show how the expected value of ΔH predicted by the model varies as a function of a given feature. Thus, these plots help to isolate trends in multivariate data that aren't readily apparent. Although the structures of these models are inherently different due to the differences between the k-NN and RF algorithms, the two models demonstrated agreement in the trends of six features. While one should exercise caution when learning trends from the model as opposed to the actual data, the agreement among the six trends leads to a higher confidence in the reality of these property-performance relations.

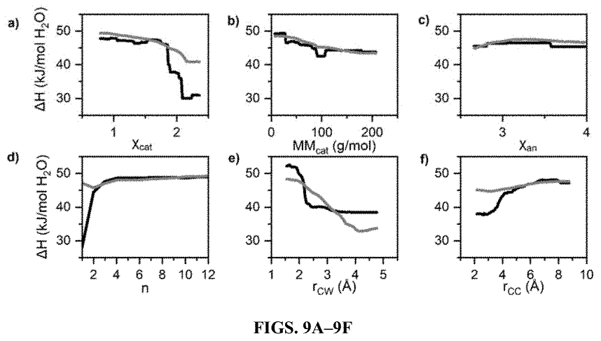

Cation Electronegativity. FIG. 9A show the PDP for the cation electronegativity. Both RF and k-NN produced models that demonstrate a significant drop in the expected value of ΔH for HC containing very electronegative cations, though this is less pronounced in the k-NN model. This trend suggests that cations with higher electronegativities don't bond with water molecules as strongly, resulting in a lower ΔH.

Cation Molar Mass. FIG. 9B shows the PDP for the cation molar mass. For both the RF and k-NN models, ΔH generally decreases for heavier cations. It seems that the lighter elements tend to bond more strongly with the coordinating water molecules, resulting in a higher ΔH.

Anion Electronegativity. FIG. 9C shows the PDP for the anion electronegativity. Although the difference is slight, both the RF and k-NN models indicate that the anions with moderate electronegativities (i.e., Cl¹⁻ and Br¹⁻) tend to have slightly higher ΔH.

Hydrate number. FIG. 9D shows the PDP for the hydrate number. The RF and k-NN models disagree on whether or not monohydrates have low ΔH, but agree that ΔH is lower for dihydrates and roughly constant for all hydrates with a hydrate number of at least three. It should be noted that Glasser, L., et al., “Systematic Thermodynamics of Hydration (and of Solvation) of Inorganic Solids,” Inorg. Chem., 48, 1661-1665 (2009) found the opposite trend: ΔH tends to decrease with increasing hydrate number. This, however, does not prove to be a contradiction as they surveyed experimentally known salt hydrates. As evidenced from equations 7 and 8, any given salt hydrate will lie above the convex hull if there exists a hydrate with both a greater hydrate number as well as a greater ΔH, since the latter hydrate forms a line with the anhydrous salt that passes below the former hydrate. For hydrates with lower hydrate number, there is a greater probability that a higher hydrate with a greater ΔH exists because there are more higher hydrates possible when the hydrate number is low. Consequently, lower hydrates generally need high values of ΔH in order to be stable. Given the sampling bias that results from thermodynamic stability, experimentally known salt hydrates will show a decreasing trend with hydrate number, while this trend need not hold for HC.

Cation-Water Distance. FIG. 9E shows the PDP for the cation-water distance. In general, a HC with a larger distance between the cation and coordinating water molecules tends to have a smaller ΔH. The shared electrons in the coordinate-covalent bonds are held less tightly by the cation's nucleus as a result of the further distance. This results in a lower bonding energy, and hence a lower ΔH.

Distance between Cations in Hydrate. FIG. 9F shows the PDP for the distance between nearest neighbor cations in the salt hydrate. Generally, this distance may be the distance between any given cation and the closest cation to it (whether or not it is the same elemental species). In both cases, ΔH generally increases as the cation-cation distance in the HC increases. This may be related to the ordering of water-coordinated cation clusters within the salt hydrate, indicating that more energetically favorable structures have greater distances between cation clusters.

SVM Model. The SVM interpretable model showed the highest predictive accuracy and was simply trained on a one hot encoding of the cation, anion, and crystal structure template used to generate the HC. The reason for the model's high predictive accuracy is the polynomial kernel. This kernel, when applied to a one hot encoding of cation, anion, and structure categories, will implicitly produce features corresponding to the categories for the cation-anion pair, the cation-structure pair, and the anion-structure pair. This leads to another design perspective. Without knowing anything about the chemistry of the composition or features of the crystal structure, one can still estimate ΔH simply by looking at other salt hydrates that share the same cation, anion, and/or crystal structure.

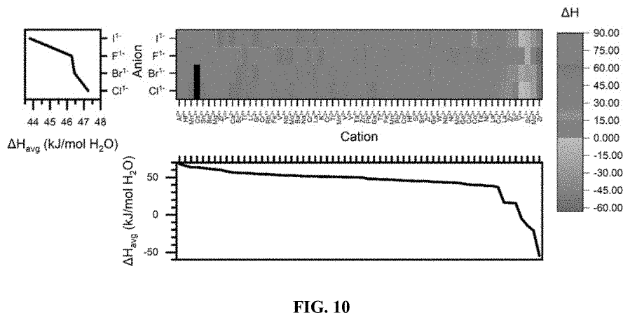

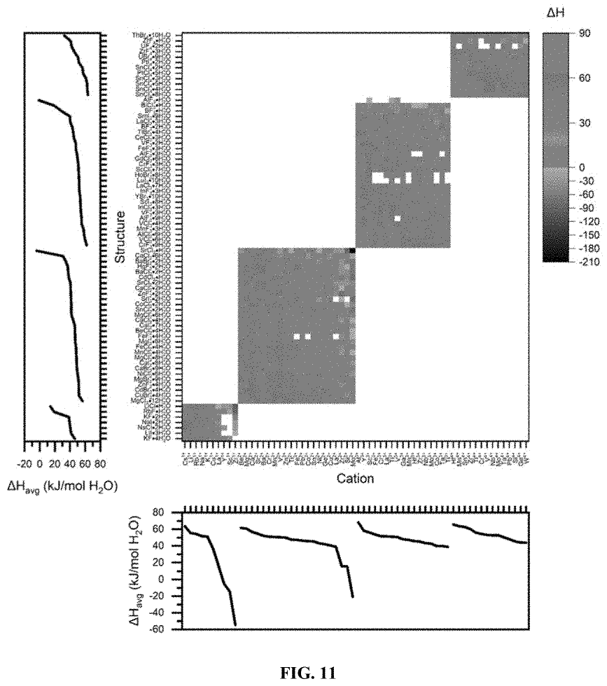

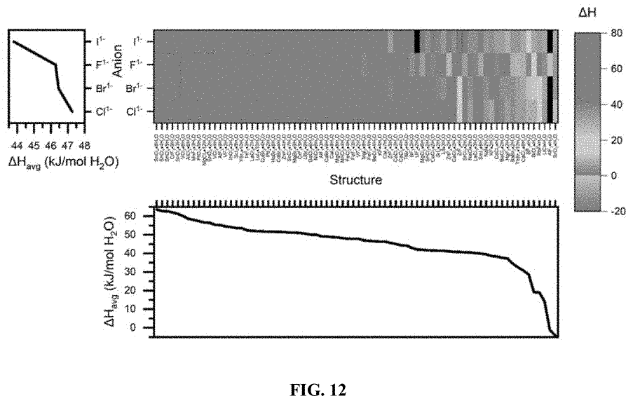

In order to illustrate this, FIG. 10 shows the average ΔH based on the cation, the anion, and the cation-anion pair. The bottom plot shows the ranking of the cations, with Al³⁺ possessing the highest average ΔH and Zr¹⁺ possessing the lowest average ΔH. The left plot similarly shows the ranking of the anions, with Cl¹⁻ possessing the highest average ΔH and I¹⁻ possessing the lowest average ΔH. However, more detailed information is shown in the heatmap. Although the general ionic trends hold across the heatmap, there are noticeable deviations. For instance, the hydrates with the highest average ΔH don't belong to AlCl₃, but rather the salt families of MnF4, SnI₄, GeF4, and CuF. Similar heatmaps for the cation-structure pairs and anion-structure pairs are found in FIGS. 11-12.

The trends revealed in the ML analysis suggest the following design rules for maximizing the TES performance of salt hydrates in accordance with certain aspects of the present disclosure.

Enthalpy of Dehydration. For a salt hydrate, ΔH affects many TES properties of interest. ΔH can be tuned by the cation, anion, and crystal structure. For the cation, smaller electronegativities and molar masses tend to correlate with higher ΔH. Regarding the anion, chlorides and bromides tend to have slightly higher ΔH, although some particular fluoride salts tend to have very high ΔH. In terms of crystal structure, a higher hydrate number, a smaller cation-water distance, and larger distance between cation nearest neighbors tend to increase ΔH. However, as shown by the SVM model, while these isolated trends exist, more precise tuning can be achieved by taking into account the specific interaction behavior between cations, anions, and crystal structures.

Energy Density. Higher energy densities can be achieved by increasing ΔH and water capacity. High water capacity in salt hydrates is achieved by increasing n and decreasing the mass and volume of the hydrate.

Stability. A HC's stability is a function of both its ΔH as well as ΔH for all other related hydrates (i.e., hydrates in the same salt family). In general, a given HC will have a higher likelihood of being stable if its ΔH is relatively high compared to ΔH of all related hydrates because this will cause it to lie deeper on the convex hull plot. Thus, one could potentially design with stability in mind by tuning ΔH via crystal structure as this affects ΔH of the specific HC rather than all hydrates in the salt family.

Operating Temperature. The turning temperature of a step reaction is proportional to ΔH; thus, temperature is tuned by tuning ΔH. Furthermore, a temperature hysteresis results from the existence of stable, intermediate hydrates. The probability of a temperature hysteresis increases as n increases since more HC exist that can potentially form as stable intermediates. This creates a design tradeoff between temperature hysteresis and energy density with respect to n.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A composition suitable for use in thermal energy systems (TES) comprising a salt hydrate represented by the formula: MX_{q}.nH₂O, where M is a cation selected from Groups 1-14 of the IUPAC Periodic Table, X is a halide of Group 17 of the IUPAC Periodic Table, q ranges from 1 to 4, and n ranges from 1 to 12, wherein the salt hydrate is selected from the group consisting of: AlBr₃.H₂O, BaBr₂.12H₂O, BaF₂.2H₂O, BaF₂.12H₂O, BaI₂.12H₂O, BeBr₂.9H₂O, BeCl₂.12H₂O, BeF₂.9H₂O, BeI₂.2H₂O, BeI₂.8H₂O, BeI₂.12H₂O, CaBr₂.12H₂O, CaI₂.2H₂O, CaI₂.12H₂O, CoBr₂.12H₂O, CoBr₃.9H₂O, CoCl₂.12H₂O, CoCl₃.9H₂O, CoF₂.12H₂O, CoF₃.9H₂O, CoI₂.12H₂O, CrBr₂.4H₂O, CrBr₂.12H₂O, CrBr₄.8H₂O, CrCl₂.12H₂O, CrCl₄.8H₂O, CrF₂.4H₂O, CrF₂.12H₂O, CrF₄.5H₂O, CrF₄.8H₂O, CrI₂.4H₂O, CrI₂.12H₂O, CrI₃.9H₂O, CrI₄.3H₂O, CrI₄.8H₂O, CuBr₂.12H₂O, CuF.H₂O, CuF.2H₂O, CuF₂.4H₂O, CuF₂.12H₂O, CuI₂.4H₂O, FeBr₃.H₂O, FeBr₃.9H₂O, FeF₂.12H₂O, FeF₃.9H₂O, FeI₃.2H₂O, FeI₃.3H₂O, GaBr₃.2H₂O, GaBr₃.9H₂O, GaF₃.9H₂O, GaI₃.H₂O, GaI₃.9H₂O, GeBr₂.4H₂O, GeBr₂.12H₂O, GeCl₂.2H₂O, GeCl₂.4H₂O, GeCl₂.12H₂O, GeCl₄.8H₂O, GeF₂.2H₂O, GeF₂.4H₂O, GeF₂.12H₂O, GeF₄.5H₂O, GeF₄.8H₂O, GeI₂.4H₂O, GeI₂.12H₂O, GeI₄.H₂O, HfBr₃.9H₂O, HfBr₄.2H₂O, HfBr₄.3H₂O, HfBr₄.4H₂O, HfBr₄.8H₂O, HfCl₃.9H₂O, HfCl₄.2H₂O, HfCl₄.3H₂O, HfCl₄.4H₂O, HfF₄.8H₂O, HfI₃.9H₂O, HfI4.2H₂O, HfI₄.8H₂O, LaF₃.9H₂O, LaI₂.12H₂O, LiF.4H₂O, MgBr₂.12H₂O, MgF₂.12H₂O, MgI₂.4H₂O, MgI₂.12H₂O, MnBr₂.12H₂O, MnBr₃.6H₂O, MnBr₄.8H₂O, MnCl₃.9H₂O, MnCl₄.8H₂O, MnF₂.12H₂O, MnF₃.9H₂O, MnF₄.2H₂O, MnF₄.4H₂O, MnF₄.5H₂O, MnF₄.8H₂O, MnI₂.12H₂O, MnI₃.6H₂O, MnI₄.8H₂O, MoBr₃.9H₂O, MoBr₄.8H₂O, MoCl₃.2H₂O, MoCl₃.9H₂O, MoCl₄.4H₂O, MoCl₄.8H₂O, MoF₂.H₂O, MoF₃.3H₂O, MoF₃.9H₂O, MoF₄.2H₂O, MoF₄.5H₂O, MoF₄.8H₂O, MoI₃.9H₂O, MoI₄.H₂O, NaBr.H₂O, NaBr₄H₂O, NaF.4H₂O, NbBr₃.6H₂O, NbBr₃.9H₂O, NbBr₄.8H₂O, NbCl₃.9H₂O, NbCl₄.8H₂O, NbF₃.H₂O, NbF₃.9H₂O, NbF₄.5H₂O, NbF₄.8H₂O, NbI₃.6H₂O, NbI₃.9H₂O, NbI₄.8H₂O, NiBr₂.12H₂O, NiBr₃.6H₂O, NiCl₃.9H₂O, NiF₂.12H₂O, NiF₃.2H₂O, NiF₃.9H₂O, NiI₂.12H₂O, PbBr₂.2H₂O, PbBr₂.4H₂O, PbBr₂.12H₂O, PbBr₄.8H₂O, PbCl₂.12H₂O, PbCl₄.3H₂O, PbCl₄.8H₂O, PbF₂.2H₂O, PbF₂.12H₂O, PbF₄.2H₂O, PbF₄.3H₂O, PbF₄.5H₂O, PbI₂.4H₂O, PbI₂.12H₂O, PbI₄.5H₂O, RbBr₄H₂O, RbCl_{.4}H₂O, RbI4H₂O, ScBr₃.9H₂O, ScF₃.3H₂O, ScF₃.9H₂O, ScI₃.6H₂O, ScI₃.9H₂O, SiBr₂.8H₂O, SiBr₄.8H₂O, SiBr₄.9H₂O, SiCl₂.8H₂O, SiCl₄.8H₂O, SiCl₄.9H₂O, SiF₄.5H₂O, SiF₄.8H₂O, SiI₂.8H₂O, SiI₄.9H₂O, SnBr₂.4H₂O, SnBr₂.12H₂O, SnCl₂.12H₂O, SnF₂.4H₂O, SnF₂.12H₂O, SnF₄.2H₂O, SnF₄.5H₂O, SnF₄.8H₂O, SnI₂.4H₂O, SnI₂.12H₂O, SnI₄.H₂O, SnI₄.2H₂O, SnI₄.3H₂O, SrBr₂.12H₂O, SrCl₂.12H₂O, SrF₂.2H₂O, SrF₂.12H₂O, SrI₂.12H₂O, TaBr₃.6H₂O, TaBr₃.9H₂O, TaBr₄.8H₂O, TaCl₃.9H₂O, TaCl₄.8H₂O, TaF₃.H₂O, TaF₄.5H₂O, TaF₄.8H₂O, TaI₃.6H₂O, TaI₄.8H₂O, TiBr₂.H₂O, TiBr₂.12H₂O, TiBr₃.9H₂O, TiBr₄.8H₂O, TiCl₂.12H₂O, TiCl₃.H₂O, TiF₂.H₂O, TiF₂.12H₂O, TiF₃.3H₂O, TiF₃.9H₂O, TiF₄.5H₂O, TiF₄.8H₂O, TiI₂.12H₂O, TiI₃.9H₂O, TiI₄.8H₂O, VBr₂.12H₂O, VBr₃.9H₂O, VBr₄.8H₂O, VCl₂.H₂O, VCl₂.12H₂O, VCl₃.9H₂O, VCl₄.8H₂O, VF₂.12H₂O, VF₃.9H₂O, VF₄.2H₂O, VF₄.5H₂O, VF₄.8H₂O, VI₂.12H₂O, VI₃.9H₂O, VI₄.8H₂O, WBr₄.8H₂O, WCl₄.8H₂O, WF₄.5H₂O, WF₄.8H₂O, WI₄.8H₂O, YF₃.9H₂O, YI₃.7H₂O, YI₃.9H₂O, ZnBr₂.12H₂O, ZnCl₂.12H₂O, ZnF₂.12H₂O, ZnI₁₂.12H₂O, ZrBr₂.H₂O, ZrBr₂.12H₂O, ZrBr₃.9H₂O, ZrBr₄.2H₂O, ZrBr₄.3H₂O, ZrBr₄.4H₂O, ZrBr₄.8H₂O, ZrCl₂.H₂O, ZrCl₂.12H₂O, ZrCl₃.9H₂O, ZrF₃.9H₂O, ZrF₄.8H₂O, ZrI₃.9H₂O, ZrI₄.2H₂O, ZrI₄.8H₂O, AIBr₃.4H₂O, AIBr₃.7H₂O, AIBr₃.8H₂O, AlBr₃.10H₂O, AlCl₃.H₂O, AlCl₃.H₂O, AlCl₃.H₂O, AlF₃.8H₂O, AlF₃.10H₂O, AlI₃.H₂O, AlI₃.2H₂O, AlI₃.3H₂O, AlI₃.4H₂O, AlI₃.7H₂O, AlI₃.8H₂O, AlI₃.10H₂O, BaBr₂.6H₂O, BaBr₂.7H₂O, BaBr₂.8H₂O, BaBr₂.9H₂O, B aF₂.H₂O, BaF₂.4H₂O, BaF₂.6H₂O, BaF₂.7H₂O, BaF₂.8H₂O, BaF₂.9H₂O, BaI₂.8H₂O, BaI₂.9H₂O, BeBr₂.H₂O, BeBr₂.2H₂O, BeBr₂.8H₂O, BeBr₂.12H₂O, BeCl₂.7H₂O, BeCl₂.8H₂O, BeCl₂.9H₂O, BeF₂.7H₂O, BeF₂.8H₂O, BeF₂.12H₂O, BeI₂.7H₂O, BeI₂.9H₂O, CaBr₂.7H₂O, CaBr₂.8H₂O, CaI₂.9H₂O, CoBr₂.8H₂O, CoBr₂.9H₂O, CoBr₃.H₂O, CoBr₃.3H₂O, CoBr₃.4H₂O, CoBr₃.7H₂O, CoBr₃.10H₂O, CoCl₃.H₂O, CoCl₃.H₂O, CoF₂.8H₂O, CoF₂.9H₂O, CoF₃.6H₂O, CoF₃.7H₂O, CoF₃.8H₂O, CoF₃.10H₂O, CoI₂.8H₂O, CoI₂.9H₂O, CoI₃.H₂O, CoI₃.6H₂O, CoI₃.7H₂O, CoI₃.9H₂O, CoI₃.H₂O, CrBr₂.H₂O, CrBr₂.2H₂O, CrBr₂.7H₂O, CrBr₂.8H₂O, CrBr₂.9H₂O, CrBr₃.H₂O, CrBr₃.2H₂O, CrBr₃.3H₂O, CrBr₃.7H₂O, CrBr₃.10H₂O, CrBr₄.2H₂O, CrBr₄.3H₂O, CrBr₄.4H₂O, CrBr₄.5H₂O, CrBr₄.9H₂O, CrCl₂.H₂O, CrCl₂.7H₂O, CrCl₂.8H₂O, CrCl₂.9H₂O, CrCl₃.H₂O, CrCl₄.2H₂O, CrCl₄.3H₂O, CrCl₄.4H₂O, CrCl₄.5H₂O, CrF2.H₂O, CrF₂.6H₂O, CrF₂.7H₂O, CrF₂.8H₂O, CrF₂.9H₂O, CrF₄.3H₂O, CrF₄.4H₂O, CrI₂.H₂O, CrI₂.2H₂O, CrI₂.6H₂O, CrI₂.7H₂O, CrI₂.8H₂O, CrI₂.9H₂O, CrI₃.H₂O, CrI₃.2H₂O, CrI₃.H₂O, CrI₃.7H₂O, CrI₃.8H₂O, CrI₃.10H₂O, CrI₄.2H₂O, CrI₄.4H₂O, CrI₄.5H₂O, CrI₄.9H₂O, CuBr₃H₂O, CuBr₂.7H₂O, CuBr₂.8H₂O, CuBr₂.9H₂O, CuCl₂.8H₂O, CuCl₂.9H₂O, CuF.3H₂O, CuF.4H₂O, CuF₂.6H₂O, CuF₂.8H₂O, CuF₂.9H₂O, CuI₂.6H₂O, CuI₂.8H₂O, CuI₂.9H₂O, CuI₂.12H₂O, FeBr₂.8H₂O, FeBr₂.12H₂O, FeBr₃.3H₂O, FeBr₃.4H₂O, FeBr₃.7H₂O, FeBr₃.8H₂O, FeBr₃.10H₂O, FeCl₂.8H₂O, FeF2.H₂O, FeF₂.2H₂O, FeF₂.6H₂O, FeF₂.9H₂O, FeF₃.2H₂O, FeF₃.4H₂O, FeF₃.6H₂O, FeF₃.7H₂O, FeF₃.8H₂O, FeF₃.10H₂O, FeI₂.7H₂O, FeI₂.8H₂O, FeI₂.12H₂O, FeI₃.H₂O, FeI₃.H₂O, FeI₃.7H₂O, FeI₃.H₂O, FeI₃.9H₂O, GaBr₃.H₂O, GaBr₃.4H₂O, GaBr₃.6H₂O, GaBr₃.7H₂O, GaBr₃.8H₂O, GaBr₃.10H₂O, GaCl₃.2H₂O, GaCl₃.H₂O, GaCl₃.H₂O, GaCl₃.7H₂O, GaCl₃.H₂O, GaCl₃.H₂O, GaF₃.4H₂O, GaF₃.6H₂O, GaF₃.7H₂O, GaF₃.10H₂O, GaI₃.H₂O, GaI₃.H₂O, GaI₃.6H₂O, GaI₃.7H₂O, GaI₃.H₂O, GeBr₂.H₂O, GeBr₂.2H₂O, GeBr₂.6H₂O, GeBr₂.7H₂O, GeBr₂.8H₂O, GeBr₂.9H₂O, GeBr₄.3H₂O, GeBr₄.4H₂O, GeBr₄.5H₂O, GeBr₄.9H₂O, GeCl₂.H₂O, GeCl₂.6H₂O, GeCl₂.7H₂O, GeCl₂.8H₂O, GeCl₂.9H₂O, GeCl₄.3H₂O, GeCl₄.4H₂O, GeCl₄.9H₂O, GeF₂.6H₂O, GeF₂.7H₂O, GeF₂.8H₂O, GeF₂.9H₂O, GeF₄.H₂O, GeF₄.4H₂O, GeF₄.9H₂O, GeI₂.H₂O, GeI₂.2H₂O, GeI₂.6H₂O, GeI₂.7H₂O, GeI₂.8H₂O, GeI₂.9H₂O, GeI₄.3H₂O, GeI_{4.}4H₂O, GeI₄.H₂O, GeI₄.9H₂O, GeI₆H₂O, GeI₇H₂O, GeI₈H₂O, GeI₁₀H₂O, HfBr₄.5H₂O, HfBr₄.9H₂O, HfBr₄.10H₂O, HfCl₃.H₂O, HfCl₃.6H₂O, HfCl₃.7H₂O, HfCl₃.H₂O, HfCl₃.H₂O, HfCl₄.9H₂O, HfCl₄.10H₂O, HfF₃.9H₂O, HfF₃.10H₂O, HfF₄.4H₂O, HfF₄.5H₂O, HfF₄.9H₂O, HfI₃.6H₂O, HfI₃.7H₂O, HfI₃.H₂O, HfI₃.H₂O, HfI₄.3H₂O, HfI₄.4H₂O, HfI₄.5H₂O, HfI₄.9H₂O, HfI₄.10H₂O, LaBr₂.9H₂O, LaBr₂.12H₂O, LaBr₃.2H₂O, LaBr₃.10H₂O, LaCl_{.3}H₂O, LaCl_{.4}H₂O, LaCl₂.12H₂O, LaF₂.12H₂O, LaF₃.H₂O, LaF₃.4H₂O, LaF₃.7H₂O, LaF₃.8H₂O, LaF₃.10H₂O, LaI.4H₂O, LaI₂.7H₂O, LaI₂.8H₂O, LaI₂.9H₂O, LaI₃.H₂O, LaI₃.2H₂O, LaI₃.3H₂O, LaI₃.H₂O, LaI₃.7H₂O, LaI₃.H₂O, LaI₃.H₂O, LiF.3H₂O, MgBr₂.7H₂O, MgF₂.6H₂O, MgF₂.8H₂O, MgI₂.H₂O, MnBr₂.7H₂O, MnBr₂.8H₂O, MnBr₂.9H₂O, MnBr₃.H₂O, MnBr₃.2H₂O, MnBr₃.3H₂O, MnBr₃.4H₂O, MnBr₃.7H₂O, MnBr₃.8H₂O, MnBr₃.9H₂O, MnBr₃.10H₂O, MnBr₄.2H₂O, MnBr₄.3H₂O, MnBr₄.5H₂O, MnBr₄.9H₂O, MnCl₃.H₂O, MnCl₃.H₂O, MnCl₃.7H₂O, MnCl₃.H₂O, MnCl₄.2H₂O, MnCl₄.3H₂O, MnCl₄.5H₂O, MnCl₄.9H₂O, MnF₂.6H₂O, MnF₂.8H₂O, MnF₂.9H₂O, MnF₃.4H₂O, MnF₃.6H₂O, MnF₃.7H₂O, MnF₄.H₂O, MnF₄.3H₂O, MnF₄.9H₂O, MnI₂.7H₂O, MnI₂.8H₂O, MnI₂.9H₂O, MnI₃.H₂O, MnI₃.2H₂O, MnI₃.3H₂O, MnI₃.H₂O, MnI₃.7H₂O, MnI₃.8H₂O, MnI₃.9H₂O, MnI₃.10H₂O, MnI₄.2H₂O, MnI₄.3H₂O, MnI₄.4H₂O, MnI₄.5H₂O, MoBr₂.12H₂O, MoBr₃.3H₂O, MoBr₃.4H₂O, MoBr₃.6H₂O, MoBr₃.7H₂O, MoBr₃.8H₂O, MoBr₃.10H₂O, MoBr₄.2H₂O, MoBr₄.3H₂O, MoBr₄.4H₂O, MoBr₄.5H₂O, MoBr₄.9H₂O, MoCl₂.12H₂O, MoCl₃.H₂O, MoCl₃.7H₂O, MoCl₃.H₂O, MoCl₃.H₂O, MoCl₄.H₂O, MoCl₄.3H₂O, MoCl₄.5H₂O, MoF₂.8H₂O, MoF₂.9H₂O, MoF₂.12H₂O, MoF₃.H₂O, MoF₃.2H₂O, MoF₃.4H₂O, MoF₃.6H₂O, MoF₃.7H₂O, MoF₃.8H₂O, MoF₃.10H₂O, MoF₄.3H₂O, MoF₄.4H₂O, MoF₄.9H₂O, MoI₂.12H₂O, MoI₃.H₂O, MoI₃.H₂O, MoI₃.6H₂O, MoI₃.7H₂O, MoI₃.H₂O, MoI₃.10H₂O, MoI₄.2H₂O, MoI₄.3H₂O, MoI₄.4H₂O, MoI₄.5H₂O, MoI₄.9H₂O, NaBr₃H₂O, NaF.H₂O, NaF.2H₂O, NaF.3H₂O, NbBr₃.2H₂O, NbBr₃.3H₂O, NbBr₃.4H₂O, NbBr₃.7H₂O, NbBr₃.8H₂O, NbBr₃.10H₂O, NbBr₄.2H₂O, NbBr₄.3H₂O, NbBr₄.4H₂O, NbBr₄.5H₂O, NbBr₄.9H₂O, NbCl₃.H₂O, NbCl₃.H₂O, NbCl₃.H₂O, NbCl₃.6H₂O, NbCl₃.7H₂O, NbCl₃.H₂O, NbCl₃.H₂O, NbCl₄.2H₂O, NbCl₄.3H₂O, NbCl₄.4H₂O, NbCl₄.5H₂O, NbCl₄.9H₂O, NbF₃.2H₂O, NbF₃.3H₂O, NbF₃.4H₂O, NbF₃.6H₂O, NbF₃.7H₂O, NbF₃.8H₂O, NbF₃.10H₂O, NbF₄.H₂O, NbF₄.2H₂O, NbF₄.3H₂O, NbF₄.4H₂O, NbF₄.9H₂O, NbI₃.2H₂O, NbI₃.H₂O, NbI₃.H₂O, NbI₃.7H₂O, NbI₃.H₂O, NbI₃.H₂O, NbI₄.2H₂O, NbI₄.3H₂O, NbI₄.4H₂O, NbI₄.5H₂O, NbI₄.9H₂O, NbI₄.10H₂O, NiBr₂.7H₂O, NiBr₂.8H₂O, NiBr₃.H₂O, NiBr₃.2H₂O, NiBr₃.3H₂O, NiBr₃.4H₂O, NiBr₃.7H₂O, NiBr₃.8H₂O, NiBr₃.9H₂O, NiBr₃.10H₂O, NiCl₃.4H₂O, NiCl₃.H₂O, NiCl₃.H₂O, NiCl₃.H₂O, NiF₂.H₂O, NiF₂.7H₂O, NiF₂.8H₂O, NiF₂.9H₂O, NiF₃.6H₂O, NiF₃.10H₂O, NiI₂.H₂O, NiI₂.2H₂O, NiI₂.7H₂O, NiI₂.8H₂O, NiI₂.9H₂O, NiI₃.2H₂O, NiI₃.3H₂O, NiI₃.6H₂O, NiI₃.7H₂O, NiI₃.8H₂O, NiI₃.9H₂O, NiI₃.H₂O, PbBr₂.6H₂O, PbBr₂.7H₂O, PbBr₂.8H₂O, PbBr₂.9H₂O, PbBr₄.3H₂O, PbBr₄.4H₂O, PbBr₄.5H₂O, PbBr₄.9H₂O, PbCl₂.H₂O, PbCl₂.7H₂O, PbCl₂.8H₂O, PbCl₂.9H₂O, PbCl₄.2H₂O, PbCl₄.4H₂O, PbCl₄.5H₂O, PbF₂.4H₂O, PbF₂.6H₂O, PbF₂.7H₂O, PbF₂.8H₂O, PbF₂.9H₂O, PbF₄.H₂O, PbF₄.4H₂O, PbI₂.H₂O, PbI₂.6H₂O, PbI₂.7H₂O, PbI₂.8H₂O, PbI₂.9H₂O, PbI₄.H₂O, PbI₄.3H₂O, PbI₄.4H₂O, PbI₄.H₂O, PbI₄.9H₂O, RbBr.H₂O, RbBr₂H₂O, RbBr₃H₂O, RbCl.H₂O, RbCl_{.2}H₂O, RbCl_{.3}H₂O, RbIH₂O, RbI2H₂O, RbI3H₂O, ScBr₃.2H₂O, ScBr₃.8H₂O, ScBr₃.10H₂O, ScCl₃.H₂O, ScCl₃.H₂O, ScF₃.2H₂O, ScF₃.4H₂O, ScF₃.7H₂O, ScF₃.8H₂O, ScF₃.10H₂O, ScI₃.H₂O, ScI₃.H₂O, ScI₃.H₂O, ScI₃.7H₂O, ScI₃.10H₂O, SiBr₂.4H₂O, SiBr₂.9H₂O, SiBr₂.12H₂O, SiBr₄.3H₂O, SiBr₄.4H₂O, SiBr₄.5H₂O, SiCl₂.4H₂O, SiCl₂.7H₂O, SiCl₂.9H₂O, SiCl₂.12H₂O, SiCl₄.3H₂O, SiCl₄.4H₂O, SiCl₄.5H₂O, SiF₂.2H₂O, SiF₂.8H₂O, SiF₄.3H₂O, SiF₄.4H₂O, SiF₄.9H₂O, SiI₂.4H₂O, SiI₂.6H₂O, SiI₂.9H₂O, SiI₂.12H₂O, SiI₄.H₂O, SnBr₂.6H₂O, SnBr₂.8H₂O, SnBr₂.9H₂O, SnBr₄.2H₂O, SnBr₄.3H₂O, SnBr₄.9H₂O, SnCl₂.8H₂O, SnF₂.6H₂O, SnF₂.7H₂O, SnF₂.8H₂O, SnF₂.9H₂O, SnF₄.H₂O, SnF₄.3H₂O, SnF₄.4H₂O, SnF₄.9H₂O, SnI₂.H₂O, SnI₂.6H₂O, SnI₂.7H₂O, SnI₂.8H₂O, SnI₂.9H₂O, SnI₄.4H₂O, SnI₄.9H₂O, SrBr₂.4H₂O, SrBr₂.7H₂O, SrBr₂.8H₂O, SrBr₂.9H₂O, SrCl₂.8H₂O, SrF₂.4H₂O, SrF₂.6H₂O, SrF₂.8H₂O, SrF₂.9H₂O, SrI₂.4H₂O, SrI₂.8H₂O, SrI₂.9H₂O, TaBr₃.H₂O, TaBr₃.2H₂O, TaBr₃.3H₂O, TaBr₃.4H₂O, TaBr₃.7H₂O, TaBr₃.8H₂O, TaBr₃.10H₂O, TaBr₄.2H₂O, TaBr₄.3H₂O, TaBr₄.4H₂O, TaBr₄.5H₂O, TaBr₄.9H₂O, TaCl₃.2H₂O, TaCl₃.H₂O, TaCl₃.H₂O, TaCl₃.6H₂O, TaCl₃.7H₂O, TaCl₃.H₂O, TaCl₃.H₂O, TaCl₄.2H₂O, TaCl₄.3H₂O, TaCl₄.4H₂O, TaCl₄.5H₂O, TaCl₄.9H₂O, TaF₃.9H₂O, TaF₃.10H₂O, TaF₄.2H₂O, TaF₄.3H₂O, TaF₄.4H₂O, TaF₄.9H₂O, TaI₃.H₂O, TaI₃.H₂O, TaI₃.7H₂O, TaI₃.H₂O, TaI₃.9H₂O, TaI₃.H₂O, TaI₄.2H₂O, TaI₄.3H₂O, TaI₄.4H₂O, TaI₄.5H₂O, TaI₄.9H₂O, TaI₄.10H₂O, TiBr₂.2H₂O, TiBr₂.4H₂O, TiBr₂.7H₂O, TiBr₂.8H₂O, TiBr₂.9H₂O, TiBr₃.H₂O, TiBr₃.2H₂O, TiBr₃.3H₂O, TiBr₃.4H₂O, TiBr₃.7H₂O, TiBr₃.8H₂O, TiBr₃.10H₂O, TiBr₄.2H₂O, TiBr₄.3H₂O, TiBr₄.4H₂O, TiBr₄.5H₂O, TiBr₄.9H₂O, TiCl₂.4H₂O, TiCl₂.7H₂O, TiCl₂.8H₂O, TiCl₂.9H₂O, TiCl₃.H₂O, TiCl₃.2H₂O, TiCl₃.7H₂O, TiCl₃.H₂O, TiCl₃.H₂O, TiCl₄.3H₂O, TiCl₄.4H₂O, TiCl₄.9H₂O, TiF₂.4H₂O, TiF₂.6H₂O, TiF₂.8H₂O, TiF₂.9H₂O, TiF₃.2H₂O, TiF₃.6H₂O, TiF₃.7H₂O, TiF₃.8H₂O, TiF₄.3H₂O, TiF₄.9H₂O, TiI₂.H₂O, TiI₂.2H₂O, TiI₂.4H₂O, TiI₂.6H₂O, TiI₂.7H₂O, TiI₂.8H₂O, TiI₂.9H₂O, TiI₃.2H₂O, TiI₃.3H₂O, TiI₃.4H₂O, TiI₃.7H₂O, TiI₃.8H₂O, TiI₃.H₂O, TiI₄.2H₂O, TiI₄.3H₂O, TiI₄.4H₂O, TiI₄.5H₂O, TiI₄.9H₂O, VBr₂.H₂O, VBr₂.7H₂O, VBr₂.8H₂O, VBr₂.9H₂O, VBr₃.H₂O, VBr₃.2H₂O, VBr₃.3H₂O, VBr₃.7H₂O, VBr₃.8H₂O, VBr₄.2H₂O, VBr₄.3H₂O, VBr₄.4H₂O, VBr₄.5H₂O, VCl₂.6H₂O, VCl₂.7H₂O, VCl₂.8H₂O, VCl₂.9H₂O, VCl₃.H₂O, VCl₃.7H₂O, VCl₃.H₂O, VCl₃.H₂O, VCl₄.2H₂O, VCl₄.3H₂O, VCl₄.5H₂O, VF₂.2H₂O, VF₂.6H₂O, VF₂.7H₂O, VF₂.8H₂O, VF₂.9H₂O, VF₃.4H₂O, VF₃.6H₂O, VF₄.H₂O, VF₄.3H₂O, VF₄.4H₂O, VI₂.H₂O,VI₂.2H₂O, VI₂.7H₂O, VI₂.8H₂O, VI₂.9H₂O, VI₃.2H₂O, VI₃.H₂O, VI₃.H₂O, VI₃.7H₂O, VI₃.H₂O, VI₃.H₂O, VI₄.2H₂O, VI₄.3H₂O, VI₄.4H₂O, VI₄.5H₂O, VI₄.9H₂O, WBr₄.2H₂O, WBr₄.3H₂O, WBr₄.5H₂O, WBr₄.9H₂O, WCl₄.2H₂O, WCl₄.3H₂O, WCl₄.4H₂O, WCl₄.5H₂O, WCl₄.9H₂O, WF₄.2H₂O, WF₄.3H₂O, WF₄.4H₂O, WI₄.2H₂O, WI₄.3H₂O, WI₄.4H₂O, WI₄.5H₂O, WI₄.9H₂O, YBr₃.H₂O, YBr₃.2H₂O, YBr₃.4H₂O, YBr₃.7H₂O, YCl₃.H₂O, YCl₃.H₂O, YF₃.H₂O, YF₃.2H₂O, YF₃.4H₂O, YF₃.6H₂O, YF₃.7H₂O, YF₃.8H₂O, YF₃.10H₂O, YI₃.2H₂O, YI₃.4H₂O, YI₃.10H₂O, ZnBr₂.7H₂O, ZnBr₂.8H₂O, ZnBr₂.9H₂O, ZnF2.H₂O, ZnF₂.6H₂O, ZnF₂.8H₂O, ZnF₂.9H₂O, ZnI2.H₂O, ZnI₂.9H₂O, ZrBr₂.6H₂O, ZrBr₂.7H₂O, ZrBr₂.8H₂O, ZrBr₂.9H₂O, ZrBr₃.2H₂O, ZrBr₃.3H₂O, ZrBr₃.4H₂O, ZrBr₃.6H₂O, ZrBr₃.7H₂O, ZrBr₃.8H₂O, ZrBr₃.10H₂O, ZrBr₄.5H₂O, ZrBr₄.9H₂O, ZrBr₄.10H₂O, ZrCl₂.9H₂O, ZrCl₃.H₂O, ZrCl₃.2H₂O, ZrCl₃.H₂O, ZrCl₃.H₂O, ZrCl₃.6H₂O, ZrCl₃.7H₂O, ZrCl₃.H₂O, ZrCl₃.H₂O, ZrCl₄.9H₂O, ZrCl₄.10H₂O, ZrF₃.6H₂O, ZrF₃.7H₂O, ZrF₃.8H₂O, ZrF₃.10H₂O, ZrF₄.2H₂O, ZrF₄.5H₂O, ZrF₄.9H₂O, ZrI₂.12H₂O, ZrI₃.H₂O, ZrI₃.H₂O, ZrI₃.6H₂O, ZrI₃.7H₂O, ZrI₃.H₂O, ZrI₃.H₂O, ZrI₄.3H₂O, ZrI₄.4H₂O, ZrI₄.5H₂O, ZrI₄.9H₂O, Zr4.10H₂O, and combinations thereof.

2. The composition of claim 1, wherein M is selected from the group consisting of: lithium (Li), sodium (Na), potassium (K), rubidium (Rb), cesium (Cs), beryllium (Be), magnesium (Mg), calcium (Ca), strontium (Sr), barium (B a), scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), iron (Fe), cobalt (Co), nickel (Ni), copper (Cu), zinc (Zn), aluminum (Al), gallium (Ga), silicon (Si), germanium (Ge), tin (Sn), lead (Pb)), lanthanum (La), and combinations thereof and X is selected from the group consisting of: fluorine (F), chlorine (Cl), bromine (Br), iodine (I), and combinations thereof.

3. The composition of claim 1 wherein M is selected from the group consisting of lithium (Li), sodium (Na), beryllium (Be), magnesium (Mg), and aluminum (Al), X is a halide selected from the group consisting of: fluorine (F), chlorine (Cl), and bromine (Br).

4. The composition of claim 1, wherein X comprises fluorine (F), so that the metal hydrate is represented by the formula: MF_{q}.nH₂O.

5. The composition of claim 1 wherein the salt hydrate is selected from the group consisting of: AlBr₃.H₂O, BaBr₂.12H₂O, BaF₂.2H₂O, BaF₂.12H₂O, BaI₂.12H₂O, BeBr₂.9H₂O, BeCl₂.12H₂O, BeF₂.9H₂O, BeI₂.2H₂O, BeI₂.8H₂O, BeI₂.12H₂O, CaBr₂.12H₂O, CaI₂.2H₂O, CaI₂.12H₂O, CoBr₂.12H₂O, CoBr₃.9H₂O, CoCl₂.12H₂O, CoCl₃.9H₂O, CoF₂.12H₂O, CoF₃.9H₂O, CoI₂.12H₂O, CrBr₂.4H₂O, CrBr₂.12H₂O, CrBr₄.8H₂O, CrCl₂.12H₂O, CrCl₄.8H₂O, CrF₂.4H₂O, CrF₂.12H₂O, CrF₄.5H₂O, CrF₄.8H₂O, CrI₂.4H₂O, CrI₂.12H₂O, CrI₃.9H₂O, CrI₄.3H₂O, CrI₄.H₂O, CuBr₂.12H₂O, CuF.H₂O, CuF.2H₂O, CuF₂.4H₂O, CuF₂.12H₂O, CuI₂.4H₂O, FeBr₃.H₂O, FeBr₃.9H₂O, FeF₂.12H₂O, FeF₃.9H₂O, FeI₃.2H₂O, FeI₃.H₂O, GaBr₃.2H₂O, GaBr₃.9H₂O, GaF₃.9H₂O, GaI₃.H₂O, GaI₃.9H₂O, GeBr₂.4H₂O, GeBr₂.12H₂O, GeCl₂.2H₂O, GeCl₂.4H₂O, GeCl₂.12H₂O, GeCl₄.8H₂O, GeF₂.2H₂O, GeF₂.4H₂O, GeF₂.12H₂O, GeF₄.5H₂O, GeF₄.8H₂O, GeI₂.4H₂O, GeI₂.12H₂O, GeI₄.H₂O, HfBr₃.9H₂O, HfBr₄.2H₂O, HfBr₄.3H₂O, HfBr₄.4H₂O, HfBr₄.8H₂O, HfCl₃.9H₂O, HfCl₄.2H₂O, HfCl₄.3H₂O, HfCl₄.4H₂O, HfF₄.8H₂O, HfI₃.9H₂O, HfI₄.2H₂O, HfI₄.H₂O, LaF₃.9H₂O, LaI₂.12H₂O, LiF.4H₂O, MgBr₂.12H₂O, MgF₂.12H₂O, MgI₂.4H₂O, MgI₂.12H₂O, MnBr₂.12H₂O, MnBr₃.6H₂O, MnBr₄.8H₂O, MnCl₃.9H₂O, MnCl₄.8H₂O, MnF₂.12H₂O, MnF₃.9H₂O, MnF₄.2H₂O, MnF₄.4H₂O, MnF₄.5H₂O, MnF₄.8H₂O, MnI₂.12H₂O, MnI₃.6H₂O, MnI₄.8H₂O, MoBr₃.9H₂O, MoBr₄.8H₂O, MoCl₃.2H₂O, MoCl₃.9H₂O, MoCl₄.4H₂O, MoCl₄.8H₂O, MoF₂.H₂O, MoF₃.3H₂O, MoF₃.9H₂O, MoF₄.2H₂O, MoF₄.5H₂O, MoF₄.8H₂O, MoI₃.9H₂O, MoI₄.H₂O, NaBr.H₂O, NaBr₄H₂O, NaF.4H₂O, NbBr₃.6H₂O, NbBr₃.9H₂O, NbBr₄.8H₂O, NbCl₃.9H₂O, NbCl₄.8H₂O, NbF₃.H₂O, NbF₃.9H₂O, NbF₄.5H₂O, NbF₄.8H₂O, NbI₃.6H₂O, NbI₃.9H₂O, NbI₄.8H₂O, NiBr₂.12H₂O, NiBr₃.6H₂O, NiCl₃.9H₂O, NiF₂.12H₂O, NiF₃.2H₂O, NiF₃.9H₂O, NiI₂.12H₂O, PbBr₂.2H₂O, PbBr₂.4H₂O, PbBr₂.12H₂O, PbBr₄.8H₂O, PbCl₂.12H₂O, PbCl₄.3H₂O, PbCl₄.8H₂O, PbF₂.2H₂O, PbF₂.12H₂O, PbF₄.2H₂O, PbF₄.3H₂O, PbF₄.5H₂O, PbI₂.4H₂O, PbI₂.12H₂O, PbI₄.5H₂O, RbBr₄H₂O, RbCl_{.4}H₂O, RbI4H₂O, ScBr₃.9H₂O, ScF₃.3H₂O, ScF₃.9H₂O, ScI₃.6H₂O, ScI₃.9H₂O, SiBr₂.8H₂O, SiBr₄.8H₂O, SiBr₄.9H₂O, SiCl₂.8H₂O, SiCl₄.8H₂O, SiCl₄.9H₂O, SiF₄.5H₂O, SiF₄.8H₂O, SiI₂.8H₂O, SiI₄.9H₂O, SnBr₂.4H₂O, SnBr₂.12H₂O, SnCl₂.12H₂O, SnF₂.4H₂O, SnF₂.12H₂O, SnF₄.2H₂O, SnF₄.5H₂O, SnF₄.8H₂O, SnI₂.4H₂O, SnI₂.12H₂O, SnI₄.H₂O, SnI₄.2H₂O, SnI₄.3H₂O, SrBr₂.12H₂O, SrCl₂.12H₂O, SrF₂.2H₂O, SrF₂.12H₂O, SrI₂.12H₂O, TaBr₃.6H₂O, TaBr₃.9H₂O, TaBr₄.8H₂O, TaCl₃.9H₂O, TaCl₄.8H₂O, TaF₃.H₂O, TaF₄.5H₂O, TaF₄.8H₂O, TaI₃.6H₂O, TaI₄.8H₂O, TiBr₂.H₂O, TiBr₂.12H₂O, TiBr₃.9H₂O, TiBr₄.8H₂O, TiCl₂.12H₂O, TiCl₃.H₂O, TiF₂.H₂O, TiF₂.12H₂O, TiF₃.3H₂O, TiF₃.9H₂O, TiF₄.5H₂O, TiF₄.8H₂O, TiI₂.12H₂O, TiI₃.9H₂O, TiI₄.8H₂O, VBr₂.12H₂O, VBr₃.9H₂O, VBr₄.8H₂O, VCl₂.H₂O, VCl₂.12H₂O, VCl₃.9H₂O, VCl₄.8H₂O, VF₂.12H₂O, VF₃.9H₂O, VF₄.2H₂O, VF₄.5H₂O, VF₄.8H₂O, VI₂.12H₂O, VI₃.9H₂O, VI₄.8H₂O, WBr₄.8H₂O, WCl₄.8H₂O, WF₄.5H₂O, WF₄.8H₂O, WI₄.8H₂O, YF₃.9H₂O, YI₃.7H₂O, YI₃.9H₂O, ZnBr₂.12H₂O, ZnCl₂.12H₂O, ZnF₂.12H₂O, ZnI₁₂.12H₂O, ZrBr₂.H₂O, ZrBr₂.12H₂O, ZrBr₃.9H₂O, ZrBr₄.2H₂O, ZrBr₄.3H₂O, ZrBr₄.4H₂O, ZrBr₄.8H₂O, ZrCl₂.H₂O, ZrCl₂.12H₂O, ZrCl₃.9H₂O, ZrF₃.9H₂O, ZrF₄.8H₂O, ZrI₃.9H₂O, ZrI₄.2H₂O, ZrI₄.8H₂O, and combinations thereof.

6. The composition of claim 1 wherein the salt hydrate is selected from the group consisting of: AlBr₃.4H₂O, AlBr₃.7H₂O, AlBr₃.8H₂O, AlBr₃.10H₂O, AlCl₃.H₂O, AlCl₃.H₂O, AlCl₃.H₂O, AlF₃.8H₂O, AlF₃.10H₂O, AlI₃.H₂O, AlI₃.2H₂O, AlI₃.3H₂O, AlI₃.4H₂O, AlI₃.7H₂O, AlI₃.8H₂O, AlI₃.10H₂O, BaBr₂.6H₂O, BaBr₂.7H₂O, BaBr₂.8H₂O, BaBr₂.9H₂O, BaF₂.H₂O, BaF₂.4H₂O, BaF₂.6H₂O, BaF₂.7H₂O, BaF₂.8H₂O, BaF₂.9H₂O, BaI₂.8H₂O, BaI₂.9H₂O, BeBr₂.H₂O, BeBr₂.2H₂O, BeBr₂.8H₂O, BeBr₂.12H₂O, BeCl₂.7H₂O, BeCl₂.8H₂O, BeCl₂.9H₂O, BeF₂.7H₂O, BeF₂.8H₂O, BeF₂.12H₂O, BeI₂.7H₂O, BeI₂.9H₂O, CaBr₂.7H₂O, CaBr₂.8H₂O, CaI₂.9H₂O, CoBr₂.8H₂O, CoBr₂.9H₂O, CoBr₃.H₂O, CoBr₃.3H₂O, CoBr₃.4H₂O, CoBr₃.7H₂O, CoBr₃.10H₂O, CoCl₃.H₂O, CoCl₃.H₂O, CoF₂.8H₂O, CoF₂.9H₂O, CoF₃.6H₂O, CoF₃.7H₂O, CoF₃.8H₂O, CoF₃.10H₂O, CoI₂.8H₂O, CoI₂.9H₂O, CoI₃.H₂O, CoI₃.6H₂O, CoI₃.7H₂O, CoI₃.9H₂O, CoI₃.10H₂O, CrBr₂.H₂O, CrBr₂.2H₂O, CrBr₂.7H₂O, CrBr₂.8H₂O, CrBr₂.9H₂O, CrBr₃.H₂O, CrBr₃.2H₂O, CrBr₃.3H₂O, CrBr₃.7H₂O, CrBr₃.10H₂O, CrBr₄.2H₂O, CrBr₄.3H₂O, CrBr₄.4H₂O, CrBr₄.5H₂O, CrBr₄.9H₂O, CrCl₂.H₂O, CrCl₂.7H₂O, CrCl₂.8H₂O, CrCl₂.9H₂O, CrCl₃.H₂O, CrCl₄.2H₂O, CrCl₄.3H₂O, CrCl₄.4H₂O, CrCl₄.5H₂O, CrF2.H₂O, CrF₂.6H₂O, CrF₂.7H₂O, CrF₂.8H₂O, CrF₂.9H₂O, CrF₄.3H₂O, CrF₄.4H₂O, CrI₂.H₂O, CrI₂.2H₂O, CrI₂.6H₂O, CrI₂.7H₂O, CrI₂.8H₂O, CrI₂.9H₂O, CrI₃.H₂O, CrI₃.2H₂O, CrI₃.4H₂O, CrI₃.7H₂O, CrI₃.8H₂O, CrI₃.10H₂O, CrI₄.2H₂O, CrI₄.4H₂O, CrI₄.5H₂O, CrI₄.9H₂O, CuBr₃H₂O, CuBr₂.7H₂O, CuBr₂.8H₂O, CuBr₂.9H₂O, CuCl₂.8H₂O, CuCl₂.9H₂O, CuF.3H₂O, CuF.4H₂O, CuF₂.6H₂O, CuF₂.8H₂O, CuF₂.9H₂O, CuI₂.6H₂O, CuI₂.8H₂O, CuI₂.9H₂O, CuI₂.12H₂O, FeBr₂.8H₂O, FeBr₂.12H₂O, FeBr₃.3H₂O, FeBr₃.4H₂O, FeBr₃.7H₂O, FeBr₃.8H₂O, FeBr₃.10H₂O, FeCl₂.8H₂O, FeF2.H₂O, FeF₂.2H₂O, FeF₂.6H₂O, FeF₂.9H₂O, FeF₃.2H₂O, FeF₃.4H₂O, FeF₃.6H₂O, FeF₃.7H₂O, FeF₃.8H₂O, FeF₃.10H₂O, FeI₂.7H₂O, FeI₂.8H₂O, FeI₂.12H₂O, FeI₃.H₂O, FeI₃.H₂O, FeI₃.7H₂O, FeI₃.H₂O, FeI₃.9H₂O, GaBr₃.H₂O, GaBr₃.4H₂O, GaBr₃.6H₂O, GaBr₃.7H₂O, GaBr₃.8H₂O, GaBr₃.10H₂O, GaCl₃.2H₂O, GaCl₃.H₂O, GaCl₃.H₂O, GaCl₃.7H₂O, GaCl₃.H₂O, GaCl₃.H₂O, GaF₃.4H₂O, GaF₃.6H₂O, GaF₃.7H₂O, GaF₃.10H₂O, GaI₃.H₂O, GaI₃.H₂O, GaI₃.6H₂O, GaI₃.7H₂O, GaI₃.H₂O, GeBr₂.H₂O, GeBr₂.2H₂O, GeBr₂.6H₂O, GeBr₂.7H₂O, GeBr₂.8H₂O, GeBr₂.9H₂O, GeBr₄.3H₂O, GeBr₄.4H₂O, GeBr₄.5H₂O, GeBr₄.9H₂O, GeCl₂.H₂O, GeCl₂.6H₂O, GeCl₂.7H₂O, GeCl₂.8H₂O, GeCl₂.9H₂O, GeCl₄.3H₂O, GeCl₄.4H₂O, GeCl₄.9H₂O, GeF₂.6H₂O, GeF₂.7H₂O, GeF₂.8H₂O, GeF₂.9H₂O, GeF₄.H₂O, GeF₄.4H₂O, GeF₄.9H₂O, GeI₂.H₂O, GeI₂.2H₂O, GeI₂.6H₂O, GeI₂.7H₂O, GeI₂.8H₂O, GeI₂.9H₂O, GeI₄.3H₂O, GeI₄.4H₂O, GeI₄.5H₂O, GeI₄.9H₂O, HfBr₃.6H₂O, HfBr₃.7H₂O, HfBr₃.8H₂O, HfBr₃.10H₂O, HfBr₄.5H₂O, HfBr₄.9H₂O, HfBr₄.10H₂O, HfCl₃.H₂O, HfCl₃.6H₂O, HfCl₃.7H₂O, HfCl₃.H₂O, HfCl₃.H₂O, HfCl₄.9H₂O, HfCl₄.10H₂O, lifF₃.9H₂O, HfF₃.10H₂O, HfF₄.4H₂O, HfF₄.5H₂O, HfF₄.9H₂O, HfI₃.6H₂O, HfI₃.7H₂O, HfI₃.H₂O, HfI₃.H₂O, HfI₄.3H₂O, HfI₄.4H₂O, HfI₄.5H₂O, HfI₄.9H₂O, HfI₄.10H₂O, LaBr₂.9H₂O, LaBr₂.12H₂O, LaBr₃.2H₂O, LaBr₃.10H₂O, LaCl_{.3}H₂O, LaCl_{.4}H₂O, LaCl₂.12H₂O, LaF₂.12H₂O, LaF₃.H₂O, LaF₃.4H₂O, LaF₃.7H₂O, LaF₃.8H₂O, LaF₃.10H₂O, LaI.4H₂O, LaI₂.7H₂O, LaI₂.8H₂O, LaI₂.9H₂O, LaI₃.H₂O, LaI₃.2H₂O, LaI₃.H₂O, LaI₃.H₂O, LaI₃.7H₂O, LaI₃.H₂O, LaI₃.H₂O, LiF.3H₂O, MgBr₂.7H₂O, MgF₂.6H₂O, MgF₂.8H₂O, MgI₂.H₂O, MnBr₂.7H₂O, MnBr₂.8H₂O, MnBr₂.9H₂O, MnBr₃.H₂O, MnBr₃.2H₂O, MnBr₃.3H₂O, MnBr₃.4H₂O, MnBr₃.7H₂O, MnBr₃.8H₂O, MnBr₃.9H₂O, MnBr₃.10H₂O, MnBr₄.2H₂O, MnBr₄.3H₂O, MnBr₄.5H₂O, MnBr₄.9H₂O, MnCl₃.H₂O, MnCl₃.H₂O, MnCl₃.7H₂O, MnCl₃.H₂O, MnCl₄.2H₂O, MnCl₄.3H₂O, MnCl₄.5H₂O, MnCl₄.9H₂O, MnF₂.6H₂O, MnF₂.8H₂O, MnF₂.9H₂O, MnF₃.4H₂O, MnF₃.6H₂O, MnF₃.7H₂O, MnF₄.H₂O, MnF₄.3H₂O, MnF₄.9H₂O, MnI₂.7H₂O, MnI₂.8H₂O, MnI₂.9H₂O, MnI₃⁻H₂O, MnI₃.2H₂O, MnI₃.H₂O, MnI₃.H₂O, MnI₃.7H₂O, MnI₃.H₂O, MnI₃.9H₂O, MnI₃.10H₂O, MnI₄.2H₂O, MnI₄.3H₂O, MnI₄.4H₂O, MnI₄.5H₂O, MoBr₂.12H₂O, MoBr₃.3H₂O, MoBr₃.4H₂O, MoBr₃.6H₂O, MoBr₃.7H₂O, MoBr₃.8H₂O, MoBr₃.10H₂O, MoBr₄.2H₂O, MoBr₄.3H₂O, MoBr₄.4H₂O, MoBr₄.5H₂O, MoBr₄.9H₂O, MoCl₂.12H₂O, MoCl₃.H₂O, MoCl₃.7H₂O, MoCl₃.H₂O, MoCl₃.H₂O, MoCl₄.H₂O, MoCl₄.3H₂O, MoCl₄.5H₂O, MoF₂.8H₂O, MoF₂.9H₂O, MoF₂.12H₂O, MoF₃.H₂O, MoF₃.2H₂O, MoF₃.4H₂O, MoF₃.6H₂O, MoF₃.7H₂O, MoF₃.8H₂O, MoF₃.10H₂O, MoF₄.3H₂O, MoF₄.4H₂O, MoF₄.9H₂O, MoI₂.12H₂O, MoI₃.H₂O, MoI₃.H₂O, MoI₃.6H₂O, MoI₃.7H₂O, MoI₃.H₂O, MoI₃.10H₂O, MoI₄.2H₂O, MoI₄.3H₂O, MoI₄.4H₂O, MoI₄.5H₂O, MoI₄.9H₂O, NaBr₃H₂O, NaF.H₂O, NaF.2H₂O, NaF.3H₂O, NbBr₃.2H₂O, NbBr₃.3H₂O, NbBr₃.4H₂O, NbBr₃.7H₂O, NbBr₃.8H₂O, NbBr₃.10H₂O, NbBr₄.2H₂O, NbBr₄.3H₂O, NbBr₄.4H₂O, NbBr₄.5H₂O, NbBr₄.9H₂O, NbCl₃.H₂O, NbCl₃.H₂O, NbCl₃.H₂O, NbCl₃.6H₂O, NbCl₃.7H₂O, NbCl₃.H₂O, NbCl₃.H₂O, NbCl₄.2H₂O, NbCl₄.3H₂O, NbCl₄.4H₂O, NbCl₄.5H₂O, NbCl₄.9H₂O, NbF₃.2H₂O, NbF₃.3H₂O, NbF₃.4H₂O, NbF₃.6H₂O, NbF₃.7H₂O, NbF₃.8H₂O, NbF₃.10H₂O, NbF₄.H₂O, NbF₄.2H₂O, NbF₄.3H₂O, NbF₄.4H₂O, NbF₄.9H₂O, NbI₃.2H₂O, NbI₃.H₂O, NbI₃.H₂O, NbI₃.7H₂O, NbI₃.H₂O, NbI₃.H₂O, NbI₄.2H₂O, NbI₄.3H₂O, NbI₄.4H₂O, NbI₄.5H₂O, NbI₄.9H₂O, NbI₄.10H₂O, NiBr₂.7H₂O, NiBr₂.8H₂O, NiBr₃.H₂O, NiBr₃.2H₂O, NiBr₃.3H₂O, NiBr₃.4H₂O, NiBr₃.7H₂O, NiBr₃.8H₂O, NiBr₃.9H₂O, NiBr₃.10H₂O, NiCl₃.H₂O, NiCl₃.H₂O, NiCl₃.H₂O, NiCl₃.10H₂O, NiF₂.H₂O, NiF₂.7H₂O, NiF₂.8H₂O, NiF₂.9H₂O, NiF₃.6H₂O, NiF₃.10H₂O, NiI₂.H₂O, NiI₂.2H₂O, NiI₂.7H₂O, NiI₂.8H₂O, NiI₂.9H₂O, NiI₃.2H₂O, NiI₃.3H₂O, NiI₃.6H₂O, NiI₃.7H₂O, NiI₃.8H₂O, NiI₃.9H₂O, NiI₃.H₂O, PbBr₂.6H₂O, PbBr₂.7H₂O, PbBr₂.8H₂O, PbBr₂.9H₂O, PbBr₄.3H₂O, PbBr₄.4H₂O, PbBr₄.5H₂O, PbBr₄.9H₂O, PbCl₂.H₂O, PbCl₂.7H₂O, PbCl₂.8H₂O, PbCl₂.9H₂O, PbCl₄.2H₂O, PbCl₄.4H₂O, PbCl₄.5H₂O, PbF₂.4H₂O, PbF₂.6H₂O, PbF₂.7H₂O, PbF₂.8H₂O, PbF₂.9H₂O, PbF₄.H₂O, PbF₄.4H₂O, PbI2.H₂O, PbI₂.6H₂O, PbI₂.7H₂O, PbI₂.8H₂O, PbI₂.9H₂O, PbI₄.H₂O, PbI₄.3H₂O, PbI₄.4H₂O, PbI₄.H₂O, PbI₄.9H₂O, RbBr.H₂O, RbBr₂H₂O, RbBr₃H₂O, RbCl.H₂O, RbCl_{.2}H₂O, RbCl_{.3}H₂O, RbIH₂O, RbI2H₂O, RbI3H₂O, ScBr₃.2H₂O, ScBr₃.8H₂O, ScBr₃.10H₂O, ScCl₃.H₂O, ScCl₃.H₂O, ScF₃.2H₂O, ScF₃.4H₂O, ScF₃.7H₂O, ScF₃.8H₂O, ScF₃.10H₂O, ScI₃.H₂O, ScI₃.H₂O, ScI₃.H₂O, ScI₃.7H₂O, ScI₃.H₂O, SiBr₂.4H₂O, SiBr₂.9H₂O, SiBr₂.12H₂O, SiBr₄.3H₂O, SiBr₄.4H₂O, SiBr₄.5H₂O, SiCl₂.4H₂O, SiCl₂.7H₂O, SiCl₂.9H₂O, SiCl₂.12H₂O, SiCl₄.3H₂O, SiCl₄.4H₂O, SiCl₄.5H₂O, SiF₂.2H₂O, SiF₂.8H₂O, SiF₄.3H₂O, SiF₄.4H₂O, SiF₄.9H₂O, SiI₂.4H₂O, SiI₂.6H₂O, SiI₂.9H₂O, SiI₂.12H₂O, SiI₄.H₂O, SnBr₂.6H₂O, SnBr₂.8H₂O, SnBr₂.9H₂O, SnBr₄.2H₂O, SnBr₄.3H₂O, SnBr₄.9H₂O, SnCl₂.8H₂O, SnF₂.6H₂O, SnF₂.7H₂O, SnF₂.8H₂O, SnF₂.9H₂O, SnF₄.H₂O, SnF₄.3H₂O, SnF₄.4H₂O, SnF₄.9H₂O, SnI₂.H₂O, SnI₂.6H₂O, SnI₂.7H₂O, SnI₂.8H₂O, SnI₂.9H₂O, SnI₄.4H₂O, SnI₄.9H₂O, SrBr₂.4H₂O, SrBr₂.7H₂O, SrBr₂.8H₂O, SrBr₂.9H₂O, SrCl₂.8H₂O, SrF₂.4H₂O, SrF₂.6H₂O, SrF₂.8H₂O, SrF₂.9H₂O, SrI₂.4H₂O, SrI₂.8H₂O, SrI₂.9H₂O, TaBr₃.H₂O, TaBr₃.2H₂O, TaBr₃.3H₂O, TaBr₃.4H₂O, TaBr₃.7H₂O, TaBr₃.8H₂O, TaBr₃.10H₂O, TaBr₄.2H₂O, TaBr₄.3H₂O, TaBr₄.4H₂O, TaBr₄.5H₂O, TaBr₄.9H₂O, TaCl₃.2H₂O, TaCl₃.H₂O, TaCl₃.H₂O, TaCl₃.6H₂O, TaCl₃.7H₂O, TaCl₃.H₂O, TaCl₃.H₂O, TaCl₄.2H₂O, TaCl₄.3H₂O, TaCl₄.4H₂O, TaCl₄.5H₂O, TaCl₄.9H₂O, TaF₃.9H₂O, TaF₃.10H₂O, TaF₄.2H₂O, TaF₄.3H₂O, TaF₄.4H₂O, TaF₄.9H₂O, TaI₃.H₂O, TaI₃.H₂O, TaI₃.7H₂O, TaI₃.H₂O, TaI₃.9H₂O, TaI₃.10H₂O, TaI₄.2H₂O, TaI₄.3H₂O, TaI₄.4H₂O, TaI₄.5H₂O, TaI₄.9H₂O, TaI₄.10H₂O, TiBr₂.2H₂O, TiBr₂.4H₂O, TiBr₂.7H₂O, TiBr₂.8H₂O, TiBr₂.9H₂O, TiBr₃.H₂O, TiBr₃.2H₂O, TiBr₃.3H₂O, TiBr₃.4H₂O, TiBr₃.7H₂O, TiBr₃.8H₂O, TiBr₃.10H₂O, TiBr₄.2H₂O, TiBr₄.3H₂O, TiBr₄.4H₂O, TiBr₄.5H₂O, TiBr₄.9H₂O, TiCl₂.4H₂O, TiCl₂.7H₂O, TiCl₂.8H₂O, TiCl₂.9H₂O, TiCl₃.H₂O, TiCl₃.2H₂O, TiCl₃.7H₂O, TiCl₃.H₂O, TiCl₃.H₂O, TiCl₄.3H₂O, TiCl₄.4H₂O, TiCl₄.9H₂O, TiF₂.4H₂O, TiF₂.6H₂O, TiF₂.8H₂O, TiF₂.9H₂O, TiF₃.2H₂O, TiF₃.6H₂O, TiF₃.7H₂O, TiF₃.8H₂O, TiF₄.3H₂O, TiF₄.9H₂O, TiI₂.H₂O, TiI₂.2H₂O, TiI₂.4H₂O, TiI₂.6H₂O, TiI₂.7H₂O, TiI₂.8H₂O, TiI₂.9H₂O, TiI₃.2H₂O, TiI₃.3H₂O, TiI₃.4H₂O, TiI₃.7H₂O, TiI₃.8H₂O, TiI₃.H₂O, TiI₄.2H₂O, TiI₄.3H₂O, TiI₄.4H₂O, TiI₄.5H₂O, TiI₄.9H₂O, VBr₂.H₂O, VBr₂.7H₂O, VBr₂.8H₂O, VBr₂.9H₂O, VBr₃.H₂O, VBr₃.2H₂O, VBr₃.3H₂O, VBr₃.7H₂O, VBr₃.8H₂O, VBr₄.2H₂O, VBr₄.3H₂O, VBr₄.4H₂O, VBr₄.5H₂O, VCl₂.6H₂O, VCl₂.7H₂O, VCl₂.8H₂O, VCl₂.9H₂O, VCl₃.H₂O, VCl₃.7H₂O, VCl₃.H₂O, VCl₃.H₂O, VCl₄.2H₂O, VCl₄.3H₂O, VCl₄.5H₂O, VF₂.2H₂O, VF₂.6H₂O, VF₂.7H₂O, VF₂.8H₂O, VF₂.9H₂O, VF₃.4H₂O, VF₃.6H₂O, VF₄.H₂O, VF₄.3H₂O, VF₄.4H₂O, VI₂.H₂O, VI₂.2H₂O, VI₂.7H₂O, VI₂.8H₂O, VI₂.9H₂O, VI₃.2H₂O, VI₃.H₂O, VI₃.H₂O, VI₃.7H₂O, VI₃.H₂O, VI₃.H₂O, VI₄.2H₂O, VI₄.3H₂O, VI₄.4H₂O, VI₄.5H₂O, VI₄.9H₂O, WBr₄.2H₂O, WBr₄.3H₂O, WBr₄.5H₂O, WBr₄.9H₂O, WCl₄.2H₂O, WCl₄.3H₂O, WCl₄.4H₂O, WCl₄.5H₂O, WCl₄.9H₂O, WF₄.2H₂O, WF₄.3H₂O, WF₄.4H₂O, WI₄.2H₂O, WI₄.3H₂O, WI₄.4H₂O, WI₄.5H₂O, WI₄.9H₂O, YBr₃.H₂O, YBr₃.2H₂O, YBr₃.4H₂O, YBr₃.7H₂O, YCl₃.H₂O, YCl₃.H₂O, YF₃.H₂O, YF₃.2H₂O, YF₃.4H₂O, YF₃.6H₂O, YF₃.7H₂O, YF₃.8H₂O, YF₃.10H₂O, YI₃.2H₂O, YI₃.4H₂O, YI₃.10H₂O, ZnBr₂.7H₂O, ZnBr₂.8H₂O, ZnBr₂.9H₂O, ZnF2.H₂O, ZnF₂.6H₂O, ZnF₂.8H₂O, ZnF₂.9H₂O, ZnI2.H₂O, ZnI₂.9H₂O, ZrBr₂.6H₂O, ZrBr₂.7H₂O, ZrBr₂.8H₂O, ZrBr₂.9H₂O, ZrBr₃.2H₂O, ZrBr₃.3H₂O, ZrBr₃.4H₂O, ZrBr₃.6H₂O, ZrBr₃.7H₂O, ZrBr₃.8H₂O, ZrBr₃.10H₂O, ZrBr₄.5H₂O, ZrBr₄.9H₂O, ZrBr₄.10H₂O, ZrCl₂.9H₂O, ZrCl₃.H₂O, ZrCl₃.2H₂O, ZrCl₃.H₂O, ZrCl₃.H₂O, ZrCl₃.6H₂O, ZrCl₃.7H₂O, ZrCl₃.H₂O, ZrCl₃.H₂O, ZrCl₄.9H₂O, ZrCl₄.10H₂O, ZrF₃.6H₂O, ZrF₃.7H₂O, ZrF₃.8H₂O, ZrF₃.10H₂O, ZrF₄.2H₂O, ZrF₄.5H₂O, ZrF₄.9H₂O, ZrI₂.12H₂O, ZrI₃.H₂O, ZrI₃.H₂O, ZrI₃.6H₂O, ZrI₃.7H₂O, ZrI₃.H₂O, ZrI₃.H₂O, ZrI₄.3H₂O, ZrI₄.4H₂O, ZrI₄.5H₂O, ZrI₄.9H₂O, ZrI₄.10H₂O, and combinations thereof.

7. The composition of claim 1 comprising a plurality of cations (M) including a first cation and a second cation, wherein a minimum distance between the first cation and the second cation is greater than or equal to about 4.1 A.

8. The composition of claim 1, wherein a temperature hysteresis of a dehydration reaction and a hydration reaction of the salt hydrate is less than or equal to about 50° C.

9. The composition of claim 1, wherein the salt hydrate has a volumetric energy density of greater than or equal to about 1.3 GJ/m³.

10. The composition of claim 1, wherein the salt hydrate is selected from the group consisting of: LiF-4H₂O, TiF₂.12H₂O, MgF₂.12H₂O, MnF₂.12H₂O, SiF₄.5H₂O, CuF.H₂O, TiF₂.H₂O, and combinations thereof.

11. A thermal energy system (TES) comprising:
a thermal energy storage material comprising a salt hydrate that is represented by the formula: MX_{q}.nH₂O, where M is a cation selected from Groups 1-14 of the IUPAC Periodic Table, X is a halide of Group 17 of the IUPAC Periodic Table, q ranges from 1 to 4, and n ranges from 1 to 12, wherein the salt hydrate is selected from the group consisting of: AlBr₃.H₂O, AlBr₃.9H₂O, AlCl₃.H₂O, AlCl₃.9H₂O, AlF₃.9H₂O, AlI₃.6H₂O, AlI₃.9H₂O, BaBr₂.12H₂O, BaCl₂.12H₂O, BaF₂.2H₂O, BaF₂.12H₂O, BaI₂.12H₂O, BeBr₂.4H₂O, BeBr₂.9H₂O, BeCl₂.2H₂O, BeCl₂.4H₂O, BeCl₂.12H₂O, BeF₂.2H₂O, BeF₂.4H₂O, BeF₂.9H₂O, BeI₂.2H₂O, BeI₂.4H₂O, BeI₂.8H₂O, BeI₂.12H₂O, CaBr₂.H₂O, CaBr₂.2H₂O, CaBr₂.12H₂O, CaCl₂.12H₂O, CaF₂.12H₂O, CaI₂.2H₂O, CaI₂.12H₂O, COBr₂.12H₂O, CoBr₃.6H₂O, CoBr₃.9H₂O, CoCl₂.12H₂O, CoCl₃.6H₂O, CoCl₃.9H₂O, CoF₂.4H₂O, CoF₂.12H₂O, CoF₃.3H₂O, CoF₃.9H₂O, CoI₂.12H₂O, CrBr₂.4H₂O, CrBr₂.12H₂O, CrBr₃.9H₂O, CrBr₄.8H₂O, CrCl₂.12H₂O, CrCl₃.9H₂O, CrCl₄.8H₂O, CrF₂.4H₂O, CrF₂.12H₂O, CrF₃.3H₂O, CrF₃.9H₂O, CrF₄.2H₂O, CrF₄.5H₂O, CrF₄.8H₂O, CrI₂.4H₂O, CrI₂.12H₂O, CrI₃.9H₂O, CrI₄.3H₂O, CrI₄.8H₂O, CsF.2H₂O, CsI.4H₂O, CuBr₂.12H₂O, CuCl₂.4H₂O, CuCl₂.12H₂O, CuF.H₂O, CuF.2H₂O, CuF₂.4H₂O, CuF₂.12H₂O, CuI₂.4H₂O, FeBr₃.H₂O, FeBr₃.9H₂O, FeCl₂.9H₂O, FeCl₃.H₂O, FeCl₃.H₂O, FeCl₃.9H₂O, FeF₂.12H₂O, FeF₃.H₂O, FeF₃.9H₂O, FeI₃.2H₂O, FeI₃.3H₂O, GaBr₃.2H₂O, GaBr₃.9H₂O, GaCl₃.H₂O, GaCl₃.9H₂O, GaF₃.9H₂O, GaI₃.H₂O, GaI₃.9H₂O, GeBr₂.4H₂O, GeBr₂.12H₂O, GeCl₂.2H₂O, GeCl₂.4H₂O, GeCl₂.12H₂O, GeCl₄.8H₂O, GeF₂.2H₂O, GeF₂.4H₂O, GeF₂.12H₂O, GeF₄.2H₂O, GeF₄.5H₂O, GeF₄.8H₂O, GeI₂.4H₂O, GeI₂.12H₂O, GeI₄.H₂O, HfBr₃.9H₂O, HfBr₄.2H₂O, HfBr₄.3H₂O, HfBr₄.4H₂O, HfBr₄.8H₂O, HfCl₃.9H₂O, HfCl₄.2H₂O, HfCl₄.3H₂O, HfCl₄.4H₂O, HfCl₄.8H₂O, tifF₄.3H₂O, HfF₄.8H₂O, HfI₃.9H₂O, HfI₄.2H₂O, HfI₄.H₂O, KBr₄H₂O, KCl_{.4}H₂O, KI.4H₂O, LaBr₃.6H₂O, LaBr₃.9H₂O, LaCl₃.6H₂O, LaCl₃.9H₂O, LaF₃.9H₂O, LaI₂.12H₂O, LaI₃.6H₂O, LaI₃.9H₂O, LiBr₃H₂O, LiBr₄H₂O, LiCl_{.4}H₂O, LiF.4H₂O, MgBr₂.2H₂O, MgBr₂.12H₂O, MgCl₂.12H₂O, MgF₂.4H₂O, MgF₂.12H₂O, MgI₂.4H₂O, MgI₂.9H₂O, MgI₂.12H₂O, MnBr₂.12H₂O, MnBr₃.6H₂O, MnBr₄.8H₂O, MnCl₂.12H₂O, MnCl₃.6H₂O, MnCl₃.9H₂O, MnCl₄.4H₂O, MnCl₄.8H₂O, MnF₂.12H₂O, MnF₃.3H₂O, MnF₃.9H₂O, MnF₄.2H₂O, MnF₄.4H₂O, MnF₄.5H₂O, MnF₄.8H₂O, MnI₂.12H₂O, MnI₃.6H₂O, MnI₄.8H₂O, MoBr₃.9H₂O, MoBr₄.8H₂O, MoCl₃.2H₂O, MoCl₃.9H₂O, MoCl₄.4H₂O, MoCl₄.8H₂O, MoF₂.H₂O, MoF₃.3H₂O, MoF₃.9H₂O, MoF₄.2H₂O, MoF₄.5H₂O, MoF₄.8H₂O, MoI₃.9H₂O, MoI₄.8H₂O, NaBr.H₂O, NaBr₄H₂O, NaCl.H₂O, NaCl_{.2}H₂O, NaCl_{.4}H₂O, NaF.4H₂O, NbBr₃.6H₂O, NbBr₃.9H₂O, NbBr₄.8H₂O, NbCl₃.9H₂O, NbCl₄.8H₂O, NbF₃.H₂O, NbF₃.9H₂O, NbF₄.5H₂O, NbF₄.8H₂O, NbI₃.6H₂O, NbI₃.9H₂O, NbI₄.8H₂O, NiBr₂.12H₂O, NiBr₃.6H₂O, NiCl₂.12H₂O, NiCl₃.6H₂O, NiCl₃.9H₂O, NiF₂.2H₂O, NiF₂.12H₂O, NiF₃.2H₂O, NiF₃.3H₂O, NiF₃.9H₂O, NiI₂.12H₂O, PbBr₂.2H₂O, PbBr₂.4H₂O, PbBr₂.12H₂O, PbBr₄.8H₂O, PbCl₂.2H₂O, PbCl₂.4H₂O, PbCl₂.12H₂O, PbCl₄.3H₂O, PbCl₄.8H₂O, PbF₂.2H₂O, PbF₂.12H₂O, PbF₄.2H₂O, PbF₄.3H₂O, PbF₄.5H₂O, PbI₂.4H₂O, PbI₂.12H₂O, PbI₄.5H₂O, RbBr₄H₂O, RbCl_{.4}H₂O, RbF.2H₂O, RbF.4H₂O, RbI4H₂O, ScBr₃.6H₂O, ScBr₃.9H₂O, ScCl₃.H₂O, ScCl₃.9H₂O, ScF₃.3H₂O, ScF₃.9H₂O, ScI₃.6H₂O, ScI₃.9H₂O, SiBr₂.8H₂O, SiBr₄.8H₂O, SiBr₄.9H₂O, SiCl₂.8H₂O, SiCl₄.8H₂O, SiCl₄.9H₂O, SiF₄.2H₂O, SiF₄.5H₂O, SiF₄.8H₂O, SiI₂.8H₂O, SiI₄.9H₂O, SnBr₂.2H₂O, SnBr₂.4H₂O, SnBr₂.12H₂O, SnBr₄.5H₂O, SnCl₂.4H₂O, SnCl₂.12H₂O, SnCl₄.3H₂O, SnCl₄.4H₂O, SnCl₄.8H₂O, SnF₂.2H₂O, SnF₂.4H₂O, SnF₂.12H₂O, SnF₄.2H₂O, SnF₄.5H₂O, SnF₄.8H₂O, SnI₂.4H₂O, SnI₂.12H₂O, SnI₄.H₂O, SnI₄.2H₂O, SnI₄.3H₂O, SnI₄.5H₂O, SrBr₂.2H₂O, SrBr₂.12H₂O, SrCl₂.12H₂O, SrF₂.2H₂O, SrF₂.12H₂O, SrI₂.12H₂O, TaBr₃.6H₂O, TaBr₃.9H₂O, TaBr₄.8H₂O, TaCl₃.9H₂O, TaCl₄.8H₂O, TaF₃.H₂O, TaF₄.5H₂O, TaF₄.8H₂O, TaI₃.6H₂O, TaI₄.8H₂O, TiBr₂.H₂O, TiBr₂.12H₂O, TiBr₃.9H₂O, TiBr₄.8H₂O, TiCl₂.H₂O, TiCl₂.12H₂O, TiCl₃.H₂O, TiCl₃.9H₂O, TiCl₄.8H₂O, TiF₂.H₂O, TiF₂.12H₂O, TiF₃.3H₂O, TiF₃.9H₂O, TiF₄.5H₂O, TiF₄.8H₂O, TiI₂.12H₂O, TiI₃.6H₂O, TiI₃.9H₂O, TiI₄.8H₂O, VBr₂.12H₂O, VBr₃.9H₂O, VBr₄.8H₂O, VCl₂.H₂O, VCl₂.12H₂O, VCl₃.H₂O, VCl₃.9H₂O, VCl₄.8H₂O, VF₂.12H₂O, VF₃.9H₂O, VF₄.2H₂O, VF₄.5H₂O, VF₄.8H₂O, VI₂.12H₂O, VI₃.9H₂O, VI₄.8H₂O, WBr₄.8H₂O, WCl₄.8H₂O, WF₄.5H₂O, WF₄.8H₂O, WI₄.8H₂O, YBr₃.6H₂O, YBr₃.9H₂O, YCl₃.H₂O, YCl₃.9H₂O, YF₃.9H₂O, YI₃.6H₂O, YI₃.7H₂O, YI₃.8H₂O, YI₃.9H₂O, ZnBr₂.4H₂O, ZnBr₂.12H₂O, ZnCl₂.12H₂O, ZnF₂.12H₂O, ZnI₂.2H₂O, ZnI₂.12H₂O, ZrBr₂.H₂O, ZrBr₂.12H₂O, ZrBr₃.9H₂O, ZrBr₄.2H₂O, ZrBr₄.3H₂O, ZrBr₄.4H₂O, ZrBr₄.8H₂O, ZrCl₂.H₂O, ZrCl₂.12H₂O, ZrCl₃.9H₂O, ZrCl₄.2H₂O, ZrCl₄.3H₂O, ZrCl₄.4H₂O, ZrCl₄.8H₂O, ZrF₃.9H₂O, ZrF₄.8H₂O, ZrI₃.9H₂O, ZrI₄.2H₂O, ZrI₄.8H₂O, AIBr₃.3H₂O, AIBr₃.4H₂O, AIBr₃.7H₂O, AIBr₃.8H₂O, AlBr₃.10H₂O, AlCl₃.2H₂O, AlCl₃.H₂O, AlCl₃.H₂O, AlCl₃.7H₂O, AlCl₃.H₂O, AlCl₃.H₂O, AlF₃.2H₂O, AlF₃.4H₂O, AlF₃.6H₂O, AlF₃.7H₂O, AlF₃.8H₂O, AlF₃.10H₂O, AlI₃.H₂O, AlI₃.2H₂O, AlI₃.3H₂O, AlI₃.4H₂O, AlI₃.7H₂O, AlI₃.8H₂O, AlI₃.10H₂O, BaBr₂.4H₂O, BaBr₂.6H₂O, BaBr₂.7H₂O, BaBr₂.8H₂O, BaBr₂.9H₂O, BaCl₂.4H₂O, BaCl₂.8H₂O, BaCl₂.9H₂O, BaF₂.H₂O, BaF₂.4H₂O, BaF₂.6H₂O, BaF₂.7H₂O, BaF₂.8H₂O, BaF₂.9H₂O, BaI₂.4H₂O, BaI₂.8H₂O, BaI₂.9H₂O, BeBr₂.H₂O, BeBr₂.2H₂O, BeBr₂.8H₂O, BeBr₂.12H₂O, BeCl₂.7H₂O, BeCl₂.8H₂O, BeCl₂.9H₂O, BeF₂.7H₂O, BeF₂.8H₂O, BeF₂.12H₂O, BeI₂.7H₂O, BeI₂.9H₂O, CaBr₂.7H₂O, CaBr₂.8H₂O, CaBr₂.9H₂O, CaCl₂.8H₂O, CaF₂.2H₂O, CaF₂.4H₂O, CaF₂.6H₂O, CaF₂.7H₂O, CaF₂.8H₂O, CaF₂.9H₂O, CaI₂.H₂O, CaI₂.4H₂O, CaI₂.7H₂O, CaI₂.9H₂O, CoBr₂.H₂O, CoBr₂.2H₂O, CoBr₂.8H₂O, CoBr₂.9H₂O, CoBr₃.H₂O, CoBr₃.3H₂O, CoBr₃.4H₂O, CoBr₃.7H₂O, CoBr₃.10H₂O, CoCl₂.4H₂O, CoCl₂.7H₂O, CoCl₂.8H₂O, CoCl₂.9H₂O, CoCl₃.H₂O, CoCl₃.H₂O, CoCl₃.H₂O, CoCl₃.7H₂O, CoCl₃.H₂O, CoF₂.H₂O, CoF₂.2H₂O, CoF₂.8H₂O, CoF₂.9H₂O, CoF₃.2H₂O, CoF₃.4H₂O, CoF₃.6H₂O, CoF₃.7H₂O, CoF₃.8H₂O, CoF₃.10H₂O, CoI₂.H₂O, CoI₂.2H₂O, CoI₂.4H₂O, CoI₂.6H₂O, CoI₂.8H₂O, CoI₂.9H₂O, CoI₃.H₂O, CoI₃.6H₂O, CoI₃.7H₂O, CoI₃.9H₂O, CoI₃.H₂O, CrBr₂.H₂O, CrBr₂.2H₂O, CrBr₂.6H₂O, CrBr₂.7H₂O, CrBr₂.8H₂O, CrBr₂.9H₂O, CrBr₃.H₂O, CrBr₃.2H₂O, CrBr₃.3H₂O, CrBr₃.4H₂O, CrBr₃.6H₂O, CrBr₃.7H₂O, CrBr₃.8H₂O, CrBr₃.10H₂O, CrBr₄.2H₂O, CrBr₄.3H₂O, CrBr₄.4H₂O, CrBr₄.5H₂O, CrBr₄.9H₂O, CrCl₂.H₂O, CrCl₂.6H₂O, CrCl₂.7H₂O, CrCl₂.8H₂O, CrCl₂.9H₂O, CrCl₃.H₂O, CrCl₃.2H₂O, CrCl₃.H₂O, CrCl₃.H₂O, CrCl₃.6H₂O, CrCl₃.7H₂O, CrCl₃.H₂O, CrCl₄.2H₂O, CrCl₄.3H₂O, CrCl₄.4H₂O, CrCl₄.5H₂O, CrF2.H₂O, CrF₂.2H₂O, CrF₂.6H₂O, CrF₂.7H₂O, CrF₂.8H₂O, CrF₂.9H₂O, CrF₃.2H₂O, CrF₃.4H₂O, CrF₃.6H₂O, CrF₄.3H₂O, CrF₄.4H₂O, CrI₂.H₂O, CrI₂.2H₂O, CrI₂.6H₂O, CrI₂.7H₂O, CrI₂.8H₂O, CrI₂.9H₂O, CrI₃.H₂O, CrI₃.2H₂O, CrI₃.3H₂O, CrI₃.H₂O, CrI₃.6H₂O, CrI₃.7H₂O, CrI₃.8H₂O, CrI₃.10H₂O, CrI₄.2H₂O, CrI₄.4H₂O, CrI₄.5H₂O, CrI₄.9H₂O, CsF.3H₂O, CuBr.H₂O, CuBr₂H₂O, CuBr₃H₂O, CuBr₄H₂O, CuBr₂.2H₂O, CuBr₂.6H₂O, CuBr₂.7H₂O, CuBr₂.8H₂O, CuBr₂.9H₂O, CuCl_{.2}H₂O, CuCl_{.3}H₂O, CuCl_{.4}H₂O, CuCl₂.H₂O, CuCl₂.6H₂O, CuCl₂.7H₂O, CuCl₂.8H₂O, CuCl₂.9H₂O, CuF.3H₂O, CuF.4H₂O, CuF2.H₂O, CuF₂.6H₂O, CuF₂.8H₂O, CuF₂.9H₂O, CuI₂.2H₂O, CuI₂.6H₂O, CuI₂.8H₂O, CuI₂.9H₂O, CuI₂.12H₂O, FeBr₂.8H₂O, FeBr₂.12H₂O, FeBr₃.3H₂O, FeBr₃.4H₂O, FeBr₃.7H₂O, FeBr₃.8H₂O, FeBr₃.10H₂O, FeCl₂.8H₂O, FeCl₂.12H₂O, FeCl₃.H₂O, FeCl₃.H₂O, FeF2.H₂O, FeF₂.2H₂O, FeF₂.6H₂O, FeF₂.9H₂O, FeF₃.2H₂O, FeF₃.4H₂O, FeF₃.6H₂O, FeF₃.7H₂O, FeF₃.8H₂O, FeF₃.10H₂O, FeI₂.7H₂O, FeI₂.8H₂O, FeI₂.12H₂O, FeI₃.H₂O, FeI₃.H₂O, FeI₃.6H₂O, FeI₃.7H₂O, FeI₃.H₂O, FeI₃.9H₂O, GaBr₃.H₂O, GaBr₃.3H₂O, GaBr₃.4H₂O, GaBr₃.6H₂O, GaBr₃.7H₂O, GaBr₃.8H₂O, GaBr₃.10H₂O, GaCl₃.2H₂O, GaCl₃.H₂O, GaCl₃.H₂O, GaCl₃.6H₂O, GaCl₃.7H₂O, GaCl₃.H₂O, GaCl₃.H₂O, GaF₃.3H₂O, GaF₃.4H₂O, GaF₃.6H₂O, GaF₃.7H₂O, GaF₃.10H₂O, GaI₃.H₂O, GaI₃.H₂O, GaI₃.6H₂O, GaI₃.7H₂O, GaI₃.H₂O, GeBr₂.H₂O, GeBr₂.2H₂O, GeBr₂.6H₂O, GeBr₂.7H₂O, GeBr₂.8H₂O, GeBr₂.9H₂O, GeBr₄.3H₂O, GeBr₄.4H₂O, GeBr₄.5H₂O, GeBr₄.9H₂O, GeCl₂.H₂O, GeCl₂.6H₂O, GeCl₂.7H₂O, GeCl₂.8H₂O, GeCl₂.9H₂O, GeCl₄.3H₂O, GeCl₄.4H₂O, GeCl₄.5H₂O, GeCl₄.9H₂O, GeF₂.6H₂O, GeF₂.7H₂O, GeF₂.8H₂O, GeF₂.9H₂O, GeF₄.H₂O, GeF₄.3H₂O, GeF₄.4H₂O, GeF₄.9H₂O, GeI₂.H₂O, GeI₂.2H₂O, GeI₂.6H₂O, GeI₂.7H₂O, GeI₂.8H₂O, GeI₂.9H₂O, GeI₄.3H₂O, GeI₄.4H₂O, GeI₄.5H₂O, GeI₄.9H₂O, GeI₆H₂O, GeI₇H₂O, GeI₈H₂O, GeI₁₀H₂O, HfBr₄.5H₂O, HfBr₄.9H₂O, HfBr₄.10H₂O, HfCl₃.H₂O, HfCl₃.6H₂O, HfCl₃.7H₂O, HfCl₃.H₂O, HfCl₃.H₂O, HfCl₄.5H₂O, HfCl₄.9H₂O, HfCl₄.10H₂O, HfF₃.9H₂O, HfF₃.10H₂O, HfF₄.H₂O, HfF₄.2H₂O, HfF₄.4H₂O, HfF₄.5H₂O, HfF₄.9H₂O, HfI₃.6H₂O, HfI₃.7H₂O, HfI₃.H₂O, HfI₃.H₂O, HfI₄.3H₂O, HfI₄.4H₂O, HfI₄.5H₂O, HfI₄.9H₂O, HfI₄.10H₂O, KBr.H₂O, KBr₂H₂O, KBr₃H₂O, KCl.H₂O, KCl_{.2}H₂O, KCl_{.3}H₂O, KF.H₂O, KF.3H₂O, KI.H₂O, KI.2H₂O, KI.2H₂O, KI.3H₂O, LaBr₂.9H₂O, LaBr₂.12H₂O, LaBr₃.H₂O, LaBr₃.2H₂O, LaBr₃.3H₂O, LaBr₃.4H₂O, LaBr₃.7H₂O, LaBr₃.8H₂O, LaBr₃.10H₂O, LaCl_{.2}H₂O, LaCl_{.3}H₂O, LaCl_{.4}H₂O, LaCl₂.12H₂O, LaCl₃.2H₂O, LaCl₃.H₂O, LaCl₃.H₂O, LaCl₃.H₂O, LaF₂.12H₂O, LaF₃.H₂O, LaF₃.3H₂O, LaF₃.4H₂O, LaF₃.6H₂O, LaF₃.7H₂O, LaF₃.8H₂O, LaF₃.10H₂O, LaI.4H₂O, LaI₂.7H₂O, LaI₂.8H₂O, LaI₂.9H₂O, LaI₃.H₂O, LaI₃.2H₂O, LaI₃.3H₂O, LaI₃.H₂O, LaI₃.7H₂O, LaI₃.H₂O, LaI₃.H₂O, LiF.H₂O, LiF.3H₂O, LiI.4H₂O, MgBr₂.7H₂O, MgBr₂.8H₂O, MgBr₂.9H₂O, MgCl₂.7H₂O, MgCl₂.8H₂O, MgF2.H₂O, MgF₂.6H₂O, MgF₂.8H₂O, MgF₂.9H₂O, MgI₂.H₂O, MgI₂.6H₂O, MgI₂.8H₂O, MnBr₂.2H₂O, MnBr₂.7H₂O, MnBr₂.8H₂O, MnBr₂.9H₂O, MnBr₃.H₂O, MnBr₃.2H₂O, MnBr₃.3H₂O, MnBr₃.4H₂O, MnBr₃.7H₂O, MnBr₃.8H₂O, MnBr₃.9H₂O, MnBr₃.10H₂O, MnBr₄.2H₂O, MnBr₄.3H₂O, MnBr₄.4H₂O, MnBr₄.5H₂O, MnBr₄.9H₂O, MnCl₂.6H₂O, MnCl₂.8H₂O, MnCl₂.9H₂O, MnCl₃.H₂O, MnCl₃.2H₂O, MnCl₃.H₂O, MnCl₃.H₂O, MnCl₃.7H₂O, MnCl₃.H₂O, MnCl₄.2H₂O, MnCl₄.3H₂O, MnCl₄.5H₂O, MnCl₄.9H₂O, MnF₂.2H₂O, MnF₂.6H₂O, MnF₂.8H₂O, MnF₂.9H₂O, MnF₃.4H₂O, MnF₃.6H₂O, MnF₃.7H₂O, MnF₄.H₂O, MnF₄.3H₂O, MnF₄.9H₂O, MnI₂.6H₂O, MnI₂.7H₂O, MnI₂.8H₂O, MnI₂.9H₂O, MnI₃.H₂O, MnI₃.2H₂O, MnI₃.3H₂O, MnI₃.H₂O, MnI₃.7H₂O, MnI₃.8H₂O, MnI₃.9H₂O, MnI₃.10H₂O, MnI₄.2H₂O, MnI₄.3H₂O, MnI₄.4H₂O, MnI₄.5H₂O, MoBr₂.12H₂O, MoBr₃.3H₂O, MoBr₃.4H₂O, MoBr₃.6H₂O, MoBr₃.7H₂O, MoBr₃.8H₂O, MoBr₃.10H₂O, MoBr₄.2H₂O, MoBr₄.3H₂O, MoBr₄.4H₂O, MoBr₄.5H₂O, MoBr₄.9H₂O, MoCl₂.12H₂O, MoCl₃.3H₂O, MoCl₃.H₂O, MoCl₃.6H₂O, MoCl₃.7H₂O, MoCl₃.8H₂O, MoCl₃.10H₂O, MoCl₄.H₂O, MoCl₄.2H₂O, MoCl₄.3H₂O, MoCl₄.5H₂O, MoF₂.8H₂O, MoF₂.9H₂O, MoF₂.12H₂O, MoF₃.H₂O, MoF₃.2H₂O, MoF₃.4H₂O, MoF₃.6H₂O, MoF₃.7H₂O, MoF₃.8H₂O, MoF₃.10H₂O, MoF₄.3H₂O, MoF₄.4H₂O, MoF₄.9H₂O, MoI₂.12H₂O,₂O, MoI₃.H₂O, MoI₃.6H₂O, MoI₃.6H₂O, MoI₃.7H₂O, MoI₃.H₂O, MoI₃.10H₂O, MoI₄.2H₂O, MoI₄.3H₂O, MoI₄.4H₂O, MoI₄.5H₂O, MoI₄.9H₂O, NaBr₃H₂O, NaCl_{.3}H₂O, NaF.H₂O, NaF.2H₂O, NaF.3H₂O, NaI.H₂O, Na1.3H₂O, Na1.4H₂O, NbBr₃.2H₂O, NbBr₃.3H₂O, NbBr₃.4H₂O, NbBr₃.7H₂O, NbBr₃.8H₂O, NbBr₃.10H₂O, NbBr₄.2H₂O, NbBr₄.3H₂O, NbBr₄.4H₂O, NbBr₄.5H₂O, NbBr₄.9H₂O, NbCl₃.H₂O, NbCl₃.H₂O, NbCl₃.H₂O, NbCl₃.6H₂O, NbCl₃.7H₂O, NbCl₃.H₂O, NbCl₃.H₂O, NbCl₄.2H₂O, NbCl₄.3H₂O, NbCl₄.4H₂O, NbCl₄.5H₂O, NbCl₄.9H₂O, NbF₃.2H₂O, NbF₃.3H₂O, NbF₃.4H₂O, NbF₃.6H₂O, NbF₃.7H₂O, NbF₃.8H₂O, NbF₃.10H₂O, NbF₄.H₂O, NbF₄.2H₂O, NbF₄.3H₂O, NbF₄.4H₂O, NbF₄.9H₂O, NbI₃.2H₂O, NbI₃.H₂O, NbI₃.H₂O, NbI₃.7H₂O, NbI₃.H₂O, NbI₃.H₂O, NbI₄.2H₂O, NbI₄.3H₂O, NbI₄.4H₂O, NbI₄.5H₂O, NbI₄.9H₂O, NbI4.10H₂O, NiBr₂.H₂O, NiBr₂.2H₂O, NiBr₂.4H₂O, NiBr₂.6H₂O, NiBr₂.7H₂O, NiBr₂.8H₂O, NiBr₂.9H₂O, NiBr₃.H₂O, NiBr₃.2H₂O, NiBr₃.3H₂O, NiBr₃.4H₂O, NiBr₃.7H₂O, NiBr₃.8H₂O, NiBr₃.9H₂O, NiBr₃.10H₂O, NiCl₂.H₂O, NiCl₂.7H₂O, NiCl₂.8H₂O, NiCl₂.9H₂O, NiCl₃.4H₂O, NiCl₃.H₂O, NiCl₃.H₂O, NiCl₃.7H₂O, NiCl₃.H₂O, NiF₂.H₂O, NiF₂.6H₂O, NiF₂.7H₂O, NiF₂.8H₂O, NiF₂.9H₂O, NiF₃.4H₂O, NiF₃.6H₂O, NiF₃.10H₂O, NiI₂.H₂O, NiI₂.2H₂O, NiI₂.4H₂O, NiI₂.7H₂O, NiI₂.8H₂O, NiI₂.9H₂O, NiI₃.2H₂O, NiI₃.3H₂O, NiI₃.6H₂O, NiI₃.7H₂O, NiI₃.8H₂O, NiI₃.9H₂O, NiI₃.H₂O, PbBr₂.H₂O, PbBr₂.6H₂O, PbBr₂.7H₂O, PbBr₂.8H₂O, PbBr₂.9H₂O, PbBr₄.3H₂O, PbBr₄.4H₂O, PbBr₄.5H₂O, PbBr₄.9H₂O, PbCl₂.H₂O,PbCl₂.6H₂O, PbCl₂.7H₂O, PbCl₂.8H₂O, PbCl₂.9H₂O, PbCl₄.2H₂O, PbCl₄.4H₂O, PbCl₄.5H₂O, PbF₂.4H₂O, PbF₂.6H₂O, PbF₂.7H₂O, PbF₂.8H₂O, PbF₂.9H₂O, PbF₄.H₂O, PbF₄.4H₂O, PbI2.H₂O, PbI₂.2H₂O, PbI₂.6H₂O, PbI₂.7H₂O, PbI₂.8H₂O, PbI₂.9H₂O, PbI₄.H₂O, PbI₄.3H₂O, PbI₄.4H₂O, PbI₄.H₂O, PbI₄.9H₂O, RbBr.H₂O, RbBr₂H₂O, RbBr₃H₂O, RbCl.H₂O, RbCl_{.2}H₂O, RbCl_{.3}H₂O, RbF.3H₂O, RbIH₂O, RbI_{.2}H₂O, RbI_{.3}H₂O, ScBr₃.2H₂O, ScBr₃.3H₂O, ScBr₃.4H₂O, ScBr₃.7H₂O, ScBr₃.8H₂O, ScBr₃.10H₂O, ScCl₃⁻H₂O, ScCl₃.2H₂O, ScCl₃.4H₂O, ScCl₃.7H₂O, ScCl₃.H₂O, ScCl₃.H₂O, ScF₃.2H₂O, ScF₃.4H₂O, ScF₃.6H₂O, ScF₃.7H₂O, ScF₃.8H₂O, ScF₃.10H₂O, ScI₃.H₂O, ScI₃.H₂O, ScI₃.H₂O, ScI₃.7H₂O, ScI₃.H₂O, ScI₃.H₂O, SiBr₂.4H₂O, SiBr₂.9H₂O, SiBr₂.12H₂O, SiBr₄.3H₂O, SiBr₄.4H₂O, SiBr₄.5H₂O, SiCl₂.4H₂O, SiCl₂.7H₂O, SiCl₂.9H₂O, SiCl₂.12H₂O, SiCl₄.3H₂O, SiCl₄.4H₂O, SiCl₄.5H₂O, SiF₂.2H₂O, SiF₂.8H₂O, SiF₄.H₂O, SiF₄.3H₂O, SiF₄.4H₂O, SiF₄.9H₂O, SiI₂.4H₂O, SiI₂.6H₂O, SiI₂.9H₂O, SiI₂.12H₂O, SiI₄.8H₂O, SnBr₂.H₂O, SnBr₂.6H₂O, SnBr₂.8H₂O, SnBr₂.9H₂O, SnBr₄.2H₂O, SnBr₄.3H₂O, SnBr₄.4H₂O, SnBr₄.9H₂O, SnCl₂.H₂O, SnCl₂.6H₂O, SnCl₂.7H₂O, SnCl₂.8H₂O, SnCl₂.9H₂O, SnCl₄.H₂O, SnCl₄.2H₂O, SnF₂.H₂O, SnF₂.6H₂O, SnF₂.7H₂O, SnF₂.8H₂O, SnF₂.9H₂O, SnF₄.H₂O, SnF₄.3H₂O, SnF₄.4H₂O, SnF₄.9H₂O, SnI₂.H₂O, SnI₂.2H₂O, SnI₂.6H₂O, SnI₂.7H₂O, SnI₂.8H₂O, SnI₂.9H₂O, SnI₄.4H₂O, SnI₄.9H₂O, SrBr₂.4H₂O, SrBr₂.7H₂O, SrBr₂.8H₂O, SrBr₂.9H₂O, SrCl₂.4H₂O, SrCl₂.7H₂O, SrCl₂.8H₂O, SrCl₂.9H₂O, SrF₂.4H₂O, SrF₂.6H₂O, SrF₂.7H₂O, SrF₂.8H₂O, SrF₂.9H₂O, SrI₂.4H₂O, SrI₂.7H₂O, SrI₂.8H₂O, SrI₂.9H₂O, TaBr₃.H₂O, TaBr₃.2H₂O, TaBr₃.3H₂O, TaBr₃.4H₂O, TaBr₃.7H₂O, TaBr₃.8H₂O, TaBr₃.10H₂O, TaBr₄.2H₂O, TaBr₄.3H₂O, TaBr₄.4H₂O, TaBr₄.5H₂O, TaBr₄.9H₂O, TaCl₃.2H₂O, TaCl₃.H₂O, TaCl₃.H₂O, TaCl₃.6H₂O, TaCl₃.7H₂O, TaCl₃.H₂O, TaCl₃.H₂O, TaCl₄.2H₂O, TaCl₄.3H₂O, TaCl₄.4H₂O, TaCl₄.5H₂O, TaCl₄.9H₂O, TaF₃.9H₂O, TaF₃.10H₂O, TaF₄.2H₂O, TaF₄.3H₂O, TaF₄.4H₂O, TaF₄.9H₂O, TaI₃.H₂O, TaI₃.H₂O, TaI₃.7H₂O, TaI₃.H₂O, TaI₃.9H₂O, TaI₃.H₂O, TaI₄.2H₂O, TaI₄.3H₂O, TaI₄.4H₂O, TaI₄.5H₂O, TaI₄.9H₂O, TaI₄.10H₂O, TiBr₂.2H₂O, TiBr₂.4H₂O, TiBr₂.6H₂O, TiBr₂.7H₂O, TiBr₂.8H₂O, TiBr₂.9H₂O, TiBr₃.H₂O, TiBr₃.2H₂O, TiBr₃.3H₂O, TiBr₃.4H₂O, TiBr₃.7H₂O, TiBr₃.8H₂O, TiBr₃.10H₂O, TiBr₄.2H₂O, TiBr₄.3H₂O, TiBr₄.4H₂O, TiBr₄.5H₂O, TiBr₄.9H₂O, TiCl₂.2H₂O, TiCl₂.4H₂O, TiCl₂.6H₂O, TiCl₂.7H₂O, TiCl₂.8H₂O, TiCl₂.9H₂O, TiCl₃.H₂O, TiCl₃.2H₂O, TiCl₃.H₂O, TiCl₃.7H₂O, TiCl₃.H₂O, TiCl₃.H₂O, TiCl₄.2H₂O, TiCl₄.3H₂O, TiCl₄.4H₂O, TiCl₄.5H₂O, TiCl₄.9H₂O, TiF₂.4H₂O, TiF₂.6H₂O, TiF₂.8H₂O, TiF₂.9H₂O, TiF₃.2H₂O, TiF₃.6H₂O, TiF₃.7H₂O, TiF₃.8H₂O, TiF₄.H₂O, TiF₄.3H₂O, TiF₄.4H₂O, TiF₄.9H₂O, TiI₂.H₂O, TiI₂.2H₂O, TiI₂.4H₂O, TiI₂.6H₂O, TiI₂.7H₂O, TiI₂.8H₂O, TiI₂.9H₂O, TiI₃.2H₂O, TiI₃.3H₂O, TiI₃.4H₂O, TiI₃.7H₂O, TiI₃.8H₂O, TiI₃.H₂O, TiI₄.2H₂O, TiI₄.3H₂O, TiI₄.4H₂O, TiI₄.5H₂O, TiI₄.9H₂O, VBr₂.H₂O, VBr₂.7H₂O, VBr₂.8H₂O, VBr₂.9H₂O, VBr₃.H₂O, VBr₃.2H₂O, VBr₃.3H₂O, VBr₃.7H₂O, VBr₃.8H₂O, VBr₄.2H₂O, VBr₄.3H₂O, VBr₄.4H₂O, VBr₄.5H₂O, VCl₂.6H₂O, VCl₂.7H₂O, VCl₂.8H₂O, VCl₂.9H₂O, VCl₃.H₂O, VCl₃.2H₂O, VCl₃.7H₂O, VCl₃.H₂O, VCl₃.H₂O, VCl₄.2H₂O, VCl₄.3H₂O, VCl₄.4H₂O, VCl₄.5H₂O, VF₂.2H₂O, VF₂.6H₂O, VF₂.7H₂O, VF₂.8H₂O, VF₂.9H₂O, VF₃.4H₂O, VF₃.6H₂O, VF₄.H₂O, VF₄.3H₂O, VF₄.4H₂O, VI₂.H₂O, VI₂.2H₂O, VI₂.7H₂O, VI₂.8H₂O, VI₂.9H₂O, VI₃.2H₂O, VI₃.H₂O, VI₃.H₂O, VI₃.7H₂O, VI₃.H₂O, VI₃.H₂O, VI₄.2H₂O, VI₄.3H₂O, VI₄.4H₂O, VI₄.5H₂O, VI₄.9H₂O, WBr₄.2H₂O, WBr₄.3H₂O, WBr₄.5H₂O, WBr₄.9H₂O, WCl₄.2H₂O, WCl₄.3H₂O, WCl₄.4H₂O, WCl₄.5H₂O, WCl₄.9H₂O, WF₄.2H₂O, WF₄.3H₂O, WF₄.4H₂O, WI₄.2H₂O, WI₄.3H₂O, WI₄.4H₂O, WI₄.5H₂O, WI₄.9H₂O, YBr₃.H₂O, YBr₃.2H₂O, YBr₃.3H₂O, YBr₃.4H₂O, YBr₃.7H₂O, YBr₃.8H₂O, YBr₃.10H₂O, YCl₃.H₂O, YCl₃.2H₂O, YCl₃.H₂O, YCl₃.7H₂O, YCl₃.H₂O, YCl₃.H₂O, YF₃.H₂O, YF₃.2H₂O, YF₃.3H₂O, YF₃.4H₂O, YF₃.6H₂O, YF₃.7H₂O, YF₃.8H₂O, YF₃.10H₂O, YI₃.2H₂O, YI₃.3H₂O, YI₃.4H₂O, YI₃.10H₂O, ZnBr₂.H₂O, ZnBr₂.6H₂O, ZnBr₂.7H₂O, ZnBr₂.8H₂O, ZnBr₂.9H₂O, ZnCl₂.8H₂O, ZnCl₂.9H₂O, ZnF2.H₂O, ZnF₂.2H₂O, ZnF₂.6H₂O, ZnF₂.8H₂O, ZnF₂.9H₂O, ZnI2.H₂O, ZnI₂.4H₂O, ZnI₂.6H₂O, ZnI₂.8H₂O, ZnI₂.9H₂O, ZrBr₂.6H₂O, ZrBr₂.7H₂O, ZrBr₂.8H₂O, ZrBr₂.9H₂O, ZrBr₃.2H₂O, ZrBr₃.3H₂O, ZrBr₃.4H₂O, ZrBr₃.6H₂O, ZrBr₃.7H₂O, ZrBr₃.8H₂O, ZrBr₃.10H₂O, ZrBr₄.5H₂O, ZrBr₄.9H₂O, ZrBr₄.10H₂O, ZrCl₂.6H₂O, ZrCl₂.8H₂O, ZrCl₂.9H₂O, ZrCl₃.H₂O, ZrCl₃.2H₂O, ZrCl₃.H₂O, ZrCl₃.H₂O, ZrCl₃.6H₂O, ZrCl₃.7H₂O, ZrCl₃.H₂O, ZrCl₃.H₂O, ZrCl₄.5H₂O, ZrCl₄.9H₂O, ZrCl₄.10H₂O, ZrF₃.6H₂O, ZrF₃.7H₂O, ZrF₃.8H₂O, ZrF₃.10H₂O, ZrF₄.2H₂O, ZrF₄.4H₂O, ZrF₄.5H₂O, ZrF₄.9H₂O, ZrI₂.12H₂O, ZrI₃.H₂O, ZrI₃.H₂O, ZrI₃.6H₂O, ZrI₃.7H₂O, ZrI₃.H₂O, ZrI₃.H₂O, ZrI₄.3H₂O, ZrI₄.4H₂O, ZrI₄.5H₂O, ZrI₄.9H₂O, ZrI₄.10H₂O, and combinations thereof,
wherein the thermal energy storage material is configured to reversibly store heat in the thermal energy system (TES) via an endothermic dehydration reaction and to release heat in in the thermal energy system (TES) via an exothermic hydration reaction.

12. The thermal energy system (TES) of claim 11, wherein the salt hydrate has a volumetric energy density of greater than or equal to about 1.3 GJ/m³.

13. The thermal energy system (TES) of claim 11, wherein a temperature hysteresis of the endothermic dehydration reaction and the exothermic hydration reaction of the salt hydrate is less than or equal to about 50° C.

14. The thermal energy system (TES) of claim 11, wherein M is selected from the group consisting of: lithium (Li), sodium (Na), potassium (K), rubidium (Rb), cesium (Cs), beryllium (Be), magnesium (Mg), calcium (Ca), strontium (Sr), barium (Ba), scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), iron (Fe), cobalt (Co), nickel (Ni), copper (Cu), zinc (Zn), aluminum (Al), gallium (Ga), silicon (Si), germanium (Ge), tin (Sn), lead (Pb)), lanthanum (La), and combinations thereof and X is selected from the group consisting of: fluorine (F), chlorine (Cl), bromine (Br), iodine (I), and combinations thereof.

15. The thermal energy system (TES) of claim 11, wherein M is selected from the group consisting of lithium (Li), sodium (Na), beryllium (Be), magnesium (Mg), and aluminum (Al), X is a halide selected from the group consisting of: fluorine (F), chlorine (Cl) and bromine (Br).

16. The thermal energy system (TES) of claim 11, wherein X comprises fluorine (F), so that the metal hydrate is represented by the formula: MF_{q}.nH₂O.

17. The thermal energy system (TES) of claim 11, wherein the salt hydrate is selected from the group consisting of: AlBr₃.H₂O, AlBr₃.9H₂O, AlCl₃.H₂O, AlCl₃.9H₂O, AlF₃.9H₂O, AlI₃.6H₂O, AlI₃.9H₂O, BaBr₂.12H₂O, BaCl₂.12H₂O, BaF₂.2H₂O, BaF₂.12H₂O, BaI₂.12H₂O, BeBr₂.4H₂O, BeBr₂.9H₂O, BeCl₂.2H₂O, BeCl₂.4H₂O, BeCl₂.12H₂O, BeF₂.2H₂O, BeF₂.4H₂O, BeF₂.9H₂O, BeI₂.2H₂O, BeI₂.4H₂O, BeI₂.8H₂O, BeI₂.12H₂O, CaBr₂.H₂O, CaBr₂.2H₂O, CaBr₂.12H₂O, CaCl₂.12H₂O, CaF₂.12H₂O, CaI₂.2H₂O, CaI₂.12H₂O, CoBr₂.12H₂O, CoBr₃.6H₂O, CoBr₃.9H₂O, CoCl₂.12H₂O, CoCl₃.6H₂O, CoCl₃.9H₂O, CoF₂.4H₂O, CoF₂.12H₂O, CoF₃.3H₂O, CoF₃.9H₂O, CoI₂.12H₂O, CrBr₂.4H₂O, CrBr₂.12H₂O, CrBr₃.9H₂O, CrBr₄.8H₂O, CrCl₂.12H₂O, CrCl₃.9H₂O, CrCl₄.8H₂O, CrF₂.4H₂O, CrF₂.12H₂O, CrF₃.3H₂O, CrF₃.9H₂O, CrF₄.2H₂O, CrF₄.5H₂O, CrF₄.8H₂O, CrI₂.4H₂O, CrI₂.12H₂O, CrI₃.9H₂O, CrI_{4.}3H₂O, CrI₄.8H₂O, CsF.2H₂O, CsI.4H₂O, CuBr₂.12H₂O, CuCl₂.4H₂O, CuCl₂.12H₂O, CuF.H₂O, CuF.2H₂O, CuF₂.4H₂O, CuF₂.12H₂O, CuI₂.4H₂O, FeBr₃.H₂O, FeBr₃.9H₂O, FeCl₂.9H₂O, FeCl₃.H₂O, FeCl₃.H₂O, FeCl₃.9H₂O, FeF₂.12H₂O, FeF₃.H₂O, FeF₃.9H₂O, FeI₃.2H₂O, FeI₃.H₂O, GaBr₃.2H₂O, GaBr₃.9H₂O, GaCl₃.H₂O, GaCl₃.9H₂O, GaF₃.9H₂O, GaI₃.H₂O, GaI₃.9H₂O, GeBr₂.4H₂O, GeBr₂.12H₂O, GeCl₂.2H₂O, GeCl₂.4H₂O, GeCl₂.12H₂O, GeCl₄.8H₂O, GeF₂.2H₂O, GeF₂.4H₂O, GeF₂.12H₂O, GeF₄.2H₂O, GeF₄.5H₂O, GeF₄.8H₂O, GeI₂.4H₂O, GeI₂.12H₂O, GeI₄.H₂O, HfBr₃.9H₂O, HfBr₄.2H₂O, HfBr₄.3H₂O, HfBr₄.4H₂O, HfBr₄.8H₂O, HfCl₃.9H₂O, HfCl₄.2H₂O, HfCl₄.3H₂O, HfCl₄.4H₂O, HfCl₄.8H₂O, HfF₄.3H₂O, HfF₄.8H₂O, HfI₃.9H₂O, HfI₄.2H₂O, HfI₄.H₂O, KBr₄H₂O, KCl_{.4}H₂O, KI.4H₂O, LaBr₃.6H₂O, LaBr₃.9H₂O, LaCl₃.6H₂O, LaCl₃.9H₂O, LaF₃.9H₂O, LaI₂.12H₂O, LaI₃.6H₂O, LaI₃.9H₂O, LiBr₃H₂O, LiBr₄H₂O, LiCl_{.4}H₂O, LiF.4H₂O, MgBr₂.2H₂O, MgBr₂.12H₂O, MgCl₂.12H₂O, MgF₂.4H₂O, MgF₂.12H₂O, MgI₂.4H₂O, MgI₂.9H₂O, MgI₂.12H₂O, MnBr₂.12H₂O, MnBr₃.6H₂O, MnBr₄.8H₂O, MnCl₂.12H₂O, MnCl₃.6H₂O, MnCl₃.9H₂O, MnCl₄.4H₂O, MnCl₄.8H₂O, MnF₂.12H₂O, MnF₃.3H₂O, MnF₃.9H₂O, MnF₄.2H₂O, MnF₄.4H₂O, MnF₄.5H₂O, MnF₄.8H₂O, MnI₂.12H₂O, MnI₃.6H₂O, MnI₄.H₂O, MoBr₃.9H₂O, MoBr₄.8H₂O, MoCl₃.2H₂O, MoCl₃.9H₂O, MoCl₄.4H₂O, MoCl₄.8H₂O, MoF₂.H₂O, MoF₃.3H₂O, MoF₃.9H₂O, MoF₄.2H₂O, MoF₄.5H₂O, MoF₄.8H₂O, MoI₃.9H₂O, MoI₄.H₂O, NaBr.H₂O, NaBr₄H₂O, NaCl.H₂O, NaCl_{.2}H₂O, NaCl_{.4}H₂O, NaF.4H₂O, NbBr₃.6H₂O, NbBr₃.9H₂O, NbBr₄.8H₂O, NbCl₃.9H₂O, NbCl₄.8H₂O, NbF₃.H₂O, NbF₃.9H₂O, NbF₄.5H₂O, NbF₄.8H₂O, NbI₃.6H₂O, NbI₃.9H₂O, NbI₄.8H₂O, NiBr₂.12H₂O, NiBr₃.6H₂O, NiCl₂.12H₂O, NiCl₃.6H₂O, NiCl₃.9H₂O, NiF₂.2H₂O, NiF₂.12H₂O, NiF₃.2H₂O, NiF₃.3H₂O, NiF₃.9H₂O, NiI₂.12H₂O, PbBr₂.2H₂O, PbBr₂.4H₂O, PbBr₂.12H₂O, PbBr₄.8H₂O, PbCl₂.2H₂O, PbCl₂.4H₂O, PbCl₂.12H₂O, PbCl₄.3H₂O, PbCl₄.8H₂O, PbF₂.2H₂O, PbF₂.12H₂O, PbF₄.2H₂O, PbF₄.3H₂O, PbF₄.5H₂O, PbI₂.4H₂O, PbI₂.12H₂O, PbI₄.5H₂O, RbBr₄H₂O, RbCl_{.4}H₂O, RbF.2H₂O, RbF.4H₂O, RbI_{.4}H₂O, ScBr₃.6H₂O, ScBr₃.9H₂O, ScCl₃.H₂O, ScCl₃.9H₂O, ScF₃.3H₂O, ScF₃.9H₂O, ScI₃.6H₂O, ScI₃.9H₂O, SiBr₂.8H₂O, SiBr₄.8H₂O, SiBr₄.9H₂O, SiCl₂.8H₂O, SiCl₄.8H₂O, SiCl₄.9H₂O, SiF₄.2H₂O, SiF₄.5H₂O, SiF₄.8H₂O, SiI₂.8H₂O, SiI₄.9H₂O, SnBr₂.2H₂O, SnBr₂.4H₂O, SnBr₂.12H₂O, SnBr₄.5H₂O, SnCl₂.4H₂O, SnCl₂.12H₂O, SnCl₄.3H₂O, SnCl₄.4H₂O, SnCl₄.8H₂O, SnF₂.2H₂O, SnF₂.4H₂O, SnF₂.12H₂O, SnF₄.2H₂O, SnF₄.5H₂O, SnF₄.8H₂O, SnI₂.4H₂O, SnI₂.12H₂O, SnI₄.H₂O, SnI₄.2H₂O, SnI₄.3H₂O, SnI₄.5H₂O, SrBr₂.2H₂O, SrBr₂.12H₂O, SrCl₂.12H₂O, SrF₂.2H₂O, SrF₂.12H₂O, SrI₂.12H₂O, TaBr₃.6H₂O, TaBr₃.9H₂O, TaBr₄.8H₂O, TaCl₃.9H₂O, TaCl₄.8H₂O, TaF₃.H₂O, TaF₄.5H₂O, TaF₄.8H₂O, TaI₃.6H₂O, TaI₄.8H₂O, TiBr₂.H₂O, TiBr₂.12H₂O, TiBr₃.9H₂O, TiBr₄.8H₂O, TiCl₂.H₂O, TiCl₂.12H₂O, TiCl₃.H₂O, TiCl₃.9H₂O, TiCl₄.8H₂O, TiF₂.H₂O, TiF₂.12H₂O, TiF₃.3H₂O, TiF₃.9H₂O, TiF₄.5H₂O, TiF₄.8H₂O, TiI₂.12H₂O, TiI₃.6H₂O, TiI₃.9H₂O, TiI₄.8H₂O, VBr₂.12H₂O, VBr₃.9H₂O, VBr₄.8H₂O, VCl₂.H₂O, VCl₂.12H₂O, VCl₃.H₂O, VCl₃.9H₂O, VCl₄.8H₂O, VF₂.12H₂O, VF₃.9H₂O, VF₄.2H₂O, VF₄.5H₂O, VF₄.8H₂O, VI₂.12H₂O, VI₃.9H₂O, VI₄.8H₂O, WBr₄.8H₂O, WCl₄.8H₂O, WF₄.5H₂O, WF₄.8H₂O, WI₄.8H₂O, YBr₃.6H₂O, YBr₃.9H₂O, YCl₃.H₂O, YCl₃.9H₂O, YF₃.9H₂O, YI₃.6H₂O, YI₃.7H₂O, YI₃.8H₂O, YI₃.9H₂O, ZnBr₂.4H₂O, ZnBr₂.12H₂O, ZnCl₂.12H₂O, ZnF₂.12H₂O, ZnI₂.2H₂O, ZnI₁₂.12H₂O, ZrBr₂.H₂O, ZrBr₂.12H₂O, ZrBr₃.9H₂O, ZrBr₄.2H₂O, ZrBr₄.3H₂O, ZrBr₄.4H₂O, ZrBr₄.8H₂O, ZrCl₂.H₂O, ZrCl₂.12H₂O, ZrCl₃.9H₂O, ZrCl₄.2H₂O, ZrCl₄.3H₂O, ZrCl₄.4H₂O, ZrCl₄.8H₂O, ZrF₃.9H₂O, ZrF₄.8H₂O, ZrI₃.9H₂O, ZrI₄.2H₂O, ZrI₄.8H₂O, and combinations thereof.

18. The thermal energy system (TES) of claim 11, wherein the salt hydrate is selected from the group consisting of: AlBr₃.3H₂O, AlBr₃.4H₂O, AlBr₃.7H₂O, AlBr₃.8H₂O, AlBr₃.10H₂O, AlCl₃.2H₂O, AlCl₃.H₂O, AlCl₃.H₂O, AlCl₃.7H₂O, AlCl₃.H₂O, AlCl₃.H₂O, AlF₃.2H₂O, AlF₃.4H₂O, AlF₃.6H₂O, AlF₃.7H₂O, AlF₃.8H₂O, AlF₃.10H₂O, AlI₃.H₂O, AlI₃.2H₂O, AlI₃.3H₂O, AlI₃.4H₂O, AlI₃.7H₂O, AlI₃.8H₂O, AlI₃.10H₂O, BaBr₂.4H₂O, BaBr₂.6H₂O, BaBr₂.7H₂O, BaBr₂.8H₂O, BaBr₂.9H₂O, B aCl₂.4H₂O, B aCl₂.8H₂O, B aCl₂.9H₂O, B aF₂.H₂O, B aF₂.4H₂O, BaF₂.6H₂O, BaF₂.7H₂O, BaF₂.8H₂O, BaF₂.9H₂O, BaI₂.4H₂O, BaI₂.8H₂O, BaI₂.9H₂O, BeBr₂.H₂O, BeBr₂.2H₂O, BeBr₂.8H₂O, BeBr₂.12H₂O, BeCl₂.7H₂O, BeCl₂.8H₂O, BeCl₂.9H₂O, BeF₂.7H₂O, BeF₂.8H₂O, BeF₂.12H₂O, BeI₂.7H₂O, BeI₂.9H₂O, CaBr₂.7H₂O, CaBr₂.8H₂O, CaBr₂.9H₂O, CaCl₂.8H₂O, CaF₂.2H₂O, CaF₂.4H₂O, CaF₂.6H₂O, CaF₂.7H₂O, CaF₂.8H₂O, CaF₂.9H₂O, CaI2.H₂O, CaI₂.4H₂O, CaI₂.7H₂O, CaI₂.9H₂O, CoBr₂.H₂O, CoBr₂.2H₂O, CoBr₂.8H₂O, CoBr₂.9H₂O, CoBr₃.H₂O, CoBr₃.3H₂O, CoBr₃.4H₂O, CoBr₃.7H₂O, CoBr₃.10H₂O, CoCl₂.4H₂O, CoCl₂.7H₂O, CoCl₂.8H₂O, CoCl₂.9H₂O, CoCl₃.H₂O, CoCl₃.H₂O, CoCl₃.H₂O, CoCl₃.7H₂O, CoCl₃.H₂O, CoF₂.H₂O, CoF₂.2H₂O, CoF₂.8H₂O, CoF₂.9H₂O, CoF₃.2H₂O, CoF₃.4H₂O, CoF₃.6H₂O, CoF₃.7H₂O, CoF₃.8H₂O, CoF₃.10H₂O, CoI₂.H₂O, CoI₂.2H₂O, CoI₂.4H₂O, CoI₂.6H₂O, CoI₂.8H₂O, CoI₂.9H₂O, CoI₃.H₂O, CoI₃.6H₂O, CoI₃.7H₂O, CoI₃.9H₂O, CoI₃.H₂O, CrBr₂.H₂O, CrBr₂.2H₂O, CrBr₂.6H₂O, CrBr₂.7H₂O, CrBr₂.8H₂O, CrBr₂.9H₂O, CrBr₃.H₂O, CrBr₃.2H₂O, CrBr₃.3H₂O, CrBr₃.4H₂O, CrBr₃.6H₂O, CrBr₃.7H₂O, CrBr₃.8H₂O, CrBr₃.10H₂O, CrBr₄.2H₂O, CrBr₄.3H₂O, CrBr₄.4H₂O, CrBr₄.5H₂O, CrBr₄.9H₂O, CrCl₂.H₂O, CrCl₂.6H₂O, CrCl₂.7H₂O, CrCl₂.8H₂O, CrCl₂.9H₂O, CrCl₃.H₂O, CrCl₃.2H₂O, CrCl₃.H₂O, CrCl₃.H₂O, CrCl₃.6H₂O, CrCl₃.7H₂O, CrCl₃.H₂O, CrCl₄.2H₂O, CrCl₄.3H₂O, CrCl₄.4H₂O, CrCl₄.5H₂O, CrF2.H₂O, CrF₂.2H₂O, CrF₂.6H₂O, CrF₂.7H₂O, CrF₂.8H₂O, CrF₂.9H₂O, CrF₃.2H₂O, CrF₃.4H₂O, CrF₃.6H₂O, CrF₄.3H₂O, CrF₄.4H₂O, CrI₂.H₂O, CrI₂.2H₂O, CrI₂.6H₂O, CrI₂.7H₂O, CrI₂.8H₂O, CrI₂.9H₂O, CrI₃.H₂O, CrI₃.2H₂O, CrI₃.3H₂O, CrI₃.H₂O, CrI₃.6H₂O, CrI₃.7H₂O, CrI₃.8H₂O, CrI₃.10H₂O, CrI₄.2H₂O, CrI₄.4H₂O, CrI₄.5H₂O, CrI₄.9H₂O, CsF.3H₂O, CuBr.H₂O, CuBr₂H₂O, CuBr₃H₂O, CuBr₄H₂O, CuBr₂.2H₂O, CuBr₂.6H₂O, CuBr₂.7H₂O, CuBr₂.8H₂O, CuBr₂.9H₂O, CuCl_{.2}H₂O, CuCl_{.3}H₂O, CuCl_{.4}H₂O, CuCl₂.H₂O, CuCl₂.6H₂O, CuCl₂.7H₂O, CuCl₂.8H₂O, CuCl₂.9H₂O, CuF.3H₂O, CuF.4H₂O, CuF2.H₂O, CuF₂.6H₂O, CuF₂.8H₂O, CuF₂.9H₂O, CuI₂.2H₂O, CuI₂.6H₂O, CuI₂.8H₂O, CuI₂.9H₂O, CuI₂.12H₂O, FeBr₂.8H₂O, FeBr₂. 12H₂O, FeBr₃.3H₂O, FeBr₃.4H₂O, FeBr₃.7H₂O, FeBr₃.8H₂O, FeBr₃.10H₂O, FeCl₂.8H₂O, FeCl₂. 12H₂O, FeCl₃.H₂O, FeCl₃.H₂O, FeF2.H₂O, FeF₂.2H₂O, FeF₂.6H₂O, FeF₂.9H₂O, FeF₃.2H₂O, FeF₃.4H₂O, FeF₃.6H₂O, FeF₃.7H₂O, FeF₃.8H₂O, FeF₃.10H₂O, FeI₂.7H₂O, FeI₂.8H₂O, FeI₂. 12H₂O, FeI₃.H₂O, FeI₃.H₂O, FeI₃.6H₂O, FeI₃.7H₂O, FeI₃.H₂O, FeI₃.9H₂O, GaBr₃.H₂O, GaBr₃.3H₂O, GaBr₃.4H₂O, GaBr₃.6H₂O, GaBr₃.7H₂O, GaBr₃.8H₂O, GaBr₃.10H₂O, GaCl₃.2H₂O, GaCl₃.H₂O, GaCl₃.4H₂O, GaCl₃.6H₂O, GaCl₃.7H₂O, GaCl₃.8H₂O, GaCl₃.10H₂O, GaF₃.3H₂O, GaF₃.4H₂O, GaF₃.6H₂O, GaF₃.7H₂O, GaF₃.10H₂O, GaI₃.H₂O, GaI₃.H₂O, GaI₃.6H₂O, GaI₃.7H₂O, GaI₃.H₂O, GeBr₂.H₂O, GeBr₂.2H₂O, GeBr₂.6H₂O, GeBr₂.7H₂O, GeBr₂.8H₂O, GeBr₂.9H₂O, GeBr₄.3H₂O, GeBr₄.4H₂O, GeBr₄.5H₂O, GeBr₄.9H₂O, GeCl₂.H₂O, GeCl₂.6H₂O, GeCl₂.7H₂O, GeCl₂.8H₂O, GeCl₂.9H₂O, GeCl₄.3H₂O, GeCl₄.4H₂O, GeCl₄.5H₂O, GeCl₄.9H₂O, GeF₂.6H₂O, GeF₂.7H₂O, GeF₂.8H₂O, GeF₂.9H₂O, GeF₄.H₂O, GeF₄.3H₂O, GeF₄.4H₂O, GeF₄.9H₂O, GeI₂.H₂O, GeI₂.2H₂O, GeI₂.6H₂O, GeI₂.7H₂O, GeI₂.8H₂O, GeI₂.9H₂O, GeI₄.3H₂O, GeI₄.4H₂O, GeI₄.5H₂O, GeI₄.9H₂O, GeI₆H₂O, GeI₇H₂O, GeI₈H₂O, GeI₁₀H₂O, HfBr₄.5H₂O, HfBr₄.9H₂O, HfBr₄.10H₂O, HfCl₃.H₂O, HfCl₃.6H₂O, HfCl₃.7H₂O, HfCl₃.H₂O, HfCl₃.H₂O, HfCl₄.5H₂O, HfCl₄.9H₂O, HfCl₄.10H₂O, HfF₃.9H₂O, HfF₃.10H₂O, HfF₄.H₂O, HfF₄.2H₂O, HfF₄.4H₂O, HfF₄.5H₂O, HfF₄.9H₂O, HfI₃.6H₂O, HfI₃.7H₂O, HfI₃.H₂O, HfI₃.H₂O, HfI₄.3H₂O, HfI₄.4H₂O, HfI₄.5H₂O, HfI₄.9H₂O, HfI₄.10H₂O, KBr.H₂O, KBr₂H₂O, KBr₃H₂O, KCl.H₂O, KCl_{.2}H₂O, KCl_{.3}H₂O, KF.H₂O, KF.3H₂O, KI.H₂O, KI.2H₂O, KI.3H₂O, LaBr₂.9H₂O, LaBr₂.12H₂O, LaBr₃.H₂O, LaBr₃.2H₂O, LaBr₃.3H₂O, LaBr₃.4H₂O, LaBr₃.7H₂O, LaBr₃.8H₂O, LaBr₃.10H₂O, LaCl_{.2}H₂O, LaCl_{.3}H₂O, LaCl_{.4}H₂O, LaCl₂.12H₂O, LaCl₃.2H₂O, LaCl₃.H₂O, LaCl₃.H₂O, LaCl₃.H₂O, LaF₂.12H₂O, LaF₃.H₂O, LaF₃.3H₂O, LaF₃.4H₂O, LaF₃.6H₂O, LaF₃.7H₂O, LaF₃.8H₂O, LaF₃.10H₂O, LaI.4H₂O, LaI₂.7H₂O, LaI₂.8H₂O, LaI₂.9H₂O, LaI₃.H₂O, LaI₃.2H₂O, LaI₃.3H₂O, LaI₃.H₂O, LaI₃.7H₂O, LaI₃.8H₂O, LaI₃.10H₂O, LiF.H₂H, LiF.3H₂O, LiI.4H₂O, MgBr₂.7H₂O, MgBr₂.8H₂O, MgBr₂.9H₂O, MgCl₂.7H₂O, MgCl₂.8H₂O, MgF₂.H₂O, MgF₂.6H₂O, MgF₂.8H₂O, MgF₂.9H₂O, MgI₂.H₂O, MgI₂.6H₂O, MgI₂.8H₂O, MnBr₂.2H₂O, MnBr₂.7H₂O, MnBr₂.8H₂O, MnBr₂.9H₂O, MnBr₃.H₂O, MnBr₃.2H₂O, MnBr₃.3H₂O, MnBr₃.4H₂O, MnBr₃.7H₂O, MnBr₃.8H₂O, MnBr₃.9H₂O, MnBr₃.10H₂O, MnBr₄.2H₂O, MnBr₄.3H₂O, MnBr₄.4H₂O, MnBr₄.5H₂O, MnBr₄.9H₂O, MnCl₂.6H₂O, MnCl₂.8H₂O, MnCl₂.9H₂O, MnCl₃.H₂O, MnCl₃.2H₂O, MnCl₃.H₂O, MnCl₃.H₂O, MnCl₃.7H₂O, MnCl₃.H₂O, MnCl₄.2H₂O, MnCl₄.3H₂O, MnCl₄.5H₂O, MnCl₄.9H₂O, MnF₂.2H₂O, MnF₂.6H₂O, MnF₂.8H₂O, MnF₂.9H₂O, MnF₃.4H₂O, MnF₃.6H₂O, MnF₃.7H₂O, MnF₄.H₂O, MnF₄.3H₂O, MnF₄.9H₂O, MnI₂.6H₂O, MnI₂.7H₂O, MnI₂.8H₂O, MnI₂.9H₂O, MnI₃.H₂O, MnI₃.2H₂O, MnI₃.H₂O, MnI₃.4H₂O, MnI₃.7H₂O, MnI₃.H₂O, MnI₃.9H₂O, MnI₃.10H₂O, MnI₄.2H₂O, MnI₄.3H₂O, MnI₄.4H₂O, MnI₄.5H₂O, MoBr₂.12H₂O, MoBr₃.3H₂O, MoBr₃.4H₂O, MoBr₃.6H₂O, MoBr₃.7H₂O, MoBr₃.8H₂O, MoBr₃.10H₂O, MoBr₄.2H₂O, MoBr₄.3H₂O, MoBr₄.4H₂O, MoBr₄.5H₂O, MoBr₄.9H₂O, MoCl₂.12H₂O, MoCl₃.H₂O, MoCl₃.H₂O, MoCl₃.6H₂O, MoCl₃.7H₂O, MoCl₃.8H₂O, MoCl₃.10H₂O, MoCl₄.H₂O, MoCl₄.2H₂O, MoCl₄.3H₂O, MoCl₄.5H₂O, MoF₂.8H₂O, MoF₂.9H₂O, MoF₂.12H₂O, MoF₃.H₂O, MoF₃.2H₂O, MoF₃.4H₂O, MoF₃.6H₂O, MoF₃.7H₂O, MoF₃.8H₂O, MoF₃.10H₂O, MoF₄.3H₂O, MoF₄.4H₂O, MoF₄.9H₂O, MoI₂.12H₂O,₂O, MoI₃.3H₂O, MoI₃⁶41420, MoI₃⁶61420, MoI₃⁶71420, MoI₃.H₂O, MoI₃.10H₂O, MoI₄.2H₂O, MoI₄.3H₂O, MoI₄.4H₂O, MoI₄.5H₂O, MoI₄.9H₂O, NaBr₃H₂O, NaCl_{.3}H₂O, NaF.H₂O, NaF.2H₂O, NaF.3H₂O, NaI.H₂O, NaI.3H₂O, NaI.4H₂O, NbBr₃.2H₂O, NbBr₃.3H₂O, NbBr₃.4H₂O, NbBr₃.7H₂O, NbBr₃.8H₂O, NbBr₃.10H₂O, NbBr₄.2H₂O, NbBr₄.3H₂O, NbBr₄.4H₂O, NbBr₄.5H₂O, NbBr₄.9H₂O, NbCl₃.1420, NbCl₃.H₂O, NbCl₃.H₂O, NbCl₃.6H₂O, NbCl₃.7H₂O, NbCl₃.H₂O, NbCl₃.H₂O, NbCl₄.2H₂O, NbCl₄.3H₂O, NbCl₄.4H₂O, NbCl₄.5H₂O, NbCl₄.9H₂O, NbF₃.2H₂O, NbF₃.3H₂O, NbF₃.4H₂O, NbF₃.6H₂O, NbF₃.7H₂O, NbF₃.8H₂O, NbF₃.10H₂O, NbF₄.H₂O, NbF₄.2H₂O, NbF₄.3H₂O, NbF₄.4H₂O, NbF₄.9H₂O, NbI₃.2H₂O, NbI₃.H₂O, NbI₃.H₂O, NbI₃.7H₂O, NbI₃.H₂O, NbI₃.H₂O, NbI₄.2H₂O, NbI₄.3H₂O, NbI₄.4H₂O, NbI₄.5H₂O, NbI₄.9H₂O, NbI₄.10H₂O, NiBr₂.H₂O, NiBr₂.2H₂O, NiBr₂.4H₂O, NiBr₂.6H₂O, NiBr₂.7H₂O, NiBr₂.8H₂O, NiBr₂.9H₂O, NiBr₃.H₂O, NiBr₃.2H₂O, NiBr₃.3H₂O, NiBr₃.4H₂O, NiBr₃.7H₂O, NiBr₃.8H₂O, NiBr₃.9H₂O, NiBr₃.10H₂O, NiCl₂.H₂O, NiCl₂.7H₂O, NiCl₂.8H₂O, NiCl₂.9H₂O, NiCl₃.H₂O, NiCl₃.H₂O, NiCl₃.H₂O, NiCl₃.7H₂O, NiCl₃.H₂O, NiF₂.H₂O, NiF₂.6H₂O, NiF₂.7H₂O, NiF₂.8H₂O, NiF₂.9H₂O, NiF₃.4H₂O, NiF₃.6H₂O, NiF₃.10H₂O, NiI₂.H₂O, NiI₂.2H₂O, NiI₂.4H₂O, NiI₂.7H₂O, NiI₂.8H₂O, NiI₂.9H₂O, NiI₃.2H₂O, NiI₃.3H₂O, NiI₃.6H₂O, NiI₃.7H₂O, NiI₃.8H₂O, NiI₃.9H₂O, NiI₃.H₂O, PbBr₂.H₂O, PbBr₂.6H₂O, PbBr₂.7H₂O, PbBr₂.8H₂O, PbBr₂.9H₂O, PbBr₄.3H₂O, PbBr₄.4H₂O, PbBr₄.5H₂O, PbBr₄.9H₂O, PbCl₂.H₂O, PbCl₂.6H₂O, PbCl₂.7H₂O, PbCl₂.8H₂O, PbCl₂.9H₂O, PbCl₄.2H₂O, PbCl₄.4H₂O, PbCl₄.5H₂O, PbF₂.4H₂O, PbF₂.6H₂O, PbF₂.7H₂O, PbF₂.8H₂O, PbF₂.9H₂O, PbF₄.H₂O, PbF₄.4H₂O, PbI₂.H₂O, 3.H₂O, PbI₂.2H₂O, PbI₂.6H₂O, PbI₂.7H₂O, PbI₂.8H₂O, PbI₂.9H₂O, PbI₄.H₂O, PbI₄.3H₂O, PbI₄.4H₂O, PbI₄.H₂O, PbI₄.9H₂O, RbBr.H₂O, RbBr₂H₂O, RbBr₃H₂O, RbCl.H₂O, RbCl.2H₂O, RbCl.3H₂O, RbF.3H₂O, RbI.H₂O, RbI2H₂O, RbI3H₂O, ScBr₃.2H₂O, ScBr₃.3H₂O, ScBr₃.4H₂O, ScBr₃.7H₂O, ScBr₃.8H₂O, ScBr₃.10H₂O, ScCl₃.H₂O, ScCl₃.2H₂O, ScCl₃.H₂O, ScCl₃.7H₂O, ScCl₃.H₂O, ScCl₃.H₂O, ScF₃.2H₂O, ScF₃.4H₂O, ScF₃.6H₂O, ScF₃.7H₂O, ScF₃.8H₂O, ScF₃.10H₂O, ScI₃.H₂O, ScI₃.H₂O, ScI₃.H₂O, ScI₃.7H₂O, ScI₃.H₂O, ScI₃.10H₂O, SiBr₂.4H₂O, SiBr₂.9H₂O, SiBr₂.12H₂O, SiBr₄.3H₂O, SiBr₄.4H₂O, SiBr₄.5H₂O, SiCl₂.4H₂O, SiCl₂.7H₂O, SiCl₂.9H₂O, SiCl₂.12H₂O, SiCl₄.3H₂O, SiCl₄.4H₂O, SiCl₄.5H₂O, SiF₂.2H₂O, SiF₂.8H₂O, SiF₄.H₂O, SiF₄.3H₂O, SiF₄.4H₂O, SiF₄.9H₂O, SiI₂.4H₂O, SiI₂.6H₂O, SiI₂.9H₂O, SiI₂.12H₂O, SiI₄.H₂O, SnBr₂.H₂O, SnBr₂.6H₂O, SnBr₂.8H₂O, SnBr₂.9H₂O, SnBr₄.2H₂O, SnBr₄.3H₂O, SnBr₄.4H₂O, SnBr₄.9H₂O, SnCl₂.H₂O, SnCl₂.6H₂O, SnCl₂.7H₂O, SnCl₂.8H₂O, SnCl₂.9H₂O, SnCl₄.H₂O, SnCl₄.2H₂O, SnF₂.H₂O, SnF₂.6H₂O, SnF₂.7H₂O, SnF₂.8H₂O, SnF₂.9H₂O, SnF₄.H₂O, SnF₄.3H₂O, SnF₄.4H₂O, SnF₄.9H₂O, SnI₂.H₂O, SnI₂.2H₂O, SnI₂.6H₂O, SnI₂.7H₂O, SnI₂.8H₂O, SnI₂.9H₂O, SnI₄.4H₂O, SnI₄.9H₂O, SrBr₂.4H₂O, SrBr₂.7H₂O, SrBr₂.8H₂O, SrBr₂.9H₂O, SrCl₂.4H₂O, SrCl₂.7H₂O, SrCl₂.8H₂O, SrCl₂.9H₂O, SrF₂.4H₂O, SrF₂.6H₂O, SrF₂.7H₂O, SrF₂.8H₂O, SrF₂.9H₂O, SrI_{2.6}H₂O, SrI_{2.}12⁶7H₂O, SrI₂.8H₂O, SrI₂.9H₂O, TaBr₃.H₂O, TaBr₃.2H₂O, TaBr₃.3H₂O, TaBr₃.4H₂O, TaBr₃.7H₂O, TaBr₃.8H₂O, TaBr₃.10H₂O, TaBr₄.2H₂O, TaBr₄.3H₂O, TaBr₄.4H₂O, TaBr₄.5H₂O, TaBr₄.9H₂O, TaCl₃.2H₂O, TaCl₃.H₂O, TaCl₃.H₂O, TaCl₃.6H₂O, TaCl₃.7H₂O, TaCl₃.H₂O, TaCl₃.H₂O, TaCl₄.2H₂O, TaCl₄.3H₂O, TaCl₄.4H₂O, TaCl₄.5H₂O, TaCl₄.9H₂O, TaF₃.9H₂O, TaF₃.10H₂O, TaF₄.2H₂O, TaF₄.3H₂O, TaF₄.4H₂O, TaF₄.9H₂O, TaI₃.H₂O, TaI₃.H₂O, TaI₃.7H₂O, TaI₃.H₂O, TaI₃.9H₂O, TaI₃.10H₂O, TaI₄.2H₂O, TaI₄.3H₂O, TaI₄.4H₂O, TaI₄.5H₂O, TaI₄.9H₂O, TaI₄.10H₂O, TiBr₂.2H₂O, TiBr₂.4H₂O, TiBr₂.6H₂O, TiBr₂.7H₂O, TiBr₂.8H₂O, TiBr₂.9H₂O, TiBr₃.H₂O, TiBr₃.2H₂O, TiBr₃.3H₂O, TiBr₃.4H₂O, TiBr₃.7H₂O, TiBr₃.8H₂O, TiBr₃.10H₂O, TiBr₄.2H₂O, TiBr₄.3H₂O, TiBr₄.4H₂O, TiBr₄.5H₂O, TiBr₄.9H₂O, TiCl₂.2H₂O, TiCl₂.4H₂O, TiCl₂.6H₂O, TiCl₂.7H₂O, TiCl₂.8H₂O, TiCl₂.9H₂O, TiCl₃.H₂O, TiCl₃.2H₂O, TiCl₃.H₂O, TiCl₃.7H₂O, TiCl₃.H₂O, TiCl₃.H₂O, TiCl₄.2H₂O, TiCl₄.3H₂O, TiCl₄.4H₂O, TiCl₄.5H₂O, TiCl₄.9H₂O, TiF₂.4H₂O, TiF₂.6H₂O, TiF₂.8H₂O, TiF₂.9H₂O, TiF₃.2H₂O, TiF₃.6H₂O, TiF₃.7H₂O, TiF₃.8H₂O, TiF₄.H₂O, TiF₄.3H₂O, TiF₄.4H₂O, TiF₄.9H₂O, TiI₂.H₂O, TiI₂.2H₂O, TiI₂.4H₂O, TiI₂.6H₂O, TiI₂.7H₂O, TiI₂.8H₂O, TiI₂.9H₂O, TiI₃.2H₂O, TiI₃.3H₂O, TiI₃.4H₂O, TiI₃.7H₂O, TiI₃.8H₂O, TiI₃.H₂O, TiI₄.2H₂O, TiI₄.3H₂O, TiI₄.4H₂O, TiI₄.5H₂O, TiI₄.9H₂O, VBr₂.H₂O, VBr₂.7H₂O, VBr₂.8H₂O, VBr₂.9H₂O, VBr₃.H₂O, VBr₃.2H₂O, VBr₃.3H₂O, VBr₃.7H₂O, VBr₃.8H₂O, VBr₄.2H₂O, VBr₄.3H₂O, VBr₄.4H₂O, VBr₄.5H₂O, VCl₂.6H₂O, VCl₂.7H₂O, VCl₂.8H₂O, VCl₂.9H₂O, VCl₃.H₂O, VCl₃.2H₂O, VCl₃.7H₂O, VCl₃.H₂O, VCl₃.H₂O, VCl₄.2H₂O, VCl₄.3H₂O, VCl₄.4H₂O, VCl₄.5H₂O, VF₂.2H₂O, VF₂.6H₂O, VF₂.7H₂O, VF₂.8H₂O, VF₂.9H₂O, VF₃.4H₂O, VF₃.6H₂O, VF₄.H₂O, VF₄.3H₂O, VF₄.4H₂O, VI₂.H₂O,VI₂.2H₂O, VI₂.7H₂O, VI₂⁶.8H₂O, VI₂.9H₂O, VI₃⁶2H₂O, VI₃⁶3H₂O, VI₃.6H₂O, VI₃.7H₂O, VI₃.H₂O, VI₃.H₂O, VI₄.2H₂O, VI₄.3H₂O, VI₄.4H₂O, VI₄.5H₂O, VI₄.9H₂O, WBr₄.2H₂O, WBr₄.3H₂O, WBr₄.5H₂O, WBr₄.9H₂O, WCl₄.2H₂O, WCl₄.3H₂O, WCl₄.4H₂O, WCl₄.5H₂O, WCl₄.9H₂O, WF₄.2H₂O, WF₄.3H₂O, WF₄.4H₂O, WI₄.2H₂O, WI₄.3H₂O, WI₄.4H₂O, WI₄.5H₂O, WI₄.9H₂O, YBr₃.H₂O, YBr₃.2H₂O, YBr₃.3H₂O, YBr₃.4H₂O, YBr₃.7H₂O, YBr₃.8H₂O, YBr₃.10H₂O, YCl₃.H₂O, YCl₃.2H₂O, YCl₃.H₂O, YCl₃.7H₂O, YCl₃.H₂O, YCl₃.H₂O, YF₃.H₂O, YF₃.2H₂O, YF₃.3H₂O, YF₃.4H₂O, YF₃.6H₂O, YF₃.7H₂O, YF₃.8H₂O, YF₃.10H₂O, YI₃.2H₂O, YI₃.3H₂O, YI₃.4H₂O, YI₃.10H₂O, ZnBr₂.H₂O, ZnBr₂.6H₂O, ZnBr₂.7H₂O, ZnBr₂.8H₂O, ZnBr₂.9H₂O, ZnCl₂.8H₂O, ZnCl₂.9H₂O, ZnF2.H₂O, ZnF₂.2H₂O, ZnF₂.6H₂O, ZnF₂.8H₂O, ZnF₂.9H₂O, ZnI2.H₂O, ZnI₂.4H₂O, ZnI₂.6H₂O, ZnI₂.8H₂O, ZnI₂.9H₂O, ZrBr₂.6H₂O, ZrBr₂.7H₂O, ZrBr₂.8H₂O, ZrBr₂.9H₂O, ZrBr₃.2H₂O, ZrBr₃.3H₂O, ZrBr₃.4H₂O, ZrBr₃.6H₂O, ZrBr₃.7H₂O, ZrBr₃.8H₂O, ZrBr₃.10H₂O, ZrBr₄.5H₂O, ZrBr₄.9H₂O, ZrBr₄.10H₂O, ZrCl₂.6H₂O, ZrCl₂.8H₂O, ZrCl₂.9H₂O, ZrCl₃.H₂O, ZrCl₃.2H₂O, ZrCl₃.H₂O, ZrCl₃.H₂O, ZrCl₃.6H₂O, ZrCl₃.7H₂O, ZrCl₃.H₂O, ZrCl₃.H₂O, ZrCl₄.5H₂O, ZrCl₄.9H₂O, ZrCl₄.10H₂O, ZrF₃.6H₂O, ZrF₃.7H₂O, ZrF₃.8H₂O, ZrF₃.10H₂O, ZrF₄.2H₂O, ZrF₄.4H₂O, ZrF₄.5H₂O, ZrF₄.9H₂O, ZrI₂.12H₂O, ZrI₃.H₂O, ZrI₃.H₂O, ZrI₃.6H₂O, ZrI₃.7H₂O, ZrI₃.H₂O, ZrI₃.H₂O, ZrI₄.3H₂O, ZrI₄.4H₂O, ZrI₄.5H₂O, ZrI₄.9H₂O, Zr4.10H₂O, and combinations thereof.

19. The thermal energy system (TES) of claim 11, wherein the salt hydrate is selected from the group consisting of: CaF₂.12H₂O, LiF₂.4H₂O, TiF₂.12H₂O, MgF₂.12H₂O, MnF₂.12H₂O, SiF₄.5H₂O, CoF₃.3H₂O, NiF₃.3H₂O, CuF.H₂O, TiF₂.H₂O, FeF₃.H₂O, and combinations thereof.

20. The thermal energy system (TES) of claim 11, wherein at least one of the endothermic dehydration reaction and the exothermic hydration reaction occurs in a temperature range of greater than or equal to about 450° C. to less than or equal to about 600° C. and the salt hydrate comprises one or more of CuF.H₂O, TiF₂.H₂O, and FeF₃.H₂O.

21. The thermal energy system (TES) of claim 11, wherein at least one of the endothermic dehydration reaction and the exothermic hydration reaction occurs in a temperature range of greater than or equal to about 300° C. to less than or equal to about 450° C. and the salt hydrate comprises one or more of CoF₃.3H₂O and NiF₃.3H₂O.

22. The thermal energy system (TES) of claim 11, wherein at least one of the endothermic dehydration reaction and the exothermic hydration reaction occurs in a temperature range of greater than or equal to about 200° C. to less than or equal to about 300° C. and the salt hydrate comprises SiF₄.5H₂O.

23. The thermal energy system (TES) of claim 11, wherein at least one of the endothermic dehydration reaction and the exothermic hydration reaction occurs in a temperature range of greater than or equal to about 100° C. to less than or equal to about 200° C. and the salt hydrate comprises one or more of MgF₂.12H₂O and MnF₂.12H₂O.

24. The thermal energy system (TES) of claim 11, wherein at least one of the endothermic dehydration reaction and the exothermic hydration reaction occurs in a temperature range of greater than or equal to about 50° C. to less than or equal to about 100° C. and the salt hydrate comprises one or more of CaF₂.12H₂O, LiF.4H₂O, and TiF₂.12H₂O.

25. A vehicle including the thermal energy system (TES) of claim 11.

26. A method of operating a thermal energy system (TES) comprising:
reversibly storing heat in a thermal energy storage material comprising a salt hydrate via an endothermic dehydration reaction, wherein the a thermal energy storage material comprising a salt hydrate that is represented by the formula: MX_{q}.nH₂O, where M is a cation selected from Groups 1.14 of the IUPAC Periodic Table, X is a halide of Group 17 of the IUPAC Periodic Table, q ranges from 1 to 4, and n ranges from 1 to 12, wherein the salt hydrate is selected from the group consisting of: AlBr₃.H₂O, AlBr₃.9H₂O, AlCl₃.H₂O, AlCl₃.9H₂O, AlF₃.9H₂O, AlI₃.6H₂O, AlI₃.9H₂O, BaBr₂.12H₂O, B aCl₂.12H₂O, BaF₂.2H₂O, BaF₂.12H₂O, BaI₂.12H₂O, BeBr₂.4H₂O, BeBr₂.9H₂O, BeCl₂.2H₂O, BeCl₂.4H₂O, BeCl₂.12H₂O, BeF₂.2H₂O, BeF₂.4H₂O, BeF₂.9H₂O, BeI₂.2H₂O, BeI₂.4H₂O, BeI₂.8H₂O, BeI₂.12H₂O, CaBr₂.H₂O, CaBr₂.2H₂O, CaBr₂.12H₂O, CaCl₂.12H₂O, CaF₂.12H₂O, CaI₂.2H₂O, CaI₂.12H₂O, COBr₂.12H₂O, CoBr₃.6H₂O, CoBr₃.9H₂O, CoCl₂.12H₂O, CoCl₃.6H₂O, CoCl₃.9H₂O, CoF₂.4H₂O, CoF₂.12H₂O, CoF₃.3H₂O, CoF₃.9H₂O, CoI₂.12H₂O, CrBr₂.4H₂O, CrBr₂.12H₂O, CrBr₃.9H₂O, CrBr₄.8H₂O, CrCl₂.12H₂O, CrCl₃.9H₂O, CrCl₄.8H₂O, CrF₂.4H₂O, CrF₂.12H₂O, CrF₃.3H₂O, CrF₃.9H₂O, CrF₄.2H₂O, CrF₄.5H₂O, CrF₄.8H₂O, CrI₂.4H₂O, CrI₂.12H₂O, CrI₃.9H₂O, CrI₄.3H₂O, CrI₄.8H₂O, CsF.2H₂O, CsI.4H₂O, CuBr₂.12H₂O, CuCl₂.4H₂O, CuCl₂.12H₂O, CuF.H₂O, CuF.2H₂O, CuF₂.4H₂O, CuF₂.12H₂O, CuI₂.4H₂O, FeBr₃.H₂O, FeBr₃.9H₂O, FeCl₂.9H₂O, FeCl₃.H₂O, FeCl₃.H₂O, FeCl₃.9H₂O, FeF₂.12H₂O, FeF₃.H₂O, FeF₃.9H₂O, FeI₃.2H₂O, FeI₃.3H₂O, GaBr₃.2H₂O, GaBr₃.9H₂O, GaCl₃.H₂O, GaCl₃.9H₂O, GaF₃.9H₂O, GaI₃.H₂O, GaI₃.9H₂O, GeBr₂.4H₂O, GeBr₂.12H₂O, GeCl₂.2H₂O, GeCl₂.4H₂O, GeCl₂.12H₂O, GeCl₄.8H₂O, GeF₂.2H₂O, GeF₂.4H₂O, GeF₂.12H₂O, GeF₄.2H₂O, GeF₄.5H₂O, GeF₄.8H₂O, GeI₂.4H₂O, GeI₂.12H₂O, GeI₄.H₂O, HfBr₃.9H₂O, HfBr₄.2H₂O, HfBr₄.3H₂O, HfBr₄.4H₂O, HfBr₄.8H₂O, HfCl₃.9H₂O, HfCl₄.2H₂O, HfCl₄.3H₂O, HfCl₄.4H₂O, HfCl₄.8H₂O, HfF₄.3H₂O, HfF₄.8H₂O, HfI₃.9H₂O, HfI₄.2H₂O, HfI₄.H₂O, KBr₄H₂O, KCl.4H₂O, KI.4H₂O, LaBr₃.6H₂O, LaBr₃.9H₂O, LaCl₃.6H₂O, LaCl₃.9H₂O, LaF₃.9H₂O, LaI₂.12H₂O, LaI₃.6H₂O, LaI₃.9H₂O, LiBr₃H₂O, LiBr₄H₂O, LiCl_{.4}H₂O, LiF.4H₂O, MgBr₂.2H₂O, MgBr₂.12H₂O, MgCl₂.12H₂O, MgF₂.4H₂O, MgF₂.12H₂O, MgI₂.4H₂O, MgI₂.9H₂O, MgI₂.12H₂O, MnBr₂.12H₂O, MnBr₃.6H₂O, MnBr₄.8H₂O, MnCl₂.12H₂O, MnCl₃.6H₂O, MnCl₃.9H₂O, MnCl₄.4H₂O, MnCl₄.8H₂O, MnF₂.12H₂O, MnF₃.3H₂O, MnF₃.9H₂O, MnF₄.2H₂O, MnF₄.4H₂O, MnF₄.5H₂O, MnF₄.8H₂O, MnI₂.12H₂O, MnI₃.6H₂O, MnI₄.H₂O, MoBr₃.9H₂O, MoBr₄.8H₂O, MoCl₃.2H₂O, MoCl₃.9H₂O, MoCl₄.4H₂O, MoCl₄.8H₂O, MoF₂.H₂O, MoF₃.3H₂O, MoF₃.9H₂O, MoF₄.2H₂O, MoF₄.5H₂O, MoF₄.8H₂O, MoI₃.9H₂O, MoI₄.H₂O, NaBr.H₂O, NaBr₄H₂O, NaCl.H₂O, NaCl_{.2}H₂O, NaCl_{.4}H₂O, NaF.4H₂O, NbBr₃.6H₂O, NbBr₃.9H₂O, NbBr₄.8H₂O, NbCl₃.9H₂O, NbCl₄.8H₂O, NbF₃.H₂O, NbF₃.9H₂O, NbF₄.5H₂O, NbF₄.8H₂O, NbI₃.6H₂O, NbI₃.9H₂O, NbI₄.8H₂O, NiBr₂.12H₂O, NiBr₃.6H₂O, NiCl₂.12H₂O, NiCl₃.6H₂O, NiCl₃.9H₂O, NiF₂.2H₂O, NiF₂.12H₂O, NiF₃.2H₂O, NiF₃.3H₂O, NiF₃.9H₂O, NiI₂.12H₂O, PbBr₂.2H₂O, PbBr₂.4H₂O, PbBr₂.12H₂O, PbBr₄.8H₂O, PbCl₂.2H₂O, PbCl₂.4H₂O, PbCl₂.12H₂O, PbCl₄.3H₂O, PbCl₄.8H₂O, PbF₂.2H₂O, PbF₂.12H₂O, PbF₄.2H₂O, PbF₄.3H₂O, PbF₄.5H₂O, PbI₂.4H₂O, PbI₂.12H₂O, PbI₄.5H₂O, RbBr₄H₂O, RbCl_{.4}H₂O, RbF.2H₂O, RbF.4H₂O, RbI4H₂O, ScBr₃.6H₂O, ScBr₃.9H₂O, ScCl₃.H₂O, ScCl₃.9H₂O, ScF₃.3H₂O, ScF₃.9H₂O, ScI₃.6H₂O, ScI₃.9H₂O, SiBr₂.8H₂O, SiBr₄.8H₂O, SiBr₄.9H₂O, SiCl₂.8H₂O, SiCl₄.8H₂O, SiCl₄.9H₂O, SiF₄.2H₂O, SiF₄.5H₂O, SiF₄.8H₂O, SiI₂.8H₂O, SiI₄.9H₂O, SnBr₂.2H₂O, SnBr₂.4H₂O, SnBr₂.12H₂O, SnBr₄.5H₂O, SnCl₂.4H₂O, SnCl₂.12H₂O, SnCl₄.3H₂O, SnCl₄.4H₂O, SnCl₄.8H₂O, SnF₂.2H₂O, SnF₂.4H₂O, SnF₂.12H₂O, SnF₄.2H₂O, SnF₄.5H₂O, SnF₄.8H₂O, SnI₂.4H₂O, SnI₂.12H₂O, SnI₄.H₂O, SnI₄.2H₂O, SnI₄.3H₂O, SnI₄.5H₂O, SrBr₂.2H₂O, SrBr₂.12H₂O, SrCl₂.12H₂O, SrF₂.2H₂O, SrF₂.12H₂O, SrI₂.12H₂O, TaBr₃.6H₂O, TaBr₃.9H₂O, TaBr₄.8H₂O, TaCl₃.9H₂O, TaCl₄.8H₂O, TaF₃.H₂O, TaF₄.5H₂O, TaF₄.8H₂O, TaI₃.6H₂O, TaI₄.8H₂O, TiBr₂.H₂O, TiBr₂.12H₂O, TiBr₃.9H₂O, TiBr₄.8H₂O, TiCl₂.H₂O, TiCl₂.12H₂O, TiCl₃.H₂O, TiCl₃.9H₂O, TiCl₄.8H₂O, TiF₂.H₂O, TiF₂.12H₂O, TiF₃.3H₂O, TiF₃.9H₂O, TiF₄.5H₂O, TiF₄.8H₂O, TiI₂.12H₂O, TiI₃.6H₂O, TiI₃.9H₂O, TiI₄.8H₂O, VBr₂.12H₂O, VBr₃.9H₂O, VBr₄.8H₂O, VCl₂.H₂O, VCl₂.12H₂O, VCl₃.H₂O, VCl₃.9H₂O, VCl₄.8H₂O, VF₂.12H₂O, VF₃.9H₂O, VF₄.2H₂O, VF₄.5H₂O, VF₄.8H₂O, VI₂.12H₂O, VI₃.9H₂O, VI₄.8H₂O, WBr₄.8H₂O, WCl₄.8H₂O, WF₄.5H₂O, WF₄.8H₂O, WI₄.8H₂O, YBr₃.6H₂O, YBr₃.9H₂O, YCl₃.H₂O, YCl₃.9H₂O, YF₃.9H₂O, YI₃.6H₂O, YI₃.7H₂O, YI₃.8H₂O, YI₃.9H₂O, ZnBr₂.4H₂O, ZnBr₂.12H₂O, ZnCl₂.12H₂O, ZnF₂.12H₂O, ZnI₂.2H₂O, ZnI₂.12H₂O, ZrBr₂.H₂O, ZrBr₂.12H₂O, ZrBr₃.9H₂O, ZrBr₄.2H₂O, ZrBr₄.3H₂O, ZrBr₄.4H₂O, ZrBr₄.8H₂O, ZrCl₂.H₂O, ZrCl₂.12H₂O, ZrCl₃.9H₂O, ZrCl₄.2H₂O, ZrCl₄.3H₂O, ZrCl₄.4H₂O, ZrCl₄.8H₂O, ZrF₃.9H₂O, ZrF₄.8H₂O, ZrI₃.9H₂O, ZrI₄.2H₂O, ZrI₄.8H₂O, AIBr₃.3H₂O, AIBr₃.4H₂O, AIBr₃.7H₂O, AIBr₃.8H₂O, AlBr₃.10H₂O, AlCl₃.2H₂O, AlCl₃.H₂O, AlCl₃.H₂O, AlCl₃.7H₂O, AlCl₃.H₂O, AlCl₃.H₂O, AlF₃.2H₂O, AlF₃.4H₂O, AlF₃.6H₂O, AlF₃.7H₂O, AlF₃.8H₂O, AlF₃.10H₂O, AlI₃.H₂O, AlI₃.2H₂O, AlI₃.3H₂O, AlI₃.4H₂O, AlI₃.7H₂O, AlI₃.8H₂O, AlI₃.10H₂O, BaBr₂.4H₂O, BaBr₂.6H₂O, BaBr₂.7H₂O, BaBr₂.8H₂O, BaBr₂.9H₂O, B aCl₂.4H₂O, B aCl₂.8H₂O, B aCl₂.9H₂O, B aF₂.H₂O, BaF₂.4H₂O, BaF₂.6H₂O, BaF₂.7H₂O, BaF₂.8H₂O, BaF₂.9H₂O, BaI₂.4H₂O, BaI₂.8H₂O, BaI₂.9H₂O, BeBr₂.H₂O, BeBr₂.2H₂O, BeBr₂.8H₂O, BeBr₂.12H₂O, BeCl₂.7H₂O, BeCl₂.8H₂O, BeCl₂.9H₂O, BeF₂.7H₂O, BeF₂.8H₂O, BeF₂.12H₂O, BeI₂.7H₂O, BeI₂.9H₂O, CaBr₂.7H₂O, CaBr₂.8H₂O, CaBr₂.9H₂O, CaCl₂.8H₂O, CaF₂.2H₂O, CaF₂.4H₂O, CaF₂.6H₂O, CaF₂.7H₂O, CaF₂.8H₂O, CaF₂.9H₂O, CaI2.H₂O, CaI₂.4H₂O, CaI₂.7H₂O, CaI₂.9H₂O, CoBr₂.H₂O, CoBr₂.2H₂O, CoBr₂.8H₂O, CoBr₂.9H₂O, CoBr₃.H₂O, CoBr₃.3H₂O, CoBr₃.4H₂O, CoBr₃.7H₂O, CoBr₃.10H₂O, CoCl₂.4H₂O, CoCl₂.7H₂O, CoCl₂.8H₂O, CoCl₂.9H₂O, CoCl₃.H₂O, CoCl₃.H₂O, CoCl₃.H₂O, CoCl₃.7H₂O, CoCl₃.H₂O, CoF₂.H₂O, CoF₂.2H₂O, CoF₂.8H₂O, CoF₂.9H₂O, CoF₃.2H₂O, CoF₃.4H₂O, CoF₃.6H₂O, CoF₃.7H₂O, CoF₃.8H₂O, CoF₃.10H₂O, CoI₂.H₂O, CoI₂.2H₂O, CoI₂.4H₂O, CoI₂.6H₂O, CoI₂.8H₂O, CoI₂.9H₂O, CoI₃.H₂O, CoI₃.6H₂O, CoI₃.7H₂O, CoI₃.9H₂O, CoI₃.H₂O, CrBr₂.H₂O, CrBr₂.2H₂O, CrBr₂.6H₂O, CrBr₂.7H₂O, CrBr₂.8H₂O, CrBr₂.9H₂O, CrBr₃.H₂O, CrBr₃.2H₂O, CrBr₃.3H₂O, CrBr₃.4H₂O, CrBr₃.6H₂O, CrBr₃.7H₂O, CrBr₃.8H₂O, CrBr₃.10H₂O, CrBr₄.2H₂O, CrBr₄.3H₂O, CrBr₄.4H₂O, CrBr₄.5H₂O, CrBr₄.9H₂O, CrCl₂.H₂O, CrCl₂.6H₂O, CrCl₂.7H₂O, CrCl₂.8H₂O, CrCl₂.9H₂O, CrCl₃.H₂O, CrCl₃.2H₂O, CrCl₃.H₂O, CrCl₃.H₂O, CrCl₃.6H₂O, CrCl₃.7H₂O, CrCl₃.H₂O, CrCl₄.2H₂O, CrCl₄.3H₂O, CrCl₄.4H₂O, CrCl₄.5H₂O, CrF2.H₂O, CrF₂.2H₂O, CrF₂.6H₂O, CrF₂.7H₂O, CrF₂.8H₂O, CrF₂.9H₂O, CrF₃.2H₂O, CrF₃.4H₂O, CrF₃.6H₂O, CrF₄.3H₂O, CrF₄.4H₂O, CrI₂.H₂O, CrI₂.2H₂O, CrI₂.6H₂O, CrI₂.7H₂O, CrI₂.8H₂O, CrI₂.9H₂O, CrI₃.H₂O, CrI₃.2H₂O, CrI₃.3H₂O, CrI₃.H₂O, CrI₃.6H₂O, CrI₃.7H₂O, CrI₃.8H₂O, CrI₃.10H₂O, CrI₄.2H₂O, CrI₄.4H₂O, CrI₄.5H₂O, CrI₄.9H₂O, CsF.3H₂O, CuBr.H₂O, CuBr₂H₂O, CuBr₃H₂O, CuBr₄H₂O, CuBr₂.2H₂O, CuBr₂.6H₂O, CuBr₂.7H₂O, CuBr₂.8H₂O, CuBr₂.9H₂O, CuCl_{.2}H₂O, CuCl_{.3}H₂O, CuCl_{.4}H₂O, CuCl₂.H₂O, CuCl₂.6H₂O, CuCl₂.7H₂O, CuCl₂.8H₂O, CuCl₂.9H₂O, CuF.3H₂O, CuF.4H₂O, CuF2.H₂O, CuF₂.6H₂O, CuF₂.8H₂O, CuF₂.9H₂O, CuI₂.2H₂O, CuI₂.6H₂O, CuI₂.8H₂O, CuI₂.9H₂O, CuI₂.12H₂O, FeBr₂.8H₂O, FeBr₂.12H₂O, FeBr₃.3H₂O, FeBr₃.4H₂O, FeBr₃.7H₂O, FeBr₃.8H₂O, FeBr₃.10H₂O, FeCl₂.8H₂O, FeCl₂.12H₂O, FeCl₃.H₂O, FeCl₃.H₂O, FeF2.H₂O, FeF₂.2H₂O, FeF₂.6H₂O, FeF₂.9H₂O, FeF₃.2H₂O, FeF₃.4H₂O, FeF₃.6H₂O, FeF₃.7H₂O, FeF₃.8H₂O, FeF₃.10H₂O, FeI₂.7H₂O, FeI₂.8H₂O, FeI₂.12H₂O, FeI₃.H₂O, FeI₃.H₂O, FeI₃.6H₂O, FeI₃.7H₂O, FeI₃.H₂O, FeI₃.9H₂O, GaBr₃.H₂O, GaBr₃.3H₂O, GaBr₃.4H₂O, GaBr₃.6H₂O, GaBr₃.7H₂O, GaBr₃.8H₂O, GaBr₃.10H₂O, GaCl₃.2H₂O, GaCl₃.H₂O, GaCl₃.4H₂O, GaCl₃.6H₂O, GaCl₃.7H₂O, GaCl₃.8H₂O, GaCl₃.10H₂O, GaF₃.3H₂O, GaF₃.4H₂O, GaF₃.6H₂O, GaF₃.7H₂O, GaF₃.10H₂O, GaI₃.H₂O, GaI₃.H₂O, GaI₃.6H₂O, GaI₃.7H₂O, GaI₃.H₂O, GeBr₂.H₂O, GeBr₂.2H₂O, GeBr₂.6H₂O, GeBr₂.7H₂O, GeBr₂.8H₂O, GeBr₂.9H₂O, GeBr₄.3H₂O, GeBr₄.4H₂O, GeBr₄.5H₂O, GeBr₄.9H₂O, GeCl₂.H₂O, GeCl₂.6H₂O, GeCl₂.7H₂O, GeCl₂.8H₂O, GeCl₂.9H₂O, GeCl₄.3H₂O, GeCl₄.4H₂O, GeCl₄.5H₂O, GeCl₄.9H₂O, GeF₂.6H₂O, GeF₂.7H₂O, GeF₂.8H₂O, GeF₂.9H₂O, GeF₄.H₂O, GeF₄.3H₂O, GeF₄.4H₂O, GeF₄.9H₂O, GeI₂.H₂O, GeI₂.2H₂O, GeI₂.6H₂O, GeI₂.7H₂O, GeI₂.8H₂O, GeI₂.9H₂O, GeI₄.3H₂O, GeI₄.4H₂O, GeI₄.5H₂O, GeI₄.9H₂O, HfBr₃.6H₂O, HfBr₃.7H₂O, HfBr₃.8H₂O, HfBr₃.10H₂O, HfBr₄.5H₂O, HfBr₄.9H₂O, HfBr₄.10H₂O, HfCl₃.H₂O, HfCl₃.6H₂O, HfCl₃.7H₂O, HfCl₃.H₂O, HfCl₃.H₂O, HfCl₄.5H₂O, HfCl₄.9H₂O, HfCl₄.10H₂O, HfF₃.9H₂O, HfF₃.10H₂O, HfF₄.H₂O, HfF₄.2H₂O, HfF₄.4H₂O, HfF₄.5H₂O, HfF₄.9H₂O, HfI₃.6H₂O, HfI₃.7H₂O, HfI₃.H₂O, HfI₃.H₂O, HfI₄.3H₂O, HfI₄.4H₂O, HfI₄.5H₂O, HfI₄.9H₂O, HfI₄.10H₂O, KBr.H₂O, KBr.2H₂O, KBr₃H₂O, KCl.H₂O, KCl_{.2}H₂O, KCl_{.3}H₂O, KF.H₂O, KF.3H₂O, KI.H₂O, KI.2H₂O, KI.3H₂O, LaBr₂.9H₂O, LaBr₂.12H₂O, LaBr₃.H₂O, LaBr₃.2H₂O, LaBr₃.3H₂O, LaBr₃.4H₂O, LaBr₃.7H₂O, LaBr₃.8H₂O, LaBr₃.10H₂O, LaCl_{.2}H₂O, LaCl_{.3}H₂O, LaCl_{.4}H₂O, LaCl₂.12H₂O, LaCl₃.2H₂O, LaCl₃.H₂O, LaCl₃.H₂O, LaCl₃.H₂O, LaF₂.12H₂O, LaF₃.H₂O, LaF₃.3H₂O, LaF₃.4H₂O, LaF₃.6H₂O, LaF₃.7H₂O, LaF₃.8H₂O, LaF₃.10H₂O, LaI.4H₂O, LaI₂.7H₂O, LaI₂.8H₂O, LaI₂.9H₂O, LaI₃.H₂O, LaI₃.2H₂O, LaI₃.3H₂O, LaI₃.4H₂O, LaI₃.7H₂O, LaI₃.8H₂O, LaI₃.10H₂O, LiF.H₂O, LiF.3H₂O, Li1.4H₂O, MgBr₂.7H₂O, MgBr₂.8H₂O, MgBr₂.9H₂O, MgCl₂.7H₂O, MgCl₂.8H₂O, MgF2.H₂O, MgF₂.6H₂O, MgF₂.8H₂O, MgF₂.9H₂O, MgI₂.H₂O, MgI₂.6H₂O, MgI₂.8H₂O, MnBr₂.2H₂O, MnBr₂.7H₂O, MnBr₂.8H₂O, MnBr₂.9H₂O, MnBr₃.H₂O, MnBr₃.2H₂O, MnBr₃.3H₂O, MnBr₃.4H₂O, MnBr₃.7H₂O, MnBr₃.8H₂O, MnBr₃.9H₂O, MnBr₃.10H₂O, MnBr₄.2H₂O, MnBr₄.3H₂O, MnBr₄.4H₂O, MnBr₄.5H₂O, MnBr₄.9H₂O, MnCl₂.6H₂O, MnCl₂.8H₂O, MnCl₂.9H₂O, MnCl₃.H₂O, MnCl₃.2H₂O, MnCl₃.H₂O, MnCl₃.H₂O, MnCl₃.7H₂O, MnCl₃.H₂O, MnCl₄.2H₂O, MnCl₄.3H₂O, MnCl₄.5H₂O, MnCl₄.9H₂O, MnF₂.2H₂O, MnF₂.6H₂O, MnF₂.8H₂O, MnF₂.9H₂O, MnF₃.4H₂O, MnF₃.6H₂O, MnF₃.7H₂O, MnF₄.H₂O, MnF₄.3H₂O, MnF₄.9H₂O, MnI₂.6H₂O, MnI₂.7H₂O, MnI₂.8H₂O, MnI₂.9H₂O, MnI₃.H₂O, MnI₃.2H₂O, MnI₃.3H₂O, MnI₃.4H₂O, MnI₃.7H₂O, MnI₃.8H₂O, MnI₃.9H₂O, MnI₃.10H₂O, MnI₄.2H₂O, MnI₄.3H₂O, MnI₄.4H₂O, MnI₄.5H₂O, MoBr₂.12H₂O, MoBr₃.3H₂O, MoBr₃.4H₂O, MoBr₃.6H₂O, MoBr₃.7H₂O, MoBr₃.8H₂O, MoBr₃.10H₂O, MoBr₄.2H₂O, MoBr₄.3H₂O, MoBr₄.4H₂O, MoBr₄.5H₂O, MoBr₄.9H₂O, MoCl₂.12H₂O, MoCl₃.H₂O, MoCl₃.H₂O, MoCl₃.6H₂O, MoCl₃.7H₂O, MoCl₃.8H₂O, MoCl₃.10H₂O, MoCl₄.H₂O, MoCl₄.2H₂O, MoCl₄.3H₂O, MoCl₄.5H₂O, MoF₂.8H₂O, MoF₂.9H₂O, MoF₂.12H₂O, MoF₃.H₂O, MoF₃.2H₂O, MoF₃.4H₂O, MoF₃.6H₂O, MoF₃.7H₂O, MoF₃.8H₂O, MoF₃.10H₂O, MoF₄.3H₂O, MoF₄.4H₂O, MoF₄.9H₂O, MoI₂.12H₂O, MoI₃.3H₂O, MoI₃.4H₂O, MoI₃.6H₂O, MoI₃.7H₂O, MoI₃.H₂O, MoI₃.10H₂O, MoI₄.2H₂O, MoI₄.3H₂O, MoI₄.4H₂O, MoI₄.5H₂O, MoI₄.9H₂O, NaBr₃H₂O, NaCl_{.3}H₂O, NaF.H₂O, NaF.2H₂O, NaF.3H₂O, NaI.H₂O, NaI.3H₂O, NaI.4H₂O, NbBr₃.2H₂O, NbBr₃.3H₂O, NbBr₃.4H₂O, NbBr₃.7H₂O, NbBr₃.8H₂O, NbBr₃.10H₂O, NbBr₄.2H₂O, NbBr₄.3H₂O, NbBr₄.4H₂O, NbBr₄.5H₂O, NbBr₄.9H₂O, NbCl₃.H₂O, NbCl₃.H₂O, NbCl₃.H₂O, NbCl₃.6H₂O, NbCl₃.7H₂O, NbCl₃.H₂O, NbCl₃.H₂O, NbCl₄.2H₂O, NbCl₄.3H₂O, NbCl₄.4H₂O, NbCl₄.5H₂O, NbCl₄.9H₂O, NbF₃.2H₂O, NbF₃.3H₂O, NbF₃.4H₂O, NbF₃.6H₂O, NbF₃.7H₂O, NbF₃.8H₂O, NbF₃.10H₂O, NbF₄.H₂O, NbF₄.2H₂O, NbF₄.3H₂O, NbF₄.4H₂O, NbF₄.9H₂O, NbI₃.2H₂O, NbI₃.H₂O, NbI₃.H₂O, NbI₃.7H₂O, NbI₃.H₂O, NbI₃.H₂O, NbI₄.2H₂O, NbI₄.3H₂O, NbI₄.4H₂O, NbI₄.5H₂O, NbI₄.9H₂O, NbI₄.10H₂O, NiBr₂.H₂O, NiBr₂.2H₂O, NiBr₂.4H₂O, NiBr₂.6H₂O, NiBr₂.7H₂O, NiBr₂.8H₂O, NiBr₂.9H₂O, NiBr₃.H₂O, NiBr₃.2H₂O, NiBr₃.3H₂O, NiBr₃.4H₂O, NiBr₃.7H₂O, NiBr₃.8H₂O, NiBr₃.9H₂O, NiBr₃.10H₂O, NiCl₂.H₂O, NiCl₂.7H₂O, NiCl₂.8H₂O, NiCl₂.9H₂O, NiCl₃.H₂O, NiCl₃.H₂O, NiCl₃.H₂O, NiCl₃.7H₂O, NiCl₃.H₂O, NiF₂.H₂O, NiF₂.6H₂O, NiF₂.7H₂O, NiF₂.8H₂O, NiF₂.9H₂O, NiF₃.4H₂O, NiF₃.6H₂O, NiF₃.10H₂O, NiI₂.H₂O, NiI₂.2H₂O, NiI₂.4H₂O, NiI₂.7H₂O, NiI₂.8H₂O, NiI₂.9H₂O, NiI₃.2H₂O, NiI₃.3H₂O, NiI₃.6H₂O, NiI₃.7H₂O, NiI₃.8H₂O, NiI₃.9H₂O, NiI₃.H₂O, PbBr₂.H₂O, PbBr₂.6H₂O, PbBr₂.7H₂O, PbBr₂.8H₂O, PbBr₂.9H₂O, PbBr₄.3H₂O, PbBr₄.4H₂O, PbBr₄.5H₂O, PbBr₄.9H₂O, PbCl₂.H₂O, PbCl₂.6H₂O, PbCl₂.7H₂O, PbCl₂.8H₂O, PbCl₂.9H₂O, PbCl₄.2H₂O, PbCl₄.4H₂O, PbCl₄.5H₂O, PbF₂.4H₂O, PbF₂.6H₂O, PbF₂.7H₂O, PbF₂.8H₂O, PbF₂.9H₂O, PbF₄.H₂O, PbF₄.4H₂O, PbI2.H₂O, PbI₂.2H₂O, PbI₂.6H₂O, PbI₂.7H₂O, PbI₂.8H₂O, PbI₂.9H₂O, PbI₄.H₂O, PbI₄.3H₂O, PbI₄.4H₂O, PbI₄.H₂O, PbI₄.9H₂O, RbBr.H₂O, RbBr₂H₂O, RbBr₃H₂O, RbCl.H₂O, RbCl_{.2}H₂O, RbCl_{.3}H₂O, RbF.3H₂O, RbIH₂O, RbI2H₂O, RbI3H₂O, ScBr₃.2H₂O, ScBr₃.3H₂O, ScBr₃.4H₂O, ScBr₃.7H₂O, ScBr₃.8H₂O, ScBr₃.10H₂O, ScCl₃.H₂O, ScCl₃.2H₂O, ScCl₃.4H₂O, ScCl₃.7H₂O, ScCl₃.8H₂O, ScCl₃.10H₂O, ScF₃.2H₂O, ScF₃.4H₂O, ScF₃.6H₂O, ScF₃.7H₂O, ScF₃.8H₂O, ScF₃.10H₂O, ScI₃.H₂O, ScI₃.H₂O, ScI₃.H₂O, ScI₃.7H₂O, ScI₃.H₂O, ScI₃.10H₂O, SiBr₂.4H₂O, SiBr₂.9H₂O, SiBr₂.12H₂O, SiBr₄.3H₂O, SiBr₄.4H₂O, SiBr₄.5H₂O, SiCl₂.4H₂O, SiCl₂.7H₂O, SiCl₂.9H₂O, SiCl₂.12H₂O, SiCl₄.3H₂O, SiCl₄.4H₂O, SiCl₄.5H₂O, SiF₂.2H₂O, SiF₂.8H₂O, SiF₄.H₂O, SiF₄.3H₂O, SiF₄.4H₂O, SiF₄.9H₂O, SiI₂.4H₂O, SiI₂.6H₂O, SiI₂.9H₂O, SiI₂.12H₂O, SiI₄.H₂O, SnBr₂.H₂O, SnBr₂.6H₂O, SnBr₂.8H₂O, SnBr₂.9H₂O, SnBr₄.2H₂O, SnBr₄.3H₂O, SnBr₄.4H₂O, SnBr₄.9H₂O, SnCl₂.H₂O, SnCl₂.6H₂O, SnCl₂.7H₂O, SnCl₂.8H₂O, SnCl₂.9H₂O, SnCl₄.H₂O, SnCl₄.2H₂O, SnF₂.H₂O, SnF₂.6H₂O, SnF₂.7H₂O, SnF₂.8H₂O, SnF₂.9H₂O, SnF₄.H₂O, SnF₄.3H₂O, SnF₄.4H₂O, SnF₄.9H₂O, SnI₂.H₂O, SnI₂.2H₂O, SnI₂.6H₂O, SnI₂.7H₂O, SnI₂.8H₂O, SnI₂.9H₂O, SnI₄.4H₂O, SnI₄.9H₂O, SrBr₂.4H₂O, SrBr₂.7H₂O, SrBr₂.8H₂O, SrBr₂.9H₂O, SrCl₂.4H₂O, SrCl₂.7H₂O, SrCl₂.8H₂O, SrCl₂.9H₂O, SrF₂.4H₂O, SrF₂.6H₂O, SrF₂.7H₂O, SrF₂.8H₂O, SrF₂.9H₂O, SrI₂.4H₂O, SrI₂.7H₂O, SrI₂.8H₂O, SrI₂.9H₂O, TaBr₃.H₂O, TaBr₃.2H₂O, TaBr₃.3H₂O, TaBr₃.4H₂O, TaBr₃.7H₂O, TaBr₃.8H₂O, TaBr₃.10H₂O, TaBr₄.2H₂O, TaBr₄.3H₂O, TaBr₄.4H₂O, TaBr₄.5H₂O, TaBr₄.9H₂O, TaCl₃.2H₂O, TaCl₃.H₂O, TaCl₃.H₂O, TaCl₃.6H₂O, TaCl₃.7H₂O, TaCl₃.H₂O, TaCl₃.H₂O, TaCl₄.2H₂O, TaCl₄.3H₂O, TaCl₄.4H₂O, TaCl₄.5H₂O, TaCl₄.9H₂O, TaF₃.9H₂O, TaF₃.10H₂O, TaF₄.2H₂O, TaF₄.3H₂O, TaF₄.4H₂O, TaF₄.9H₂O, TaI₃.H₂O, TaI₃.H₂O, TaI₃.7H₂O, TaI₃.H₂O, TaI₃.9H₂O, TaI₃.H₂O, TaI₄.2H₂O, TaI₄.3H₂O, TaI₄.4H₂O, TaI₄.5H₂O, TaI₄.9H₂O, TaI₄.10H₂O, TiBr₂.2H₂O, TiBr₂.4H₂O, TiBr₂.6H₂O, TiBr₂.7H₂O, TiBr₂.8H₂O, TiBr₂.9H₂O, TiBr₃.H₂O, TiBr₃.2H₂O, TiBr₃.3H₂O, TiBr₃.4H₂O, TiBr₃.7H₂O, TiBr₃.8H₂O, TiBr₃.10H₂O, TiBr₄.2H₂O, TiBr₄.3H₂O, TiBr₄.4H₂O, TiBr₄.5H₂O, TiBr₄.9H₂O, TiCl₂.2H₂O, TiCl₂.4H₂O, TiCl₂.6H₂O, TiCl₂.7H₂O, TiCl₂.8H₂O, TiCl₂.9H₂O, TiCl₃.H₂O, TiCl₃.2H₂O, TiCl₃.H₂O, TiCl₃.7H₂O, TiCl₃.H₂O, TiCl₃.H₂O, TiCl₄.2H₂O, TiCl₄.3H₂O, TiCl₄.4H₂O, TiCl₄.5H₂O, TiCl₄.9H₂O, TiF₂.4H₂O, TiF₂.6H₂O, TiF₂.8H₂O, TiF₂.9H₂O, TiF₃.2H₂O, TiF₃.6H₂O, TiF₃.7H₂O, TiF₃.8H₂O, TiF₄.H₂O, TiF₄.3H₂O, TiF₄.4H₂O, TiF₄.9H₂O, TiI₂.H₂O, TiI₂.2H₂O, TiI₂.4H₂O, TiI₂.6H₂O, TiI₂.7H₂O, TiI₂.8H₂O, TiI₂.9H₂O, TiI₃.2H₂O, TiI₃.3H₂O, TiI₃.4H₂O, TiI₃.7H₂O, TiI₃.8H₂O, TiI₃.H₂O, TiI₄.2H₂O, TiI₄.3H₂O, TiI₄.4H₂O, TiI₄.5H₂O, TiI₄.9H₂O, VBr₂.H₂O, VBr₂.7H₂O, VBr₂.8H₂O, VBr₂.9H₂O, VBr₃.H₂O, VBr₃.2H₂O, VBr₃.3H₂O, VBr₃.7H₂O, VBr₃.8H₂O, VBr₄.2H₂O, VBr₄.3H₂O, VBr₄.4H₂O, VBr₄.5H₂O, VCl₂.6H₂O, VCl₂.7H₂O, VCl₂.8H₂O, VCl₂.9H₂O, VCl₃.H₂O, VCl₃.2H₂O, VCl₃.7H₂O, VCl₃.H₂O, VCl₃.H₂O, VCl₄.2H₂O, VCl₄.3H₂O, VCl₄.4H₂O, VCl₄.5H₂O, VF₂.2H₂O, VF₂.6H₂O, VF₂.7H₂O, VF₂.8H₂O, VF₂.9H₂O, VF₃.4H₂O, VF₃.6H₂O, VF₄.H₂O, VF₄.3H₂O, VF₄.4H₂O, VI₂.H₂O,VI₂.2H₂O, VI₂.7H₂O, VI₂.8H₂O, VI₂.9H₂O, VI₃.2H₂O, VI₃.H₂O, VI₃.H₂O, VI₃.7H₂O, VI₃.H₂O, VI₃.H₂O, VI₄.2H₂O, VI₄.3H₂O, VI₄.4H₂O, VI₄.5H₂O, VI₄.9H₂O, WBr₄.2H₂O, WBr₄.3H₂O, WBr₄.5H₂O, WBr₄.9H₂O, WCl₄.2H₂O, WCl₄.3H₂O, WCl₄.4H₂O, WCl₄.5H₂O, WCl₄.9H₂O, WF₄.2H₂O, WF₄.3H₂O, WF₄.4H₂O, WI₄.2H₂O, WI₄.3H₂O, WI₄.4H₂O, WI₄.5H₂O, WI₄.9H₂O, YBr₃.H₂O, YBr₃.2H₂O, YBr₃.3H₂O, YBr₃.4H₂O, YBr₃.7H₂O, YBr₃.8H₂O, YBr₃.10H₂O, YCl₃.H₂O, YCl₃.2H₂O, YCl₃.H₂O, YCl₃.7H₂O, YCl₃.H₂O, YCl₃.H₂O, YF₃.H₂O, YF₃.2H₂O, YF₃.3H₂O, YF₃.4H₂O, YF₃.6H₂O, YF₃.7H₂O, YF₃.8H₂O, YF₃.10H₂O, YI₃.2H₂O, YI₃.3H₂O, YI₃.4H₂O, YI₃.10H₂O, ZnBr₂.H₂O, ZnBr₂.6H₂O, ZnBr₂.7H₂O, ZnBr₂.8H₂O, ZnBr₂.9H₂O, ZnCl₂.8H₂O, ZnCl₂.9H₂O, ZnF2.H₂O, ZnF₂.2H₂O, ZnF₂.6H₂O, ZnF₂.8H₂O, ZnF₂.9H₂O, ZnI2.H₂O, ZnI₂.4H₂O, ZnI₂.6H₂O, ZnI₂.8H₂O, ZnI₂.9H₂O, ZrBr₂.6H₂O, ZrBr₂.7H₂O, ZrBr₂.8H₂O, ZrBr₂.9H₂O, ZrBr₃.2H₂O, ZrBr₃.3H₂O, ZrBr₃.4H₂O, ZrBr₃.6H₂O, ZrBr₃.7H₂O, ZrBr₃.8H₂O, ZrBr₃.10H₂O, ZrBr₄.5H₂O, ZrBr₄.9H₂O, ZrBr₄.10H₂O, ZrCl₂.6H₂O, ZrCl₂.8H₂O, ZrCl₂.9H₂O, ZrCl₃.H₂O, ZrCl₃.2H₂O, ZrCl₃.H₂O, ZrCl₃.4H₂O, ZrCl₃.6H₂O, ZrCl₃.7H₂O, ZrCl₃.H₂O, ZrCl₃.H₂O, ZrCl₄.5H₂O, ZrCl₄.9H₂O, ZrCl₄.10H₂O, ZrF₃.6H₂O, ZrF₃.7H₂O, ZrF₃.8H₂O, ZrF₃.10H₂O, ZrF₄.2H₂O, ZrF₄.4H₂O, ZrF₄.5H₂O, ZrF₄.9H₂O, ZrI₂.12H₂O, ZrI₃.H₂O, ZrI₃.H₂O, ZrI₃.6H₂O, ZrI₃.7H₂O, ZrI₃.H₂O, ZrI₃.H₂O, ZrI₄.3H₂O, ZrI₄.4H₂O, ZrI₄.5H₂O, ZrI₄.9H₂O, ZrI₄.10H₂O, and combinations thereof; and
releasing heat via an exothermic hydration reaction of the salt hydrate.
